(19) United States
(12) Patent Application Publication
(10) Pub. No.: US 2025/0316013 A1
(43) Pub. Date: Oct. 9, 2025

(54) USER INTERFACES FOR GENERATING AUTOMATICALLY-GENERATED CONTENT

(71) Applicant: Apple Inc., Cupertino, CA (US)

(72) Inventors: James J. OWEN, San Francisco, CA (US); Miquel ESTANY RODRIGUEZ, San Francisco, CA (US); Alfred B. HUERGO WAGNER, Redwood City, CA (US); Aaron D. MUSENGO, San Jose, CA (US); Christopher R. DONEGAN, Foster City, CA (US); Christopher C. NIEDERAUER, Los Altos Hills, CA (US); Giancarlo YERKES, San Francisco, CA (US)

(21) Appl. No.: 19/093,022

(22) Filed: Mar. 27, 2025

Related U.S. Application Data
(60) Provisional application No. 63/631,445, filed on Apr. 8, 2024.
(60) Provisional application No. 63/657,971, filed on Jun. 9, 2024.
(60) Provisional application No. 63/658,421, filed on Jun. 10, 2024.
(60) Provisional application No. 63/709,506, filed on Oct. 20, 2024.

(51) Int. Cl. G06T 13/80; G06T 5/92; G06T 11/00; G06V 20/40

(52) U.S. Cl. CPC G06T 13/80; G06T 5/92; G06T 11/001; G06V 20/44; G06T 2200/24; G06T 2207/20208

(57) ABSTRACT

In some embodiments, an electronic device generates an automatically-generated visual media using one or more recognized concepts extracted from a prompt inputted by a user. The recognized concepts include personalized template subjects and/or prompt suggestions. While displaying the user interface including the recognized concepts, the electronic device receives one or more inputs to modify the recognized concepts. The electronic device generates multiple variants of the automatically-generated visual content using the one or more recognized concepts. The electronic device adds an automatically-generated visual content to a content entry field of an application, different than the automatically-generated visual media application, without opening the automatically-generated visual media application. The electronic device applies a visual effect to content that is generated using an artificial intelligence model. The electronic device displays visual information corresponding to an artificial intelligence model. The electronic device displays an animation including displaying a user interface with high dynamic range luminance.

### CROSS-REFERENCE TO RELATED APPLICATIONS

This application claims the benefit of U.S. Provisional Application No. 63/631,445, filed Apr. 8, 2024, U.S. Provisional Application No. 63/657,971, filed Jun. 9, 2024, U.S. Provisional Application No. 63/658,421, filed Jun. 10, 2024, and U.S. Provisional Application No. 63/709,506, filed Oct. 20, 2024, the contents of which are herein incorporated by reference in their entireties for all purposes.

### FIELD OF THE DISCLOSURE

This disclosure relates generally to an electronic device presenting user interfaces for generating automatically-generated content.

### BACKGROUND OF THE DISCLOSURE

User interaction with electronic devices has increased significantly in recent years. These devices can be devices such as computers, tablet computers, televisions, multimedia devices, or mobile devices. In some circumstances, users may wish to create generative images using reference images. The user may therefore desire efficient ways of generating automatically-generated content and displaying the automatically-generated content.

### SUMMARY OF THE DISCLOSURE

Providing efficient ways of displaying representations of recognized concepts of a prompt used to generate automatically-generated visual content allows a user to easily and efficiently see the concepts used to generate the generative image, thereby reducing errors in output of the electronic device, and avoiding the need for additional input to correct such errors. Allowing a user to edit previously generated media allows the user to efficiently change recognized concepts of a previously generated media item, thereby reducing computing resources used by the electronic device, and also reduces erroneous inputs to the electronic device.

In some embodiments, an electronic device receives a prompt for generating an automatically-generated visual content. In some embodiments, the electronic device extracts recognized concepts from the prompt to be used to influence the generation of the automatically-generated visual content. In some embodiments, while displaying the user interface including the recognized concepts, the electronic device receives one or more inputs to modify the recognized concepts. In some embodiments, the electronic device generates (e.g., using an AI process or a generative AI process) an automatically-generated visual content using the one or more recognized concepts.

In some embodiments, the electronic device adds an automatically-generated visual content to a content entry field of a first application, different than the automatically-generated visual media application, without opening the automatically-generated visual media application. In some embodiments, the electronic device displays a user interface within the first application including one or more previously generated automatically-generated visual content to be added to the content entry field. In some embodiments, the electronic device edits previously generated automatically-generated visual content and creates new automatically-generated visual content using reference media items while in the first application. In some embodiments, the electronic device detects an event corresponding to a respective functionality that outputs content generated based on an artificial intelligence (AI) model and displays the content with a visual effect that includes a visual characteristic associated with content generated based on an AI model. In some embodiments, the electronic device displays an animation indicative of an AI model content generation information, wherein the animation includes High Dynamic Range (HDR) content.

Displaying a user interface for inserting the automatically-generated visual content into the user interface of the first application allows a user to efficiently insert such visual media into the first application without opening a second application and/or navigating away from the first user interface, thereby reducing inputs needed to insert such visual media. Displaying a user interface for generating the automatically-generated visual content based on a reference media item in the user interface of the first application allows a user to generate an automatically-generated visual content for use with the first application without opening a second application and/or navigating away from the first application, thereby reducing inputs needed to generate such visual media. Displaying a user interface with a visual characteristic and/or animation to indicate that the content is based on AI generated content allows a user to visually assess when content was generated using an AI model.

Displaying a representation of second automatically-generated generative visual content based on a user selected prompt used to automatically generate first automatically-generated generative visual content in response to an input including a movement component provides an intuitive way to display representations of different automatically-generated generative visual content efficient interactions between the user and the electronic device.

Restricting automatically-generated visual content generated in response to user inputs enhances the operability of the device and makes the user-device interface more efficient.

Suggesting prompt components based on previously presented content and/or device context allows the user to easily and efficiently select relevant prompt components to be used to influence the generation of an automatically-generated visual content, thereby reducing the number of inputs needed to generate automatically-generated visual media and reducing erroneous inputs to the electronic device.

Presenting options for personalizing the subject of automatically-generated visual media, including editing subjects and/or creating subjects provides efficient ways of customizing the content of automatically-generated visual media while reducing inputs and user errors.

Providing options to personalize template subjects allows a user to constrain certain appearance characteristics while allowing variability for other appearance characteristics therefore allowing for a broader range of representations of different types of subjects for the automatically-generated visual content.

The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIGS. 3A-3G is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6MM illustrate exemplary ways in which an electronic device displays recognized concepts and generates automatically-generated visual media in accordance with some embodiments of the disclosure.

FIG. 7 illustrates a flow diagram illustrating a method in which an electronic device displays recognized concepts and generates automatically-generated visual media in accordance with some embodiments of the disclosure.

FIG. 8 illustrates a flow diagram illustrating a method in which an electronic device edits one or more parameters associated with a previously generated automatically-generated visual content and regenerates a new automatically-generated visual content in accordance with some embodiments of the disclosure.

FIGS. 9A-9X illustrate exemplary ways in which an electronic device adds automatically-generated visual content to a first user interface of a first application according to some embodiments of the disclosure.

FIG. 10 illustrates a flow diagram illustrating a method in which an electronic device adds automatically-generated visual content to a first user interface of a first application according to some embodiments of the disclosure.

FIGS. 11A-11J illustrate exemplary ways in which an electronic device selects a reference media item to be used to generate an automatically-generated visual content while displaying a user interface of a first application.

FIG. 12 illustrates a flow diagram illustrating a method in which an electronic device selects a reference media item to be used to generate an automatically-generated visual content while displaying a user interface of a first application.

FIGS. 13A-13HH illustrate exemplary visual effects applied to a user interfaces that include content related to an artificial intelligence model.

FIG. 14 illustrates a flow diagram illustrating a method in which an electronic device displays visual information based upon an event that corresponds to an artificial intelligence model in accordance with some embodiments of the disclosure.

FIG. 15 illustrates a flow diagram illustrating a method in which an electronic device displays an animation including high dynamic range luminance in accordance with some embodiments of the disclosure.

FIGS. 16A-16U illustrate exemplary ways in which an electronic device displays multiple variations of representations of automatically-generated visual content items in accordance with some embodiments of the disclosure.

FIG. 17 illustrates a flow diagram illustrating a method in which an electronic device displays multiple variations of representations of automatically-generated visual content items in accordance with some embodiments of the disclosure.

FIGS. 18A-18BB illustrate exemplary ways in which an electronic device restricts automatically-generated visual content in accordance with some embodiments of the disclosure.

FIG. 19 illustrates a flow diagram illustrating a method in which an electronic device restricts automatically-generated visual content in accordance with some embodiments of the disclosure.

FIGS. 20A-20AA illustrate exemplary ways in which an electronic device displays prompt component suggestions and generates an automatically-generated visual content in accordance with some embodiments of the disclosure.

FIG. 21 illustrates a flow diagram illustrating a method in which an electronic device displays prompt component suggestions and generates an automatically-generated visual content in accordance with some embodiments of the disclosure.

FIGS. 22A through 22CCC illustrate exemplary ways in which an electronic device presents user interfaces for editing a subject of an automatically-generated visual content item in accordance with some embodiments of the disclosure.

FIG. 23 illustrates a flow diagram illustrating a method in which an electronic device presents user interfaces for editing a subject of an automatically-generated visual content item in accordance with some embodiments of the disclosure.

FIGS. 24A-24E illustrate exemplary ways in which an electronic device detects an input to display automatically-generated visual content in a user interface of an application in accordance with some embodiments of the disclosure.

FIGS. 25A-25O illustrate exemplary ways in which an electronic device detects an input to display automatically-generated visual content in a user interface of an application in accordance with some embodiments of the disclosure and example visual effects and/or operations corresponding to visual effects and/or operations described in this disclosure.

FIGS. 26A-26P illustrate exemplary ways in which an electronic device presents user interfaces for selecting a template subject for generating an automatically-generated visual content item in accordance with some embodiments of the disclosure.

FIG. 27 illustrates a flow diagram illustrating a method in which an electronic device presents user interfaces for selecting a template subject for generating an automatically-generated visual content item in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used, and structural changes are optionally made without departing from the scope of the disclosed embodiments.

Providing efficient ways of displaying representations of recognized concepts of a prompt used to generate an automatically-generated visual content allows a user to easily and efficiently see the concepts used to generate the generative image, thereby reducing errors in output of the electronic device, and avoiding the need for additional input to correct such errors. Allowing a user to edit previously generated media allows the user to efficiently change recognized concepts of a previously generated media item, thereby reducing computing resources used by the electronic device, and also reduces erroneous inputs to the electronic device.

In some embodiments, an electronic device receives a prompt for generating an automatically-generated visual content. In some embodiments, the electronic device extracts recognized concepts from the prompt to be used to influence the generation of the automatically-generated visual content. In some embodiments, while displaying the user interface including the recognized concepts, the electronic device receives one or more inputs to modify the recognized concepts. In some embodiments, the electronic device generates (e.g., using an AI process or a generative AI process) an automatically-generated visual content using the one or more recognized concepts.

In some embodiments, the electronic device adds an automatically-generated visual content to a content entry field of a first application, different than the automatically-generated visual media application, without opening the automatically-generated visual media application. In some embodiments, the electronic device displays a user interface within the first application including one or more previously generated automatically-generated visual content to be added to the content entry field. In some embodiments, the electronic device edits previously generated automatically-generated visual content and creates new automatically-generated visual content using reference media items while in the first application.

Displaying a user interface for inserting the automatically-generated visual content into the user interface of the first application allows a user to efficiently insert such visual media into the first application without opening a second application and/or navigating away from the first user interface, thereby reducing inputs needed to insert such visual media. Displaying a user interface for generating the automatically-generated visual content based on a reference media item in the user interface of the first application allows a user to generate an automatically-generated visual content for use with the first application without opening a second application and/or navigating away from the first application, thereby reducing inputs needed to generate such visual media.

Displaying a representation of second automatically-generated generative visual content based on a user selected prompt used to automatically generate first automatically-generated generative visual content in response to an input including a movement component provides an intuitive way to display representations of different automatically-generated generative visual content efficient interactions between the user and the electronic device.

Displaying an animation in which portions of a user interface are displayed with a degree of luminance that is greater than a standard dynamic range of luminance visually emphasizes that operations associated with of an electronic device are ongoing, and reduces input erroneously interrupting such operations.

Restricting automatically-generated visual content generated in response to user inputs enhances the operability of the device and makes the user-device interface more efficient.

Suggesting prompt components based on previously presented content and/or device context allows the user to easily and efficiently select relevant prompt components to be used to influence the generation of an automatically-generated visual content, thereby reducing the number of inputs needed to generate automatically-generated visual media and reducing erroneous inputs to the electronic device.

Presenting options for personalizing the subject of automatically-generated visual media, including editing subjects and/or creating subjects provides efficient ways of customizing the content of automatically-generated visual media while reducing inputs and user errors.

Providing options to personalize template subjects allows a user to constrain certain appearance characteristics while allowing variability for other appearance characteristics therefore allowing for a broader range of representations of different types of subjects for the automatically-generated visual content.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example, on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

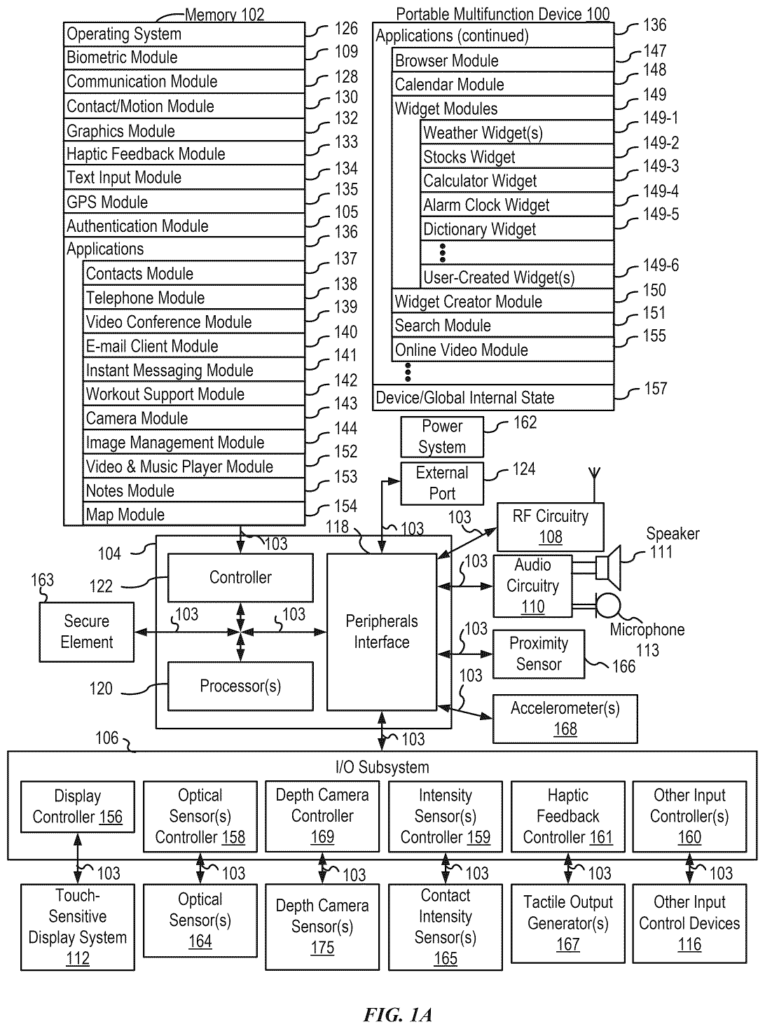

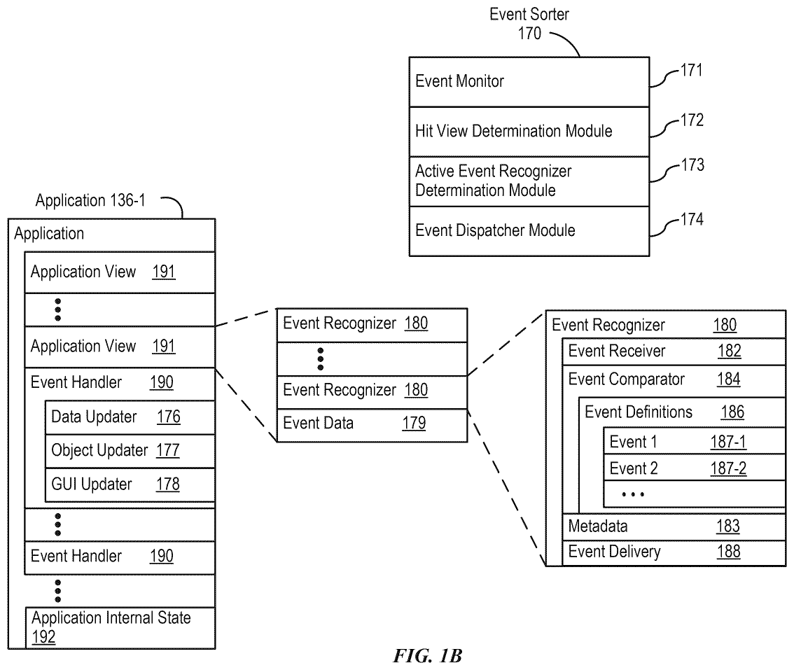

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

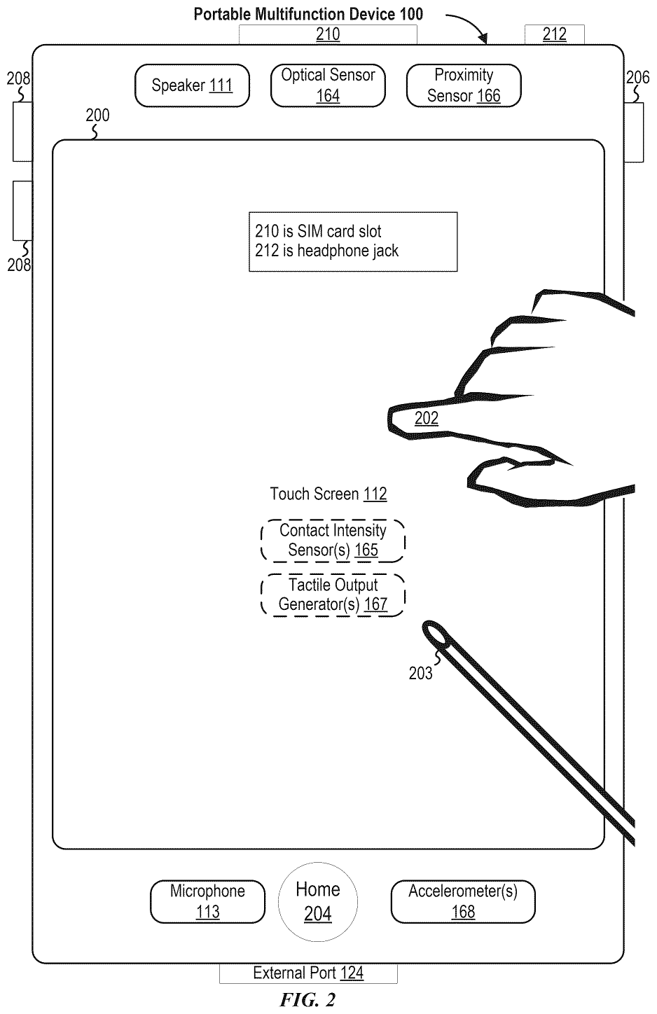

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/48,264, “Gestures For Touch Sensitive Input Devices,” filed Jan. 31, 2005; (5) U.S. patent application Ser. No. 11/38,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

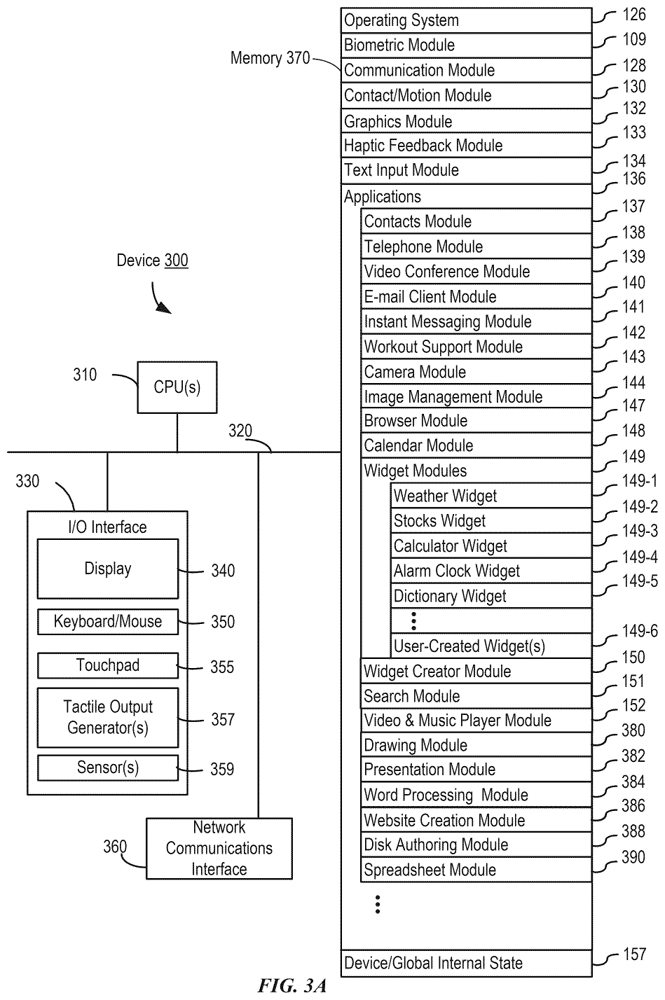

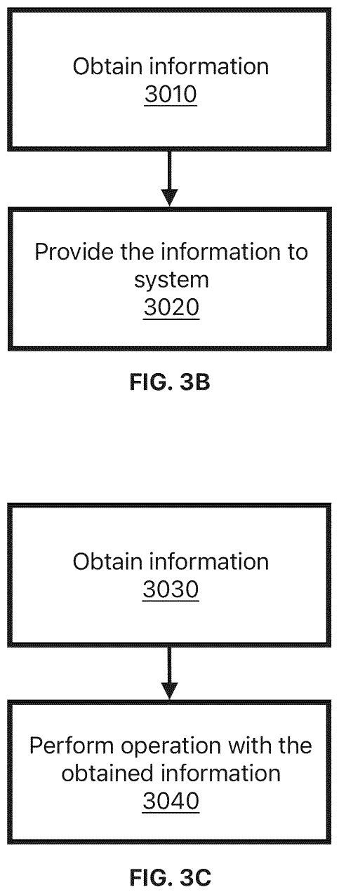

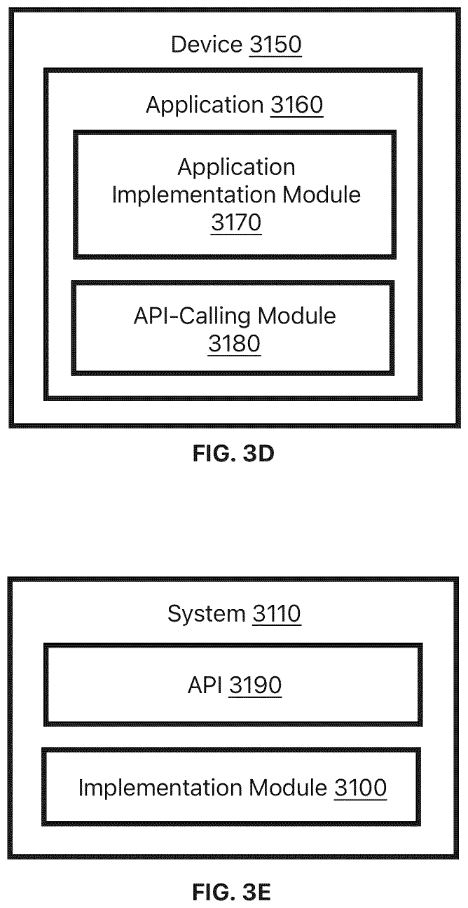

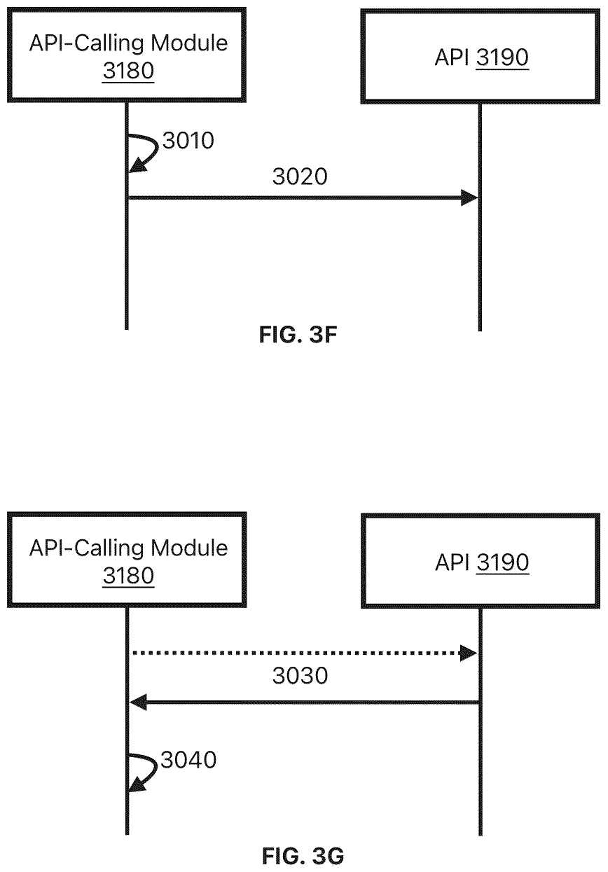

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,67, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

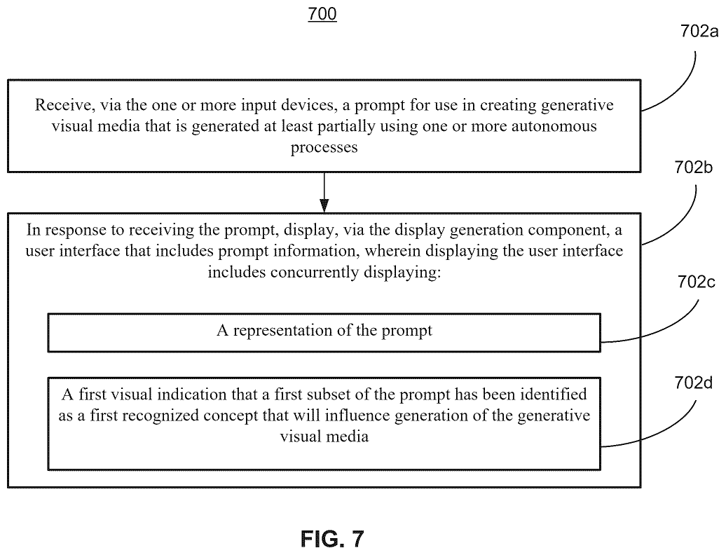

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700, 800, 1000, 1200, 1400, 1500, 1700, 1900, 2100, 2300, and 2700 (FIGS. 7, 8, 10, 12, 14, 15, 17, 19, 21, 23, and 27) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

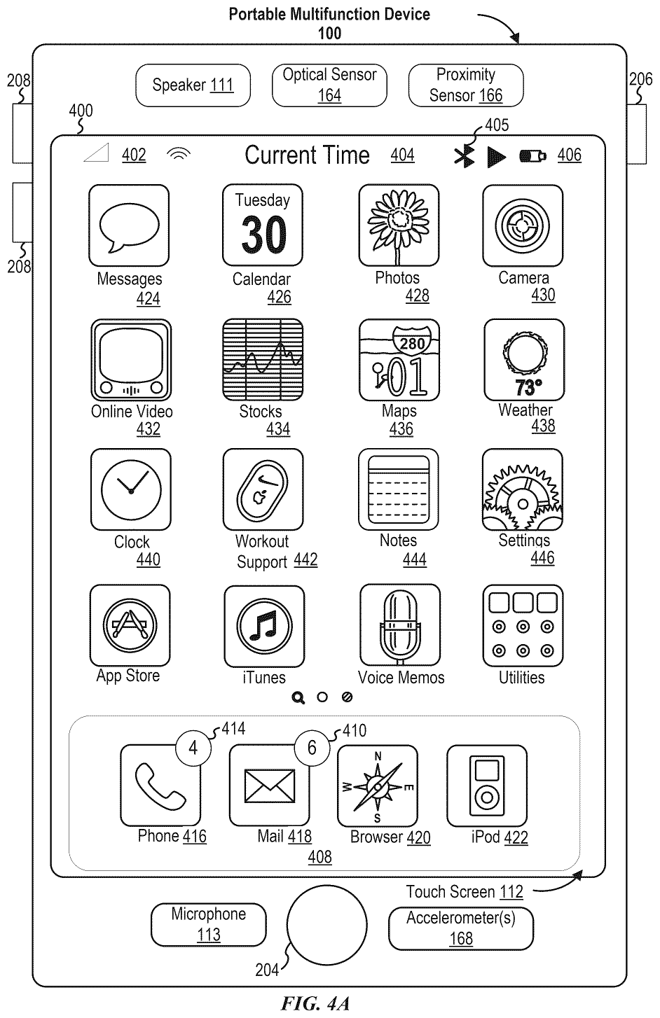

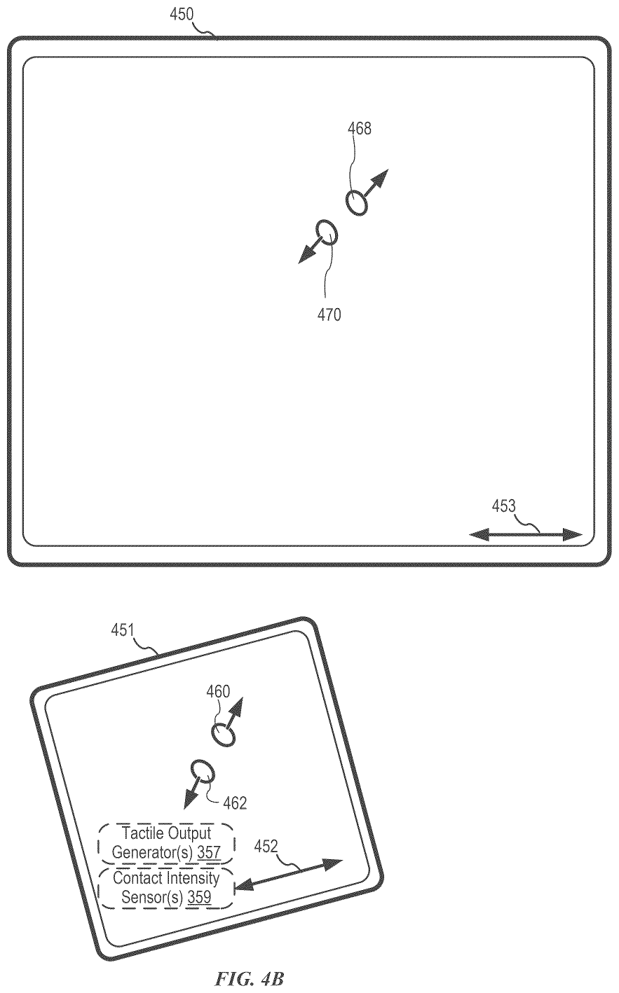

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.5, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

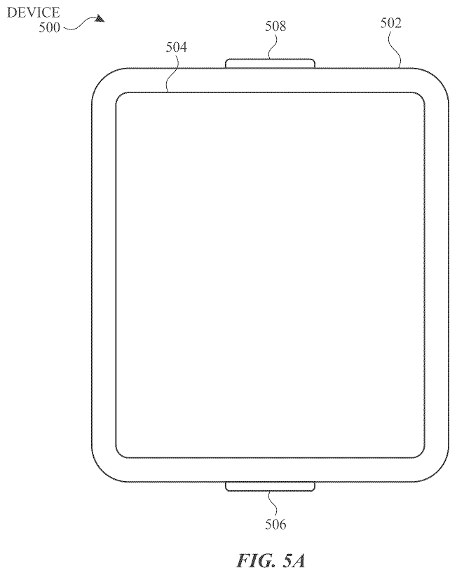

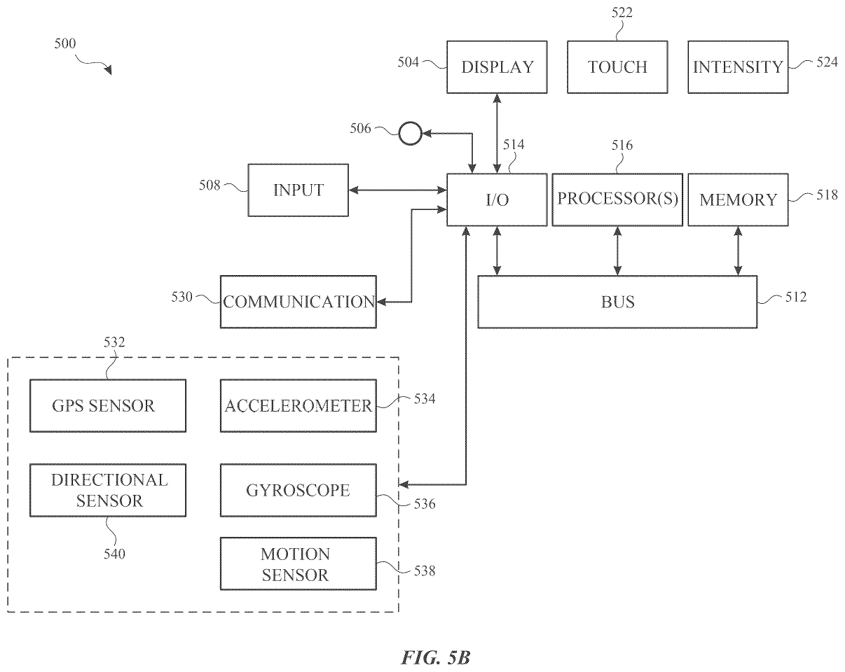

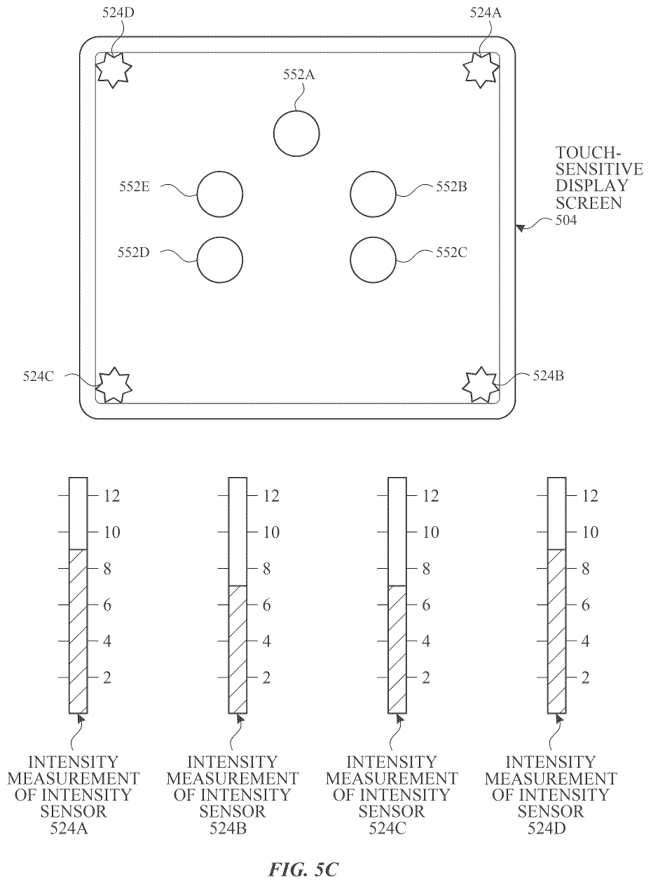

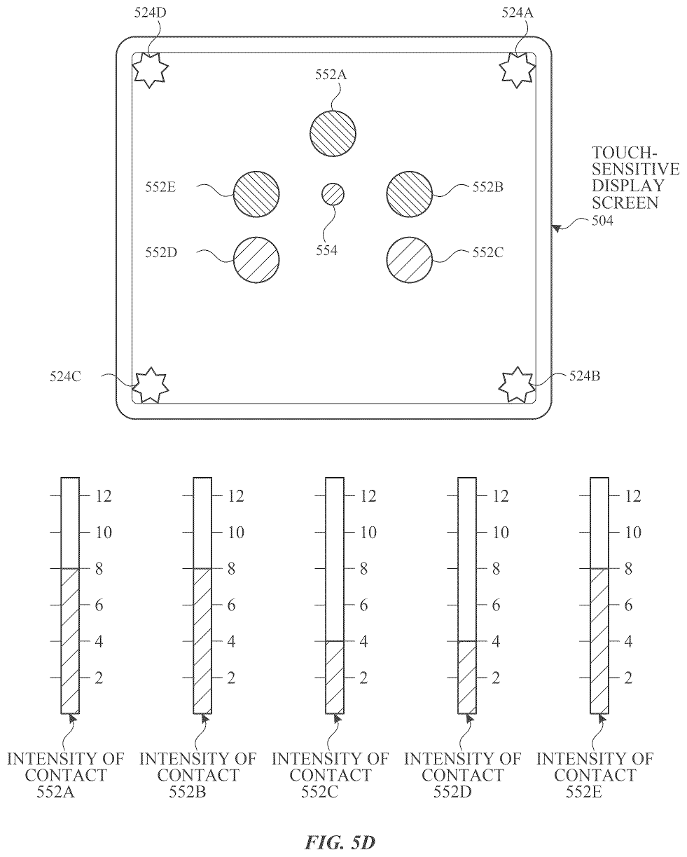

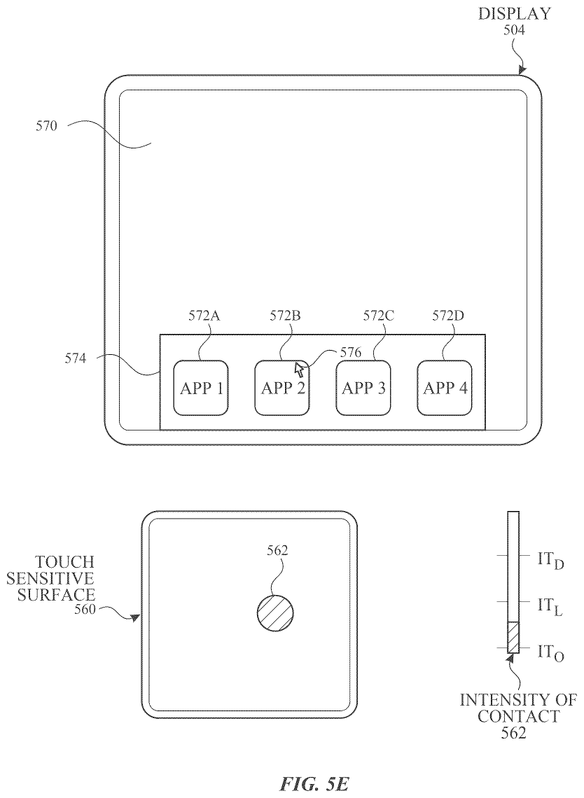

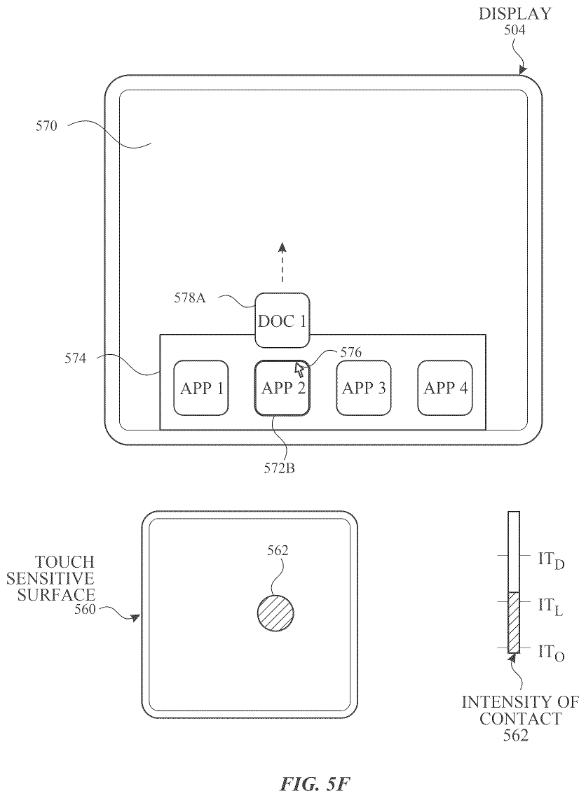

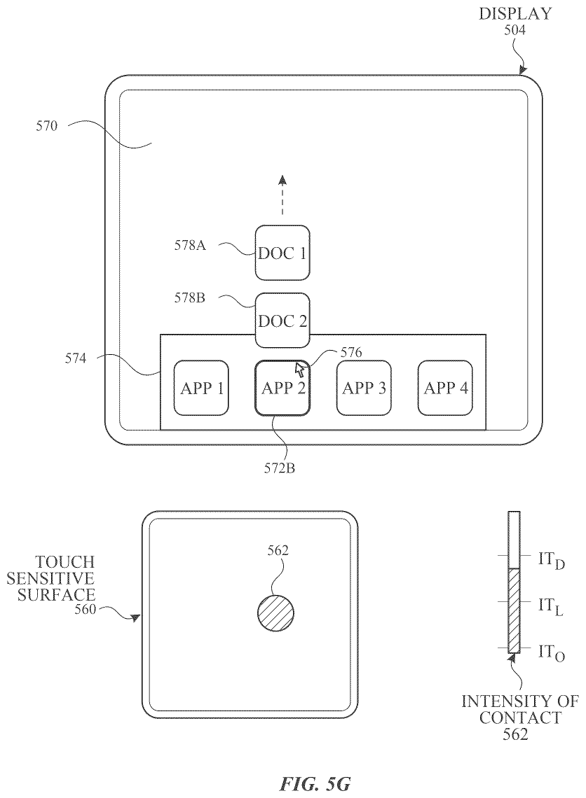

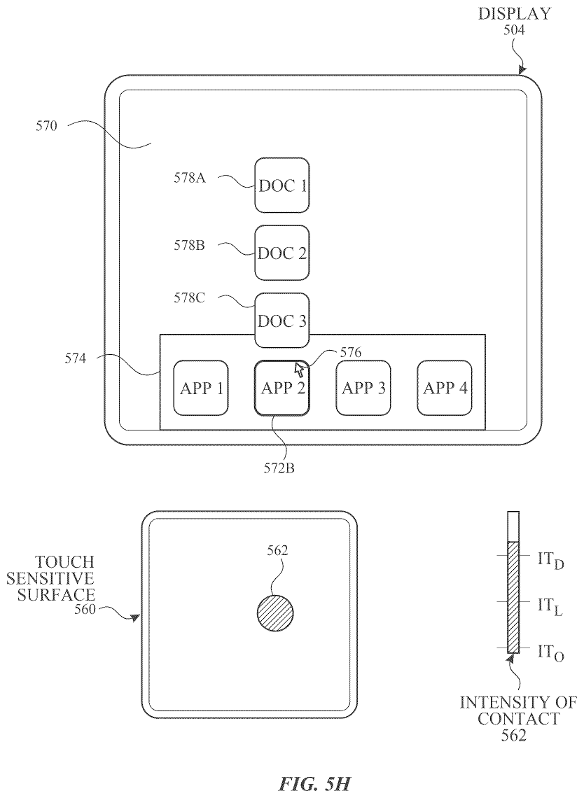

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 516 optionally execute any number of programs stored in memory 506 or storage, which optionally includes instructions to perform one or more of the methods and/or processes described herein (e.g., methods 700, 800, 1000, 1200, 1400, 1500, 1700, 1900, 2100, 2300, and/or 2700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.5, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Users interact with electronic devices in many different manners. In some embodiments, an electronic device is in communication with one or more input devices, a display generation component, and wireless circuitry. In some embodiments, the electronic device presents a user interface that receives a prompt to be used to influence generation of an automatically-generated visual media, such as described in more detail with reference to method 700. In some embodiments, automatically-generated visual media is media generated using autonomous processes. In some embodiments, generating the automatically-generated visual media includes using a real image as a starting point to build in additional concepts and/or features found in the prompt, as described in method 700. In some embodiments, a real image is an image captured of the real world such as an image captured by a camera or user created digital image or a modified version of a real-world image or user created digital image. In some embodiments, the real image is not a previously generated automatically-generated visual content. The embodiments described below provide ways in which the electronic device receives and displays concepts to be used to influence the generation of the automatically-generated visual media. The embodiments described below also provide ways in which the electronic device generates (e.g., using an AI process or a generative AI process) the automatically-generated visual media. Displaying representations of recognized concepts of a prompt allows a user to easily and efficiently see the concepts used to generate the automatically-generated visual media, thereby reducing errors in output of the electronic device, and avoiding the need for additional input to correct such errors. It is understood that people use devices. When a person uses a device, that person is optionally referred to as a user of the device.

In some embodiments, an input that is described as a contact is one or a tap input, a multi-tap input, or a long press input. In some embodiments, an input that is described as a selection input is a button press, air tap, tap input, multi-tap or a long press input, or other confirmation input that is detected while attention is directed to a corresponding user interface element.

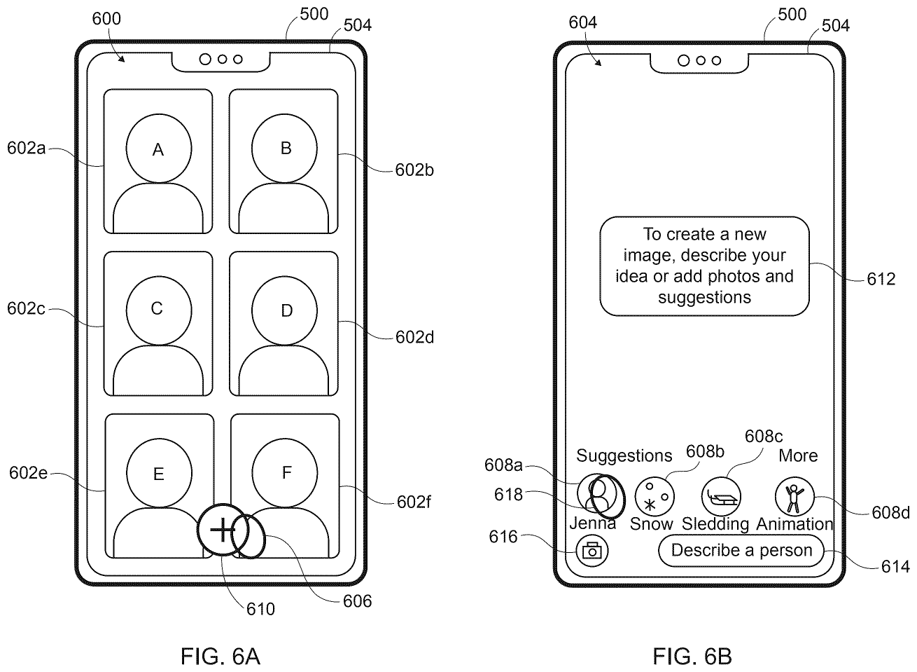

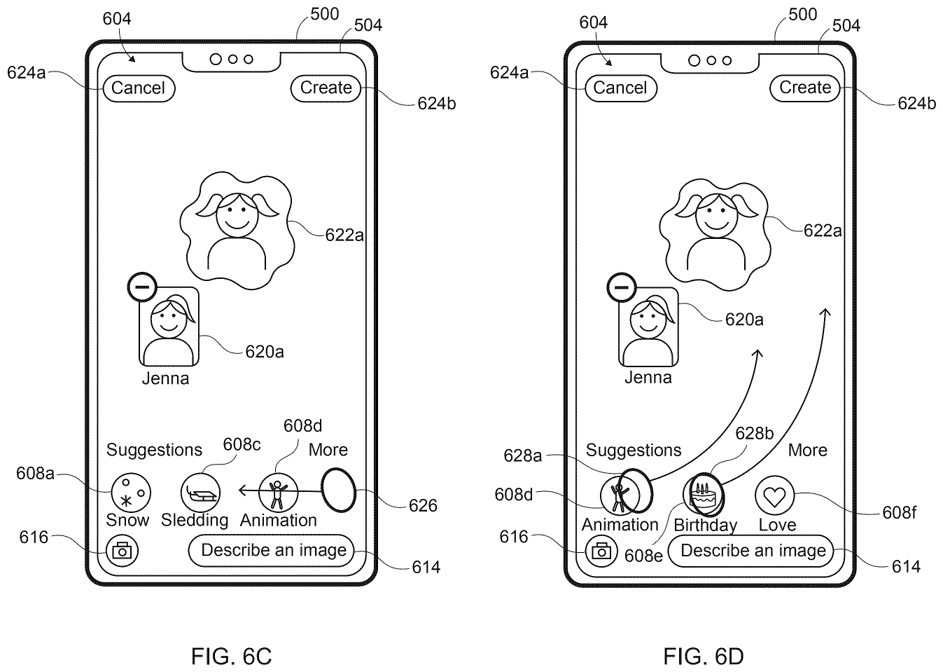

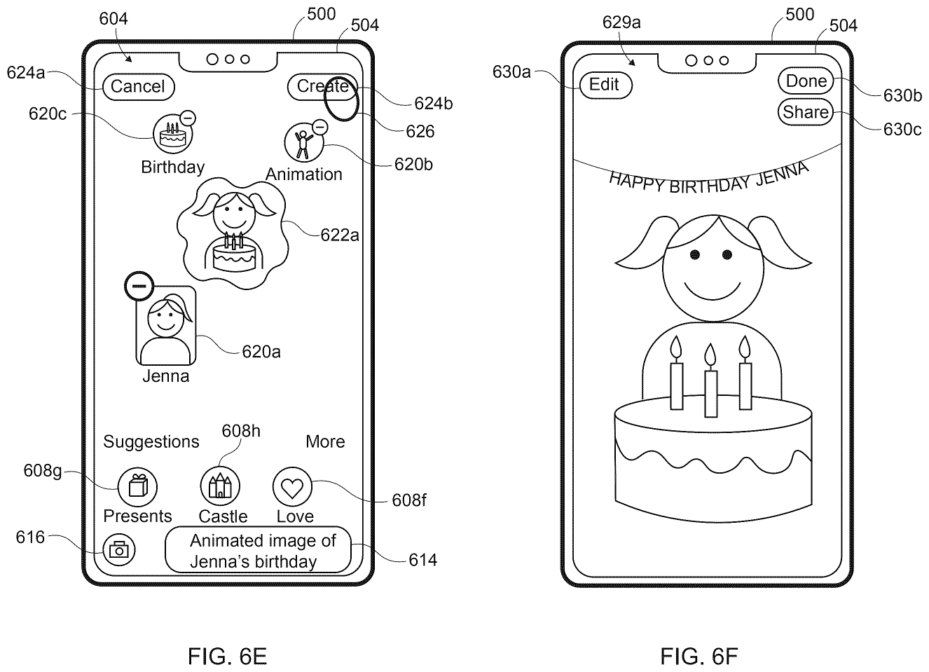

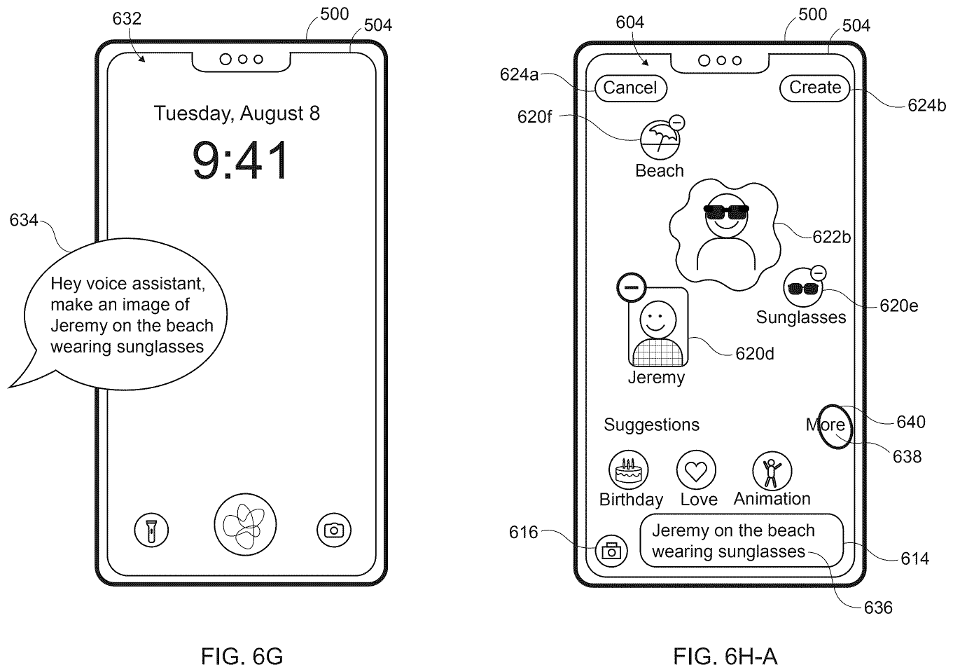

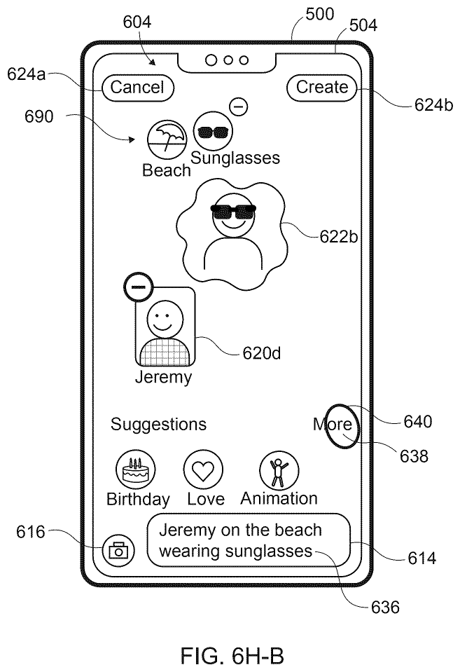

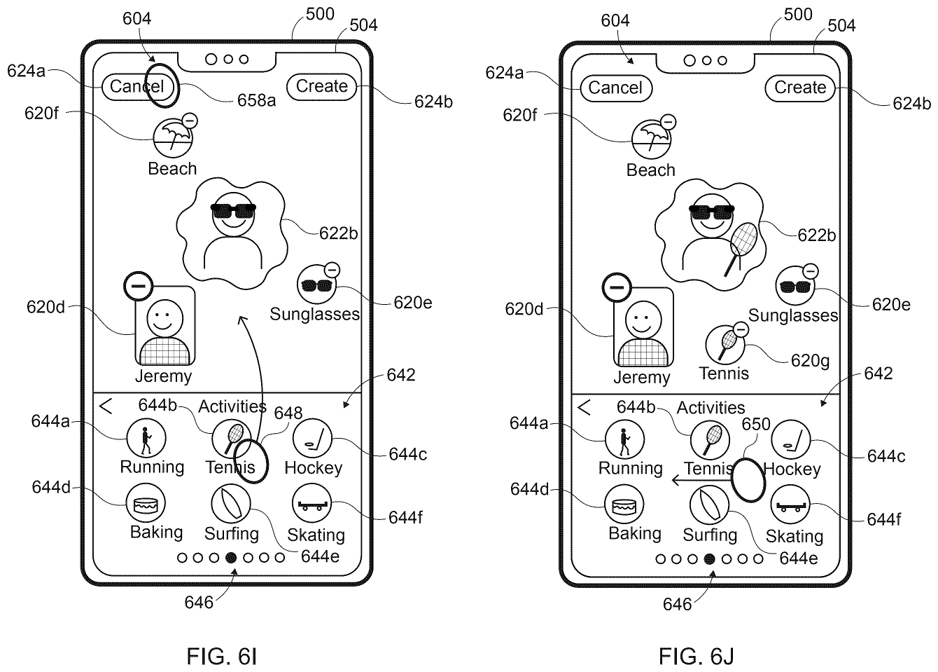

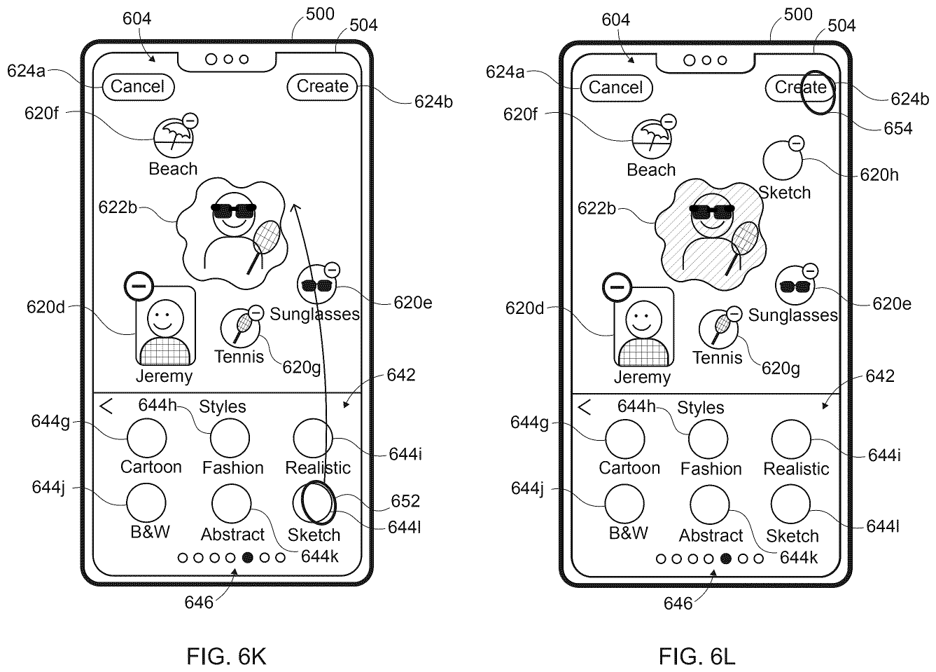

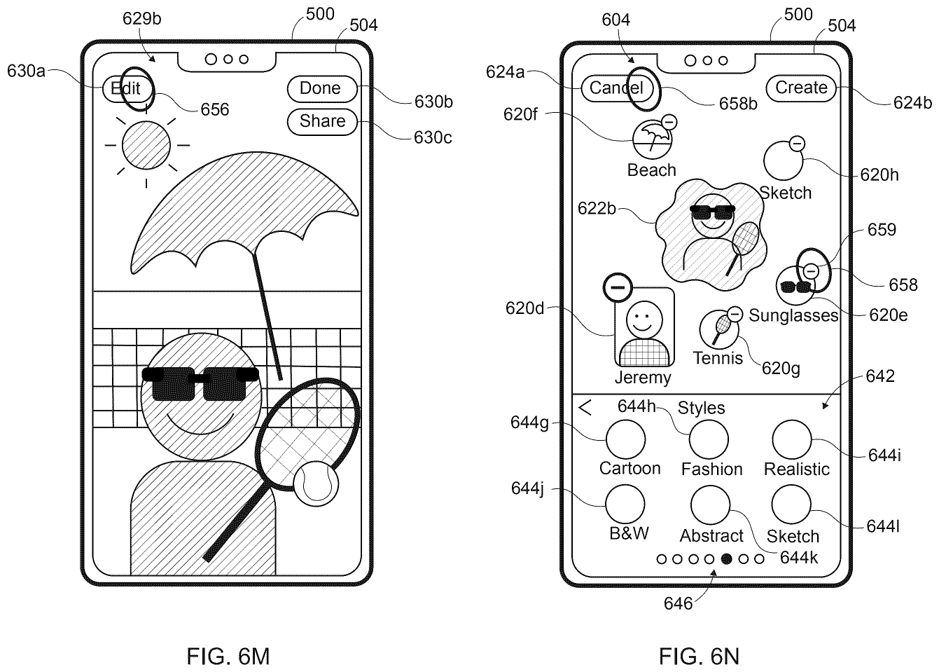

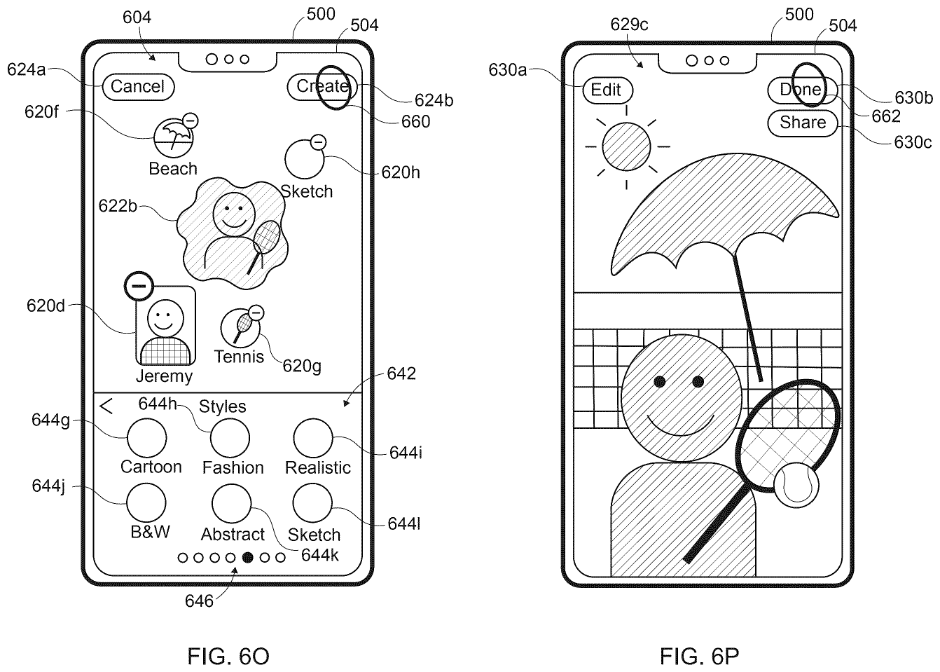

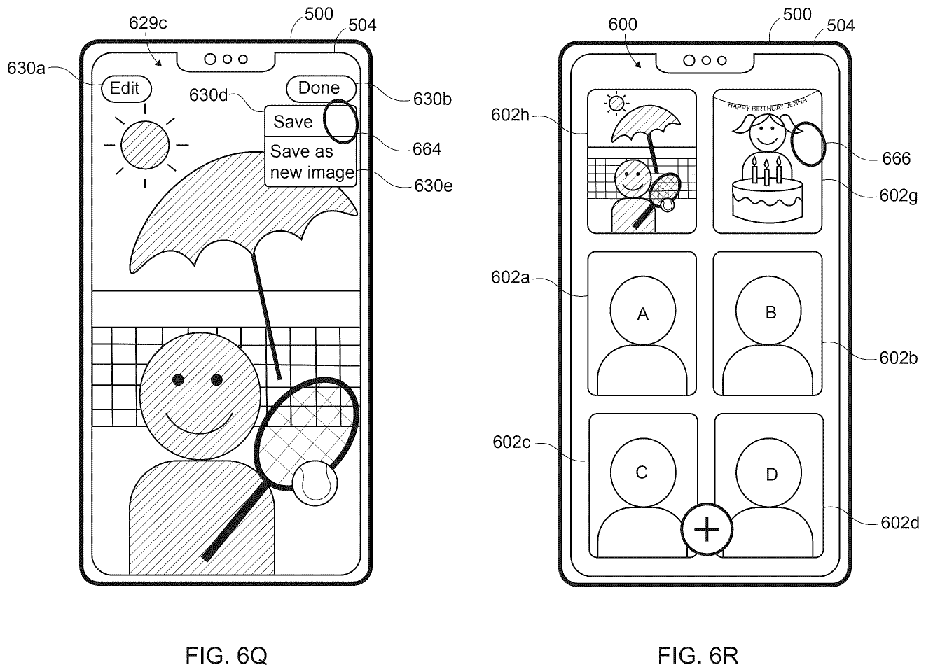

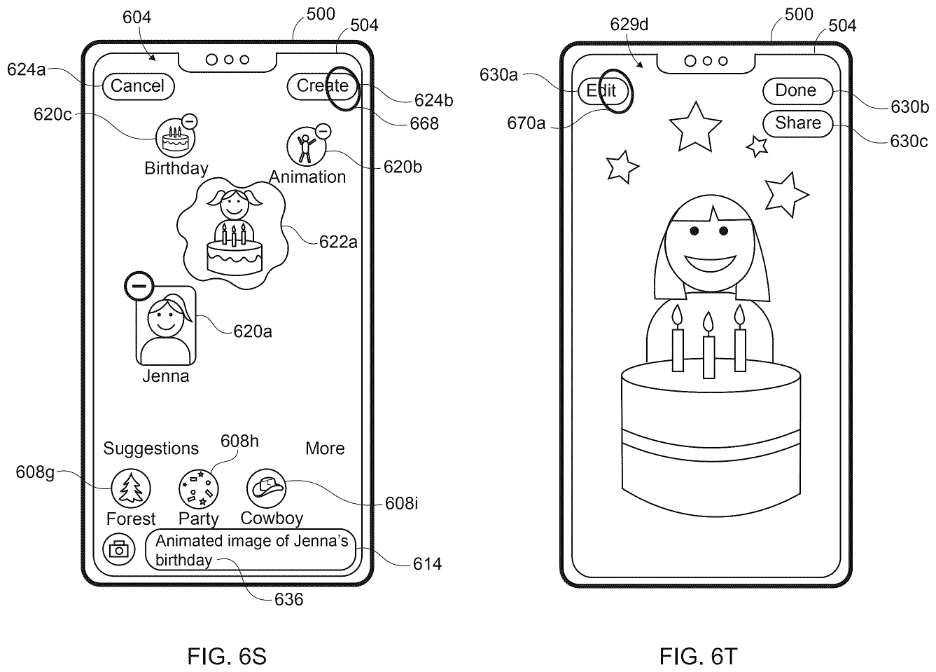

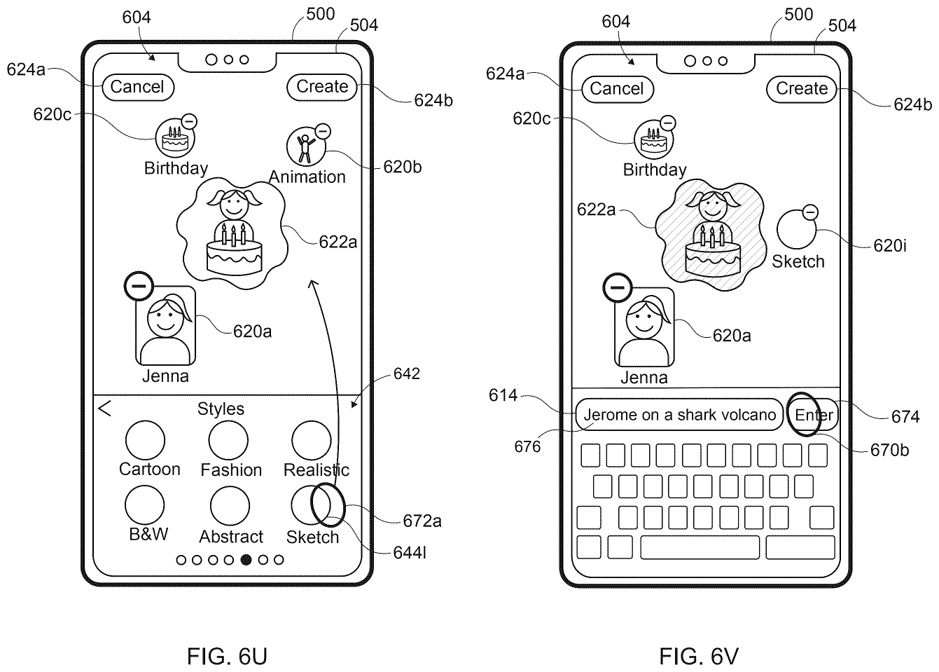

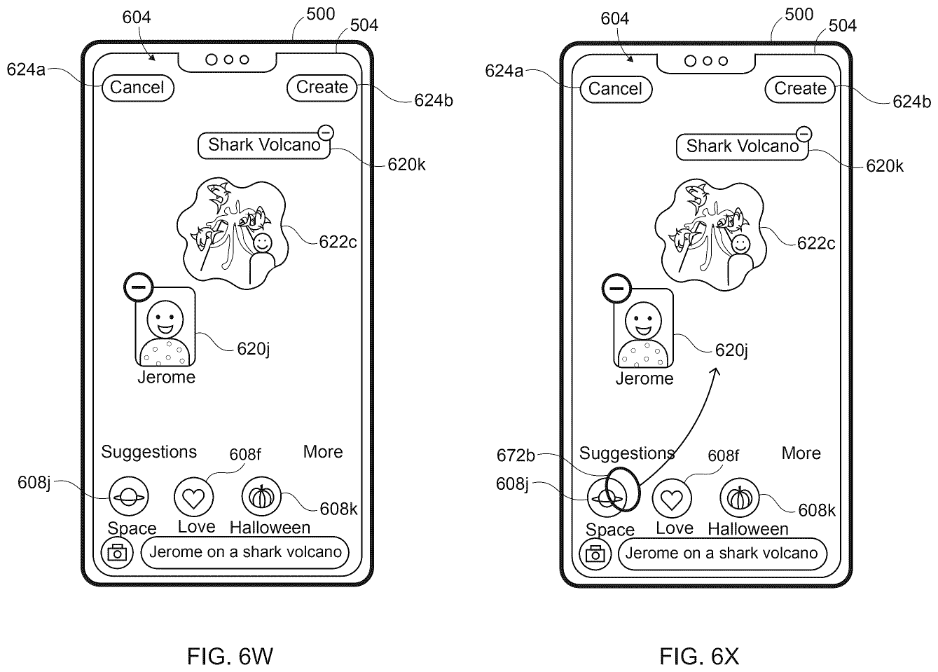

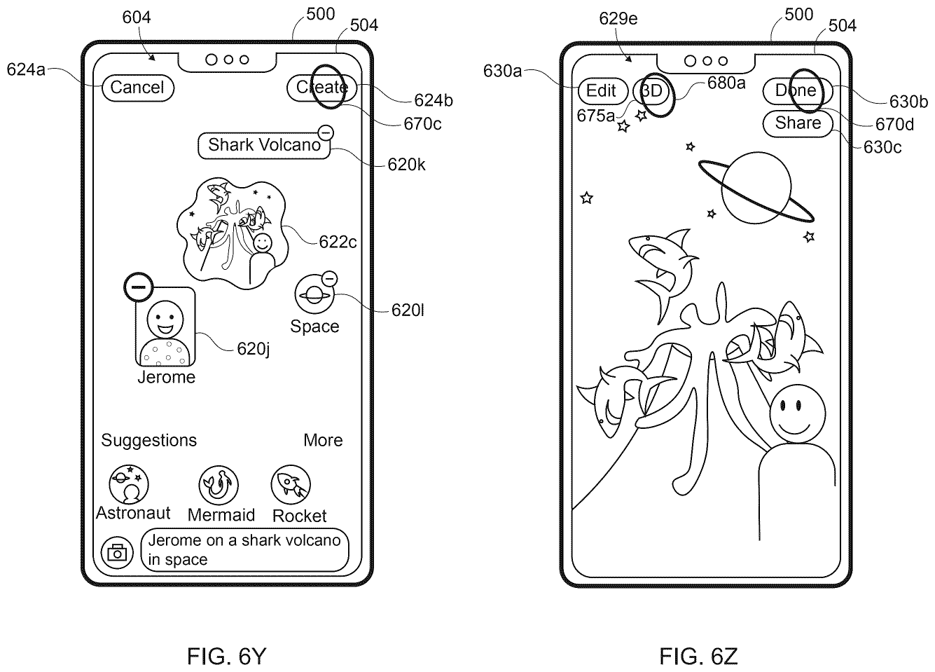

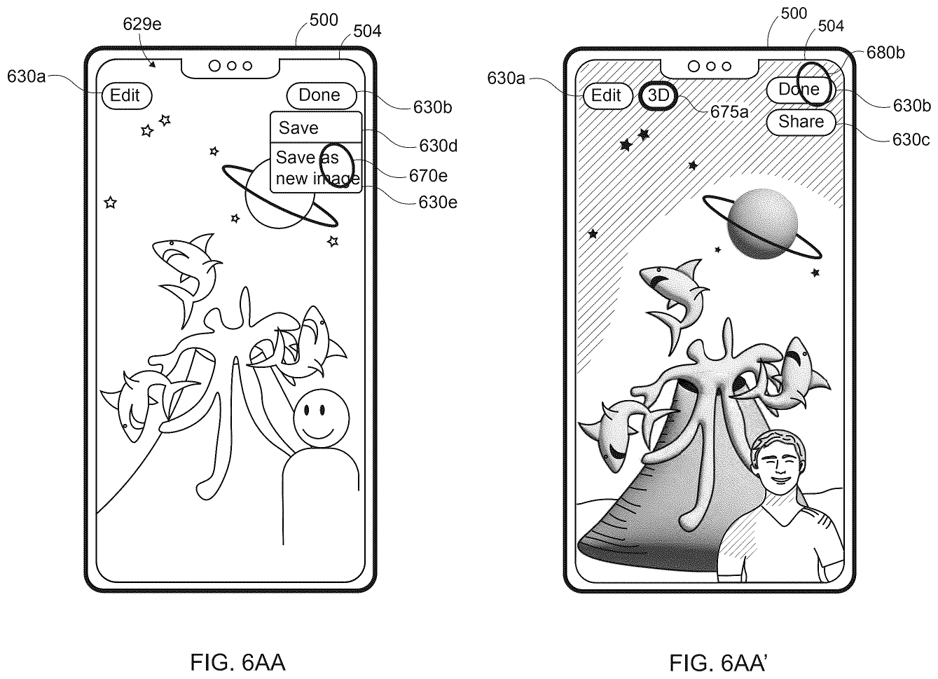

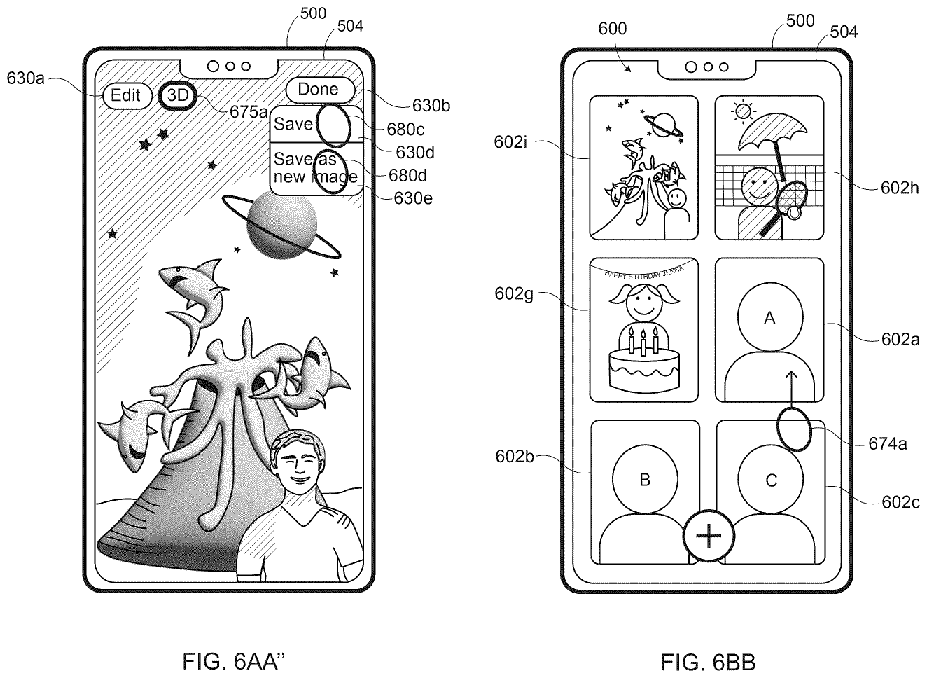

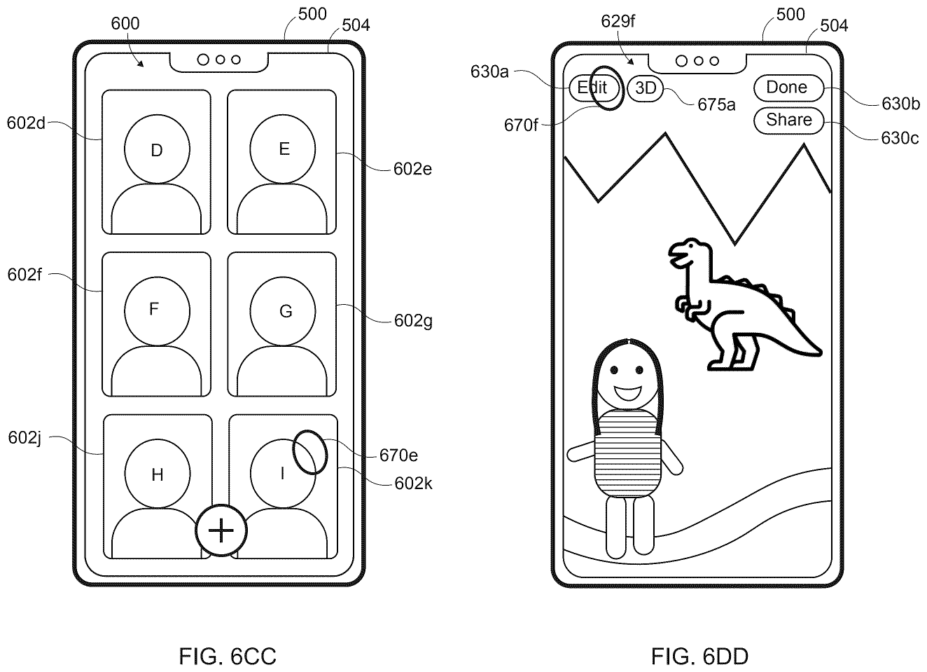

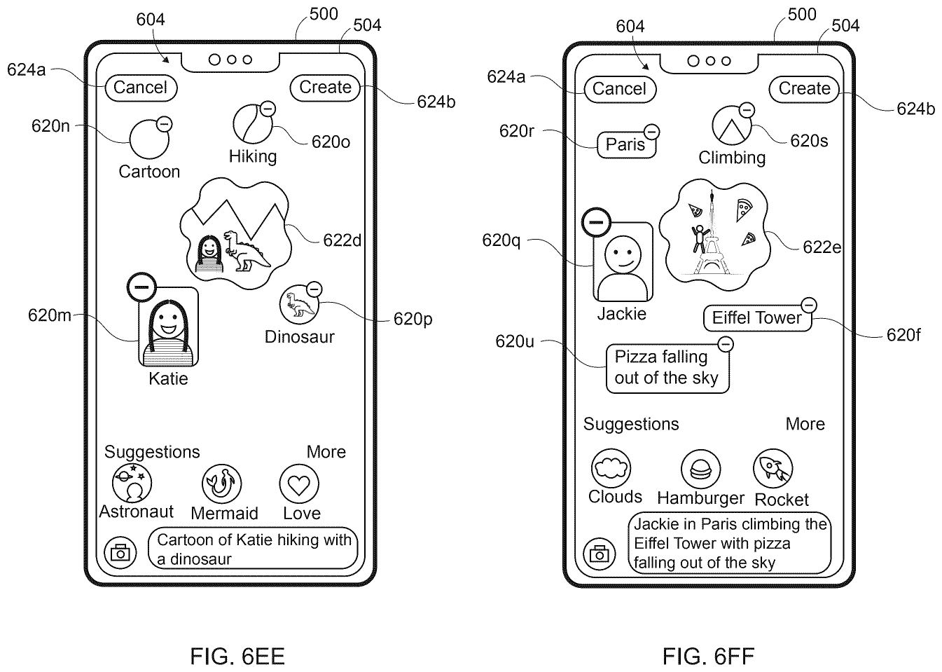

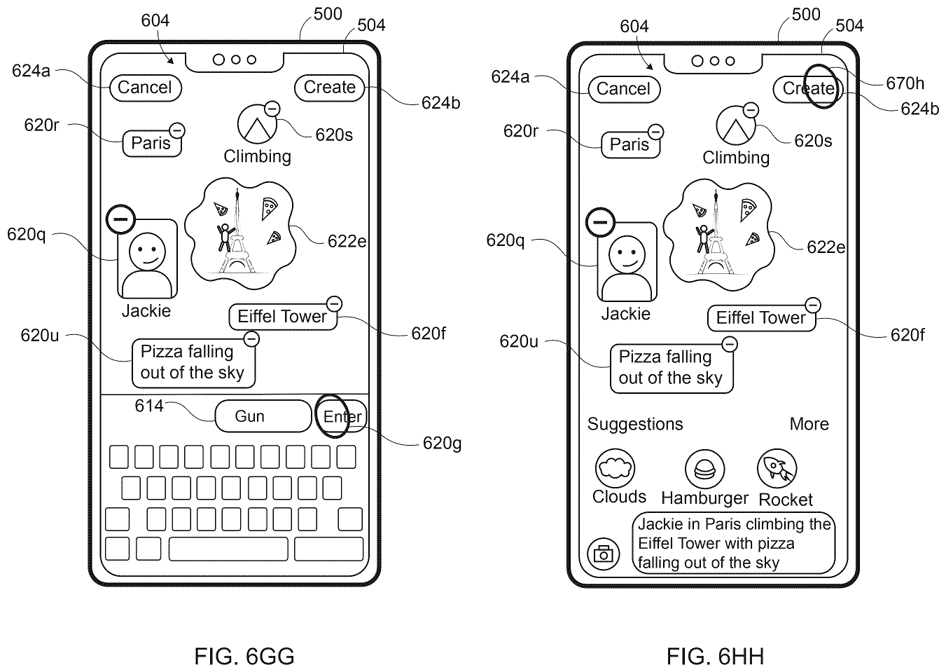

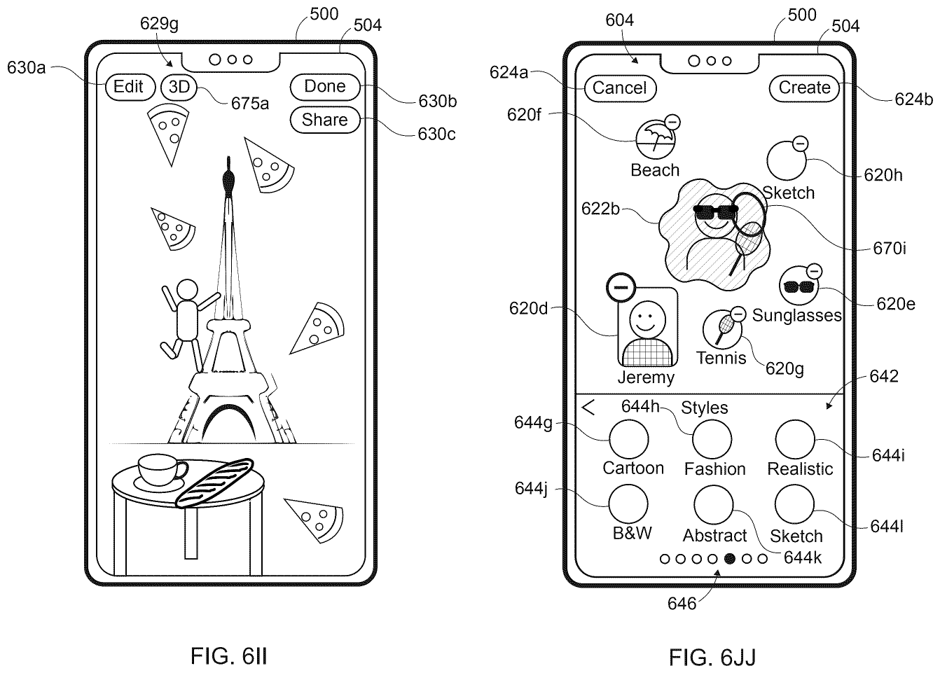

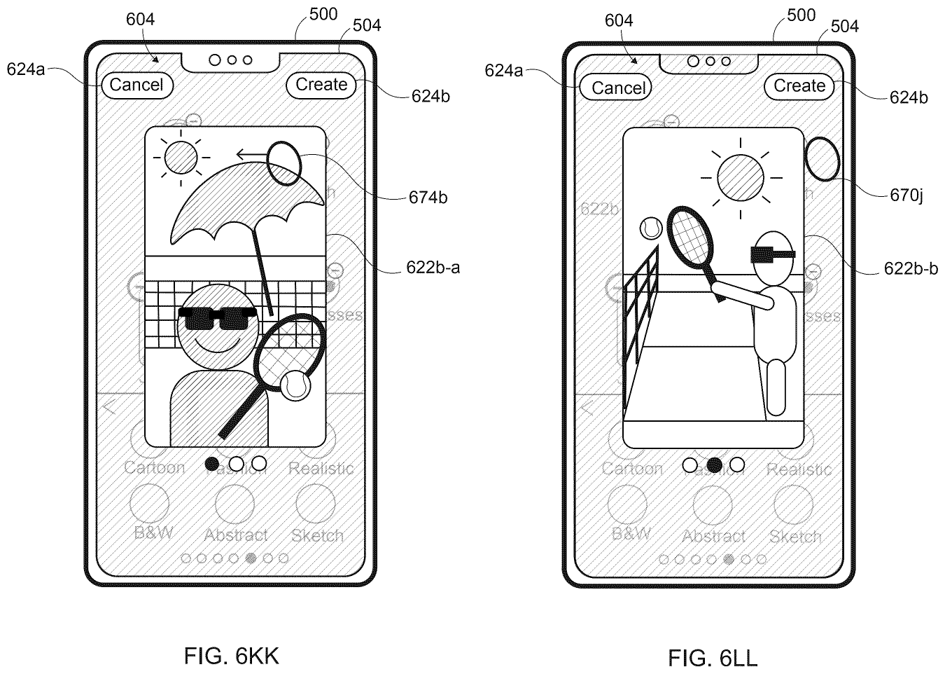

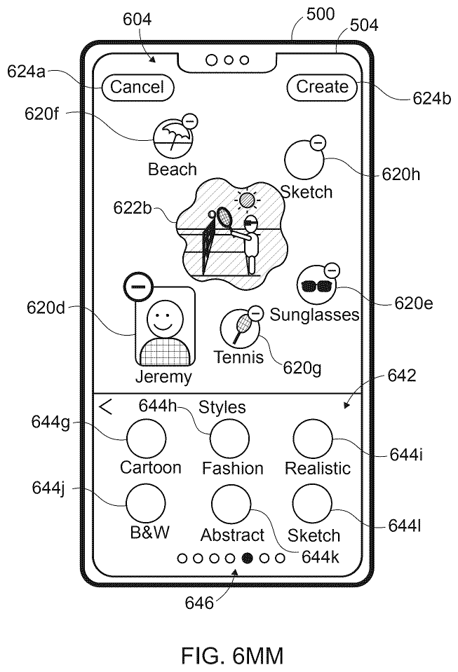

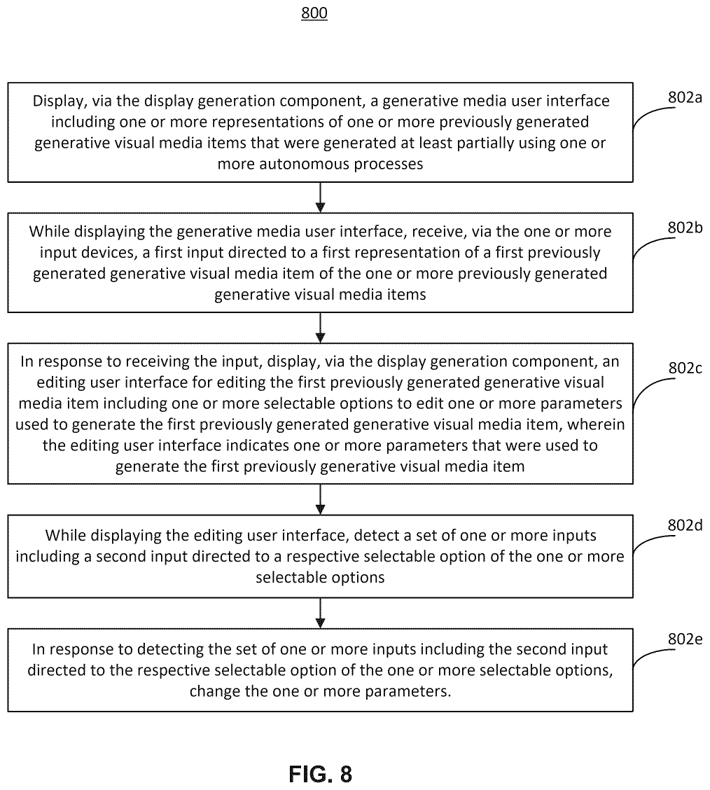

FIGS. 6A-6MM illustrate exemplary ways in which an electronic device displays recognized concepts and generates automatically-generated visual media. The embodiments in these figures are used to illustrate the processes described below, including the processes described with reference to FIG. 7 and FIG. 8. Although FIGS. 6A-6MM illustrate various examples of ways an electronic device is able to perform the processes described below with respect to FIG. 7 and FIG. 8, it should be understood that these examples are not meant to be limiting, and the electronic device is able to perform one or more processes described below with reference to FIG. 7 and FIG. 8 in ways not expressly described with reference to FIGS. 6A-6MM.

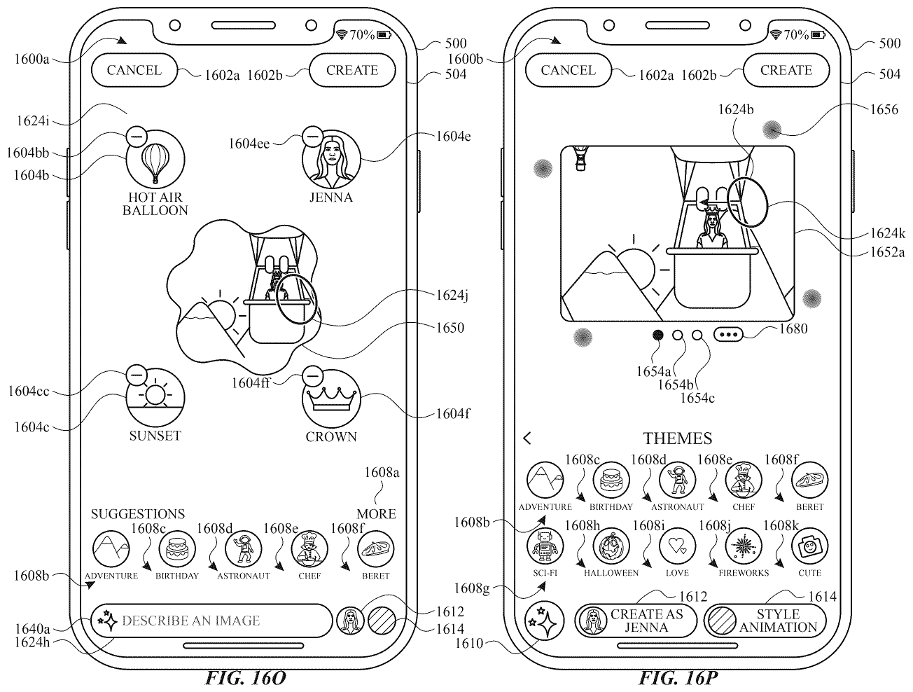

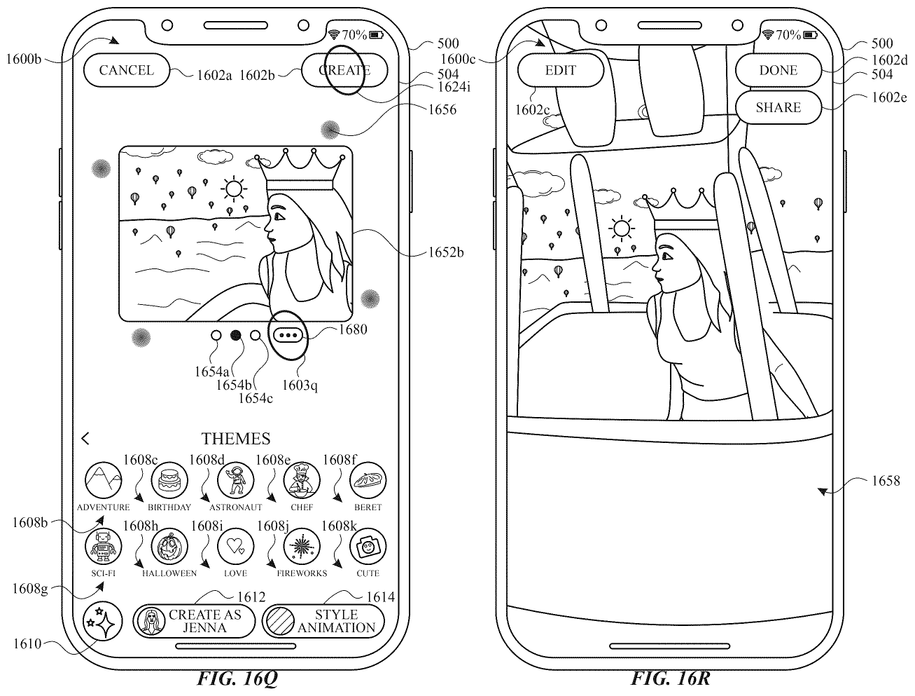

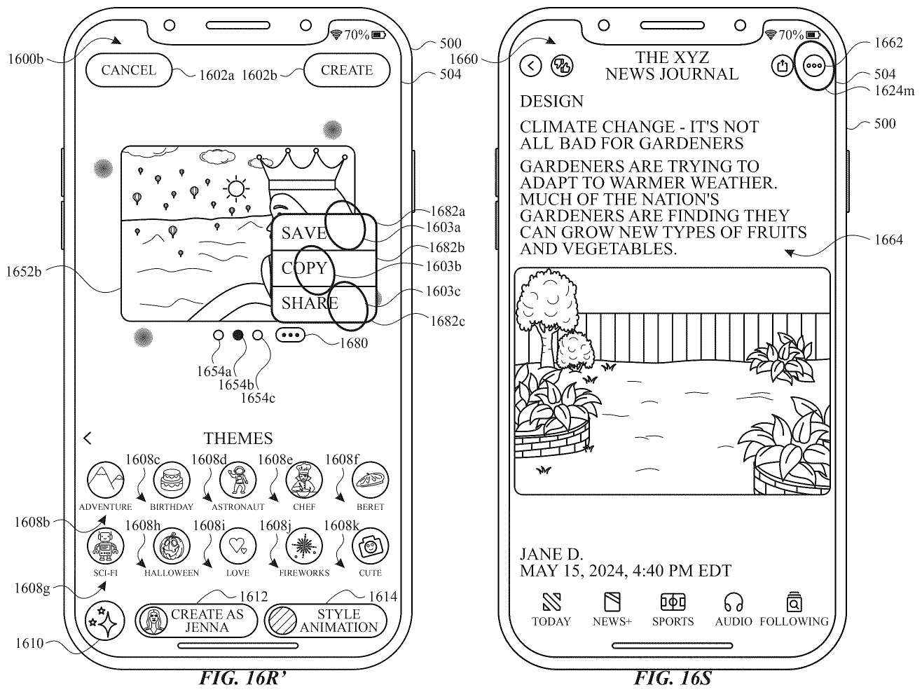

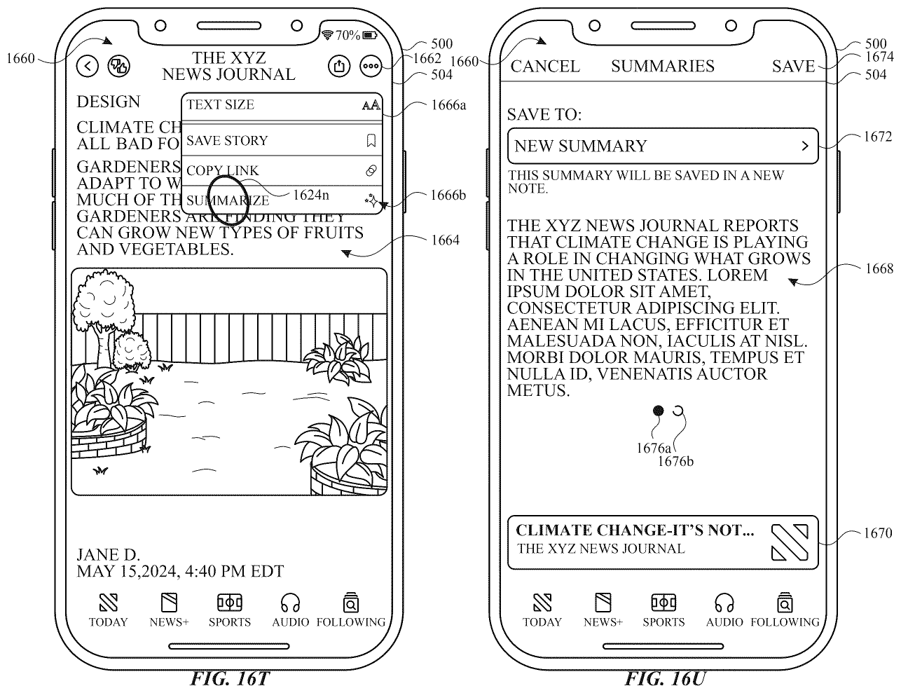

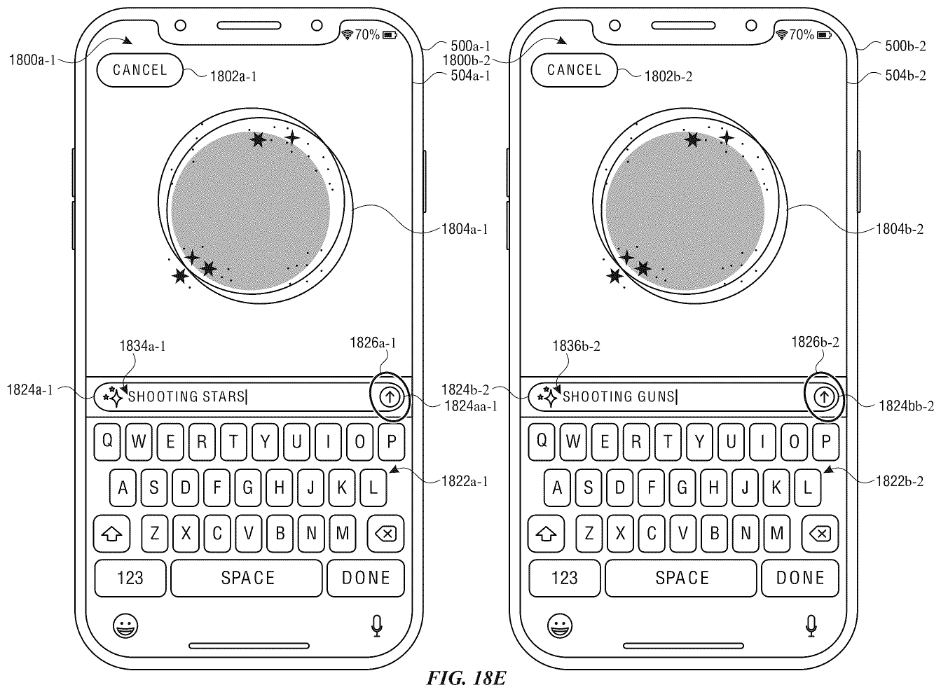

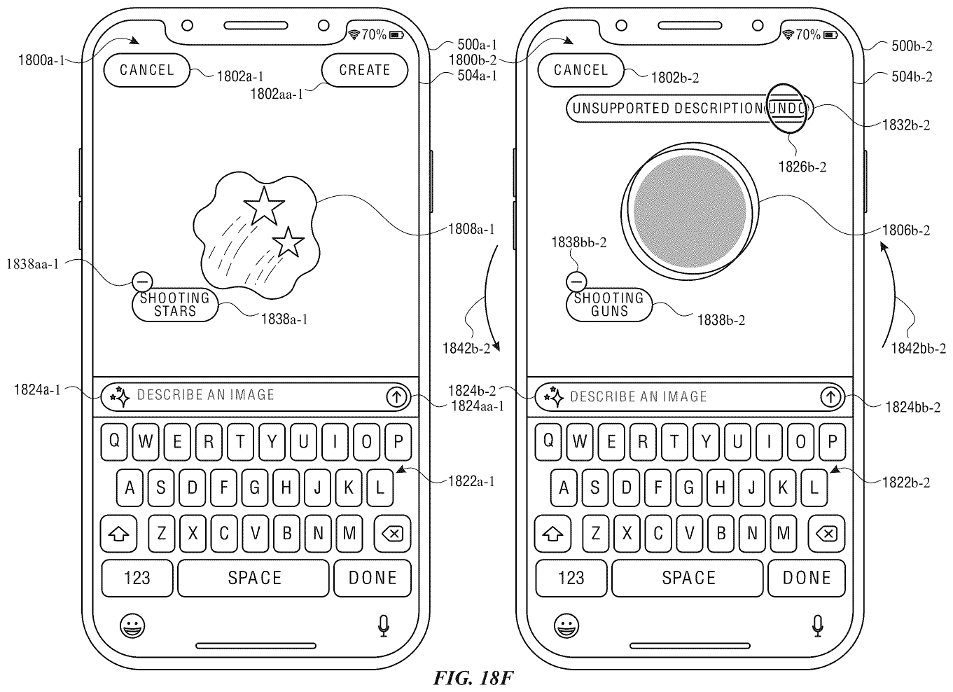

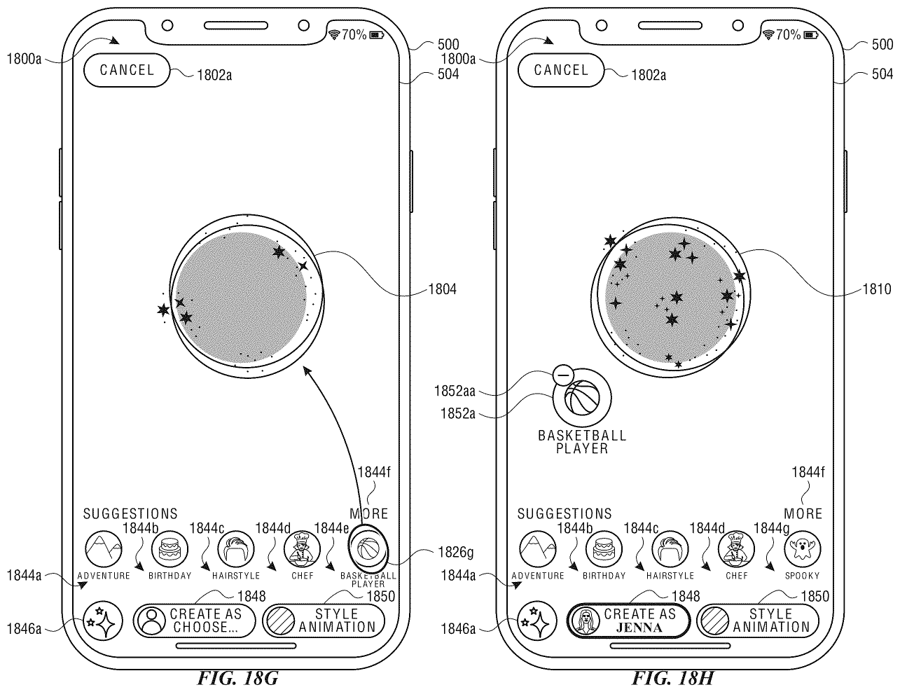

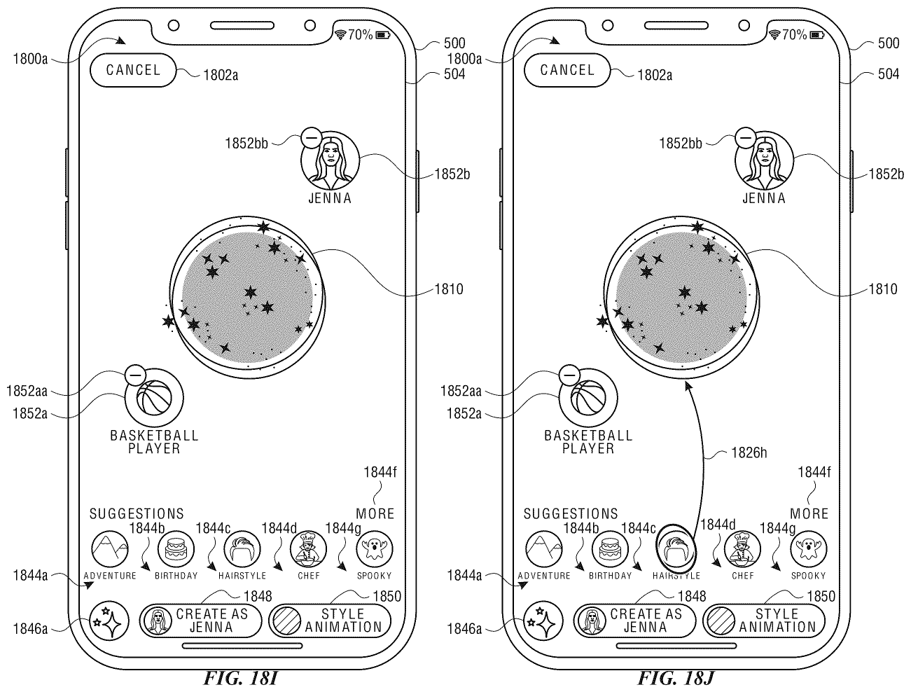

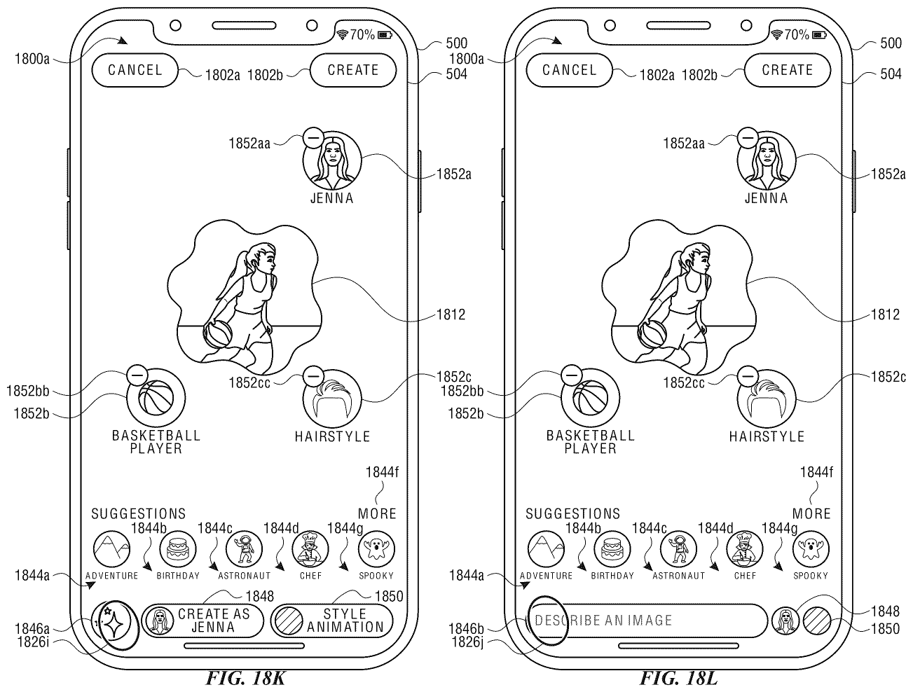

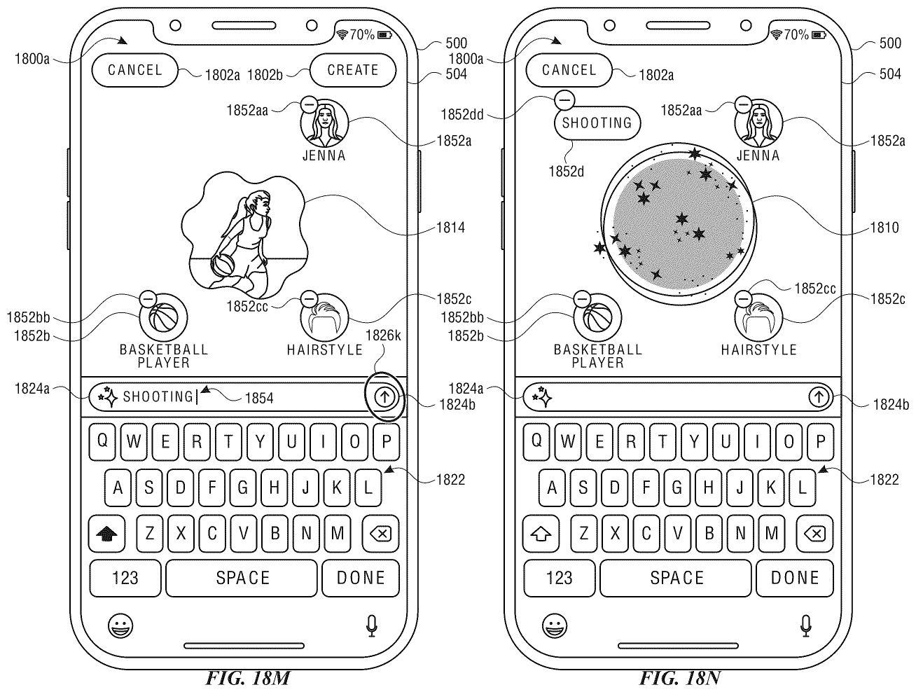

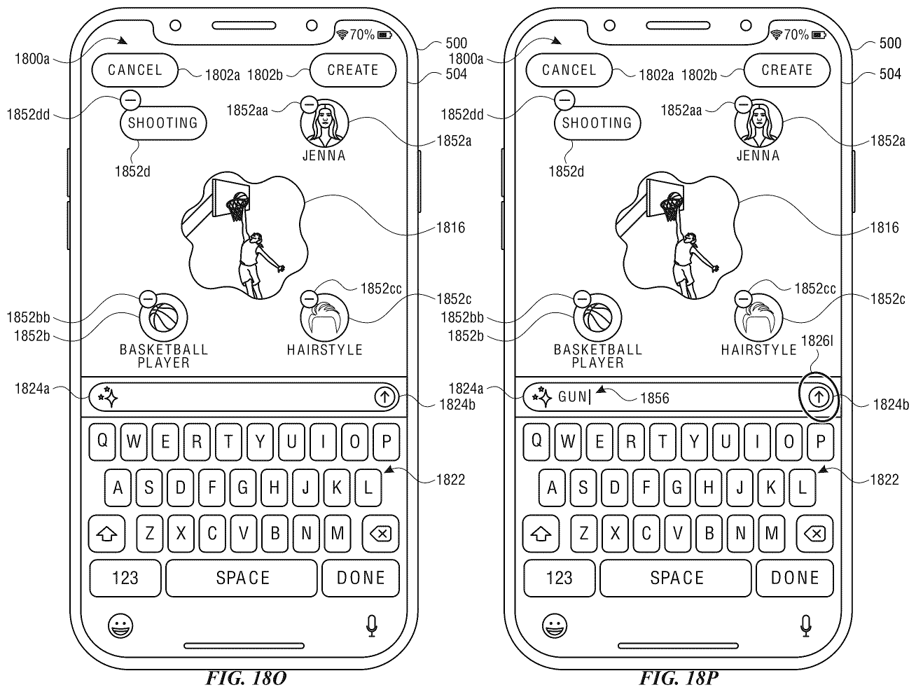

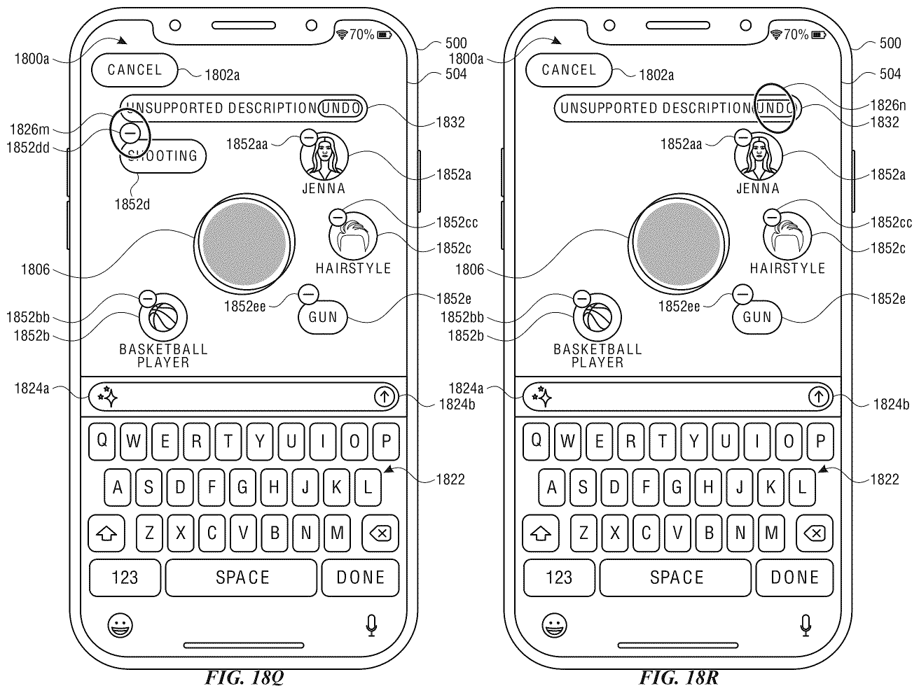

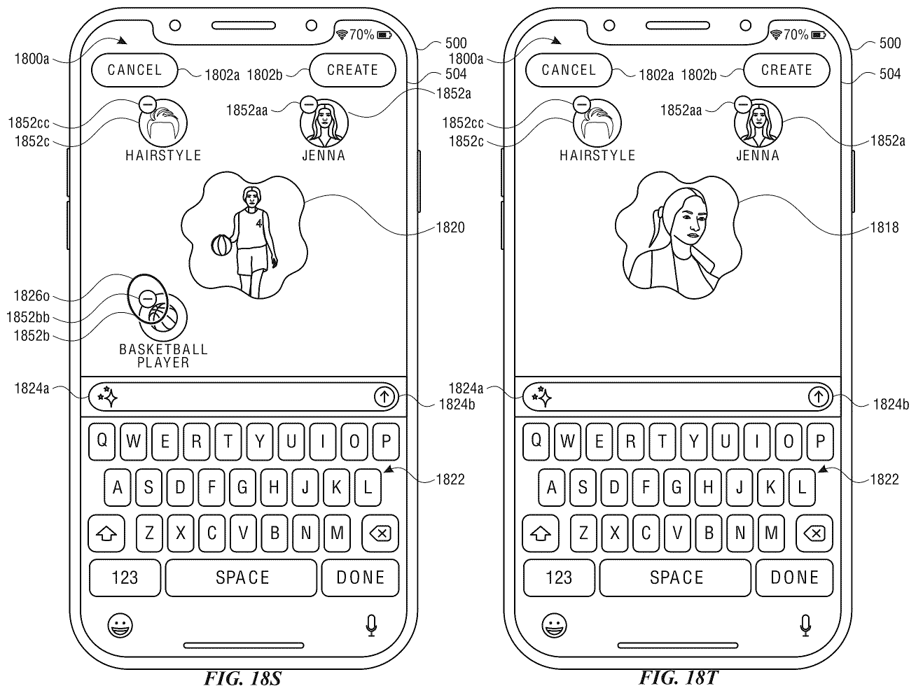

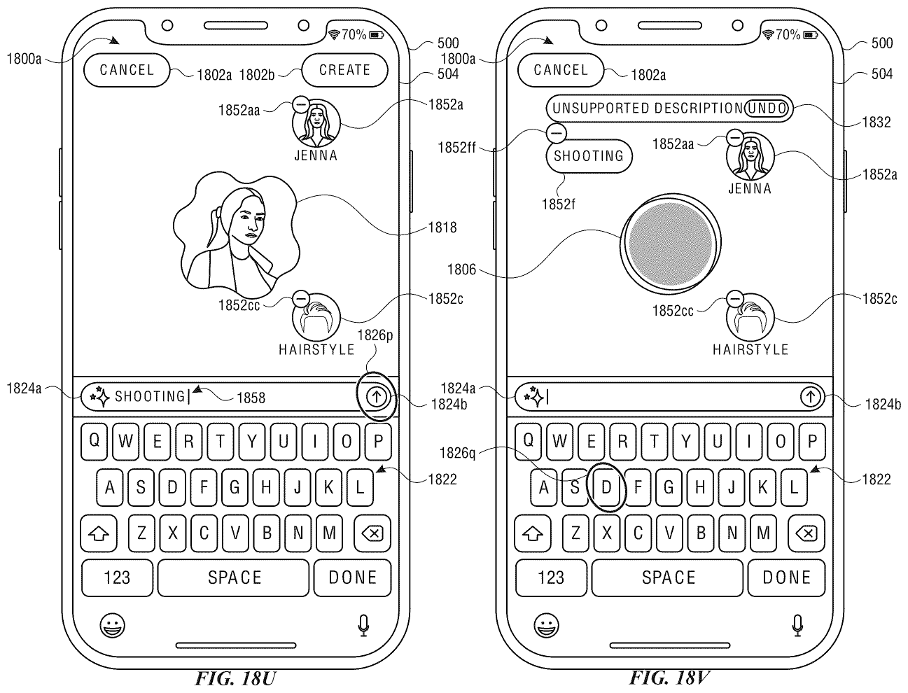

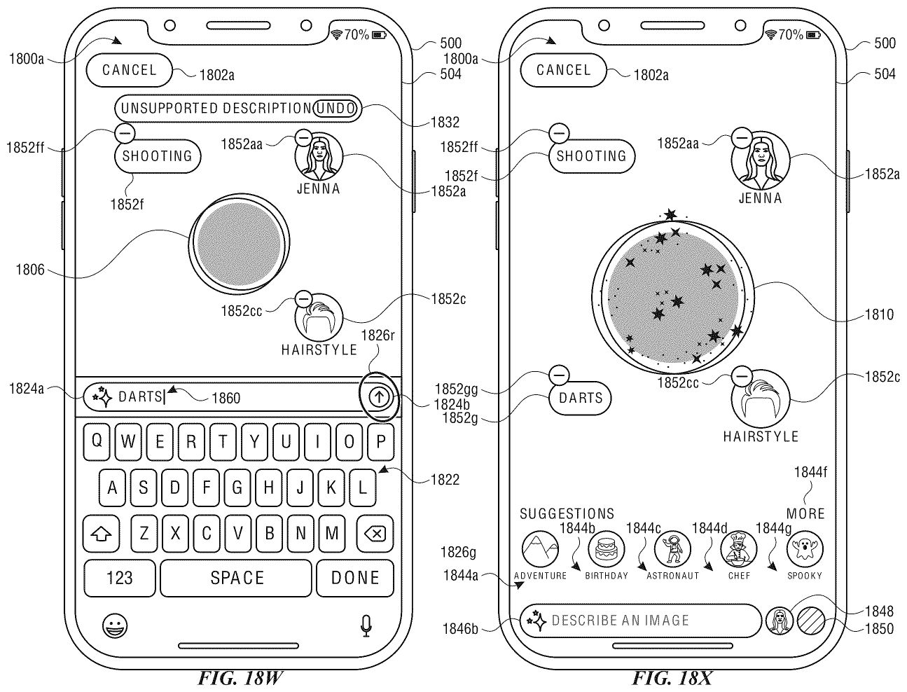

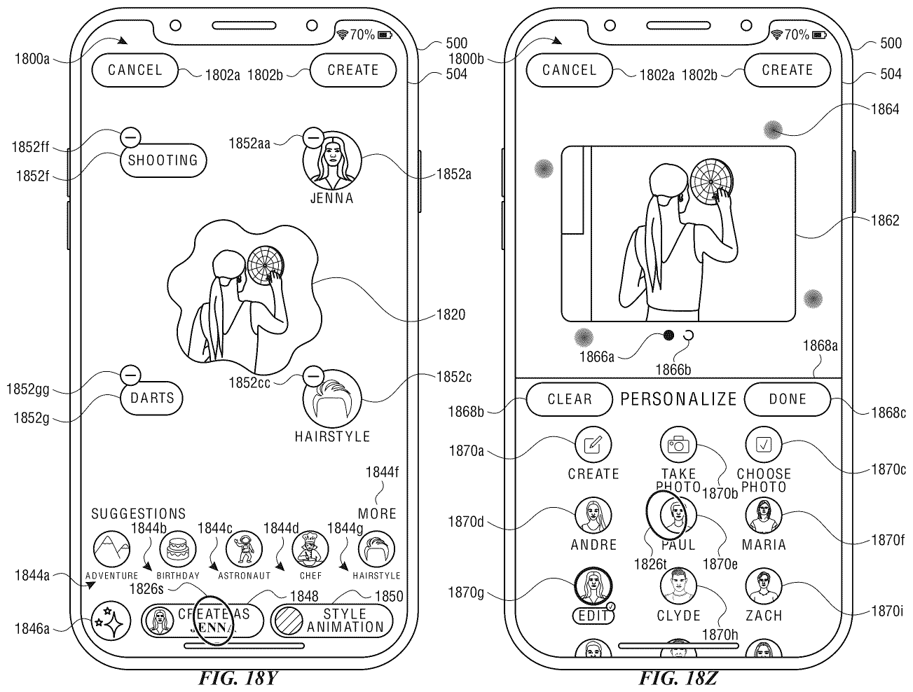

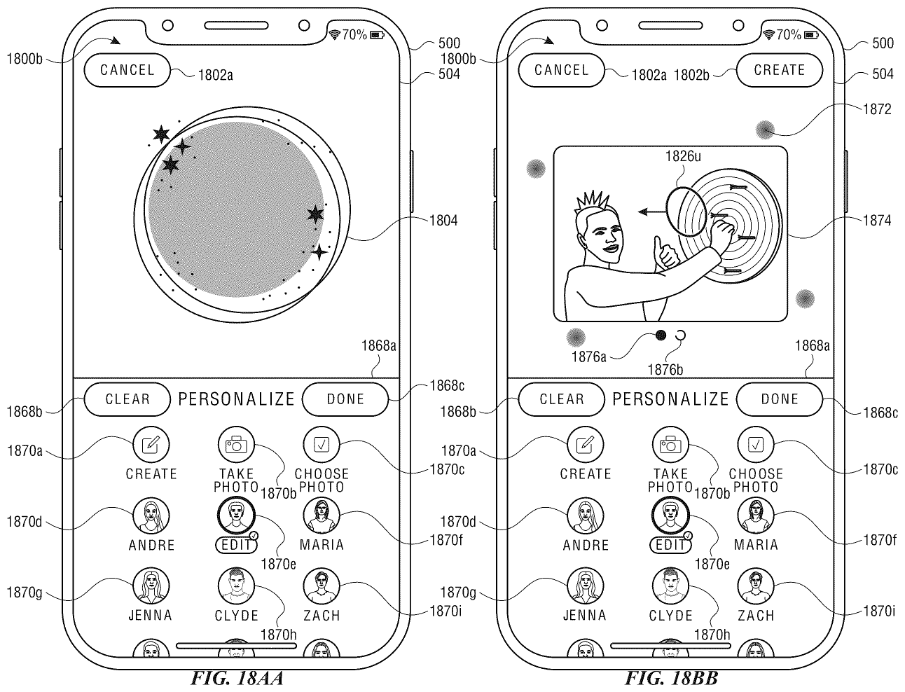

In some embodiments, the user interface of FIGS. 6A-6MM corresponds to the user interface of FIGS. 16A-16U, 18A-18BB, 20D-20AA, 22A-22CCC, 24A-24E, and/or 26A-26P, and user interface elements with corresponding shapes, text, and/or glyphs have the same or similar functions, for example a “cancel” selectable user interface object illustrated in one figure optionally has some or all of the same functions as a “cancel” selectable user interface object in another figure. Similarly, a selectable user interface object with a “+” glyph has some or all of the same functions as a selectable user interface object with a “+” glyph in another figure.

FIG. 6A-6F illustrates embodiments in which the electronic device generates (e.g., using an AI process or a generative AI process) an automatically-generated visual content using the automatically-generated visual media application. FIG. 6A illustrates an electronic device 500 with a display generation component 504 (e.g., a touchscreen). In some embodiments, the electronic device 500 is a mobile device, such as a smartphone, tablet, or wearable device. In FIG. 6A, the electronic device 500 displays user interface 600 that includes a gallery of automatically-generated visual content. The gallery of automatically-generated visual content includes automatically-generated visual content 602a through 602f. In some embodiments, the visual content 602a through 602f represent sample automatically-generated visual content. For example, the electronic device 500 provides examples of automatically-generated visual content in user interface 600 before the user has generated automatically-generated visual content. In FIG. 6A, user interface 600 also includes a selectable option 610 that, when selected, causes the electronic device 500 to start the process to generate an automatically-generated visual media.

While displaying user interface 600 in FIG. 6A, the electronic device 500 receives a selection input (e.g., a tap or long press input) including contact 606 (e.g., a touch input using a finger) directed towards selectable option 610. As a result, the electronic device 500 displays user interface 604, shown in FIG. 6B. FIG. 6B illustrates a user interface that receives a prompt, starting media, and/or recognized concepts for use in generating automatically-generated visual content. Examples of prompts, recognized concepts, and starting media are described in further detail in method 700. Although touch inputs including contacts are used in the embodiments described here as example inputs, other inputs are possible including voice, hardware input device inputs, and/or air gesture inputs.

In FIG. 6B, the user interface 604 includes a visual indication 612 including text describing the generative visual content process. For example, to create an automatically-generated visual content, the user first needs to input a starting image and/or a prompt and/or recognized concept. In FIG. 6B, user interface 604 also includes selectable options 608a through 608d, which, when selected, cause the electronic device 500 to add recognized concepts (e.g., including starting media) to an automatically-generated visual content. In some embodiments, selectable options 608a through 608b are suggested by the electronic device (e.g., at random or they are frequently used recognized concepts). In some embodiments, selectable options 608a through 608d include text describing the recognized concept and icons including visual representations of the recognized concept. For example, selectable option 608a includes a representation of “Jenna” and the text “Jenna”, selectable option 608b includes an icon of snowflakes and text “Snow”, selectable option 608c includes an icon of a sled and text “Sledding”, and selectable option 608d (e.g., representing a style recognized concept, as described in method 700) includes an icon of a person dancing and text “Animation”. Additionally, in FIG. 6B, the user interface 604 includes a selectable option 616 that, when selected, causes the electronic device 500 to open a camera application or a photo library to select starting media, and a text input region 614 for receiving a prompt, both of which are described in further detail in method 700.

While displaying user interface 604 in FIG. 6B, the electronic device 500 receives a selection input (e.g., a tap or long press input) including contact 618 (e.g., a touch input using a finger or a gaze input using a user's eyes) directed towards selectable option 608a, which is a starting media recognized concept of “Jenna”. In some embodiments, the electronic device has one or more images of Jenna (e.g., in a photos library or other content application), which were used to create the representation of Jenna shown in selectable option 608a. As a result of detecting the input, the electronic device displays “Jenna” as a recognized concept in user interface 604, as shown in FIG. 6C, which is now being used to influence the generation of the automatically-generated visual content.

FIG. 6C illustrates user interface 604 after the user has initiated the process to generate an automatically-generated visual content (e.g., by selecting starting media). As described in method 700, the user optionally selects starting media using the suggestions (shown in FIG. 6B) of recognized concepts and/or by choosing an image from a camera application and/or a photo library (e.g., by receiving an input directed towards selectable option 616). After initiating the process, the electronic device 500 displays the starting media as a recognized concept 620a, shown in FIG. 6C. After initiating the process, the electronic device 500 also displays a representation 622a of the automatically-generated visual content. The representation of the automatically-generated visual content is described in further detail in method 700. The representation of the automatically-generated visual content is a preview of the automatically-generated visual content. The user interface 604 also includes selectable options 624a through 624b. In some embodiments, selectable option 624a, when selected, causes the electronic device 500 to end (e.g., cancel) the process to generate an automatically-generated visual content, and selectable option 624b, when selected, causes the electronic device 500 to generate the automatically-generated visual content, as described below. Selectable option 624a optionally corresponds to selectable option 1602a, 1802a, and/or 2202a in FIGS. 16A-16U, 18A-18BB, 20D-20AA, 22A-22CCC, and/or 26A-26P. Selectable option 624b optionally corresponds to selectable option 1602b, 1802b, and/or 2202b in FIGS. 16A-16U, 18A-18BB, 20D-20AA, 22A-22CCC, and/or 26A-26P.

While displaying the user interface 604 in FIG. 6C, the electronic device 500 receives a swipe input including contact 626 (e.g., a drag motion using a finger in contact with the touch screen) directed towards the recognized concept suggestions. In response to receiving the input, the electronic device displays additional recognized concepts suggestions (e.g., selectable options 608e through 608f), shown in FIG. 6D.

While displaying the additional selectable options 608e through 608f, the electronic device 500 receives a drag input using contacts 628a through 628b (e.g., a dragging motion using a finger remaining in contact with the touch screen) directed towards dragging selectable options 608d and 608e, respectively, to be used to influence generation of the automatically-generated visual content. As a result, the electronic device 500 displays selectable options 608d and 608e as recognized concepts 620b and 620c, respectively, in FIG. 6E. Alternatively, in some embodiments, the electronic device 500 receives a selection input towards selectable option 608d and 608e to add them as recognized concepts.

FIG. 6E illustrates user interface 604 including recognized concepts 620a through 620c. In response to receiving the input in FIG. 6D to add selectable options 608d and 608e as recognized concepts, the electronic device 500 updates the representation 622a of the automatically-generated visual content to include the additional recognized concepts, as described further in method 700. In some embodiments, in response to receiving the input selecting the option 608d, the electronic device 500 updates the user interface 604 including representation 622a to include the recognized concept associated with option 608d, and in response to receiving the input selecting the option 608e, the electronic device 500 updates the user interface 604 including representation 622a to include the recognized concept associated with option 608e. In some embodiments, the boundary of the representation 622a is animated, as described in method 700. As shown in FIG. 6E, the boundary of the representation 622 is blob shape, and in some embodiments, the shape is animated. Additionally, in response to receiving the input in FIG. 6D, the electronic device replaces the selectable options 608d and 608e with additional selectable options 608g and 608h corresponding to recognized concepts different from those corresponding to options 608d and 608e, as shown in FIG. 6E.

While displaying the user interface 604 in FIG. 6E, the electronic device 500 receives a selection input, (e.g., a tap or a long press) including contact 626, directed towards selectable option 624b, that when selected causes the electronic device to generate the automatically-generated visual content. In response to receiving the input in FIG. 6E, the electronic device 500 ceases to display user interface 604 and displays user interface 629a, shown in FIG. 6F. In some embodiments, user interface 629a includes the automatically-generated visual content that is optionally higher fidelity than the representation 622a, described in further detail in method 700.

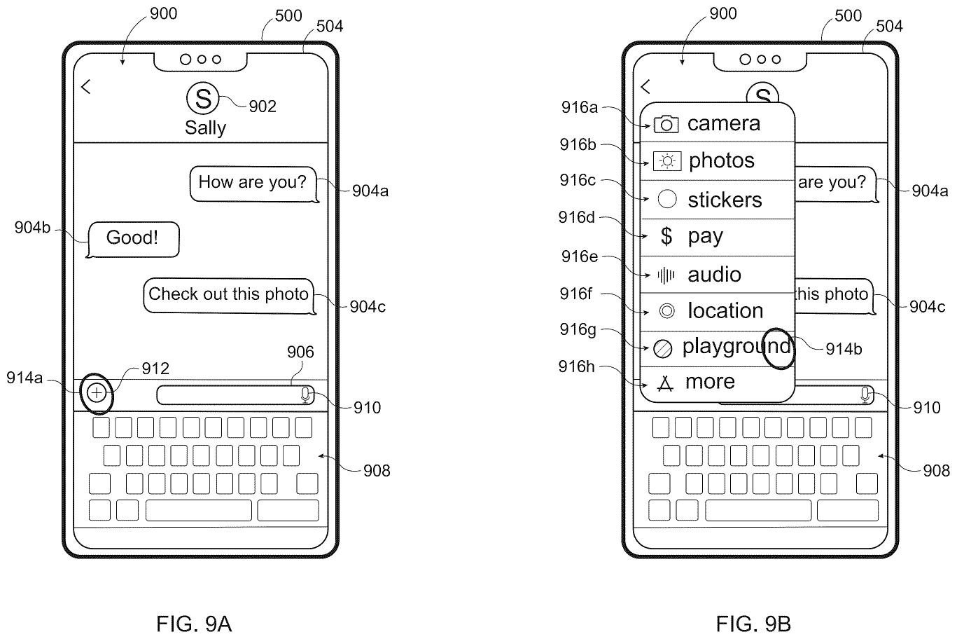

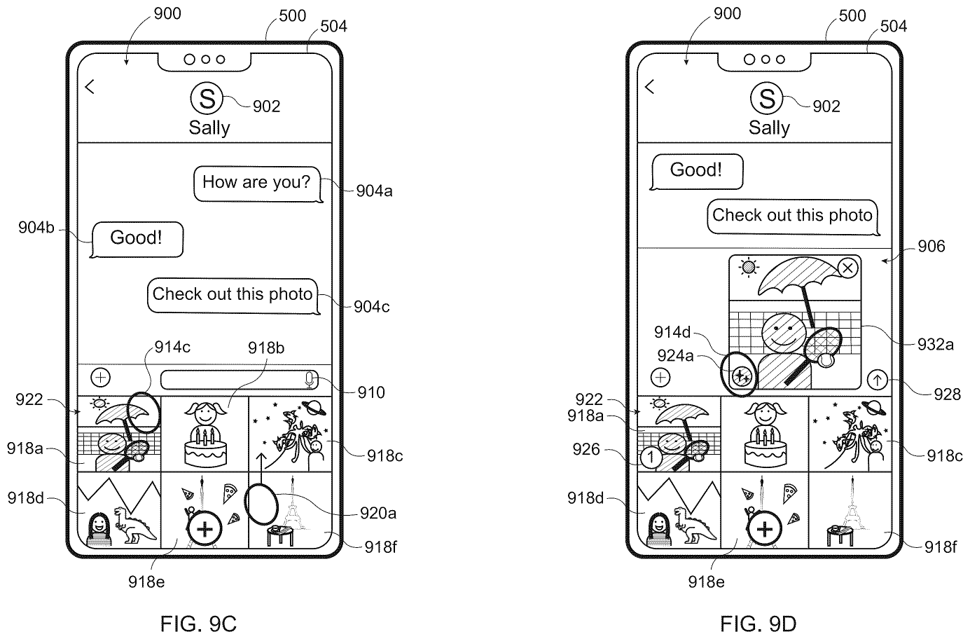

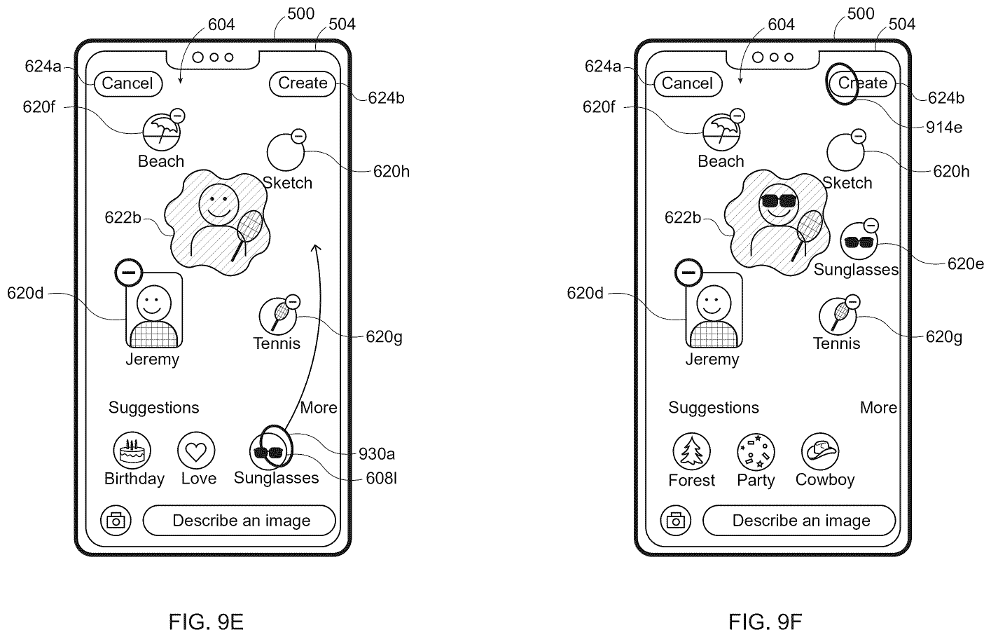

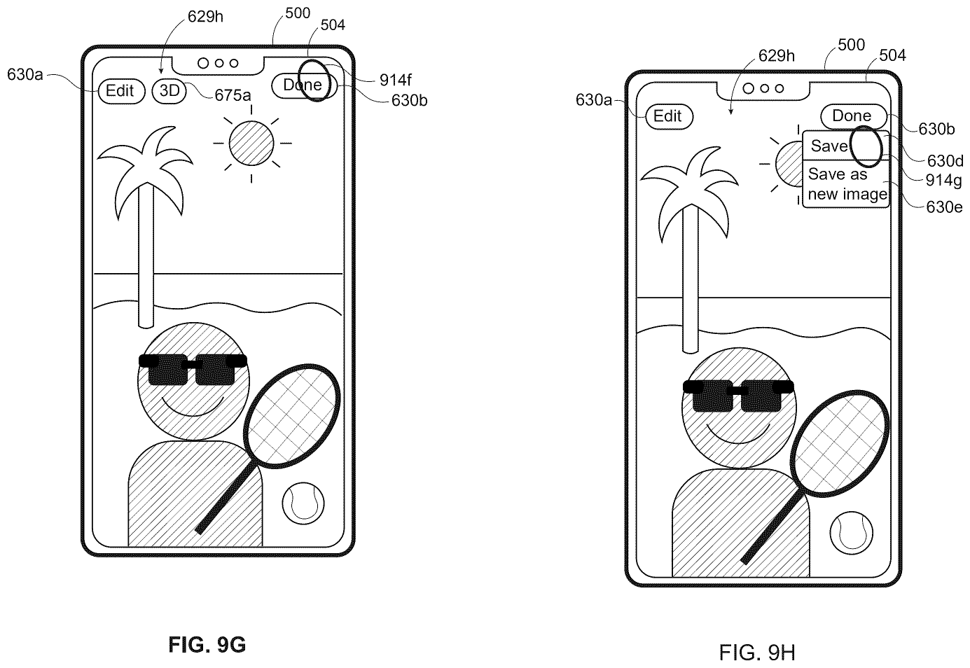

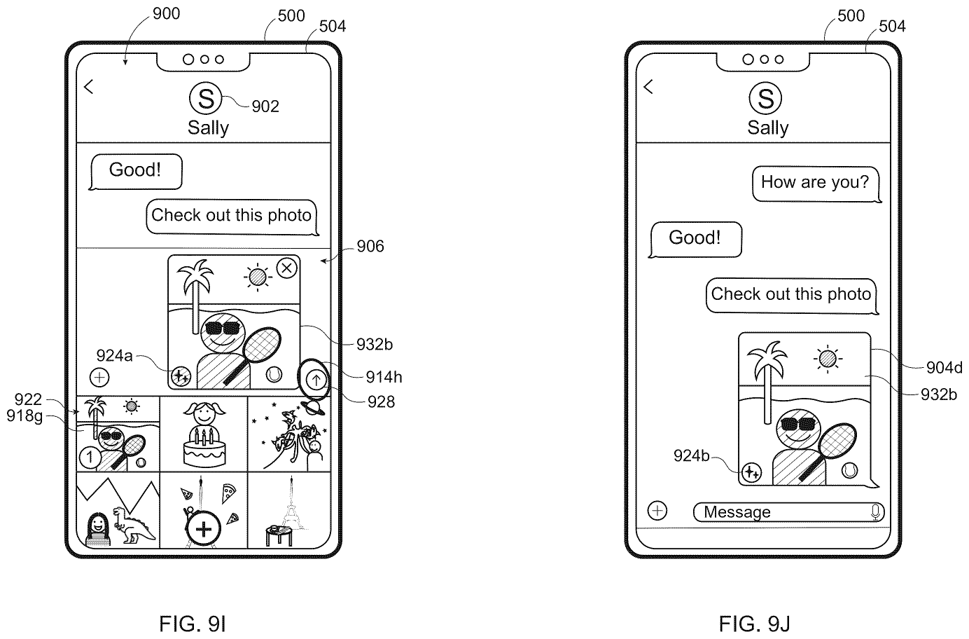

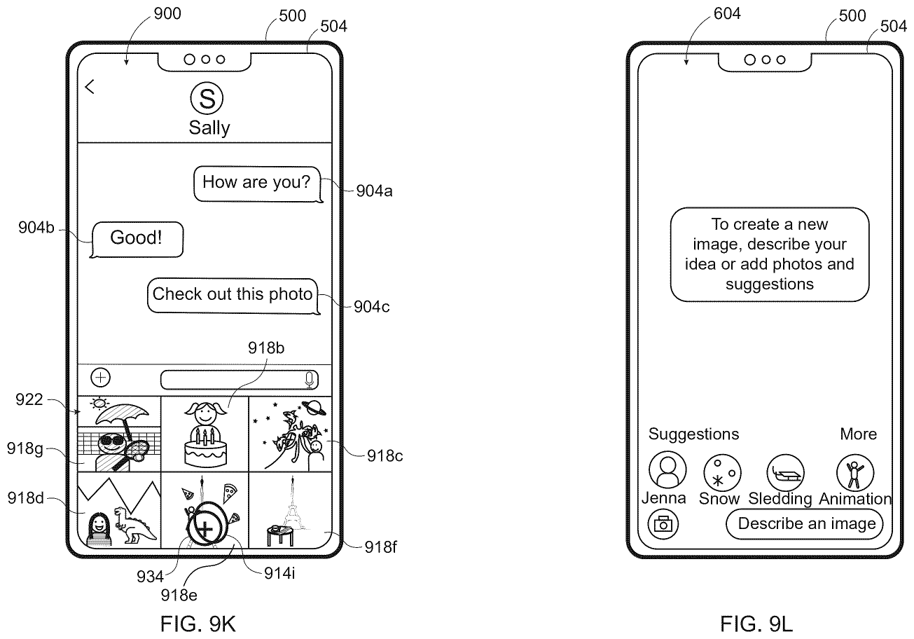

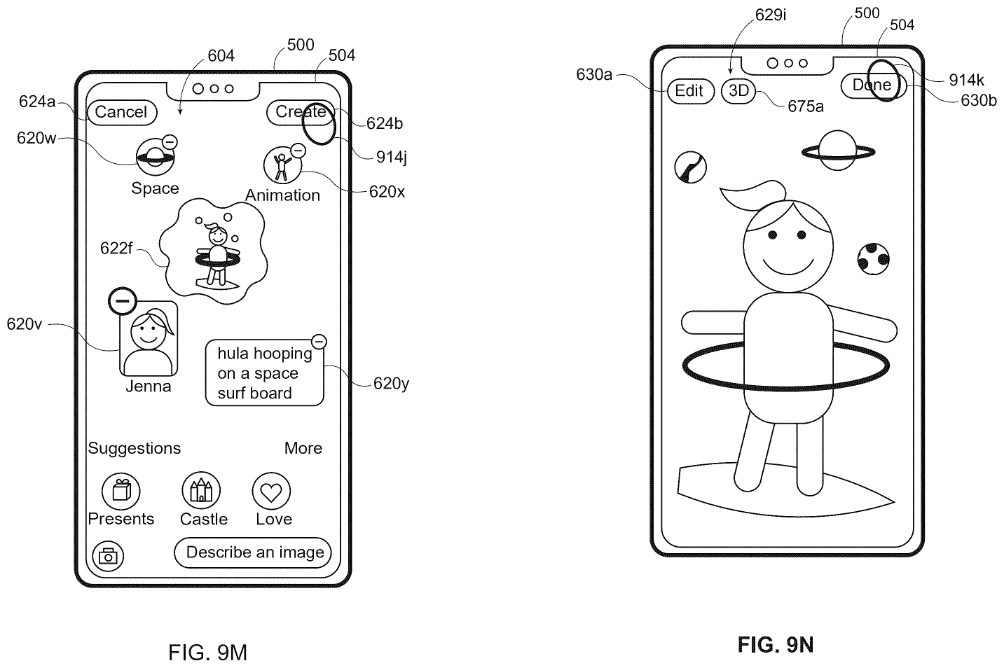

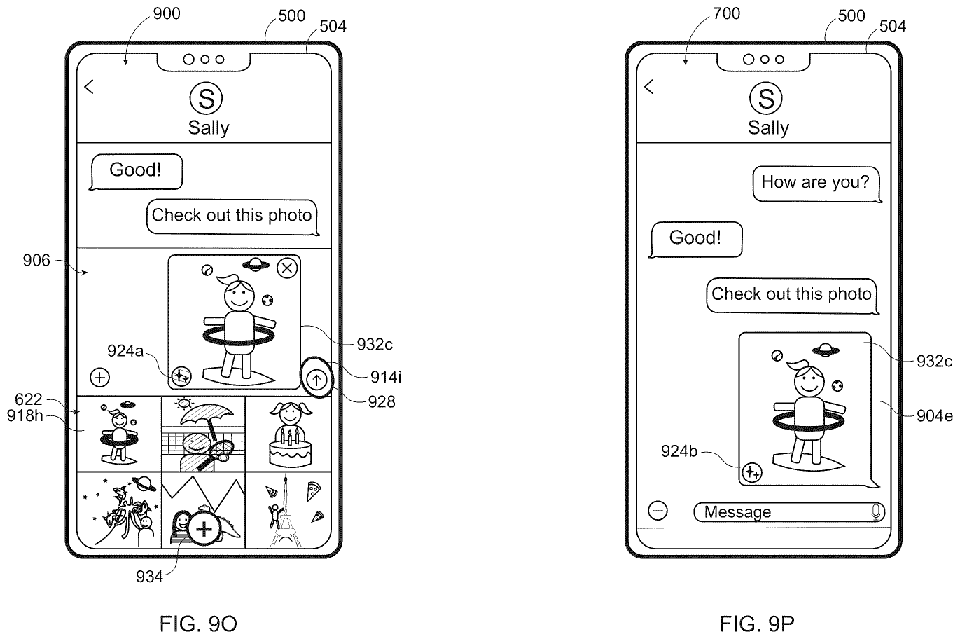

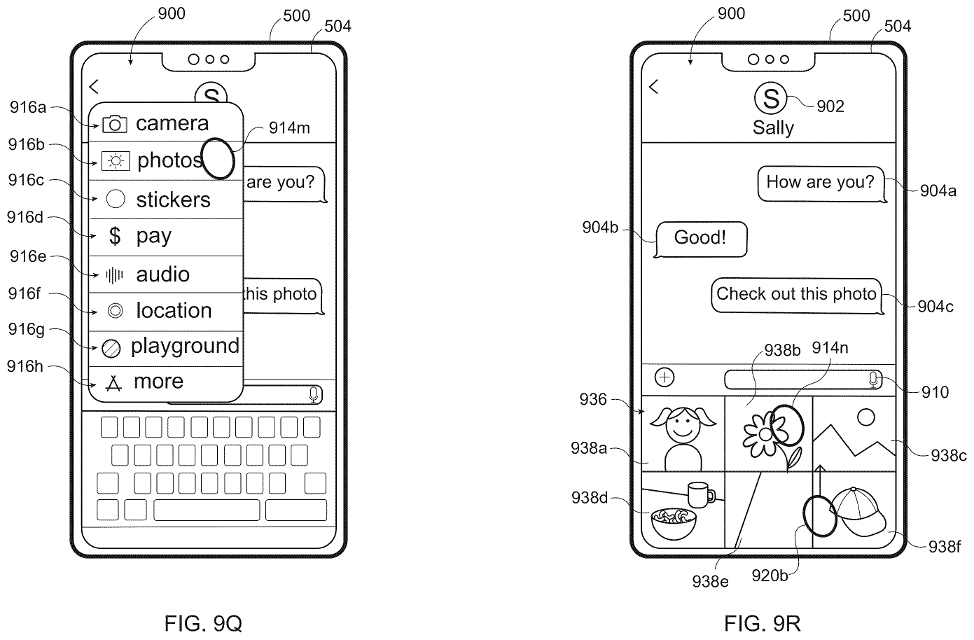

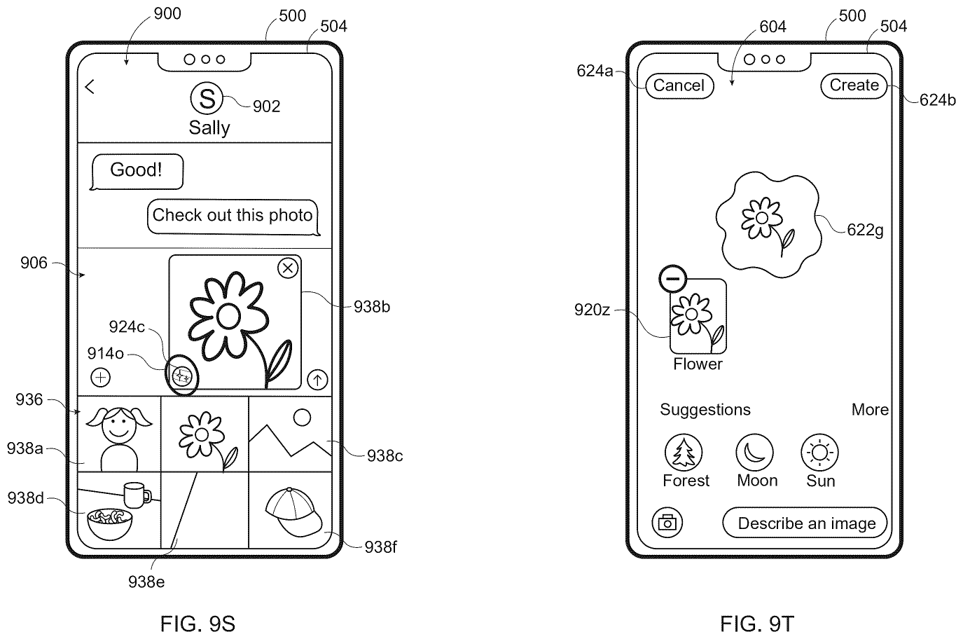

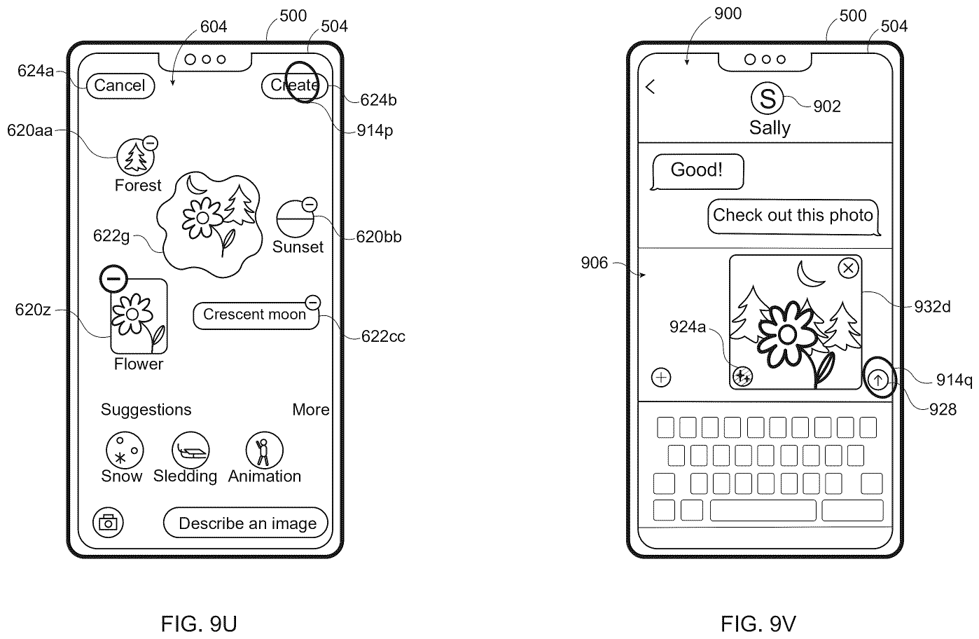

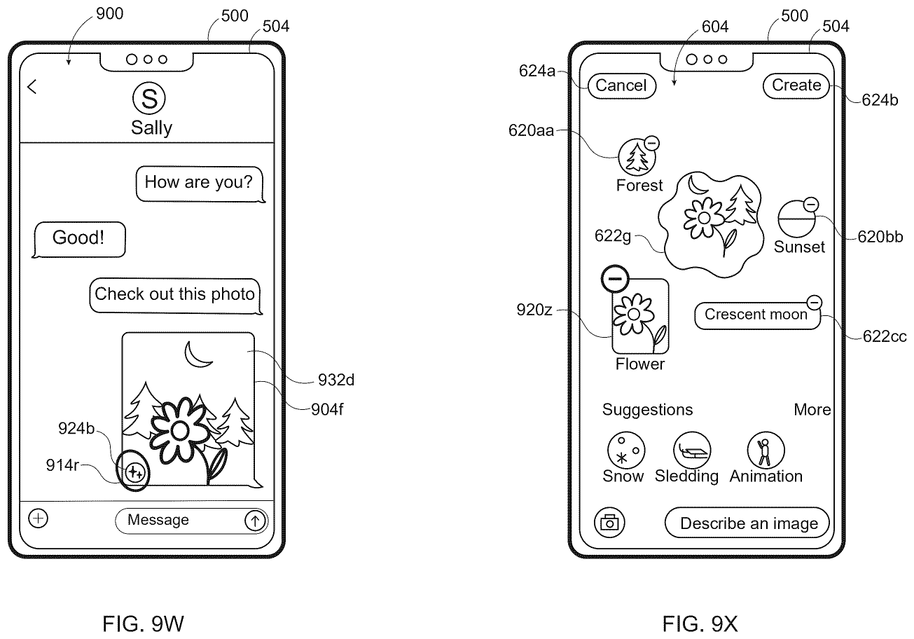

FIG. 6F is a user interface 629a including the automatically-generated visual content that is generated using autonomous processes, as described in method 700. In some embodiments, the automatically-generated visual content includes the recognized concepts 620b through 620c incorporated into the starting media (e.g., recognized concept 620a) to formulate a new image (e.g., the automatically-generated visual content). For example, the electronic device 500 uses the representation of Jenna as the starting image and incorporates the recognized concepts of “birthday” and “animation” in the automatically-generated visual content in user interface 629a. As shown in user interface 629a, Jenna is having a birthday celebration with a banner and a birthday cake. In some embodiments, the automatically-generated visual content in FIG. 6F is animated. For example, the candles are flickering, Jenna is shown blowing out the candles, and/or the “happy birthday” banner is moving and includes changing colors. As shown in FIG. 6F, user interface 629a includes selectable options 630a through 630c. Options 630a through 630c optionally correspond to options 1602c and/or 2242a; options 1602d and/or 2242b; and options 1602e and 2242c, respectfully, in FIGS. 9A-9X, 16A-16U, 18G-18BB, 20D-20AA, 22A-22CCC, and/or 26A-26P. In some embodiments, the electronic device 500 redisplays user interface 604 in FIG. 6E in response to the electronic device receiving an input directed towards selectable option 630a. In some embodiments, the electronic device 500 saves the automatically-generated visual content (e.g., in the gallery shown by user interface 600 in FIG. 6A) in response to the electronic device receiving an input directed towards selectable option 630b. Actions in response to the electronic device receiving an input directed towards selectable option 630b are described in further detail below. For example, the user optionally saves the image as a new image or overrides a previous image, as described in FIG. 6Q. In some embodiments, the electronic device 500 transmits the automatically-generated visual content to a different application and/or a different device in response to the electronic device receiving an input directed towards selectable option 630c.

FIG. 6G illustrates an embodiment wherein a user inputs a prompt to initiate a process to generate an automatically-generated visual content using a voice assistant (e.g., and not through user interface 600 shown in FIG. 6A). As shown in FIG. 6G, a user activates a voice assistant (e.g., using a voice command 634 and/or a button) while the electronic device displays user interface 632 (e.g., a lock screen user interface) and tells the voice assistant to generate an image. In some embodiments, the text illustrates the voice command 634 to the voice assistant.

In response to receiving the voice command 634, the electronic device 500 displays user interface 604, described in greater detail above, including the details from the voice command 634. FIG. 6H-A illustrates a first embodiment of a user interface 604 including a recognized concept 620d representing “Jeremy” and a prompt 636 in text entry region 614. In some embodiments, the recognized concept 620d is a representation of “Jeremy” including one or more characteristics of the recognized concept 620a, as described above. FIG. 6H-A also includes recognized concepts 620e and 620f, which are recognized concepts extracted from prompt 636. In some embodiments, extracting recognized concepts from a prompt is described in further detail in method 700. FIG. 6H-A also includes a representation 622b of the automatically-generated visual content, which as one or more characteristics of the representation 622a of another automatically-generated visual content, as described above.

FIG. 6H-B illustrates a second embodiment of user interface 604. In some embodiments, FIG. 6H-B includes one or more characteristics of FIG. 6H-A. In response to receiving the voice command 634 (e.g., in some embodiments, the electronic device 500 receives a prompt and/or an additional prompt via text as described herein), the electronic device 500 displays recognized concept 620d representing “Jeremy” and a cluster of recognized concepts 690 representing the prompt. As described in method 700, in some embodiments, the electronic device 500 displays a cluster of icons and/or text in response to receiving a prompt with multiple recognized concepts.

While displaying the recognized concepts 620d through 620f in FIG. 6H-A, the electronic device 500 receives a selection input (e.g., a tap or long press input) including contact 640 directed towards a selectable option 638 in FIG. 6H-A. In response to receiving the input, the electronic device 500 displays a menu 642 including a collection of recognized concepts that, when selected, influence the creation of an automatically-generated visual content, as shown in FIG. 6I. In some embodiments, the collection of recognized concepts is described in further detail in the description of method 700 below.

FIG. 6I illustrates the menu 642 of recognized concepts including recognized concepts 644a through 644f. In some embodiments, the menu 642 of recognized concepts are categorized by type of recognized concept. For example, recognized concepts 644a through 644f are activity recognized concepts (e.g., the recognized concepts 644a through 644f in this category are activities). In some embodiments, the menu 642 includes a plurality of categories of recognized concepts, as described in method 700. As shown in FIG. 6I, the menu 642 includes indication 646, indicating the number of categories in the menu 642, and the location of the category currently displayed.

While displaying the menu 642 of recognized concepts including recognized concepts 644a through 644f in FIG. 6I, the electronic device 500 receives a dragging input including movement of contact 648 directed towards dragging recognized concept 644b towards the region of user interface 604 including the recognized concepts being used to influence the generation of the automatically-generated visual content. In response to receiving the input, the electronic device 500 updates the representation 622b of the automatically-generated visual content to include recognized concept 644b (e.g., “tennis”), shown in FIG. 6J. For example, in FIG. 6J, the electronic device 500 updates representation 622b to include a tennis racket. Additionally, the electronic device 500 updates the recognized concepts used to influence the generation of the automatically-generated visual content to include recognized concept 620g which corresponds to the selected recognized concept 644b (e.g., “tennis”).

In some embodiments, while displaying user interface 604 including the menu 642 in FIG. 6I, the electronic device 500 receives a selection input directed towards option 624a, such as detecting contact 658a (e.g., a tap or long press input). In some embodiments, other selection inputs, such as an air gesture input, a voice input, and/or an input detected using a hardware input device, are possible. In some embodiments, the input is in place of or in addition to the input including contact 648 described above. In response to receiving the input directed towards option 624a, the electronic device 500 removes the recognized concepts 620d, 620f, and 620e from the prompt and ceases displaying the representations of recognized concepts 620d, 620f, and 620e. In response to removing the recognized concepts used to influence the generation of the automatically-generated visual media, the electronic device 500 displays user interface 604 with visual indication 612, as shown in FIG. 6B. In some embodiments, the electronic device displays visual indication 612 because there are no longer any recognized concepts to be used to influence the generation of the automatically-generated visual content item.

In FIG. 6J, the electronic device 500 receives a swipe input including contact 650 in the menu 642 region of the user interface 604. In response to receiving the input in FIG. 6J, the electronic device 500 updates the menu 642 to include a display of a second category (e.g., “Styles”) of recognized concepts 644g through 644l, shown in FIG. 6K. In some embodiments, the second category includes styles that the automatically-generated visual content is generated with. In some embodiments, in response to receiving the swipe input including movement of contact 650, the electronic device 500 also updates indication 646 to indicate the location of the second category (e.g., to the right of the activities category). While displaying the styles category, the electronic device 500 receives a dragging input including movement of contact 652 directed towards dragging recognized concept 644l (e.g., “sketch”) to the region of the user interface 604 including recognized concepts used to influence the generation of the automatically-generated visual content. In response to receiving the input, the electronic device 500 updates the region of the user interface 604 to include recognized concept 620h, which corresponds to recognized concept 644i in the menu 642 of recognized concepts, in FIG. 6L. Additionally, in response to receiving the dragging input including movement of contact 652, the electronic device 500 updates the representation 622b, in FIG. 6L, to include a sketch style.

In FIG. 6L, the electronic device 500 receives a selection input (e.g., a tap or long press input) including contact 654 directed towards selectable option 624b. In response to receiving the selection input, the electronic device 500 ceases displaying user interface 604 and begins displaying user interface 629b, shown in FIG. 6M. FIG. 6M illustrates user interface 629b including the automatically-generated visual content generated using the recognized concepts 620d through 620h. For example, the automatically-generated visual content includes a sketch of Jeremy at the beach playing tennis with sunglasses on. In some embodiments, user interface 629b includes one or more characteristics of user interface 629a in FIG. 6F. As described above and in method 700, the automatically-generated visual content is of higher fidelity than the representation 622b. For example, the automatically-generated visual content in FIG. 6M includes more details (e.g., a tennis net, a tennis ball, an umbrella, and the sun) than the representation 622 illustrated in FIG. 6L. As described with reference to method 700, the automatically-generated visual content is not visual media generated as a result of image manipulation, but instead the one or more recognized concepts (e.g., 620d through 620h) are used as seeds to modify a real-world image into an automatically-generated visual content.

In FIG. 6M, the electronic device 500 receives a selection input (e.g., a tap or long press input) including contact 656 directed towards selectable option 630a. In response to receiving the input, the electronic device 500 ceases displaying user interface 629b and redisplays user interface 604, including the recognized concepts (e.g., recognized concepts 620d through 620h) used to influence the generation of the automatically-generated visual content. FIG. 6N illustrates the electronic device 500 displaying user interface 604 in response to the electronic device 500 receiving the selection input (e.g., a tap or long press input) including contact 656 in FIG. 6M.

While displaying user interface 604 in FIG. 6N, the electronic device 500 receives a selection input (e.g., a tap or long press input) including contact 658 corresponding to a request to delete recognized concept 620e such that the recognized concept 620e no longer influences the generation of the automatically-generated visual content. In some embodiments, the selection input is directed towards a selectable option 659 overlaid on the recognized concept 620e. In some embodiments, the recognized concepts used to influence the generation of the automatically-generated visual content include corresponding selectable options that, when selected, cause the electronic device 500 to delete the recognized concept corresponding to the selected option. In response to receiving the selection input in FIG. 6N, the electronic device 500 ceases to display recognized concept 620e, as shown in FIG. 6O. Additionally, in response to receiving the selection input, the electronic device 500 updates representation 622b, in FIG. 6O, to reflect that the recognized concept 620e is no longer being used to influence the generation of the automatically-generated visual content. For example, in FIG. 6N, the electronic device 500 receives an input corresponding to a request to delete the “sunglasses” recognized concept, and in response to receiving the input, the electronic device 500 updates representation 622b in FIG. 6O to no longer include Jeremy wearing sunglasses.

In some embodiments, while displaying user interface 604 in FIG. 6N, the electronic device 500 receives a selection input directed towards option 624a, such as detecting a tap input or long press input with contact 658b. In some embodiments, the input is in place of or in addition to the input including contact 658a described above. In some embodiments, other selection inputs, such as an air gesture input, a voice input, and/or an input detected using a hardware input device, are possible. In response to receiving the input directed towards option 624a, the electronic device 500 removes the recognized concepts 620d, 620f, 620h, 620e, and 620g. In response to removing the recognized concepts used to influence the generation of the automatically-generated visual media. the electronic device 500 displays user interface 604 with visual indication 612, as shown in FIG. 6B, and no longer displays the recognized concepts 620d, 620f, 620h, 620e, and 620g. In some embodiments, the electronic device displays visual indication 612 because there are no longer any recognized concepts to be used to influence the generation of the automatically-generated visual content item.

In FIG. 6O, the electronic device 500 receives a selection input (e.g., a tap or long press input) including contact 660 directed towards selectable option 624b, to regenerate the automatically-generated visual content without recognized concept 620e. As a result, the electronic device 500 ceases to display user interface 604 and displays user interface 629c to include a regenerated version of the automatically-generated visual content not including recognized concept 620e (e.g., the automatically-generated visual content shown in FIG. 6M). FIG. 6P illustrates the regenerated automatically-generated visual content when the process to generate automatically-generated visual content is deterministic. Specifically, FIG. 6P is different from FIG. 6O because the automatically-generated visual content in FIG. 6P lacks sunglasses. However, in some embodiments, and as described in method 700, the generation of the automatically-generated visual content is non-deterministic. Specifically, one or more elements in addition to the removal of the sunglasses are changed in the resulting regenerated automatically-generated visual content. FIGS. 9D-9G describe regenerating a non-deterministic automatically-generated visual content. In some embodiments, user interface 629c has one or more characteristics of the user interfaces 629a through 629b described above. While displaying the regenerated automatically-generated visual content in FIG. 6P, the electronic device 500 receives a selection input (e.g., a tap or a long press) using contact 662 directed towards selectable option 630c. In response, the electronic device 500 displays selectable options 630d through 630e, shown in FIG. 6Q. In some embodiments, selectable option 630d, when selected, causes the electronic device 500 to save the regenerated automatically-generated visual content over the previously generated automatically-generated visual content (e.g., the automatically-generated visual content shown in FIG. 6M), which is also described in greater detail in method 800. In some embodiments, selectable option 630e, when selected, causes the electronic device 500 to save the regenerated automatically-generated visual content as a new automatically-generated visual content, described in greater detail in method 800. In FIG. 6Q, the electronic device 500 receives a selection input (e.g., a tap or long press input) including contact 664 directed towards selectable option 630d. In response, the electronic device 500 saves the regenerated automatically-generated visual content, as shown in FIG. 6R.

FIG. 6R illustrates user interface 600 including automatically-generated visual content 602g through 602h. Automatically-generated visual content 602g corresponds to the automatically-generated visual content shown in FIG. 6F, which was saved as a new image. Automatically-generated visual media 602h corresponds to the automatically-generated visual content shown in FIG. 6Q, which was saved instead of the automatically-generated visual content shown in FIG. 6M. In some embodiments, the automatically-generated visual content in user interface 600 are listed in the order that they are saved and/or generated (e.g., automatically-generated visual content 602g was saved and/or generated before automatically-generated visual content 602h).

In FIG. 6R, the electronic device 500 receives a selection input (e.g., a tap or long press input) including contact 666 directed towards automatically-generated visual content 602g. In response to receiving the input, the electronic device 500 redisplays the user interface 604 including the recognized concepts (e.g., recognized concepts 620a through 620c) used to generate automatically-generated visual content 602g, shown in FIG. 6S. In some embodiments, the user interface 604 includes additional suggestions, different than the previous suggestions shown in FIG. 6E, including selectable options 608h through 608i, shown in FIG. 6S. In some embodiments, the text entry region 614 includes prompt 636 that is a textual description of the recognized concepts 620a through 620c. As described in method 700, the electronic device 500 updates prompt 636 as the user modifies adds, and/or removes recognized concepts to be used to influence the generation of the automatically-generated visual content.

In FIG. 6S, the electronic device 500 receives a selection input (e.g., a tap or long press input) including contact 668 directed towards selectable option 624b. In response to receiving the input, the electronic device 500 generates the automatically-generated visual content. After generating the automatically-generated visual content, the electronic device 500 ceases displaying user interface 604 and begins displaying user interface 629d, in FIG. 6T. In some embodiments, user interface 629d includes one or more characteristics of user interface 629a through 629c, described above.

FIG. 6T illustrates a different automatically-generated visual content than FIG. 6F because, as described in method 800, the electronic device 500 uses a different random or pseudorandom seed value or seed content to regenerate the automatically-generated visual content. Although the automatically-generated visual content in FIG. 6T and in FIG. 6F use the same recognized concepts, they are different automatically-generated visual content. In FIG. 6T, the electronic device 500 receives a selection input (e.g., a tap or long press input) including contact 670a directed towards selectable option 630a. In response to receiving the input, in FIG. 6U, the electronic device ceases to display user interface 629d and redisplays user interface 604 including the recognized concepts (e.g., recognized concepts 620a through 620c) used to generate the automatically-generated visual content in FIG. 6T.

In FIG. 6U, the electronic device 500 receives a dragging input including movement of contact 672a directed towards recognized concept 644i in the style category of menu 642. In response to receiving the input shown in FIG. 6U, in FIG. 6V, the electronic device 500 ceases to display recognized concept 620b and displays recognized concept 620i, corresponding to recognized concept 644l in menu 642. In some embodiments, as described in method 700, certain categories of recognized concepts (e.g., style category) are mutually exclusive; therefore, adding a recognized concept in the respective category results in the other recognized concept being removed from the recognized concepts used to generate the automatically-generated visual content. In response to receiving the input in FIG. 6U, the electronic device 500 also updates representation 622a to include the sketch recognized concept (e.g., recognized concept 622i).

In FIG. 6V, the electronic device receives a typing input directed towards the text entry region 614 to enter a new prompt 676. In some embodiments, the electronic device receives a voice command input to enter a new prompt 676. FIG. 6V displays the new prompt 676. In FIG. 6V, the electronic device receives a selection input 670b directed towards selectable option 674, which updates the prompt (“sketch image of Jenna's birthday”) to the new prompt 676 (“Jerome on a shark volcano”), shown in FIG. 6W.

FIG. 6W illustrates the user interface 604 including the recognized concepts extracted from the prompt 676 (e.g., recognized concept 620j through 620k). Extracting the recognized concepts is described in greater detail in the description of method 700. Displaying user interface 604 including the new recognized concepts in response to receiving a new prompt 676 is also described in further detail in the description of method 800. In some embodiments, the recognized concepts used to generate the automatically-generated visual content are displayed as text (e.g., recognized concept 622k) without an image corresponding to the text, as described in greater detail in the description of method 700. In some embodiments, recognized concepts without images associated with the word are displayed with only text. For example, recognized concept 622k is displayed as text because “shark volcano” is an imaginary concept. Additionally, the user interface 604 includes additional suggestions such as selectable option 608j (e.g., “space”) and selectable option 608k (e.g., “Halloween”). Additionally, the user interface 604 includes a representation 622c of the automatically-generated visual content.

FIG. 6X illustrates the electronic device 500 receiving a dragging input including movement of contact 672b directed to dragging selectable option 608j towards the region of the user interface 604 including the recognized concepts used to influence the generation of the automatically-generated visual content. In response to receiving the input, the electronic device 500 displays a recognized concept 620l corresponding to selectable option 608j, shown in FIG. 6Y. Additionally, in FIG. 6Y, the electronic device 500 updates representation 622c to include the recognized concept 620l. While displaying the user interface 604 in FIG. 6Y, the electronic device 500 receives a selection input directed towards selectable option 624b (e.g., a tap or a long press) including contact 670c. In response to receiving the input in FIG. 6Y, the electronic device 500 ceases to display user interface 604, and begins displaying user interface 629e including the automatically-generated visual content, shown in FIG. 6Z.

FIG. 6Z illustrates user interface 629e which includes the automatically-generated visual content generated using the recognized concepts 620j through 620l in FIG. 6Y. User interface 629e has one or more characteristics of the user interface 629a through 629d described above. While displaying user interface 629e, the electronic device 500 receives a selection input directed towards 630b (e.g., a tap or a long press) including contact 670d. In response to receiving the input shown in FIG. 6Z, the electronic device 500 displays additional selectable options 630d and 630e shown in FIG. 6AA. In some embodiments, the selectable options 630d and 630e are described above with reference to FIG. 6Q. However, in FIG. 6AA, the electronic device 500 receives a selection input (e.g., a tap or long press input) including contact 670e directed towards selectable option 630e to save the automatically-generated visual content in FIG. 6AA as a new image instead of overriding the previously generated automatically-generated visual content (e.g., shown in FIG. 6F). In response to receiving the input in FIG. 6AA, the electronic device 500 displays the automatically-generated visual content in user interface 629e as a new image represented by automatically-generated visual content 602i in user interface 600, shown in FIG. 6BB. For example, the automatically-generated visual content 602i does not replace the automatically-generated visual content 602g since the automatically-generated visual content 602i was generated by modifying the recognized concepts used to generate the automatically-generated visual content 602g and saved as a new automatically-generated visual content.

FIG. 6Z also illustrates an input directed towards option 675a, such as detecting contact 680a (e.g., a tap or long press input). In some embodiments, the electronic device 500 receives the input separately (e.g., independently) from the input that the electronic device detects with contact 670d (e.g., a tap or a long press). Alternatively, in some embodiments, the electronic device 500 detects the input (e.g., with contact 680a (e.g., a tap or a long press)) concurrently with the input (e.g., with contact 670d (e.g., a tap or a long press)). In some embodiments, other selection inputs, such as an air gesture input, a voice input, and/or an input detected using a hardware input device, are possible. In response to detecting the input (e.g., detecting contact 680a (e.g., a tap or long press input)), shown in FIG. 6Z, the electronic device 500 regenerates the automatically-generated visual content item shown in FIG. 6Z as a three-dimensional automatically-generated visual content item, shown in FIG. 6AA′. Three-dimensional automatically-generated visual content items are described in greater detail in method 700. In some embodiments, the three-dimensional automatically-generated visual content item is a three-dimensional representation of the previously generated automatically-generated visual content item (e.g., shown in FIG. 6Z). In some embodiments, the three-dimensional automatically-generated visual content item is regenerated using the recognized concepts and optionally has a different visual appearance than the automatically-generated visual content item shown in FIG. 6Z.

In FIG. 6AA′, the electronic device 500 detects an input directed towards option 630b, such as detecting contact 680b (e.g., a tap or long press input). In some embodiments, other selection inputs, such as an air gesture input, a voice input, and/or an input detected using a hardware input device, are possible. In response to detecting the input, the electronic device 500 displays additional selectable options 630d and 630e shown in FIG. 6AA″. In some embodiments, the selectable options 630d and 630e are described above with reference to FIG. 6Q. In some embodiments, the electronic device 500 receives a selection input directed towards selectable option 630d, such as detecting contact 680c (e.g., a tap or long press input), to save the three-dimensional automatically-generated visual content item shown in FIG. 6AA″, over the previously generated automatically-generated visual content item shown in FIG. 6Z, In some embodiments, the electronic device 500 detects a selection input directed towards selectable option 630e, such as detecting contact 680d (e.g., a tap or long press input), to save the three-dimensional automatically-generated visual content item as a new image instead of overriding the previously generated automatically-generated visual content item (e.g., shown in FIG. 6Z).

FIG. 6BB illustrates the electronic device 500 displaying the automatically-generated visual content in user interface 629e as a new image represented by automatically-generated visual content 602i in user interface 600. While displaying the user interface 600 in FIG. 6BB, the electronic device 500 receives an upward swipe input including contact 674a. As a result, the electronic device 500 displays additional automatically-generated visual content stored in the gallery of automatically-generated visual content, as shown in FIG. 6CC. In some embodiments, the additional automatically-generated visual content (e.g., automatically-generated visual content 602j and 602k in FIG. 6CC) are sample automatically-generated visual content or previously generated visual content. For example, the automatically-generated visual content 602a through 602g and 602j through 602k are previously generated visual content generated using recognized concepts selected by the user similarly to the examples described herein instead of sample automatically-generated visual content (e.g., examples that use recognized concepts selected by the electronic device 500 or a server in communication with the electronic device 500). In some embodiments, the automatically-generated visual content displayed on user interface 600 include automatically-generated visual content of various people, as described in methods 700 and 800.

In FIG. 6CC, the electronic device 500 receives a selection input (e.g., a tap or long press input) including contact 670e directed towards automatically-generated visual content 602k. In response to receiving the input shown in FIG. 6CC, the electronic device 500 ceases displaying user interface 600 and displays user interface 629f, which includes the image of the automatically-generated visual content 602k, shown in FIG. 6DD. In some embodiments, user interface 629f includes one or more characteristics of the user interfaces 629a through 629e. While displaying the automatically-generated visual content in FIG. 6DD, the electronic device 500 receives a selection input (e.g., a tap or long press input) including contact 670f. In response, the electronic device 500 ceases displaying user interface 629f and begins displaying user interface 604 including the recognized concepts 620m through 620p used to generate the automatically-generated visual content 602k, shown in FIG. 6EE. FIG. 6EE also includes a representation 622d of automatically-generated visual content 606k.

In FIG. 6DD, the user interface 629f also includes a selectable option 675a, that when selected, causes the electronic device 500 to generate a three-dimensional (3D) version of automatically-generated visual media 602k. Alternatively, the electronic device 500 generates a new automatically-generated visual content item as a 3D automatically-generated visual content item using the one or more recognized concepts. In some embodiments, selectable option 627a is described in greater detail in FIG. 6Z.

FIG. 6FF illustrates an embodiment where user interface 604 includes recognized concepts used to generate a different automatically-generated visual content. In FIG. 6FF, user interface 604 includes recognized concepts 620q through 620u and a representation 622e of the resulting automatically-generated visual content. In FIG. 6FF, user interface 604 includes text recognized concepts (e.g., recognized concepts 620r, 620t, and 620u). As described above, some recognized concepts do not include a visual representation.

FIG. 6GG illustrates the electronic device 500 detecting a user typing “gun” into the text entry field 614. The electronic device 500 also detects a selection input (e.g., a tap or a long press) using contact 670g to add “gun” as a recognized concept. Because “gun” is a high risk concept, as described in greater detail in method 700, the electronic device 500 does not add “gun” as a recognized concept, as shown in FIG. 6HH. Alternatively, in some embodiments, the electronic device 500 displays a recognized concept corresponding to “gun” and also displays a visual indication indicating that the recognized concept is high risk. In some embodiments, “gun” is a high risk concept when combined with some words but not when combined other words. For example, “hot glue gun” is not a high risk concept while “shooting guns” is a high risk concept. Similarly, in some embodiments, there are words that are not high risk in isolation but are high risk when combined with other words. For example, “punch” is low risk on its own, but “punch” combined with a person (e.g., “punch my brother”) is a high risk word. In some embodiments, a high risk word is able to be turned into a low risk word when a term is added to lower the risk because it changes the interpretation of one or more words in the prompt. For example, “punch” is high risk but “my brother drinking punch” is not.

In FIG. 6GG, the electronic device 500 detects a selection input (e.g., a tap or a long press) using contact 670h directed towards selectable option 624b. In response to receiving the input in FIG. 6GG, the electronic device 500 generates the automatically-generated visual content without the high risk recognized concept, “gun”, including ceasing displays user interface 604 and displaying user interface 629g. As shown in FIG. 6II, the user interface 629g does not include the high risk recognized concept, “gun”. Alternatively, in some embodiments and as described in method 700, the electronic device 500 forgoes generating an automatically-generated visual content all together. In some embodiments, the electronic device 500 displays an indication of an error (e.g., an error message) in response to detecting an input directed towards selectable option 624b.

In FIG. 6II, the user interface 629g also includes a selectable option 675a, that when selected, causes the electronic device 500 to generate a three-dimensional (3D) version of the automatically-generated visual media shown in FIG. 6II. Alternatively, the electronic device 500 generates a new automatically-generated visual content item as a 3D automatically-generated visual content item using the one or more recognized concepts. In some embodiments, selectable option 627a is described in greater detail in FIG. 6Z.

FIGS. 6JJ-6MM illustrate an embodiment in which the electronic device 500 displays a plurality of representations of automatically-generated visual content that are generated using the same recognized concepts and/or prompt. The user interface shown in FIG. 6JJ includes one or more characteristics of the user interface shown in FIG. 6L. In FIG. 6JJ, the electronic device 500 displays representation 622b including a preview of the automatically-generated visual content to be generated using the recognized concepts 620d through 620h. In FIG. 6JJ, the electronic device 500 receives a selection input (e.g., a tap or long press input) including contact 670i directed towards the representation 622b. In response to receiving the input, the electronic device 500 displays a representation 622b-a corresponding to the representation 622b in FIG. 6KK. In some embodiments, the electronic device 500 displays representation 622b-a corresponding to the representation 622b in FIG. 6KK without receiving the input directed towards the representation 622b. For example, the electronic device displays representation 622b-a corresponding to the representation 622b in FIG. 6KK after a time threshold (e.g., 1 second, 5 seconds, 10 seconds, 30 seconds, 1 minute, or 5 minutes) where the electronic device 500 does not detect an input is reached.

FIG. 6KK illustrates the electronic device 500 displaying user interface 604 including representation 622b-a. Representation 622b-a is a larger (in size) representation of representation 622b. In some embodiments, representation 622b-a includes one or more characteristics of 622b as described in method 700. While displaying the representation 622b-a, the electronic device detects a swipe (e.g., a motion) input including contact 674b directed towards the user interface 604 and/or directed towards representation 622b-a. In response to receiving the input, the electronic device 500 generates a representation 622b-b, shown in FIG. 6LL, of a second automatically-generated visual content that is generated using the same prompt and/or recognized concepts (e.g., recognized concepts 620d through 620h) as the automatically-generated visual content and the corresponding representation 622b-a of the automatically-generated visual content. In some embodiments, the content of the representation 622b-b is different from the content of representation 622b-a even though they are based on the same recognized concepts. Generating a representation of a second automatically-generated visual content in response to the input is described in greater detail in method 700. In some embodiments, in FIG. 6KK, if the electronic device 500 receives an input directed towards option 624b, then the electronic device 500 generates the automatically-generated visual content, which is based on representation 622b-a.

FIG. 6LL illustrates the representation 622b-b that is generated using the same recognized concepts (e.g., recognized concepts 620d through 620h) as the representation 622b-a. In some embodiments, in FIG. 6LL, if the electronic device 500 receives an input directed towards option 624b, then the electronic device 500 generates the second automatically-generated visual content, which is based on representation 622b-b. In some embodiments, if the electronic device receives right to left swipe (e.g., such as including contact 674b) in FIG. 6LL, then the electronic device 500 generates a representation of a third automatically-generated visual media that is generated using recognized concepts 620d through 620h. In some embodiments, the content of the representation of the third automatically-generated visual media is different from the content of representation 622b-a and representation 622b-a even though they are based on the same recognized concepts. In some embodiments, if the electronic device receives a left to right swipe input in FIG. 6LL, then the electronic device 500 redisplays representation 622b-a.

In FIG. 6LL, the electronic device 500 receives a selection input (e.g., a tap or long press input) including contact 670j directed towards a location outside of the representation 622b-b. In response to receiving the input, the electronic device 500 ceases displaying the representation 622b-b and resumes the previous display of user interface 604 including the display of the recognized concepts 620d through 620h and the representation 622b, shown in FIG. 6MM. In response to receiving the input, the electronic device 500 displays the representation 622b to correspond to the representation of the second automatically-generated visual content (e.g., instead of the first automatically-generated visual content, and different in content than the content of representation 622b corresponding to the first automatically-generated visual content, as in FIG. 6JJ) while continuing to display the same recognized concepts 620d through 620h as before. In some embodiments, if the electronic device 500 receives an input directed towards option 624b, then the electronic device 500 initiates the generation of the second automatically-generated visual content, similar to as previously described.

FIG. 7 illustrates a flow diagram illustrating a method in which an electronic device displays recognized concepts and generates automatically-generated visual media in accordance with some embodiments of the disclosure. The method 700 is optionally performed at first electronic device and/or electronic devices such as device 100, device 300, or device 500 as described above with reference to FIGS. 1A-1B, 2-3, 4A-4B and 5A-5H. Some operations in method 700 are, optionally combined and/or order of some operations is, optionally, changed.

As described below, the method 700 provides ways in which an electronic device displays one or more recognized concepts and prompts to be used to influence generation of an automatically-generated visual content. Displaying representations of recognized concepts of a prompt allows a user to easily and efficiently see the concepts used to generate the generative image, thereby reducing errors in output of the electronic device, and avoiding the need for additional input to correct such errors.

Method 700 is performed at an electronic device in communication with a display generation component and one or more input devices, such as electronic device 500 shown in FIG. 6A. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor).

In some embodiments, the electronic device receives (702a), via the one or more input devices, a prompt for use in creating automatically-generated visual media (e.g., generative visual media, such as images and/or videos, that is generated automatically and/or generated at least partially using one or more autonomous processes)) that is generated at least partially using one or more autonomous processes, such as the prompt received using voice command 634 shown in FIG. 6G. In some embodiments, a user of the electronic device inputs a prompt to generate visual media. In some embodiments, the user inputs a prompt using a keyboard (e.g., touch keyboard or physical keyboard), a voice command, and/or a touchpad. In some embodiments, the prompt is a text prompt describing concepts to be added to an image. In some embodiments, the prompt is and/or includes media such as still images, videos, avatars, emojis, and/or a combination of media. In some embodiments, the user chooses a prompt from a menu of concepts (e.g., activities, outfits, accessories, themes, and/or styles). In some embodiments, the menu presents concepts using images (e.g., icons). In some embodiments, the electronic device uses one or more autonomous processes such as artificial neural networks and/or machine learning to generate the automatically-generated visual media. For example, automatically-generated visual media are generated using prompts and are not images captured of the real world. In some embodiments, automatically-generated visual media corresponds to the media produced by a machine program that uses foundational models (FMs) (e.g., neural networks trained using data sourced from a variety of methods) to generate the media, optionally without user input providing visual content that ends up in the automatically-generated visual media. Optionally one or more or all visual portions of generative visual content are generated by the machine program, and not by a user providing such visual portions. For example, the electronic device generates (e.g., using an AI process or a generative AI process) automatically-generated visual media using a non-visual input (e.g., using text and/or audio) and not using a visual input such as visual media (e.g., images and/or photos). For example, the electronic device generates (e.g., using an AI process or a generative AI process) automatically-generated visual media using text prompts (e.g., a user telling the electronic device to generate an image of Max playing volleyball on the beach in space) rather than using visual inputs (e.g., visual inputs of Max playing volleyball on the beach and of space). In some embodiments, automatically-generated visual media is not visual media that is generated as a result of image manipulation (e.g., adding stickers or filters to a pre-existing image of the real world). In some embodiments, automatically-generated visual media is not visual media that is generated by a user providing visual content without semantic content. For example, automatically-generated visual media is not visual media that is generated using a drawing application (e.g., a user providing the visual content such as lines, shapes, contours, and/or colors for a drawing). In some embodiments, semantic content includes the semantics of the subjects in the image and/or the semantics of the style of the automatically-generated visual content (e.g., sketch, animation, cartoon, or pop-art). In some embodiments, the electronic device uses one or more items of pre-existing visual media (e.g., images captured of the real world such as images captured by a camera or user created digital images or a modified version of a real-world image or user created digital image) as a seed for creating automatically-generated visual content. In some embodiments, the computer system uses a random seed such as visual noise or other as a starting point for generating the image or video. For example, automatically-generated visual content build additional concepts and/or features into a real image. In some embodiments, generating automatically-generated visual media includes using a real-world image as a starting point to create a new image using one or more recognized concepts. In some embodiments, automatically-generated visual media incorporates one or more recognized concepts by including the semantic characteristics of the recognized concepts without including an exact representation of the one or more recognized concepts. For example, the electronic device uses one or more autonomous processes (e.g., machine learning processes) to reimagine the starting image with the additional recognized concepts.

In some embodiments, in response to receiving the prompt, the electronic device displays (702b), via the display generation component, a user interface (e.g., a user interface of a content application) that includes prompt information (e.g., a prompt review user interface), such as user interface 604 shown in FIG. 6H-A.

In some embodiments, displaying the user interface includes concurrently displaying a representation of the prompt (702c), such as prompt 636 displayed in text entry region 614 shown in FIG. 6H-A. In some embodiments, the representation of the prompt includes text and/or images. In some embodiments, the representation of the prompt is text representing the prompt received via the one or more input devices. For example, a user inputs a prompt (e.g., via text or voice command) such as “birthday in space” and the representation of the prompt is text that includes “birthday in space”. In some embodiments, a user inputs a prompt by selecting one or more visual representations of recognized concepts in a collection of recognized concepts, as described below. For example, the electronic device displays a menu of recognized concepts including an icon representing “tennis” (e.g., a tennis racket), and an icon representing “beach” (e.g., a palm tree with sand). In some embodiments, a user selects the aforementioned recognized concepts by selecting the associated icons (e.g., a drag and drop input), which results in the electronic device combining the recognized concepts into a string (e.g., “tennis on the beach”) to be displayed as the representation of the prompt.

In some embodiments, displaying the user interface includes concurrently displaying a first visual indication that a first portion of the prompt (e.g., word, phrased, portion of a word, visual input, or character string) has been identified as a first recognized concept that will influence generation of the automatically-generated visual media (702d), such as recognized concept 620f shown in FIG. 6H-A representing a first portion of the prompt. In some embodiments, the recognized concepts include keywords, visual media, and/or style representations. In some embodiments, the electronic device and/or server processes the representation of the prompt using one or more language models, and optionally compares the prompt to a database of recognized concepts (e.g., keywords and/or media) to determine recognized concepts. For example, and as described below, the electronic device and/or server includes a database of recognized concepts. In some embodiments, the electronic device and/or server matches the recognized concepts to keywords and/or media in the prompt. In some embodiments, the recognized concepts in the prompt include the nouns in the prompt. In some embodiments, each recognized concept (e.g., concept tokens) includes a corresponding visual indication. In some embodiments, the visual indications includes text and/or images (e.g., an icon) describing the recognized concept. For example, the prompt is “birthday in space” and the recognized concepts include “birthday” and “space” and the first visual indication includes an image of a birthday cake and a second visual indication includes an image of a rocket. Displaying representations of recognized concepts of a prompt allows a user to easily and efficiently see the concepts used to generate the generative image, thereby reducing errors in output of the electronic device, and avoiding the need for additional input to correct such errors.

In some embodiments, displaying the user interface that includes the prompt information further includes displaying a second visual indication that a second portion of the prompt has been identified as a second recognized concept that will influence the generation of the automatically-generated visual media, wherein the second visual indication is displayed concurrently with the first visual indication in the user interface, the second visual indication is different than the first visual indication and the second portion of the prompt is different than the first portion of the prompt, such as the recognized concept 620e shown in FIG. 6H-A representing a second portion of the prompt. In some embodiments, the first visual indication is related to the first recognized concept and not the second recognized concept. In some embodiments, the second visual indication has one or more characteristics of the first visual indication as described above. For example, the second visual indication is an icon and/or text describing the second recognized concept and not the first recognized concept. For example, the prompt is “birthday in space” and the first portion of the prompt/the first recognized concept is “birthday” and the second portion of the prompt/the second recognized concept is “space”. In some embodiments, the first visual indication is an illustration of a birthday cake and the second visual indication is an illustration of the solar system. Displaying more than one representation of recognized concepts corresponding to different recognized concepts of a prompt allows a user to easily and efficiently see the concepts used to generate the generative image, thereby reducing errors in output of the electronic device, and avoiding the need for additional input to correct such errors.

In some embodiments, the prompt includes starting media for use in creating the automatically-generated visual media, and the starting media influences the generation of the automatically-generated visual media. For example, the prompt in FIG. 6H-A includes “Jeremy”, which results in recognized concept 620d being used at the starting media. In some embodiments, starting media includes a photo, video, and/or other image, such as a photo, video, or an image from a photo library or a camera. In some embodiments, the prompt includes a photo and a string of text (which the electronic device will use to detect recognized concepts). In some embodiments, the starting media is a representation of a person generated by the electronic device. For example, the electronic device generates a representation of a person using a plurality of photos in a photo library that include the person. In some embodiments, the starting media is a person, a place, or other content captured by a photo. In some embodiments, the electronic device detects a user input (e.g., a selection input) that has characteristics of the inputs described below, for providing the starting media. In some embodiments, the starting media, and the first portion of prompt both concurrently influence the generation of the automatically-generated visual media. Including starting media allows the electronic device to generate a generative image, thereby reducing errors in output of the electronic device, and avoiding the need for additional input to correct such errors.

In some embodiments, the first recognized concept includes a keyword or set of related keywords, such as recognized concepts 620f, 620e, and 690 shown in FIGS. 6H-A and 6H-B. In some embodiments, the first recognized concept is a keyword of a prompt. For example, nouns in the prompt are optionally keywords. In some embodiments, representations of keywords are displayed as text (e.g., there is not an image associated with the keyword). In some embodiments, the electronic device integrates concepts related to the keyword in to the automatically-generated visual media. For example, if the keyword is “Paris” then the electronic device integrates concepts related to “Paris” in the automatically-generated visual media (e.g., the Eiffel Tower, French pastries, French art, and/or other French landmarks). Displaying keywords as recognized concepts allows a user to easily and efficiently see the concepts used to generate the generative image, thereby reducing errors in output of the electronic device, and avoiding the need for additional input to correct such errors.

In some embodiments, the first recognized concept includes visual media, such as the picture of Jeremy represented by recognized concept 620d in FIG. 6H-A. In some embodiments, the electronic device detects an input by the user to provide the user interface with visual media and then the visual media is a recognized concept. For example, the user selects an image (e.g., from a photo library or a camera application) to be used to generate the automatically-generated visual media, then the image is presented as the recognized concept. Alternatively, or additionally, in some embodiments, the electronic device detects an input identifying the recognized concept (e.g., via the prompt or an additional input), and the electronic device produces the visual media based on the input. For example, the electronic device displays an icon associated with a recognized concept. For example, if the portion of the prompt that has been identified is “Eiffel Tower”, then the electronic device displays a recognized concept that is an icon of the Eiffel Tower. In some embodiments, the visual media (e.g., the icon) is a photo, video, or a sketch. Displaying visual media as recognized concepts allows a user to easily and efficiently see the concepts used to generate the generative image, thereby reducing errors in output of the electronic device, and avoiding the need for additional input to correct such errors.

In some embodiments, the first recognized concept includes a style prompt, such as recognized concept 620b shown in FIG. 6E. In some embodiments, the electronic device detects an input selecting a style prompt from a predetermined set of style prompts, such as the style prompts associated with selectable options 644g through 644l in FIG. 6N. Alternatively, or additionally, in some embodiments, the user inputs a style prompt using text (e.g., keywords or a set of keyword) and/or a voice input. In some embodiments, the style prompts dictate the style of the automatically-generated visual media. For example, style prompts include sketch, cartoon, realistic, black and white, animation, noir, or painting. In some embodiments, the recognized concepts only includes one style at a time, as described below. Displaying style prompts as recognized concepts allows a user to easily and efficiently see the concepts used to generate the generative image, thereby reducing errors in output of the electronic device, and avoiding the need for additional input to correct such errors.

In some embodiments, while displaying the user interface that includes the prompt information, the electronic device detects one or more inputs corresponding to a request to modify one or more recognized concepts that will influence the generation of the automatically-generated visual media, such as input (e.g., a tap or a long press) including contact 647 in FIG. 6I and input (e.g., a tap or a long press) including contact 658 in FIG. 6N. In some embodiments, the one or more inputs includes a selection input, such as a tap or long press with a contact (e.g., a finger, or stylus), selection with an indirect input device (e.g., mouse, remote control, or trackpad) that is directed to a location of a focus indicator such as a cursor or selection ring) and/or a gaze input (optionally as part of an air gesture). In some embodiments, the one or more inputs is directed towards a selectable option on or near the one or more visual indications associated with the one or more recognized concepts that is selectable to modify (e.g., change or delete) the one or more recognized concepts. For example, the one or more inputs are directed towards a selectable option on or near the first visual indication associated with the recognized concept.

In some embodiments, in response to detecting the one or more inputs, the electronic device modifies (e.g., adding, removing, and/or editing) the one or more recognized concepts that will influence the generation of the automatically-generated visual media in accordance with the one or more inputs, such as adding recognized concept 620g in FIG. 6J in response to the input (e.g., a tap or a long press) including contact 647 and removing recognized concept 620e in FIG. 6O in response to receiving the input (e.g., a tap or a long press) including contact 658. In some embodiments, a user modifies the first recognized concept by changing the recognized concept from a first concept to a second concept. For example, a user changes the recognized concept “birthday” to “graduation party” (e.g., by inputting via voice, text, or handwriting) which results in the electronic device changing the first visual indication representing “birthday” to a second visual indication representing “graduation party”. In some embodiments, a user modifies the first visual indication by changing the icon representing the recognized concept. For example, the first visual indication is a birthday cake representing the recognized concept, “birthday”. The user optionally changes the icon to an image of a birthday candle to represent the recognized concept, “birthday”. In some embodiments, modifying the first visual indication includes deleting the recognized concept such that the electronic device no longer displays the first visual indication. In some embodiments, modifying the recognized concept includes changing the recognized concepts that will influence the generation of the automatically-generated visual media which also includes changing the representation of the automatically-generated visual media, described below, and ultimately, change the automatically-generated visual media. Modifying a recognized concept by selecting the visual indication associated with the recognized concept allows a user to easily and efficiently modify the recognized concepts used to generate the generative image, thereby reducing errors in output of the electronic device, and avoiding the need for additional input to correct such errors.

In some embodiments, the one or more inputs corresponding to the request to modify the one or more recognized concepts that will influence the generation of the automatically-generated visual media includes an input to modify the prompt, such as inputting the new prompt 676 in text entry region 614 shown in FIG. 6V. In some embodiments, the one or more inputs has one or more characteristics of the one or more inputs described above. In some embodiments, the one or more inputs includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the one or more inputs is directed towards the representation of the prompt. In some embodiments, the input is directed to a text entry region, described in detail below, and includes adding, deleting, or modifying text.

In some embodiments, in response to receiving the one or more inputs, the electronic device updates the representation of the prompt to a representation of a second prompt in accordance with modifications to the prompt indicated by the one or more inputs, such as shown by the new prompt in the text entry region 614 in FIG. 6W. In some embodiments, the user changes a portion of the prompt or the entire prompt. In some embodiments, in response to receiving the second prompt, the electronic device updates the representation of the prompt to the representation of the second prompt. In some embodiments, modifications to the prompt includes changing the text of the prompt and/or changing an image associated with the prompt.

In some embodiments, in response to receiving the one or more inputs, the electronic device displays, in the user interface, one or more second visual indications corresponding to one or more portions of the second prompt that have been identified as recognized concepts, such as shown by recognized concepts 620j and 620k in FIG. 6W. The one or more second visual indications have one or more characteristics of the first visual indication. In some embodiments, identifying the one or more portions of the second prompt has one or more characteristics of identifying the one or more portions of the prompt. In some embodiments, changing the prompt includes deleting the portion of the prompt corresponding to the recognized concept. In some embodiments, if the portion of the prompt corresponding to the recognized concept is deleted, the electronic device ceases displaying the first visual indication corresponding to the recognized concept based on the portion of the prompt. For example, the electronic device ceases displaying recognized concepts 620a, 620c, and 620i in response to receiving the prompt 676 in FIG. 6V and begins displaying recognized concepts 620j and 620k in FIG. 6W. In some embodiments, if the user did not modify the portion of the prompt that includes the portion of the prompt associated with the first visual indication, then the electronic device continues to display the first visual indication corresponding to the recognized concept based on the portion of the prompt. In some embodiments, ceasing displaying the first visual indication means that the recognized concept associated with the first visual indication will no longer influence the generation of the automatically-generated visual media. In some embodiments, modifying the prompt includes changing the recognized concepts that will influence the generation of the automatically-generated visual media which also includes changing the representation of the automatically-generated visual media, described below, and ultimately, change the automatically-generated visual media Modifying recognized concepts by modifying the prompt allows a user to easily and efficiently modify the recognized concepts used to generate the generative image, thereby reducing errors in output of the electronic device, and avoiding the need for additional input to correct such errors.

In some embodiments, the one or more inputs corresponding to the request to modify the one or more recognized concepts that will influence the generation of the automatically-generated visual media includes an input corresponding to a request to add a second recognized concept that will influence the generation of the automatically-generated visual media, such as shown by the input (e.g., a tap or a long press) including contact 672b to add selectable option 608j as a recognized concept in FIG. 6X. In some embodiments, adding a second recognized concept includes changing the prompt to include the second recognize concept, such as described above. In some embodiments, adding the second recognized concept includes dragging (e.g., using a dragging input) to drag a second recognized concept or a selection input to select a second recognized concept from a plurality of recognized concepts (as described below) into the area where the other recognized concepts are displayed. Alternatively, or additionally, in some embodiments, adding the second recognized concept includes selecting (e.g., via a tap) a recognized concept form a list of recognized concepts. In some embodiments, the first input has one or more characteristics of the selection inputs described above. In some embodiments, the first input is a dragging input including a tap and drag and drop motion using a contact or a gaze. In some embodiments, first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the one or more inputs, the electronic device displays a second visual indication corresponding to the second recognized concept concurrently with the first visual indication corresponding to the recognized concept, such as shown by recognized concept 620l in FIG. 6Y. In some embodiments, the second visual indication is displayed near the first visual indication (e.g., next to or adjacent to). In some embodiments, displaying the second visual indication further includes displaying the second recognized concept in the representation of the prompt. In some embodiments, adding the second recognized concept also causes the automatically-generated visual media to be based on the second recognized concept and/or updates the representation of the automatically-generated visual media, described below. In some embodiments, adding new recognized concept includes changing the recognized concepts that will influence the generation of the automatically-generated visual media which also includes changing the representation of the automatically-generated visual media, described below, and ultimately, change the automatically-generated visual media. Modifying the recognized concept by adding recognized concepts allows a user to easily and efficiently change the recognized concepts used to generate the generative image, thereby reducing errors in output of the electronic device, and avoiding the need for additional inputs to correct such errors.

In some embodiments, the one or more inputs corresponding to the request to modify the one or more recognized concepts that will influence the generation of the automatically-generated visual media include an input corresponding to a request to delete the first recognized concept, such as input (e.g., a tap or a long press) including contact 658 to delete recognized concept 620e in FIG. 6N. In some embodiments, the second input has one or more characteristics of the inputs described above. In some embodiments, the second input is a selection input directed towards a selectable option on or near the recognized concept that is selectable to delete the recognized concept. In some embodiments, the input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the second input is a drag input wherein a user taps on the first visual indication and, while continuing to make contact with the touch screen, drags the first visual indication off the user interface.

In some embodiments, in response to receiving the one or more inputs, the electronic device ceases display of the first visual indication, such as the electronic device 500 no longer displaying recognized concept 620e in FIG. 6O. In some embodiments, the electronic device continues to display other visual indications of other recognized concepts (e.g., a second visual indication of a second recognized concept). In some embodiments, ceasing displaying the first visual indication includes updating the representation of the prompt to no longer include the portion of the prompt associated with the recognized concept. In some embodiments, deleting the recognized concept also causes the recognized concept to no longer influence the generation of the automatically-generated visual media and/or updates the representation of the automatically-generated visual media, described below, to no longer include the recognized concept. Allowing a user to easily and efficiently change the recognized concepts used to generate the generative image reduces errors in output of the electronic device, and avoids the need for additional inputs to correct such errors.

In some embodiments, while displaying the first visual indication corresponding to the first recognized concept (e.g., recognized concept 620b shown in FIG. 6U), the electronic device receives, via the one or more input devices, a second input corresponding to a request to add a second recognized concept, wherein the second recognized concept is in a same category as the first recognized concept, such as the input (e.g., a tap or a long press) including contact 672a directed towards option 644l in FIG. 6U. In some embodiments, the second input has one or more characteristics of the inputs described above. In some embodiments, a user drags and drops the second recognized concept from a plurality of recognized concepts to the area occupied by the first recognized concept to add the second recognized concept. In some embodiments, the In some embodiments, a user selects the second recognized concept to add the second recognized concept. In some embodiments, adding a recognized concept includes adding a recognized concept to the recognized concepts that will influence the generation of the automatically-generated visual media. In some embodiments, recognized concepts in a category of recognized concepts are related (e.g., same type of recognized concept that influences the same aspect of the generated media). For example, categories include styles (e.g., sketch, painting, realistic, or other styles), activities (e.g., types of sports), and locations. In some embodiments, some categories of recognized concepts are mutually exclusive such that if a recognized concept in a first category is added, then other recognized concepts in the same category that are being used to influence the generation of the automatically-generated visual media are removed. In some embodiments, the second input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the input, the electronic device ceases display of the first visual indication corresponding to the first recognized concept (e.g., the electronic device does not display recognized concept 620b in FIG. 6V). In some embodiments, ceasing displaying the first visual indication further includes no longer influencing the generation of the automatically-generated visual media using the first recognized concept. In some embodiments, the electronic device updates the representation of the prompt in response to removing a portion of the prompt (e.g., the first recognized concept). In some embodiments, the first visual indication and the first recognized concept associated with the first visual indication are removed without the electronic device receiving an input to remove them.

In some embodiments, in response to receiving the input, the electronic device displays a second visual indication corresponding to the second recognized concept that will influence the generation of the automatically-generated visual media, such as the electronic device 500 displaying recognized concept 620i in FIG. 6V. In some embodiments, the second visual indication has one or more characteristics of the first visual indication and other visual indications as described herein. In some embodiments, displaying the second visual indication includes influencing the generation of the automatically-generated visual media using the second recognized concept. For example, recognized concepts in the style category are mutually exclusive such that the automatically-generated visual media only has one style. In some embodiments, recognized concepts in the activities category, clothing category, and/or food category are not mutually exclusive. For example, the automatically-generated visual media includes a plurality of activities. In some embodiments, as a result of the one or more inputs, the representation of the automatically-generated visual media and the automatically-generated visual media (e.g., if generated) is based on the second recognized concept and not the first recognized concept. Allowing only one recognized concept in a specific category of recognized concepts by automatically removing the other recognized concept reduces the amount of erroneous inputs to select recognized concepts used to generate the automatically-generated visual media.

In some embodiments, displaying the user interface further includes displaying a first plurality of representations of concepts representing recognized concepts of a first category within a database of recognized concepts, such as menu 642 including recognized concepts 644a through 644f shown in FIG. 6I. In some embodiments, the representation of concepts includes icons, images, and/or text. In some embodiments, the first category includes a first representations of concept (e.g., a first visual indication) representing a first recognized concept, and a second representations of concept (e.g., a second visual representation) representing a second recognized concept. In some embodiments, the database of recognized concepts includes a plurality of categories of recognized concepts (e.g., a first category, a second category, and a third category). In some embodiments, the categories include one or more characteristics of the categories as described above. For example, the electronic device 500 displays the category of recognized concepts associated with “activities” in FIG. 6J and the category of recognized concepts associated with “Styles” in FIG. 6K. In some embodiments, the database of recognized concepts is stored on the electronic device (e.g., in the content application) and/or on a storage device (e.g., cloud storage) in communication with the electronic device.

In some embodiments, while displaying the first plurality of representations of concepts, the electronic device receives, via the one or more input devices, an input corresponding to a request to display a second plurality of representations of concepts representing recognized concepts of a second category within the database, the second category different from the first category, such the swipe input including contact 650 shown in FIG. 6J. In some embodiments, the input is a movement input (e.g., swipe input or a dragging input), and/or a selection input (e.g., tapping input or gaze input). In some embodiments, the input has one or more characteristics of the inputs as described above. In some embodiments, the input is directed towards a category selection control including a first visual indication corresponding to a first category and a second visual indication corresponding to a second category. In some embodiments, a user taps the visual indication to navigate to the corresponding category. Alternatively, or additionally, in some embodiments, the electronic device displays a second category in response to receiving a swiping or dragging input directed towards representations of concepts in the first category (e.g., a right swipe or a left swipe to navigate to a different category).

In some embodiments, in response to receiving the input corresponding to the request to display the second plurality of representations of concepts, the electronic device displays, in the user interface, the second plurality of representations of concepts (e.g., and ceasing display of the first plurality of representations of concepts), such as recognized concepts 644g through 644l shown in FIG. 6K. In some embodiments, the second plurality of representations of concepts is associated with a second category. In some embodiments, a user selects (e.g., via a tap input, a drag input, or a gaze input) an representations of concept in a second category (or a first category) of recognized concepts, and in response, the electronic device adds the respective recognized concept to the recognized concepts used to influence the generation of the automatically-generated visual media and displays a visual indication of the added recognized concept as described above with respect to visual indications of other recognized concepts. In some embodiments, recognized concepts in the first plurality of representations of concepts and recognized concepts in the second plurality of representations of concepts are selectable (e.g., using a selection or a movement input) to be added to the recognized concepts used to influence the generation of the automatically-generated visual media, such as using the swipe input including contact 652 directed towards recognized concept 644l in FIG. 6K. Allowing a user to navigate through a menu of recognized concepts grouped by category allows the user to easily identify and select recognized concepts to be used to generate the automatically-generated visual media, thereby reducing erroneous inputs to generate the automatically-generated visual media.

In some embodiments, while displaying the user interface that includes the prompt information, the electronic device displays a selectable option for removing a plurality of recognized concepts that will influence generation of the automatically-generated visual content, such as option 624a, shown in FIG. 6N and FIG. 6I. In some embodiments, the selectable option is a “remove all” or cancel option for removing the prompt and/or the one or more recognized concepts that comprise the prompt.

In some embodiments, while displaying the selectable option, the electronic device detects, via the one or more input devices, an input directed towards the selectable option, such as the electronic device detecting contact 658b (e.g., a tap or long press input) directed towards option 624a, shown in FIG. 6N, and the electronic device detecting contact 658a (e.g., a tap or long press input) directed towards option 624a, shown in FIG. 6I. In some embodiments, the input is a selection input, such as a tap or long press with a contact (e.g., a finger, or stylus), selection with an indirect input device (e.g., mouse, remote control, or trackpad) that is directed to a location of the selectable option, or focus indicator such as a cursor or selection ring) and/or a gaze input (optionally as part of an air gesture). In some embodiments, the input is a voice input corresponding to a request to select the selectable option.

In some embodiments, in response to detecting the input, the electronic device removes the plurality of recognized concepts from being used to influence generation of the automatically-generated visual content, including ceasing display of one or more visual indications corresponding to the plurality of the recognized concepts (e.g., the recognized concepts that were removed), and ceasing using the plurality of the recognized concepts (e.g., the recognized concepts that were removed) to influence the generation of the automatically-generated visual content. For example, in response to detecting the input (e.g., a tap or a long press) with contact 648b shown in FIG. 6N, the electronic device ceases displaying the recognized concepts 620d through 620h, and begins displaying the user interface 604 shown in FIG. 6B. In some embodiments, ceasing the display of the visual indications of the one or more recognized concepts includes removing the prompt. In some embodiments, ceasing the display of the visual indications of the one or more recognized concepts includes no longer using the one or more recognized concepts to influence the generation of the automatically-generated visual media. In some embodiments, the electronic device does not remove the subject and/or style to be used to generate the automatically-generated visual content. In some embodiments, in response to detecting the input, the electronic device displays the user interface that is displayed prior to the electronic device receiving the prompt. In some embodiments, the selectable option is selectable to remove all (e.g., or multiple of) the recognized concepts currently being used to influence the generation of the automatically-generated visual content. Displaying an option to remove recognized concepts allows a user to easily and efficiently remove a plurality of recognized concepts, thereby reducing errors in output of the electronic device, and avoiding the need for additional input to correct such errors.

In some embodiments, removing the plurality of recognized concepts includes removing all of the recognized concepts that will influence the generation of the automatically-generated visual content, such as removing all the recognized concepts 620d through 620h, shown in FIG. 6N. In some embodiments, as described above, removing all of the recognized concepts includes no longer using the recognized concepts to influence the generation of the automatically-generated visual media. In some embodiments, removing all of the recognized concepts includes ceasing the display of the respective visual indications corresponding to the recognized concepts in the user interface. In some embodiments, removing all of the recognized concepts does not include removing the style and/or subject. In some embodiments, the style and subject of the automatically-generated visual media is described in greater detail in methods 1700, 1900, 2100, 2300, and/or 2500. In some embodiments, removing all of the recognized concepts includes removing the style and/or subject. Displaying a button to remove all recognized concepts allows a user to easily and efficiently remove a plurality of recognized concepts, thereby reducing errors in output of the electronic device, and avoiding the need for additional input to correct such errors.

In some embodiments, while displaying the first visual indication corresponding to the first recognized concept (e.g., the first visual indication as described above), the electronic device receives, via the one or more input devices, a first input corresponding to a request to add a second recognized concept corresponding to a representation of a person (e.g., an image of a person) that will influence the generation of the automatically-generated visual media, such as input (e.g., a tap or a long press) including contact 618 shown in FIG. 6B or if the electronic device had receives an input directed towards option 616 to add a representation of a person in FIG. 6B. Adding a recognized concept corresponding to a representation of a person is described in greater detail in method 800. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the first input, the electronic device displays, in the user interface, a second visual indication corresponding to the second recognized concept that will influence the generation of the automatically-generated visual media, such as displaying recognized concept 620a in FIG. 6C in response to the electronic device receiving the input in FIG. 6B. In some embodiments, the second visual indication includes a representation of the person. For example, the second visual indication is a picture of the person. In some embodiments, the representation of a person is a mutually exclusive recognized concept. For example, adding a recognized concept of a representation of a second person includes removing the previously added recognized concept of a representation of a first person. In some embodiments, the person is the starting media for the generation of the automatically-generated visual media, as described above. In some embodiments, before receiving the first input, the automatically-generated visual media is influenced by the recognized concept and not by the second recognized concept. In some embodiments, after receiving the first input, the automatically-generated visual media is influenced by the recognized concept and the second recognized concept. In some embodiments, adding the representation of the person includes adding a representation of a person from a collection of representations of people identified (e.g., by the electronic device and/or a server) from a media library (e.g., photo and/or video library) of the user, as described in greater detail in method 800. In some embodiments, the user selects a representation of a person identified as being important (e.g., by being named in the collection of representations of people and/or by being marked as a favorite person in the collection of representations of people, such as in response to user input). Including starting media of a representation of a person allows the electronic device to generate a generative image, thereby reducing errors in output of the electronic device, and avoiding the need for additional input to correct such errors.

In some embodiments, while displaying the first visual indication corresponding to the first recognized concept (e.g., the first visual indication as described above), the electronic device receives, via the one or more input devices, a first input corresponding to a request to add a second recognized concept corresponding to a representation of an animal (e.g., an image of a dog, cat, or another animal) that will influence the generation of the automatically-generated visual media, such as if input (e.g., a tap or a long press) including contact 618 was directed towards a selectable option of an animal in FIG. 6B. Adding a recognized concept corresponding to a representation of an animal includes one or more characteristics of adding a recognized concept corresponding to a representation of a person as described in greater detail in method 800 and above. In some embodiments, the second recognized concept corresponds to an individual animal, such as a particular animal; for example, a pet. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the animals that are available to be used as recognized concepts are animals that have been identified in a personal media collection of a user, such as one or more pets of a user. Sometimes these pets will have been identified as being important to the user by being marked as “favorites” or by being assigned one or more names. In some embodiments, the animals that are available to be used as recognized concepts have been identified in multiple media items or more than a threshold number of different media items (e.g., 5, 10, 100, or 1,000 media items).

In some embodiments, in response to receiving the first input, the electronic device displays, in the user interface, a second visual indication corresponding to the second recognized concept that will influence the generation of the automatically-generated visual media, such as if recognized concept 620a includes a representation of an animal in FIG. 6C. In some embodiments, the second visual indication includes a representation of the animal. For example, the second visual indication is a picture of the animal. In some embodiments, the representation of the animal is a mutually exclusive recognized concept. For example, adding a recognized concept of a representation of a second animal includes removing the previously added recognized concept of a representation of a first animal. In some embodiments, adding the representation of the animal includes removing the previously added recognized concept of a person or other object that is being used as the starting media. In some embodiments, adding the representation of the animal includes adding a representation of an animal from a collection of representations of animals identified (e.g., by the electronic device and/or by a server) from a media library (e.g., photo and/or video library) of the user, as described in greater detail in method 800. In some embodiments, the user selects a representation of an animal identified as being important (e.g., by being named in the collection of representations of animals and/or by being marked as a favorite animal in the collection of representations of animal, such as in response to a user input). Including starting media of a representation of an animal allows the electronic device to generate a generative image using starting media that is not a person, thereby reducing errors in output of the electronic device, and avoiding the need for additional input to correct such errors.

In some embodiments, displaying the user interface further comprises displaying a text entry region, such as text entry region 614, shown in FIG. 6G, configured to receive text corresponding to additional prompt information corresponding to one or more concepts that will influence the generation of the automatically-generated visual media. In some embodiments, a user adds and/or modifies the prompt to the second prompt (e.g., as described above) using the text entry region. In some embodiments, the electronic device receives text using a physical or virtual keyboard, with a voice command, or with handwriting (e.g., using a stylus). In some embodiments, in response to receiving text, the electronic device updates the representation of the prompt with the additional prompt information. In some embodiments, in response to receiving text, the electronic device displays representations of the additional recognized concepts corresponding to portions of the text that have been identified as recognized concepts. In some embodiments, the generation of the automatically-generated visual media is influenced by the additional recognized concepts. In some embodiments, the electronic device updates the representation of the automatically-generated visual media to include the representations of the additional recognized concepts, described below. In some embodiments, the prompt received by the electronic device in step(s) 702 that corresponds to the recognized concept is a text string, and the electronic device receives the prompt via input directed to the text entry region. Including a text entry region that receives text corresponding to additional prompt information on the user interface allows the user to easily input additional prompt information to be used to generate the automatically-generated visual media, thereby reducing erroneous inputs to generate the automatically-generated visual media.

In some embodiments, while displaying the user interface including the text entry region, the electronic device receives, via the one or more input devices, a first input that includes text directed towards the text entry region, such as shown by the voice command 634 in FIG. 6G resulting in prompt 636 being added to the text entry region 614. In some embodiments, the first input includes typing using a physical or virtual keyboard, with a voice command, or with handwriting using a stylus.

In some embodiments, in response to receiving the first input, in accordance with a determination that the first input corresponds to a plurality of recognized concepts that will influence the generation of the automatically-generated visual media, the electronic device displays, in the user interface, a first visual representation corresponding to the first input that indicates the plurality of recognized concepts of the text, such as shown by recognized concepts 629 as a cluster in FIG. 6H-B. In some embodiments, the electronic device identifies the one or more recognized concepts in the text using methods as described above. For example, the electronic device identifies keywords in the text. In some embodiments, the first visual representation has one or more characteristics of the first visual indication as described above. In some embodiments, the visual representation is a cluster of visual indications of recognized concepts. For example, when text includes and/or corresponds to a plurality of recognized concepts, the electronic device displays the visual indications as a first visual representation (e.g., a cluster of visual indications). For example, if the text is “on the beach wearing sunglasses”, then the first visual representation includes a visual indication of “beach” and a visual indication of “sunglasses”. In some embodiments, the visual representation for an individual recognized concept in the cluster includes icons/images, text, and/or a mix of images and text. For example, if there is no image or icon associated with a recognized concept, then the electronic device displays text associated with the recognized concept. In some embodiments, in accordance with a determination that the first input does not correspond to a plurality of recognized concepts that will influence the generation of the automatically-generated visual media, the electronic device forgoes displaying the first visual representation that indicates the plurality of recognized concepts of the text. In some embodiments, the first input includes text associated with one recognized concept. In some embodiments, the electronic device displays a visual indication corresponding to the recognized concept but the electronic device does not display a first visual representation including a cluster of visual indications (e.g., because there is only one recognized concept). Displaying more than one representation of recognized concepts corresponding to different recognized concepts of a prompt as a cluster allows a user to easily and efficiently see the concepts used to generate the generative image, thereby reducing errors in output of the electronic device, and avoiding the need for additional input to correct such errors.

In some embodiments, while displaying the first visual representation corresponding to the first input that indicates the plurality of recognized concepts of the text, the electronic device receives, via the one or more input devices, an input directed towards the visual representation, such as if the electronic device receives an input directed towards recognized concept 620c and the recognized concept 620c does not include the text “birthday” in FIG. 6S. In some embodiments, the input has one or more characteristics of the inputs as described above. In some embodiments, the input is a selection input (e.g., a tap input, an air gesture, or a gaze input).

In some embodiments, in response to receiving the input, the electronic device displays a second visual representation corresponding to the text wherein the second visual representation is different from the first visual representation corresponding to the first input, such as if recognized concept 620c only includes the text “birthday” after receiving the input in FIG. 6S. In some embodiments, the second visual representation is displayed concurrently with the first visual representation. In some embodiments, the second visual representation is displayed in place of the first visual representation (e.g., the electronic device ceases displaying the visual representation). In some embodiments, the second visual representation is the previously inputted text describing the recognized concepts while the first visual representation is a cluster of icons, text, or a combination thereof describing the text. In some embodiments, the second visual representation is displayed overlaid over (e.g., on top of) the visual representation. In some embodiments, the second visual representation is displayed to the right, left, above, or below the first visual representation. In some embodiments, the second visual representation is displayed in the text entry region that originally received the prompt and/or text. Redisplaying the text phrase corresponding to text after receiving an input directed towards the visual representation (e.g., a cluster of images) allows a user to easily and efficiently see the text used to generate the generative image, thereby reducing errors in output of the electronic device, and avoiding the need for additional input to correct such errors.

In some embodiments, the text entry region includes the representation of the prompt (e.g., as described above), such as text entry region 614 including prompt 636 in FIG. 6S.

In some embodiments, while displaying the user interface with the text entry region including the representation of the prompt, the electronic device receives, via the one or more input devices, an input corresponding to a request to change one or more recognized concepts that will influence the generation of the automatically-generated visual media, such as if the electronic device 500 receives a typing or voice command input in FIG. 6S. In some embodiments, the input has one or more characteristics of the inputs as described above. In some embodiments, the input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, changing the one or more recognized concepts includes changing the prompt from the first prompt to the second prompt, as described above. In some embodiments, changing the one or more recognized concepts includes modifying, adding, or deleting recognized concepts, as described above.

In some embodiments, in response to receiving the input, the electronic device displays, via the display generation component, an updated representation of the prompt in accordance with the request to change the one or more recognized concepts (e.g., by modifying or replacing the prior representation of the prompt), such as shown by the new prompt in the text entry field 614 in FIG. 6W. In some embodiments, updating the representation of the prompt includes updating the text to include the modifications, additions, or deletions of recognized concepts. For example, if the representation of the prompt includes “watching a movie in space” and the user adds “monkey” to the recognized concepts, then the representation of the prompt is updated to include “monkey” (e.g., “watching a movie in space with a monkey”). In some embodiments, updating the representation of the prompt includes changing the representation of the prompt from the first prompt to the second prompt, as described above. In some embodiments, the representation of the prompt changes randomly (e.g., the user randomly generates a prompt). Updating the representation of the prompt as the prompt changes (e.g., by modifying the recognized concepts or changing the prompt) allows a user to easily and efficiently see the concepts used to generate the generative image, thereby reducing errors in output of the electronic device, and avoiding the need for additional input to correct such errors.

In some embodiments, in response to receiving the prompt (e.g., the first prompt or the second prompt, as described above), the electronic device displays, via the display generation component, a representation of the automatically-generated visual media in the user interface that is influenced by the prompt information (e.g., the recognized concepts identified from one or more portions of the prompt), such as shown by representation 622c in FIG. 6W. In some embodiments, the representation of the automatically-generated visual media is a preview of the automatically-generated visual media that is based on the recognized concepts. In some embodiments, the representation of the automatically-generated visual media (e.g., the preview) is a lower resolution version of the automatically-generated visual media. In some embodiments, the representation of the automatically-generated visual media does not include all the characteristics of the automatically-generated visual media. Displaying a representation of the automatically-generated visual media allows a user to easily and efficiently see the representation of the automatically-generated visual media while also seeing the recognized concepts, thereby reducing the need for additional inputs to change the concepts used to generate the automatically-generated visual media.

In some embodiments, while displaying the first visual indication corresponding to the first recognized concept and while displaying the representation of the automatically-generated visual media, the electronic device receives, via the one or more input devices, a first input corresponding to a request to modify one or more recognized concepts that will influence the generation of the automatically-generated visual media, such as the input (e.g., a tap or a long press) including contact 672b in FIG. 6X. In some embodiments, the first input has one or more characteristics of the inputs as described above. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments modifying the one or more recognized concepts includes modifying the prompt, such as described above. In some embodiments, modifying the one or more recognized concepts includes adding a recognized concept from a database of recognized concepts, as described above. In some embodiments, modifying the one or more recognized concepts includes deleting/removing one or more recognized concepts that are currently being used to influence the generation of the automatically-generated visual media.

In some embodiments, in response to receiving the first input, the electronic device displays, via the display generation component, an updated representation of the automatically-generated visual media in accordance with the modifications of the one or more recognized concepts, such as shown by the representation 622c in FIG. 6Y including stars in response to the addition of the recognized concept 620l. In some embodiments, the modification is an addition of a second recognized concept and updating the representation of the automatically-generated visual media includes integrating the second recognized concept with the recognized concept in the representation of the automatically-generated visual media. In some embodiments, updating the representation of the automatically-generated visual media includes regenerating the representation of the automatically-generated visual media to include the second recognized concept. Additionally, in some embodiments, removing a recognized concept causes the electronic device to update the representation of the automatically-generated visual media to no longer include the recognized concept. Additionally, in some embodiments, modifying a recognized concept causes the electronic device to update the representation of the automatically-generated visual media to be influenced by the modification of the recognized concept Updating the representation of the automatically-generated visual media in response to modifying the recognized concepts allows a user to visualize the automatically-generated visual media thereby the need for additional input to regenerate the representation of the automatically-generated visual media after modifying the recognized concepts.

In some embodiments, while displaying the user interface including the representation of the automatically-generated visual media, the electronic device receives, via the one or more input devices, a first input corresponding to a request to generate the automatically-generated visual media based on the prompt corresponding to the one or more recognized concepts, such as input (e.g., a tap or a long press) including contact 670c in FIG. 6Y. In some embodiments, the first input includes one or more characteristics of the inputs described above. In some embodiments, the first input is a selection input directed towards a selectable option, that when selected, generates the automatically-generated visual media. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the first input, the electronic device ceases display of the representation of the automatically-generated visual media, such as no longer displaying representation 622c in FIG. 6Z. In some embodiments, the electronic device also ceases displaying the user interface including the recognized concepts used to influence the generation of the automatically-generated visual media. In some embodiments, the representation of the automatically-generated visual media is a low fidelity representation of the automatically-generated visual media. In some embodiments, the representation of the automatically-generated visual media does not include all the features/characteristics that are included in the automatically-generated visual media. For example, the representation of the automatically-generated visual media does not fully encapsulate all the recognized concepts. For example, if the recognized concept is “birthday in space”, the representation of automatically-generated visual media optionally includes stars and a birthday cake, wherein the automatically-generated visual media include stars, a birthday cake, birthday banners, all while set inside a space shuttle capsule.

In some embodiments, in response to receiving the first input, the electronic device displays, via the display generation component, a second representation of the automatically-generated visual media, wherein the second representation of the automatically-generated visual media is of higher fidelity than the representation of the automatically-generated visual media, such as the automatically-generated visual content shown in user interface 629e in FIG. 6Z. In some embodiments, and as described above, the automatically-generated visual media includes additional features and characteristics that are not included in the representation of the automatically-generated visual media. For example, the automatically-generated visual media is of higher resolution than the representation of the automatically-generated visual media. For example, the automatically-generated visual media includes more color depth, higher dynamic range, higher resolution, more detailed, larger scale, different colors, additional objects, and/or additional representations of recognized concepts than the representation of the automatically-generated visual media. In some embodiments, displaying the automatically-generated visual media includes displaying the automatically-generated visual media in a second user interface while ceasing display of the user interface including the recognized concepts. In some embodiments, the electronic device displays the automatically-generated visual media at a second size greater than a first size that the representation of the automatically-generated visual media is displayed with. Displaying a high fidelity representation of the automatically-generated visual media in response to receiving an input allows the user to quickly and efficiently see the automatically-generated visual media thereby reducing erroneous inputs to the electronic device.

In some embodiments, displaying the representation of the automatically-generated visual media includes animating the representation of the automatically-generated visual media over time, such as the boundary of the representation 622c changing over time in FIG. 6Y. In some embodiments, animating the representation of the automatically-generated visual media includes changing the boundary location between the representation of the automatically-generated visual media and the remainder of the user interface, which optionally changes the separation and/or distance between one or more visual indications of the one or more recognized concepts and the representation of the automatically-generated visual media. In some embodiments, animating the representation of the automatically-generated visual media includes changing the color, pattern, and/or texture of the boundary between the representation of the automatically-generated visual media and the remainder of the user interface. In some embodiments, the electronic device animates the representation of the automatically-generated visual media in response to detecting an input including a prompt and/or a recognized concept. Animating the representation of the automatically-generated visual media allows the user to quickly identify the representation of the automatically-generated visual media thereby reducing erroneous inputs to the electronic device.

In some embodiments, while displaying a second representation of the automatically-generated visual media (e.g., the second representation of the automatically-generated visual media is displayed at a larger size but at a same resolution and/or fidelity as the representation of the automatically-generated visual media. In some embodiments, the second representation of the automatically-generated visual media is the same as the representation of the automatically-generated visual media), the electronic device receives, via the one or more input devices, a sequence of one or more inputs corresponding to a request to display different automatically-generated visual media based on the prompt, such as the input (e.g., a tap or a long press) including contact 670i in Fig. JJ and the input (e.g., a tap or a long press) including contact 674b in FIG. 6KK. In some embodiments, the second representation of the automatically-generated visual media is displayed as a result of the sequence of one or more inputs (e.g., a selection input, such as a tap or a click or an air gesture) directed towards the representation of the automatically-generated visual media. In some embodiments, the input has one or more characteristics of the inputs as described above. In some embodiments, the representation of the automatically-generated visual media displayed in response to receiving the prompt is the same as the second representation of the automatically-generated visual media. In some embodiments, the sequence of one or more inputs directed to the second representation includes a selection input, such as a tap or long press with a contact (e.g., a finger, or stylus), selection with an indirect input device (e.g., mouse, remote control, or trackpad) that is directed to a location of a selectable option (e.g., the location of the second representation), or focus indicator such as a cursor or selection ring) and/or a gaze input (optionally as part of an air gesture). In some embodiments, the sequence of one or more inputs is a swipe input directed towards the second representation of the automatically-generated visual media. For example, the swipe input is a swipe (e.g., a tap and drag) with a contact, a swipe with an indirect input device and/or a gaze input. In some embodiments, the representation of the second automatically-generated visual media is a different image than the second representation of the automatically-generated visual media. In some embodiments, the representation of the second automatically-generated visual media is generated using the same prompt as the second representation of the automatically-generated visual media. In some embodiments, since the process to generate automatically-generated visual media is non-deterministic, described below, the second representation of the automatically-generated visual media is a different image (e.g., includes one or more different features) than the representation of the second automatically-generated visual media. In some embodiments, the input corresponding to the request to replace the second representation of the automatically-generated visual media with the representation of second automatically-generated visual media different from the automatically-generated visual media and based on the prompt does not alter the prompt and/or one or more or any of the recognized concepts used to generate the representation of the automatically-generated visual media and/or the second representation of the automatically-generated visual media. For example, the recognized concepts in FIG. 6JJ and FIG. 6MM are the same.

In some embodiments, in response to receiving the sequence of one or more inputs corresponding to the request to display different automatically-generated visual media based on the prompt, the electronic device displays, via the display generation component, a representation of the second automatically-generated visual media, such as representation 622b-b in FIG. 6LL. In some embodiments, the second automatically-generated visual media is different from the automatically-generated visual media (e.g., representation 622b-b of the second automatically-generated visual content in FIG. 6LL is different than representation 622b-a of the automatically-generated visual content in FIG. 6KK), the second automatically-generated visual media was generated based on the prompt (e.g., the same prompt that was used to generate the second representation of the automatically-generated visual media) (e.g., the representation 622b-b of the second automatically-generated visual content is generated using the same recognized concepts (e.g., recognized concepts 620d through 620h) as the representation 622b-a in FIG. 6KK), and the second automatically-generated visual media is displayed at a location that was previously occupied by the second representation of the automatically-generated visual content (e.g., representation 622b-b in FIG. 6LL is displayed at the same place as representation 622b-a in FIG. 6KK). In some embodiments, the second representation of the automatically-generated visual media ceases to be displayed. In some embodiments, a visual prominence of the second representation of the automatically-generated visual media is reduce (e.g., by reducing a size, opacity, brightness, saturation, and/or other visual property of the second representation of the automatically-generated visual content). In some embodiments, the second representation of the automatically-generated visual media is moved to a different location in the user interface that includes the second automatically-generated visual media. In some embodiments, the representation of the second automatically-generated visual media is generated using the same prompt (e.g., recognized concepts) as the second representation of the automatically-generated visual media. In some embodiments, the representation of the second automatically-generated visual media has one or more characteristics of the second representation of the automatically-generated visual media and the representation of the automatically-generated visual media, such as size and/or a displayed location within the user interface. In some embodiments, the representation of the second automatically-generated visual media is the same size as the second representation of the automatically-generated visual media. In some embodiments, the representation of the second automatically-generated visual media is a low fidelity representation of the second automatically-generated visual media. In some embodiments, the representation of the second automatically-generated visual media does not include all the features/characteristics that are included in the second automatically-generated visual media. In some embodiments, in response to a similar input (e.g., a swipe input described below) directed towards the representation of the second automatically-generated visual media, the electronic device displays a representation of a third automatically-generated visual media that is also generated using the same prompt and/or recognized concepts. In some embodiments, while displaying the representation of the second automatically-generated visual media, the electronic device receives an input corresponding to a request to generate the second automatically-generated visual media (e.g., the input is described in greater detail below), and as a result, the electronic device generates (e.g., using an AI process or a generative AI process) the second automatically-generated visual media (e.g., and not the automatically-generated visual media). Displaying a representation of a second automatically-generated visual media in response to receiving an input while displaying the second representation of the automatically-generated visual media allows the user to easily and efficiently see different versions of automatically-generated visual media that can be generated using the same prompt, thereby reducing the need for additional inputs to preview different versions of automatically-generated visual media using the same prompt.

In some embodiments, the input is a movement input directed towards the second representation of the automatically-generated visual media, such as the input including contact 674b in FIG. 6KK. For example, the swipe input is a swipe (e.g., a tap and drag) with a contact, a swipe with an indirect input device (e.g., a movement of a mouse, remote control, or trackpad), a gaze input (e.g., a movement of eyes), and/or an air-swipe input (e.g., a pinch and drag using a contact such as a user's index and thumb fingers). In some embodiments, the electronic device receives a left swipe input on the second representation of the automatically-generated visual media to display the representation of the second automatically-generated visual media. In some embodiments, the electronic device receives a right swipe while the electronic device is displaying the representation of the second automatically-generated visual media to display the second representation of the automatically-generated visual media. Using a swipe input directed towards the second representation of the automatically-generated visual media to display the representation of the second automatically-generated visual media simplifies the interaction with the electronic device by reducing the number of selectable options needed on the user interface thereby reducing the number of erroneous inputs.

In some embodiments, prior to receiving the sequence of one or more inputs corresponding to the request to display different automatically-generated visual media based on the prompt, the representation of the second automatically-generated visual media had not been generated. For example, in FIG. 6KK, the representation 622b-a has not been generated. In some embodiments, in response to receiving the prompt, the electronic device generates (e.g., using an AI process or a generative AI process) the automatically-generated visual media and/or one or more representations thereof without generating the second automatically-generated visual media, or other automatically-generated visual content based on the prompt. In some embodiments, the second automatically-generated visual media corresponding the representation of the second automatically-generated visual media is not generated until the electronic device receives the swipe input corresponding to a request to display the representation of the second automatically-generated visual media.

In some embodiments, in response to receiving the sequence of one or more inputs corresponding to the request to display different automatically-generated visual media based on the prompt, the electronic device generates (e.g., using an AI process or a generative AI process) the representation of the second automatically-generated visual media based on the prompt, such as generating representation 622b-b in FIG. 6LL in response to the input in FIG. 6KK. In some embodiments, while displaying the representation of the second automatically-generated visual media, the electronic device receives a right to left swipe directed towards the representation of the second automatically-generated visual media. In some embodiments, as a result, the electronic device generates (e.g., using an AI process or a generative AI process) a representation of a third automatically-generated visual media based on the prompt and displays the representation of the third automatically-generated visual media. In some embodiments, the representation of the third automatically-generated visual media and/or the third automatically-generated visual media is not generated until the right to left swipe is detected on the representation of the second automatically-generated visual media. In some embodiments, the electronic device generates (e.g., using an AI process or a generative AI process) one or more representations (e.g., 1, 2, 3, 5, or 10 representations) of automatically-generated visual content in response to receiving successive inputs to display additional automatically-generated visual media based on the prompt (e.g., the swipe input described above). Alternatively, in some embodiments, the electronic device generates (e.g., using an AI process or a generative AI process) a plurality (e.g., 1, 2, 3, 5, or 10) of automatically-generated visual media and/or their representations based on the prompt including the second representation of the automatically-generated visual media and the representation of the second automatically-generated visual media in response to receiving the prompt, such as if the electronic device generates (e.g., using an AI process or a generative AI process) the second representation of the automatically-generated visual content in FIG. 6KK and the representation of the second automatically-generated visual content in FIG. 6LL, concurrently. Generating the representation of the second automatically-generated visual media after receiving the input reducing the computational power need by the electronic device because representations of automatically-generated visual media are generated when requested by the user.

In some embodiments, displaying the representation of the automatically-generated visual content in the user interface includes displaying a selectable option for generating a three-dimensional representation of the automatically-generated visual content (e.g., a three-dimensional representation is described in greater detail in method 2500. The three-dimensional representation can be a true three-dimensional object, an object that has been generated with two or more views that can be viewed concurrently by different eyes to generate the illusion of stereoscopic depth (e.g., by simulating the appearance of a three-dimensional object from multiple viewpoints concurrently), and/or another type of three-dimensional representation. In some embodiments, the three-dimensional representation is a stereoscopic three-dimensional representation and/or a three-dimensional object that is generated using the prompt that is able to be viewed in three-dimensions), such as option 675a, shown in FIG. 6Z. In some embodiments, the three-dimensional representation is in a style that is distinct from the other styles that can be used to generate an automatically-generated visual content. In some embodiments, styles are described in greater detail herein, and in methods 1700, 1900, 2100, 2300, and 2500. In some embodiments, the option for generating a three-dimensional representation is an option separate from the one or more style options.

In some embodiments, the electronic device detects, via the one or more input device, an input directed towards the selectable option, such as detecting contact 680a (e.g., a tap or long press input), shown in FIG. 6Z. In some embodiments, the input is a selection input directed towards the selectable option, that when selected, causes the electronic device to generate and/or display the three-dimensional representation of the automatically-generated visual content. In some embodiments, the input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the input is a voice input corresponding to a request to select the selectable option.

In some embodiments, in response to detecting the input, the electronic device generates (e.g., the one or more recognized concepts influence the generation of the three-dimensional representation) a three-dimensional representation of the automatically-generated visual content, such as the automatically-generated visual content shown in FIG. 6AA′. In some embodiments, the three-dimensional representation retains one or more (or, optionally, all) the features (e.g., recognized concepts, styles, and/or subjects) of the automatically-generated visual content. For example, in response to detecting the input, the electronic device displays a three-dimensional version of the two-dimensional representation that was previously displayed. In some embodiments, the electronic device generates the three-dimensional representation using the same prompt as the previously generated automatically-generated visual content. Alternatively, in some embodiments, in response to detecting the input, the electronic device generates a new image based on the prompt that is three-dimensional and has a different composition (e.g., a different appearance and/or different automatically-generated elements such as a subject, style, foreground, and/or background) from the previously displayed two-dimensional representation, though still being based on the same prompt. For example, the electronic device generates a different representation of the prompt/recognized concepts using the new style (e.g., the three-dimensional style), as described in greater detail in method 1700. In some embodiments, displaying the three-dimensional representation includes retaining the selected style of the automatically-generated visual content. In some embodiments, the style is updated to the three-dimensional style in response to receiving the input. In some embodiments, the electronic device displays and/or generates the three-dimensional representation using one or more autonomous processes such as artificial neural networks and/or machine learning models, as described above. In some embodiments, the one or more autonomous processes includes characteristics of the one or more autonomous processes used to generate automatically-generated visual content (e.g., two-dimensional automatically-generated visual content). In some embodiments, the electronic device displays the three-dimensional representation after generating and/or saving the three-dimensional representation. In some embodiments, the three-dimensional representation is displayed using a different electronic device that has three-dimensional display capabilities (e.g., an electronic device with a lenticular display and/or on a head-mounted display). Displaying a selectable option to generate a three-dimensional version of the automatically-generated visual content while displaying the representation of the automatically-generated visual content allows the user to easily choose to generate the three-dimensional version without the need to provide additional input for defining the prompt, thereby reducing erroneous inputs to the electronic device.

In some embodiments, while displaying the user interface including the representation of the prompt and the first visual indication (e.g., representing the recognized concept), the electronic device receives, via the one or more input devices, an input corresponding to a request to generate the automatically-generated visual media, such as the input (e.g., a tap or a long press) including contact 670c directed towards option 624b in FIG. 6Y. In some embodiments, the input includes one or more characteristics of the inputs described above. In some embodiments, the input is a selection input directed towards a selectable option that, when selected, causes the electronic device to generate the automatically-generated visual media. In some embodiments, the input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the input, the electronic device initiates a process to generate the automatically-generated visual media (e.g., at the electronic device or at a server in communication with the electronic device), such as using the one or more autonomous processes to display the automatically-generated visual content shown in FIG. 6Z. In some embodiments, initiating the process to generate the automatically-generated visual media includes using one or more autonomous processes such as artificial neural networks and/or machine learning to generate the automatically-generated visual media, as described above. In some embodiments, the electronic device builds the recognized concepts and/or features into an image using artificial neural networks and/or machine learning. In some embodiments, once the automatically-generated visual media is generated, the electronic device displays the automatically-generated visual media, which is a higher fidelity representation than the representation of the automatically-generated visual media, as described above. In some embodiments, before receiving the input, the electronic device does not/has not generated the automatically-generated visual media; the electronic device instead optionally displays a preview of what will be generated (e.g., the representation of the automatically-generated visual media). In some embodiments, after initiating the process to generate the automatically-generated visual media, the automatically-generated visual content is generated and, optionally, displayed via the one or more display generation components. Initiating a process to generate the automatically-generated visual media while displaying the user interface allows the user to quickly and efficiently initiate the process to generate the automatically-generated visual media, thereby reducing erroneous inputs to the electronic device.

In some embodiments, while the automatically-generated visual media is influenced by one or more concepts of the prompt, the electronic device receives, via the one or more input devices, a first input corresponding to a request to regenerate the automatically-generated visual media such as the input (e.g., a tap or a long press) including contact 668 in FIG. 6S. In some embodiments, the first input includes one or more characteristics of the inputs as described above. In some embodiments, the first input is a selection input or a voice input. In some embodiments, the first input is directed towards an option to generate the second automatically-generated visual media. In some embodiments, the input does not change the prompt and/or the one or more recognized concepts that influence the generation of the automatically-generated visual media. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the first input, the electronic device displays, via the display generation component, a second automatically-generated visual media based on the prompt corresponding to the one or more recognized concepts, wherein the second automatically-generated visual media is different from the automatically-generated visual media, such as the automatically-generated visual content displayed in FIG. 6T. The automatically-generated visual content displayed in FIG. 6T is different than the automatically-generated visual content displayed in FIG. 6F even though the recognized concepts used to generate both are the same. In some embodiments, generating the second automatically-generated visual media includes generating the second automatically-generated visual media using the same prompt and recognized concepts as the first automatically-generated visual media. For example, the electronic device does not include additional recognized concepts to influence generation of the second automatically-generated visual media. In some embodiments, the electronic device uses a different random or pseudorandom seed value, or seed content to generate the second automatically-generated visual media. For example, and as described above, automatically-generated visual media is generated using one or more items of pre-existing visual media (e.g., images captured of the real world such as images captured by a camera or user created digital images or a modified version of a real world image or user created digital image) as a seed. For example, the electronic device uses a different image of “space” to generate the second automatically-generated visual media if the recognized concept is “space”. Regenerating the automatically-generated visual media using the same recognized concepts allows the user to receive different automatically-generated visual content without changing recognized concepts thereby reducing the number of inputs needed to create different automatically-generated visual content.

In some embodiments, the electronic device displays a gallery of automatically-generated visual content (e.g., without displaying a user interface that is used to generate a new automatically-generated visual content or prior to displaying the user interface that is used to generate a new automatically-generated visual content) (e.g., the user interface described above with or without the prompt information), such as shown in user interface 600 in FIG. 6R. In some embodiments, the gallery of automatically-generated visual content includes a plurality of previously generated visual content, as described in method 800.

In some embodiments, while displaying the gallery of automatically-generated visual content, the electronic device receives, via the one or more input devices, a first input directed towards a selectable option to display the user interface that includes the prompt information, such as the input (e.g., a tap or a long press) including contact 666 in FIG. 6R. In some embodiments, the first input includes one or more characteristics of the inputs described above. In some embodiments, the first input is directed towards a selectable option that is selectable to generate a new automatically-generated visual content or towards a previously generated automatically-generated visual content. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the first input, the electronic device ceases display of the gallery of automatically-generated visual content and displays, via the display generation component, the user interface that includes the prompt information, such as shown in user interface 604 in FIG. 6S. In some embodiments, the user interface that includes the prompt information includes one or more characteristics of the user interface as described above. In some embodiments, the user interface displays the prompt information corresponding to the respective previously generated automatically-generated visual content. In some embodiments, the user modifies the prompt and/or the respective objects wile displaying the user interface, as described above. In some embodiments, if the first input is directed towards the selectable option that is selectable to generate a new automatically-generated visual content, then the user interface does not automatically include prompt information and the user is prompted to enter a prompt and/or recognized concepts. Displaying the user interface in response to an input while displaying the gallery of automatically-generated visual content allows the user to efficiently create automatically-generated visual content, thereby reducing the number of erroneous inputs to the electronic device.

In some embodiments, the electronic device receives, via the one or more input devices, a first input corresponding to a request to generate second automatically-generated visual media based on a second prompt, wherein the second prompt corresponds to a second recognized concept (e.g., the second prompt includes one or more additional recognized concepts), such as shown with the input including contact 620g in FIG. 6GG. In some embodiments, the first input includes one or more characteristics of the inputs described above. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the electronic device receives the first input while displaying the user interface that includes the prompt information. In some embodiments, the electronic device receives the input to generate the second generative visual content based on the second prompt using a voice command. For example, the user uses a virtual assistant to generate the second automatically-generated visual media based on the second prompt. In some embodiments, the input is an input while displaying the user interface and the preview of the second automatically-generated visual media) and thus results in creation, display and/or updating of a preview of the second automatically-generated visual media, and in some embodiments, the input is an input to actually initiate generation of the second automatically-generated visual media, and thus results in creation and/or display of the second automatically-generated visual media.

In some embodiments, in response to receiving the first input, in accordance with a determination that the second recognized concept satisfies one or more criteria, initiating a process to generate the second visual generative visual content based on the second recognized concept, such as if the concept in text entry field 614 was not a high risk concept and the electronic device receives the input (e.g., a tap or a long press) including contact 670h in FIG. 6HH. In some embodiments, the one or more criteria includes a criterion that is satisfied when the prompt does not include high risk recognized concepts. In some embodiments, the database of recognized concepts, as described above, includes a database of high risk recognized concepts. In some embodiments, a user can determine high risk recognized concepts. In some embodiments, high risk recognized concepts are determined by an administrator of the content application and/or the content user interface. In some embodiments, while in the user interface including the prompt information, initiating the process to generate the second automatically-generated visual media includes updating the representation of the automatically-generated visual media to include the second recognized concept and/or generating the second automatically-generated visual media in response to an input corresponding to a request to generate the second automatically-generated visual media. In some embodiments, while in the user interface including the automatically-generated visual media, initiating the process to generate the second automatically-generated visual media includes redisplaying the user interface including the prompt and a visual representation of the second recognized concept that satisfies the one or more criteria. In some embodiments, the user interface also includes an updated representation of the automatically-generated visual media to incorporate the second recognized concept. In some embodiments, after initiating the process to generate the second automatically-generated visual media, the second automatically-generated visual content is generated and, optionally, displayed via the one or more display generation components.

In some embodiments, in response to receiving the first input, in accordance with a determination that the second recognized concept does not satisfy the one or more criteria, forgoing initiating the process to generate the second automatically-generated visual media based on the second recognized concept, such as not generating the automatically-generated visual content including the second recognized concept “gun” in FIG. 6II. In some embodiments, high risk recognized concepts (e.g., recognized concepts that don't satisfy the one or more criteria) include concepts relating to violence, drugs, and/or trademarked concepts. In some embodiments, high risk recognized concepts are described in greater detail in method 700. In some embodiments, the electronic device generates (e.g., using an AI process or a generative AI process) the second generative visual content using other recognized concepts identified in the second prompt (e.g., recognized concepts that satisfy the one or more criteria), without generating the second generative visual content using the high risk recognized concept, as described below. In some embodiments, the electronic device forgoes generating the second automatically-generated visual media in response to identifying the high risk recognized concept, as described below. In some embodiments, if the prompt only includes one recognized concept (e.g., a recognized concept that does not satisfy the one or more criteria), then the electronic device does not generate the representation of the second automatically-generated visual media or the second automatically-generated visual media. Detecting high risk recognized concepts and not generating the second generative visual content as a result, reduces the number of inputs needed by a user thereby reducing erroneous inputs to the electronic device.

In some embodiments, forgoing initiating the process to generate the second automatically-generated visual media based on the second recognized concept in response to receiving the first input further comprises initiating a process to generate third automatically-generated visual media based on a third recognized concept corresponding to the second prompt that satisfies the one or more criteria and not based on the second recognized concept that does not satisfy the one or more criteria, such as generating the automatically-generated visual content in FIG. 6II without the second recognized concept “gun”. In some embodiments, the electronic device generates (e.g., using an AI process or a generative AI process) the generative visual content using the recognized concepts identified in the portion of the second prompt that satisfies the one or more criteria. In some embodiments, initiating the process to generate the third automatically-generated visual media includes displaying a representation (e.g., preview) of the third automatically-generated visual media in the user interface and/or displaying the third automatically-generated visual media in response to generating the third automatically-generated visual media. Automatically generating a generative visual content without the high risk recognized concepts reduces the number of inputs needed by a user thereby reducing erroneous inputs to the electronic device.

In some embodiments, forgoing initiating the process to generate the second automatically-generated visual media based on the second recognized concept in response to receiving the first input further comprises forgoing generating the second automatically-generated visual media, such as if the electronic device 500 does not display the user interface 629g in FIG. 1I in response to receiving the input in FIG. 6HH. In some embodiments, in response to detecting that a portion of the prompt does not satisfy the one or more criteria, the electronic device forgoes displaying the second automatically-generated visual media. For example, the electronic device displays an error message instead of an automatically-generated visual media. In some embodiments, forgoing initiating the process to generate the second automatically-generated visual media includes forgoing displaying a representation (e.g., preview) of the second automatically-generated visual media in the user interface and/or forgoing displaying the second automatically-generated visual media in response to an input corresponding to a request to generate the second automatically-generated visual media. Forgoing generating a generative visual content with the high risk recognized concepts reduces the number of inputs needed by a user to identify the high risk recognized concepts thereby reducing erroneous inputs to the electronic device.

In some embodiments, forgoing initiating the process to generate the second visual generative visual content based on the second recognized concept further comprises displaying, via the display generation component, a visual indication indicating a portion of the second prompt (e.g., the portion corresponding to the second recognized concept) that does not satisfy the one or more criteria (e.g., an icon such as an exclamation point or text indicating an error) in the user interface including a representation of the second prompt (e.g., the user interface described above), such as if the electronic device 500 displays “gun” as a recognized concept in the user interface 604 in FIG. 6HH with an indication that the recognized concept does not satisfy the one or more criteria (e.g., display with an exclamation point or with a text indicating that the recognized concept is undefined). In some embodiments, initiating the process to generate the second visual generative visual content based on the second recognized concept includes forgoing displaying the visual indication, such as shown in FIG. 6FF, where the recognized concept “gun” is not shown. In some embodiments, in accordance with a determination that a first portion of the second prompt satisfies the one or more criteria and a second portion of the second prompt does not satisfy the one or more criteria, the electronic device displays a visual indication that the first portion of the second prompt does not satisfy the one or more criteria (in addition to or instead of displaying a visual indication that the second portion of the second prompt does not satisfy the one or more criteria). In some embodiments, the visual indication is located on or near the recognized concept corresponding to the first portion of the second prompt. In some embodiments, the visual indication includes text, images, and/or color indicating that the recognized concept does not satisfy the one or more first criteria. In some embodiments, the visual indication includes a red exclamation point and/or text including “error”. In some embodiments, in accordance with a determination that the second portion of the second prompt satisfies the one or more criteria and the first portion of the second prompt does not satisfy the one or more criteria, the electronic device displays a visual indication that the second portion of the second prompt does not satisfy the one or more criteria (in addition to or instead of displaying the visual indication that the first portion of the second prompt does not satisfy the one or more criteria). In some embodiments, the visual indication includes one or more characteristics of the visual indication described above. In some embodiments, the portions of the prompt associated with recognized concepts that satisfies the one or more criteria do not include a display of the visual indication. In some embodiments, if the portion of the second prompt does not satisfy a first criterion (e.g., the portion of the second prompt includes trademarked concepts), then the electronic device displays a first visual indication. In some embodiments, if the portion of the second prompt does not satisfy a second criterion (e.g., the concepts in the portion of the second prompt are not recognized (e.g., unknown words)), then the electronic device displays a second visual indication, different than the first visual indication. In some embodiments, if the portion of the second prompt does not satisfy a third criterion (e.g., the portion of the second prompt includes concepts that depict violence), then the electronic device displays a third visual indication, different than the second visual indication. In some embodiments, the first, second, and third visual indications (and any additional visual indications of concepts that do not satisfy the one or more criteria for other reasons) include an indication of the particular reason why the portion of the prompt does not satisfy the one or more criteria, such as text or an image indicating the reason. In some embodiments, the different visual indications have different visual appearances. Displaying a visual indication indicating the high risk recognized concepts reduces the number of inputs needed by a user to identify the high risk recognized concepts thereby reducing erroneous inputs to the electronic device.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 800, 1000, 1200, 1400, 1500, 1700, 1900, 2100, 2300, and/or 2700) are also applicable in an analogous manner to method 700 described above with respect to FIG. 7. For example, the operation of the electronic device to display a representation of a prompt and one or more recognized concepts described above with reference to method 700 optionally has one or more of the characteristics of editing one or more parameters, including one or more recognized concepts, of a previously generated automatically-generated visual content, the addition of a representation of automatically-generated visual content into a first application, and the presentation of an automatically-generated visual media creation user interface to use a non-automatically-generated visual media as the reference media item, generating multiple variations of representations of automatically-generated visual content, restricting prompt components to be used to generate automatically-generated visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., methods 800, 1000, 1200, 1400, 1500, 1700, 1900, 2100, 2300, and/or 2700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 702b, and receiving operation 702a are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIG. 8 illustrates a flow diagram illustrating a method in which an electronic device edits one or more parameters associated with a previously generated automatically-generated visual content and regenerates a new automatically-generated visual content in accordance with some embodiments of the disclosure. The method 800 is optionally performed at first electronic device and/or electronic devices such as device 100, device 300, or device 500 as described above with reference to FIGS. 1A-1B, 2-3, 4A-4B and 5A-5H. Some operations in method 800 are, optionally combined and/or order of some operations is, optionally, changed.

As described below, the method 800 provides ways in which an electronic device edits one or more parameters of a previously generated automatically-generated visual content. Allowing a user to edit previously generated media allows the user to efficiently change recognized concepts of a previously generated media item, thereby reducing computing resources used by the electronic device, and also reduces erroneous inputs to the electronic device.

Method 800 is performed at an electronic device in communication with a display generation component and one or more input devices, such as electronic device 500 shown in FIG. 6A. In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, the electronic device displays, via the display generation component, a generative visual content user interface including one or more representations of one or more previously generated automatically-generated visual content that were generated at least partially using one or more autonomous processes, such as shown by the user interface 600 including automatically-generated visual content 602a through 602k shown in FIGS. 6A, 6R, and 6BB. In some embodiments, the generative visual content user interface is a user interface of a content application. In some embodiments, the electronic device produces and stores a plurality of automatically-generated visual content using the content application. In some embodiments, the automatically-generated visual content are generated at a server (e.g., based on data sent from the electronic device), and the electronic device displays the generative images after receiving data for those generative images from the server. In some embodiments, the content user interface includes a content entry field (e.g., a text entry field and/or a content (e.g., image and/or video) entry field) where a user inputs prompts, as described in method 700 to generate visual media (e.g., generative image(s)), such as shown by text entry field 614. In some embodiments, the content user interface also includes a user interface element that is selectable to input a starting media for creating a generative image, as described in method 700, such as shown by option 616 shown in FIG. 6B. In some embodiments, the one or more previously generated automatically-generated visual content includes pictures and/or videos that a user has generated previously using the content application (e.g., such as automatically-generated visual media as described with reference to method 700) and has indicated that they are to be saved. In some embodiments, the one or more autonomous processes includes the one or more autonomous processes as described in method 700. In some embodiments, the previously generated automatically-generated visual content include automatically-generated visual content generated by electronic devices associated with user accounts other than the user account associated with the electronic device. In some embodiments, the previously generated automatically-generated visual content do not include automatically-generated visual content generated by electronic devices associated with user accounts other than the user account associated with the electronic device. In some embodiments, the previously generated automatically-generated visual content are stored at a server in communication with the electronic device and displayed on the electronic device.

In some embodiments, while displaying the generative visual content user interface, the electronic device receives, via the one or more input devices, a first input directed to a first representation of a first previously generated automatically-generated visual content of the one or more previously generated automatically-generated visual content, such as shown by input (e.g., a tap or a long press) including contact 666 directed towards automatically-generated visual content 602g in FIG. 6R. In some embodiments, the first input is a selection input, such as a tap, a gaze, and/or a click using a mouse/trackpad directed towards the first representation of the first previously generated generative visual content.

In some embodiments, in response to receiving the input, the electronic device displays, via the display generation component, an editing user interface for editing the first previously generated automatically-generated visual content including one or more selectable options to edit one or more parameters used to generate the first previously generated automatically-generated visual content, wherein the editing user interface indicates one or more parameters (e.g., one or more values for dynamic parameters or one or more recognized concepts) that were used to generate the first previously automatically-generated visual content, such as shown by user interface 604 in FIG. 6S including the recognized concepts 620a through 620C used to influence the generation of the automatically-generated visual content 602g. In some embodiments, the editing user interface includes visual indications of recognized concepts. In some embodiments, the recognized concepts are the portions from the prompt inputted that have been identified as recognized concepts, which is described in greater detail in method 700. In some embodiments, the first visual indication of a first recognized concept includes a selectable option to delete the first recognized concept (e.g., the parameter), a selectable option to add additional recognized concepts, and/or a selectable option to edit the first recognized concept. In some embodiments, a second visual indication of a second recognized concept includes a selectable option to delete the second recognized concept, and/or a selectable option to edit the second recognized concept. In some embodiments, the editing user interface includes a search bar that has one or more characteristics of the search bar described in method 700, and that receives additional prompts from the user to be used to generate additional recognized concepts (e.g., to add to the first set or the second set of recognized concepts).

In some embodiments, while displaying the editing user interface, detecting a set of one or more inputs including a second input directed to a respective selectable option of the one or more selectable options, such as while displaying the user interface 604, receiving an input (e.g., a tap or a long press) including contact 672a in FIG. 6U. In some embodiments, the second input is a selection input, that has one or more characteristics of the first input, as described above. In some embodiments, the respective selectable option is one of the selectable options to edit, delete, or add recognized concepts, as described above.

In some embodiments, in response to detecting the set of one or more inputs including the second input directed to the respective selectable option of the one or more selectable options, the electronic device changes the one or more parameters, such as adding recognized concept 620i to user interface 604 in FIG. 6V. In some embodiments, editing (e.g., adding, changing, or deleting) parameters used for generating the automatically-generated visual content changes the resulting automatically-generated visual content, as described below. In some embodiments, changing the one or more parameters includes changing the one or more recognized concepts used to generate the automatically-generated visual content. In some embodiments, changing the one or more parameters includes changing and/or adding a prompt used to generate the automatically-generated visual content (e.g., the first previously generated visual content). Allowing a user to edit previously generated media allows the user to efficiently change recognized concepts of a previously generated media item, thereby reducing computing resources used by the electronic device, and also reduces erroneous inputs to the electronic device.

In some embodiments, the editing user interface includes a first visual indication of a first parameter used to generate the first previously generated automatically-generated visual content, such as recognized concept 620c in FIG. 6U. In some embodiments, the first parameter is a recognized concept, described further in method 700. In some embodiments, the editing user interface includes one or more visual indications of one or more parameters used to influence the generation of the first previously generated generative visual content in a manner similar to the manner of displaying visual indications of recognized concepts described above with reference to method 700. Displaying the parameters used to generate the automatically-generated visual media while in the editing user interface allows a user to easily and efficiently see the concepts used to generate the generative image, thereby reducing errors in output of the electronic device, and avoiding the need for additional input to correct such errors.

In some embodiments, while displaying the editing user interface, the electronic device changes the one or more parameters used to generate the first previously generated automatically-generated visual content, such as inputting a new prompt (e.g., second prompt 676) into text entry field 614 in FIG. 6V. In some embodiments, changing the one or more parameters includes adding, modifying, or deleting one or more recognized concepts in accordance with method 700.

In some embodiments, after changing the one or more parameters, the electronic device receives, via the one or more input devices, a second input corresponding to a request to generate a second automatically-generated visual content based on the changed one or more parameters, such as the input (e.g., a tap or a long press) including contact 670c in FIG. 6Y. In some embodiments, the second input has one or more characteristics of the input described above. In some embodiments, the second input includes a selection input, such as a tap or a long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the second input is a selection input directed towards a selectable option that is selectable to generate the second automatically-generated visual content.

In some embodiments, in response to receiving the second input, the electronic device initiates a process to generate the second automatically-generated visual content, different than the first previously automatically-generated visual content, based on the changed one or more parameters. The electronic device uses one or more autonomous processes to generated the second automatically-generated visual content shown in FIG. 6Z. In some embodiments, generating the second automatically-generated visual content includes generating the second automatically-generated visual content using the new recognized concepts. In some embodiments, generating the second automatically-generated visual content includes one or more characteristics of generating the automatically-generated visual content described in method 700. In some embodiments, initiating the process to generate the second automatically-generated visual content includes updating the representation of the second automatically-generated visual content, described in greater detail in method 700, and generating the second automatically-generated visual content. In some embodiments, after initiating the process to generate the second automatically-generated visual media, the second automatically-generated visual content is generated and, optionally, displayed via the one or more display generation components.

In some embodiments, after generating the second automatically-generated visual content (e.g., in response to generating the second automatically-generated visual content and/or in response to a sequence of one or more inputs that includes the second input), the electronic device displays, via the display generation component, the second automatically-generated visual content, such as the second automatically-generated visual content shown in FIG. 6Z.

Modifying a parameter while in the editing user interface allows a user to easily and efficiently modify the recognized concepts used to generate the generative image, thereby reducing errors in output of the electronic device, and avoiding the need for additional input to correct such errors.

In some embodiments, after generating (and, optionally, after displaying) the second automatically-generated visual content, the electronic device receives, via the one or more input devices, a third input corresponding to a request to save the second automatically-generated visual content, such as the input (e.g., a tap or a long press) including contact 670d directed towards the option 630b in FIG. 6Z In some embodiments the third input has one or more characteristics of the input as described above. In some embodiments, the third input is directed towards a selectable option. In some embodiments, the third input is a voice input or a gaze input (optionally as part of an air gesture). In some embodiments, the third input is directed towards a selectable option in a user interface including the second automatically-generated visual content.

In some embodiments, in response to receiving the third input, in accordance with a determination that the third input is directed towards a first option (e.g., a save or replace option that is optionally a selectable button and/or in accordance with a determination that the third input corresponds to a request to replace the first previously generated visual content), the electronic device replaces the first previously generated visual content in the generative visual content user interface with the second automatically-generated visual content, such as if the input is directed towards option 630d in FIG. 6AA. In some embodiments, replacing the first previously generated visual content with the second automatically-generated visual content also includes no longer displaying the first previously generated visual content on the generative visual content user interface. In some embodiments, replacing the first previously generated visual content with the second automatically-generated visual content means saving the second generated visual content over the first previously generated visual content. In some embodiments, after generating the second automatically-generated visual content (e.g., in response to generating the second automatically-generated visual content and/or in response to a sequence of one or more inputs that includes the second input), displaying, via the display generation component, the second automatically-generated visual content in the generative visual content user interface without displaying the first automatically-generated visual content in the generative visual content user interface (e.g., because the first generative visual content has been replaced with the second generative visual content). In some embodiments, the first generative visual content had a respective position in an ordered media gallery in the generative visual content user interface and the second generative visual content is displayed at the position in the media gallery.

In some embodiments, in response to receiving the third input, in accordance with a determination that the third input is directed towards a second option (e.g., a save as a copy option that is optionally a selectable button and/or in accordance with a determination that the third input corresponds to a request to save the second automatically-generated visual content without replacing the first previously generated visual content), saving the second automatically-generated visual content as a new automatically-generated visual content to be displayed in the generative visual content user interface (e.g., while maintaining the first previously generated visual content), such as if the input is directed towards option 630e in FIG. 6AA. In some embodiments, saving the second automatically-generated visual content as a new automatically-generated visual content to be displayed in the generative visual content user interface also includes displaying both the second generated visual content and the first previously generated visual content in the generative visual content user interface. In some embodiments, after generating the second automatically-generated visual content (e.g., in response to generating the second automatically-generated visual content and/or in response to a sequence of one or more inputs that includes the second input), displaying, via the display generation component, the second automatically-generated visual content in the generative visual content user interface concurrently with displaying the first automatically-generated visual content in the generative visual content user interface (e.g., because the second generative visual content is displayed in addition to the second generative visual content), such as the concurrent display of the automatically-generated visual content 602g and automatically-generated visual content 602i in FIG. 6BB. In some embodiments, the first generative visual content had a first position in an ordered media gallery in the generative visual content user interface and the second generative visual content is displayed at a second position in the media gallery that is different from the first position in the media gallery, while the first generative visual content continues to be displayed at the first position in the media gallery. Including an option to save an automatically-generated visual content as a new automatically-generated visual content and including an option to replace the automatically-generated visual content with the new automatically-generated visual content allows a user to quickly and efficiently save the automatically-generated visual content, thereby reducing the erroneous inputs to the electronic device.

In some embodiments, while displaying the editing user interface for editing the first previously generated automatically-generated visual content (e.g., user interface 604 in FIG. 6S), the electronic device receives a second input (e.g., the second input includes one or more characteristics of the input as described above), via the one or more input devices, directed towards an option (and/or corresponding to a request) to generate a second automatically-generated visual content using the one or more parameters used to generate the first previously generated automatically-generated visual content, such as the input (e.g., a tap or a long press) including contact 668 directed towards option 624b. In some embodiments, the second input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the electronic device generates (e.g., using an AI process or a generative AI process) the second automatically-generated visual content using the same prompt and/or recognized concepts as the first previously generated automatically-generated visual content. In some embodiments, the option is a selectable option or the user uses a voice command to “select” the option or initiate the option to generate the second automatically-generated visual content. In some embodiments, the second input does not change the prompt and/or the one or more recognized concepts that influence the generation of the automatically-generated visual media.

In some embodiments, in response to receiving the second input, the electronic device initiates a process to generate a second automatically-generated visual content, different than the first previously automatically-generated visual content, based on the one or more parameters, such as using one or more autonomous processes to generate the image shown in FIG. 6T. In some embodiments, regenerating an automatically-generated visual content using the same parameters (e.g., recognized concepts) is described in greater detail in method 700. In some embodiments, the electronic device uses a different random or pseudorandom seed value, or seed content to generate the second automatically-generated visual media. For example, the electronic device does not include additional recognized concepts to generate the second automatically-generated visual content. For example, and as described above, automatically-generated visual media is generated using one or more items of pre-existing visual media (e.g., images captured of the real world such as images captured by a camera or user created digital images or a modified version of a real world image or user created digital image) as a seed. For example, the electronic device uses a different image of “space” to generate the second automatically-generated visual media if the recognized concept is “space”. In some embodiments, generating the second automatically-generated visual content includes updating the representation (e.g., preview) of the second automatically-generated visual content and/or displaying and/or generating the second automatically-generated visual content. In some embodiments, after initiating the process to generate the second automatically-generated visual media, the second automatically-generated visual content is generated and, optionally, displayed via the one or more display generation components.

In some embodiments, after generating the second automatically-generated visual content (e.g., in response to generating the second automatically-generated visual content and/or in response to a sequence of one or more inputs that includes the second input), the electronic device displays, via the display generation component, the second automatically-generated visual content, such as the automatically-generated visual content shown in FIG. 6T. Regenerating the automatically-generated visual media using the same recognized concepts allows the user to receive different automatically-generated visual content without changing recognized concepts thereby reducing the number of inputs needed to create different automatically-generated visual content.

In some embodiments, displaying the editing user interface further includes concurrently displaying at least a portion of the generative visual content user interface, such as if user interface 600 is displayed with user interface 604 in FIG. 6S. In some embodiments, the editing user interface is overlaid over the generative visual content user interface. In some embodiments, the electronic device does not concurrently display a portion of the generative visual content user interface while displaying the editing user interface. Displaying a portion of the generative visual content user interface while displaying the editing user interface allows the user to view additional information while editing a generative visual content, thereby reducing erroneous inputs to the electronic device.

In some embodiments, the one or more parameters includes a person represented by the first previously generated automatically-generated visual content (e.g., the person includes one or more characteristics of the representation of a person as described in method 700), and changing the one or more parameters includes receiving an input, via the one or more input devices, corresponding to a request to change the person represented by the first previously generated visual content from a first person to a second person different from the first person, such as by inputting text changing the person shown by the second prompt 676 in FIG. 6V which results in the person changing from Jenna to Jerome in FIG. 6W. In some embodiments, the input is a user input that has one or more characteristics of the inputs described above. In some embodiments, the input is a voice input. In some embodiments, the user selected the second person from a photo library or using the camera application. In some embodiments, the electronic device displays a plurality of representations of different people including the first person and the second person and the user selects the representation of the second person to change the person represented. In response to changing the person from the first person to the second person, the electronic device optionally regenerates the representation (e.g., preview) of the automatically-generated visual content based on the new parameters, as described in method 700. In some embodiments, after regenerating the representation of the automatically-generated visual media based on the new parameters, the electronic device receives a request to generate the automatically-generated visual content and as a result, the electronic device displays, via the display generation component, the automatically-generated visual content including the new parameters. Allowing a user to change the person represented by the previously generated visual content without changing the other parameters allows a user to easily and efficiently change the starting media, thereby reducing erroneous inputs to the electronic device.

In some embodiments, while the first previously automatically-generated visual content is associated with the first person, receiving an input corresponding to selection of an image of a second person (e.g., via a photo library or via a camera application. In some embodiments, the image of the second person is or is part of a video including the person, or is not part of a video.), such as an input (e.g., a tap or a long press) including contact 618 directed towards option 608a in FIG. 6B. In some embodiments, the input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to receiving the input corresponding to selection of the image of the second person, using the image of the second person as a recognized concept that will influence generation of the automatically-generated visual media, such as “Jenna” displayed as a recognized concept 620a in FIG. 6C. Alternatively, in some embodiments, the user can select a video of a person (e.g., of a second person). In some embodiments, changing the person associated with the visual content includes having the ability to regenerate the visual content using the second person instead of the first person. In some embodiments, the user selects a photo from a photo library of a second person or the user takes a picture of the second person using a camera application. Allowing a user to change the person represented by the previously generated visual content without changing the other parameters allows a user to easily and efficiently change the starting media, thereby reducing erroneous inputs to the electronic device.

In some embodiments, receiving the input corresponding to the selection of the image of the second person comprises receiving a first input corresponding to a request to open a view of a media library, such as if the electronic device receives an input directed towards option 616 in FIG. 6C; In some embodiments, the first input includes one or more characteristics of the selection input as described herein.

In some embodiments, in response to receiving the first input, the electronic device displays the view of the media library, such as if the electronic device 500 displays a media library in response to the input. In some embodiments, the media library includes a plurality of images and/or videos. In some embodiments, the media library includes a plurality of images and/or videos of the second person and of other people, objects, or environments (e.g., of animals, people, or scenery). In some embodiments, the media library includes a plurality of images and/or videos captured using the camera application and/or saved to the library, described below. In some embodiments, the media library includes photos and/or images transmitted from a second user account (e.g., via a message) and saved to the media library. In some embodiments, the media library includes automatically-generated visual content. In some embodiments, the images and/or videos in the media library are saved on the electronic device and/or on a server.

In some embodiments, while displaying the view of the media library, the electronic device receives a second input corresponding to the selection of the image of the second person in the media library, such as if the electronic device 500 receives an input directed towards a representation of a second person while in the media library. As described above, the user chooses a photo of a person from an image library (e.g., photo and/or video library). Allowing a user to change the person represented by the previously generated visual content using an image library or a camera application without changing the other parameters allows a user to easily and efficiently change the starting media, thereby reducing erroneous inputs to the electronic device.

In some embodiments, receiving the input corresponding to the selection of the image of the second person comprises receiving a first input corresponding to a request to open a view of a camera application including a live preview of a physical environment, such as if the electronic device receives an input directed towards selectable option 616 in FIG. 6C In some embodiments, the first input has one or more characteristics of the inputs as described herein. In some embodiments, the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture). In some embodiments, the view of the camera application is displayed overlaid over the editing user interface. In some embodiments, the camera application is an application including one or more options to take a picture and/or video of the physical environment shown in the live preview of the physical environment.

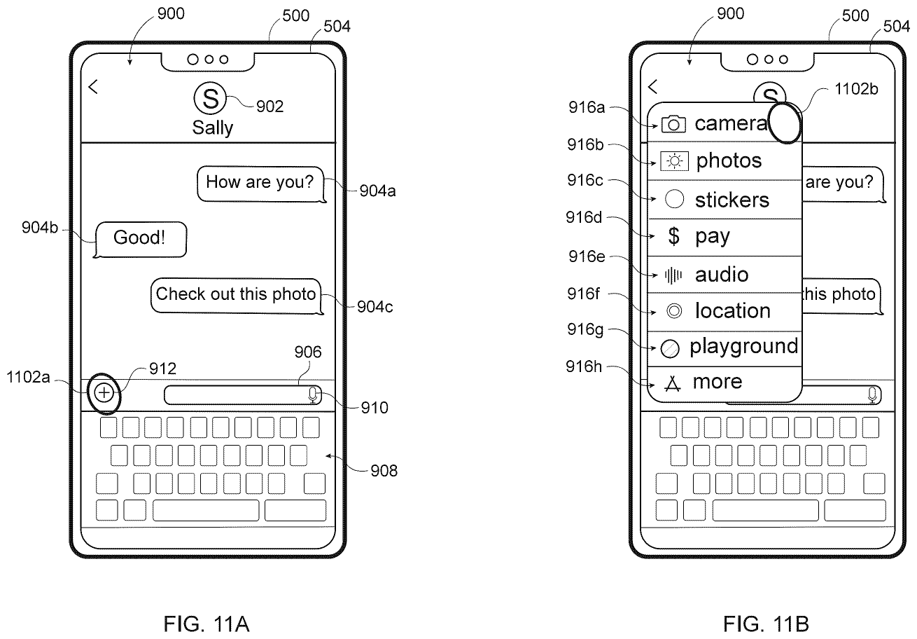

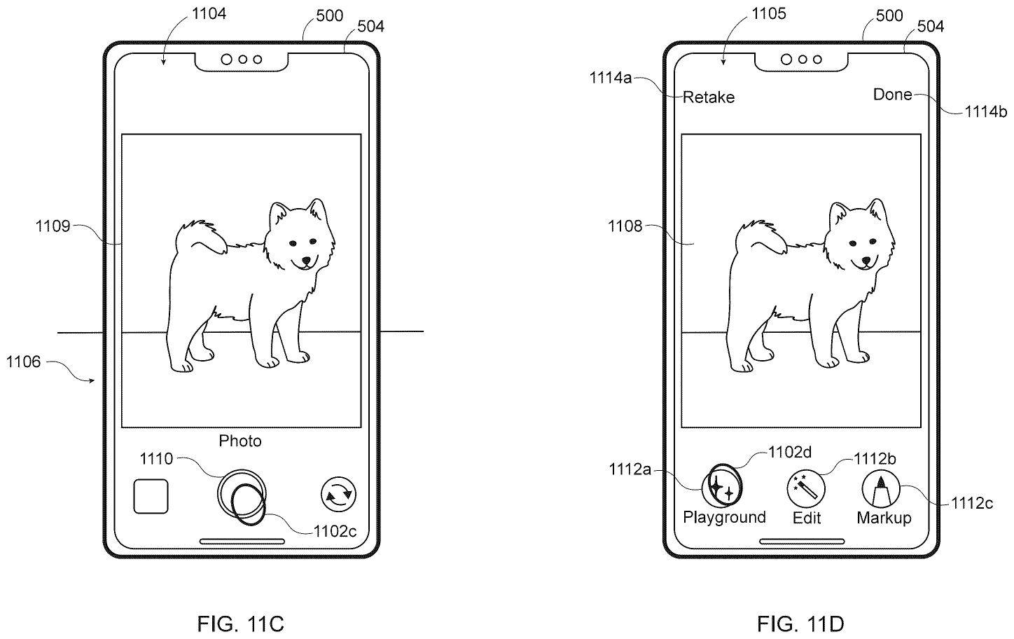

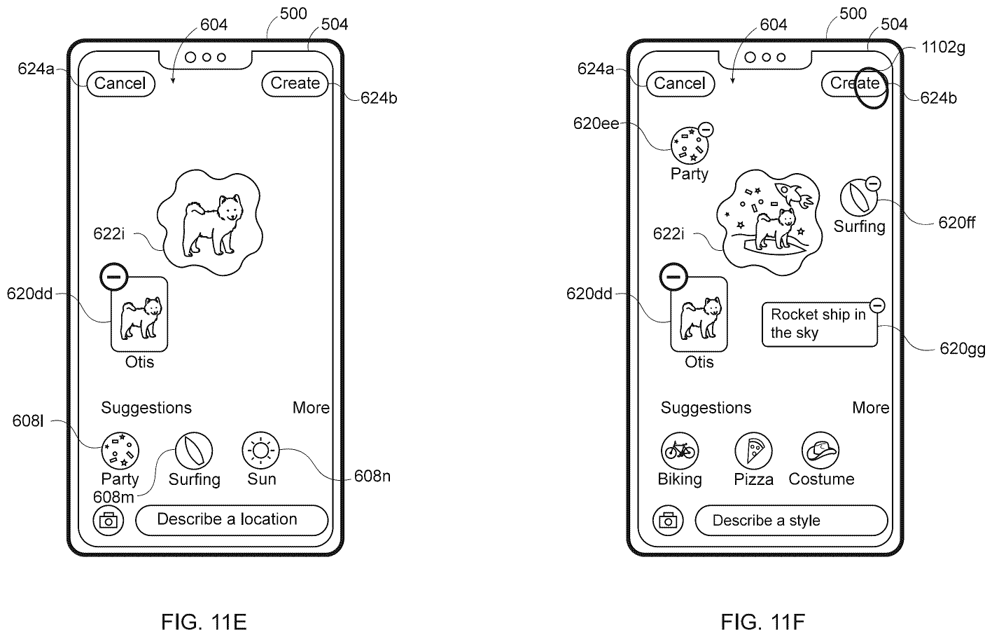

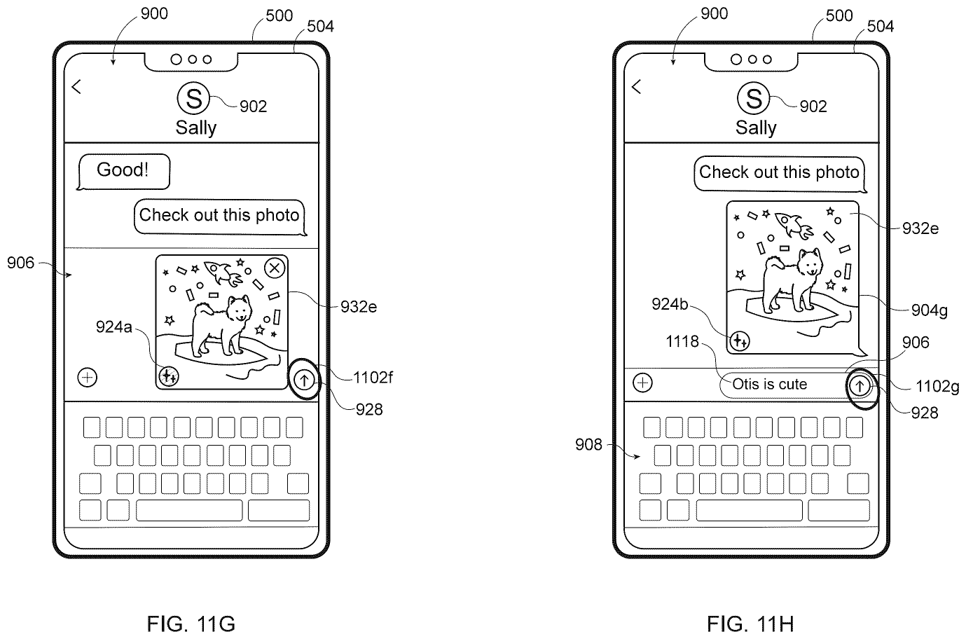

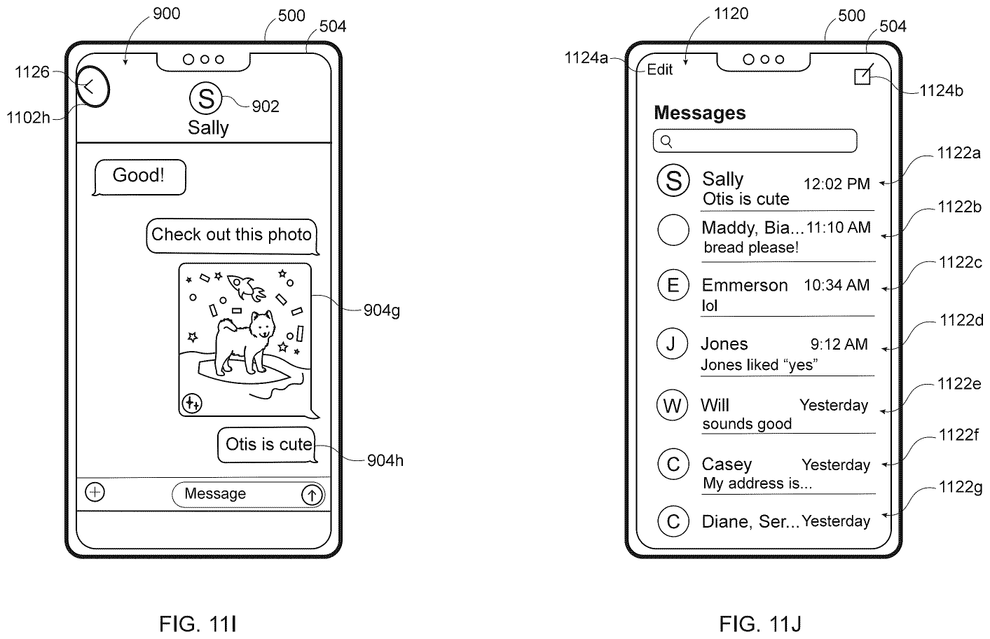

In some embodiments, in response to receiving the first input, the electronic device displays the view of the camera application and while displaying the view of the camera application, the electronic device receives a second input (e.g., having one or more characteristics of the selection inputs as described herein) capturing the image of the second person in the camera application of the electronic device, such as if the electronic device displays a view of the camera application like FIG. 11c and receives an input directed towards an option to capture a photo (e.g., an input (e.g., a tap or a long press) including contact 1102c in FIG. 11C). As described above, the user chooses a photo of a person by taking a picture/video using a camera application. For example, the user selects a virtual or physical button (e.g., or a voice or gaze input) on the electronic device to take a picture/video. In some embodiments, the image of the second person is or is part of the captured image including the person, or is not part of the captured image. Allowing a user to change the person represented by the previously generated visual content using an image library or a camera application without changing the other parameters allows a user to easily and efficiently change the starting media, thereby reducing erroneous inputs to the electronic device.

In some embodiments, changing the person represented by the first previously generated visual content from the first person to the second person further comprises receiving, via the one or more input devices, an input corresponding to a request to select the second person from a collection of identified people that are identified from a media library associated with the electronic device, such as if the electronic device displays selectable options like 608a in FIG. 6B in a media library. In some embodiments, the input includes one or more characteristics of the inputs described above. In some embodiments, the input is a tap input, a voice input, and/or a gaze input (optionally as part of an air gesture).

In some embodiments, in response to receiving the input corresponding to the request to select the second person from the collection of identified people, updating the person represented by the first previously generated visual content from the first person to the second person based on one or more media items identified as including the second person, such as changing the person from Jenna to Jerome in FIG. 6W in response to receiving an input selecting a representation of a person in a media library. In some embodiments, the electronic device identifies people in a media library (e.g., a photos/videos library). For example, the electronic device identifies people that appear in one or more photos and/or videos in a media library. In some embodiments, a user picks a second person from the collection of identified people and the electronic device uses one or more of the associated photos (e.g., associated with the second photo) as a seed and/or starting media to generate the visual content. Specifically, in some embodiments, the electronic device uses multiple photos and/or videos of the second person to generate the automatically-generated visual content. In some embodiments, the electronic device uses one (e.g., randomly selected, pseudo randomly selected, or selected based on some criteria such as a representative photo selected by the user) photo or video of the second user to generate the automatically-generated visual content. In some embodiments, the electronic device prompts the user to pick a media item to be used to generate the automatically-generated visual content. In some embodiments, the user does not need to provide an input to display and/or include the particular people identified in the collection of identified people. In some embodiments, the collection of identified people or a portion of the collection is displayed in the editing user interface. Displaying a collection of identified people allows a user to easily and efficiently change the person represented by the generated visual content, thereby reducing erroneous inputs to the electronic device.

In some embodiments, the one or more parameters includes a person represented by the first previously generated automatically-generated visual content (e.g., the person includes one or more characteristics of the representation of a person as described in method 700), and changing the one or more parameters includes receiving an input (e.g., the first input includes a selection input, such as a tap or long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture), via the one or more input devices, corresponding to a request to change the person represented by the first previously generated visual content from a person to an animal different from the person, such as if recognized concept 620j is replaced by a recognized concept of an animal in FIG. 6W. In some embodiments, the animal is a dog, cat, bird, lizard, or another animal. In some embodiments, changing the person represented from the first previously generated automatically-generated visual content to an animal includes selecting an animal in a media library (e.g., having one or more characteristics of selecting a representation of a person in a media library as described herein) or taking a photo of an animal using a camera application (e.g., having one or more characteristics of taking a photo of a person using the camera application as described herein). In some embodiments, selecting an animal is described in greater detail in method 700. In some embodiments, the electronic device uses multiple photos and/or videos of the animal to generate the automatically-generated visual content. In some embodiments, the electronic device uses one (e.g., randomly selected, pseudo randomly selected, or selected based on some criteria such as a representative photo selected by the user) photo or video of the animal to generate the automatically-generated visual content. In some embodiments, in response to changing the person to an animal, the electronic device ultimately regenerates the automatically-generated visual content to include the animal as the starting media and displays the automatically-generated visual content including the animal. Displaying a collection of identified animals allows a user to easily and efficiently change the person represented by the generated visual content to other subject matter, thereby reducing erroneous inputs to the electronic device.

In some embodiments, displaying the generative visual content user interface includes concurrently displaying, via the display generation component, in the generative visual content user interface a representation of the first previously generated visual content associated with (e.g., based on, including and/or depicting) a first person and a representation of a second previously generated visual content associated with (e.g., based on, including and/or depicting) a second person (e.g., or a first animal or pet) different from the first person, such as user interface 600 including an automatically-generated visual content 602g of Jenna and an automatically-generated visual content 602h of Jeremy in FIG. 6BB. In some embodiments, the user generates automatically-generated visual content associated with a plurality of people including the first person and the second person. In some embodiments, the first previously automatically-generated visual content is not associated with the second person and the second previously generated automatically-generated visual content is not associated with the first person. In some embodiments, the first previously generated visual content is different from the second previously generated visual content. In some embodiments, the generative visual content user interface includes an automatically-generated visual content associated with a first person and an automatically-generated visual content associated with a first animal. In some embodiments, in response to receiving an input directed towards the second previously generated visual content associated with the first animal, the electronic device displays the editing user interface associated with the second previously generated visual content. In some embodiments, the automatically-generated visual media user interface also includes a third automatically-generated visual content associated with a second person, different than the first person, and in response to receiving an input directed towards the third automatically-generated visual content, the electronic device displays the editing user interface associated with the third automatically-generated visual content. Displaying a plurality of previously generated visual content associated with a plurality of different people in the generative visual content user interface allows the user to easily select their desired previously generated visual content, thereby reducing erroneous inputs to the electronic device.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 1000, 1200, 1400, 1500, 1700, 1900, 2100, 2300, and/or 2700) are also applicable in an analogous manner to method 800 described above with respect to FIG. 8. For example, the operation of editing one or more parameters, including one or more recognized concepts, of a previously generated automatically-generated visual content described above with reference to method 800 optionally has one or more of the characteristics of, displaying a representation of a prompt and one or more recognized concepts, the addition of a representation of automatically-generated visual content into a first application, and the presentation of an automatically-generated visual media creation user interface to use a non-automatically-generated visual media as the reference media item, displaying portion(s) of a user interface with HDR luminance, displaying one or more portions of the user interface with luminance that is within or greater than a SDR luminance, generating multiple variations of representations of automatically-generated visual content, restricting prompt components to be used to generate automatically-generated visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., methods 700, 1000, 1200, 1400, 1500, 1700, 1900, 2100, 2300, and/or 2700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 8 are, optionally, implemented by components depicted in FIGS. 1A-1B. For example, displaying operation 802a and 802c, detecting operation 802d, change operation 802e, and receiving operation 802b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, a user wants to add an automatically-generated visual content to a messaging conversation while in a messaging application. In some embodiments, while the electronic device is presenting a messaging user interface including the messaging conversation, the electronic device receives a request to add an automatically-generated visual content to the messaging conversation. In some embodiments, in response to receiving the request, the electronic device displays a collection of automatically-generated visual content for the user to select and send to a recipient of the messaging conversation. In some embodiments, automatically-generated visual media is media generated using autonomous processes. In some embodiments, generating the automatically-generated visual media includes using a real image as a starting point to build in additional concepts and/or features found in the prompt, as described in methods 700 and 800. The embodiments described below provide ways in which the electronic device receives and adds automatically-generated visual content from the automatically-generated visual media application to the first application. The embodiments described below also provide ways in which the electronic device transmits automatically-generated visual content to a messaging conversation with a second user account. Displaying a user interface for inserting the automatically-generated visual content into the user interface of the first application allows a user to efficiently insert such visual media into the first application without opening a second application and/or navigating away from the first user interface, thereby reducing inputs needed to insert such visual media. It is understood that people use devices. When a person uses a device, that person is optionally referred to as a user of the device.

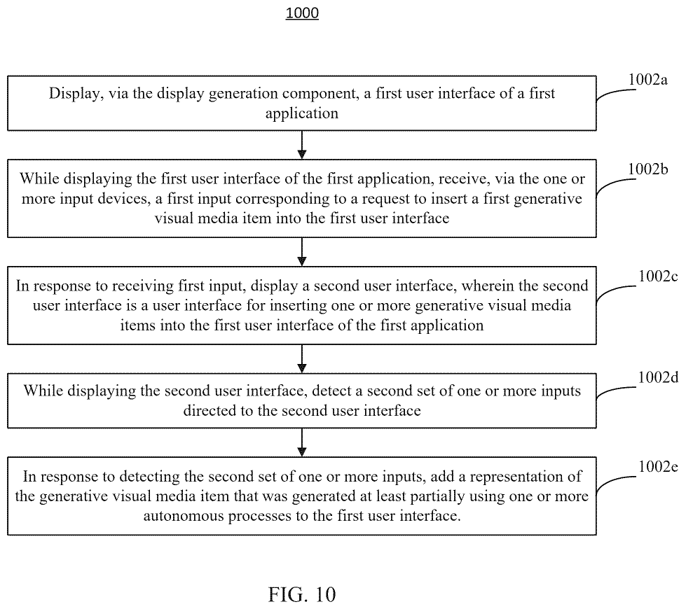

FIGS. 9A-9X illustrate exemplary ways in which an electronic device adds automatically-generated visual content to a first user interface of a first application according to some embodiments of the disclosure. The embodiments in these figures are used to illustrate the processes described below, including the processes described with reference to FIG. 10. Although FIGS. 9A-9X illustrate various examples of ways an electronic device is able to perform the processes described below with respect to FIG. 10, it should be understood that these examples are not meant to be limiting, and the electronic device is able to perform one or more processes described below with reference to FIG. 10 in ways not expressly described with reference to FIGS. 9A-9X.

FIG. 9A illustrates an embodiment of a messaging user interface of a messaging application. FIG. 9A illustrates an electronic device 500 with a display generation component 504 (e.g., a touchscreen). In some embodiments, the electronic device 500 is a mobile device, such as a smartphone, tablet, or wearable device. In FIG. 9A, the electronic device 500 displays user interface 900 that includes a messaging conversation between Joe (e.g., the user associated with the electronic device 500) and a contact named Sally (e.g., indicated by the representation 902 of Sally). The messaging user interface 900 includes a first user interface object 904a (or representation) of a first message that was added to the messaging conversation from a first user account and/or device (e.g., electronic device 500) associated with Joe, a second user interface object 904b (or representation) of a second message that was added to the messaging conversation from a second device and/or a second user account associated with Sally, and a third user interface object 904c (or representation) of a third message that was added to the messaging conversation from the electronic device 500 and/or the first user account associated with Joe. In some embodiments, the electronic device 500 displays the first user interface object 904a, in messaging user interface 900, in response to electronic device 500 receiving an indication that the device associated with Joe has added the first message to the messaging conversation, which includes the text “How are you?”. In some embodiments, the electronic device 500 displays the second user interface object 904b, in messaging user interface 900, in response to electronic device 500 receiving an indication that the device associated with Sally has added the second message, which included the text “Good!”, to the messaging conversation. In some embodiments, the electronic device 500 displays the third user interface object 904c, in messaging user interface 900, in response to device 500 receiving an indication that the device associated with Joe has added the third message to the messaging conversation, which included the text “Check out this photo”.

In FIG. 9A, the messaging user interface 900 also includes a content entry field 906 that receives inputs to add text, visual media, and/or other content to the messaging conversation. In some embodiments, the electronic device receives content for the content entry field 906 using a keyboard 908 with selectable keys such that a user can type text into the content entry field 906. The user interface 900 also includes a selectable option 910, that when selected, causes the electronic device 500 to use the one or more input devices (e.g., a microphone) to receive a voice command from a user (e.g., a voice command to input text). In some embodiments, the messaging user interface 900 also includes a selectable option 912 that, when selected, causes the electronic device 500 to display a menu of selectable options 916a through 916h that, when selected, configure the electronic device 500 to insert various content items associated with various applications into the content entry field.

In FIG. 9A, the electronic device 500 receives a selection input (e.g., a tap or long press input) including contact 914a directed towards selectable option 912. In response to receiving the input in FIG. 9A, the electronic device 500 displays selectable options 916a through 916h, shown in FIG. 9B.

FIG. 9B illustrates the user interface 900 including the menu of selectable options that, when selected, cause the electronic device 500 to insert various content into the content entry field 906. One or more of options 916a through 916g are associated with applications other than the messaging application and facilitate sending messages including content associated with respective applications other than the messaging application. In some embodiments, selectable option 916a, when selected, causes the electronic device 500 to open a user interface of a camera application, described in greater detail in FIGS. 11B-11D, to facilitate composing a message including one or more (e.g., still or video) images captured using the camera application. In some embodiments, the selectable option 916b, when selected, causes the electronic device 500 to open a user interface of a media library such that a user can select a media item from the media library to be inserted in the content entry field 906. This is described in greater detail in FIGS. 9P-9Q. In some embodiments, selectable option 916c, when selected, causes the electronic device 500 to open a sticker library such that the user can select a sticker (e.g., an image with an arbitrary boundary shape) to add to the content entry field 906. In some embodiments, selectable option 916d, when selected, causes the electronic device 500 to add a monetary payment to the content entry field 906. In some embodiments, selectable option 916e, when selected, causes the electronic device 500 to add an audio recording to the content entry field 906. In some embodiments, selectable option 916f, when selected, causes the electronic device 500 to add an indication of a location (e.g., the current location of the electronic device 500) to the content entry field 906 using a maps application. In some embodiments, selectable option 916g, when selected, causes the electronic device 500 to open a user interface of the automatically-generated visual media application such that a user can select one or more automatically-generated visual content to be inserted in the content entry field 906. In some embodiments, selectable option 916h, when selected, causes the electronic device 500 to display additional selectable options that cause the electronic device 500 to perform various actions.

In FIG. 9B, the electronic device 500 receives a selection input (e.g., a tap or long press input) including contact 914b directed towards selectable option 916g. In response to receiving the input in FIG. 9B, the electronic device 500 displays a user interface element 922 including representations 918a through 918f of suggested automatically-generated visual content in the messaging application, shown in FIG. 9C. In some embodiments, and as described in method 1000, user interface element 922 is a user interface element of a second application (e.g., the automatically-generated visual media application). In some embodiments, the suggested automatically-generated visual content are previously generated automatically-generated visual content, which are described in greater detail in FIG. 7 and in method 1000.

FIG. 9C illustrates the messaging user interface 900 including a user interface element 922 of the automatically-generated visual media application. The user interface element 922 includes representations 918a through 918f of automatically-generated visual content previously generated using the automatically-generated visual media application. For example, the automatically-generated visual media application generated the automatically-generated visual content corresponding to representations 918a through 918f according to methods 700, 800, 1000, or 1200 described herein. While displaying the user interface element 922, if the electronic device 500 receives a swipe input including contact 920a directed towards the user interface element 922, then the electronic device 500 optionally displays additional representations of suggested automatically-generated visual content. For example, the electronic device 500 displays six representations 918a through 918f in FIG. 9C, and if the electronic device receives the input including contact 920a, the electronic device optionally displays a greater number of representations of suggested automatically-generated visual content. FIG. 9C also illustrates the electronic device 500 receiving a selection input (e.g., a tap or long press input) including contact 914c directed towards representation 918a. In response to receiving the input in FIG. 9C, the electronic device 500 displays a representation 932a of the generative visual content corresponding to representation 918a in the content entry field 906, shown in FIG. 9D. In some embodiments, the electronic device 500 receives the input including contact 920a independently from the input (e.g., a tap or a long press) including contact 914c (e.g., they are alternatively detected). In some embodiments, after receiving the input including contact 920a, the electronic device 500 receives a selection input, optionally similar to the input (e.g., a tap or a long press) including contact 914c, directed towards an additional representation of a suggested automatically-generated visual content that is displayed.

FIG. 9D illustrates the user interface 900 including representation 932 of an automatically-generated visual content in the content entry region 906. As described in method 1000, because the representation 932 is a representation of an automatically-generated visual content, the electronic device 500 displays a visual indication 924a overlaid on the representation 932. In some embodiments, the representation 932 corresponds to the representation 918a shown in user interface element 922. Also, in response to adding content to the content entry region 906, the electronic device 500 displays a selectable option 928 corresponding to a send button. In some embodiments, the selectable option 928, when selected, causes the electronic device 500 to transmit the contents of the content entry region 906 to the messaging conversation with Sally. The user interface 900 also include visual indication 926 on representation 918a indicating that the representation 918a is the first representation added to the content entry region 906. In some embodiments, as the electronic device 500 receives additional inputs selecting additional representation to be added to the content entry region 906, the electronic device 500 displays additional indications on the respective representations to indicate how many representations are added to the content entry region 906 and optionally the order in which the representations will be displayed in the message once the message is sent.

In FIG. 9D, the electronic device 500 receives a selection input (e.g., a tap or long press input) including contact 914d directed towards visual indication 924a. In response to receiving the input in FIG. 9D, the electronic device 500 displays user interface 604 (e.g., an automatically-generated visual media creation user interface), shown in FIG. 9E and described in greater detail in methods 700 and 800 and in FIGS. 6A-6MM. In some embodiments, the selection input is optionally directed towards representation 918a and not towards visual indication 924a.

FIG. 9E illustrates the automatically-generated visual media creation user interface 604, which is described in further detail in methods 700 and 800 and in FIG. 6A-II. In some embodiments, in response to selecting visual indication 924a in FIG. 9D, the electronic device 500 displays the user interface 604 including indications 620d, 620f, 620g, 620h of recognized concepts on which generation of the automatically-generated visual media is based. In some embodiments, the user interface illustrated in FIG. 9E has one or more characteristics of the user interface illustrated in FIG. 6O. Specifically, representation 932a shown in FIG. 9D corresponds to the automatically-generated visual content shown in user interface 629c in FIG. 6P having the one or more recognized concepts shown in FIG. 6O. FIG. 9E also illustrates representation 622b described in further detail above with reference to FIG. 6O.

While displaying user interface 604 in FIG. 9E, the electronic device 500 receives a dragging input including contact 930a directed towards dragging selectable option 608l to be used as a recognized concept in the generation of the automatically-generated visual content. In some embodiments, the dragging input has one or more characteristics of the dragging input described above with reference to FIG. 6D. In some embodiments, selectable option 608l, shown in FIG. 9E, corresponds to a suggested recognized concept, having one or more characteristics of the selectable options 608a through 608k, described in FIGS. 6A-6MM. In some embodiments, in response to receiving the input in FIG. 9E, the electronic device 500 updates the user interface 604 in FIG. 9F to include selectable option 620e corresponding to the recognized concept “sunglasses,”. In some embodiments, selectable option 620e includes a (−) indication that when selected, causes the electronic device 500 to remove the recognized concept from the prompt to create the automatically-generated visual content. Selectable option 620e is described in greater detail in FIG. 6H-A.

In FIG. 9F, the electronic device receives a selection input (e.g., a tap or long press input) including contact 914e directed towards selectable option 624b (e.g., described in greater detail with reference to FIG. 9E, that when selected, causes the electronic device 500 to generate the automatically-generated visual content, described in greater detail in FIG. 9E. In response to receiving the input in FIG. 9F, the electronic device 500 displays user interface 629h including the resulting automatically-generated visual content in FIG. 9G.

FIG. 9G illustrates the automatically-generated visual content that is generated using autonomous processes, as described in method 700, in response to receiving the input illustrated in FIG. 9F. The automatically-generated visual content in FIG. 9G is generated using the recognized concepts 620d through 620h, shown in FIG. 9F. In some embodiments, the automatically-generated visual content shown in FIG. 9G is different than the automatically-generated visual content shown in FIG. 6M even though they are both generated using the same recognized concepts. As described in method 700, the process to generate automatically-generated visual content is non-deterministic and regenerating the automatically-generated visual content using the same recognized concepts results in different automatically-generated visual content, as described in greater detail in method 700.

In FIG. 9G, the user interface 629h also includes the selectable option 675a, that when selected, causes the electronic device 500 to generate a three-dimensional (3D) version of the automatically-generated visual media shown in FIG. 9G. Alternatively, the electronic device 500 generates a new automatically-generated visual content item as a 3D automatically-generated visual content item using the one or more recognized concepts. In some embodiments, selectable option 627a is described in greater detail in FIG. 6Z.

In some embodiments, user interface 629h has one or more characteristics of user interface 629a through 629g described in FIGS. 6A-6MM. In some embodiments, any of the user interfaces 629a through 629g includes the selectable option 675a, described in greater detail in FIG. 6Z. Selectable options 630a and 630b are described in greater detail in FIG. 6F and correspond to options 630a 1602c, and/or 2242a and options 630b, 1602d, and/or 2242b in FIGS. 6A-6MM, 16A-16U, 18G-18BB, 20D-20AA, 22A-22CCC, and/or 26A-26P. In FIG. 9G, the electronic device receives a selection input (e.g., a tap or long press input) including contact 914f directed towards selectable option 630b. in response to receiving the input in FIG. 9G, the electronic device 500 displays selectable options 630d and 630e shown in FIG. 9H. Selectable options 630d and 630e are described in greater detail in FIG. 6Q and with reference to methods 700, 800, and 1000. While displaying the selectable options 630d and 630e in FIG. 9H, the electronic device receives a selection input (e.g., a tap or a long press input) using contact 914g directed towards selectable option 630d. In response to receiving the input, the electronic device 500 saves the automatically-generated visual content in the automatically-generated visual media application and ceases displaying user interface 629h and redisplays user interface 900, as shown in FIG. 9I. In some embodiments, saving the automatically-generated visual content also includes adding the automatically-generated visual content as an automatically-generated visual content in user interface 600, described in method 700 and 800, and in FIG. 6R.

After closing the user interface associated with the second application (e.g., the user interface 629h of the automatically-generated visual media application), the electronic device 500 adds a representation 932b corresponding to representation 918g to the content entry field 906, shown in FIG. 9I. Because the input in FIG. 9H is directed towards selectable option 630d rather than option 630e, the electronic device 500 replaces representation 918a with representation 918g instead of adding representation 918g as a new representation in the user interface element 622 (and in the gallery shown by user interface 600 in FIG. 6A) in FIG. 9I. Additionally, in FIG. 9I, the electronic device 500 replaces representation 932a with representation 932b as a result of detecting the input towards selectable option 630d. In some embodiments, adding a generated automatically-generated visual content to the content entry field 906 is described in further detail in method 1000.

While displaying the user interface 900 in FIG. 9I including representation 932b, the electronic device 500 receives a selection input (e.g., a tap or long press input) including contact 914h directed towards selectable option 928 to send a message including the automatically-generated visual content associated with the representation 932b to the messaging conversation with Sally. In response to receiving the input, the electronic device 500 adds a fourth message to the messaging conversation represented by user interface object 904d, shown in FIG. 9J. The fourth message includes the representation 932b of the automatically-generated visual content shown in FIG. 9H. In FIG. 9J, the electronic device also includes a visual indication 924b overlaid over representation 932b in the user interface object 904b. In some embodiments, before the message is sent (e.g., while the representation 932b is displayed in content entry region 906), the electronic device 500 displays the visual indication 924a overlaid over representation 932b, as described in FIG. 9D. After the message is sent to the messaging conversation, the electronic device displays visual indication 924b, instead. In some embodiments, visual indication 924b also indicates that the media item (e.g., representation 932b) is an automatically-generated visual content. However, in some embodiments, the visual indication 924b is not selectable to open the user interface 604 to edit the one or more parameters of the respective automatically-generated visual content. In some embodiments, the visual indication 924a has one or more characteristics in common with visual indication 924b and one or more characteristics that are different than visual indication 924b, as described in methods 1000 and 1200.

FIG. 9K illustrates the user interface 900 including the three messages between Sally and Joe, described in FIG. 9A. The three messages are represented by user interface objects 904a through 904c. FIG. 9K also includes the user interface element 922 including the representations 918b through 918g of the suggested automatically-generated visual content. The user interface element 922 also includes a selectable option 934 that, when selected, causes the electronic device 500 to display the user interface 604 to create a new automatically-generated visual content. In FIG. 9K, the electronic device 500 receives a selection input (e.g., a tap or a long press input) directed towards selectable option 934 including contact 914i. In response to receiving the input, the electronic device 500 displays the user interface 604 over the user interface 900, shown in FIG. 9L. In some embodiments, the user interface 604 shown in FIG. 9L is described in greater detail above with reference to FIG. 6B. In FIG. 9L, the electronic device 500 does not close the first application but rather displays the user interface 604 of the automatically-generated visual media application (or a representation of the user interface 604) over user interface 900. In some embodiments, adding a prompt and/or recognized concepts to be used to influence the generation of the automatically-generated visual content using user interface 604 is described in greater detail in methods 700 and with reference to FIGS. 6B-6E and FIGS. 6G-6L. As such, the details to add recognized concepts 620v through 620y in FIG. 9M are not described but correspond to the methods to add recognized concepts in FIGS. 6B-6E and in FIGS. 6G-6L. For example, the user inputs a prompt and/or selects recognized concepts from the suggested recognized concepts to add recognized concepts 620v through 620y to user interface 604. As described in method 700 and in FIGS. 6A-6MM, recognized concepts include visual and/or textual descriptions.

While displaying the recognized concepts 620v through 620y used to influence the generation of the automatically-generated visual content and representation 622f representing a low fidelity version of the automatically-generated visual content (e.g., having one or more characteristics of the representations 622a through 622e and described in method 700), the electronic device 500 receives a selection input (e.g., a tap or long press input) including contact 914j directed towards selectable option 624b, shown in FIG. 9M. In response to receiving the input, the electronic device 500 displays user interface 629i including automatically-generated visual content generated using recognized concepts 620v through 620y, shown in FIG. 9N. In some embodiments, user interface 629i has one or more characteristics of user interfaces 629a through 629h, described in FIGS. 6A-6MM.

In FIG. 9N, the user interface 629i also includes the selectable option 675a, that when selected, causes the electronic device 500 to generate a three-dimensional (3D) version of the automatically-generated visual media shown in FIG. 9N. Alternatively, the electronic device 500 generates a new automatically-generated visual content item as a 3D automatically-generated visual content item using the one or more recognized concepts. In some embodiments, selectable option 627a is described in greater detail in FIG. 6Z.

While displaying user interface 629i, the electronic device 500 receives a selection input (e.g., a tap or long press input) including contact 914k directed towards selectable option 630b in FIG. 9N. In response to receiving the input, the electronic device 500 adds a representation 932c of the automatically-generated visual content generated using recognized concepts 620v through 620y to the content entry field 906 of the messaging application user interface, shown in FIG. 9O. In some embodiments, because this automatically-generated visual content was a new automatically-generated visual content and not a modified automatically-generated visual content based on a previously generated automatically-generated visual content, the electronic device 500 does not display options to “save” or “save as” (e.g., options 630d and 630e, shown in FIG. 9H) in user interface 629i before displaying the user interface in FIG. 9O. Additionally, as shown in FIG. 9O, the newly generated automatically-generated visual content is also shown in the suggested automatically-generated visual content (e.g., user interface element 622) as representation 618h. In some embodiments, in response to receiving the input in FIG. 9N, the electronic device 500 also adds the automatically-generated visual content to the gallery of automatically-generated visual content shown in user interface 600.

While displaying the representation 932c in the content entry field 906 of user interface 900, the electronic device 500 receives a selection input (e.g., a tap or long press input) including contact 914i directed towards selectable option 928. In response to receiving the input, the electronic device 500 sends the automatically-generated visual content to the messaging conversation and displays the representation 932c included in a user interface object 904e in the messaging conversation shown in FIG. 9P. In some embodiments, FIG. 9P has one or more characteristics of FIG. 9J.

FIG. 9Q illustrates the user interface 900 including selectable options 916a through 916h, as described with reference to FIG. 9B. Instead of receiving a selection input directed towards option 916g, as described with reference to FIG. 9B, in FIG. 9Q, the electronic device 500 receives a selection input (e.g., a tap or long press input) including contact 914m directed towards option 916b. In response to receiving the input shown in FIG. 9Q, the electronic device 500 displays a user interface element 936 of a media library in the messaging application, shown in FIG. 9R. In some embodiments, the media library is also accessible through a media library application. The user interface element 936 has one or more characteristics of the user interface element 922, described above. However, the electronic device 500 displays media items from the media library, which optionally includes a mix of generative and non-generative visual content, in user interface element 936. While displaying the user interface element 936 in FIG. 9R, the electronic device 500 displays representations 938a through 938f of media items. In response to receiving a swipe input including contact 920b, the electronic device 500 displays additional representations of media items similar to as described in FIG. 9C.

In some embodiments, if the electronic device detects a swipe input on the user interface element 936 including contact 920b, as shown in FIG. 9R, the electronic device 500 optionally responds by displaying additional representations of non-automatically-generated visual content. For example, the electronic device 500 displays six representations 938a through 938f in FIG. 9S, and if the electronic device receives the input including contact 920b, the electronic device optionally displays a greater number of representations of non-automatically-generated visual content.

While displaying the user interface element 936 in FIG. 9R, the electronic device receives a selection input (e.g., a tap or long press input) including contact 914n directed towards representation 938b. In response to receiving the input shown in FIG. 9R, the electronic device 500 adds the representation 938b of the media item to the content entry field 906, shown in FIG. 9S. The electronic device 500 also displays a visual indication 924c overlaid over the representation 938b of the media item to indicate that the media item is not automatically-generated visual media. In some embodiments, visual indication 924c is visually different from indication 924a and 924b as described in further detail below with reference to method(s) 1000 and/or 1200. For example, the color of visual indication 924c is different from the colors of indications 924a and 924b because indication 924c is displayed overlaid on representation 938b that is non-generative.

While displaying the indication 924c overlaid over representation 938b, the electronic device receives a selection input (e.g., a tap or long press input) including contact 9140 directed towards the indication 924c, as shown in FIG. 9S. In response to receiving the input shown in FIG. 9S, the electronic device displays the user interface 604 of the automatically-generated visual media application including the media item (e.g., representation 938b) as the starting media (e.g., recognized concept 620z) and a representation 622g of the automatically-generated visual content, shown in FIG. 9T. In some embodiments, using a media item as the reference media item (e.g., the starting media) while in the first user interface is described in greater detail in method 1200. In some embodiments, adding a prompt and/or recognized concepts to be used to influence the generation of the automatically-generated visual content is described in greater detail in methods 700 and with reference to FIGS. 6B-6E and FIGS. 6G-6L. As such, the details to add recognized concepts 620z through 620cc in FIG. 9U are not described but correspond to the methods to add recognized concepts in method 700, FIGS. 6B-6E, and in FIGS. 6G-6L. For example, the user selects representations of recognized concepts from the suggested recognized concepts or a menu of recognized concepts (described in greater detail in method 700), or the electronic device receives a prompt including the recognized concepts 602z through 620cc.

While displaying the recognized concepts 620z through 620cc in FIG. 9U, the electronic device 500 receives a selection input (e.g., a tap or long press input) including contact 914p directed towards selectable option 624b. The details for creating and generating the automatically-generated visual content are described above with reference to FIGS. 9G-91 and FIGS. 9N-90. After generating the automatically-generated visual content and saving the automatically-generated visual content, the electronic device 500 ceases displaying user interface 604 and adds the representation 932d of the automatically-generated visual content to the content entry field 906 in user interface 900, shown in FIG. 9V. The representation 932d of the automatically-generated visual content replaces representation 938b of the media item (e.g., the reference media for the automatically-generated visual content).

FIG. 9V illustrates the representation 932d of the automatically-generated visual media generated using the recognized concepts described with reference to FIG. 9U. The electronic device 500 displays the indication 924a over the representation 932d because the representation 932d is an automatically-generated visual content that has not been sent to the messaging conversation. Indication 924a is different than indication 924c shown in FIG. 9S. Indication 924a has one or more similar characteristics and one or more different characteristics of Indication 924c. In FIG. 9V, the electronic device 500 receives a selection input (e.g., a tap or long press input) including contact 914q directed towards selectable option 928 to send a message including the representation 932d of the automatically-generated visual media to the messaging conversation with Sally. In response to receiving the input shown in FIG. 9V, the electronic device 500 adds a message represented by user interface object 904f to the messaging conversation with Sally, shown in FIG. 9W. In some embodiments, the user interface object 904f includes the representation 932d of the automatically-generated visual content and indication 924b indicating that the representation 932d is sent to the messaging conversation. In some embodiments, indication 924b is described in greater detail above.

In FIG. 9W, the electronic device receives a selection input (e.g., a tap or long press input) including contact 914r directed towards indication 924b. In response to receiving the input, the electronic device 500 displays user interface 604 overlaid over user interface 900 of the first application, shown in FIG. 9X. User interface 604 in FIG. 9X has one or more characteristics of user interface 604 in FIG. 9U. The electronic device 500 displays the recognized concepts 620z through 620cc in FIG. 9X and the user can modify the recognized concepts while the electronic device 500 is displaying user interface 604. Modifying recognized concepts is described in greater detail in methods 700 and 800.

In some embodiments, contacts 614a through 614r have one or more characteristics of selection inputs (e.g., a tap or a long press input) including contacts in FIGS. 6A-6MM. Although touch inputs including contacts are used in the embodiments described here as example inputs, other inputs are possible including voice, hardware input device inputs, and/or air gesture inputs.

FIG. 10 illustrates a flow diagram illustrating a method in which an electronic device adds automatically-generated visual content to a first user interface of a first application according to some embodiments of the disclosure. The method 1000 is optionally performed at first electronic device and/or electronic devices such as device 100, device 300, or device 500 as described above with reference to FIGS. 1A-1B, 2-3, 4A-4B and 5A-5H. Some operations in method 1000 are, optionally combined and/or order of some operations is, optionally, changed.

As described below, the method 1000 provides ways in which an electronic device adds an automatically-generated visual content to a first user interface of a first application. Displaying a user interface for inserting the automatically-generated visual content into the user interface of the first application allows a user to efficiently insert such visual media into the first application without opening a second application and/or navigating away from the first user interface, thereby reducing inputs needed to insert such visual media.

In some embodiments, method 1000 is performed at an electronic device in communication with a display generation component and one or more input devices (e.g., electronic device 500 described in FIG. 9A). In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, the electronic device display (1002a), via the display generation component, a first user interface of a first application, such as messaging user interface 900 in FIG. 9A. In some embodiments, the first user interface is a user interface of a content sharing application (e.g., a photo sharing application, social media application, or messaging application). In some embodiments, the first user interface includes one or more selectable options that are selectable to insert automatically-generated visual content (e.g., to send and/or share with a second user of a second electronic device). In some embodiments, the first user interface is a messaging user interface of a messaging application. In some embodiments, the messaging user interface includes a messaging conversation which includes messages sent from the electronic device to the messaging conversation and/or messages sent, to the messaging conversation, from one or more other electronic devices associated with one or more users other than a user of the electronic device. In some embodiments, the messaging user interface includes an entry field (e.g., the message composition field, such as a text or media entry field) where the automatically-generated visual content will be inserted in response to the request, described below. In some embodiments, the messaging user interface includes selectable options to insert other content (e.g., media from other applications) into the conversation, such as photos, audio, and/or location data. In some embodiments, the first application is not an automatically-generated visual media application (e.g., the application used to display and/or generate automatically-generated visual content described in methods 700 and 800).

In some embodiments, while displaying the first user interface of the first application, the electronic device receives (1002b), via the one or more input devices, a first input corresponding to a request to insert a first automatically-generated visual content into the first user interface (e.g., the automatically-generated visual content is described in greater detail in methods 700 and 800), such as the input including contact 914b in FIG. 9B. In some embodiments, the first input is a selection input, such as a tap, a gaze, and/or a click using a mouse/trackpad directed towards a selectable option (e.g., a virtual or physical button). In some embodiments, inserting the generative visual content includes inserting the generative visual content into the entry field described below.

In some embodiments, in response to receiving first input, the electronic device displays (1102c) a second user interface, wherein the second user interface is a user interface (e.g., of an automatically-generated visual media application, such as the application used to display and/or generate automatically-generated visual content described in methods 700 and 800) for inserting one or more automatically-generated visual content into the first user interface of the first application, such as user interface element 922 in FIG. 9C. In some embodiments, the second user interface is a user interface of the first application. In some embodiments, the second user interface is a user interface of a second application (e.g., an automatically-generated visual media application such as the application used to display automatically-generated visual content described in methods 700 and 800), different than the first application. In some embodiments, the second user interface includes representations of one or more previously generated automatically-generated visual content. In some embodiments, the second user interface includes a selectable option to generate a new automatically-generated visual content. In some embodiments, the second user interface is displayed concurrently with the first user interface. In some embodiments, the second user interface is overlaid over the first user interface (e.g., such that a portion of the first user interface is displayed while displaying the second user interface). In some embodiments, prior to displaying the second user interface for inserting automatically-generated visual content and/or in the same location of the display at which the second user interface is displayed, the electronic device displays a different user interface for inserting other content in the entry field, such as a third user interface. For example, the third user interface is one of a soft keyboard for entering text and/or emojis, a user interface of an image (e.g., sharing or saving) application for inserting non-generative images into the first user interface, an audio recording user interface for inserting an audio recording into the first user interface, and/or a user interface of a maps application for inserting location sharing elements into the first user interface. In some embodiments, in response to receiving the first input, the electronic device replaces the other user interface for inserting other content with the second user interface for inserting automatically-generated visual content.

In some embodiments, while displaying the second user interface, the electronic device detects (1002d) a second set of one or more inputs directed to the second user interface, such as the input including contact 914c in FIG. 9C directed towards representation 918a (e.g., an automatically-generated visual content). In some embodiments, the second set of one or more inputs have one or more characteristics of the first input described above. In some embodiments, the second set of one or more inputs includes a selection input, such as a tap or long press with a contact (e.g., a finger, or stylus), selection with an indirect input device (e.g., mouse, remote control, or trackpad) that is directed to a location of a focus indicator such as a cursor or selection ring) and/or a gaze input (optionally as part of an air gesture).

In some embodiments, in response to detecting the second set of one or more inputs, the electronic device adds (1102e) a representation of the automatically-generated visual content that was generated at least partially using one or more autonomous processes to the first user interface, such as adding representation 932a to the content entry region 906 in FIG. 9D. Generating the new automatically-generated visual content is optionally at the electronic device or at a different electronic device, such as a server, in communication with the electronic device, as described further detail in methods 700 and/or 800. In some embodiments, the autonomous processes are described in further detail in methods 700 and/or 800. In some embodiments, the automatically-generated visual content is a previously generated automatically-generated visual content. In some embodiments, the automatically-generated visual content is generated using the second one or more inputs while in a user interface of the automatically-generated visual media application (e.g., the second user interface, or while in a third user interface, different than the second user interface).

Displaying a user interface for inserting the automatically-generated visual content into the user interface of the first application allows a user to efficiently insert such visual media into the first application without opening a second application and/or navigating away from the first user interface, thereby reducing inputs needed to insert such visual media.

In some embodiments, displaying the second user interface further comprises concurrently displaying a plurality of representations of recommended automatically-generated visual content including the automatically-generated visual content, such as representations 918a through 918f in FIG. 9C. In some embodiments, the second user interface includes automatically-generated visual content that are also displayed in the generative visual content user interface described in method 800. In some embodiments, the electronic device receives an input directed towards selecting a second automatically-generated visual content and in response to the input, the electronic device inserts the second automatically-generated visual content into the first user interface. Displaying recommended automatically-generated visual content in a user interface for inserting the automatically-generated visual content into the user interface of the first application allows a user to efficiently insert such visual media into the first application without opening a second application and/or navigating away from the first user interface, thereby reducing inputs needed to insert such visual media.

In some embodiments, the recommended automatically-generated visual content are previously generated automatically-generated visual content, such as the representations 918a through 918f corresponding to previously generated automatically-generated visual content (e.g., automatically-generated visual content 602a through 602f) in user interface 600 shown in FIGS. 6BB, 6CC, and 6A. In some embodiments, the second user interface includes automatically-generated visual content that are also displayed in the generative visual content user interface described in method 800. In some embodiments, previously generated automatically-generated visual content are described in greater detail in method 800. In some embodiments, previously generated automatically-generated visual content were generated at least partially using one or more autonomous processes, as described in methods 700 and 800. Displaying previously generated automatically-generated visual content in a user interface for inserting the automatically-generated visual content into the user interface of the first application allows a user to efficiently insert such visual media into the first application without opening a second application and/or navigating away from the first user interface, thereby reducing inputs needed to insert such visual media.

In some embodiments, adding the automatically-generated visual content to the first user interface further comprises adding a representation of the automatically-generated visual content to a content entry field in the first user interface of the first application, such as adding representation 932a to the content entry region 906 in FIG. 9D. In some embodiments, the content entry field is a messaging composition field of a messaging application. In some embodiments, the first application is the messaging application. For example, the electronic device displays text and/or images in the content entry field to be sent in a message to a messaging conversation. The messaging conversation optionally includes one or more second user accounts (e.g., the second user account associated with a second electronic device) different from a user account associated with the electronic device. In some embodiments, the messaging conversation is between three (or more) user accounts. In some embodiments, the first input, described above, is directed towards the representation of the first automatically-generated visual content in the second user interface. In some embodiments, the representation of the automatically-generated visual content is the representation of the automatically-generated visual content described in method 700 (e.g., a lower fidelity version of the automatically-generated visual content) or the automatically-generated visual content generated using the process to generate the automatically-generated visual content (e.g., the higher fidelity representation described in method 700). In some embodiments, the representation of the automatically-generated visual content is smaller in size compared to the high-fidelity representation described in method 700 but contains the characteristics of the higher fidelity representation (e.g., higher resolution, more detailed, more color depth, and other characteristics described in method 700). In some embodiments, the content entry field accepts different kinds of content in response to different inputs. For example, the content entry field accepts media content (e.g., media items including non-automatically-generated visual content and automatically-generated visual content), text, voice recordings, videos, stickers, electronic payments, and other content. In some embodiments, the electronic device can add different content while the content entry field includes an automatically-generated visual content or before the content entry field includes the automatically-generated visual content. Adding the automatically-generated visual content to the content entry field without opening a second application and/or navigating away from the first user interface reducing inputs needed to insert such visual media into the first user interface.

In some embodiments, the representation of the automatically-generated visual content in the first user interface includes a visual indication that the automatically-generated visual content is automatically-generated visual media (e.g., text and/or images such as an icon indicating that the automatically-generated visual content is automatically-generated visual media), such as indication 924a shown in FIG. 9D.

In some embodiments, the electronic device displays a third user interface for inserting non-automatically-generated visual media into the first user interface of the first application, such as user interface element 936 in FIG. 9R. In some embodiments, the third user interface is a user interface of a media library or of a camera application, as described below. In some embodiments, the third user interface includes a plurality of representations of non-automatically-generated visual content.

In some embodiments, while displaying the third user interface for inserting the non-automatically-generated visual media into the first user interface of the first application, the electronic device detects, via the one or more input devices, a respective set of one or more inputs directed to the third user interface, such as input including contact 914n and input including 920b in FIG. 9R. In some embodiments, the respective set of one or more inputs has one or more characteristics of the first input, described above. In some embodiments, the respective set of one or more inputs include an input (e.g., a selection input) directed towards a representation of a non-automatically-generated visual content (e.g., a “real-world” image as described in method 700) in the third user interface that corresponds to a request to include the selected non-automatically-generated visual content in a draft message to be sent to the messaging conversation displayed in the first user interface of the first application. For example, the respective set of one or more inputs directed to the third user interface is directed towards the representation of the non-automatically-generated visual content or an option corresponding to the representation of the non-automatically-generated visual content.

In some embodiments, in response to detecting the respective set of one or more inputs directed to the third user interface, the electronic device displays, via the display generation component, a representation of a non-automatically-generated visual content in the first user interface without displaying a visual indication that the non-automatically-generated visual content is automatically-generated visual media, such as the electronic device 500 displaying representation 938b of a non-automatically-generated visual content without displaying indication 924a in FIG. 9S. In some embodiments, displaying the representation of the non-automatically-generated visual content in the first user interface includes displaying the representation in the content entry field, described above. In some embodiments, the representation of the non-automatically-generated visual content does not include a visual indication (e.g., such as the indication that indicates whether a visual content is an automatically-generated visual content) overlaid on top of the representation. In some embodiments, there is an option displayed overlaid on the non-automatically-generated visual media that is selectable to use the non-automatically-generated visual content as a reference media item to generate a different automatically-generated visual content, such as described with reference to method 1200. Reference media items are described in greater detail in method 1200. In some embodiments, the option has a visual characteristic in common with the visual indication of the automatically-generated visual media and a visual characteristic that is different from the visual indication of the automatically-generated visual media. For example, the option includes the same image on the icon as the icon of the visual indication of the automatically-generated visual media. However, the option is optionally a different color, transparency, shading, and/or line thickness than the icon of the visual indication of the automatically-generated visual media. Displaying a visual indication that an automatically-generated visual content is automatically-generated visual media allows a user to easily and efficiently identify automatically-generated visual media without additional inputs.

In some embodiments, the first application is a messages application. For example, the messaging application includes a message collection user interface 1120 shown in FIG. 11J and a messaging user interface 900, shown in FIG. 9A. In some embodiments, the messages application includes one or more messaging user interfaces corresponding to messaging conversations between the user account of the electronic device and one or more different user accounts. In some embodiments, the electronic device is able to transmit and/or receive messages from other user accounts in the messaging application. In some embodiments, the electronic device displays messages from the other user accounts and outgoing messages in the messaging application. For example, the messaging application includes a messaging user interface including a messaging conversation between the first user account of the electronic device and at least a second user account of a second electronic device. Displaying a user interface for inserting the automatically-generated visual content into the user interface of a messaging application allows a user to efficiently message automatically-generated visual content to other user accounts without opening a second application and/or navigating away from the first user interface, thereby reducing inputs needed to insert such visual media.

In some embodiments, while displaying the representation of the automatically-generated visual content in the content entry field in the first user interface of the first application, the electronic device receives, via the one or more input devices, a respective set of one or more inputs corresponding to a request to send a message to a messaging conversion (e.g., with one or more second user accounts), such as the input including contact 914h in FIG. 9I. In some embodiments, the respective one or more inputs corresponding to the request to send the message includes one or more characteristics of the first input described above. In some embodiments, the respective one or more inputs is directed towards an option included in a messaging user interface (e.g., a selectable option selectable via touch or gaze input). For example, the option is a send button. In some embodiments, the respective one or more inputs is a voice input or an input received via a hardware input device.

In some embodiments, in response to receiving the respective set of one or more inputs corresponding to the request to send the message to the messaging conversion, the electronic device sends a message to the messaging conversation that includes the automatically-generated visual content, such as the message represented by user interface object 904d including representation 932b shown in FIG. 9J. In some embodiments, sending the message includes sending an indication of the message including an indication of the automatically-generated visual content to the electronic device of the one or more second user accounts (e.g., the account that the message was sent to). In some embodiments, sending the message including the automatically-generated visual content to the messaging conversation causes one or more electronic devices with access to the messaging conversation, including the electronic device(s) of the one or more second user accounts, to display the automatically-generated visual content. For example, the electronic devices with access to the messaging conversation display the automatically-generated visual content in a user interface of the messaging application including the messaging conversation.

In some embodiments, the electronic device displays, via the display generation component, a representation of the message that includes the automatically-generated visual content in the first user interface that includes a representation of the automatically-generated visual content, such as representation 932b shown in FIG. 9J which corresponds to representation 918g in FIG. 9I. In some embodiments, the representation of the message is displayed in the messaging user interface including the messaging conversation. In some embodiments, displaying the representation of the message allows a user to view previously sent messages in a messaging conversation. In some embodiments, the representation of the automatically-generated visual content is no longer displayed in the content entry field after receiving the third input. In some embodiments, the representation of the automatically-generated visual content is displayed as part of the first user interface that is different than the content entry region, which also optionally includes representation of other messages in the conversation (e.g., the messages including content such as text, video, non-automatically-generated visual content, different automatically-generated visual content, emojis, and other content as described above). Displaying the representation of the automatically-generated visual content after sending the automatically-generated visual content in a message allows the user to efficiently view the automatically-generated visual content that was sent, thereby reducing inputs needed to view the automatically-generated visual content.

In some embodiments, while displaying the representation of the automatically-generated visual content in the content entry field, the electronic device receives, via the one or more input devices, a respective set of one or more inputs corresponding to a request to enter text in the content entry field, such as one or more typing inputs to type text 1118 in FIG. 11H. In some embodiments, the respective set of one or more inputs include one or more characteristics of the first input described above. In some embodiments, the respective set of one or more inputs includes an input directed towards a soft keyboard, physical keyboard, and/or virtual assistant to enter text into the content entry field. For example, the respective set of one or more inputs includes an input directed towards the content entry field (e.g., an input corresponding to entering text).

In some embodiments, in response to receiving the respective set of one or more inputs corresponding to the request to enter text in the content entry field, the electronic device displays, via the display generation component, the text in the content entry field concurrently with the representation of the automatically-generated visual content, such as if the content entry field 906 includes the text 1118 and the representation 932e of the automatically-generated visual media image in FIG. 11H. In some embodiments, if the electronic device does not receive the first input to add the automatically-generated visual content to the content entry field, then the electronic device displays the text without displaying the representation of the automatically-generated visual content. In some embodiments, the electronic device sends messages with text, representations of automatically-generated visual content, or a combination of the above. For example, in response to receiving an input corresponding to a request to send a message while displaying the representation of the automatically-generated visual media and the text in the content entry field, the electronic device sends a message to the messaging conversation that includes the automatically-generated visual media and the text. Allowing the user to send text and automatically-generated visual content together in a message reduces the number of inputs needed to transmit text and visual media to a messaging conversation.

In some embodiments, while displaying, via the display generation component, the representation of the automatically-generated visual content, the electronic device receives, via the one or more input devices, a respective set of one or more inputs corresponding to a request to edit the automatically-generated visual content, such as input including contact 914d directed towards indication 924a shown in FIG. 9D. In some embodiments, the respective set of one or more inputs has one or more characteristic of the inputs described above. In some embodiments, the respective set of one or more inputs includes an input directed towards an option displayed on the first and/or second user interfaces. In some embodiments, the option is the visual indication that indicates that the automatically-generated visual content is automatically-generated visual media. The visual indication is described in greater detail above.

In some embodiments, in response to receiving the respective set of one or more inputs corresponding to the request to edit the automatically-generated visual content, the electronic device displays an editing user interface including one or more controls for modifying one or more parameters used to influence the generation of the automatically-generated visual content, such as user interface 604 shown in FIG. 9E including one or more controls for adding, modifying, and/or deleting the recognized concepts 620d through 620g. In some embodiments, the editing user interface has one or more characteristics of the editing user interface described in method 800. In some embodiments, the one or more parameters have one or more characteristics of the one or more parameters described in method 800. In some embodiments, one or more parameters includes the recognized concepts, which are described in greater detail in methods 700 and 800. In some embodiments, the electronic device modifies the one or more parameters by adding, changing, and/or deleting parameters in response to user input. In some embodiments, the electronic device generates (e.g., using an AI process or a generative AI process) the edited automatically-generated visual content in response to receiving an input directed towards a selectable option to generate the automatically-generated visual content, as described in greater detail in methods 700 and 800. Displaying an option to edit the automatically-generated visual content reduces the number of inputs needed to open the editing user interface, thereby reducing erroneous inputs to the electronic device.

In some embodiments, while displaying the second user interface, the electronic device receives, via the one or more input devices, a respective set of one or more inputs directed towards a selectable option that is selectable to create a new automatically-generated visual content, such as the input including contact 914i directed towards option 934 in FIG. 9K. In some embodiments, the respective set of one or more inputs has one or more characteristics of the inputs described above. In some embodiments, the selectable option is selectable via a selection input (e.g., a tap input and/or a gaze input). In some embodiments, the electronic device displays the selectable option on the second user interface. Alternatively, the respective set of one or more inputs includes an input that is optionally a voice input. In some embodiments, the new automatically-generated visual content is not a modified version of the first automatically-generated visual content or other automatically-generated visual content displayed in the second user interface.

In some embodiments, in response to receiving the respective set of one or more inputs directed towards the selectable option that is selectable to create a new automatically-generated visual content, the electronic device displays, via the display generation component, an automatically-generated visual media creation user interface for generating the new automatically-generated visual content, such as user interface 604 shown in FIG. 9L. In some embodiments, the automatically-generated visual media creation user interface is described in greater detail in methods 700 and 800. In some embodiments, generating the new automatically-generated visual content includes generating using one or more recognized concepts and/or starting media, as described in methods 700 and 800. In some embodiments, the electronic device receives inputs to add, delete, and/or change the one or more parameters to generate the new automatically-generated visual content in the creation user interface. Displaying an option that is selectable to open the automatically-generated visual media creation user interface reduces the number of inputs needed to open the automatically-generated visual media creation user interface (e.g., the electronic device displays the automatically-generated visual media creation user interface without opening the second application), thereby reducing erroneous inputs to the electronic device.

In some embodiments, while displaying the automatically-generated visual media creation user interface, the electronic device receives, via the one or more input devices, one or more parameters that will influence the generation of the new automatically-generated visual media (e.g., images and/or videos) that is generated at least partially using one or more autonomous processes, such as recognized concepts 602v through 620y shown in FIG. 9M. In some embodiments, the one or more parameters have one or more characteristics of the one or more parameters described in method 800. In some embodiments, the electronic device receives starting media, prompts, and/or recognized concepts (described in greater detail in methods 700 and 800) for use in creating the new automatically-generated visual content. In some embodiments, the electronic device receives the one or more parameters via a keyboard, a voice command, and/or a touchpad. In some embodiments, receiving the one or more parameters includes receiving one or more inputs selecting representations of the one or more parameters, receiving one or more inputs entering text describing the one or more parameters, and/or receiving a voice input indicating the one or more parameters. In some embodiments, the automatically-generated visual media creation user interface has one or more of the characteristics describes with reference to methods 700 and/or 800. Allowing the user to add one or more parameters while displaying the automatically-generated visual media creation user interface reduces the number of erroneous inputs to the electronic device thereby reducing the computing resources used by the electronic device.

In some embodiments, the one or more parameters includes text corresponding to one or more recognized concepts, such as text shown in recognized concept 620y shown in FIG. 9M. In some embodiments, the text is inputted using a keyboard and/or voice command while displaying the automatically-generated visual media creation user interface. In some embodiments, the text corresponds to a prompt, which the electronic device uses to identify recognized concepts. In some embodiments, the text includes keywords corresponding to one or more recognized concepts. In some embodiments, the one or more parameters and the one or more recognized concepts, and their corresponding inputs, are described in greater detail in methods 700 and 800. Allowing the user to input text as one or more recognized concepts allows the user to easily and efficiently create automatically-generated visual content based on text inputs (rather than visual inputs).

In some embodiments, after generating the new automatically-generated visual content and while displaying the automatically-generated visual media creation user interface, the electronic device receives, via the one or more input devices, a respective set of one or more inputs corresponding to a request to save the new automatically-generated visual content, such as the inputs including contact 914k shown in FIGS. 9N and 914g shown in FIG. 9H. In some embodiments, the respective set of one or more inputs has one or more characteristics of the inputs described above. In some embodiments, the respective set of one or more inputs is directed towards an option in the automatically-generated visual media creation user interface to save the new automatically-generated visual content (e.g., a “save” and/or “save as” option). Saving an automatically-generated visual content is described in more detail in method 800.

In some embodiments, in response to receiving the respective set of one or more inputs corresponding to the request to save the new automatically-generated visual content, in accordance with a determination that the respective set of one or more inputs corresponding to the request to save the new automatically-generated visual content is directed towards a first option (e.g., a save or replace option described in greater detail in method 800), the electronic device replaces the automatically-generated visual content with the new automatically-generated visual content, such as if an input is directed towards option 630d shown in FIG. 9H. In some embodiments, replacing the automatically-generated visual content with the new automatically-generated visual content also includes no longer displaying the automatically-generated visual content in the first user interface (e.g., in the content entry field) or in the second user interface. In some embodiments, replacing the automatically-generated visual content with the new automatically-generated visual content means saving the new automatically-generated visual content over the automatically-generated visual content. In some embodiments, replacing the automatically-generated visual content with the new automatically-generated visual content also includes populating a representation of the new automatically-generated visual content in the first user interface (e.g., in the content entry field of the messaging conversation). In some embodiments, replacing a first automatically-generated visual content with a second automatically-generated visual content is described in greater detail in method 800.

In some embodiments, in response to receiving the respective set of one or more inputs corresponding to the request to save the new automatically-generated visual content, in accordance with a determination that the respective set of one or more inputs corresponding to the request to save the new automatically-generated visual content is directed towards a second option (e.g., a save as a copy option described in greater detail in method 800), the electronic device saves the new automatically-generated visual content as a second automatically-generated visual content to be displayed in the second user interface, such as if the input is directed towards selectable option 630e shown in FIG. 9H. In some embodiments, saving the new automatically-generated visual content as the second automatically-generated visual content also includes displaying the second automatically-generated visual content in the first user interface (e.g., in the content entry field of the messaging conversation) and optionally no longer displaying the previously displayed automatically-generated visual content in the first user interface. In some embodiments, both the automatically-generated visual content and the second automatically-generated visual content are displayed in the second user interface. In some embodiments, saving the new automatically-generated visual media as a second automatically-generated visual content is described in greater detail in method 800. Including an option to save an automatically-generated visual content as a new automatically-generated visual content and including an option to replace the automatically-generated visual content with the new automatically-generated visual content allows a user to quickly and efficiently save the automatically-generated visual content, thereby reducing the erroneous inputs to the electronic device.

In some embodiments, in response to detecting the respective set of one or more inputs corresponding to the request to save the new automatically-generated visual content, the electronic device adds the new automatically-generated visual content that was generated at least partially using the one or more autonomous processes into the first user interface of the first application, such as adding representation 932c to the content entry field 906 shown in FIG. 9O. In some embodiments, the electronic device adds the automatically-generated visual content to a content entry field of the first user interface. In some embodiments, the content entry field has one or more characteristics of the content entry field described above. In some embodiments, the content entry field includes one or more automatically-generated visual content to be sent to the messaging conversation. In some embodiments, after saving the new automatically-generated visual content, an indication of the new automatically-generated visual content is transmitted to the first application. In some embodiments, in response to the third input, the new automatically-generated visual content is also displayed in the second user interface. As described above, in some embodiments, in response to receiving an input corresponding to a request to send a message to the messaging conversation while displaying the newly automatically-generated visual content in the content entry field in the first user interface, the electronic device sends a message including the newly automatically-generated visual content to the messaging conversation. Automatically adding the new automatically-generated visual content to the content entry field of the first application reduces the number of inputs needed to add the new automatically-generated visual content to the content entry field after generating and saving the new automatically-generated visual content, therefore reducing the erroneous inputs to the electronic device.

It should be understood that the particular order in which the operations in FIG. 10 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1200, 1400, 1500, 1700, 1900, 2100, 2300, and/or 2700) are also applicable in an analogous manner to method 1000 described above with respect to FIG. 10. For example, the operation of the addition of a representation of automatically-generated visual content into a first application described above with reference to method 1000 optionally has one or more of the characteristics of, displaying a representation of a prompt and one or more recognized concepts, editing one or more parameters, including one or more recognized concepts, of a previously generated automatically-generated visual content, and the presentation of an automatically-generated visual media creation user interface to use a non-automatically-generated visual media as the reference media item, displaying portion(s) of a user interface with HDR luminance, displaying one or more portions of the user interface with luminance that is within or greater than a SDR luminance, generating multiple variations of representations of automatically-generated visual content, restricting prompt components to be used to generate automatically-generated visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., methods 700, 800, 1200, 1400, 1500, 1700, 1900, 2100, 2300, and/or 2700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 10 are, optionally, implemented by components depicted in FIGS. 1A-1B. For example, displaying operation 1002a and 1002c, detecting operation 1002d, adding operation 1002e, and receiving operation 1002b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, while displaying a messaging conversation in a messaging conversation between the user and a second user, the user wants to select and/or take a photo/video of a non-automatically-generated visual content. In some embodiments, after selecting and/or taking a photo/video of the non-automatically-generated visual content, the user wants to create an automatically-generated visual content using the image as the reference media item, while the electronic device is still displaying the messaging user interface. In some embodiments, after selecting the reference media item (e.g., from a media library or from a camera application), the electronic device displays an automatically-generated visual media creation user interface. In some embodiments, automatically-generated visual media is media generated using autonomous processes. In some embodiments, generating the automatically-generated visual media includes using a real image as a starting point to build in additional concepts and/or features found in the prompt, as described in methods 700 and 800. The embodiments described below provide ways in which the electronic device receives and adds automatically-generated visual content from the automatically-generated visual media application to the first application. The embodiments described below also provide ways in which the electronic device transmits automatically-generated visual content to a messaging conversation with a second user account. Displaying a user interface for generating the automatically-generated visual content based on a reference media item in the user interface of the first application allows a user to generate an automatically-generated visual content for use with the first application without opening a second application and/or navigating away from the first application, thereby reducing inputs needed to generate such visual media for use with the first application. It is understood that people use devices. When a person uses a device, that person is optionally referred to as a user of the device.

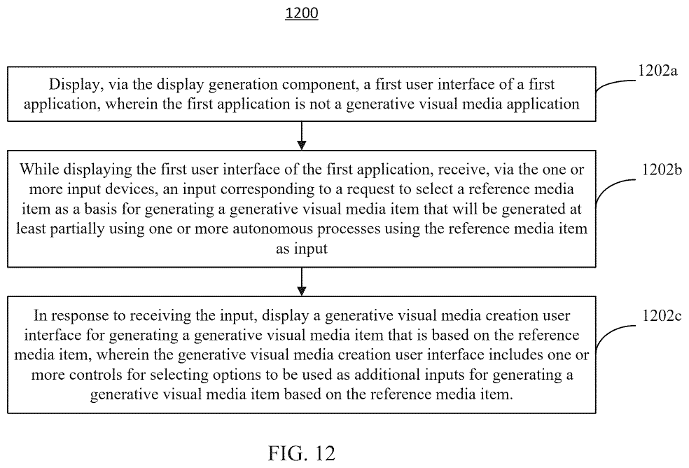

FIGS. 11A-11J illustrate exemplary ways in which an electronic device selects a reference media item to be used to generate an automatically-generated visual content while displaying a user interface of a first application. The embodiments in these figures are used to illustrate the processes described below, including the processes described with reference to FIG. 12. Although FIGS. 11A-11J illustrate various examples of ways an electronic device is able to perform the processes described below with respect to FIG. 12, it should be understood that these examples are not meant to be limiting, and the electronic device is able to perform one or more processes described below with reference to FIG. 12 in ways not expressly described with reference to FIGS. 11A-11I.

FIG. 11A illustrates embodiments of a messaging user interface of a messaging application. FIG. 11A illustrates an electronic device 500 with a display generation component 504 (e.g., a touchscreen). In some embodiments, the electronic device 500 is a mobile device, such as a smartphone, tablet, or wearable device. In FIG. 9A, the electronic device 500 displays user interface 600 that includes a messaging conversation between Joe (e.g., the user associated with the electronic device 500) and a contact named Sally (e.g., indicated by the representation 902 of Sally). The messaging user interface 900 includes the first user interface object 904a (or representation) of a first message, the second user interface object 904b (or representation) of a second message that was added to the messaging conversation from a second device and/or a second user account associated with Sally, and the third user interface object 904c (or representation) of a third message that was added to the messaging conversation from the electronic device 500 and/or the first user account associated with Joe. In some embodiments, the user interface objects 904a, 904b, and 904c and the messaging user interface 900 are described in additional detail in FIG. 9A.

In FIG. 11A, the messaging user interface 900 also includes a content entry field 906, a keyboard 908, a selectable option 910, that when selected, causes the electronic device 500 to use the one or more input devices (e.g., a microphone) to receive a voice command from a user (e.g., a voice command to input text), and a selectable option 912, that when selected, causes the electronic device 500 to display a menu of selectable options 916a through 916h that are selectable to insert various content items into the content entry field.

In FIG. 11A, the electronic device 500 receives a selection input (e.g., a tap or long press input) including contact 1102a directed towards selectable option 912. In response to receiving the input in FIG. 11A, the electronic device 500 displays selectable options 916a through 916h, shown in FIG. 11B.

FIG. 11B illustrates the user interface 900 including the menu of selectable options, that when selected, causes the electronic device 500 to perform various actions while in the messaging application including inserting content into the content entry field 906. The selectable options 916a through 916h are described in greater detail with reference to FIG. 9B.

In FIG. 11B, the electronic device 500 receives a selection input (e.g., a tap or long press input) including contact 1102b directed towards selectable option 916a. In response to receiving the input in FIG. 11B, the electronic device 500 displays a user interface 1104 of a camera application, shown in FIG. 11C. In some embodiments, the camera application is described in greater detail in method 1200. In some embodiments, the electronic device 500 does not close the messaging application to open the camera application, rather the user interface 1104 is displayed over and/or within the messaging user interface 900.

FIG. 11C illustrates the user interface 1104 of the camera application. In some embodiments, the electronic device can use a picture taken using the camera application as a reference media (e.g., starting media) to generate an automatically-generated visual content. FIG. 11C illustrates the physical environment 1106 and the electronic device 500 displaying the user interface 1104 including a representation 1109 of the physical environment. In some embodiments, the user interface 1104 includes a selectable option 1110, that when selected, captures an (e.g., still and/or video) image a representation of the physical environment 1106. In some embodiments, while the selectable option 1110 is displayed as a virtual button in FIG. 11C, the selectable option 1110 can be a physical button on electronic device 500 or a button selectable using a voice command.

In FIG. 11C, the electronic device 500 receives a selection input (e.g., a tap or a long press input) using contact 1102c directed towards selectable option 1110. In response to the input, the electronic device 500 captures an image (e.g., representation 1108) of the physical environment 1106. FIG. 11D illustrates the representation 1108 after the electronic device captures the physical environment 1106. In some embodiments, the electronic device 500 can capture photos and/or videos using the user interface 1104.

FIG. 11D illustrates a user interface 1105 of the camera application that is displayed after the electronic device 500 captures a photo of the physical environment. The electronic device 500 displays the representation 1108 of the physical environment (e.g., a representation of the captured photo) and a plurality of selectable options 1112a through 1112c, 1114a, and 1114b. Selectable option 1114a, when selected, causes the electronic device 500 to redisplay user interface 1104 such that the electronic device is configured to recapture a photo of the physical environment 1106 shown by representation 1109. Selectable option 1114b, when selected, causes the electronic device 500 to add the representation 1108 to the content entry field 906 of the first application (e.g., on user interface 900). Selectable option 1112a, when selected, causes the electronic device 500 to use the representation 1108 as reference media for a new automatically-generated visual content and display the user interface 604 of the automatically-generated visual media application. Selectable option 1112b, when selected, causes the electronic device 500 to open an editing user interface including one or more selectable options to edit the representation 1108 (e.g., resize option, crop option, an option to add a filter, and other photo editing options). Selectable option 1112c, when selected, causes the electronic device 500 to open a markup user interface including one or more options to annotate the representation 1108. In some embodiments, editing representation 1108 using selectable options 1112b and 1112c are different than using representation 1108 as a reference media for creating a new automatically-generated visual content. For example, editing representation 1108 using selectable options 1112b and 1112c does include creating a new image using representation 1108, just editing characteristics of representation 1108. In FIG. 11D, the electronic device 500 receives a selection input directed towards option 1112a. In response to receiving the input, the electronic device 500 ceases displaying the user interface 1105 of the camera application and displays user interface 604 of the automatically-generated visual media application, shown in FIG. 11E, including a recognized concept 620dd corresponding to the representation 1108 to be used as the reference media. Reference media items are described in greater detail in method 1200.

FIG. 11E illustrates the user interface 604, described in greater detail in FIGS. 6A-6MM, including a recognized concept 620dd corresponding to the image captured using the camera application (e.g., representation 1108) as the reference media. The user interface 604 also includes selectable options 624a and 624b and suggested recognized concepts (e.g., selectable options 608l through 608n) which are described in greater detail with reference to FIG. 6C.

FIG. 11F illustrates the user interface 604 after the electronic device 500 has added recognized concepts 620ee through 620gg. In some embodiments, adding a prompt and/or one or more recognized concepts to be used to influence the generation of the automatically-generated visual content is described in greater detail in methods 700 and with reference to FIGS. 6B-6E and FIGS. 6G-6L. As such, the details to add recognized concepts 620ee through 620gg in FIG. 11F are not described but correspond to the methods to add recognized concepts in method 700, and with reference to FIGS. 6B-6E, and FIGS. 6G-6L. For example, the electronic device receives an input corresponding to adding a prompt including the one or more recognized concepts 620ee through 620gg, and/or the electronic device receives inputs selecting the one or more recognized concepts 620ee through 620gg from the suggested recognized concepts and/or the menu of recognized concepts described with reference to method 700.

While displaying the recognized concepts 620ee through 620gg in FIG. 11F, the electronic device 500 receives a selection input (e.g., a tap or long press input) including contact 1102e directed towards selectable option 624b. The details for creating and generating the automatically-generated visual content is described above with reference to FIGS. 9G-91 and FIGS. 9N-90. For example, selecting selectable option 624b causes the electronic device 500 to generate the automatically-generated visual content and then the electronic device receives an input to save the automatically-generated visual content. After generating the automatically-generated visual content and saving the automatically-generated visual content, the electronic device 500 ceases displaying user interface 604 and adds the representation 932e corresponding to the automatically-generated visual content generated using recognized concepts 620dd through 620gg to the content entry field 906 in user interface 900, shown in FIG. 11G. In FIG. 11G, the electronic device 500 also displays indication 924a overlaid on representation 932e to indicate that the representation 932e is an automatically-generated visual content. Indication 924a is described in greater detail in method 1000 and with reference to FIG. 9D.

In FIG. 11G, the electronic device 500 receives a selection input (e.g., a tap or long press input) including contact 1102f directed towards selectable option 928. In response to receiving the input, the electronic device 500 sends the message including the automatically-generated visual content represented by representation 932e to the messaging conversation with Sally, as shown in FIG. 11H. FIG. 11H illustrates the messaging user interface 900 including the message conversation with Sally. In FIG. 11H, the user interface 900 includes the user interface object 904g which includes the representation 932e of the automatically-generated visual content and indication 924b indication that the representation 932e is an automatically-generated visual content and is sent in the messaging conversation. In some embodiments, indication 924b is described in FIG. 9J.

FIG. 11H includes text 1118 that has been input in content entry region 906. In some embodiments, the electronic device displays the text 1118 in response to receiving a text input via the soft keyboard 908 (e.g., a tap or gaze input directed towards the virtual keyboard represented by keyboard 908), described with reference to FIG. 9A, via a voice command (e.g., activated by selecting option 910, shown in FIG. 11A and described with reference to FIG. 9A), and/or via a physical keyboard in communication with the electronic device. In some embodiments, and as described in methods 1000 and 1200, the content entry region 906 includes media items and/or text. In FIG. 11G, the electronic device 500 receives a selection input (e.g., a tap or long press input) including contact 1102g directed towards option 928. In response to receiving the input, the electronic device 500 sends the text (“Otis is cute”) in the content entry field to the messaging conversation with Sally, as shown in FIG. 11I. In some embodiments, the text 1118 is entered in the content entry region 906 concurrently with the representation 932e shown in FIG. 11G. In some embodiments, the text 1118 and the representation 932e are optionally concurrently sent to the messaging conversation (e.g., as one message).

FIG. 11I illustrates the messaging conversation in the messaging user interface 900 including the additional user interface object 904h added to the conversation. User interface object 904h includes the text (“Otis is cute”) from FIG. 11H. In FIG. 11H, the electronic device 500 receives a selection input (e.g., a tap or long press input) including contact 1102h directed towards selectable option 1126. In response to receiving the input, the electronic device 500 ceases displaying messaging user interface 900, and displays a message collection user interface 1120 of the messaging application, shown in FIG. 11J. The message collection user interface 1120 includes a collection of messages between the user of the electronic device 500 and different user accounts.

FIG. 11J illustrates the message collection user interface 1120 including a plurality of representations of different messaging conversations 1122a through 1122g between the user of the electronic device 500 and a different user account. In response to selecting one of the different representations of different messaging conversations 1122a through 1122g, the electronic device 500 displays a messaging user interface including the messages between the participants of the messaging conversation. For example, in response to receiving an input directed towards representation 1122a in FIG. 11J, the electronic device 500 displays the messaging user interface 900 including the one or more user interface objects corresponding to the messages between the user and Sally (e.g., as shown in FIG. 11A). For example, in response to receiving an input directed towards representation 1122c in FIG. 11J, the electronic device 500 displays the messaging user interface including the one or more user interface objects corresponding to the messages between the user and Emmerson. The features described with reference to the messaging user interface 900 including the messaging conversation between the user and Sally are optionally available/apply to the conversations that are selected and navigated to from FIG. 11J. The different representations of different messaging conversations 1122a through 1122g also include a preview of the most recent message sent to the respective messaging conversation and the time at which the message was sent. The message collection user interface 1120 also includes selectable option 1124a, which when selected, causes the electronic device to display an editing user interface of the message collection user interface 1120 (e.g., to delete and/or rearrange the representations of different messaging conversations 1122a through 1122g). The messaging user interface also includes selectable option 1124b, which when selected, displays a new message user interface that includes one or more selectable options to create a messaging conversation with a new user account.

In some embodiments, contacts 1102a through 1102h have one or more characteristics of selection inputs (e.g., a tap or a long press input) including contacts described with reference to FIGS. 6A-6MM. Although touch inputs including contacts are used in the embodiments described here as example inputs, other inputs are possible including voice, hardware input device inputs, and/or air gesture inputs.

FIG. 12 illustrates a flow diagram illustrating a method in which an electronic device selects a reference media item to be used to generate an automatically-generated visual content while displaying a user interface of a first application in accordance with some embodiments of the disclosure. The method 1200 is optionally performed at first electronic device and/or electronic devices such as device 100, device 300, or device 500 as described above with reference to FIGS. 1A-1B, 2-3, 4A-4B and 5A-5H. Some operations in method 1200 are, optionally combined and/or order of some operations is, optionally, changed.

As described below, the method 1200 provides ways in which an electronic device selects a reference media item to be used to generate an automatically-generated visual content while displaying a user interface of a first application. Displaying a user interface for generating the automatically-generated visual content based on a reference media item in the user interface of the first application allows a user to generate an automatically-generated visual content for use with the first application without opening a second application and/or navigating away from the first application, thereby reducing inputs needed to generate such visual media.

Method 1200 is performed at an electronic device in communication with a display generation component and one or more input devices, such as electronic device 500 shown in FIG. 11A. In some embodiments, the electronic device has one or more characteristics of the electronic device described in method 700. In some embodiments, the display generation component has one or more characteristics of the display generation component described in method 700. In some embodiments, the one or more input devices has one or more characteristics of the one or more input devices described in method 700.

In some embodiments, the electronic device displays (1202a), via the display generation component, a first user interface of a first application, wherein the first application is not an automatically-generated visual media application (e.g., the application used to display and/or generate automatically-generated visual content described in methods 700 and 800), such as messaging user interface 900 of a messaging application shown in FIG. 11A. In some embodiments, the first user interface of the first application has one or more characteristics of the first user interface of the first application as described in method 1000.

In some embodiments, while displaying the first user interface of the first application, the electronic device receives (1202b), via the one or more input devices, an input corresponding to a request to select a reference media item (e.g., a photo or video) as a basis for generating an automatically-generated visual content that will be generated at least partially using one or more autonomous processes (e.g., described in greater detail in methods 700 and 800) using the reference media item as input, such as selecting a reference media item from a camera application using the input including contact 1102c shown in FIG. 11C or selecting a reference media item from a media library using an input including contact 914n shown in FIG. 9R. In some embodiments, generating the automatically-generated visual content has one or more characteristics of generating visual content described with reference to methods 700, 800, and/or 1000. In some embodiments, the input has one or more characteristics of the inputs described in method 1000. In some embodiments, the reference media item is an image from a photo library and/or an image taken from a camera application. In some embodiments, the reference media item is not an automatically-generated visual content. Alternatively, in some embodiments, the reference media item is a previously generated visual content (e.g., selected from the second user interface described in method 1000, or from the gallery of automatically-generated visual content described in methods 700 and 800). In some embodiments, in response to receiving the input, the electronic device displays a user interface of a photo library (e.g., within the first application and/or without opening the photo library application) so that the user can select a reference media item. In some embodiments, in response to receiving the input, the electronic device displays a user interface of a camera application including a representation of the physical world of the electronic device (e.g., within the first application and without opening the photo library application or camera application) so that the user can take a photo and/or video to be used as a reference media item using a camera in communication with the electronic device. In some embodiments, taking a photo and/or video includes detecting an input such as a physical press of a button, a voice command to take a photo and/or video, and/or a tap input directed towards a virtual button selectable to take a photo and/or video.

In some embodiments, in response to receiving the input, the electronic device displays (1202c) an automatically-generated visual media creation user interface for generating an automatically-generated visual content that is based on the reference media item, wherein the automatically-generated visual media creation user interface includes one or more controls for selecting options (e.g., recognized concepts and/or one or more parameters as described in methods 700 and 800) to be used as additional inputs for generating an automatically-generated visual content based on the reference media item (e.g., the automatically-generated visual media creation user interface optionally includes one or more characteristics of the user interface described in method 700 and the editing user interface in method 800), such as user interface 604 shown in FIG. 11E including the reference media as recognized concept 620dd. In some embodiments, the automatically-generated visual media creation user interface is a user interface of the first application. In some embodiments, the automatically-generated visual media creation user interface is a user interface of a second application (e.g., an automatically-generated visual media application such as the application used to display automatically-generated visual content described in methods 700 and 800), different than the first application. In some embodiments, the automatically-generated visual media creation user interface is displayed concurrently with the first user interface. In some embodiments, the automatically-generated visual media creation user interface is displayed in conjunction with (e.g., overlaid on, displayed adjacent to, or displayed near) the first user interface (e.g., the electronic device displays a portion of the first user interface while displaying the automatically-generated visual media creation user interface). In some embodiments, the automatically-generated visual media creation user interface includes a representation of the reference media item. In some embodiments, the reference media item includes a representation of a person, such as described in methods 700 and 800. In some embodiments, the representation of the person is in the reference media item itself or in an image other than the reference media item. In some embodiments, the reference media item does not include a representation of a person (e.g., the reference media item is a photo of a tree, an animal, a building, scenery, or other inanimate/animate objects), such as using representation 938b as the reference media item, shown in FIG. 9R. In some embodiments, the automatically-generated visual media creation user interface includes a content entry region configured to receive one or more parameters to influence the generation of the automatically-generated visual content, such as described in methods 700 and 800. In some embodiments the one or more parameters includes one or more characteristics of the one or more parameters described in method 800. In some embodiments, the one or more parameters includes recognized concepts and/or a prompt, described in greater detail in methods 700 and 800. In some embodiments, the automatically-generated visual media creation user interface includes an option that, when selected, causes the electronic device to initiate a process to generate the automatically-generated visual content based on the reference media item and the one or more parameters. Displaying a user interface for generating the automatically-generated visual content based on a reference media item in the user interface of the first application allows a user to generate an automatically-generated visual content for use with the first application without opening a second application and/or navigating away from the first application, thereby reducing inputs needed to generate such visual media.

In some embodiments, the first application is a messaging application, such as the messaging application including the messaging user interface 900 shown in FIG. 11A. In some embodiments, the messaging application has one or more characteristics of the messaging application described in method 1000. Displaying a user interface for inserting the automatically-generated visual content into the user interface of a messaging application allows a user to efficiently message automatically-generated visual content to other user accounts without opening a second application and/or navigating away from the first user interface, thereby reducing inputs needed to insert such visual media.

In some embodiments, while displaying the automatically-generated visual media creation user interface, the electronic device receives, via the one or more input devices, a respective set of one or more inputs corresponding to a request to generate the automatically-generated visual content, such as the input including contact 624b in FIG. 11F and also, optionally, the including contact 914g shown in FIG. 9H. In some embodiments, the respective set of one or more inputs includes one or more characteristics of the input described above. In some embodiments, the respective set of one or more inputs includes a selection input, such as a tap with a contact (e.g., a finger, or stylus), selection with an indirect input device (e.g., mouse, remote control, or trackpad) that is directed to a location of a focus indicator such as a cursor or selection ring) and/or a gaze input (optionally as part of an air gesture). In some embodiments, the one or more second inputs is directed towards a selectable option on the automatically-generated visual media creation user interface that is selectable to indicate the generation of the automatically-generated visual content.

In some embodiments, in response to receiving the respective set of one or more inputs corresponding to the request to generate the automatically-generated visual content, the electronic device generates (e.g., using an AI process or a generative AI process) the automatically-generated visual content, such as if the electronic device 500 displays a user interface including a high fidelity version of representation 622dd in FIG. 11F. In some embodiments, generating the automatically-generated visual content includes saving the automatically-generated visual content, described in further detail in methods 800 and 1000. In some embodiments, generating the automatically-generated visual media is described in further detail in methods 700, 800, and 1000.

In some embodiments, the electronic device adds a representation of the automatically-generated visual content to a content entry field in the first user interface of the messaging application, such as adding representation 932e into content entry field 906 shown in FIG. 11G. In some embodiments, after the electronic device is finished generating the automatically-generated visual content (e.g., the electronic device generates the automatically-generated visual content and receives an input corresponding to a request to save the automatically-generated visual content, described further detail in method 1000), the electronic device displays a representation of the automatically-generated visual content in a content entry field in the first user interface. In some embodiments, the content entry field is a messaging composition field of a messaging application, as described in further detail in method 1000. Automatically adding the automatically-generated visual content to the content entry field of the first application reduces the number of inputs needed to add the automatically-generated visual content to the content entry field after generating and saving the automatically-generated visual content, therefore reducing the erroneous inputs to the electronic device.

In some embodiments, receiving the input corresponding to the request to select the reference media item as the basis of generating the automatically-generated visual content further comprises receiving the input directed towards a first visual indication displayed, via the display generation component, in conjunction with (e.g., overlaid on, displayed adjacent to, or displayed near) a representation of the reference media item, such as receiving an input including contact 9140 directed towards indication 924c shown in FIG. 9S. In some embodiments, the first visual indication has one or more characteristics of the visual indication indicating that the automatically-generated visual content is automatically-generated visual media, described in method 1000. In some embodiments, the first visual indication and the visual indication that the automatically-generated visual content is automatically-generated visual media (e.g., the second visual indication described below) include differences, described below. In some embodiments, the first visual indication is an icon representing automatically-generated visual media. In some embodiments, the input is a selection input (e.g., a tap input or a gaze input). In some embodiments, the input is a voice input or an input received via a hardware input device. Displaying a visual indication on the reference media item that is selectable to display the automatically-generated visual media creation user interface with the reference media item as the starting media reduces the number of inputs needed to generate automatically-generated visual content, therefore reducing erroneous inputs to the electronic device.

In some embodiments, while displaying the automatically-generated visual media creating user interface, the electronic device receives a respective set of one or more inputs corresponding to a request to generate the automatically-generated visual content, such as the input including contact 1102g directed towards option 624b shown in FIG. 11F. In some embodiments, the respective set of one or more inputs has one or more characteristics of the inputs described above. In some embodiments, the respective set of one or more inputs includes an input directed towards an option (e.g., a “create” option) to cause the generation of the automatically-generated visual content.

In some embodiments, in response to receiving the respective set of one or more inputs corresponding to a request to generate the automatically-generated visual content, the electronic device generates (e.g., using an AI process or a generative AI process) the automatically-generated visual content that is based on the reference media item, such as if the electronic device 500 displays a user interface including the high fidelity version of the representation 622i shown in FIG. 11F. In some embodiments, the automatically-generated visual content is also based on one or more parameters including prompts and recognized concepts, described in greater detail in methods 700, 800, and 1000. In some embodiments, generating the automatically-generated visual content is as described with reference to methods 700, 800 and/or 1000.

In some embodiments, after generating the automatically-generated visual content, the electronic device displays, in the first user interface, a representation of the automatically-generated visual content, such as representation 932e shown in FIG. 11G. In some embodiments, the representation of the automatically-generated visual content is the representation of the automatically-generated visual content described in method 700 (e.g., a lower fidelity version of the automatically-generated visual content) or the automatically-generated visual content generated using the process to generate the automatically-generated visual content (e.g., the higher fidelity representation described in method 700). In some embodiments, the representation of the automatically-generated visual content is smaller in size compared to the high-fidelity representation described in method 700 but contains the characteristics of the higher fidelity representation (e.g., higher resolution, more detailed, more color depth, and other characteristics described in method 700). In some embodiments, the representation of the automatically-generated visual content is displayed in a content entry field described in greater detail above and in method 1000.

In some embodiments, after generating the automatically-generated visual content, the electronic device displays, in the first user interface, a second visual indication displayed in conjunction with (e.g., overlaid on, displayed adjacent to, or displayed near) the representation of the automatically-generated visual content, such as visual indication 924a shown in FIG. 11G, wherein the first visual indication (e.g., visual indication 924c shown in FIG. 9S that is displayed in conjunction with a non-automatically-generated visual content) has a first value for a visual characteristic (e.g., the first visual indication has a first visual appearance) and the second visual indication has a second value for the visual characteristics that is different from the first value (e.g., the second visual indication has a second visual appearance, different from the first visual appearance). In some embodiments, different visual indications are overlaid over automatically-generated visual content and reference media items to visually indicate which media items are generative and which are not. In some embodiments, reference media items have a first value for the visual characteristic (e.g., a first color, a first shading, a first transparency, a first line thickness, and/or a first shape) of the first visual indication. In some embodiments, automatically-generated visual content have a second value for the visual characteristic (e.g., a second color, a second shading, second transparency, a second line thickness, and/or a second shape) of the second visual indication. In some embodiments, there are similarities between the first visual indication and the second visual indication. For example, the first visual indication and the second visual indication include the same image in the icon, however, the first visual indication is a first color and the second visual indication is a second color. Having different visual indications for automatically-generated visual content and reference media items allows a user to easily and efficiently identify the type of media item even if the automatically-generated visual content are photorealistic, thereby reducing erroneous inputs to the electronic device.

In some embodiments, while displaying the representation of the automatically-generated visual content in the first user interface of the first application with the second visual indication displayed in conjunction with (e.g., overlaid on, displayed adjacent to, or displayed near) the representation of the automatically-generated visual content (e.g., before the electronic device receives an input directed towards sending the message including the representation of the automatically-generated visual content. In some embodiments, displaying the representation of the automatically-generated visual content in the first user interface is described in greater detail in method 1000.), the electronic device receives, via the one or more input devices, a respective set of one or more inputs corresponding to a request to send a message including the automatically-generated visual content to a messaging conversation, such as an input including contact 1102f directed towards option 928 shown in FIG. 11G. In some embodiments, the respective set of one or more inputs includes one or more characteristics of the first input described above. In some embodiments, the respective set of one or more inputs is directed towards an option included in a messaging user interface (e.g., a selectable option selectable via touch or gaze input). For example, the option is a send button. In some embodiments, the third input is a voice input or an input received via a hardware input device.

In some embodiments, in response to receiving the respective set of one or more inputs corresponding to the request to send a message including the automatically-generated visual content to the messaging conversation, the electronic device sends the message including the automatically-generated visual content to the messaging conversation, such as shown by the message represented by user interface object 904g including representation 932e of the automatically-generated visual content in FIG. 11H. In some embodiments, sending the message includes one or more characteristics of sending the message described in method 1000.

In some embodiments, after sending the message, the electronic device displays, via the display generation component, in the first user interface, a representation of the message that includes the representation of the automatically-generated visual media including a third visual indication displayed in conjunction with (e.g., overlaid on, displayed adjacent to, or displayed near) the representation of the automatically-generated visual content with a third value for the visual characteristic that is different from the second value (e.g., the third visual indication has a different visual appearance than the first visual indication and/or the second visual indication), such as indication 924b shown in FIG. 11H, which is different than indication 924a shown in FIG. 11G. In some embodiments, displaying the representation of the message with the representation of the automatically-generated visual content is described in greater detail in method 1000. In some embodiments, the representation of the message is displayed in the messaging user interface including the messaging conversation. In some embodiments, displaying the representation of the message allows a user to view previously sent messages in a messaging conversation. In some embodiments, the third visual indication has a third value for the visual characteristic (e.g., a third color, a third shading, a third transparency, a third line thickness, and/or a third shape). In some embodiments, the third visual indication has one or more characteristics of the first and second visual indications. For example, the third visual indication includes the same image as the first and second visual indication but includes a third color different than the first and second colors. In some embodiments, sending the message includes sending an indication that the automatically-generated visual content is automatically-generated visual media. In some embodiments, sending the message including the automatically-generated visual content to the messaging conversation causes one or more electronic devices with access to the messaging conversation, including the electronic device(s) of the one or more second user accounts, to display the automatically-generated visual content. In some embodiments, the electronic device(s) of the one or more second user accounts also displays the third visual indication overlaid over the automatically-generated visual content. In some embodiments, the third visual indication is selectable to display the editing user interface including the one or more parameters used to generate the automatically-generated visual content. Alternatively, in some embodiments, the third visual indication is selectable to display the editing user interface and to use the automatically-generated visual content as the reference media item. Alternatively, in some embodiments, the third visual indication is not selectable to open the editing user interface. Displaying a different visual indications on the automatically-generated visual content after the automatically-generated visual content has been sent in the message allows a user to easily and efficiently identify the type of media item even if the automatically-generated visual media is photorealistic, thereby reducing erroneous inputs to the electronic device.

In some embodiments, while displaying the representation of the automatically-generated visual content in the first user interface of the first application with the second visual indication displayed in conjunction with (e.g., overlaid on, displayed adjacent to, or displayed near) the representation of the automatically-generated visual content (e.g., and before receiving the input to send the message including the representation of the automatically-generated visual content), the electronic device receives, via the one or more input devices, a respective set of one or more inputs corresponding to a request to send a message including the automatically-generated visual content to a messaging conversation, such as input including contact 1102f shown in FIG. 11G. In some embodiments, the respective set of one or more inputs includes one or more characteristics of the first input described above. In some embodiments, the respective set of one or more inputs is directed towards an option included in a messaging user interface (e.g., a selectable option selectable via touch or gaze input). For example, the option is a send button. In some embodiments, the third input is a voice input or an input received via a hardware input device.

In some embodiments, in response to receiving the respective set of one or more inputs corresponding to the request to send a message including the automatically-generated visual content to a messaging conversation, the electronic device sends the message including the automatically-generated visual content to the messaging conversation, such as shown by the message represented by user interface object 904g including representation 932e of the automatically-generated visual content in FIG. 11H. In some embodiments, sending the message includes one or more characteristics of sending the message described in method 1000.

In some embodiments, after sending the message, the electronic device displays, in the first user interface, a representation of the message that includes the representation of the automatically-generated visual media without displaying the second visual indication, such as if representation 932e did not include indication 924b shown in FIG. 11H. In some embodiments, after sending the message, the electronic device does not display a visual indication (e.g., the second visual indication or the third visual indication or another visual indication, described above) on the representation of the automatically-generated visual content. In some embodiments, sending the message does not include sending an indication that the automatically-generated visual content is automatically-generated visual media. For example, the electronic device(s) of the one or more second user accounts that receives the message also does not display a visual indication (e.g., the second or third visual indication) overlaid over the automatically-generated visual content. Additionally, in some embodiments, after sending the message including the automatically-generated visual content to the messaging conversation, the electronic device does not display the representation of the message with the second visual indication such that the automatically-generated visual content cannot be edited once sent in the message. Forgoing displaying the second visual indication on the automatically-generated visual content after the automatically-generated visual content has been sent in the message allows a user to easily and efficiently identify that the automatically-generated visual content is automatically-generated visual media that has been sent to the messaging conversation even if the automatically-generated visual media has the appearance of being photorealistic, thereby reducing erroneous inputs to the electronic device.

In some embodiments, while displaying the first user interface of the first application, the electronic device receives an indication of a first message including a representation of a second automatically-generated visual content, such as if the electronic device 500 receives a message in the messaging user interface 900 from Sally in FIG. 11H including a representation of a second automatically-generated visual content. In some embodiments, the electronic device receives the first message from an electronic device(s) of the one or more second user accounts (e.g., the electronic device(s) of the one or more second user accounts sends a message in the messaging conversation including the second automatically-generated visual content).

In some embodiments, in response to receiving the indication of the first message, the electronic device displays, in the first user interface, the representation of the message that includes the representation of the second automatically-generated visual content including the third visual indication displayed in conjunction with (e.g., overlaid on, displayed adjacent to, or displayed near) the representation of the second automatically-generated visual content, such as if the representation of the second automatically-generated visual media includes the indication 924b displayed in conjunction with the representation. In some embodiments, the third visual indication has one or more characteristics of the second and/or third visual indication as described above. In some embodiments, the indication that the automatically-generated visual content is automatically-generated visual media is transmitted with the message (e.g., the indication that the second automatically-generated visual content is automatically-generated visual media is sent to the electronic device and the electronic device displays the third visual indication as a result). In some embodiments, the third visual indication displayed overlaid on the representation of the second automatically-generated visual content is displayed by one or more or all of the electronic devices that have access to the messaging conversation. In some embodiments, the electronic device does not display the third visual indication overlaid over the representation of the second automatically-generated visual content, as described in greater detail above. In some embodiments, the third visual indication is selectable to display the editing user interface including the one or more parameters used to generate the automatically-generated visual content. Alternatively, in some embodiments, the third visual indication is selectable to display the editing user interface and to use the automatically-generated visual content as the reference media item. Alternatively, in some embodiments, the third visual indication is not selectable to open the editing user interface. Displaying a visual indication on the automatically-generated visual content after the automatically-generated visual content has been sent in the message allows a user to easily and efficiently identify media items that are automatically-generated visual content in the messages even if the automatically-generated visual content have the appearance of being photorealistic, thereby reducing erroneous inputs to the electronic device.

In some embodiments, the first user interface of the first application concurrently includes the representation of the automatically-generated visual content including the third visual indication and the representation of the second automatically-generated visual content including the third visual indication, such as if the representation of the second automatically-generated visual content includes indication 924b and the representation 932e of the first automatically-generated visual content includes indication 924b shown in FIG. 11H. In some embodiments, automatically-generated visual content sent in the messaging conversation includes the third visual indication overlaid over the representation of the respective automatically-generated visual content. In some embodiments, multiple automatically-generated visual content are displayed as including a respective visual indication including the same visual appearance as the third visual indication. In some embodiments, the visual indications are selectable to display the editing user interface, as described with reference to the third visual indication above. Alternatively, in some embodiments, the visual indications are not selectable to open the editing user interface. Sharing the visual indication on the automatically-generated visual content after the automatically-generated visual content has been sent in the message allows the users of the messaging conversation to easily and efficiently identify automatically-generated visual content in the messages even if they are photorealistic, thereby reducing erroneous inputs to the electronic device.

In some embodiments, while displaying the first user interface of the first application, the electronic device receives an indication of a second message that includes a representation of a non-automatically-generated visual content, such as if the electronic device 500 receives a message in the messaging user interface 900 from Sally in FIG. 11H including a representation of a non-automatically-generated visual content. In some embodiments, the second message is displayed in the messaging conversation with the one or more second user accounts associated with the sender of the second message in the first user interface. In some embodiments, the second message is sent by the electronic device(s) of the one or more second user accounts.

In some embodiments, in response to receiving the indication of the second message, the electronic device displays, a representation of the second message including the representation of the non-generative automatically-generated visual content without displaying the third visual indication displayed in conjunction with (e.g., overlaid on, displayed adjacent to, or displayed near) the representation of the non-automatically-generated visual content, such as if the representation of the automatically-generated visual content in the message does not include the indication 924b. In some embodiments, the electronic device displays the first visual indication, described above, over the representation of the non-automatically-generated visual content. In some embodiments, the representation of the non-automatically-generated visual content does not include a visual indication overlaid over the representation. In some embodiments, non-automatically-generated visual content do not include the display of the third visual indication since the third visual indication is overlaid over automatically-generated visual media. Forgoing displaying the visual indication to identify automatically-generated visual content on non-automatically-generated visual content allows the user to easily identify media items, thereby reducing erroneous inputs to the electronic device.

In some embodiments, the input corresponding to the request to select the reference media item is included in a sequence of one or more inputs that further comprises receiving a respective set of one or more inputs corresponding to a request to display a media library, such as input including 914m directed towards option 916b in FIG. 9Q. In some embodiments, the respective set of one or more inputs includes one or more characteristics of the inputs described above. In some embodiments, the respective set of one or more inputs is directed towards a selectable option in the first user interface (e.g., selectable via tap input, gaze input, and/or voice command input) that is selectable to display the media library. In some embodiments, the media library is described in greater detail in methods 800 and 1000.

In some embodiments, in response to receiving the respective set of one or more inputs corresponding to the request to display the media library, the electronic device displays, via the display generation component, the media library (optionally in the first user interface), such as user interface element 936 shown in FIG. 9R. In some embodiments, the media library is an image (e.g., photo) and/or video library. In some embodiments, the media library includes image(s) (e.g., photo(s)) and/or video(s) of people, objects, or environments (e.g., of animals, people, or scenery). In some embodiments, the media library includes automatically-generated visual content and non-automatically-generated visual content. In some embodiments, the media library is overlaid over the first user interface, described in greater detail in method 1000.

In some embodiments, while displaying the media library, the electronic device receives a respective set of one or more inputs corresponding to a request to select a respective media item from a plurality of media items in the media library as the reference media item, such as the input including contact 914 directed towards representation 938b shown in FIG. 9R.

In some embodiments, in response to receiving the respective set of one or more inputs corresponding to the request to select the reference media item, using the respective media item as the reference media item, such as using representation 938b as the reference media item (e.g., recognized concept 920z) shown in FIG. 9T. In some embodiments, the respective set of one or more inputs has one or more characteristics of the inputs described above. In some embodiments, respective set of one or more inputs is directed towards a representation of the reference media item displayed in the media library. In some embodiments, after selecting the reference media item, the electronic device displays the automatically-generated visual media creation user interface, described above in method 1000. In some embodiments, if respective set of one or more inputs is directed towards a representation of a second reference media item, then the electronic device uses the second reference media item as the starting media (e.g., described in methods 700 and 800) for generating an automatically-generated visual content. Displaying a media library for a user to select a reference media item without opening a media library application and/or navigating away from the first user interface reduces the number of inputs needed to select reference media items.

In some embodiments, the input corresponding to the request to select the reference media item is included in a sequence of one or more inputs that further comprises receiving a respective set of one or more inputs corresponding to a request to display a user interface of a camera application including a live preview of a physical environment, such as the input including contact 1102b directed towards option 916a shown in FIG. 11B. In some embodiments, the respective set of one or more inputs has one or more characteristics of the inputs described above. In some embodiments, the respective set of one or more inputs is directed towards an option in the first user interface (e.g., selectable via tap input, gaze input, and/or voice command input) that is selectable to display the user interface of the camera application.

In some embodiments, in response to receiving the respective set of one or more inputs corresponding to the request to display a user interface of a camera, the electronic device displays, on the first user interface, the user interface of the camera application, such as user interface 1104 shown in FIG. 11C. In some embodiments, the user interface of the camera application includes one or more options to take a picture and/or video of the physical environment shown in the live preview of the physical environment included in the user interface of the camera application. In some embodiments, the user interface of the camera application is overlaid over the first user interface. In some embodiments, the user interface of the camera application includes the live preview of the physical environment, an option that is selectable to capture an image and/or video of what is being previewed in the live preview. In some embodiments, after capturing the image and/or video, the user interface includes one or more selectable options to edit the image and/or video and to use the image and/or video as the reference media item in an automatically-generated visual content.

In some embodiments, while displaying the user interface of the camera application, the electronic device receives a respective set of one or more inputs corresponding to a request to capture a new media item using the camera application for use as the reference media item, such as with an input including contact 1102c directed towards option 1110 shown in FIG. 11C. In some embodiments, in response to receiving the respective set of one or more inputs corresponding to the request to capture a new media item using the camera application, the electronic device captures a new media item using the camera application and using the new media item as the reference media item, such as capturing representation 1108 shown in FIG. 11D and using representation 1108 as the recognized concept 620dd shown in FIG. 11E.

In some embodiments, the respective set of one or more inputs has one or more characteristics of the inputs described above. For example, the user selects a virtual or physical button (e.g., via a tap, a voice, or gaze input) on the electronic device to take a picture/video. In some embodiments, after capturing the new media item, the electronic device uses the new media item as the reference media for generating an automatically-generated visual content. For example, and as described above, the electronic device receives an input directed towards an option on the user interface to use the new media item as the reference media item. Alternatively, in some embodiments, the electronic device receives an input to save the new media item in the media library without using it to generate an automatically-generated visual content. Displaying a user interface of a camera application for a user to capture a reference media item without opening the camera application and/or navigating away from the first user interface reduces the number of inputs needed to select reference media items.

In some embodiments, displaying the automatically-generated visual media creation user interface in response to receiving the input corresponding to the request to the select the reference media item includes displaying a representation of the reference media item in the automatically-generated visual media creation user interface, such as displaying representation 1108 as recognized concept 620dd in FIG. 11E. Displaying the representation of the reference media item in the automatically-generated visual media creation user interface is optionally as described in further detail in methods 700 and/or 800. In some embodiments, the electronic device additionally or alternatively displays a representation of the automatically-generated visual content (e.g., which is based on the reference media item) while in the automatically-generated visual media creation user interface, which is also described in further detail in methods 700 and/or 800. Displaying the reference media used to generate the automatically-generated visual media while in the automatically-generated visual media creation user interface allows a user to easily and efficiently see the concepts used to generate the generative image, thereby reducing errors in output of the electronic device, and avoiding the need for additional input to correct such errors.

In some embodiments, while displaying the automatically-generated visual media creation user interface, the electronic device receives, via the one or more input devices, one or more parameters to be used as the options to be used as additional inputs for generating the automatically-generated visual content, such as recognized concepts 620ee through 620gg shown in FIG. 11F. In some embodiments, in response to receiving the one or more parameters, the electronic device displays the one or more parameters (e.g., recognized concepts) on the automatically-generated visual media creation user interface. In some embodiments, the one or more parameters has one or more characteristics of the one or more parameters described in method 800. In some embodiments, the electronic device receives starting media, prompts, and/or recognized concepts (described in greater detail in methods 700 and 800) for use in creating the new automatically-generated visual content. In some embodiments, the electronic device receives the one or more parameters via a keyboard, a voice command, and/or a touchpad. In some embodiments, receiving the one or more parameters includes receiving one or more inputs selecting representations of the one or more parameters, receiving one or more inputs entering text describing the one or more parameters, and/or receiving a voice input indicating the one or more parameters. Receiving a parameter while displaying the automatically-generated visual media creation user interface allows a user to easily and efficiently modify the recognized concepts used to generate the automatically-generated visual content, thereby reducing errors in output of the electronic device, and avoiding the need for additional input to correct such errors.

In some embodiments, the electronic device receives, via the one or more input devices, the one or more parameters includes receiving a language (e.g., text or spoken) prompt to be used to influence the generation of the automatically-generated visual content, such as shown by recognized concept 620gg in FIG. 11F. In some embodiments, the automatically-generated visual media creation user interface includes a text entry field for receiving language prompts. In some embodiments, the electronic device receives the language prompt using a keyboard and/or a voice command. In some embodiments, the electronic device identifies one or more recognized concepts in the language prompt to be used to influence the generation of the automatically-generated visual content. In some embodiments, language prompts and one or more parameters are described in greater detail in methods 700, 800, and 1000. Allowing the user to input text as one or more parameters allows the user to easily and efficiently create automatically-generated visual content based on text inputs (rather than visual inputs).

In some embodiments, the electronic device receives, via the one or more input devices, a respective set of one or more inputs providing one or more parameters for generating the automatically-generated visual content and requesting to generate the automatically-generated visual content based on the reference media item and the one or more parameters, such as the input including contact 1102g shown in FIG. 11F. In some embodiments, providing one or more parameters and request to generate the automatically-generated visual content is described in further detail in methods 700 and 800. In some embodiments, the respective set of one or more inputs occur while the electronic device is displaying the automatically-generated visual media creation user interface. In some embodiments, the respective set of one or more inputs includes an input directed towards inputting a prompt and/or inputting one or more recognized concepts, described in greater detail in methods 700 and 800.

In some embodiments, in response to receiving the respective set of one or more inputs providing one or more parameters for generating the automatically-generated visual content, the electronic device displays, via the display generation component, a representation of the automatically-generated visual content in the first user interface of the first application generated based on the one or more parameters, such as representation 932e shown in FIG. 11G. In some embodiments, the electronic device also receives an input to generate the automatically-generated visual content after receiving one or more inputs providing one or more parameters. In some embodiments, in response to receiving the respective set of one or more inputs providing the one or more parameters for generating the automatically-generated visual content, the electronic device generates (e.g., using an AI process or a generative AI process) the automatically-generated visual content. In some embodiments, generating the automatically-generated visual content includes saving the automatically-generated visual content, described in greater detail in methods 800 and 1000. In some embodiments, generating the new automatically-generated visual content includes generating using one or more recognized concepts and/or starting media, as described in methods 700 and/or 800. In some embodiments, the electronic device displays a representation of the automatically-generated visual content in a content entry field in the first user interface. In some embodiments, the automatically-generated visual content is also displayed in a user interface of the automatically-generated visual media application (e.g., the second application). For example, the automatically-generated visual content is displayed in a gallery of other previously generated automatically-generated visual content, described in method 800.

In some embodiments, displaying the representation of the automatically-generated visual content includes in accordance with a determination that the one or more parameters are one or more first parameters, displaying the representation of the automatically-generated visual content with a first appearance, such as the visual appearance of representation 932e shown in FIG. 11G. In some embodiments, the electronic device generates (e.g., using an AI process or a generative AI process) the automatically-generated visual content with the first appearance using one or more recognized concepts identified from the one or more first parameters and the reference media item. In some embodiments, a representation of the automatically-generated visual content with the first appearance is displayed in the content entry field in the first user interface. In some embodiments, the electronic device sends a message including the automatically-generated visual content with the first appearance by receiving an input while the representation of the automatically-generated visual content with the first appearance is displayed in the first user interface, as described above.

In some embodiments, displaying the representation of the automatically-generated visual content includes in accordance with a determination that the one or more parameters are one or more second parameters different from the one or more first parameters, displaying the representation of the automatically-generated visual content with a second appearance that is different from the first appearance, such as if the recognized concepts in FIG. 11F were different, then the visual appearance of representation 932e would be different in FIG. 11G. In some embodiments, the electronic device generates (e.g., using an AI process or a generative AI process) the automatically-generated visual content with the second appearance using one or more recognized concepts identified from the one or more second parameters and the reference media item. In some embodiments, the first one or more parameters are different from the second one or more parameters. Alternatively, in some embodiments, the parameters are the same but the process to generate automatically-generated visual content is non-deterministic (e.g., described in greater detail in methods 700 and 800) so the resulting automatically-generated visual content are different. For example, the first appearance and the second appearance are different. In some embodiments, different parameters results in different automatically-generated visual content, as described in methods 700 and 800. Automatically adding the automatically-generated visual content to the first user interface of the first application reduces the number of inputs needed to add the automatically-generated visual content to the first application (e.g., navigating away from the automatically-generated visual media creation user interface) after generating the automatically-generated visual content, therefore reducing the erroneous inputs to the electronic device.

In some embodiments, after generating the automatically-generated visual content, the electronic device receives, via the one or more input devices, a respective set of one or more inputs corresponding to a request to save the automatically-generated visual content, such as the input including contact 914f directed towards 930b in FIG. 9G and the input including contact 914g in FIG. 9H. In some embodiments, the respective set of one or more inputs has one or more characteristics of the inputs described above. In some embodiments, the respective set of one or more inputs is directed towards an option in the automatically-generated visual media creation user interface to save the automatically-generated visual content (e.g., save or save as copy as described in methods 800 and 1000). In some embodiments, saving an automatically-generated visual content is described in more detail in method 800.

In some embodiments, in response to receiving the respective set of one or more inputs corresponding to the request to save the automatically-generated visual content, the electronic device saves the automatically-generated visual content to a gallery of automatically-generated visual content (e.g., described in greater detail in method 800) in an automatically-generated visual media application, such as if representation 932e is saved to the user interface 600, shown in FIG. 6A and if representation 932e is also displayed in user interface element 922 shown in FIG. 9O. In some embodiments, even though the process to generate the automatically-generated visual content was launched/started from the first application, the electronic device saves the automatically-generated visual content to the automatically-generated visual media application. In some embodiments, the respective set of one or more inputs is directed towards a save or replace option described in greater detail in method 800 and 1000. In some embodiments, the respective set of one or more inputs is directed towards a save as a copy option described in greater detail in method 800 and 1000. In some embodiments, saving the automatically-generated visual content also includes populating a representation of the new automatically-generated visual content in the first user interface (e.g., in the content entry field of the messaging conversation), described above. In some embodiments, the electronic device saves the automatically-generated visual content to the first application. Alternatively, in some embodiments, the electronic device does not save the automatically-generated visual content to the first application. In some embodiments, the automatically-generated visual media application is described in greater detail in methods 700 and 800. Automatically saving the automatically-generated visual content to a gallery in the automatically-generated visual media application reduces the number of inputs needed to add the automatically-generated visual content to the automatically-generated visual media application (e.g., navigating away from the first application) after generating the automatically-generated visual content, therefore reducing the erroneous inputs to the electronic device.

It should be understood that the particular order in which the operations in FIG. 12 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1400, 1500, 1700, 1900, 2100, 2300, and/or 2700) are also applicable in an analogous manner to method 1200 described above with respect to FIG. 12. For example, the operation of the presentation of an automatically-generated visual media creation user interface to use a non-automatically-generated visual media as the reference media item described above with reference to method 1200 optionally has one or more of the characteristics of, displaying a representation of a prompt and one or more recognized concepts, editing one or more parameters, including one or more recognized concepts, of a previously generated automatically-generated visual content, the addition of a representation of automatically-generated visual content into a first application, displaying portion(s) of a user interface with HDR luminance, displaying one or more portions of the user interface with luminance that is within or greater than a SDR luminance, generating multiple variations of representations of automatically-generated visual content, restricting prompt components to be used to generate automatically-generated visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., methods 700, 800, 1000, 1400, 1500, 1700, 1900, 2100, 2300, and/or 2700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 12 are, optionally, implemented by components depicted in FIGS. 1A-1B. For example, displaying operation 1202a and 1202c, and receiving operation 1202b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

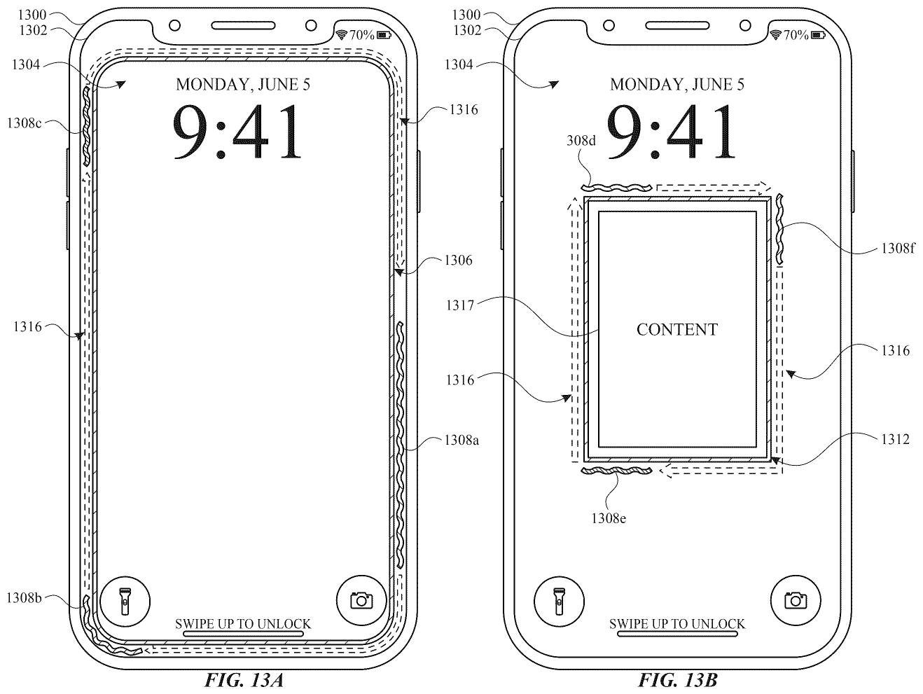

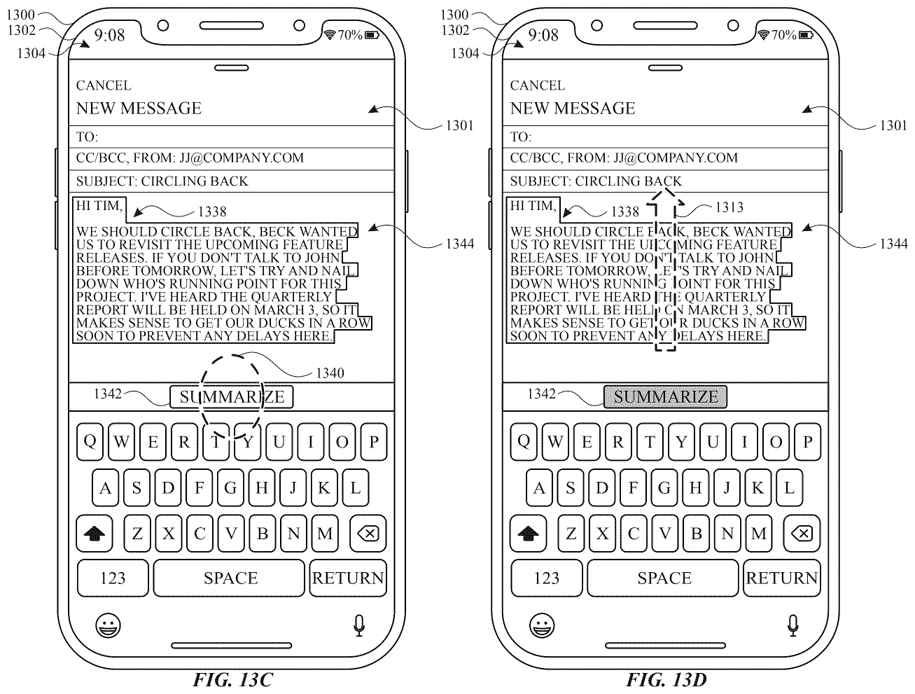

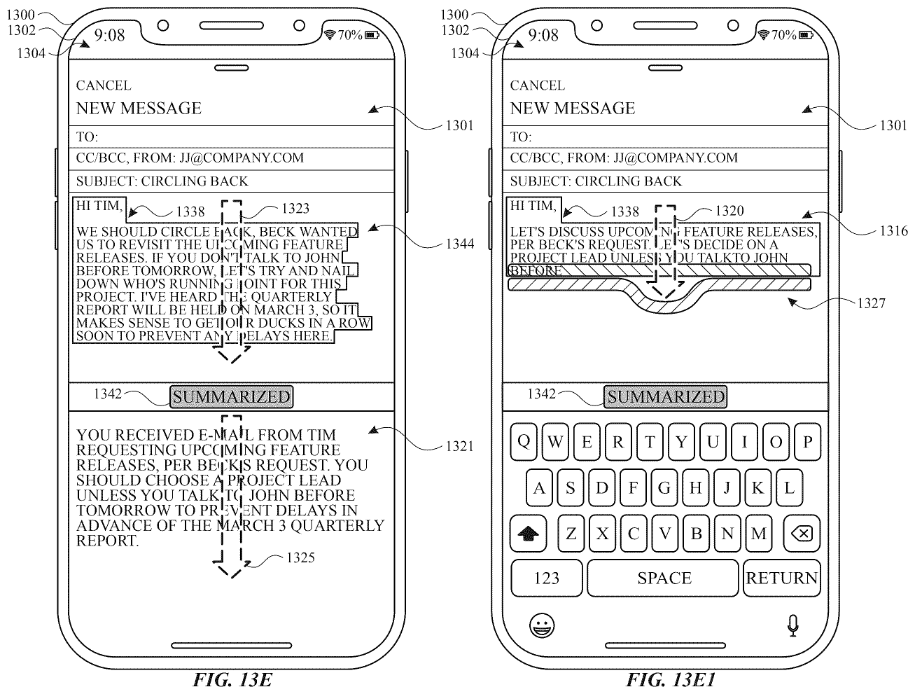

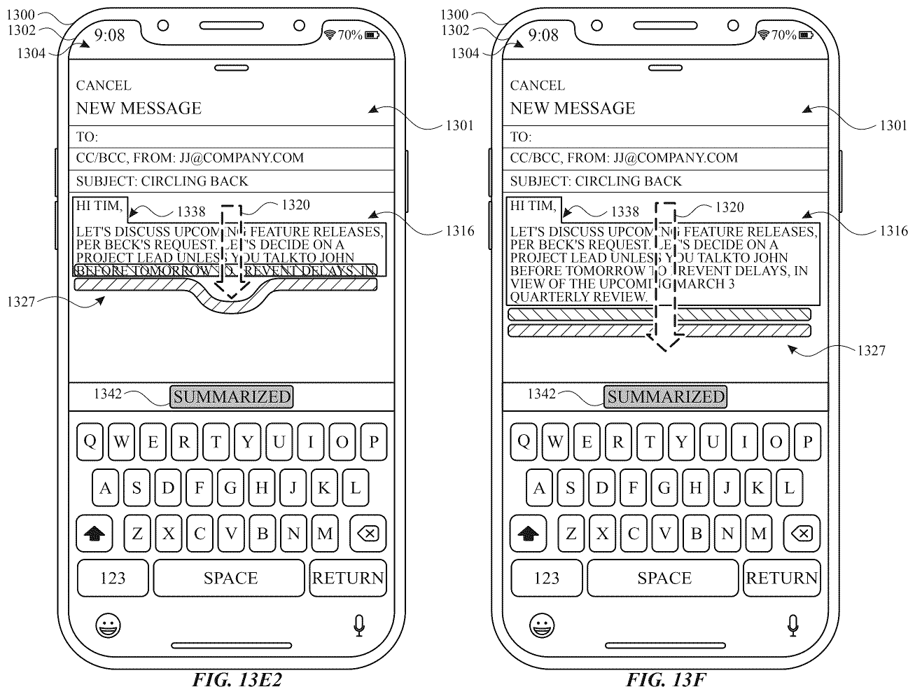

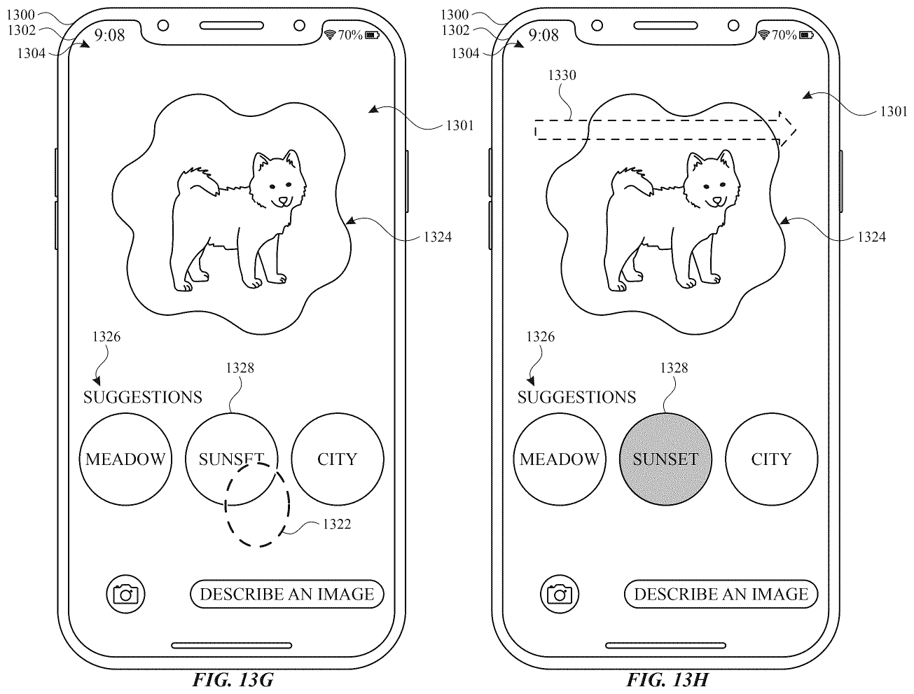

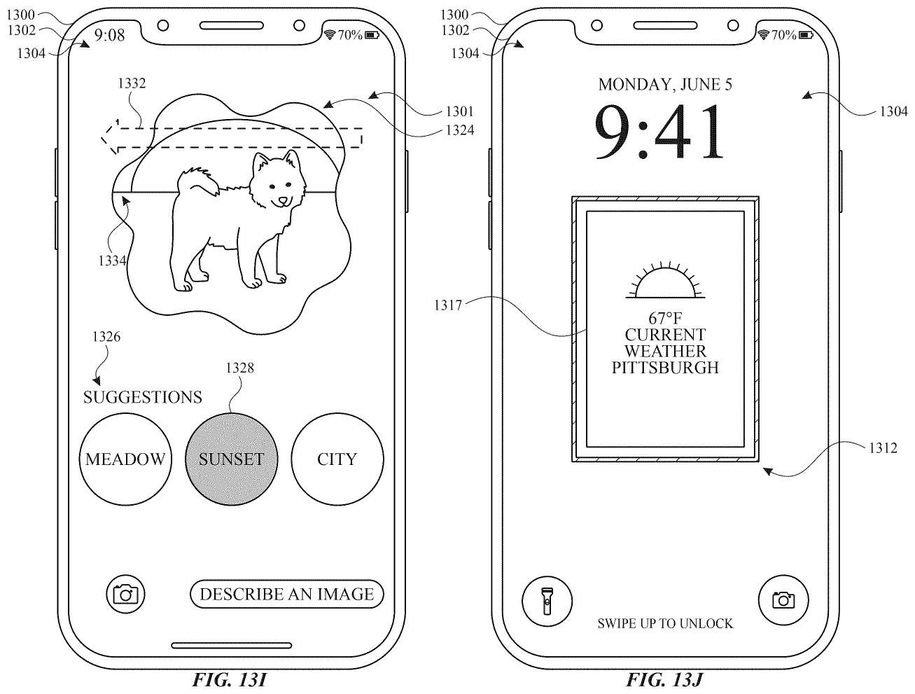

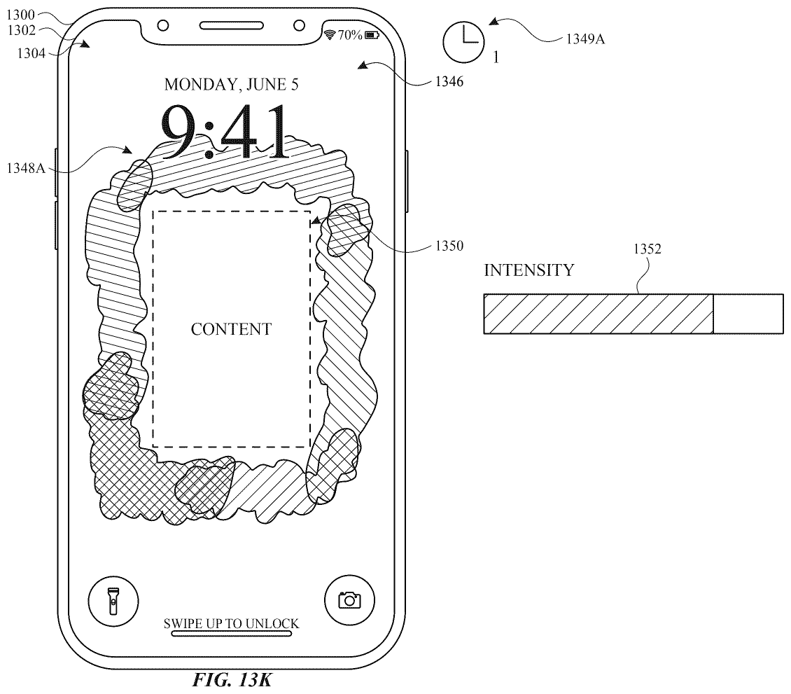

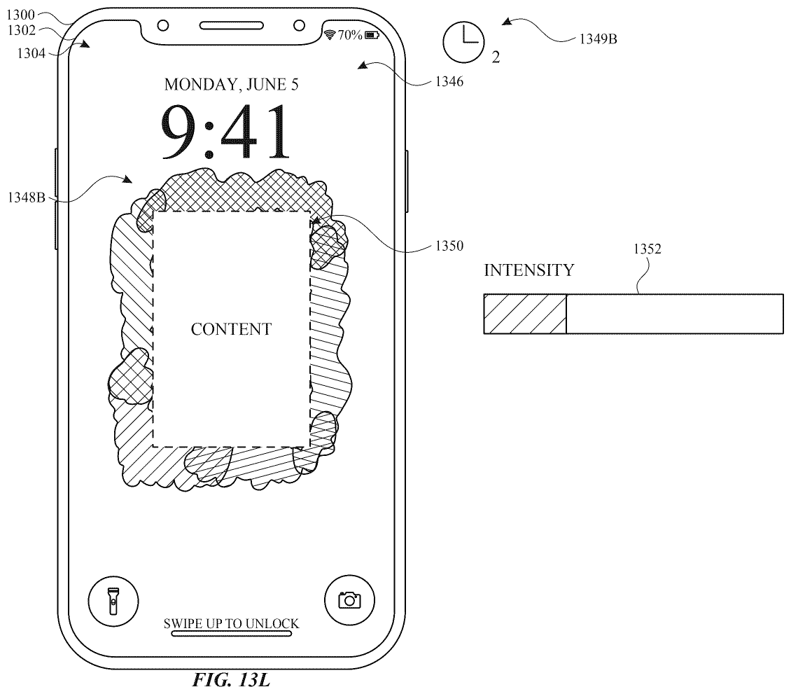

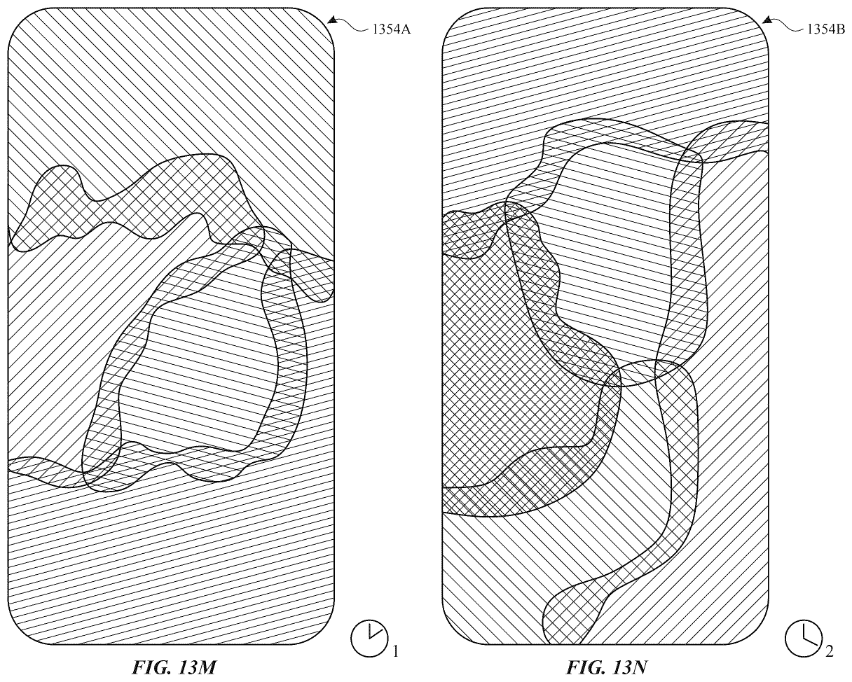

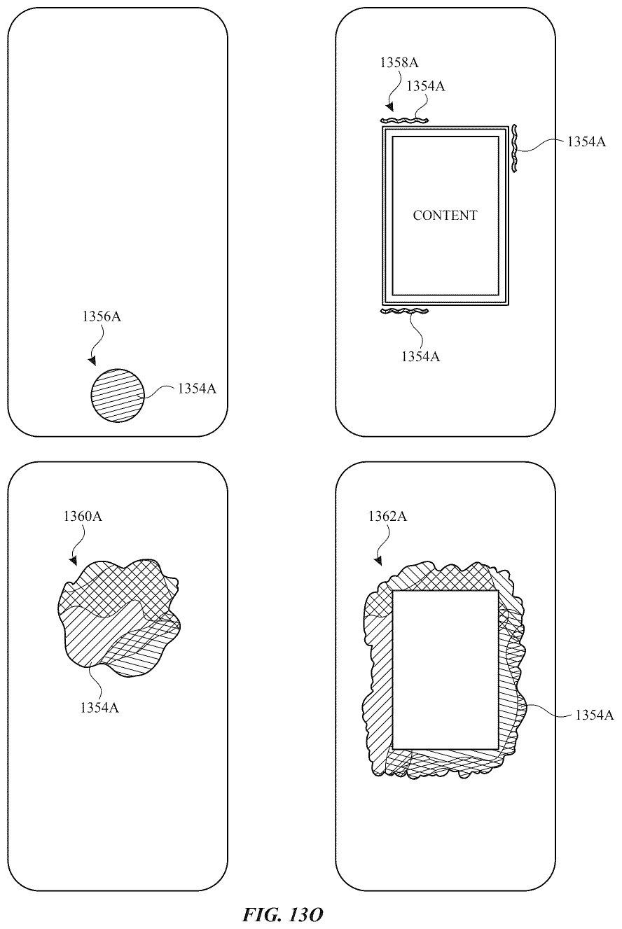

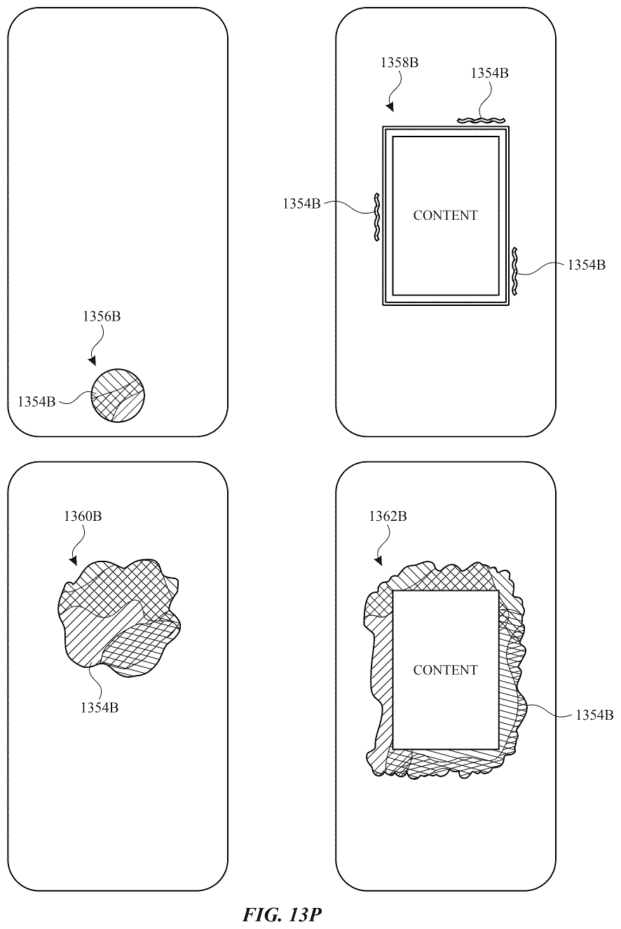

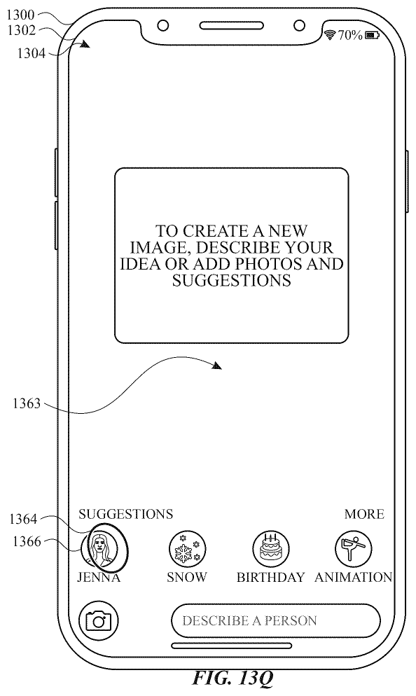

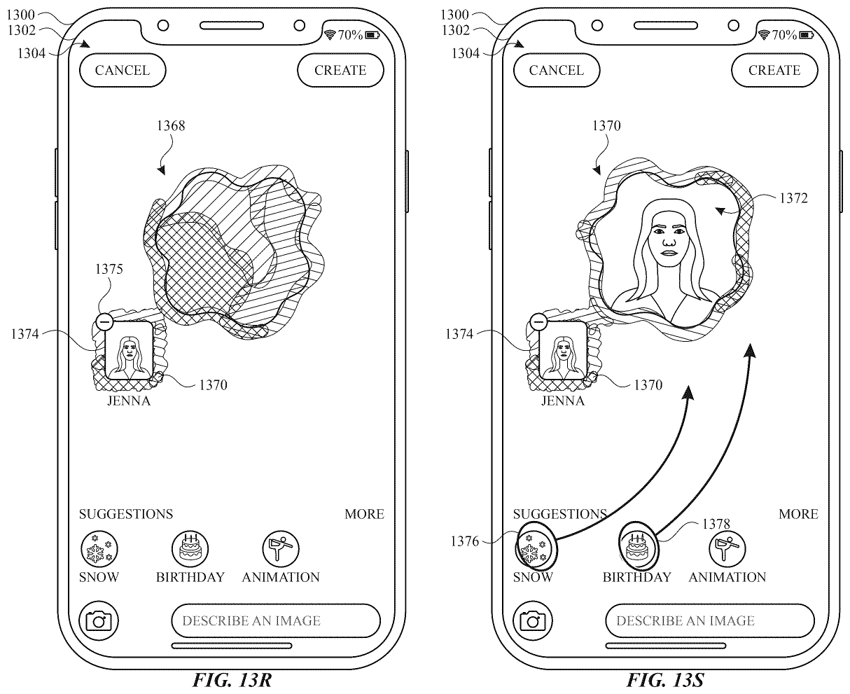

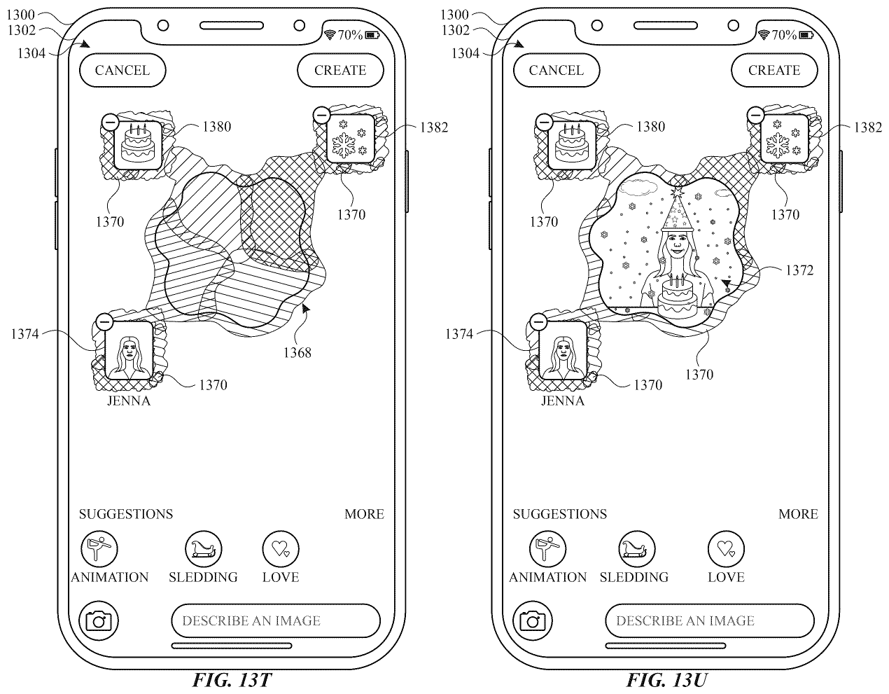

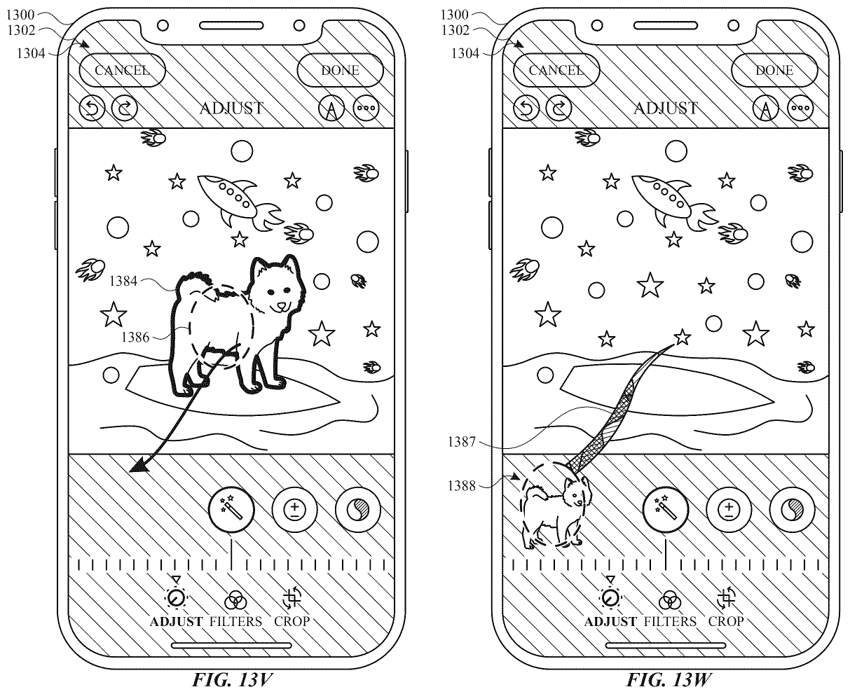

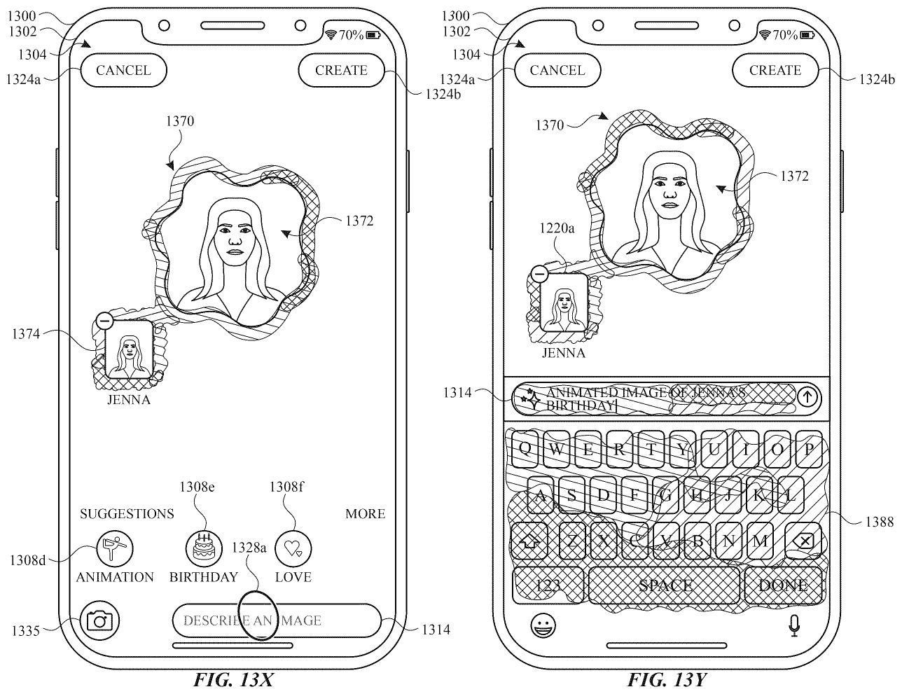

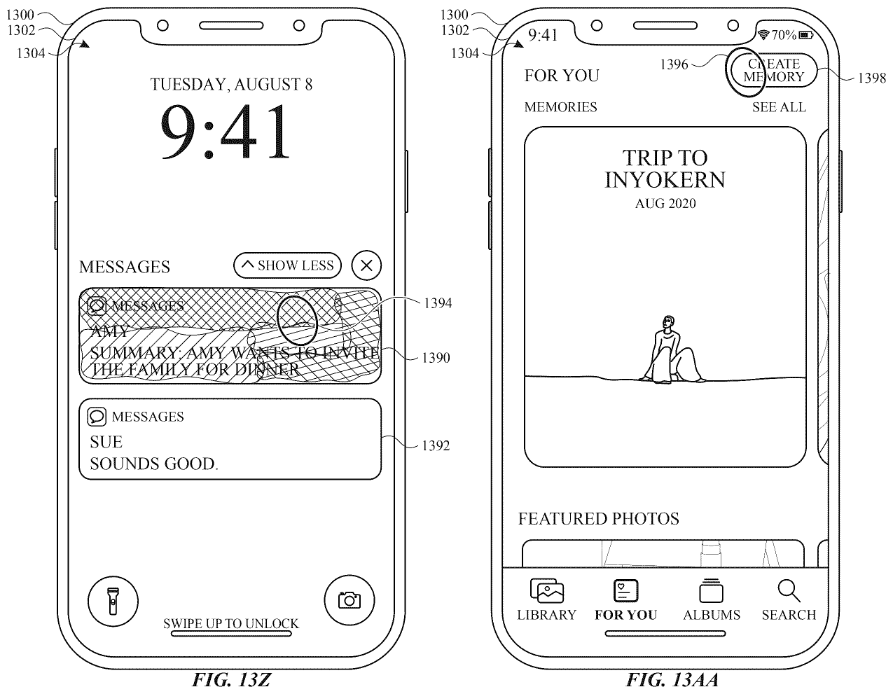

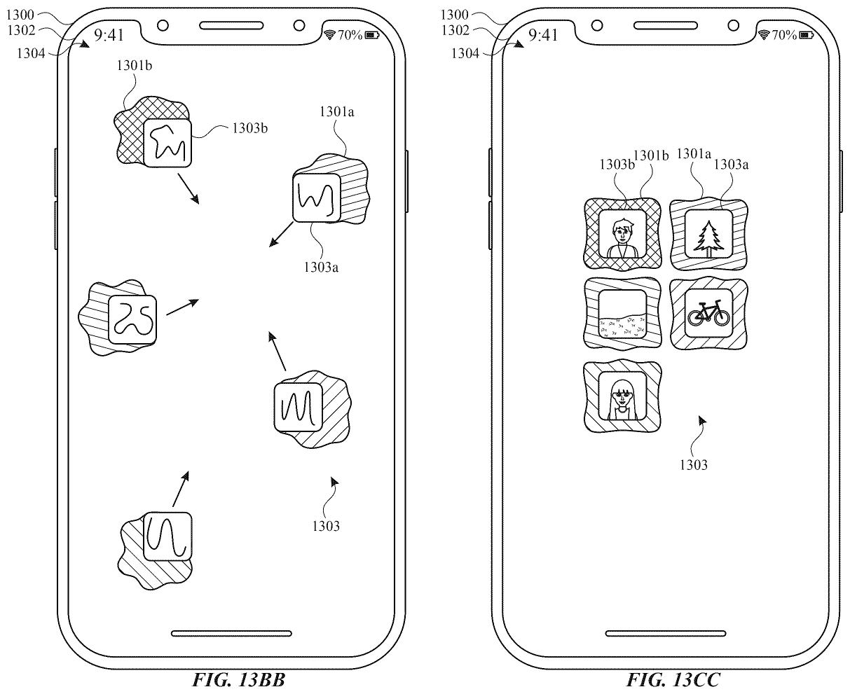

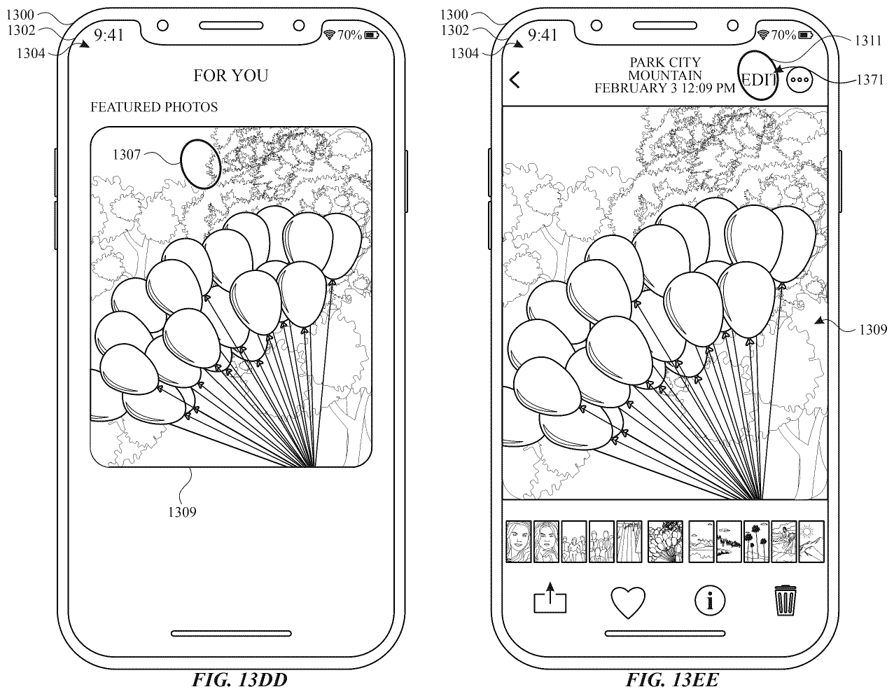

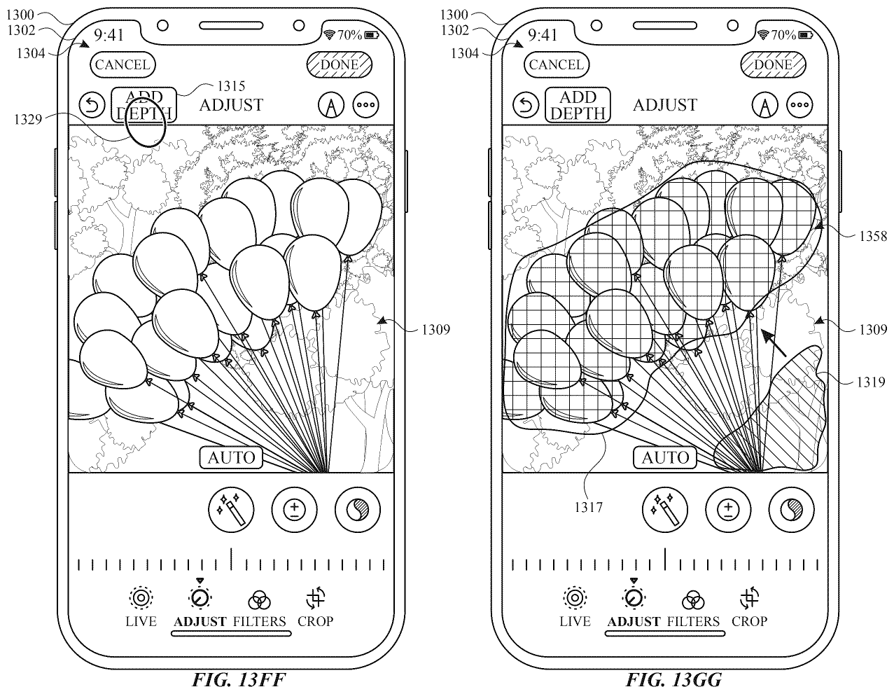

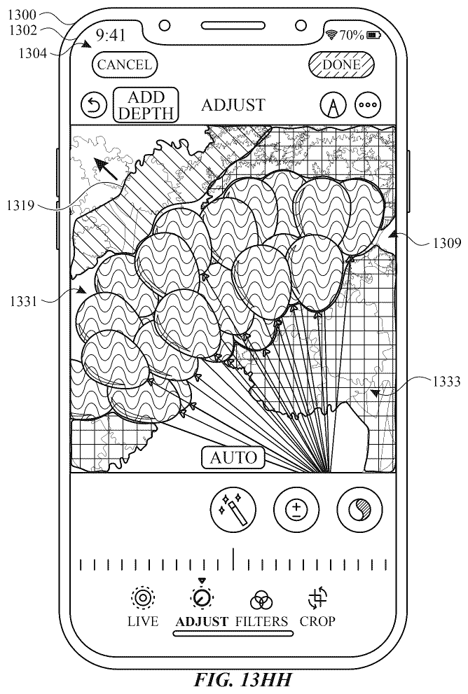

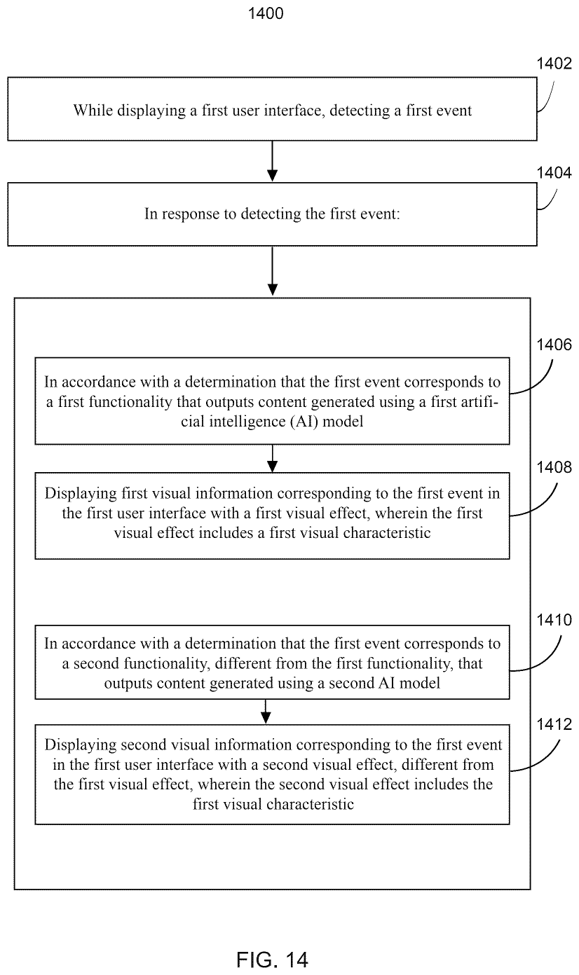

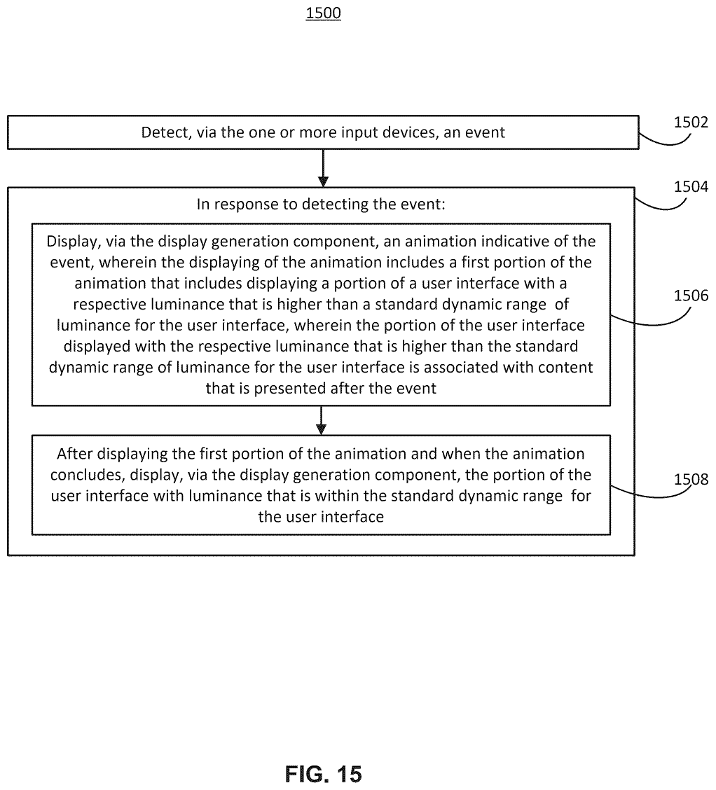

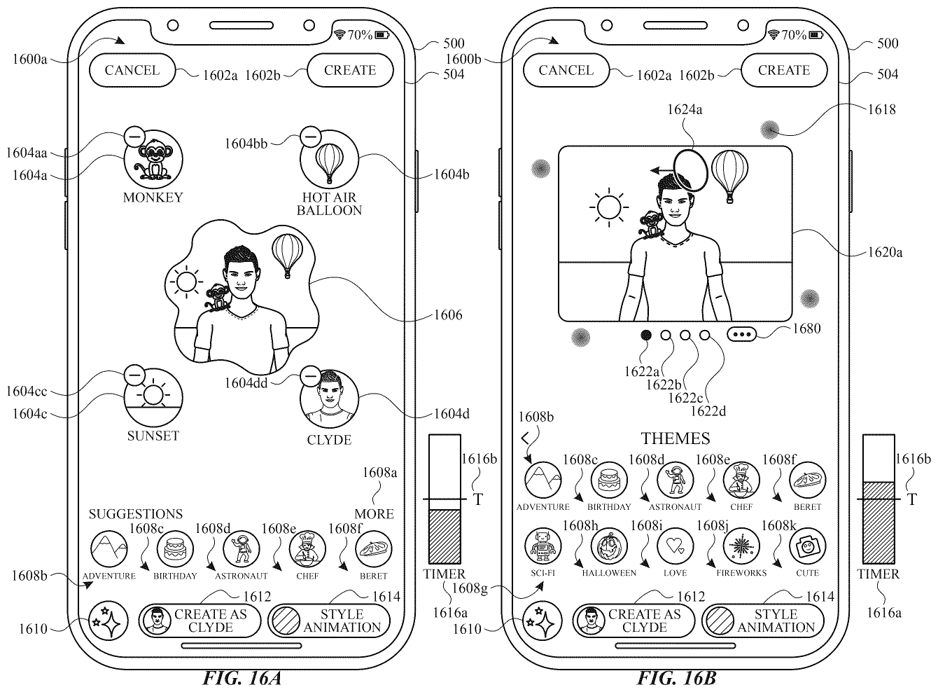

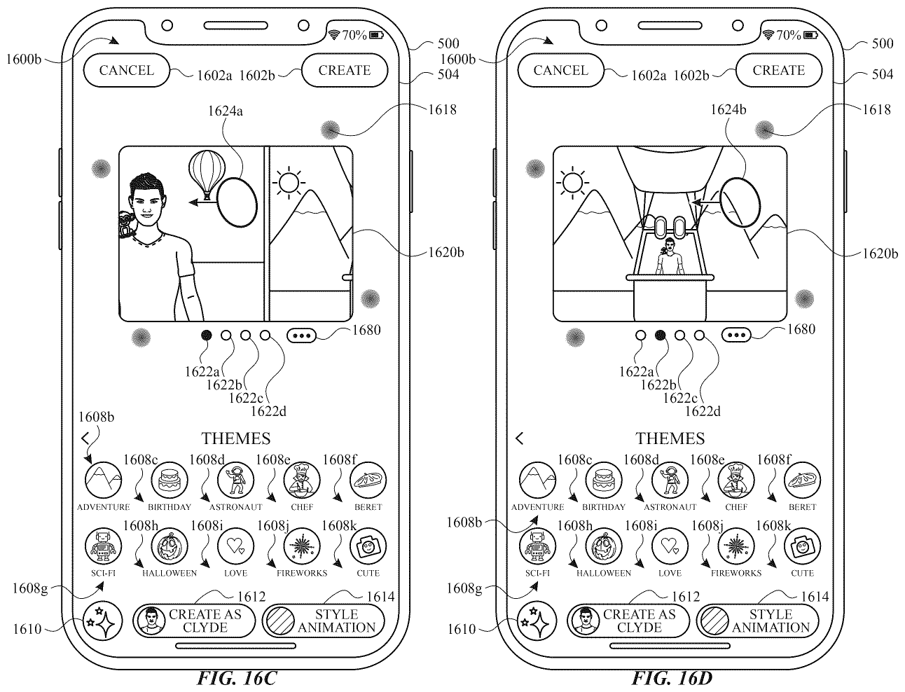

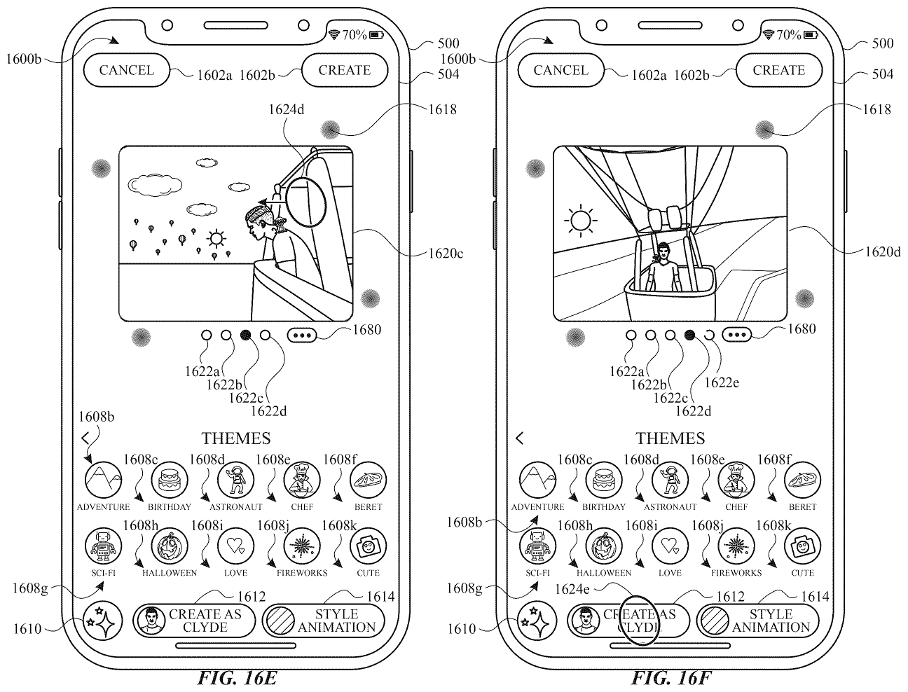

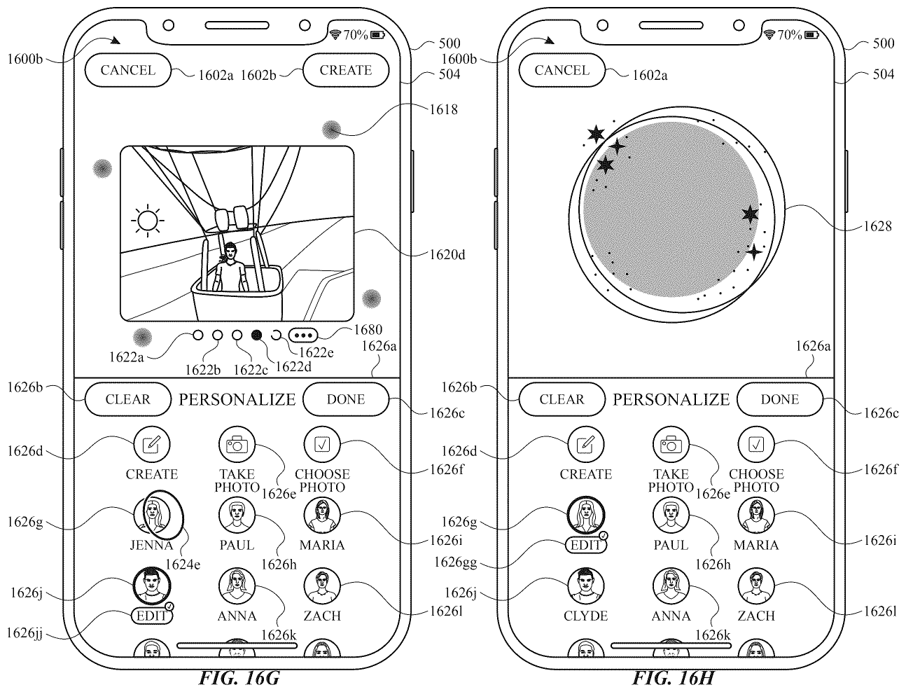

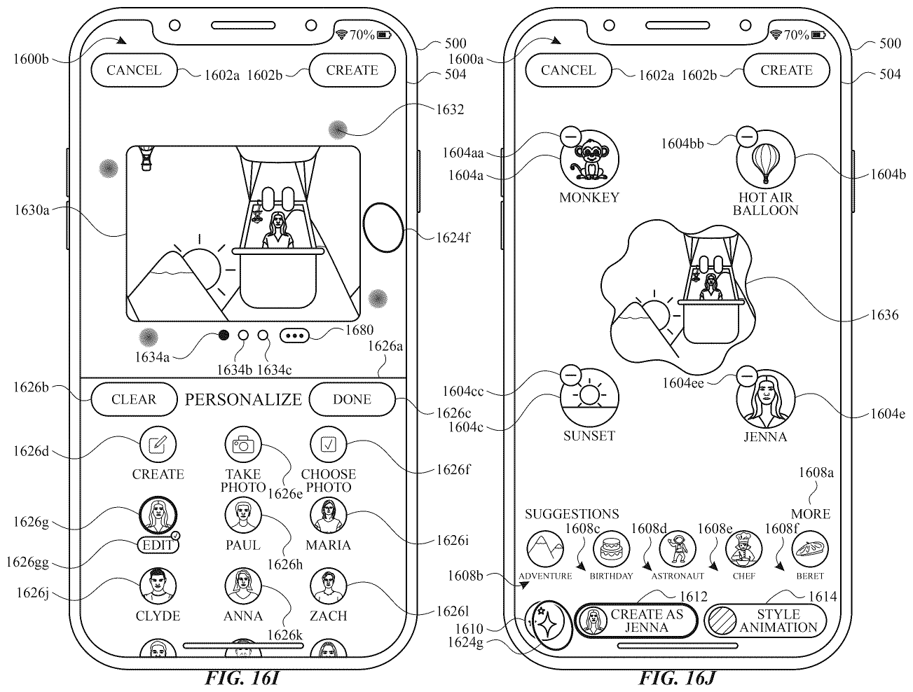

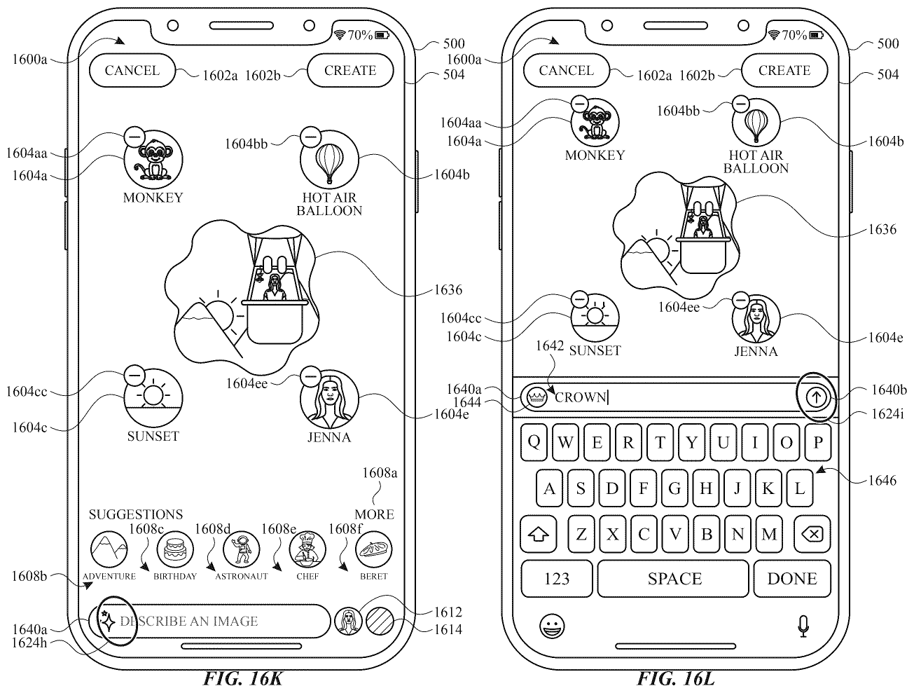

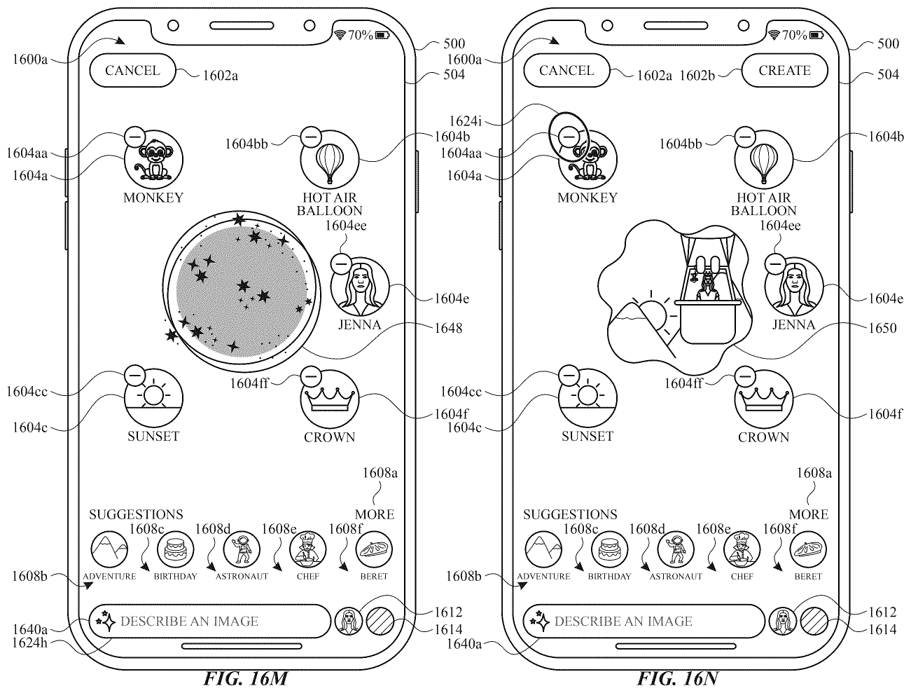

FIGS. 13A-13HH illustrate exemplary ways in which an electronic device displays content and user interface associated with content items. The embodiments in these figures are used to illustrate the processes described below, including the processes described with reference to FIG. 14 and FIG. 15. Although Figs. FIGS. 13A-13HH illustrate various examples of ways an electronic device is able to perform the processes described below with respect to FIG. 14 and FIG. 15, it should be understood that these examples are not meant to be limiting, and the electronic device is able to perform one or more processes described below with reference to FIG. 14 and FIG. 15 in ways not expressly described with reference to Figs. FIGS. 13A-13HH. FIGS. 13A-13HH illustrate exemplary ways in which an electronic device displays visual effects and/or visual characteristics to indicate and/or notify a user that one or more functionalities which output content used one or more artificial intelligence (AI) processes (e.g., based on one or more AI models) to generate the content. In some embodiments one or more AI processes (e.g., that are based on AI models) and/or one or more AI models described with reference to FIGS. 13A-13HH, and/or described with reference to methods 1400 and/or 1500 have one or more characteristics that are similar to, or the same as, one or more characteristics of one or more processes and/or one or more AI models described with reference to methods 700, 800, 1000, 1200, 1700, 1900, 2100, and/or 2300. The visual effects as illustrated herein are optionally linked to the use of one or more functionalities (e.g., first functionality, second functionality, third functionality, and/or fourth functionality). Accordingly, by using a visual effect which corresponds to one or more AI-based functionalities, the electronic device indicates to the user the generated output content was generated using an AI process. In some embodiments, each visual effect which indicates the use of AI generative functionalities shares a common visual characteristic with the other visual effects. Accordingly, by using a common visual characteristic across the visual effects, the electronic device indicates that each of the visual effects corresponding to the use of the one or more functionalities is using an AI generative process for the generation of content corresponding to the visual information.

FIG. 13A illustrates a user interface 1304 indicating that the electronic device 1300 is using one or more functionalities that output content using a generative AI process (e.g., based on a AI model) in response to the electronic device receiving input from the user. In some embodiments, FIG. 13A represents the electronic device performing a generative operation using the one or more functionalities which generate content using one or more AI processes (e.g., one or more AI models), prior to displaying the visual content (e.g., as seen in FIG. 13B). For instance, in some embodiments, the visual effect illustrated in FIG. 13A corresponds to the electronic device 1300 receiving user input corresponding to an indication to generate visual information using one or more functionalities which use one or more AI processes (e.g., based on one or more AI models) with a voice assistant functionality, and the user input includes verbal input from the user. When the electronic device receives the user input invoking the voice assistant (e.g., while processing the user input, and/or while generating the visual information), the electronic device displays the visual effect 1308a-1308c as shown in FIG. 13A, and when the electronic device displays the generated visual information 1317, the electronic device displays the visual information 1317 with the visual effect 1308d-1308f.

As shown in FIG. 13A, the visual effect 1308 (e.g., 1308a-1308c) provides visual confirmation that the electronic device is generating visual content using one or more of the functionalities. As shown in the example of FIG. 13A, visual effect 1308a-1308c includes a border surrounding at least a portion of a user interface element 1306. The visual effect 1308a-1308c optionally includes an animation 1316 such that the visual effect 1308a-1308c optionally rotates (e.g., clockwise, and/or counter-clockwise) around the user interface element 1306. In some embodiments, the visual effect 1308a-1308c optionally changes in location, length, width, color, and/or luminance over time. In some embodiments the visual effect 1308a-1308c includes a continuous border, optionally including a plurality of overlapping and/or intersecting border portions, which surround the entire user interface element 1306.

When the visual information is generated, the electronic device 1300 optionally displays the visual information with a visual effect which corresponds to and/or shares one or more characteristics with the visual effect which is displayed when the one or more functionalities are initiated. As illustrated in FIG. 13B, when the electronic device 1300 displays the visual information 1317 generated by the one or more functionalities, the electronic device optionally displays the visual information 1317, which was generated with one or more functionalities which use one or more AI processes (e.g., based on one or more AI models) to generate content, with a visual effect 1308d-1308f which shares one or more characteristics with visual effect 1308a-1308c shown in FIG. 13A. For instance, in accordance with displaying the generated visual information 1317, the electronic device 1300 optionally displays a visual effect 1308d-1308f which shares one or more characteristics with respect to visual effect 1308a-1308c as shown in FIG. 13A.

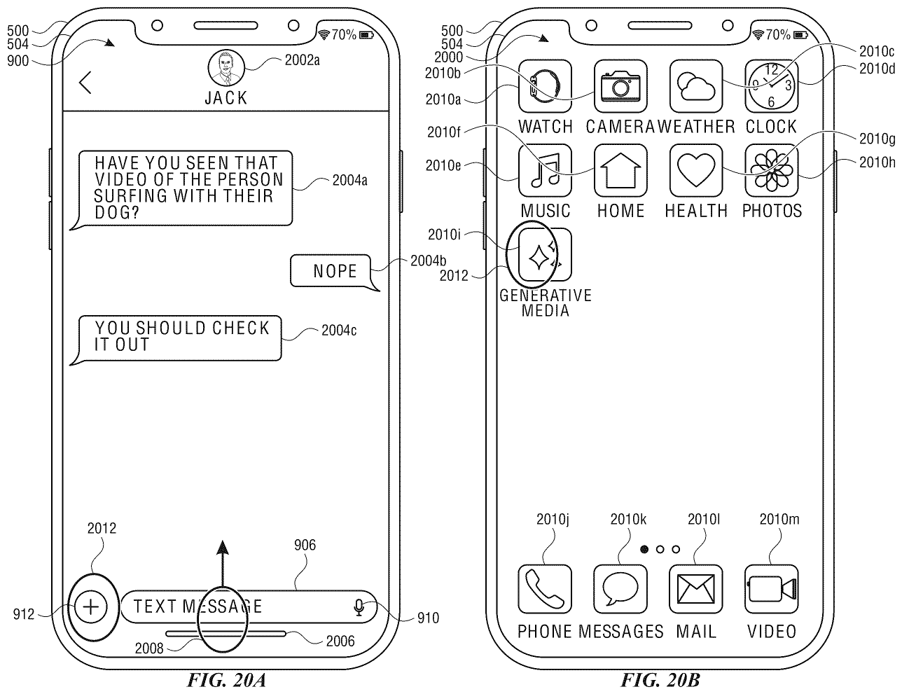

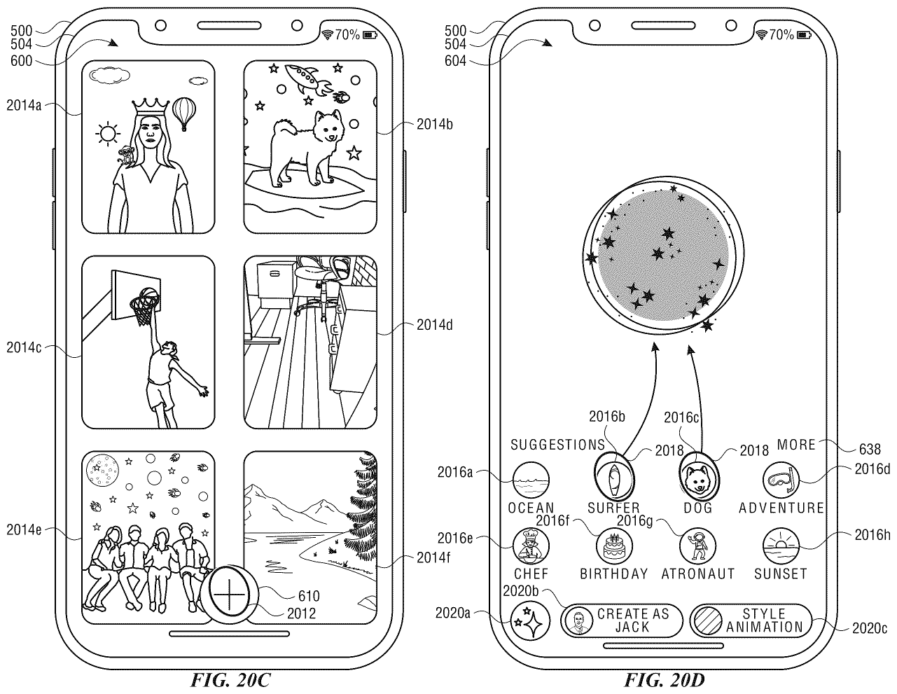

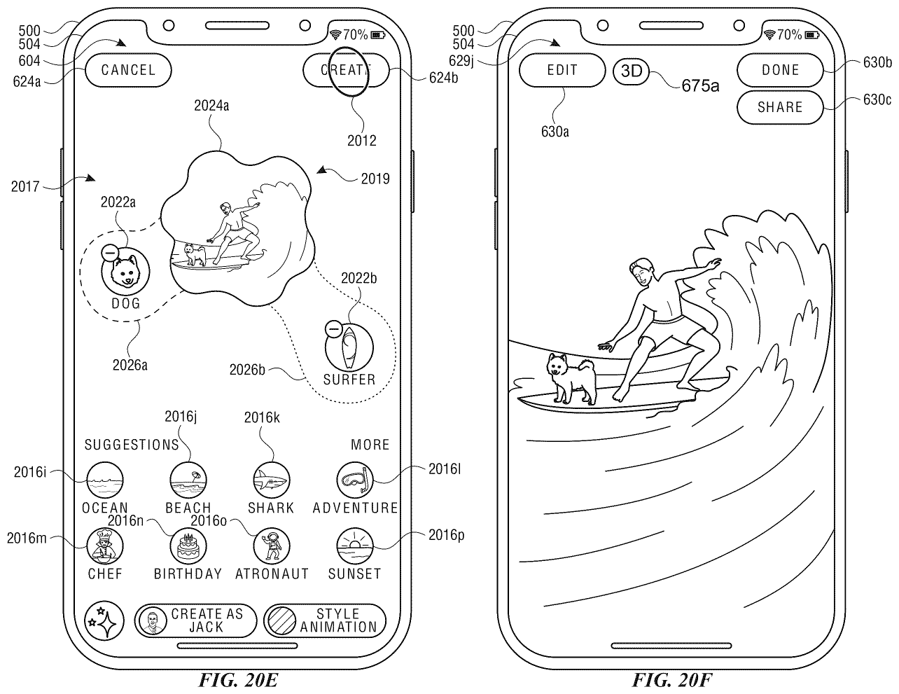

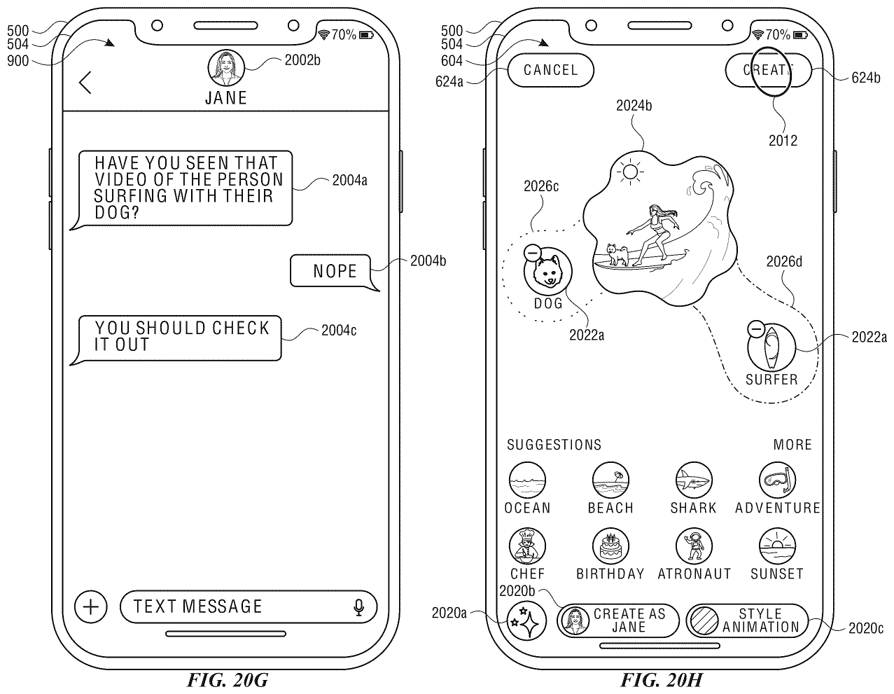

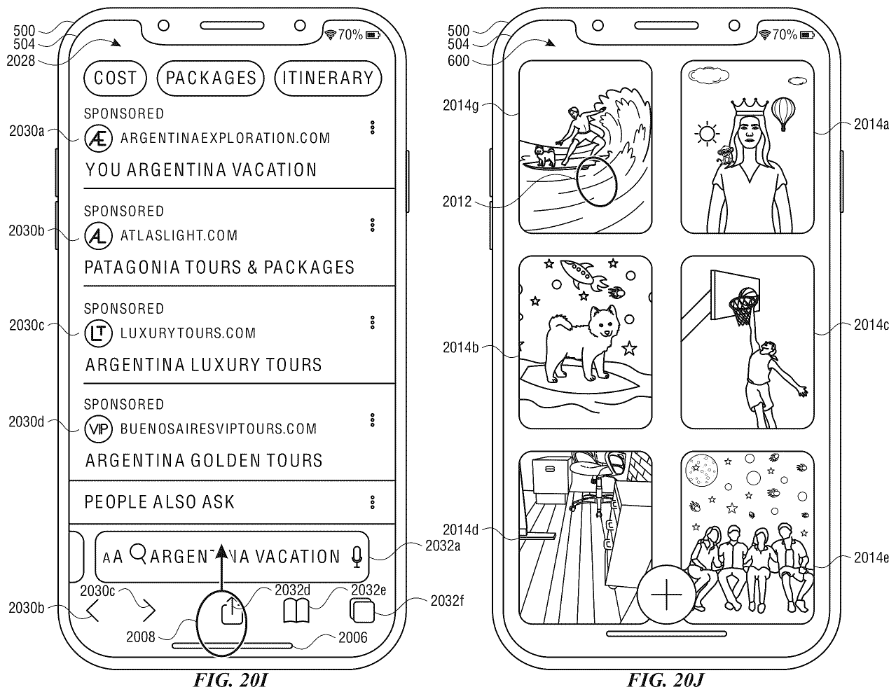

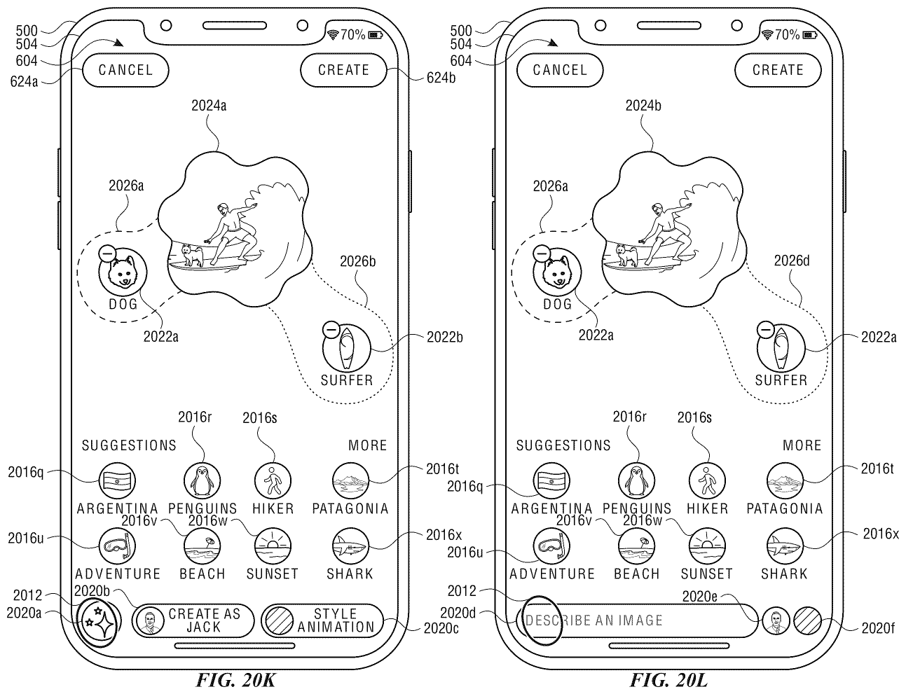

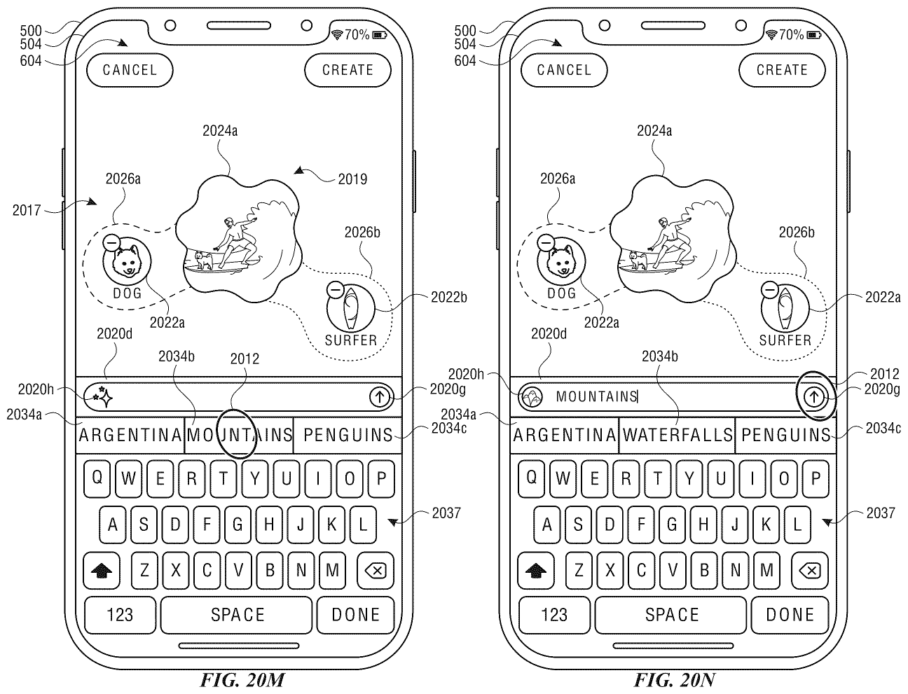

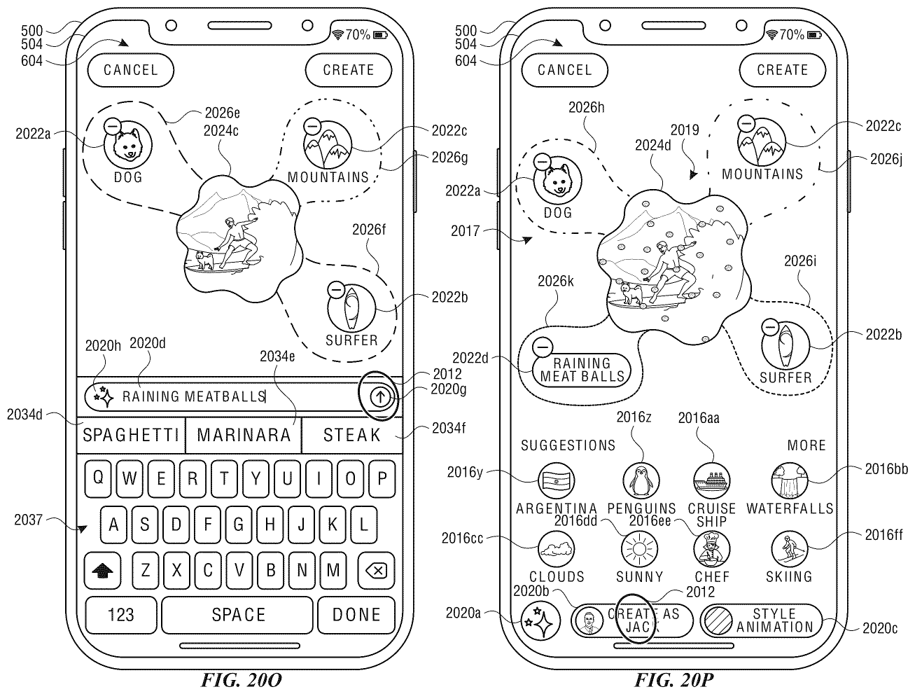

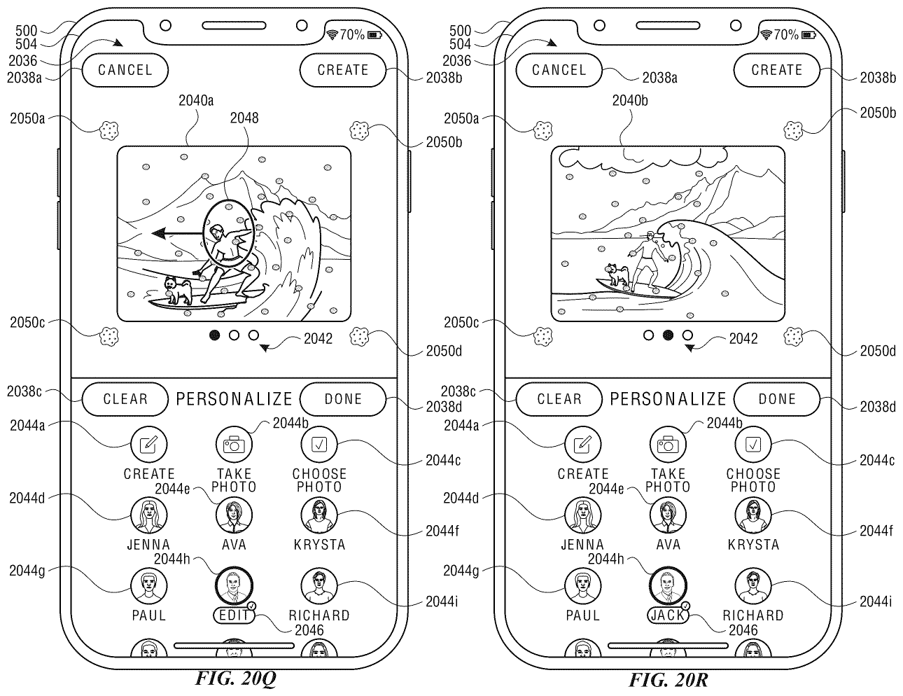

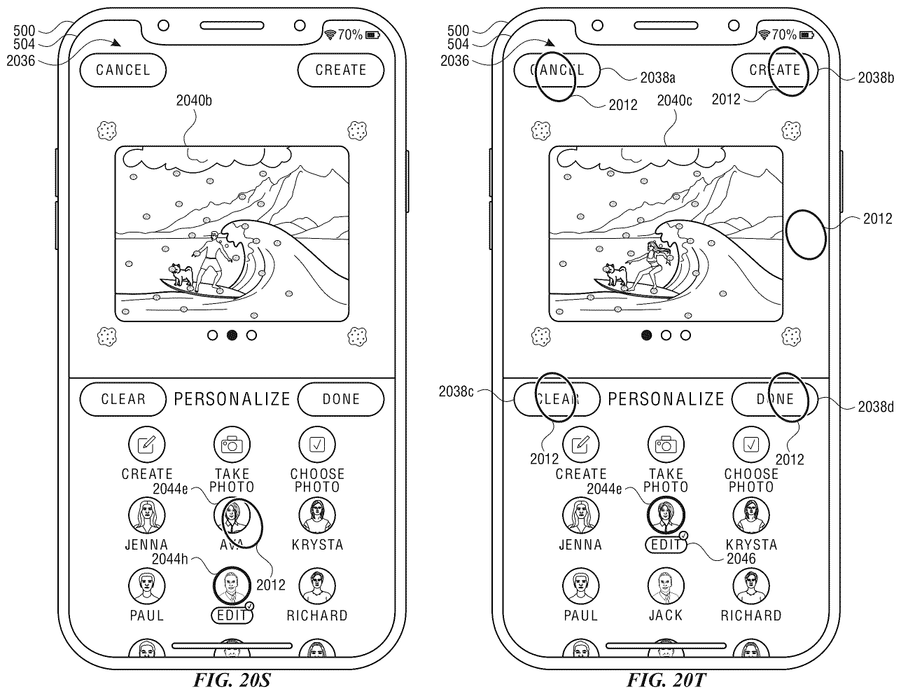

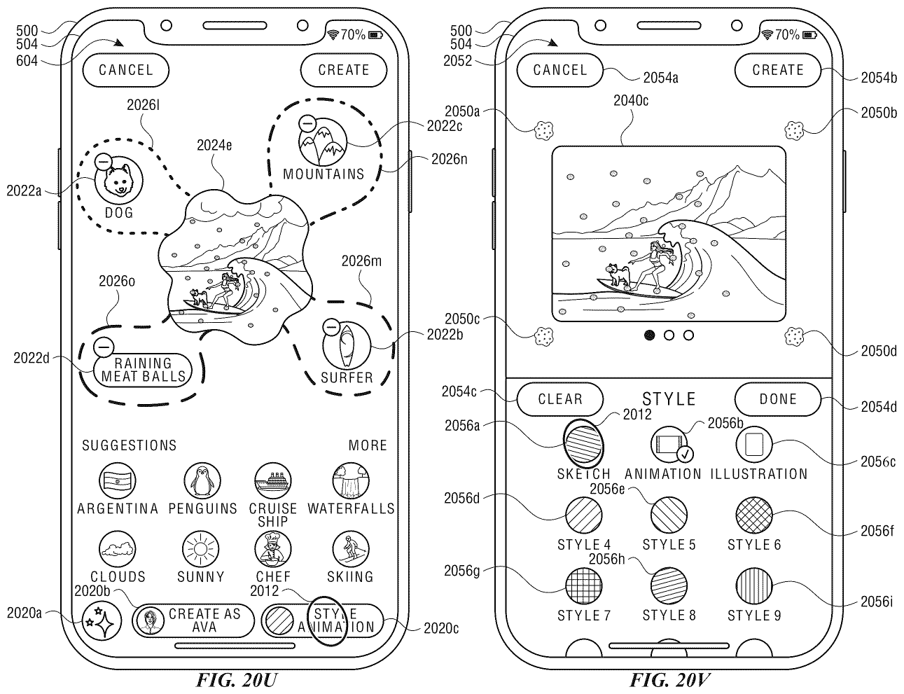

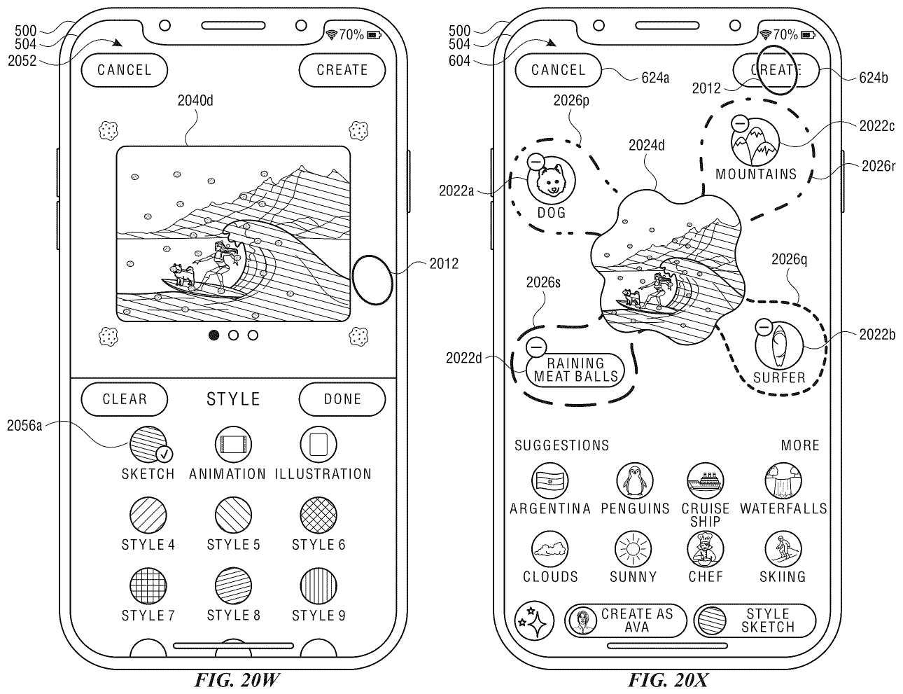

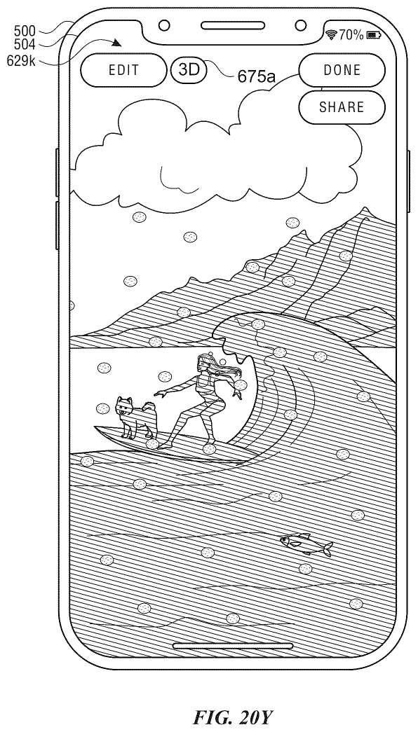

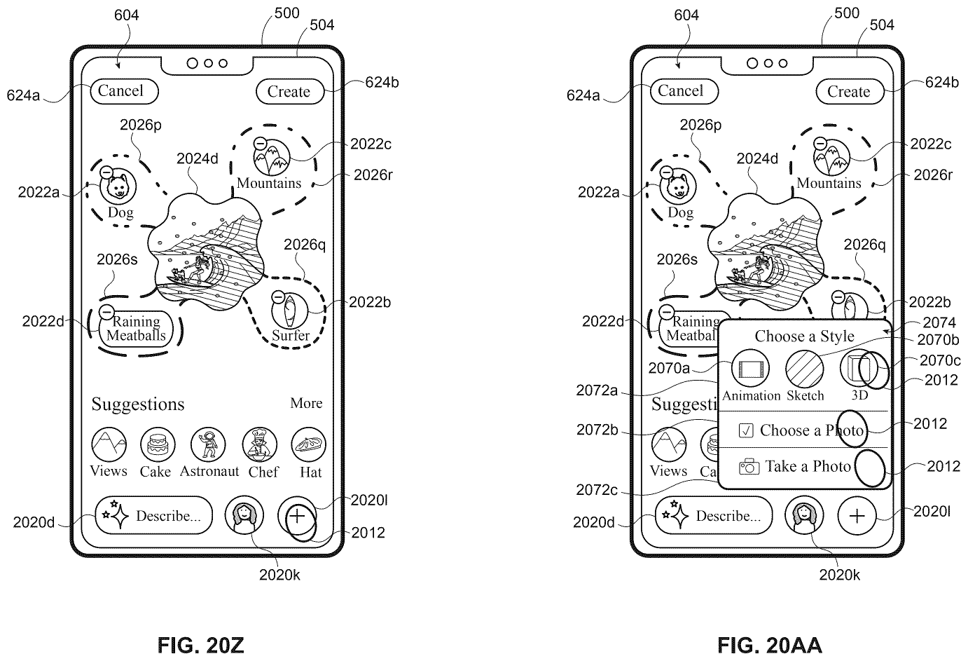

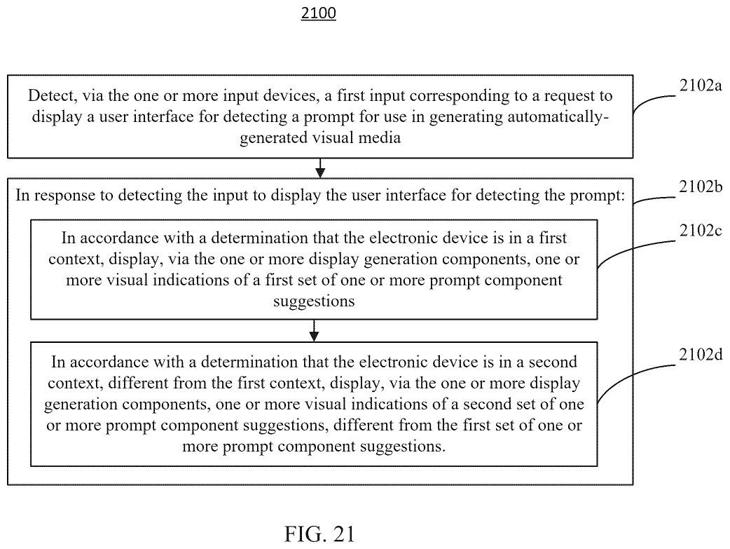

At times, embodiments herein describe visual information. Such visual information optionally includes different types of media, such as text, user captured images, video, system notifications, automatically-generated visual content (e.g., described with reference to methods 700, 800, 1000, 1200, 1400, 1500, 1700, 1900, 2100, 2300 and/or 2700) as described herein, and/or portions of a user interface underlaying and/or at least partially surrounding the media. It is further understood that certain user interface elements described with reference to methods 700, 800, 1000, 1200, 1400, 1500, 1700, 1900, 2100, 2300 and/or 2700 optionally are displayed with visual effects and/or information described with reference to FIGS. 13A-13HH, such as applied to the representation 2024a in FIG. 20E.

FIGS. 13C-13F illustrate embodiments in which electronic device 1300 displays visual effects, information, and/or animations indicating that artificial intelligence model(s) are invoked. FIG. 13C illustrates initiation of display of an animation that indicates invocation of an AI process (e.g., based on one or more AI models) on a user interface. In FIG. 13C, electronic device 1300 displays user interface 1304 via display generation component 1302. It is understood that electronic device 1300 is optionally a mobile device, such as a smartphone, tablet, and/or a wearable device. User interface 1304 in FIG. 13C includes a user interface for an electronic mail (e-mail) application, including various fields for changing the recipient and content of the e-mail. As described with reference to methods 1400 and/or 1500, it is understood that user interface 1304 may include user interfaces for one or more of a media editing application, a media browsing application, a lock screen before user authentication is verified, a home screen, a text editing application, a camera application, and/or some combination of the aforementioned applications. FIGS. 13C-13F describe embodiments relating to display of SDR and/or HDR luminance (e.g., described further with reference to methods 1400 and/or 1500). It is understood that the region(s) of user interface 1304 that are described as being displayed with HDR luminance are optionally additionally or alternatively displayed with one or more of the other visual effects described herein with reference to methods 1400 and/or 1500.

In FIG. 13C, some or all of user interface 1304 is displayed with a standard dynamic range (SDR) luminance. As described with reference to method 1500, the luminance of some or all of user interface 1304 optionally falls within a first range of luminance (e.g., a default range of luminance). Displaying user interface 1304 with SDR luminance optionally additionally or alternatively includes displaying a first color gamut (e.g., color space) and/or first color gradient respectively including a first set of one or more colors, saturations, and/or functions defining the color gradient.

In FIG. 13C, user interface 1304 additionally includes a keyboard user interface element, which includes a plurality of representation of keys, which when selectable, cause electronic device 1300 to enter text 1338 into the e-mail portion of the user interface 1304. In some embodiments, the keyboard user interface includes and/or is displayed adjacent to (e.g., and/or concurrently with) one or more selectable options that are selectable to modify and/or analyze content displayed in the user interface. For example, FIG. 13C includes selectable option 1342, which is optionally selectable to initiate an analysis of content displayed in user interface 1304, and/or content that is not yet displayed (e.g., generated according to methods 700, 800 and/or 1000). In FIG. 13C, selection option 1342 includes text (e.g., “summarize”) indicating that the selection input 1340 when directed to selectable option 1342 is operative to initiate one or more operations to summarize text 1338 included in an email using one or more AI processes (e.g., based on one or more AI models) (e.g., generative AI models).

In FIG. 13D, electronic device 1300 displays an animation in response to detecting selection input 1342 in FIG. 13C. For example, animation indicator 1313 indicates a first portion of the animation that is displayed, traveling upwards relative to user interface 1304. In FIG. 13D, some or all of the region 1344 is displayed with one or more characteristics included in an animation and/or a visual effect described with reference to methods 1400 and/or 1500. For example, a portion of region 1344 is displayed with one or more colors and/or one or HDR luminance. As described with reference to method 1500, HDR luminance optionally includes the luminance of a some or all of user interface 1304, which optionally exceeds the SDR luminance used to display portions of user interface 1304 that are not being animated (e.g., outside of region 1344). Additionally or alternatively, in FIG. 13D, region 1344 is optionally displayed with a luminance, color, saturation, and/or point along a color gradient beyond a range of luminance, colors, saturations, and/or endpoint of a color gradient that is included in the user interface 1304. Thus, the first portion of the animation optionally includes displaying a first portion of user interface 1304 with a luminance and/or color that exceeds a SDR luminance and/or extends beyond a color gamut associated with displaying user interface 1304 with SDR luminance (e.g., HDR luminance). Additionally, in FIG. 13D, electronic device 1300 changes the visual appearance of selectable option 1342 to indicate that the animation has been initiated and/or is ongoing.

In some embodiments, while displaying the first portion of the animation, electronic device 1300 concurrently displays some portions of user interface 1304 with SDR luminance and/or with a standard color gamut. Accordingly, user interface 1304 is optionally displayed with a combination of HDR and SDR luminance while displaying the first portion of the animation, thus emphasizing the visual contrast between the portion of user interface 1304 displayed with HDR luminance, and other portions displayed with SDR luminance.

In FIG. 13E, electronic device 1300 displays a second portion of the animation, indicated by animation indicator 1323. In some embodiments, the second portion of the animation is displayed concurrently with, and/or rapidly after displaying the first portion of the animation, similar to as described with reference to the first portion of the animation, electronic device 1300 in FIG. 13D. In FIG. 13E, electronic device 1300 progresses the displayed animation, such as progressively changing the portion(s) of region 1344 displayed with the HDR luminance, a modified color, and/or another visual effect, mimicking the appearance that the portion(s) of region 1344 are moving downward relative to user interface 1304. As illustrated by the direction of animation indicators 1313 and 1323, the respective portion is optionally directional (e.g., traveling vertically). In some embodiments, respective portions of the user interface 1304 displayed with HDR luminance correspond to content that is currently displayed, such as moving across text and/or images included in user interface 1304 in FIG. 13E. In some embodiments, electronic device 1300 displays an animation indicated by animation indicator 1325 as shown in FIG. 13E. Animation indicator 1325 indicates the direction of progression of the animation described above, which optionally moves over the text 1321, which optionally corresponds to a summary of the text 1338.

FIG. 13E1-FIG. 13F illustrate exemplary manners in which electronic device 1300 progresses the animation described with reference to FIG. 13D and/or FIG. 13E. For example, in FIG. 13E1, electronic device 1300 initiates display of the animation applied to text 1338 in the region 1316 and/or region 1327 in response to detecting input 1340 as shown in FIG. 13C. As indicated by animation indicator 1320, electronic device 1300 optionally progressively displays regions of the user interface 1304 with the HDR luminance and/or visual effects described herein. In FIG. 13E1, electronic device 1300 displays region 1327 with the HDR luminance (e.g., after having previously displayed region 1316 with the HDR luminance). Gradually, electronic device 1300 displays the text 1338, updated to include a summary of the text included in the user's original draft e-mail (e.g., as shown in FIG. 13C). From FIG. 13E1 to FIG. 13E2, electronic device 1300 moves the region 1327 downward relative to user interface 1304, additionally displaying text that is generated (e.g., using the one or more machine learning models and/or artificial intelligence models described with reference to method s 700, 800, 1000, 1200, 1400, 1500, 1700, 1900, 2100, and/or 2300). In FIG. 13E2, region 1316 includes portions of user interface 1304 that were displayed with the HDR luminance in FIG. 13E1. From FIG. 13E2 to FIG. 13F, electronic device 1300 moves the region 1327 of user interface 1304 that is displayed with the HDR luminance, extending beyond the region 1316 that includes text 1338 summarizing the original draft e-mail (e.g., text 1338 in FIG. 13C).

FIGS. 13G-13I illustrate embodiments of electronic device 1300 generating portions of visual media, and displaying one or more visual effects indicating performance of the generating operations which invoke an AI process (e.g., based on an AI model) to generate the visual media. In FIG. 13G, electronic device 1300 displays representation 1324, corresponding to a visual content that electronic device 1300 generated using one or more machine learning models and/or candidates described with reference to methods 2100 and/or 2300. In some embodiments, representation 1324 has one or more characteristics that are similar to or the same as one or more characteristics of previews of automatically-generated virtual content, as described with reference to methods 700, 800, 1000, 1200, 1400, 1500, 1700, 1900, 2100, 2300 and/or 2700. In some embodiments, the user interface 1304 illustrated in FIGS. 13G-13I include one or more characteristics that are similar to or the same as one or more characteristics of the user interfaces described with reference to methods 700, 800, 1000, 1200, 1400, 1500, 1700, 1900, 2100, 2300 and/or 2700). Electronic device 1300 in FIG. 13G displays a plurality of suggestions 1326 corresponding to candidates to modify the representation 1324, such as selectable option 1328 (e.g., “sunset”). In FIG. 13G, electronic device 1300 detects input 1322 directed to selectable option 1328, and in response, initiates display of a visual effect and/or animation as illustrated in FIG. 13H. In some embodiments, the visual effect and/or animation overlays and/or surrounds where the visual content will be generated in user interface 1304, and/or overlays and/or surrounds visual content that is recently generated (e.g., within a threshold amount of time of a current moment during the animation (e.g., 0.1, 0.25, 0.5, 0.1, 0.25, 0.5, 0.75, 1, 1.25, 1.5, or 3 seconds)). In FIG. 13H, electronic device 1300 displays the animation including display of HDR luminance and/or other visual effects moving in a lateral direction relative to user interface 1304, as indicated by animation indicator 1330 moving rightward. In some embodiments, electronic device 1300 displays a portion of the generated content (e.g., the sunset) in the “wake” of where the visual effect is located over the course of the animation, and/or at portions of user interface 1304 where the visual effect is displayed. In FIG. 13H, electronic device 1300 modifies the visual appearance of the selectable option 1328 to indicate a selection state, in particular, that selectable option 1328 was selected. From FIG. 13H to FIG. 13I, electronic device 1300 displays the visual element 1334 (e.g., a setting sun) using one or more generative artificial intelligence models, moving the portions of the user interface 1304 displayed with the visual effect and/or HDR luminance in a second direction relative to user interface 1304 as indicated by animation indicator 1332.

When the one or more functionalities which use an AI process (e.g., based on an AI model) to generate content in order to generate visual information are invoked, and the user provided input does not require the AI generative model to generate the visual information, the electronic device 1300 displays the resulting visual information without any visual effect(s) which correspond to the use of the one or more AI processes (e.g., based on one or more AI models). For instance, as illustrated in FIG. 13J, the electronic device 1300 has received user input requesting information pertaining to the current weather in Pittsburgh, Pennsylvania. Accordingly, the electronic device 1300 returns visual information 1317 which is not based on AI generated content, and displays the resulting visual information via a user interface element 1312 with the current weather in Pittsburgh, without a visual effect associated with the display of visual information based on AI generated content (e.g., such shown in FIG. 13A-13B).

In some embodiments, when the electronic device 1300 displays the visual effect in conjunction with the invocation of the one or more functionalities, and/or in accordance with displaying the visual information generated by the one or more functionalities, the computer system displays the visual effect in a manner such that one or more characteristics of the visual effect vary over time. In some embodiments when one or more of the functionalities which output content generated using an AI process (e.g., based on an AI model) are invoked, the electronic device 1300 displays a visual effect 1348 (e.g., 1348A-1348B) such as shown in FIGS. 13K-13L for instance which includes a cloud-like halo 1348 (e.g., 1348a-1348b) around the displayed visual information 1350 (e.g., the generative content). When the visual information is initially displayed at a first time 1349A, as shown in FIG. 13K, the visual effect 1348A is shown in a first state corresponding to a first time 1349A, and over time, the visual effect optionally changes in pattern and/or diminishes with respect to one or more characteristics (e.g., color, intensity, and/or size). As shown, the intensity 1352 of the visual effect as shown in 13K at the first time, changes in size, and intensity between the first time and the second time as shown in FIG. 13L.

As shown in FIG. 13L, the second visual effect 1348B is illustrated in a second state corresponding to a second time 1349B, different than and later than the first time 1349A (e.g., at FIG. 13K). As shown in FIG. 13L, the second visual effect 1348B in the second state has an intensity 1352 which is lower, the second visual effect has a reduced size, and the patterns of the displayed colors have changed as compared to the second visual effect 1348A in the first state at the first time shown in FIG. 13K.

In some embodiments the visual effects which correspond to one or more functionalities are unique to the functionality, however the visual effects share a common visual characteristic to indicate to the user that one or more functionalities which generate content using one or more AI processes (e.g., based on one or more AI models) have been invoked and/or have been used to generate the displayed visual information. FIG. 13M-FIG. 13N illustrate a layer 1354 (e.g., 1354A-1354B) which provides an exemplary common visual characteristic which is used by a plurality of such AI-related visual effects. As shown, FIG. 13M corresponds to the state (e.g., color(s), spatial pattern, and/or overlapping portions) of the layer 1354A at a first time, and FIG. 13N corresponds to the state of the layer 1354B at a second time, different than the first time. The layer includes multiple colorized portions which overlap, interact, and/or morph in accordance with an animation algorithm (e.g., random, pseudorandom, and/or formulaic). Between a first time (e.g., FIG. 13M) and a second time (e.g., FIG. 13N), the colors and/or portions of the layer spatially morph and/or are modulated. In some embodiments the layer exists behind elements (e.g., user interface) of the display generation component and are revealed by the display of the visual effects (e.g., 1308 as shown in FIG. 13A-13B). For instance, when the electronic device 1300 displays the visual effect, it optionally reduces the visual prominence (e.g., increases transparency) of a portion of the user interface corresponding to the location of the visual effect to enable increased visibility of the layer 1354.

FIG. 13O provides a representation of the reveal of the layer 1354A with respect to FIG. 13M when the visual effects are displayed. Each of the illustrated visual effects as shown in FIG. 13O reveal (e.g., through reduction of visual prominence of the corresponding portion of the user interface, and/or increase of transparency) a portion of the layer 1354. For instance, when the electronic device 1300 displays visual effect 1356A, the electronic device 1300 reduces the visual prominence of a circular portion of the user interface to reveal the layer 1354A as shown in FIG. 13M. In some embodiments, visual effect 1356A corresponds to when the electronic device receives user input invoking a voice assistant which uses one or more AI processes (e.g., based on one or more AI models) to generate visual information. When the electronic device 1300 displays visual effect 1358A, the electronic device 1300 reduces the visual prominence of border shaped portions, such as those described in relation to FIG. 13A-13B of the user interface to reveal the layer 1354A. In some embodiments, visual effect 1358A corresponds to when the electronic device receives user input invoking a voice assistant which uses one or more AI processes (e.g., based on one or more AI models) to generate visual information such as described in relation to FIG. 13A-13B. When the electronic device 1300 displays visual effect 1360A, the electronic device 1300 reduces the visual prominence of an amorphous region of the user interface to reveal the layer 1354A. In some embodiments, visual effect 1360A corresponds to when the electronic device receives user input corresponding to graphical input (e.g., such as described in relation to FIG. 13G-13I, FIG. 13R-13U, and/or FIGS. 13X-13Y), and the electronic device is processing user inputs, and/or generating visual information (e.g., prior to displaying visual information) which uses one or more AI processes (e.g., based on one or more AI models) to generate visual information. Additionally or alternatively, the electronic device optionally displays visual effect 1354A with the visual information (e.g., 1303a-1303b) obscuring the visual effect such as shown with respect to FIG. 13BB-13CC. When the electronic device 1300 displays visual effect 1362A, the electronic device 1300 reduces the visual prominence of an amorphous halo of the user interface around a user interface element to reveal the layer 1354A. In some embodiments, visual effect 1362A corresponds to when the electronic displays visual information which is generated using a functionality using one or more AI processes (e.g., based on one or more AI models) to generate visual information based on user input which is graphical in form, such as shown in relation to FIGS. 13R-13U, and/or 13X-13Y (e.g., while displaying visual information). FIG. 13P illustrates the visual effect revealing the layer 1354B as related to a second time, demonstrating that the revealed portion of the layer optionally changes with respect to time and/or that the content of layer 1354 at a given portion changes over time (e.g., from 1354A to 1354B).

When the user uses one or more functionalities that output content generated by one or more AI processes (e.g., based on one or more AI models), the electronic device 1300 provides a visual indication during the process of generating the content and/or when the visual information resulting from the generated content is displayed as illustrated in FIGS. 13Q-13U. FIG. 13Q-13U illustrate an exemplary process of generating visual information based on user input (e.g., selecting of elements, dragging of elements, written description, and/or verbal description) into an input field. FIG. 13Q illustrates the response of the electronic device 1300 following the user entering a generative mode wherein user inputs received by the electronic device 1300 are included in the input to the one or more functionalities to generate visual information such as an AI generated image in a generative area 1363. The user interface including the generative area 1363 as shown, shares one or more characteristics in relation to the user interfaces for generating generative visual content as described with respect to method 700, 800, 1000, 1200, 1500, 1700, 1900, 2100, and/or 2300. As shown, the electronic device 1300 detects the user has provided a selection input 1364 of a Jenna element 1366 corresponding to a representation of a person. Upon selection of the Jenna element 1366, the electronic device 1300 uses one or more functionalities (e.g., that invoke an AI process) to generate an image with the Jenna element.

Following the selection input 1364 (e.g., at FIG. 13Q), while the electronic device 1300 is generating the visual information and/or prior to displaying the visual information, the electronic device 1300 initiates the one or more functionalities and displays a visual effect 1368 within the generative area 1363 to indicate to the user that the generative operation has been initiated as shown in FIG. 13R. The visual effect as shown in FIG. 13R obscures an area of the generative area while the visual information has not been displayed. The visual effect 1368 is optionally animated, optionally uses one or more colors, and optionally reveals a portion of the layer 1354 as described in relation to FIG. 13M-13N. Furthermore, the electronic device 1300 displays a Jenna icon 1374 with visual effect 1370 surrounding it, indicating that the Jenna element is an input for the generation of the visual information. The visual effects, as applied to the Jenna icon 1347 and the visual information 1372 generated through the one or more functionalities which use one or more AI processes (e.g., based on one or more AI models), share one or more visual characteristics with each other. In the event that the electronic device 1300 receives an input (e.g., a touch input) at the minus symbol 1375 of an icon, the electronic device 1300 removes the corresponding element (e.g., the Jenna element) as an input for the one or more functionalities. The visual effect 1368 obscuring an area, and the visual effect 1370 surrounding the Jenna icon 1374, extend toward each other, intersect, and/or overlap to indicate that the Jenna element is included in the generative process using the one or more functionalities.

Upon displaying the generated visual information 1372 as shown in FIG. 13S, the electronic device 1300 displays a visual effect 1370 which surrounds the visual information 1372, and the Jenna icon 1374 is also displayed with the visual effect 1370 which surrounds it. In some embodiments, when the electronic device 1300 displays visual information, the visual information obscures one or more portions of a visual effect (e.g., visual effect 1368 at FIG. 13R), wherein the portions of the visual effect which are not obscured by the visual information are still visible to the user.

During the generative operation (e.g., prior to generating the visual information, while generating the visual information, and/or after displaying the visual information), when the electronic device 1300 receives a user input which corresponds to the addition and/or removal of elements, the electronic device 1300 regenerates visual information for display using the new and/or remaining elements. For instance, as shown in FIG. 13S, the electronic device 1300 receives user input (e.g., select and/or drag) corresponding to the addition of a snow element and a birthday element.

As shown in FIG. 13T, the addition of the birthday element is represented by a birthday icon 1380, and the snow element is represented by a snow icon 1382. The visual effect 1368 extends outward toward, and intersects with the visual effect 1370 displayed around each icon (e.g., Jenna icon 1374, birthday icon 1380, and/or snow icon 1382) corresponding to the elements included in the generative functionality operation that invokes an AI process. The one or more functionalities are generating (e.g., as evidenced by visual effect 1368) visual information for display which combine each of the selected elements.

Once the generation of the visual information is complete, the electronic device 1300 displays the visual information 1372 as shown in FIG. 13U with the visual information in a central location with the icons corresponding to the generative elements surrounding it. As shown, the visual information 1372 includes a generated image which combines the generative elements of the Jenna element, the snow element, and the birthday element which is displayed with the visual effect 1370 surrounding the visual information, and each of the icons. As shown, the visual effect displayed surrounding the visual information, and the visual effect displayed surrounding each of the icons, extend toward each other in a manner that the visual effect of the visual effect intersects the visual effect displayed around each of the icons.

In some embodiments, visual information includes one or more elements which are modular, moveable, and/or removeable from the visual information displayed following generation through the user of one or more functionalities which generate content using one or more AI processes (e.g., based on one or more AI models). For instance, in some embodiments the electronic device 1300 provides a visual indication, (e.g., with visual effect which optionally shares one or more characteristics with visual effects as described in relation to method 1400 and/or method 1500) that one or more portions of the visual information, generated using one or more functionalities which use one or more AI processes (e.g., based on one or more AI models), are removable. In some embodiments, the electronic device provides indication of what portions of an image are removeable when the electronic device receives a user input (e.g., touch selection of a selectable option corresponding to adjusting the image) corresponding to one or more image editing operations. For instance, FIG. 13V illustrates an image of a dog surfing in space with the dog standing atop a surfboard on water, with a background of space. For instance, following receiving user input corresponding with a request to identify removable aspects of visual information, generated using one or more functionalities which use one or more AI processes (e.g., based on one or more AI models), the electronic device indicates to the user that the dog is removeable from the image by displaying the dog with a visual effect. When the electronic device 1300 receives a user input 1386 directed to one or more elements, the electronic device 1300 highlights the element which has been selected. In the case of FIG. 13V, the electronic device 1300 detects the user input 1386 is directed to the dog, as such the electronic device 1300 highlights (e.g., makes bold, and/or displays a visual effect) the border 1384 of the dog indicating to the user that the dog has been selected. The user input 1386 as shown, includes a touch and drag to a lower left portion of the user interface 1304. When the user input 1386 drags the dog away from the position as shown in FIG. 13V to the position as shown in FIG. 13W, the electronic device 1300 provides an infill which is optionally generated by one or more functionalities which use one or more AI processes (e.g., based on one or more AI models), such that the infill matches the surrounding background of space. Furthermore, in accordance with the touch and drag user input 1386, the electronic device 1300 displays a trail 1387, which is optionally displayed with a visual effect with relation to the visual effects described herein.

FIGS. 13X-13HH illustrate embodiments of electronic device 1300 displaying one or more visual effects while various user interfaces are displayed. In FIG. 13X, electronic device 1300 displays user interface 1304 which is optionally similar to, or the same as described with reference to FIG. 13S (e.g., user interface 1304 is a user interface for automatically-generated visual content using one or more AI processes (e.g., based on one or more AI models)). User interface 1304 includes selectable option 1324a, which when selected, causes electronic device 1300 to cease generation of visual information 1372, and includes selectable option 1324b, which when selected, causes electronic device 1300 to commit and/or save the visual media corresponding to visual information 1372. Electronic device 1300 in FIG. 13X displays visual effect 1370, extending toward and/or surrounding icon 1374. Electronic device 1300 concurrently displays icons 1308d-1308f, which when selected, optionally cause electronic device 1300 to update visual information 1372 using the one or more AI processes (e.g., based on one or more AI models) and the concept corresponding to the selected icon. In FIG. 13X, electronic device 1300 displays icon 1335, which when selected, causes electronic device 1300 to capture an image that electronic device 1300 is able to use to change aspects of visual information 1372. In some embodiments, electronic device 1300 detects input such as input 1328a directed to prompt bar 1314, which when selected, initiates a process to enter information that electronic device 1300 uses to modify visual information 1372 in accordance with the one or more AI processes (e.g., based on one or more AI models).

In FIG. 13Y, electronic device 1300 displays the keyboard 1388 and updates display of the prompt bar 1314. In some embodiments, electronic device 1300 displays visual effects overlaying, and/or otherwise applied to the regions of user interface 1304 that correspond to keyboard 1388 and prompt bar 1314. Thus, electronic device 1300 in FIG. 13Y indicates that generative artificial intelligence models, such as associated with one or more of the functionalities described with reference to method 1400, are potentially used to generate visual information 1372 in accordance with input directed to keyboard 1388 which when detected, causes electronic device 1300 to populate prompt bar 1314.

In FIG. 13Z, electronic device 1300 displays a plurality of notifications 1390 and 1392, optionally including visual effects indicating that notification contents have been summarized using one or more AI processes (e.g., based on one or more AI models). In some embodiments, electronic device 1300 displays visual effects corresponding to notifications that include information associated with an artificial intelligence functionality. In some embodiments, electronic device 1300 displays the visual effect overlaying notification 1390. In some embodiments, electronic device 1300 displays the visual effect surrounding, and not within a region bounded by a border of notification 1390. In some embodiments, electronic device 1300 displays the visual effect within some or all of the region bounded by the border of notification 1390. It is understood that one or more of the aforementioned embodiments are merely exemplary, and that electronic device 1300 optionally displays the visual effect corresponding to regions associated with notification 1390 (e.g., within the notification, outside the notification, applied to a portion or all of the notification, and/or some combination thereof). In some embodiments, notification 1390 is displayed with one or more of the visual effects described herein due to the automatic summarization performed by electronic device 1300 (e.g., “Summary: Amy wants to invite the family for dinner.”) In some embodiments, electronic device 1300 forgoes display of the visual effect when artificial intelligence functionality is not invoked, such as forgoing display of a visual effect applied to notification 1392.

In FIG. 13AA, electronic device 1300 displays a user interface 1304 for a visual media browsing and/or editing application. In FIG. 13AA, electronic device 1300 displays representations of visual media, such as photos, concurrently while displaying selectable option 1398. In response to detecting selection input 1396 directed to selectable option 1398 in FIG. 13AA, electronic device 1300 initiates a process to create a collection (e.g., an automatically curated collection of photos, videos, and/or audio from a media library of a user of the electronic device) of visual content, such as by using one or more of the AI processes described herein.

As described above, a collection of visual content optionally includes photos, generated images, videos, and/or the like, such as an automatically generated collection of photos relating to a vacation a user of electronic device 1300 took, and/or a collection of generated visual media and/or videos relating to an individual that is prominent in the user's library of visual media. In FIG. 13BB, electronic device 1300 displays an animation in which a plurality of abstract representations 1303 (e.g., and/or representations corresponding to visual media that will be included in the collection) are displayed, moving throughout user interface 1304. In some embodiments, the animation includes moving the representations 1303 that include representations 1303a, 1303b, and the like, relative to the user interface. In some embodiments, the animation includes moving representations as though the representation descend in a depth direction from the user's viewpoint or perspective toward a simulated plane in the user interface 1304 parallel to a surface of electronic device 1300.

In FIG. 13BB, electronic device 1300 displays visual effects 1301a and 1301b applied to representation 1303a and representation 1303b and/or at least partially surrounding representations 1303a and representation 1303b. In some embodiments, visual effects 1301a and/or 1301b have one or more characteristics similar to, or the same as other visual effects described with reference to FIGS. 13A-13HH. In some embodiments, the visual effects 1301a and 1301b share one or more visual characteristics such as a color palette that changes over time, and in some embodiments, visual effects 1301a and 1301b have one or more different visual characteristics, such as a pattern of movement and/or a predominant color. In FIG. 13CC, electronic device 1300 concludes the animation initiated from FIG. 13BB, including display of representations 1303a and 1303b including the related visual content (e.g., photos, videos, automatically-generated visual content, and/or the like). In FIG. 13CC, electronic device 1300 displays representations 1303 respectively with visual effects similar to or the same as the visual effects that were displayed while performing the animation, such as including a same color and/or a same cycling of a saturation of the color, indicating that the representation 1303 were selected in accordance with the one or more AI processes (e.g., based on one or more AI models) described herein.

FIGS. 13DD-13HH illustrates examples of electronic device 1300 using one or more AI processes (e.g., based on one or more AI models) to generate depth information for visual media. In FIG. 13DD, electronic device 1300 displays the user interface for a visual media browsing and/or editing application, including representation 1309 corresponding to a first image (e.g., a photo, a photo augmented with automatically-generated visual content such as objects, and/or an automatically-generated visual content item). In FIG. 13DD, electronic device 1300 detects selection input 1307 directed to representation 1309, and in response, updates user interface 1304, enlarging representation 1309 as shown in in FIG. 13EE and initiating display of one or more selectable options including selectable option 1371. In response to detecting selection input 1311 directed to selectable option 1371 in FIG. 13EE, electronic device 1300 initiates display of a plurality of additional selectable options that are respectively selectable to cause electronic device 1300 to perform an editing operation associated with the representation 1309 such as in FIG. 13FF. In some embodiments, representation 1309 corresponds to a two-dimensional image not associated with depth data and/or information. Accordingly, when displaying representation 1309 and/or one or more images corresponding to representation 1309, electronic device 1300 (e.g., and/or other devices that are optionally configured to display a simulated depth of the corresponding image and/or stereoscopic representation of the image) optionally display representation 1309 as a flat, planar image. As described in further detail below, electronic device 1300 optionally uses one or more AI processes (e.g., based on one or more AI models) to determine and/or generate depth information of the image corresponding to representation 1309.

In FIG. 13FF, electronic device 1300 displays selectable option 1315, which when selected such as in response to detecting selection input 1329, causes electronic device 1300 to initiate analysis of representation 1309 including an analysis of depth. In some embodiments, electronic device 1300 performs and/or requests and obtains results of analysis of depth in an image using one or more AI processes (e.g., based on one or more AI models). For example, in response to detecting input 1329 in FIG. 13FF, electronic device 1300 initiates an analysis and/or a generating of depth information, such as identifying which one or more items are foreground, midground, and/or background portions of the image, and/or assigning one or more simulated or physical depth values to the identified items. As one example, in FIG. 13GG, electronic device 1300 detects that balloons included in the foreground of representation 1309 are at a first set of one or more depths, and being the closest items in the representation, comprise the foreground of representation 1309. Accordingly, electronic device 1300 initiates display of a first visual effect 1358 corresponding to a center of the foreground item(s), such as center of the grouping of balloons in FIG. 13GG, and moving outward toward a periphery of the balloons, thus indicating depth information is and/or was generated corresponding to the balloons. In some embodiments, first visual effect 1358 has one or more characteristics similar to, or the same as other visual effects described with reference to FIGS. 13A-13HH. Additionally, electronic device 1300 initiates display of visual effect 1319 in FIG. 13GG, to provide visual indication that moves across representation 1309 indicating a progression of the analysis.

From FIG. 13GG to FIG. 13HH, electronic device 1300 continues to display the animation and/or the visual effects. For example, electronic device 1300 displays the balloons included in representation 1309 with a second visual effect 1331, which is optionally different from the first visual effect 1358. In FIG. 13HH, electronic device 1300 detects the midground and/or background content of representation 1309 includes trees, and accordingly displays the trees with a third visual effect 1333. In some embodiments, the third visual effect is similar to, or the same as the first visual effect 1358. In some embodiments, second visual effect 1331 and/or third visual effect 1333 have one or more characteristics similar to, or the same as other visual effects described with reference to FIGS. 13A-13HH. Accordingly, electronic device 1300 optionally simulates the appearance of a visual effect that is initially displayed overlaying and/or applied to foreground content, and/or progressively moving “backward” in a depth dimension toward the midground and/or background of the image identified using the one or more AI processes (e.g., based on one or more AI models). In FIG. 13HH, electronic device 1300 moves the visual effect 1319 diagonally, upwards and/or to the left of user interface 1304 from FIG. 13GG to FIG. 13HH, thus indicating that the analysis is nearing completion. In some embodiments, after the analysis concludes, electronic device 1300 ceases display of the various visual effects and/or the animation, and/or embeds and/or associates depth information and/or metadata with representation 1309. For example, when electronic device 1300 communicates the file corresponding to representation 1309, electronic device 1300 optionally also includes the generated depth information, which when opened and/or examined at another electronic device, optionally facilitates an exploration and/or editing of an image corresponding to the file as though the photo has a depth. For example, when opening the file at the other device, the other device optionally displays the image stereoscopically, simulating the sensation of depth to an otherwise planar image.

FIG. 14 illustrates a flow diagram illustrating a method in which an electronic device displays visual information based upon an event that corresponds to an artificial intelligence model in accordance with some embodiments of the disclosure. The method 1400 is optionally performed at first electronic device and/or electronic devices such as device 100, device 300, or device 500 as described above with reference to FIGS. 1A-1B, 2-3, 4A-4B and 5A-5H. Some operations in method 1200 are, optionally combined and/or order of some operations is, optionally, changed.

As described below, the method 1400 provides ways in which an electronic device displays visual information based upon an event that corresponds to an artificial intelligence model. Displaying visual information based upon an event that corresponds to an artificial intelligence process enhances user interactions with the electronic device by providing identifiable visual effects corresponding to the use of one or more particular AI process driven functionalities, and/or common visual characteristics across different visual effects.

In some embodiments, as illustrated in FIGS. 13A-13B and/or 25A-25E, for instance, a method 1400 is performed at an electronic device 1300 in communication with a display generation component 1302, and one or more input devices. For example, the electronic device, the one or more input devices, and/or the display generation component have one or more characteristics of the electronic device(s), the one or more input devices, and/or the display generation component(s) described with reference to FIG. 1-FIG. 2. In some embodiments the electronic device is configured to provide a view of a physical environment surrounding a user, however the embodiments discussed herein are not limited thereto. In some embodiments, the electronic device, the display generation component, and the one or more input devices share one or more characteristics with the electronic devices described with respect to methods 700, 800, 1000, 1200, 1500, 1700, 1900, 2100, and/or 2300.

In some embodiments, while the electronic device 1300 displays (1402) a first user interface (e.g., 1304, and/or 1312), the electronic device detects (1404) a first event. In some embodiments, when the electronic device detects a first event while displaying the first user interface, the electronic device initiates one or more operations. The first event optionally corresponds to a user input to initiate one or more artificial intelligence (AI) functionality operations wherein the electronic device uses AI to generate content corresponding to the user input. AI generated content optionally includes textual information, graphical information, animation(s), audio, and/or video. In some embodiments the generation of visual information includes the generation of new visual information, and/or the augmentation of existing visual information. Additionally or alternatively, the first event optionally corresponds to a request from one or more active applications running on the electronic device corresponding to a request to initiate the one or more AI operations. Generation of content using an artificial intelligence model optionally includes the use of one or more program(s) and/or algorithm(s) applied to one or more datasets to recognize patterns, and/or make predictions based on the inputs received to result in generated content, and optionally includes the use of machine learning algorithms. In some embodiments, the first event corresponds to a request to generate new content (e.g., text, images and/or videos) and/or analyze existing content (e.g., text, images and/or videos, and/or optionally provided via user input) using such AI functionality, such as described with reference to methods 700, 800, 1000, 1200, 1500, 1700, 1900, 2100, and/or 2300.

In some embodiments, in response to detecting the first event, and in accordance with a determination that the first event corresponds to a first functionality that outputs content on user interface 1314 generated using a first artificial intelligence (AI) process (e.g., based on one or more AI models) (1406), the electronic device displays first visual information (such as visual information 1315) corresponding to the first event in the first user interface (e.g., 1304, and/or 1312), with a first visual effect 1308 (e.g., one or more of visual effects) as shown in FIGS. 13A-13B and/or 25A-25E wherein the first visual effect includes a first visual characteristic (1408). In some embodiments, when the electronic device receives input corresponding to the first event which includes a request for first visual information (e.g., content generated by a first AI process), the electronic device initiates the first functionality. The electronic device optionally initiates the first functionality in response to verbal input, button actuation, keystroke, dynamic motion, hand gesture from the user and/or a request from the one or more active applications running on the electronic device. In some embodiments the first functionality is invoked by a second electronic device interconnected with the electronic device. When the electronic device receives an input to invoke the first functionality (e.g., request for generation of visual information based on the first AI process), the electronic device optionally generates first visual information and displays the first visual information within the first user interface. The first visual information optionally includes textual information, graphical information, two-dimensional information, three-dimensional information, and/or animated information that is generated by the first AI process. Furthermore, the first visual information is optionally sourced visual information, aggregated visual information, and/or newly generated visual information. In some embodiments, the content generated by the first AI process shares one or more characteristics of the AI-generated content described with reference to methods 700, 800, 1000, 1200, 1500, 1700, 1900, 2100, and/or 2300.

In some embodiments the first functionality includes generating the first visual information based on user input (e.g., keystroke, graphical input, and/or verbal input) providing contextual information. For instance a user input surrounding a query in relation to the keyword “peacock” optionally results in generation of an encyclopedic paragraph description of a peacock, while a first user input corresponding to the first event in relation to the key phrase “peacock riding a bicycle” optionally results in generation of an image and/or animation of a peacock riding a bicycle which is optionally displayed on the first user interface. When displaying the first visual information (e.g., peacock on a bicycle) generated by the first functionality on the first user interface, the first electronic device optionally displays the first user interface with a first visual effect, indicating that the first visual information has been generated using the first functionality. Additionally or alternatively, the first visual effect is displayed upon receipt of user input, while generating the first visual information, and/or upon displaying the first visual information. The first visual effect as displayed by the electronic device (e.g., a colorized halo) optionally indicates that the first functionality has been invoked.

In some embodiments the first visual effect includes a halo effect, a colorized effect, and/or an animated effect applied to the first user interface and/or the first visual information. In some embodiments the first visual effect includes a colorized halo applied around the first user interface and/or the colorized halo is displayed with one or more animations. The halo as described herein is optionally aligned with the boundaries of the first user interface, but not limited thereto. For instance, when the first visual information is displayed on a rectangularly shaped first user interface, the halo comprises a rectangular shape matching the rectangular shape of the first user interface. In some embodiments the first visual effect is displayed on a first visual effect layer and one or more mask layers applied to conceal and/or reveal portions of the first visual effect layer in accordance with the first functionality. The halo optionally comprises a shape which mimics the shape of the first visual information, a predetermined shape, and/or an amorphous shape. For instance a halo comprises a circular shape which is optionally amorphously animated in a randomized manner to show undulations through localized scaling (increase and/or decrease) of the circular shape within a scaling threshold (e.g., 1%, 5%, or 10%), localized scaling of the first user interface, localized color variation, and/or localized masking along portions of the predetermined shape to provide movement, animation, and/or the perception of movement while maintaining the general circular shape.

Displaying the first visual effect optionally includes displaying a visual effect layer periodically and/or continuously on the first visual effect layer. In some embodiments the first visual effect layer is displayed behind the first user interface in a manner such that the first user interface masks a portion of the first visual effect layer corresponding to the location of the first user interface.

When the electronic device determines that the first event corresponds to an input (e.g., request from user and/or active application(s)) to initiate the first functionality, the electronic device optionally displays the first visual effect, which includes the first visual characteristic, with the first user interface. In some embodiments the first visual characteristic includes a color palette, a color range (e.g., High-Dynamic Range (HDR)), an animation, randomization, layering of visual elements, and/or masking of visual elements. In some embodiments HDR includes one or more characteristics with HDR as described with respect to method 1500.

Additionally or alternatively, the first visual effect optionally indicates receipt of the user input requesting the first functionality, content generation in process in accordance with the first functionality, and/or when the first visual information displayed is an AI generated response to the first event (e.g., user input, such as a search query). In some embodiments the first visual effect shares one or more characteristics with the animation effect described with respect to method 1500.

In some embodiments, in accordance with a determination that the first event corresponds to a second functionality, different from the first functionality, that outputs content generated using a second AI process (1410) (e.g., a second AI process that is the same as the first AI process or a second AI process that is different from the first AI process), the electronic device displays second visual information (e.g., text 1318 shown in FIGS. 13F and/or 25K) corresponding to the first event in the first user interface with a second visual effect 1320, different from the first visual effect, wherein the second visual effect includes the first visual characteristic (1412). In some embodiments, when the electronic device receives input corresponding to the first event which includes a request for second visual information (e.g., content generated by a second AI process), the electronic device initiates the second functionality. The electronic device optionally initiates the second functionality in response to verbal input, button actuation, keystroke, dynamic motion, hand gesture from the user and/or a request from the one or more active applications running on the electronic device. In some embodiments the second functionality is invoked by a second electronic device interconnected with a first electronic device. When the electronic device receives an input to invoke the second functionality, the electronic device optionally generates the second visual information and displays the second visual information within the first user interface. The content generated with the second functionality optionally includes revisions, augmentation, additions and/or deletions to existing visual information, generated by the second AI process. Furthermore, the second visual information is optionally sourced visual information, aggregated visual information, and/or newly generated visual information. In some embodiments, the content generated by the second AI process shares one or more characteristics of the AI-generated content described with reference to methods 700, 800, 1000, 1200, 1500, 1700, 1900, 2100, and/or 2300.

In some embodiments the first functionality includes reviewing (e.g., proof-reading) existing content wherein the second AI process provides revisions, suggested revisions, and/or additional content as related to the existing content. For instance, a user optionally initiates the generation of the second visual information in relation to existing written content including: a sentence, paragraph, page, and/or multiple pages of written content. Additionally or alternatively, the generation of the second visual content optionally includes the proofing of existing graphical content (e.g., imagery, animation, two-dimensional content, and/or three-dimensional content) wherein the second visual content includes revisions, suggested revisions, and/or additional content related to the to the existing graphical content. When the second visual content is displayed on the first user interface, the second visual content is displayed with a second visual effect to indicates invocation of the second functionality. For instance, when the user initiates the second functionality in relation to existing written content including a phrase “The peacock was riding an bicycle”, the electronic device scans the existing written content, and generates the second visual information which includes “The peacock was riding a bicycle” and optionally includes “The peacock was riding a mountain bike”. The electronic device optionally displays a second visual effect when displaying the second visual information (e.g., “The peacock was riding a mountain bike”) on the first user interface. In some embodiments the second visual effect optionally indicates receipt of the user input requesting the second functionality, content generation in process in accordance with the second functionality, and/or when the second visual information displayed is an AI generated response to the search query.

In some embodiments the second visual effect includes a first respective animation in a first direction (e.g., up, down, left, right, in, out, and/or diagonally) followed by a second respective animation in a second direction wherein the second direction is optionally different than the first direction, and in some embodiments opposite the direction of the first direction. In some embodiments the first respective animation of the second visual effect corresponding to the second visual effect is displayed in relation to the existing visual content (e.g., “The peacock was riding a bicycle”), and the second respective animation of the second visual effect is displayed in relation to the second visual information (e.g., “The peacock was riding a mountain bike”). For instance, first respective animation of the second visual effect optionally includes a first color gradient which travels upward indicated that the electronic device is scanning the existing visual content, and the second respective animation of the second visual effect optionally includes a second color gradient which travels downward indicating the display of the second visual information generated with the second functionality.

The second visual effect optionally shares one or more characteristics with the first visual effect described with respect to the current method. For instance, the second visual effect optionally shares a color palette, a color range (e.g., High-Dynamic Range (HDR)), an animation, a randomization algorithm, a layering of visual elements, and/or masking of visual elements with the first visual effect. In some embodiments the second visual effect shares one or more characteristics with the animation effect described with respect to method 1500.

In some embodiments, although the first visual characteristic is common between the first visual effect and the second visual effect, the first visual effect includes a second characteristic which is different than a second characteristic of the second visual effect. The second visual characteristic of the first visual effect and the second visual characteristic of the second visual effect are optionally different based on one or more characteristics including: color palette, size, shape, scale in relation to the first user interface, animation, intensity, brightness, and/or contrast. In some embodiments the visual appearance of the first visual effect is different from the visual appearance of the second visual effect.

In some embodiments, while displaying the first user interface, detecting a second event, different from the first event, and in response to detecting the second event, in accordance with a determination that the second event corresponds to the first functionality that outputs content generated using the first AI process, displaying visual information corresponding to the second event in the first user interface with the first visual effect (e.g., an animation or visual effect that is applied to different content but has similar stages, colors, and/or other visual effect characteristics that are applied to other content generated by the first AI process). In some embodiments, while displaying the first user interface, detecting a second event, different from the first event, and in response to detecting the second event, in accordance with a determination that the second event corresponds to the second functionality that outputs content generated using the second AI process, displaying visual information corresponding to the second event in the first user interface with the second visual effect (e.g., an animation or visual effect that is applied to different content but has similar stages, colors, and/or other visual effect characteristics that are applied to other content generated by the second AI process).

By displaying the first visual information generated with the first functionality with the first visual effect, and displaying the second visual information with the second visual effect, different than the first visual effect, the electronic device indicates to the user which functionality was used to generate the provided visual information. Furthermore, by the first visual effect and the second visual effect sharing at least a first visual characteristic, the electronic device indicates to the user that displayed information includes content generated by one or more AI processes. By providing a visual indication as to the corresponding functionality by which the visual information is provided, the user is informed as to the method of generation of the visual information (e.g., AI generated, non-AI generated), and/or the source of information (e.g., first AI process, and/or second AI process). Furthermore, through providing the user visual indication of the method of generation (e.g., AI generated), the user is made aware of a possible need to further verify the accuracy and/or validity of the generated content.

In some embodiments, while the electronic device displays the first user interface (e.g., 1304 as illustrated in FIGS. 13A-B and/or 25A-25E), and in response to detecting the first event, in accordance with a determination that the first event corresponds to a third functionality, which is different from the first functionality and the second functionality, that outputs content generated using a third AI process (e.g., a third AI process that is the same as the first AI process and/or the second AI process or a third AI process that is different from the first AI process and/or the second AI process), the electronic device 1300 displays third visual information corresponding to the first event in the first user interface with a third visual effect such as the visual effect 1330 illustrated in FIG. 13H. The third visual effect is optionally different from the first visual effect 1308 and the second visual effect 1320. However, the third visual effect optionally includes the first visual characteristic. In some embodiments, the electronic device optionally uses a third visual effect to differentiate a third functionality from the first functionality and the second functionality. For instance, when the first event corresponds to the user requesting an AI generated response which does not correspond to the first and/or second functionalities, and corresponds to a third functionality (e.g., an AI generated food order recommendation from a local restaurant), the electronic device optionally displays an AI generated food order in the first user interface with a third visual effect. When displaying the AI generated food order generated by the third functionality, the electronic device optionally displays a colorized animation with one or more visual characteristics which are unique to the third functionality. For instance, the electronic device optionally displays a colorized animation of the third visual effect in a first horizontal direction when processing the first event corresponding to the third functionality (e.g., request to generate a food order), and displays the colorized animation of the third visual effect in a second horizontal direction, different from the first horizontal direction, when displaying the third visual information. In some embodiments, the third visual effect shares the first visual characteristic with the first visual effect and the second visual effect. In some embodiments the third visual effect shares one or more characteristics with the first visual effect and the second visual effect as described with respect to the current method. In some embodiments, while displaying the first user interface, detecting a second event, different from the first event, and in response to detecting the second event, in accordance with a determination that the second event corresponds to the third functionality that outputs content generated using the third AI process, displaying visual information corresponding to the second event in the first user interface with the third visual effect (e.g., an animation or visual effect that is applied to different content but has similar stages, colors, and/or other visual effect characteristics that are applied to other content generated by the third AI process).

By displaying the third visual information generated with the third functionality with the third visual effect, which is different than the first visual effect and the second visual effect, the electronic device indicates to the user as to the method of generation (e.g., AI generated) and/or the source of the information (e.g., third AI process). Furthermore, by displaying the third visual information with the shared first visual characteristic, also used by the first visual effect and the second visual effect, the electronic device indicates to the user that the third generated information includes content generated by one or more AI processes. By providing a visual indication as to the corresponding functionality by which the visual information is provided, the user is informed as to the method of generation of the visual information (e.g., AI generated, and/or non-AI generated), and/or the source of information (e.g., first AI process, second AI process, and/or third AI process). Furthermore, through providing the user visual indication of the method of generation (e.g., AI generated), the user is made aware of a possible need to further verify the accuracy and/or validity of the generated content.

In some embodiments, while the electronic device 1300 displays the first user interface, and in response to detecting the first event, in accordance with a determination that the first event corresponds to a fourth functionality that outputs content generated using a fourth AI process (e.g., a fourth AI process that is the same as the first AI process, the second AI process, and/or the third AI process or a fourth AI process that is different from the first AI process, the second AI process, and/or the third AI process), the electronic device 1300 displays fourth visual information (e.g., visual information 1350 as shown in FIG. 13L) corresponding to the first event in the first user interface with a fourth visual effect (e.g., 1384B as shown in FIG. 13L). The fourth visual effect is optionally different from the first visual effect, the second visual effect, and the third visual effect. However, in some embodiments the fourth visual effect includes the first visual characteristic. In some embodiments, the electronic device optionally uses a fourth visual effect to differentiate a fourth functionality from the first functionality, the second functionality, and the third functionality, wherein the fourth visual effect is different that the first visual effect, the second visual effect, and the third visual effect. However, the fourth visual effect optionally shares a first visual characteristic in common with the first visual effect, the second visual effect, and the third visual effect. For instance, when the first event corresponds to the user requesting an AI generated response which does not correspond to the first functionality, the second functionality, and/or the third functionality, and corresponds to a fourth functionality, such as a request to generate and display an AI generated animation illustrating how to service automobile brakes, the electronic device optionally displays an AI generated animation providing visual instructions pertaining to the servicing of automobile brakes with a fourth visual effect. In some embodiments the fourth visual effect includes an animation which radiates outward from the displayed fourth visual information, wherein the radiating animation optionally pulsates radially inward and outward from a region surrounding the displayed fourth visual information. In some embodiments, the fourth visual effect shares the first visual characteristic with the first visual effect, the second visual effect, and the third visual effect. In some embodiments the fourth visual effect shares one or more characteristics, in addition to the first characteristic, with the first visual effect, the second visual effect, and/or the third visual effect as described with respect to the current method. In some embodiments, while displaying the first user interface, detecting a second event, different from the first event, and in response to detecting the second event, in accordance with a determination that the second event corresponds to the fourth functionality that outputs content generated using the fourth AI process, displaying visual information corresponding to the second event in the first user interface with the fourth visual effect (e.g., an animation or visual effect that is applied to different content but has similar stages, colors, and/or other visual effect characteristics that are applied to other content generated by the fourth AI process).

By displaying the fourth visual information generated with the fourth functionality with the fourth visual effect, which is different than the first visual effect, the second visual effect, and/or the third visual effect the electronic device indicates to the user as to the method of generation (e.g., AI generated) and/or the source of the information (e.g., fourth AI process). Furthermore, by displaying the fourth visual information with the shared first visual characteristic, also used by the first visual effect and the second visual effect, the electronic device indicates to the user that the fourth generated information includes content generated by one or more AI processes. By providing a visual indication as to the corresponding functionality by which the visual information is provided, the user is informed as to the method of generation of the visual information (e.g., AI generated, non-AI generated), and/or the source of information (e.g., first AI process, second AI process, third AI process, and/or fourth AI process). Furthermore, through providing the user visual indication of the method of generation (e.g., AI generated), the user is made aware of a possible need to further verify the accuracy and/or validity of the generated content.

In some embodiments, while the electronic device 1300 displays the first user interface, and in response to detecting the first event, in accordance with a determination that the first event corresponds to a respective functionality, different from the first functionality and the second functionality (and optionally the third functionality and the fourth functionality), that does not output content generated using an AI process, the electronic device 1300 displays respective visual information (e.g., visual information 1317 illustrated in FIG. 13J) corresponding to the first event in the first user interface, wherein the respective visual information does not include the first visual characteristic (such as visual characteristic 1308 illustrated in FIGS. 13A and/or 25C-25E). In some embodiments, when the electronic device displays content (e.g., respective visual information) generated by a respective functionality which does not include content generated using an AI process, the electronic device displays the respective visual information without including the first visual characteristic. For instance, when the electronic device receives a request from the user for a list of local restaurants within a proximity (e.g., 1 km) from the current location of the user and/or the electronic device, the electronic device optionally displays the list of local restaurant on the first user interface without displaying the first visual characteristic when the list of local restaurants that is displayed is not generated by an AI process. Additionally or alternatively, when the electronic device receives a request from the user to display visual information corresponding to the current weather outside in Pittsburgh, Pennsylvania, the electronic device optionally displays the current weather report for Pittsburgh, Pennsylvania without a visual effect (e.g., the first visual effect), as the visual information displayed has not been generated by an AI process. By displaying the respective visual information, generated without an AI process, without the first visual characteristic, the electronic device indicates to the user that the respective visual information was not generated with an AI process.

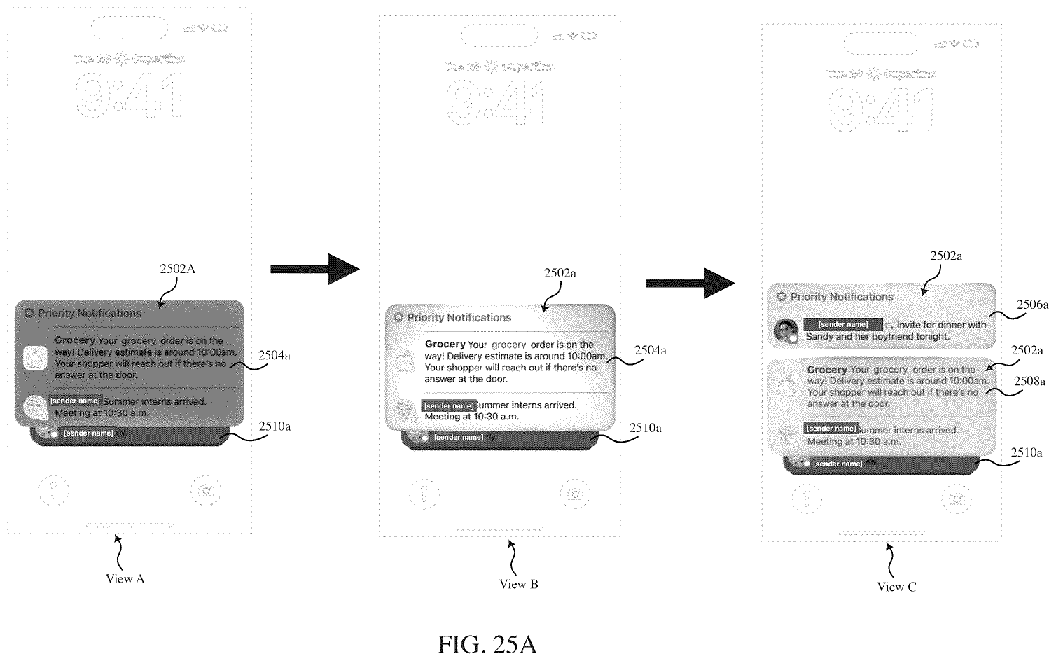

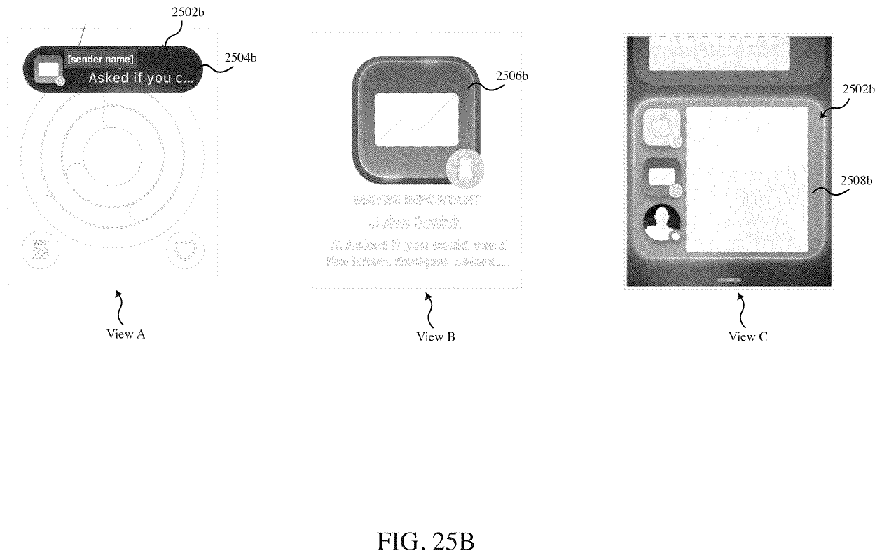

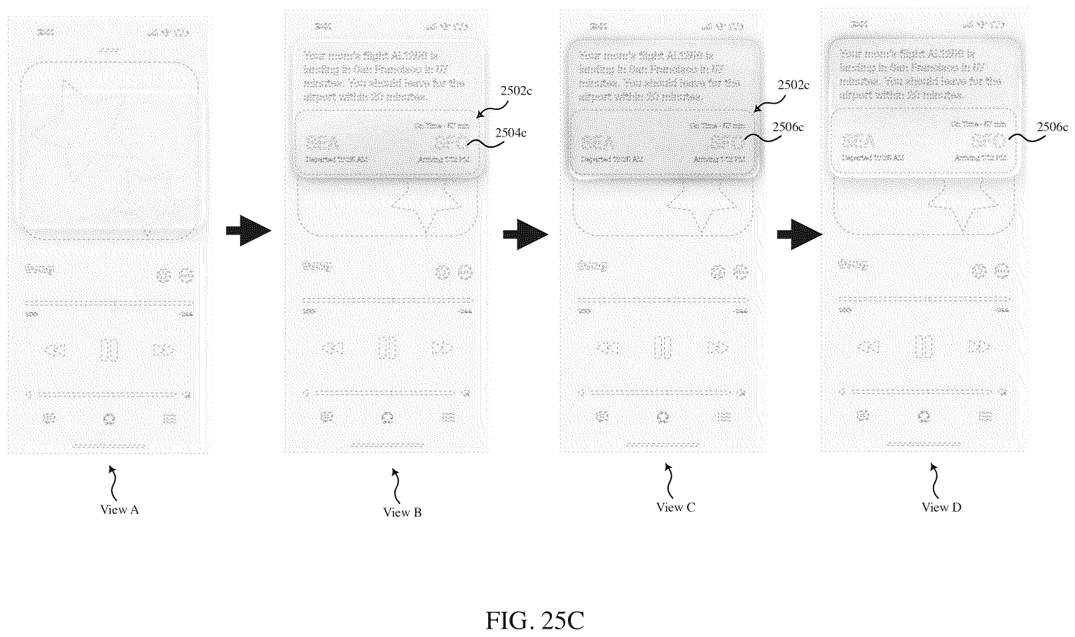

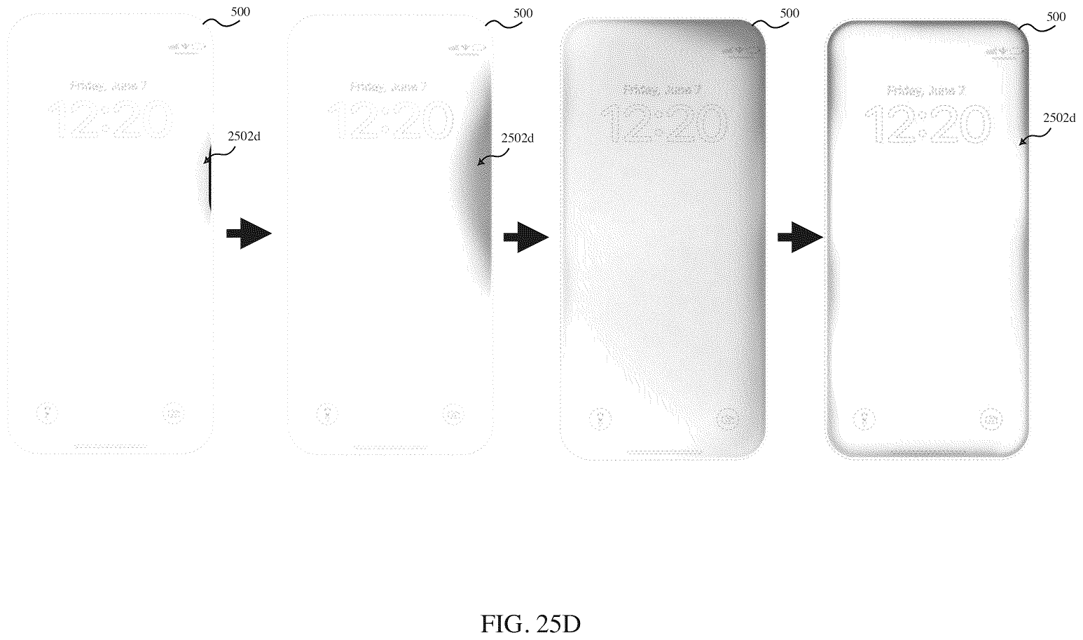

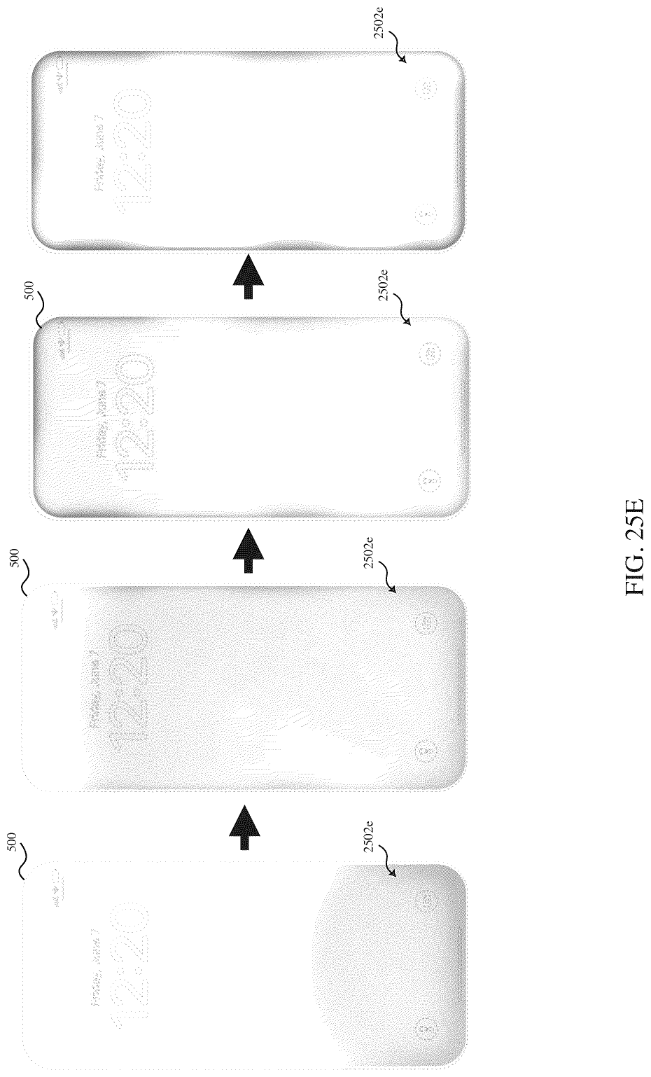

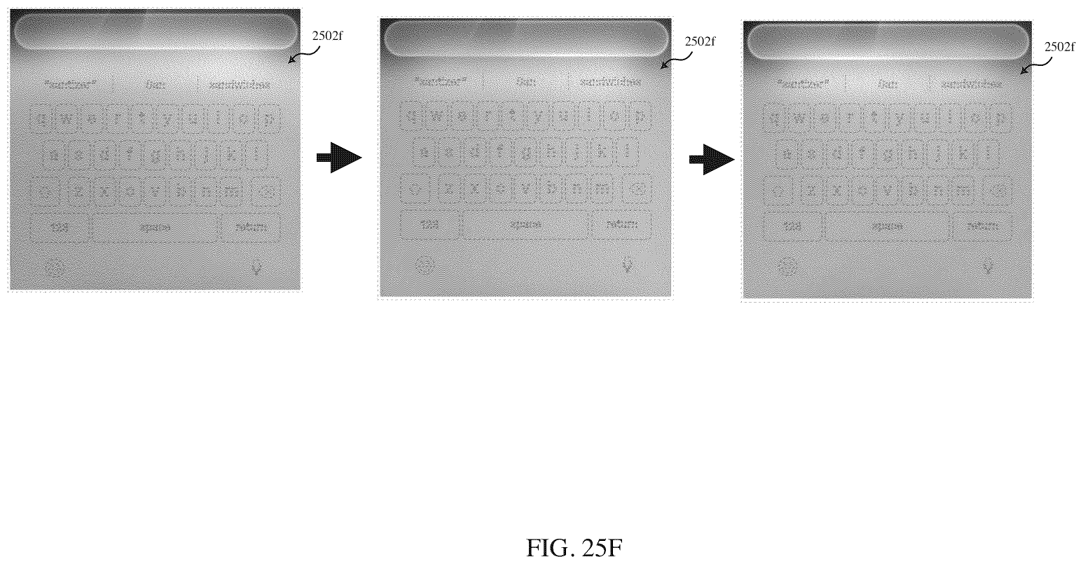

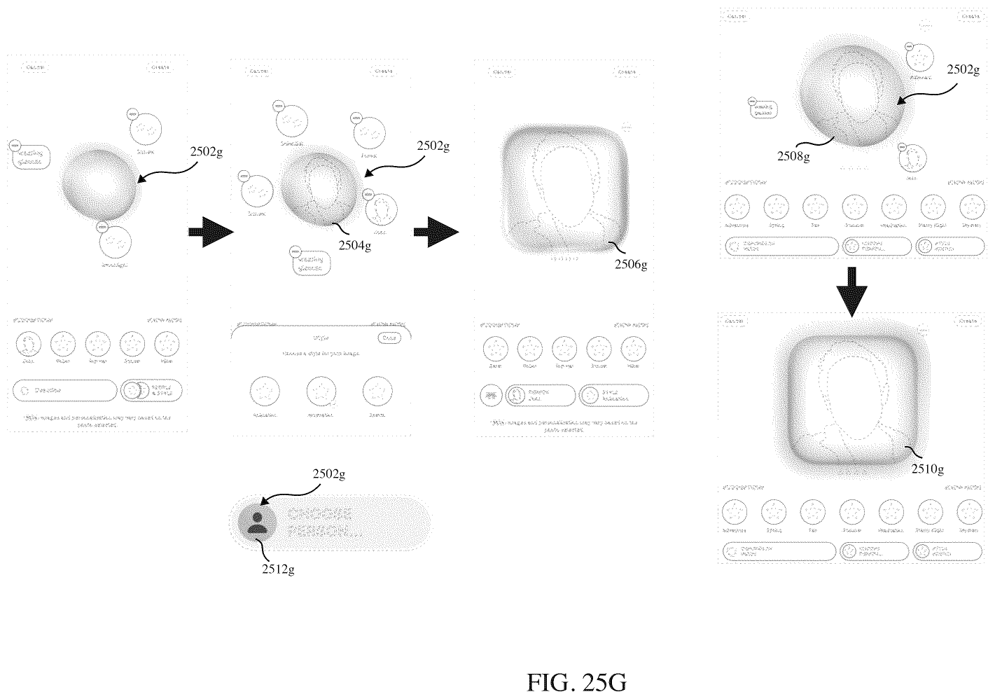

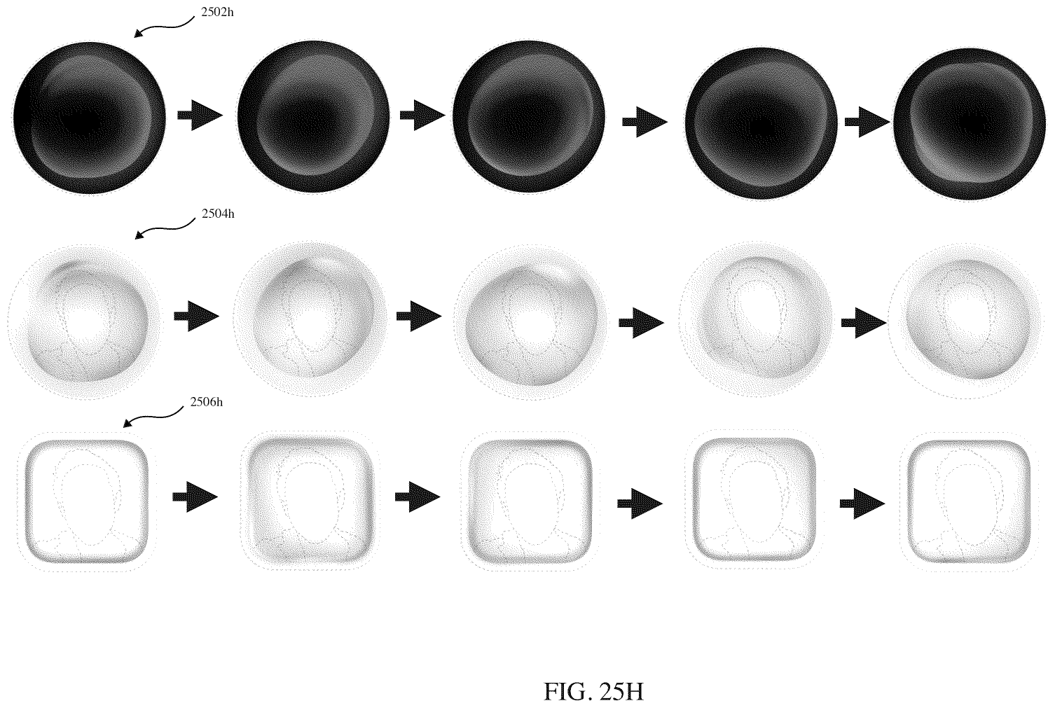

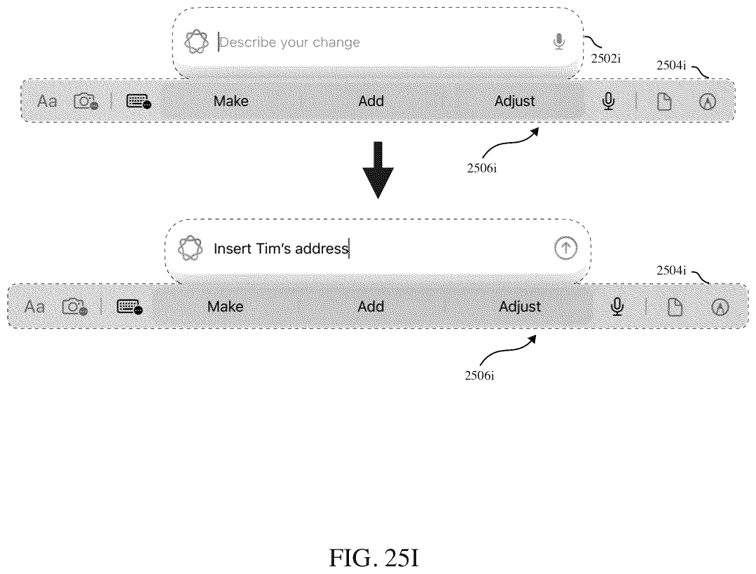

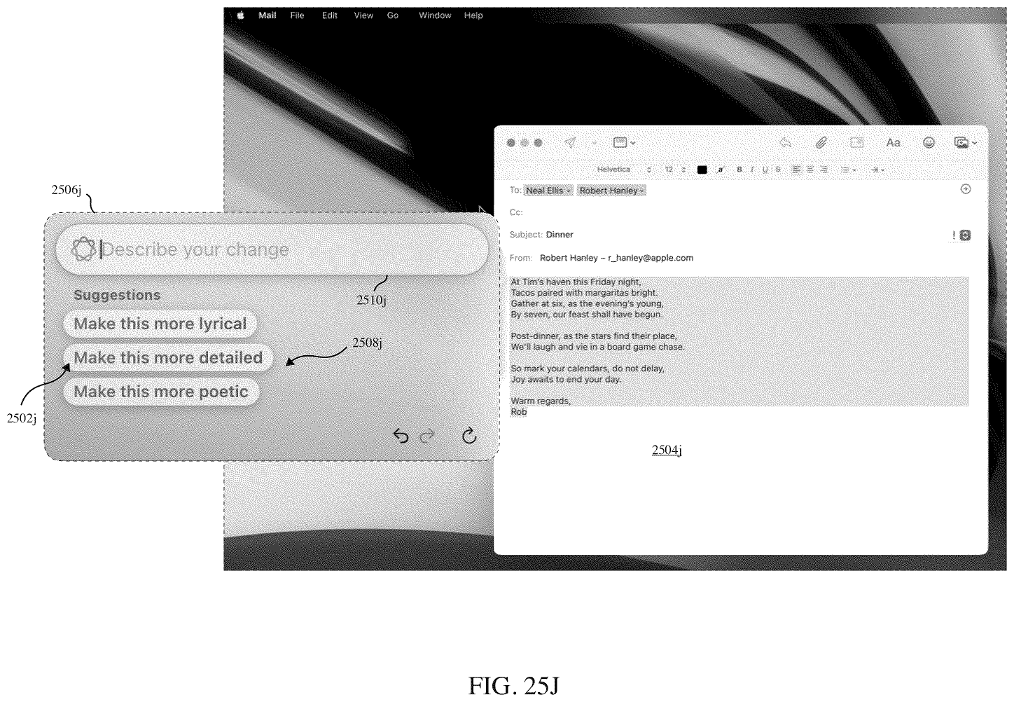

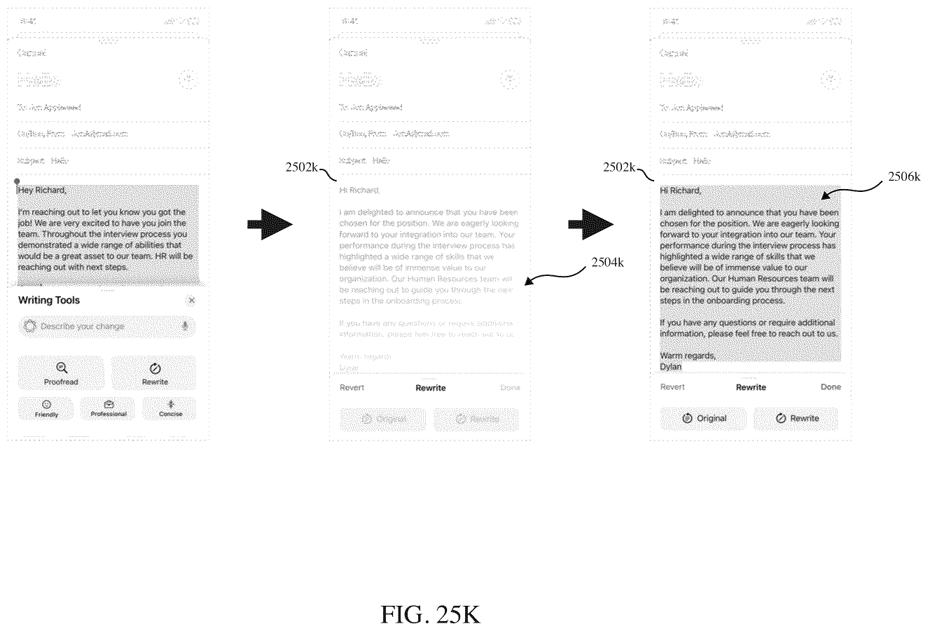

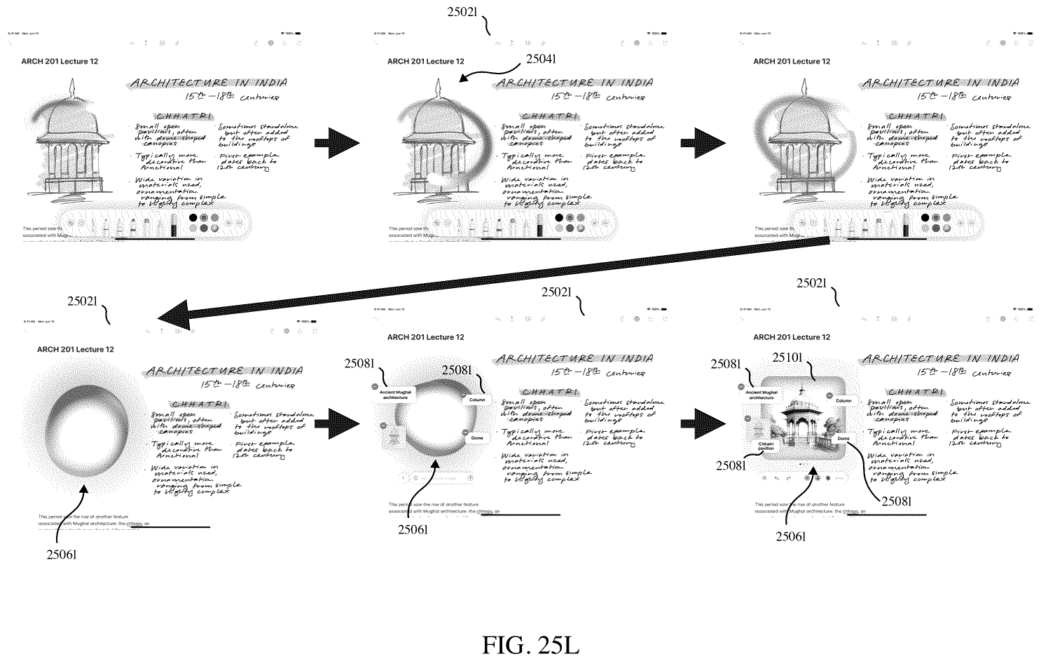

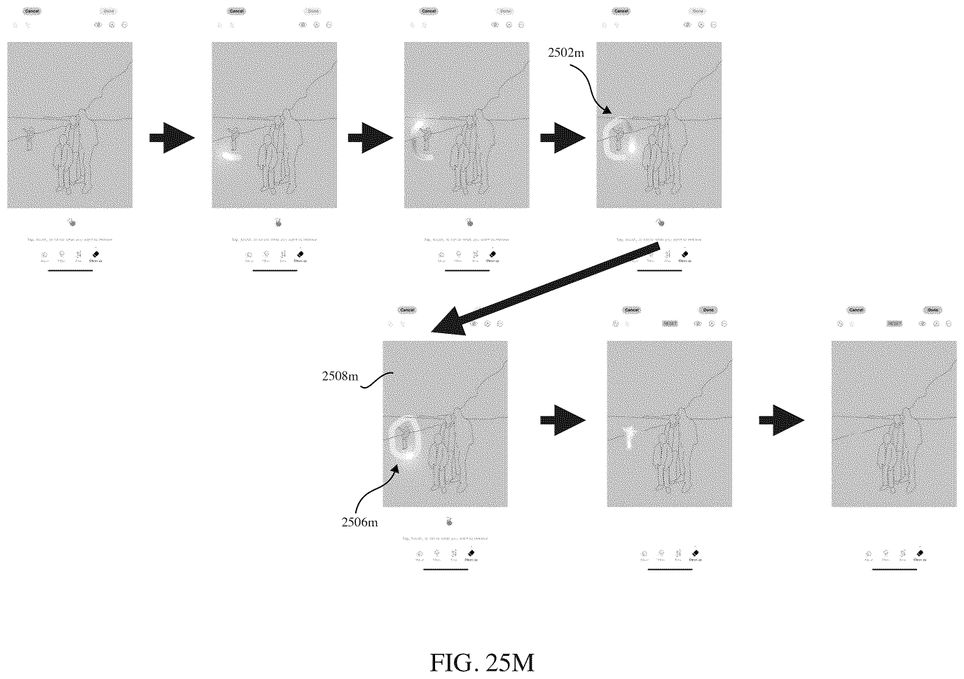

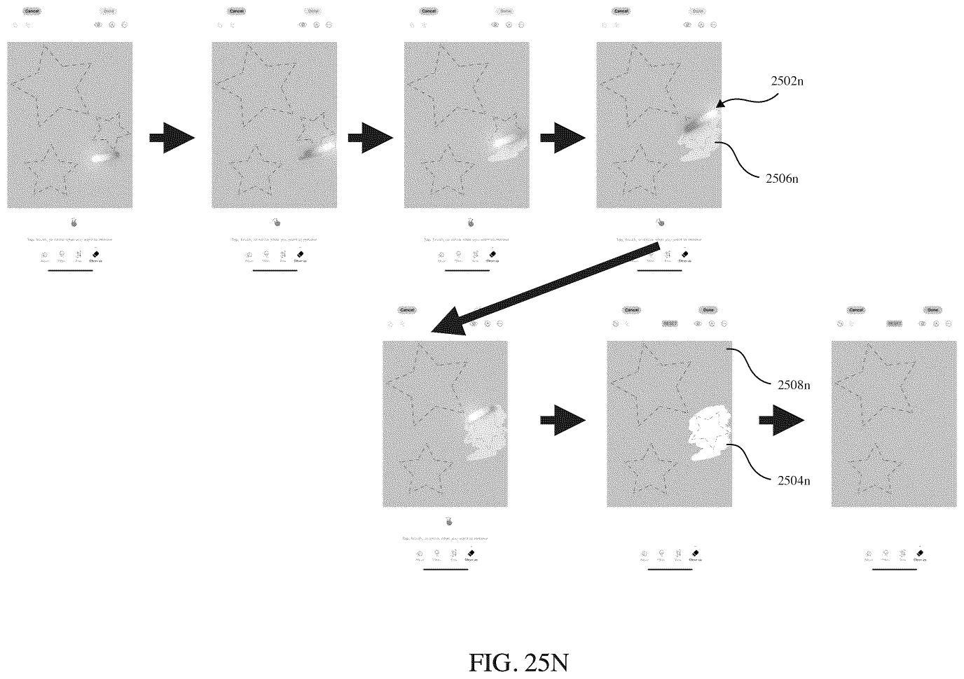

In some embodiments, while displaying the first user interface, the electronic device detects a second event, which is different from the first event. In response to detecting the second event, in accordance with a determination that the second event corresponds to the first functionality, the electronic device 1300 displays a first animation sequence (such as animation 1316 illustrated in FIG. 13B and/or FIGS. 25A-25B) corresponding to the first functionality. The first animation sequence optionally corresponds to (e.g., is the same as or includes the same or similar visual characteristics or changes applied to different content from the content that was generated as part of the) a respective animation sequence that was displayed as part of displaying the first visual information corresponding to the first functionality in response to the first event. In some embodiments, when the electronic device detects a second event corresponding the first functionality, the electronic device displays generated second visual information on the first user interface with the first visual effect indicating to the user that the first functionality that outputs content generated using the first AI process was invoked and used to generate content. When the electronic device displays content in response to the second event, the electronic device optionally displays the second visual information with a first animation sequence. The first animation sequence optionally corresponds to a respective animation sequence displayed when the content generated in response to the first event was displayed on the first user interface after it was generated in accordance with the first functionality. In some embodiments, the first visual effect and the respective visual effect share one or more characteristics, in addition to the first visual characteristic. For instance, when the first functionality is invoked, the electronic device optionally displays the first visual information with a colorized halo animation sequence. In some embodiments the colorized halo animation sequence is identically replicated each time (first event, and/or second event) the first functionality is invoked, even though the content generated in response to the first and second events is optionally different (e.g., providing an AI-synthesized summary response to a first query and providing an AI-synthesized summary response to a second query, optionally different from the first query). Additionally or alternatively, in some embodiments the colorized halo is replicated with a randomized colorization effect wherein the halo effect displayed in response to a first event invoking the first functionality and the halo effect displayed in response to the second event share one or more characteristics, in addition to the first visual characteristic, but are unique in relation to each other.

Similarly, in some embodiments, a second animation sequence related to the second functionality is replicated in totality (e.g., identically) and/or partially (e.g., with unique elements) each time (e.g., first event, and/or second event) when the second functionality is invoked, even when invoked in response to different events. In some embodiments, when the electronic device detects a second event corresponding to the user requesting the electronic device to generate second visual information using the second functionality, the electronic device displays the generated second visual information on the first user interface with the second visual effect indicating to the user that the second functionality was invoked and used to generate the second visual information. When the electronic device displays the second visual information, the electronic device optionally displays the second visual information with a second animation sequence. The second animation sequence optionally corresponds to (e.g., is the same as) a respective animation sequence displayed when the first visual information was displayed on the first user interface after the first visual information was generated with the second functionality. In some embodiments, the second visual effect and the respective visual effect share one or more characteristics, in addition to the first visual characteristic. By using an animation sequence (e.g., first animation sequence, and/or second animation sequence) which corresponds to a particular functionality (e.g., first functionality, second functionality, third functionality, and/or fourth functionality) when displaying visual information generated by the particular functionality, the electronic device provides a visual indication as to which of the one or more functionalities has been generated by an AI process.

In some embodiments the electronic device displays the visual effects (such as visual effect 1308) with the first visual characteristic which includes displaying the visual effects with a graphical element (e.g., a same graphical element is displayed for different visual effects with the same first visual characteristic). In some embodiments, the visual characteristic includes a graphical element (e.g., icon, text, and/or glyph) that is displayed by the electronic device, and which indicates to the user that the generated content to which the displayed visual information (e.g., first visual information, and/or second visual information) corresponds is generated using one or more AI processes. The graphical element optionally includes a logo, a shape or form created by the user, and/or text. For example, the electronic device optionally displays a graphical element (e.g., in the shape of a sphere) corresponding to visual effect 1356A as illustrated in FIGS. 13O and/or 25E in response to the electronic device receiving an indication from the user to invoke a virtual assistant. For instance, when the electronic device determines that a first event (e.g., user input) corresponds to a request to generate display visual information with a functionality (e.g., first, second, third, and/or fourth) which generates content based on an AI process (e.g., first, second, third and/or fourth) the electronic device optionally displays the graphical element (e.g., an icon, text, and/or glyph) which notifies the user that a functionality which has been invoked, and/or used in the generation of displayed visual information. In some embodiments, the graphical element is animated. The graphical element is optionally displayed when the AI generative functionalities are invoked, during the generation of the visual information, and/or upon display of the visual information generated by the one or more AI processes. By using a common graphical element as the first visual characteristic which is shared across multiple AI generative functionalities, the electronic device provides the user a visual cue indicating that the displayed visual information has been generated using one or more AI processes.

In some embodiments the electronic device displays the first visual effect (such as visual effect 1308 as illustrated in FIG. 13A-13B and/or 25A-25E), which includes displaying the first visual effect with a first animated visual effect. In some embodiments the electronic device displays the second visual effect (such as animation 1320 as illustrated in FIGS. 13F and/or 25K) which includes displaying the second visual effect with a second animated visual effect. In some embodiments, the first visual effect which is displayed in accordance with the first functionality includes a first animated visual effect. Additionally or alternatively, the second visual effect optionally includes a second animated visual effect, wherein the second animation is optionally different than the first animation with respect to one or more characteristics, other than the first visual characteristic. For instance, in conjunction with (e.g., upon invocation of, during the generation of content, and/or upon displaying visual information) the first functionality, the electronic device optionally displays a halo which includes an animated aspect or visual appearance simulating an animated aspect to the halo. Additionally or alternatively, in conjunction with the second functionality, the electronic device optionally displays a colorized boundary which progresses upward and/or downward across content (e.g., user generated content input, and/or AI generated content output) which includes an animated aspect or visual appearance simulating an animated aspect to the colorized boundary. The animated visual effect optionally shares one or more characteristics with the animation(s) and/or an animated effect as described in relation to method 1500. The first animated visual effect, and the second animated visual effect optionally include a shared visual characteristic indicating that each of the visual effects correspond to functionalities which generate content using one or more AI processes and/or visual information displayed by the electronic device corresponds to content generated by one or more AI processes. By displaying the first visual information with one or more particular animations (e.g., first animation, and/or second animation) which each correspond to a particular functionality (e.g., first functionality, second functionality, third functionality, and/or fourth functionality) the electronic device provides the user an indication as to which of the particular functionalities have been used to generate the first visual information. Furthermore, the user of an animation increases visibility of the corresponding visual effects (e.g., in contrast to a static visual effect) and/or provides a more pleasant viewing experience to the user.

In some embodiments, the electronic device displays the visual effects with the first visual characteristic which includes displaying the visual effects with an animated change in color such as if visual effect 1308 in FIGS. 13A-13B and/or 25A-25O included an animated change in color. Further example of an animated change in color can be found, for instance, in FIG. 13K-13L with respect to visual effect 1348A in a first state in contrast with visual 1348B in a second state. In some embodiments the first visual characteristic is an animated change in color wherein the color as applied in the one or more visual effects (e.g., first visual effect, and/or second visual effect) includes the animated change in color which is displayed in accordance with the corresponding visual effect. For instance, when the first visual effect is displayed, the electronic device optionally displays a halo which includes the animated change in color. Additionally or alternatively, when the second visual effect is displayed, the electronic device optionally displays the first respective animation (e.g., in a first direction) and second respective animation (e.g., in a second direction) where the respective animations include the animated change in color. The animated change in color optionally includes a color change sequence and/or a range of colors which are used in a randomized manner. In some embodiments the first visual characteristic includes a manner (e.g., random, pseudorandom, pattern, and/or spatial variation of color) of animating the change in color, such that the manner of animating the change in color is similar and/or identical across multiple visual effects (e.g., first visual effect, and/or second visual effect) while the colors used in conjunction with the first functionality and the second functionality optionally differ. Additionally or alternatively, in some embodiments the first visual characteristic includes a similar manner of animating the change in color, and a similar color palette, while the order of colors used and/or the shape of the multiple visual effects differs. By using a similar or identical color change sequence and/or manner of animation as the first visual characteristic, the electronic device provides a notification to the user of the electronic device that the information displayed (e.g., first visual information, and/or second visual information) has been generated using one or more AI processes.

In some embodiments the electronic device displays the animated change in color which includes displaying the animated change in color with an animated change through a first range of colors such as if visual effect 1308 included an animated change in color with an animated change through a range of colors, such as in in FIG. 13K-13L with respect to visual effect 1348A in a first state in contrast with visual 1348B in a second state such as if the colors used were animated with an animated change through a first range of colors. In some embodiments the animated change in colors includes an animated change through a first range of colors (e.g., orange, red, purple, and/or blue). In some embodiments one or more colors included in the first range of colors are selected from one or more colors of the visible light spectrum, or as defined by one or more color models (e.g., RGB, and/or CMYK). In some embodiments the animated change through the first range of colors includes one or more gradients between different pairs of colors (e.g., from the first range of colors). Accordingly, the change of colors is optionally gradual, and/or instant (e.g., without gradient). While the first visual characteristic includes a similar or identical animated change through a predetermined range of colors (e.g., first range of colors), the animation of the first visual effect optionally differs from the animation of the second visual effect. For instance, the first visual effect optionally includes the animated change through the first range of colors in a first order, and the second visual effect optionally includes the animated change through the first range of colors in a second order. Additionally or alternatively, the electronic device optionally displays visual information using a second range of colors (e.g., an animated change through a second range of colors), different from the first range of colors, to indicate that displayed visual information corresponds to content generated by one or more non-AI processes (e.g., existing dataset, and/or existing encyclopedic reference). By using an animated change through a first range of colors the electronic device provides an identifiable animated change indicating that one or more AI processes have been used to generate the content on which the displayed visual information corresponds to.

In some embodiments, while displaying the first user interface (e.g., first user interface 1314 as illustrated in FIGS. 13B and/or 25A-25O), and in response to detecting the first event, in accordance with the determination that the first event corresponds to the first functionality that outputs content using the first AI process, the electronic device animates (e.g., animation 1316 as illustrated in FIGS. 13B and/or 25A-25O) the animated change through the first range of colors in a first manner such as if visual effect 1308 illustrated in FIGS. 13B and/or 25A-25O included an animated change through a first range of colors. Further example of an animated change in color can be found, for instance, in FIG. 13K-13L with respect to visual effect 1348A in a first state in contrast with visual 1348B in a second state such as if the colors used were animated with an animated change through a first range of colors. In some embodiments, the animated change through the first range of colors is specific to the functionality and/or AI process with which the electronic device generates (e.g., using an AI process or a generative AI process) the corresponding visual information. For instance, when the first functionality is invoked to generate first visual content through the use of a first AI process, the first visual effect displayed in conjunction with the display of the first visual information, includes the animated change through the first range of colors which is animated in a first manner. The first range of colors optionally includes two or more colors (e.g., hues, tints, tones, and/or shades) which are a subset of an available range of colors. For instance, the first manner in which the animated change through the first range of colors optionally includes displaying the animated change through the first range of colors in a random or pseudorandom manner (e.g., the colors change over time in a random, and/or pseudorandom manner). Additionally or alternatively, the first manner optionally includes displaying the animated change through the first range of colors with a first preset pattern.

In some embodiments, in accordance with the determination that the first event corresponds to the second functionality that outputs content using the second AI process, the electronic device animates (e.g., animation 1320 as illustrated in FIGS. 13F and/or 25K) the animated changed through the first range of colors in a second manner, which is optionally different from the first manner. In some embodiments, when the second functionality is invoked to generate second visual content through the use of a second AI process, the second visual effect displayed in conjunction with the display of the second first visual information, includes the animated change through the first range of colors which is animated in a second manner, which is different than the first manner. For instance, the second manner in which the animated change through the first range of colors optionally includes displaying the animated change through the first range of colors in a random or pseudorandom manner, when the first manner includes displaying the animated change through the first range of colors with a first preset pattern. Additionally or alternatively, the second manner optionally includes displaying the animated change through the first range of colors with a second preset pattern, when the first manner includes the animated change through the first range of colors with a first present pattern. Additionally or alternatively, in some embodiments when the first visual effect includes animating the animated change with a first algorithm in the first manner (e.g., random, pseudorandom, and/or pattern), the second visual effect animates the animated change in the first manner, with a second algorithm which differs from the first algorithm. For instance, the first visual effect optionally includes animating the animated change in a random manner through the use of the first algorithm, while the second visual effect also includes animating the animated change in a random manner through the use of a second algorithm. In some embodiments the manner of animation as related to the first visual effect and the second visual effect corresponds to the order in which the first range of colors are displayed. For instance, the first visual effect optionally includes an animated change through the first range of colors in a first order, and the second visual effect optionally includes an animated change through the first range of colors in a second order, which is different than the first order. Additionally or alternatively, in some embodiments the manner of animation as related to the first visual effect and the second visual effect corresponds to the duration which each of the colors of the first range of colors is displayed in relation to the first visual effect and/or the second visual effect. For instance, the first visual effect optionally includes displaying each color of the first range of colors for a first duration, and the second visual effect optionally includes displaying each color of the first range of colors for a second duration, different than the second duration. A duration, as related to the duration of displaying one or more colors of the first range of colors optionally include: 0.05 s, 0.1 s, 0.5 s, 1 s, and/or greater than 1 s. By displaying the first visual information with an animated change through the first range of colors which is animated in the first manner, and displaying the second visual information with an animated change through the first range of colors which is animated in the second manner, different than the first manner, the electronic device provides the user a visual indication as to which of the particular functionalities have been used to generate the first visual information.

In some embodiments, while displaying the first user interface (e.g., 1314 as illustrated in FIG. 13B and/or 25A-25O), and in response to detecting the first event, in accordance with the determination that the first event corresponds to the first functionality that outputs content using the first AI process, the electronic device 1300 animates the animated change through a first subset of the first range of colors such as if the visual effect 1308 in FIG. 13 animated through a subset of a range of colors. Further example of an animated change in color can be found, for instance, in FIG. 13K-13L with respect to visual effect 1348A in a first state in contrast with visual 1348B in a second state such as if the colors used were animated with an animated change through a first a subset of the first range of colors. In some embodiments, when the first functionality is invoked to generate first visual content through the use of a first AI process, the first visual effect displayed in conjunction with the display of the first visual information, includes the animated change through a first subset of the first range of colors. For instance, when the first range of colors includes red, orange, yellow, green, blue, indigo, and violet, the first subset of the first range of colors optionally includes red, orange, yellow, and green.

In some embodiments, in accordance with the determination that the first event corresponds to the second functionality that outputs content using the second AI process, the electronic device 1300 animates the animated change through a second subset of the first range of colors, which is optionally different than the first subset of the first range of colors such as if the visual effect 1308 in FIG. 13 animated through a different subset of a range of colors. Further example of an animated change in color can be found, for instance, in FIG. 13R-13S with respect to visual effect 1370 such as if the colors used were animated with an animated change through second subset of the first range of colors. In some embodiments, when the second functionality is invoked to generate second visual content through the use of a second AI process, the second visual effect displayed in conjunction with the display of the second visual information, includes the animated change through a second subset of the first range of colors. For instance, when the first range of colors includes red, orange, yellow, green, blue, indigo, and violet, the second subset of the first range of colors optionally includes green, blue, indigo, and violet. The second subset of the first range of colors is optionally different than the first subset of the first range of colors. In some embodiments the first subset of the first range of colors and the second subset of the first range of colors are different while overlapping, for instance, the examples provided include an overlapping color (e.g., green). However, the first subset and the second subset of the first range of colors are optionally coinciding (e.g., share one or more colors), and/or optionally unique (e.g., no shared colors between the first subset and the second subset). By displaying the first visual information with an animated change through the first subset of the first range of colors, and displaying the second visual information with an animated change through the second subset of the first range of colors, different than the first subset, the electronic device provides the user a visual indication (e.g., first subset in contrast with the second subset) as to which of the particular functionalities have been used to generate the first visual information.

In some embodiments, the electronic device 1300 displays the visual effects with the first visual characteristic, which includes displaying the visual effects with an animation of a spatially varying color pattern such as if visual effect 1308 in FIG. 13 was animated using a spatially varying color pattern. Further example of a spatially varying color pattern can be found for instance as related to layer 1354A at a first time as illustrated in FIG. 13M, and layer 1354B at a second time as illustrated in FIG. 13N. In some embodiments the first visual characteristic includes an animation of a spatially varying color pattern. A spatially varying color pattern optionally includes one or more colors which are displayed simultaneously and/or concurrently on the first user interface wherein the area, volume, and/or location of the one or more colors changes (e.g., shifts in location, morphs in shape and/or size, changes in color, changes hue, changes in brightness, changes in intensity, and/or transitions from a first color to a second color) over time. The spatially varying color pattern optionally includes one or more colors which are predetermined and/or randomly selected. In some embodiments the first visual characteristic includes a virtual layer with spatially varying color patterns located behind the first user interface wherein one or more masks are used to generate visual effects (e.g., the first visual effect, and/or the second visual effect) which are attributed to the use of a particular functionality (e.g., the first functionality, and/or the second functionality). By using first visual characteristic which includes a spatially varying color pattern, the electronic device provides a visual cue which indicates to the user that the generated content corresponding to the visual information (e.g., first visual information, and/or second visual information) displayed through the first user interface includes information generated by one or more AI processes.

In some embodiments the electronic device 1300 displays visual effects with the first visual characteristic, which includes displaying the visual effects with a glowing effect that extends from a boundary) associated with the first user interface, and gradually fades according to a non-linear manner as a distance from the boundary associated with the first user interface increases such as if visual effect 1308 extending from a boundary 1306 in FIGS. 13A and/or 25D-25E and was a glowing effect that faded as the distance from the boundary increased. In some embodiments, the first visual characteristic includes an animation which simulates and/or provides a representation of a glowing effect. The glowing effect optionally includes modulating one or more aspects (e.g., color, hue, and/or brightness) of the visual characteristic to simulate one or more portions of a visual effect (e.g., first visual effect, and/or second visual effect) as glowing. The glowing effect optionally includes the first visual effect originating from the boundary of the first user interface having a first level of intensity at the boundary, and a second level of intensity located radially outward from the boundary. In some embodiments the boundary corresponds to a physical boundary (e.g., display boundary), while additionally or alternatively, the boundary corresponds to a boundary of visual information (e.g., first visual information, and/or second visual information) which is displayed via a user interface element on the user interface. In some embodiments the first level of intensity is greater than the second level of intensity. Additionally or alternatively, in some embodiments the second level of intensity is greater than the first level of intensity. Furthermore, in some embodiments the first visual characteristic extends inward from the first boundary of the first user interface. The transition from the first level of intensity at the boundary of the first user interface to the second level of intensity at a first distance (e.g., 1 pixel, 10 pixels, 50 pixels, 100 pixels, or more than 100 pixels) from the boundary of first user interface, optionally occurs linearly and/or non-linearly (e.g., exponentially, logarithmically, and/or according to a non-linear algorithm). For instance, when the first visual information is displayed on the first user interface, halo effect corresponding to the first visual effect is displayed which extends outward from the boundary of the first user interface. The halo effect optionally exhibits a maximum color intensity (e.g., white) at the boundary of the first user interface. As the halo extends outward from the boundary of the first user interface, the color optionally transitions and/or modulates to visible color(s) (e.g., orange, red, purple, and/or blue). Additionally or alternatively, the intensity reduces to a minimum color intensity (e.g., black, and/or non-visible) at a distance of 50 pixels from the boundary of the user interface in accordance with an algorithm, wherein the intensity reduces from the maximum intensity to the minimum intensity in accordance with an exponentially decaying algorithmic model. In some embodiments, the distance at which the second level of intensity is exhibited varies in accordance with a repeating animated pattern, a randomized pattern, and/or a pseudorandomized pattern. In some embodiments the intensity of the halo optionally reduces to a minimum intensity in a direction extending outward from the boundary of the user interface (e.g., from the user interface boundary toward a display edge). Additionally or alternatively, the manner in which the intensity of the halo reduces to a minimum intensity optionally occurs in a direction extending inward from the boundary of the user interface (e.g., from the user interface boundary away from a display edge). By providing a glowing effect with a visual effect (e.g., first visual effect) wherein the glowing effect fades as the visual extends away from the boundary of the first user interface, electronic device provides a visual cue to the user that one or more functionalities (e.g., first functionality) has been used to generate the displayed visual information.

In some embodiments, while displaying the first user interface, and in response to detecting the first event corresponding to the first functionality, the electronic device 1300 displays the first visual effect (e.g., first visual effect 1308) with a first spatial parameter at a first time. In some embodiments, the electronic device displays the first visual effect with a second spatial parameter, which is different from the first spatial parameter, at a second time, which is different from the first time such as displaying visual effect 1308 in FIGS. 13B and/or 25A-25O with a varying spatial parameter over time. Further example can be seen, for instance, with respect to the size of visual effect 1348A at a first time 1349A as illustrated in FIG. 13K, as compared to visual effect 1348B at a second time 1349B as illustrated in FIG. 13L. In some embodiments, when the electronic device detects a first event including an input from the user corresponding to the first functionality, the electronic device displays the first visual information with the first visual effect. The first visual effect optionally includes a first animated effect including one or more changes in one or more spatial parameters (e.g., size, shape, and/or location) which simulates movement of the first visual effect. Accordingly, when displaying the first visual information, the first animated effect optionally exhibits first spatial parameters at a first time and exhibits second spatial parameters at a second time wherein one or more of second spatial parameters differ from the first spatial parameters. In some embodiments, a second animated effect, corresponding to the second functionality, shares one or more characteristics with the first animated effect as described herein. For instance, when the first visual information is displayed on the first user interface, the first visual effect optionally includes a halo effect which changes with regard to one or more spatial parameters (e.g., size, shape, and/or location), providing a dynamic visual effect over time. As time passes, the dynamic visual effect of the first visual effect optionally changes in size, shape, intensity, brightness, color, and/or location. For instance, when the first visual effect is displayed (e.g., a colorized halo) in response to the invocation of first functionality the colorized halo is displayed with a first spatial parameter (e.g., extending inward from an outer boundary of a user interface), and with an animation rotating in a first direction (e.g., clockwise). When the first visual information, corresponding to content generated by the first functionality, is displayed via a user interface element, the colorized halo is displayed with a second spatial parameter (e.g., extending outward from the outer boundary of the user interface element outward toward the outer boundary of the user interface), and with the animation rotating in a second direction (e.g., counter clockwise), different from the first direction. Additionally or alternatively, when the second visual information is displayed on the first user interface, the second visual effect optionally changes with regard to one or more spatial parameters (e.g., size, shape, and/or location), providing a dynamic visual effect over time. The dynamic visual effect of the first visual effect and the dynamic visual effect of the second visual effect are optionally the same, different in relation to one or more characteristics, and/or the same in relation to one or more characteristics. By including a dynamic effect (e.g., first animated effect, and/or second animated effect) which varies in spatial parameters when displaying the visual information (e.g., first visual information, and/or second visual information), the electronic device provides a visual cue to the user that indicates one or more functionalities (e.g., first functionality, and/or second functionality) have been used to generate content corresponding to the displayed visual information.

In some embodiments, while displaying the first user interface, and in response to detecting the first event, the electronic device 1300 displays the first visual effect 1308 with a first visual intensity at a first time and in some embodiments the electronic device displays the first visual effect with a second visual intensity, which is different from the first visual intensity, at a second time, which is different from the first time. Further example can be seen, for instance, with respect to the intensity 1352 of visual effect 1348A at first time 1349A as shown in FIG. 13K, as compared with the intensity 1352 of visual effect 1348B at first time 1349B as shown in FIG. 13L. In some embodiments, when the electronic device detects a first event corresponding to the first functionality, the electronic device displays the first visual information with the first visual effect. The first visual effect optionally includes a first animated effect including one or more changes to visual intensity (e.g., brightness, color saturation, hue, and/or contrast) over time. Accordingly, when displaying the first visual information, the first animated effect optionally exhibits a first visual intensity at a first time, and exhibits a second visual intensity at a second time, wherein the second visual intensity differs from the first visual intensity. In some embodiments, the visual intensity (e.g., first visual intensity, and/or second visual intensity) shares one or more characteristics with the visual intensity as described with respect to method 1500. In some embodiments, when the electronic device detects a first event corresponding to the second functionality, the electronic device displays the second visual information with the second visual effect The second visual effect optionally includes a second animated effect including one or more changes to visual intensity (e.g., brightness, color saturation, hue, and/or contrast) over time. Changes in visual intensity as related to the second visual effect optionally share one or more characteristics with the changes in visual intensity with respect to the first visual effect described herein. By including an animated effect (e.g., first animated effect, and/or second animated effect) when displaying visual information (e.g., first visual information, and/or second visual information) with a visual effect, the electronic device provides a visual cue to the user that one or more functionalities (e.g., first functionality, and/or second functionality) have been used to generate content which the displayed visual information corresponds to.

In some embodiments, first visual effect at least temporarily includes displaying the first visual content (such as visual content 1315 in FIGS. 13B 25M-25O, and/or 25A-25C) with High Dynamic Range (HDR) luminance that is greater than a standard range of luminance that is available to display content in the first user interface. In some embodiments, displaying visual information (e.g., first visual information, and/or second visual information) with HDR luminance shares one or more characteristics with displaying with HDR luminance and/or HDR effects described with respect to method 1500. In some embodiments, displaying with HDR luminance refers to displaying content in a manner in which the visual intensity of the content (e.g., brightness) is greater than a brightness of non-HDR content such as Standard Dynamic Range (SDR) content. For instance, while a range of brightness for SDR luminance is in the range of 100-300 nits, HDR luminance has a peak brightness of up to 10,000 nits. Thus, in some embodiments, the brightness (e.g., visual intensity) associated with HDR luminance will have peak brightness that is greater than the standard range of brightness for user interfaces that generally display SDR content. In some embodiments, the visual effects displayed when generated content that is based on an AI process (e.g., with the HDR luminance) are not displayed for other content (that is not generated using an AI process), and the other content is displayed with SDR effects as described herein. In some embodiments, the content generated by the one or more AI processes is displayed in and/or limited to SDR after the visual effect terminates (e.g., the first and/or second visual effect). In some embodiments, the second visual effect also at least temporarily includes displaying second visual information with HDR luminance in a manner similar to the first visual effect. By including an animated effect (e.g., first animated effect, and/or second animated effect) that includes displaying visual information with HDR luminance, the electronic device provides a visual cue to the user that an AI process has been used to generate the displayed visual information, and thereby minimizing inputs to the electronic device that would otherwise be needed due to correcting errors associated with misclassifying content as not being generated by an AI process, and thereby preserving computing resources associated with the additional inputs.

In some embodiments, the first user interface (such as user interface 1314 in FIGS. 13B and/or 25A-25F) includes a plurality of user interface elements. In some embodiments. in response to the first event, and in accordance with the determination that the first event corresponds to the first functionality, the electronic device displays the first visual effect (such as visual effect 1308), which includes displaying a first user interface element of the first user interface with the first visual effect. In some embodiments the first visual effect includes displaying the first user interface element with a common animated layer (such as layer 1354A-1354B as shown in FIG. 13M-13N), which varies spatially over time. In some embodiments, in response to detecting a second event, different from the first event, and in accordance with a determination that the second event corresponds to a second functionally that outputs content generated using a third AI process, the electronic device displays a second user interface element of the first user interface (such as user interface 1314) with a third visual effect (such as visual effect 1360A as shown in FIG. 13M), wherein the third visual effect includes displaying the second user interface element with the common animated layer, and wherein the common animated layer varies spatially over time. In some embodiments, the first visual effect includes displaying the first user interface element over (e.g., imposed on) an animated layer that can be commonly used by multiple user interface elements (e.g., the second user interface element). In some embodiments, the first user interface element is displayed on the common animated layer such that the first user interface element exposes (at least partially) the common animated layer, such that at the user interface elements, the animated layer is visible to the user of the electronic device, while other portions of the first user interface cover/obscure the common animated layer such that they are not visible to the user through the first user interface. In some embodiments each functionality (e.g., first functionality, second functionality, third functionality, and/or fourth functionality) is configured to expose a portion of the layer in a manner which is unique to the functionality. For instance, the common animated layer is optionally exposed in the form of: a halo, a wave-like form that traverses vertically across visual information being processed and/or displayed, a wave-like form that traverses horizontally across visual information being processed and/or displayed surrounding, radially growing or retracting in relation to visual information being processed and/or displayed surrounding, and/or a combination thereof. In some embodiments, the common animated layer varies spatially over time. For instance, the animated layer includes a plurality of color regions that vary in brightness, color, shape, tint, and other visual characteristics over time such that the animated layer appears to be an animated layer of colors that are moving across the layer over time. By including an animated layer (e.g., first animated effect, and/or second animated effect) that includes an animated layer, the electronic device provides a visual cue to the user that an AI process has been used to generate the displayed visual information, and thereby minimizing inputs to the electronic device that would otherwise be needed due to correcting errors associated with misclassifying content as not being generated by an AI process, and thereby preserving computing resources associated with the additional inputs.

In some embodiments, as illustrated in FIGS. 13B and/or 25A-25O for instance, displaying first visual information (such as visual information 1315) corresponding to the first event in the first user interface (such as user interface 1314) with the first visual effect includes, while displaying the first user interface, and while displaying the first visual effect 1308 in response to detecting the first event, when the electronic device 1300 receives a first user input at the first user interface, the electronic device 1300 modifies one or more aspects of the first visual effect (such as visual effect 1308). In some embodiments, the first visual effect is based on, or is modified according to a user input (e.g., audio input, text input, and/or a touch input). In some embodiments, the aspects of the first visual effect that are modified in response to a user input include but are not limited to, a color, brightness, an animation, a speed, and/or other visual characteristic associated with the visual effect. As an example, in the case of a speech-based modification, when the computer system detects a first event corresponding to initiation of a generative functionality that requests a speech-based input, the computer system displays the first visual effect, and when the user provides a speech based input, the first visual effect is optionally modified and/or modulated based on as aspect of the speech input such as the magnitude and/or frequency of the speech input. In some embodiments, the second visual effect is similarly based on, or is modified according to user input. In some embodiments, the visual effect (e.g., first visual effect, and/or second visual effect) corresponds to the location in which the first user input corresponding to the first event is detected. The location optionally corresponds to the location of a user input (e.g., at a location of a touch input, air gesture, voice input, and/or mouse input) and/or based on a location of an input device that detected the input (e.g., a location of a microphone for an audio input, a location of a button for a button press input, and/or a location of a rotatable input mechanism for a rotation input). Accordingly, when the visual effect corresponds to the location in which the first user input is detected, the visual effects (e.g., first visual effect, and/or second visual effect) are modified in a manner which corresponds to the location and/or source of the first user input. By modifying an aspect of the visual effect in response to user input, the electronic device provides a visual cue to the user that an AI process has received a user input, thereby minimizing inputs to the electronic device that would otherwise be needed due to correcting errors associated with misclassifying inputs as not being received by an AI process, and thereby preserving computing resources associated with the additional inputs.

In some embodiments, as illustrated in FIGS. 13A-B and/or 25G-25L, displaying first visual information (such as visual information 1315) includes the electronic device 1300 applying the first visual effect (such as visual effect 1308) to content generated based on the first functionality. In some embodiments, displaying second visual information (e.g., text 1318 shown in FIGS. 13F and/or 25G-25L) includes the electronic device 1300 applying the second visual effect (e.g., animation 1320) to content generated based on the second functionality. In some embodiments, the first effect is applied to the content displayed on the first user interface when the content was generated based on the first functionality, and similarly the second effect is applied to the content displayed on the first user interface when the first user interface displays content generated based on the second functionality. The first visual effect and the second visual effect share one or more characteristics with the first visual effect and second visual effect described herein. In some embodiments, content generated by the first functionality and the second functionality, include but is not limited to textual, graphical, and/or video content. In some embodiments, when the first functionality is used to generate first visual information, the electronic device displays the first visual effect which optionally corresponds to an animated halo around the first visual information. Additionally or alternatively, when the second functionality is used to generate second visual information, the electronic device optionally displays the second visual effect, which optionally corresponds to a wave-like form that traverses vertically across visual information being processed and/or displayed. Additionally or alternatively, visual information (e.g., first visual information, and/or second visual information) which is generated based on the same user input but using different functionalities (e.g., first functionality, and/or second functionality), the electronic device displays the resulting visual information with the visual effect (e.g., first visual effect, and/or second visual effect) corresponding to the respective functionality. By applying a visual effect to content that is generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, performing the first functionality includes the electronic device 1300 displaying a status indicator associated with a virtual assistant, such as visual effect 1356A as shown in FIGS. 13O and/or 25C-25E. In some embodiments, a virtual assistant refers to an application that is executed on the electronic device that can perform a wide variety of tasks for a user including but not limited to searching tasks, generating textual and/or visual content, and/or generating calendar appointments. In some embodiments, the virtual assistant communicates with the user using textual and/or audio cues. In some embodiments, the virtual assistant accepts inputs from the user in the form of voice inputs and/or text inputs that are entered on the one or more input devices. In some embodiments, the status indicator (e.g., a glowing border) corresponds to the electronic device awaiting and/or requesting an input, such as an audible prompts from the user (e.g., spoken word). In some embodiments, the status indicator (e.g., a glowing border) indicates that the virtual assistant has generated content based on the input provided by the user, and further indicates that the virtual assistant has generated the content using an AI process. In some embodiments, the status indicator includes the first visual effect. By applying a visual effect to content that is generated by a functionality that involves an AI process such as a status indicator for a virtual assistant, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, performing the first functionality includes the electronic device 1300 displaying a response generated by a virtual assistant. In some embodiments, the virtual assistant shares one or more characteristics with the virtual assistants described with respect to methods 700, 800, 1000, and/or 1200. In some embodiments, the response generated by the virtual assistant is displayed on a user interface (e.g., text and/or images). In some embodiments, the user interface that includes the response generated by the virtual assistant includes one or more selectable options that are configured to facilitate interaction with the response by the user. In some embodiments, selectable options share one or more characteristics with the selectable options described with respect to methods 700, 800, 1000, and/or 1200. By applying a visual effect to content that is generated by a functionality that involves an AI process such as a response generated by a virtual assistant, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, the first functionality includes the electronic device 1300 displaying an input region on the first user interface (such as if an input region were displayed on user interface 1304 in FIGS. 13A and/or FIGS. 25D-25F) for accepting one or more inputs to specify parameters for generation of content using an AI process (e.g., the first AI process). In some embodiments, the input region includes a text field, a keyboard, and/or one or more selectable options displayed on the user interface, that facilitate the user modifying content generated by the AI process (e.g., in response to user input directed to the input region). For example, the user using a keyboard input region is able to modify text that was generated by an AI process. The keyboard input region has the first visual effect applied to it by the electronic device indicating to the user that the user by interacting with the keyboard input region is modifying content generated by an AI process. In some embodiments, the input region shares one or more characteristics with the input region(s) described with respect to method 700. By applying a visual effect to an input region to modify content generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, performing the first functionality includes the electronic device 1300 displaying a block of text that was impacted by the first AI process (such as text 1338 in FIGS. 13D, 25A-25C, and/or 25K) (e.g., generated, modified, summarized, edited, and/or analyzed using the first AI process). In some embodiments, the block of text includes the entirety of a textual passage, a portion of a textual passage, and or one or more words within a textual passage that have been generated using an AI process. In some embodiments, the text is generated by the AI process in various contexts for instance when the AI process is summarizing a textual passage, and/or when the AI process has generated edited text. In some embodiments, the block of text is analyzed using the first AI process, when the block of text is used at part of an input to the first AI process, and thus the content generated by the first AI process is based on the block of text. For instance in the case of summarization, the input text (e.g., the text to be summarized) has the first visual effect applied to it. By applying a visual effect to a block of text generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, the block of text includes a first portion and a second portion. In some embodiments, displaying first visual information (such as first information 1315 illustrated in FIGS. 13B 25K, and/or 25A-25C) corresponding to the first event in the first user interface with the first visual effect includes the electronic device 1300 displaying the first portion of the block of text with the first visual effect (such as visual effect 1308), and the electronic device 1300 displaying the second portion of the block of text without the first visual effect. In some embodiments, the electronic device displays the first visual effect only to the text that has been generated and/or analyzed using the AI process. Thus, in some embodiments, in a given passage of text, only the words, and/or sentences that have been generated and/or analyzed using an AI process have the first visual effect applied to them, while words and/or sentences that were not generated and/or analyzed using an AI process do not have the first visual effect applied to them. By applying a visual effect only to text that has been generated by a functionality that involves an AI process and not applying the visual effect to text that has not been generated by a functionality that involves the AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, the block of text is included by the electronic device 1300 in a notification. In some embodiments, the block of text includes summarized text such as the summarized text 1321 in FIGS. 13E and/or 25A-25B. In some embodiments, the summarized text is generated by the first AI process. In some embodiments, the first AI process inputs a larger textual passage (e.g., an email and/or document) and provides a summary of the passage on the first user interface. In some examples, the text that includes the summary of the larger textual passage is displayed on the first user interface with the first visual effect so as to indicate to the user that the content of the summarized text was generated using the first AI process. By applying a visual effect to textual summaries generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, performing the first functionality includes the electronic device 1300 displaying visual media content generated by the first AI process (e.g., generative visual media, as described with reference to methods 700, 800, 1000, and/or 1200). In some embodiment, the visual media content (e.g., graphical and/or video content) includes visual media that has been generated by an AI process, visual media that has been modified using an AI process, and/or visual media that has had one or more visual characteristics that has been modified using an AI process. In some embodiments, applying a visual effect to the visual media includes applying a visual effect to the visual media itself and/or applying a visual media to a user interface (or a portion thereof) that the visual media is displayed on. For instance, applying the visual effect to the visual media includes applying the visual effect to one or more portions of the first user interface that does not includes the visual media itself (e.g., an edge region of the first user interface). In some embodiments, the visual effect is displayed surrounding the visual media and/or overlaying at least a portion of the visual media. By applying a visual effect to visual media generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments performing first functionality includes the electronic device 1300 displaying an element of a visual media content (e.g., AI-generated or not AI-generated) that is removeable. In some embodiments, a visual media content item includes one or more elements that were generated using an AI process (e.g., by a generative infill functionality). In some embodiments, an element of the visual media content that was generated using an AI process is also removeable (e.g., the media content is returned to the state it was in before the element was added into the media content by the AI process). Thus, the electronic device displays the first visual effect to items in an image (e.g., elements of a visual media content) that were generated by an AI, so that the user can readily identify which portions of an image were generated by an AI process. In some embodiments, the visual effect can additionally or alternatively be applied to items in an image (e.g., non-AI generated, or AI generated) that can be removed using an AI process and infilled with an AI process item. When an AI generative functionality (e.g., first functionality, and/or second functionality) is used to generate an image with multiple elements (e.g., a dog surfing in space), some elements (e.g., the dog, and/or the surfboard) are optionally removeable and/or replaceable by the user and/or the electronic device, wherein when the elements are removed, the AI generative functionality optionally infills the areas of the images that were previously obscured by the removed element. In some embodiments, the element of the visual media that is removeable shares one or more characteristics with the generative visual media described with respect to methods 700, 800, 1000, 1200, 1500, 1700, 1900, 2100, and/or 2300. By applying a visual effect to visual media generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, performing the first functionality includes the electronic device 1300 displaying one or more animated media items as part of a visual media content. In some embodiments, a visual content item includes one or more animated media items that are generated by an AI process and displayed as part of the visual content item. For instance, in response to a user query requesting an animated media item (e.g., an animated animal, and/or vehicle) be added to a visual content, the electronic device uses an AI process to generate the animated media item, and when displaying the animated media item as part of the visual content, applies the first visual effect to the animated media item, thereby indicating to the user that the animated media item was generated using an AI process. In some embodiments, the one or more animated media items are displayed concurrently or consecutively (e.g., like a presentation). In some embodiments, the one or more animated media items correspond to a sequence of media items (e.g., images, videos, or the like, and/or whether or not AI-generated) displayed consecutively, and the sequence, selection of, and the presentation of the media items is generated by the AI process. By applying a visual effect to animated media items generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments, performing the first functionality includes the electronic device 1300 displaying an indication of one or more search results which are generated using the first AI process in response to a search query. In some embodiments, the one or more search results include search results that are generated using an AI process. In some embodiments, the visual effect is applied to the displayed search results to indicate that the search results were generated using an AI process. In some embodiments, the search results are generated in result to a search query using the virtual assistant described herein. By applying a visual effect to search results generated by a functionality that involves an AI process, the electronic device provides a visual cue to the user that an AI process has generated the content, thereby minimizing inputs to the electronic device that would otherwise be needed due to correcting errors associated with misclassifying inputs as not being generated by an AI process, and thereby preserving computing resources associated with the additional inputs.

In some embodiments the first AI process is a generative AI process. In some embodiments, a generative AI process includes AI process that generates textual and/or visual content as an output and in response to an input provided by a user of the electronic device and/or training data. In some embodiments, the second AI process described herein is alternatively and or additionally a generative AI process. Generative AI processes are described more with reference to methods 700, 800, 1000, 1200, 1500, 1700, 1900, 2100, and/or 2300. By applying a generative AI process to generate content, the electronic device automates processes that would otherwise have to be manually performed by a user of the electronic device using one or more inputs provided to the electronic device, thereby minimizing inputs to the electronic device that would otherwise be needed to generate the content, and thereby preserving computing resources associated with the additional inputs.

In some embodiments, the first event is detected while the electronic device displays a first user interface corresponding to a first software application, such as user interface 1304 as shown in FIGS. 13E1 and/or 25K. In some embodiments, while displaying a second user interface, different from the first user interface, corresponding to a second software application that is different from the first software application, such as user interface 1304 as shown in FIG. 13S, the electronic device detects a second event, different from the first event, such as an event including input 1374 as shown in FIG. 13S. In some embodiments, in response to detecting the second event, and in accordance with a determination that the second event corresponds to the first functionality that outputs content generated using the first artificial intelligence (AI) model, the electronic device displays the first visual information corresponding to the second event in the first user interface with the first visual effect, wherein the first visual effect includes the first visual characteristic, such as the visual information corresponding to visual effect 1370 as shown in FIG. 13S. In some embodiments, in response to detecting the second event, and in accordance with a determination that the second event corresponds to the second functionality, different from the first functionality, that outputs content generated using the second AI model, the computer system displays the second visual information corresponding to the first event in the first user interface with the second visual effect, different from the first visual effect, wherein the second visual effect includes the first visual characteristic, such as visual effect 1387 as shown in FIGS. 13W and/or 25M-25N.

It should be understood that the particular order in which the operations in FIG. 14 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1500, 1700, 1900, 2100, 2300, and/or 2700) are also applicable in an analogous manner to method 1400 described above with respect to FIG. 14. For example, the operation of displaying portion(s) of a user interface with HDR luminance described above with reference to method 1400 optionally has one or more of the characteristics of, displaying a representation of a prompt and one or more recognized concepts, editing one or more parameters, including one or more recognized concepts, of a previously generated automatically-generated visual content, the addition of a representation of automatically-generated visual content into a first application, and constraining template subjects and using a random or pseudorandomly selected template subject as the subject for generating the automatically-generated visual content described herein with reference to other methods described herein (e.g., 700, 800, 1000, 1200, 1500, 1700, 1900, 2100, 2300, and/or 2700). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 14 are, optionally, implemented by components depicted in FIGS. 1A-1B. For example, detecting operation 1404 and displaying operation 1406 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

FIG. 15 illustrates a flow diagram illustrating a method in which an electronic device displays an animation including high dynamic range luminance in accordance with some embodiments of the disclosure. The method 1500 is optionally performed at first electronic device and/or electronic devices such as device 100, device 300, or device 500 as described above with reference to FIGS. 1A-1B, 2-3, 4A-4B and 5A-5H. Some operations in method 1500 are, optionally combined and/or order of some operations is, optionally, changed.

As described below, the method 1500 provides ways in which an electronic device displays an animation including high dynamic range luminance. Displaying an animation in which portions of a user interface are displayed with a degree of luminance that is greater than a standard dynamic range of luminance visually emphasizes that operations associated with of an electronic device are ongoing, and reduces input erroneously interrupting such operations.

In some embodiments, a method 1500 is performed at an electronic device in communication with one or more input devices and a display generation component, such as electronic device 1300 as shown in FIGS. 13C and/or 25K. In some embodiments, the electronic device has one or more characteristics of the electronic device described in methods 700, 800, 1000, 1200, 1400, 1700, 1900, 2100, and/or 2300. In some embodiments, the display generation component has one or more characteristics of the display generation component described in methods 700, 800, 1000, 1200, 1400, 1700, 1900, 2100, and/or 2300. In some embodiments, the one or more input devices has one or more characteristics of the one or more input devices described in methods 700, 800, 1000, 1200, 1400, 1700, 1900, 2100, and/or 2300.

In some embodiments, the electronic device detects (1502), via the one or more input devices, an event, such as selection input 1310 as shown in FIGS. 13C and/or 25K. For example, the event optionally includes one or more inputs including voice input, selection of one or more physical and/or virtual buttons, a sequence of selections of the one or more buttons, text entry (e.g., directed to a physical or virtual keyboard), one or more touch inputs directed to a surface monitored by the electronic device (e.g., a touchscreen, a trackpad, and/or a non-touch sensitive surface that a user of the electronic device touches), and/or one or more air gestures (e.g., an air pinch including contacting of a plurality of fingers of one or more hands of the user, an air pointing of one or more fingers, an air splaying of fingers separating a plurality of fingers, and/or air curling of one or more fingers). In some embodiments, the event does not include an express input requesting performance of an animation indicative of the event (e.g., as described further herein). For example, the electronic device optionally determines and/or receives an indication that content displayed and/or to be displayed via the display generation component satisfies one or more criteria, such as a criterion satisfied when the content is associated with (and/or generated by) one or more machine learning models and/or one or more neural networks, as described further with reference to methods 700, 800, 1000, 1200, 1400, 1700, 1900, 2100, and/or 2300. Additionally (or alternatively), the one or more criteria optionally include a criterion satisfied when the electronic device is generating and/or modifying media, such as text, video, images, spatial data associated with such media, and/or some combination thereof. Additionally criteria and/or conditions that are optionally associated with the event are described further with reference to methods 700, 800, 1000, 1200, 1400, 1700, 1900, 2100, and/or 2300.

In some embodiments, in response to detecting the event (1504) in accordance with a determination that the event is a first type of event, such as event corresponding to selection of selectable option 1342 as shown in FIGS. 13C and/or 25K and/or operations performed in response to the selection, the electronic device displays (1506), via the display generation component, an animation indicative of the event, such as the animation corresponding to indicator 1313 as shown in FIGS. 13D and/or 25K and/or corresponding to indicators 1323 and/or 1325 as shown in FIGS. 13E and/or 25K, wherein the displaying of the animation includes a first portion of the animation that includes displaying a portion of a user interface with a respective luminance that is higher than a standard dynamic range (e.g., SDR) of luminance for the user interface (and/or higher than a standard dynamic range of luminance for the display generation component, the respective luminance sometimes referred to as HDR or high dynamic range luminance), such as portion(s) of user interface 1301 including—but not limited to—where and adjacent to where text 1338 is displayed as shown in FIGS. 13D and/or 25K, wherein the portion of the user interface displayed with the respective luminance that is higher than the standard dynamic range of luminance for the user interface is associated with content that is presented after (and/or in response to) the event, such as text 1338 as shown in FIGS. 13E and/or 25K and/or text 1338 as shown in FIGS. 13F and/or 25K. For example, the electronic device optionally performs the animation(s) described herein without detecting one or more additional inputs and/or events after detecting the event. For example, the electronic device optionally detects that the event is associated with generating and/or modifying media using one or more machine learning models and/or using one or more inputs provided by the user of the electronic device, and in response to detecting the one or more inputs, optionally displays the animation. In some embodiments, the animation includes displaying one or more portions of a user interface displayed via the display generation component with HDR luminance. HDR, as referred to herein, optionally includes using one or more techniques to display content with a luminosity and/or visual contrast that are greater than a standard dynamic range (SDR) luminosity and/or visual contrast. As an example, content displayed with HDR luminance optionally peaks at 500, 750, 1000, 1250, 1400, 1750, 2000, 5000, 7500, and/or 10,000 nits, and content displayed with SDR optionally peaks at 75, 100, 150, 200, 250, and/or 300 nits. The animation, for example, optionally includes concurrently and/or gradually displaying portions of an image and/or text that are being and/or will soon be analyzed by the electronic device (and/or one or more other devices such as one or more servers) with HDR luminance, causing edges of the portion of the image and/or text under evaluation (and/or the portions of the image and/or text) to be displayed with a luminosity that is greater than a peak luminosity of portions of the user interface displayed with SDR. In some embodiments, the content displayed after the event is generated in response to the event, and is partially or entirely not displayed prior to detecting the event. In some embodiments, the electronic device displays the content partially or entirely before detecting the event, and in response to detecting the event, maintains display of the content while displaying the animation and after the animation concludes. Thus, content that is presented after the event includes content that is displayed both before and after the event is detected. It is understood that embodiments herein describe display of the user interface with SDR or HDR, but that comparison is merely one of many possible embodiments. For example, the electronic device optionally displays portion(s) of the user interface with one or more first luminosity values associated with a first peak luminosity value during the animation, and optionally displays the portion(s) of the user interface with one or more second luminosity values associated with a second peak luminosity value after the animation concludes. In some embodiments, the second peak luminosity is less than the first peak luminosity, but is greater than any upper bound described with reference to SDR luminance herein. In some embodiments, content that is described as “being displayed with SDR luminance” means content that is displayed with luminance values that are within the SDR luminance range, while content that is described as “being displayed with HDR luminance” means content that is displayed with luminance values that are outside of (e.g., higher than) the SDR luminance range but still within the HDR luminance range.

In some embodiments, the animation includes displaying one or more portions of an edge bounding some or all of a user interface with the HDR luminance (and/or not displaying content under evaluation with the HDR luminance), such as border 1306 as shown in FIGS. 13A and/or 25D-25E. For example, in response to detecting a voice and/or text input requesting generation and/or modification of content, the electronic device optionally displays a border with one or more colors and/or lighting effects simulating a glowing of one or more portions of the border. In some embodiments, the electronic device animates the changing of the colors (e.g., along a gradient) between one or more colors. In some embodiments, the changing of colors is included in the first portion and/or other portions of the animation. In some embodiments, the changing of colors and/or the border are additionally displayed after the conclusion of the animation (e.g., without HDR luminance). In some embodiments, one or more portions of the color border are masked, and at those masked one or more portions, the electronic device displays a lighting effect with HDR luminance. Accordingly, the masked one or more portions of the border (and/or other portions of the user interface other than the border) are optionally displayed with a HDR luminance, which optionally includes displaying the masked one or more portions with a luminance that exceeds a maximum and/or typical SDR luminance. In some embodiments, the portions of the border displayed with the hot luminance change over the duration of the animation. For example, the size of one or more portions of the mask are optionally and gradually increased and/or decreased over time while displaying the animation, such that the portions of the border displayed with HDR luminance grow and/or shrink over time. Thus, displaying the animation optionally includes a pulsing and/or undulating pattern in which regions of a user interface displayed with the HDR luminance gradually and/or quickly grow and/or shrink over time. The first portion of the animation, therefore, optionally includes displaying one or more first portions of the user interface with HDR luminance. In some embodiments, displaying the first portion of the animation includes displaying one or more portions of the user interface with SDR while other one or more portions are displayed with HDR. For example, one or more portions of the border described herein are optionally displayed with HDR luminance and while other one or more portions of the border are optionally displayed with SDR luminance.

In some embodiments, displaying the animation includes displaying a second portion of the animation, such as a second portion of the animation including, but not limited to, as portions of the animation indicated by indicators 1313, 1323, and/or 1325 as shown in FIGS. 13D-13E and/or 25K. For example, displaying the second portion of the animation optionally includes changing which one or more portions of the border described herein are displayed with SDR or HDR. As an example, a first portion of the border is optionally displayed with HDR during the first portion of the animation, and is optionally displayed with SDR during the second portion of the animation. In some embodiments, the portions of the user interface displayed with HDR during the animation are determined randomly and/or pseudo-randomly. It is understood that embodiments described with reference to an animation displayed alongside particular forms of media and/or with a particular appearance (e.g., portions of an image, text, and/or a border) optionally apply to other embodiments. For example, the masking and/or display of the first and/or second portion of the animation as described with reference to the border herein optionally apply to one or more portions of an image being generated and/or modified by the electronic device.

In some embodiments, in response to detecting the event (1504), after displaying the first portion of the animation and when the animation concludes, such as the user interface 1301 after the animation indicated by indicators 1323, 1325, 1320 as shown in FIGS. 13E-F and/or 25K concludes, the electronic device displays (1508) the portion of the user interface with luminance that is within the standard dynamic range (e.g., is not higher than the standard dynamic range) for the user interface (and/or is within a standard dynamic range of luminance for the display generation component, sometimes referred to as HDR or high dynamic range luminance), such as portion(s) of user interface 1301 including—but not limited to—where and adjacent to where text 1338 is displayed as shown in FIGS. 13E and/or 25K and/or text 1338 is displayed as shown in FIGS. 13F and/or 25K. For example, the electronic device optionally terminates and/or temporarily ceases display of the animation in accordance with a determination that the electronic device and/or one or more devices in communication with the electronic device have provided results that correspond to the event. As an example, the electronic device optionally displays the portion of the user interface that was displayed with HDR luminance during the first portion of the animation with SDR luminance. In some embodiments, the electronic device maintains display of visual content that indicates that the event described herein was detected. For example, the electronic device optionally maintains display of the animated color border with SDR luminance, and optionally forgoes the masking of the border and/or forgoes display of the border with HDR luminance. In some embodiments, displaying the first portion of the animation includes concurrently displaying one or more first portions of the user interface with luminance that is higher than the standard dynamic range, and includes displaying one or more second portions of the user interface with luminance that is included within the standard dynamic range. Displaying the portion of the user interface with HDR luminance during the first portion of the animation indicates that the electronic device has detected the first type of event and/or is performing operations in accordance with the event, thus reducing the likelihood the user provides input erroneously disrupting the operations and/or providing visual feedback of the state of the electronic device to the user, thereby reducing power consumption associated with erroneous interactions with the device.

In some embodiments, displaying the animation includes in accordance with a determination that a result of an operation performed in response to the event corresponds to a first region in the user interface, the portion of the user interface displayed with the respective luminance that is higher than the standard dynamic range of luminance for the user interface corresponds to (e.g., is displayed over) the first region, such as portion(s) of user interface 1301 including—but not limited to—a first region including where and adjacent to where text 1338 is displayed as shown in FIGS. 13D and/or 25K, and/or region 1327 as shown in FIG. 13E1 and/or 25K. For example, the operation optionally includes analyzing, generating, and/or modifying one or more portions of the content. In some embodiments, region(s) of the user interface displayed with the respective luminance during the animation correspond to such one or more portions of the content. For example, the respective luminance is displayed at the first region immediately before a portion of the content generated by the electronic device is displayed at the first region. Additionally (or alternatively), the respective luminance is optionally displayed at a portion of the content that is modified in response to the event, the content optionally displayed before the event was detected.

In some embodiments, displaying the animation includes, in accordance with a determination that the result of the operation corresponds to a second region in the user interface, different from the first region in the user interface, the portion of the user interface displayed with the respective luminance that is higher than the standard dynamic range of luminance for the user interface corresponds to (e.g., is displayed over) the second region in the user interface, such as a region of the user interface including sunset 1334 as shown in FIG. 13I (e.g., in addition to, or in the alternative to a region of the user interface 1301 corresponding to indicator 1330 as shown in FIG. 13H), and/or such as the region corresponding to visual effect 1348B as shown in FIG. 13L. For example, displaying the animation optionally includes changing which one or more portions of the user interface are displayed with the respective luminance. For example, the first and the second regions in the user interface optionally are at least partially overlapping and/or adjacent to one another. In response to detecting the event, and after displaying the first region of the user interface with the respective luminance, the electronic device optionally displays a result of the operation, such as a portion of an image, one or more words, and/or one or more portions of additional or alternative media generated when the operation is performed. In some embodiments, when displaying the animation and when the result of the operation corresponds to the first region of the user interface, the first region of the user interface is optionally displayed with the respective luminance that is higher than the standard dynamic range of luminance while the second region is optionally displayed with the standard dynamic range of luminance. Additionally (or alternatively), when displaying the animation and the result of the operation corresponds to the second region of the user interface, the second region of the user interface is optionally displayed with the respective luminance that is higher than the standard dynamic range of luminance while the first region is optionally displayed with the standard dynamic range of luminance. Displaying the first or second region with the respective luminance indicates where result(s) of the operation are displayed and that the first or second region are related to a specific functionality/operation.

In some embodiments, the first region of the user interface includes text while displaying the animation indicative of the event, such as the region 1344 of user interface 1301 including text 1338 as shown in FIGS. 13C and/or 25K. For example, the first region (and/or the second region) of the user interface optionally includes font-based text and/or a representation of handwritten text, which optionally is displayed before, during, and/or after displaying the animation, and/or before, during, and/or after displaying the first region (and/or the second region) of the user interface with the respective luminance. In some embodiments, the font-based text and/or the representation of the handwritten text is included in and/or corresponds to the content described with reference to method 1500. In some embodiments, the text is displayed in a user interface corresponding to a respective application, such as a note taking application, a text editing application, an e-mail application, an internet browser application, and the like. Displaying the respective luminance at a region of the user interface including and/or that will include text related to an operation of the electronic device indicates that the text is and/or will be analyzed and/or generated by the an specific functionality/operation performed by the electronic device.

In some embodiments, the first region of the user interface includes at least a portion of an image while displaying the animation indicative of the event, such as a region of user interface 1301 including some or all of representation 1324 as shown in FIG. 13G. For example, the first region (and/or the second region) of the user interface optionally includes a portion of a static image, video, a graphic, and/or some combination thereof, which optionally is displayed before, during, and/or after displaying the animation, and/or before, during, and/or after displaying the first region (and/or the second region) of the user interface with the respective luminance. In some embodiments, the portion of the static image, the video, the graphic, and/or some combination thereof are included in and/or correspond to the content described with reference to method 1500. Displaying the respective luminance at a region of the user interface including and/or that will include portions of an image related to an operation of the electronic device indicates that the portions of the image are and/or will be analyzed and/or generated by a specific operation/functionality of the electronic device.

In some embodiments, in response to detecting the event, and in accordance with a determination that the event is a second type of event, different from the first type of event, the electronic device displays, via the display generation component, an animation indicative of the second type of event, wherein displaying the animation indicative of the second type of event includes displaying a portion of the user interface with respective second luminance, different from the respective luminance, that is within the standard dynamic range of luminance for the user interface (and where the animation indicative of the second type of event does not include displaying any portion of the user interface with luminance that is higher than the standard dynamic range of luminance for the user interface), such as displaying animation similar to and/or having one or more characteristics similar to as described with reference to indicator 1313, optionally including display of portions of user interface 1301 with HDR luminance as shown indicated in FIGS. 13D and/or 25K, and/or regions outside of region 1344 as shown in FIGS. 13E and/or 25K. For example, in response to detecting an event (e.g., that is not directed to analyzing, generating, and/or modifying content that is displayed before, in response to, and/or after detecting the event), the electronic device optionally displays an animation that does not include displaying the user interface with HDR luminance. Such an animation optionally includes one or more characteristics similar to or the same as described with reference to other characteristic(s) of animation(s) described herein, but does not include displaying the user interface with HDR luminance. For example, the animation that does include displaying the HDR luminance optionally travels in a similar or same pattern, or is pseudorandomly generated based upon a seed similar to or the same as a seed used to generate a portion of the animation including HDR luminance. Displaying the animation without include HDR luminance indicates that the second type of event was not related to a specific operation/functionality and/or that operations different from those performed in accordance with the first type of event are being performed.

In some embodiments, the first type of event includes an operation associated with an artificial intelligence model, such as an artificial intelligence model that parses, analyzes, summarizes, proofreads, and or edits text 1338 in user interface 1301 as shown in FIGS. 13D and/or 25K. For example, the first type of event optionally includes initiating generation and/or modification of the content described with reference to method 1500 based upon one or artificial intelligence models (e.g., generative artificial intelligence mode and/or machine learning model). For example, the operation optionally includes generating an image, editing an image, generating text, editing text, and/or labelling portions of media using one or more natural language processing models, generative artificial intelligence models, and/or one or more neural networks. In some embodiments, the operation is associated with and/or is one or more operations described with reference to methods 700, 800, 1000, 1200, 1400, 1500, 1700, 1900, and/or 2300. In some embodiments, the operation includes modifying or generating such content in response to detecting a selectable option and/or voice input initiating such an operation. In some embodiments, the image(s), text, labels, media, and/or other content correspond to and/or are included in the content displayed after the event as described with reference to method 1500. Displaying the animation in response to detecting the artificial intelligence-associated operation visually indicate that the operation has been triggered, reducing the likelihood that the user erroneously requests repeating of the operation and thereby reducing processing required by the electronic device.

In some embodiments, the first type of event includes an operation associated with generating the content, such as generative artificial intelligence operation(s) employed when generating sunset 1334 as shown in FIG. 13I. For example, as described further herein with reference to the first and/or second region of the user interface, the operation optionally includes generating one or more portions of content, such as text, images, graphics, video, and/or some combination thereof. In some embodiments, the operation associated with generating content has one or more characteristics of similar or identical operations described with reference to methods 700, 800, 1000, 1200, 1400, 1700, 1900, and/or 2300. Displaying the animation when performing a content generation operation indicates that the content was generated by a specific operation/functionality, thus reducing the likelihood that the user erroneously requests repeating of the operation and thereby reducing processing required by the electronic device.

In some embodiments, the first type of event includes an operation associated with modifying a content item (e.g., the content that is presented after and/or in response to and/or before and/or during the event), such as generating text 1338 as shown in FIGS. 13F and/or 25K and/or generating visual information 1372 as shown in FIG. 13S. For example, as described further herein with reference to the first and/or second region of the user interface, the operation optionally includes modifying one or more portions of content, such as modifying portion(s) of text, images, graphics, video, and/or some combination thereof (e.g., that are displayed before and/or after the event is detected). In some embodiments, such operations and/or content have one or more characteristics of operation(s) and/or content described with reference to methods 700, 800, 1000, 1200, 1400, 1500, 1700, 1900, and/or 2300. In some embodiments, the content item corresponds to the content described with reference to method 1500. Thus, the content is optionally (and/or at least partially) displayed before detecting the event, and/or optionally continues to be displayed in response to detecting the event. Displaying the animation when performing a content modification operation indicates that the device initiated the operation, thus reducing the likelihood that the user erroneously requests repeating of the operation and thereby reducing processing required by the electronic device.

In some embodiments, the displayed animation indicative of the event corresponds to (e.g., is displayed on, with respect to, and/or relative to) one or more content items (e.g., the content that is presented after and/or in response to and/or before and/or during the event) related to an operation associated with the first type of event, such as overlaying and/or applying to representation 1324 and/or regions of user interface 1301 surrounding representation 1324 as shown in FIG. 13G, and/or such as the region corresponding to visual effect 1370 as shown in FIG. 13S. For example, as described with reference to the first and/or second region of the user interface, the animation corresponds to one or more content items (that optionally include the content that is presented after the event) that are optionally displayed before and/or after detecting the event. For example, the one or more content items optionally are media, text, images, video, and/or some combination thereof that are partially or entirely generated in response to detecting the event, and/or are optionally modified in response to detecting the event. In some embodiments, the duration, the number and/or spatial arrangement of portions of the user interface, the rate at which the animation progressively moves throughout the user interface, and/or the direction(s) that the animation progressively moves relative to the user interface that are displayed with HDR luminance are selected based upon the content associated with the operation. For example, when analyzing and/or generating text, the electronic device optionally displays the HDR luminance corresponding to portions of the user interface that move from and upward and/or leftward portion of the text and/or a region of the user interface at which generated text is optionally displayed, progressing downward and/or rightward over a first period of time. As another example, the electronic device optionally displays the HDR luminance corresponding to portions of the user interface where content will be added to media such as a portion of a picture and/or one or more frames of a video, the portions moving from an interior portion of where the content will optionally be added to a border of where the content will be optionally added. Displaying the animation that corresponds to content relative to an operation associated with the content visually indicates that respective content is or will be modified and/or generating, thus reducing the likelihood that the user erroneously requests repeating of the operation and thereby reducing processing required by the electronic device.

In some embodiments, the one or more content items includes a first content item that is used to generate a result of the operation associated with the first type of event, and the displayed animation is displayed over the first content item, such as content including the text 1338 as shown in FIGS. 13E and/or 25K and/or representation 1324 as shown in FIG. 13G. For example, the portion of the user interface displayed with the respective luminance are similar to or the same as where portion(s) of the first content item are displayed, visually indicating that such portion(s) of the first content item are and/or will be used as input for generating a result of an operation (e.g., a content modification and/or generation operation). It is understood that the portion(s) include some or all of the first content item. In some embodiments, the animation “moves” relative to the user interface, which includes displaying adjacent and/or contiguous portions of the user interface with the HDR luminance during respective, consecutive periods of time, thus mimicking an effect of the HDR luminance moving relative to the user interface. In some embodiments, the movement includes moving upward, downward, leftward, and/or rightward relative to content such as a portion of an image, a portion of a video, text, a representation of handwriting, and/or the like. In some embodiments, the movement includes moving from a border (e.g., a displayed or not displayed border) circumscribing where content is currently displayed, moving the HDR luminance toward an interior of the border. In some embodiments, the movement includes moving from the interior of the border to border itself. In some embodiments, a plurality of portions of the user interface corresponding to content that is used to generate the result of the operation are displayed with the HDR luminance concurrently. In some embodiments, the number, spatial profile, and/or spatial arrangement of such portions change over the course of the animation. For example, the electronic device optionally displays two regions of the user interface having an irregular, curved border with the HDR luminance during a first portion of the animation, and optionally displays three regions that are contiguous or are non-contiguous with the two regions of the user interface with the HDR luminance during a second, different portion of the animation. Displaying the respective luminance corresponding to the first content item visually indicates that the first content item will be used to generate a result of the operation, thus reducing the likelihood that the user repeats the operation without knowing what input(s) affected the result and thereby reducing processing performed when repeating the operation.

In some embodiments, the one or more content items includes a first content item that is a result of the operation associated with the first type of event, such as text 1338 as shown in FIG. 13G, and the displayed animation is displayed over the first content item, such as overlaying and/or surrounding portions of characters included in text 1338. For example, the portion of the user interface displayed with the respective luminance (e.g., content that is part of the one or more content items) are similar to or the same as where portion(s) of the first content item are generated in response to detecting the event, thus visually indicating that such portion(s) of the user interface included content generated in accordance with the operation. It is understood that the portion(s) include some or all of the first content item. In some embodiments, the animation moves over the content that is generated as a result of the operation in a manner that is similar to or the same as described with reference to the animation moving over content used to generate the result of the operation. In some embodiments, the user interface foreshadows the display of the result of the operation by displaying the animation at portion(s) of the user interface with the HDR luminance, and shortly thereafter, the electronic device displays portion(s) of the result of the operation at such portion(s) of the user interface. Displaying the respective luminance corresponding to the first content item visually indicates that the first content item is generated based upon the operation, thus reducing the likelihood that the user repeats the operation without knowing what component of the user interface includes device generated content, thereby reducing processing performed when repeating the operation.

In some embodiments, displaying the first portion of the animation includes changing one or more visual characteristics of the one or more content items, such as an opacity, saturation, and/or color of text 1338 as shown in FIGS. 13E and/or 25K. For example, the one or more visual characteristics optionally include blurring, scaling, visually distorting, changing an opacity level, changing color(s), and/or ceasing display of some or all of respective portions of the one or more content items. In some embodiments, the one or more visual characteristics are different from the luminance of the user interface. In some embodiments, concurrently while displaying a first one or more portions of the user interface and/or content associated with an operation of the electronic device with the modified one or more visual characteristics (e.g., blurred, scaled, distorted, modified in opacity, and/or modified in color), the electronic device maintains display of one or more second portions of the user interface without modified the same or similar visual characteristics. Changing visual characteristic(s) of the one or more content items indicates that content generation and/or modification is initiated, thus reducing the likelihood the user erroneously interrupts such operations.

In some embodiments, displaying the first portion of the animation includes changing one or more colors of the one or more content items, such as a color of text 1338 as shown in FIGS. 13E and/or 25K. For example, the color, hue saturation, and/or some combination thereof are optionally changed. In some embodiments the electronic device concurrently changes the color characteristic(s) of the portion of the user interface displayed with the respective luminance is changed in color during the animation. In some embodiments, the color and/or additional or alternative visual characteristics included in the animation change in a manner that is similar to, or the same as described with reference to method 1500. For example, the electronic device optionally displays one or more portions of a user interface with respective colors, sequencing through a gradient of colors as described further herein. Changing visual characteristic(s) of the one or more content items indicates that content generation and/or modification is initiated, thus reducing the likelihood the user erroneously interrupts such operations.

In some embodiments, displaying the first portion of the animation comprises moving the animation over different portions of the one or more content items over time, such as moving the animation over a first portion of text 1338 as shown in FIGS. 13D and/or 25K and/or moving the animation in a different manner over the first portion (or another portion) of text 1338 as shown in FIGS. 13E and/or 25K. In some embodiments, as described further herein, the one or more content items optionally include or are optionally different from the content described with reference to method 1500. In some embodiments, displaying one or more portions of the animation includes changing which respective portion(s) of one or more content items are displayed with the respective luminance (e.g., the HDR luminance). For example, the electronic device displays a first portion of the one or more content items with the respective luminance while a second portion of the one or more content items are displayed with SDR luminance during the first portion of the animation, and the electronic device optionally displays the second portion of the one or more content items with the respective luminance and optionally displays the first portion of the one or more content items with the SDR luminance during a second, different portion of the animation. In some embodiments, the portion of the one or more content items displayed with the HDR luminance grows during the animation. For example, only the first one or more portions are optionally displayed with the HDR luminance during the first portion of the animation, and both the first and the second one or more portions are optionally displayed with the HDR luminance during a second portion of the animation. Displaying the movement of the animation visually indicates a progression of the animation as well as visually indicates a progress of an operation that is associated with the animation.

In some embodiments, displaying the first portion of the animation comprises displaying, via the display generation component, a respective first portion of the user interface with one or more first colors during the first portion of the animation, such as a portion of the user interface at least partially included in the region 1344 as shown in FIGS. 13D and/or 25K. For example, the respective first portion of the user interface optionally is the same as, or is optionally different from the portion of the user interface displayed with the respective luminance during the first portion of the animation as described with reference to method 1500. In some embodiments, the one or more first colors are associated with a color gradient, including a plurality of different colors and/or hues. In some embodiments, while displaying the first portion of the animation, the one or more first colors are displayed at additional or alternative portion(s) of the user interface, different from the respective first portion of the user interface.

In some embodiments, displaying the first portion of the animation comprises displaying, via the display generation component, the respective first portion of the user interface with one or more second colors during a second portion of the animation, different from the first portion of the animation, wherein the one or more first colors and the one or more second colors are colors along a color gradient, such as one or more colors included in the color gradient at the portion of the user interface at least partially included in the region 1344 as shown in FIGS. 13D and/or 25K. In some embodiments, the first portion of the animation includes displaying the respective portion of the user interface with one or more second colors, different from the one or more first colors. For example, the first one or more colors optionally includes blue tones and/or hues, and the second one or more colors optionally includes pink tones and/or hues (and optionally does not include the blue tones and/or hues). In some embodiments, while displaying the second portion of the animation, the one or more second colors are displayed at additional or alternative portion(s) of the user interface, different from the respective first portion of the user interface. In some embodiments, the animation includes changing color(s) of portions of the user interface such that the gradient appears to travel to different portions of the user interface. For example, when displaying the second portion of the animation, a respective second portion of the user interface (e.g., adjacent to the respective first portion of the user interface) is optionally displayed with the one or more first colors. In additional or alternative portions of the animation, additional or alternative portions of the user interface are displayed with the one or more first colors (e.g., such portions optionally adjacent to the respective second portion of the user interface), the respective second portion of the user interface is optionally displayed with the one or more second colors, and the respective first portion of the user interface is optionally displayed with one or more third colors, optionally different from the one or more second colors and/or optionally different from the one or more first colors. It is understood that the animation optionally includes a plurality of colors (e.g., green, purple, pink, orange, and/or yellow), and that the first portion of the animation optionally includes displaying the respective portion of the user interface with one or more colors that cycles and/or gradually transitions between the plurality of colors. Animating a changing of colors along a color gradient visually indicates a progression of operations related to the first event, thus reducing the likelihood the user erroneously interrupts the operations, thereby reducing needless power consumption required by the interruptions.

In some embodiments, the portion of the user interface displayed with the respective luminance that is higher than the standard dynamic range of luminance for the user interface corresponds to the respective first portion of the user interface during the first portion of the animation, such as a first portion of user interface 1301 as shown in FIGS. 13D and/or 25K, and the portion of the user interface displayed with the respective luminance that is higher than the standard dynamic range of luminance for the user interface corresponds to a respective second portion of the user interface, different from the respective first portion of the user interface, during the second portion of the animation, such as a different portion of the user interface 1301 shown in FIGS. 13D and/or 25K, and/or as shown by the intensity 1352 changing from as shown in FIG. 13K to as shown in FIG. 13L. In some embodiments, the respective first portion and/or the respective second portion of the user interface are adjacent to one another. Additionally (or alternatively), the first portion of the user interface is optionally displayed with the standard dynamic range of luminance during the second portion of the animation. Thus, the HDR luminance optionally appears to move over the course of the animation. In some embodiments, the HDR luminance moves in one or more directions relative to the user interface, such that during a respective portion of the animation, one or more portions of the user interface that were displayed with HDR luminance prior to displaying the respective portion of the animation are optionally displayed with SDR luminance. It is understood that the animation optionally includes cycling through the color gradient for the respective first portion of the user interface at a first time, and optionally includes cycling the color gradient for a respective second portion of the user interface at a second time. In some embodiments, portions of the user interface displayed with the HDR luminance are modified by the electronic device with respect to one or more visual characteristics, such as inclusion of content corresponding to a result and/or an input for an operation associated with the electronic device, and/or such as display of color along of gradient of colors indicating a progression of the animation with respect to content and/or the user interface. Displaying different portions of the user interface with the respective luminance that is higher than the standard dynamic range of the luminance visually indicates that operation(s) related to the event are optionally ongoing in response to detecting the event, thus reducing the likelihood that the user prematurely terminates the operation(s), and thereby reducing power consumption required to terminate the operation(s).

In some embodiments, in accordance with a determination that a first portion of the content presented after the event is associated with first depth information, the color gradient displayed at the first portion of the content includes one or more third colors, such as a depth between a dog included in representation 1324 as shown in FIG. 13G and a background landscape, and/or a depth between visual elements included in representation 1309 as shown in FIG. 13GG. For example, the one or more third colors optionally includes the one or more first colors, the one or more second colors, and additional or alternative colors. In some embodiments, the number of third colors increases (or, optionally, decreases) based upon detecting greater or lesser variance in spatial information associated with the content. For example, when the content described with reference to method 1500 includes one or more images and/or video that is or will soon be associated with spatial information, the electronic device optionally determines and/or changes the number of one or more third colors. As an example, in accordance with a determination that the depth information is a first value, the one or more third colors include a first number of colors. In accordance with a determination that the depth information is a second value (e.g., that there is a greater variance, rate of change, and/or absolute differences in depth between objects in an image), the electronic device changes the one or more third colors to include a second number of colors, different from the one or more first number of colors. It is understood that in addition to or in the alternative to a number of colors, the electronic device optionally changes a range of saturation of colors in accordance with depth information, similar to as described with reference to the number of colors. In additional embodiments, the electronic device optionally selects a starting point along a gradient of colors that is based upon the depth information. For example, the gradient is optionally cyclic, such that when the depth information the first value the animation initiates by displaying a portion of the user interface with a first color, transitioning over time to a second color, and after third color. In some embodiments, when the depth information is a second value (e.g., described further below), the animation initiates by displaying the portion of the user interface with the second color, transitioning over time to the third color, and the after that the first color.

In some embodiments, in accordance with a determination that the first portion of the content presented after the event is associated with second depth information, different from the first depth information, the color gradient displayed at the first portion of the content includes one or more fourth colors, different from the one or more third colors, such as different colors when the dog as shown in representation 1324 in FIG. 13G corresponds to a background object that is behind the dog, and is relatively closer in a depth direction to the dog than the landscape, such as colors corresponding to the visual effect 1321 and/or visual effect 1323 as shown in FIG. 13HH. For example, the one or more third colors include three colors when the depth information is the first value, and include four colors when the depth information is a second value, different from the first value. Displaying the color gradient based upon the depth information visually indicates the depth information, thus indicating spatial characteristics of content that is otherwise difficult to indicate to the user.

In some embodiments, the displaying the first portion of the animation includes displaying the first portion of the animation on a first spatial area of the user interface, and wherein the portion of the user interface displayed with the respective luminance is a second spatial area of the user interface, smaller than the first spatial area of the user interface, such as a portion (but not all) of the region of user interface 1301 indicated by region 1344 as shown in FIGS. 13D and/or 25K, and/or a region corresponding to visual effect 1358 as shown in FIG. 13GG as compared to the region(s) of user interface 1304 corresponding to visual effects 1323 and/or 1321 in FIG. 13HH. For example, the animation visually occupies a first area in the user interface and the portion of the user interface displayed with the respective luminance (e.g., the second spatial area) is less than the first spatial area, while the remaining portions of the first spatial area not included in the second spatial area are optionally displayed with the SDR luminance. Additionally (or alternatively), the spatial profile (e.g., shape and/or dimensions) of the first spatial area is optionally different from the portion of the user interface displayed with the respective luminance. In some embodiments, however, the entirety of the user interface is displayed with a modified luminance, such as the HDR luminance, and/or the entirety of the user interface is displayed with one or more modified visual characteristics different from a steady state of the user interface that is displayed when the operation associated with functionality of the electronic device and/or content presented via the electronic device is not ongoing. Displaying the portion of the user interface with the respective luminance than is less than and included in the first spatial area, thus reducing the power consumption required to display the HDR luminance otherwise required to display the entire first spatial area with the HDR luminance.

In some embodiments, displaying the first portion of the animation includes changing an intensity of the animation over time, such as changing the intensity indicated by indicator 1313 as shown in FIGS. 13D and/or 25K and/or the changing of intensity 1352 as shown from FIG. 13K to 13L. In some embodiments, the intensity of the animation includes one or more of a size of a portion of the user interface where the animation is displayed (e.g., overlaying the portion of the user interface), the number of visual effects applied to the portion of the user interface (e.g., a blurring effect, a change in color, a change in saturation, a visual distortion, and/or some combination thereof, increasing the luminosity of the portion of the user interface), and/or some combination of such factors. For example, during the animation, the luminance of the portion of the user interface optionally increases and/or decreases over time and/or the degree of spatial distortion (described further herein) optionally increases or decreases over time. In some embodiments, the intensity of the animation includes one of such factors, in other embodiments, the intensity includes a plurality of such factors. In some embodiments, the intensity increases over (e.g., increasing a size of a blurring radius, changing of color of the user interface based upon a first sequence of colors, increasing saturation (or, optionally decreasing the saturation), increasing a degree of visual distortion, and/or some combination thereof). In some embodiments, the intensity decreases over time (e.g., decreasing the size of the blurring radius, changing the colors in a sequence that opposes the increase in intensity, decreasing the saturation, decreasing the degree of visual distortion, and/or some combination thereof). It is understood that the intensity optionally changes in one manner during the first portion animation (e.g., increasing or decreasing), and/or optionally changes in another manner during the second portion of the animation (e.g., increasing and/or decreasing). Displaying the first portion of the animation including changing of the intensity of the animation over time draws the user's attention toward corresponding portions of the user interface and reinforces that content displayed after the animation concludes will be generated and/or modified.

In some embodiments, the intensity of the animation includes a luminance of the animation, such as a luminance of the animation indicated by indicator 1313 as shown in FIGS. 13D and/or 25K and/or associated with the intensity 1352 as shown in FIG. 13K. For example, as described with reference to the intensity of the animation, the intensity optionally includes the luminance of the animation. In some embodiments, the respective luminance changes at a rate similar to or the same as the rate of change of luminance at other portions of the user interface. In some embodiments, the change(s) in luminance are performed concurrently while displaying the first portion of the animation. In some embodiments, the changing of the respective luminance includes decreasing the luminance to fall within the SDR luminance range, and includes increasing the luminance from the decreased luminance to higher than the SDR luminance range. Changing of the luminance of the animation over time draws the user's attention toward corresponding portions of the user interface and reinforces that content displayed after the animation concludes will be generated and/or modified.

In some embodiments, the intensity of the animation corresponds to an amount of the user interface displayed with the respective luminance that is higher than the standard dynamic range of luminance for the user interface, such as the amount and/or size of the region of user interface 1301 that is displayed with the respective luminance as shown in FIGS. 13D and/or 25K. For example, the electronic device optionally displays a plurality of portions of the user interface with the respective luminance concurrently. In some embodiments, displaying the first portion of the animation includes displaying a plurality of portions of the user interface with HDR luminance, but with different respective levels of luminance (e.g., one portion of the user interface is higher luminance than another portion (e.g., the respective second luminance), and both luminances are within a range of HDR luminance beyond a maximum SDR luminance). In some embodiments, displaying the second portion of the animation includes increasing the relative portion of the user interface that is displayed with the respective luminance, and/or luminance greater than a maximum SDR luminance. Displaying a plurality of portions of the user interface with HDR luminance visually indicates progression of operations related to the event, thus reducing erroneous interruptions to performance of the operations and thereby reduces power consumption required to process such erroneous interruptions.

In some embodiments, the displaying the portion of the user interface with the respective luminance that is higher that a standard dynamic range of luminance for the user interface occurs a period of time after the animation indicative of the event begins, wherein during the period of time the animation does not include displaying the portion of the user interface with the respective luminance that is higher than the standard dynamic range of luminance for the user interface, such as delaying display of an animation including displaying the user interface 1301 with the respective luminance as indicated by the indicator 1313 as shown in FIGS. 13D and/or 25K. For example, in response to detecting the event, the electronic device optionally forgoes display of the portion of the user interface with the respective luminance for the period of time. In some embodiments, after the period of time (e.g., and during the animation), the electronic device initiates display of the portion of the user interface with the respective luminance. In some embodiments, the electronic device increases the luminance of the portion of the user interface to correspond to the respective luminance in response to detecting the event that corresponds to the first type of event, and without detecting intervening user input (e.g., voice input, button selection, touch directed to trackpads, and/or some combination thereof). In some embodiments, other portion(s) of the user interface are displayed with the respective luminance in response to detecting the event, and before the period of time passes. Displaying the portion of the user interface with the respective luminance after a period of time creates visual emphases at the appropriate portion of the user interface, and at an appropriate time relative to operations associated with the event.

In some embodiments, displaying the portion of the user interface with respective luminance that is higher than the standard dynamic range of luminance for the user interface comprises displaying the portion of the user interface with respective luminance that is higher than the standard dynamic range of luminance for the user interface during a first time period, such as displaying a portion of the region indicated by region 1344 with the respective luminance as shown in FIGS. 13E and/or 25K. For example, as described with reference to method 1500. For example, the display of the portion with the respective luminance is optionally performed in response to detecting the event (e.g., immediately when initiating the animation).

In some embodiments, displaying the portion of the user interface with respective luminance that is higher than the standard dynamic range of luminance for the user interface comprises ceasing display of the portion of the user interface with respective luminance that is higher than a standard dynamic range of luminance for the user interface during a second time period that is after the first time period but before a third time period, such as ceasing the display such as ceasing the displaying of the portion of the region indicated by region 1344 with the respective luminance as shown in FIGS. 13E and/or 25K. For example, the portion of the user interface is optionally displayed with a SDR luminance during a second period of time.

In some embodiments, displaying the portion of the user interface with respective luminance that is higher than the standard dynamic range of luminance for the user interface comprises displaying the portion of the user interface with respective luminance that is higher than the standard dynamic range of luminance for the user interface during the third time period, such as displaying the portion of the region indicated by region 1344 with the respective luminance as shown in FIGS. 13E and/or 25K. For example, the portion of the user interface is optionally displayed with the respective luminance again, during third period of time. Thus, the animation optionally includes changing luminance of the portion of the user interface over time from HDR luminance, to SDR luminance, and back to HDR luminance. The changing of luminance of the user interface conserves power required to constantly display the portion of the user interface with HDR luminance, and visually indicates whether an operation associated with the event is ongoing.

In some embodiments, displaying the animation indicative of the event includes changing a saturation (e.g., of colors) of the portion of the user interface over time, such as changing saturation of one or more colors of the portion of user interface 1301 indicated by region 1344 as shown in FIGS. 13E and/or 25K. For example, the electronic device changes the saturation of the portion of the user interface from a first saturation value to a second saturation value during the first portion and/or another portion of the animation. In some embodiments, displaying the animation indicative of the event includes changing a plurality of portions of the user interface with respective saturations over time, from the first value to the second value (and/or between other saturation values). In some embodiments, the first and/or second values correspond to saturation values included in the content that is displayed after (and/or before) the event is detected. In some embodiments, the colors that saturate or desaturate during the animation indicative of the event are similar to or the same as the content that is displayed after (and/or before) the event is detected. Changing saturation of the user interface during the animation provides visual feedback that an operation is triggered in response to detecting the event, and reduces the likelihood that the user erroneously interrupts the operation, thus reducing power consumption required to interrupt the operation.

In some embodiments, displaying the animation indicative of the event includes changing a degree of blurring associated with the animation over time, such as changing blurring effect applied to the portion of user interface 1301 indicated by region 1344 as shown in FIGS. 13E and/or 25K. For example, the electronic device optionally displays a blurring effect corresponding to a first blur radius during the first portion of the animation, and includes displaying the blurring effect corresponding to a second blur radius, different from the first blur radius, during a second portion of the animation, different from the first portion of the animation. Thus, the portion of the user interface displayed with the respective luminance, for example, optionally is displayed with a blurring radius value that optionally changes over time. Additionally (or alternatively), the blurring effect is optionally applied to portion(s) (e.g., some or all) of the content described with reference to method 1500 that is displayed after the event. It is understood that the blurring radius optionally extends beyond, and/or is within the portion of the user interface displayed with the respective luminance. In some embodiments, the portion of the user interface displayed with the blurring effect is different from (e.g., non-overlapping with) the portion of the user interface displayed with the respective luminance. Displaying a blurring effect draws the user's attention toward portions of the user interface and/or away from other portion so the user interface, thus optionally providing visual feedback concerning a progression of operation(s) related to the event.

In some embodiments, displaying the animation indicative of the event includes changing a degree of spatial distortion (e.g., stretching, twisting, expanding, compressing, bending, or otherwise changing a spatial distribution of one portion of the content relative to a spatial distribution of one or more other portions of the content) associated with the animation over time, such as spatially distorting of one or more colors of the portion of user interface 1301 indicated by region 1344 as shown in FIGS. 13E and/or 25K. For example, the electronic device optionally displays, via the display generation component, at least a portion of the content while the animation is displayed, wherein displaying the animation further comprises, during the first portion of the animation, displaying a first visual distortion of a first portion of the content, and during a second portion of the animation, different from the first portion of the animation, displaying a second visual distortion of the first portion of the content. In some embodiments, such first and/or second portions correspond to the respective portion of the user interface display with the respective luminance. In some embodiments, the spatial distortion includes changing a scale and/or relative dimensions of portions of an image over a period of time. For example, a first vertical line included in an image optionally increases in scale by a first degree, and a second vertical line included in the image optionally increases (e.g., or decrease) in scale by a second degree, greater than, less than, or equal (e.g., in the case of decreasing the scale) to the first degree. In some embodiments, the spatial distortion is applied to some or all of the content that is displayed after (and/or before) the event is detected. Spatially distorting content visually indicates that various operations are optionally performed with respect to the content, thus reducing the likelihood that the user is unaware that portion(s) of the content are newly generated and/or modified, thereby reducing the likelihood of erroneous user interaction and corresponding power consumption required to perform operations in response to the interaction.

In some embodiments, displaying the animation indicative of the event includes changing a spatial distribution of the animation over the user interface over time, such as changing a spatial distribution of one or more portions of user interface 1301 indicated by region 1344 as shown in FIGS. 13E and/or 25K. For example, one or more dimensions of the user interface affected by the animation optionally change over a period of time. As an example, the first portion of the animation optionally includes modifying display of one or more first portions of the user interface. In such an example, the electronic device optionally displays a second portion of the animation, different from the first portion of the animation, which optionally includes modifying display of one or more second portions of the user interface during a second portion of the animation, different from the first portion of the animation, wherein a spatial distribution of the one or more first portions of the user interface is different from a spatial distribution of the one or more second portions of the user interface. In some embodiments, the first portion and the second portion of the user interface at least partially include where the content that is displayed after (and/or before) the event is detected. Thus, the spatial distribution of the animation relative to the content optionally changes over time. Changing a spatial distribution of the animated effect over time optionally conveys the progression of operations associated with the event, thus reducing the likelihood that the user erroneously interacts and/or interrupts with the user interface during performance of the operations.

In some embodiments, the user interface that is displayed when the event is detected is a first user interface that corresponds to a first software application, such as user interface 1304 as shown in FIGS. 13C and/or 25K corresponding to an e-mail application. In some embodiments, while displaying a second user interface, different from the first user interface, corresponding to a second software application, different from the first software application, such as user interface 1304 as shown in FIG. 13GG, corresponding to a media editing and/or browsing application, the electronic device detects, via the one or more input devices, a respective event, such as input 1329 as shown in FIG. 13FF. In some embodiments, while displaying the second user interface, and in response to detecting the respective event, in accordance with a determination that the event is the first type of event, the electronic device displays, via the display generation component, a respective animation indicative of the event, such as the animation including first visual effect 1358 and/or visual effect 1319 as shown in FIG. 13GG, wherein the displaying of the respective animation includes a first portion of the respective animation that includes displaying a portion of the second user interface with the respective luminance that is higher than the standard dynamic range of luminance for the second user interface, wherein the portion of the second user interface displayed with the respective luminance that is higher than the standard dynamic range of luminance for the second user interface is associated with content that is presented after the respective event, such as luminance of the region corresponding to visual effect 1358 as shown in FIG. 13GG. In some embodiments, after displaying the first portion of the respective animation and when the respective animation concludes, the electronic device displays the portion of the second user interface with luminance that is within the standard dynamic range for the second user interface, such as displaying the region corresponding to visual effect 1358 as shown in FIG. 13GG with a luminance that the region is displayed with as shown in FIG. 13FF.

It should be understood that the particular order in which the operations in FIG. 15 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1400, 1700, 1900, 2100, 2300, and/or 2700) are also applicable in an analogous manner to method 1500 described above with respect to FIG. 15. For example, the operation of displaying one or more portions of the user interface with luminance that is within or greater than a SDR luminance described above with reference to method 1500 optionally has one or more of the characteristics of, displaying a representation of a prompt and one or more recognized concepts, editing one or more parameters, including one or more recognized concepts, of a previously generated automatically-generated visual content, the addition of a representation of automatically-generated visual content into a first application, presenting an automatically-generated visual media creation user interface to use a non-automatically-generated visual media as the reference media item, displaying portion(s) of a user interface with HDR luminance, generating multiple variations of representations of automatically-generated visual content, restricting prompt components to be used to generate automatically-generated visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., 700, 800, 1000, 1200, 1400, 1700, 1900, 2100, 2300, and/or 2700). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 15 are, optionally, implemented by components depicted in FIGS. 1A-1B. For example, displaying operation 1506 and 1508, and detecting operation 1502 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners, including interacting with applications to create content items. The embodiments described below provide a quick and efficient way of displaying multiple variations of representations of automatically-generated visual content items in response to intuitive gesture inputs, which enhances the operability of the device and makes the user-device interface more efficient. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

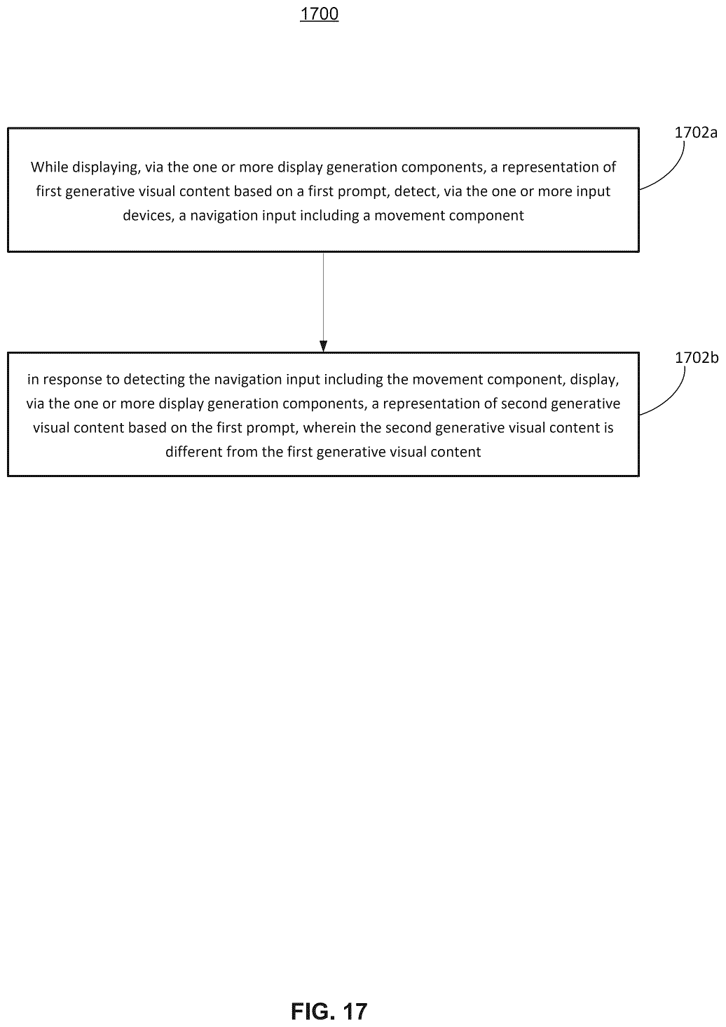

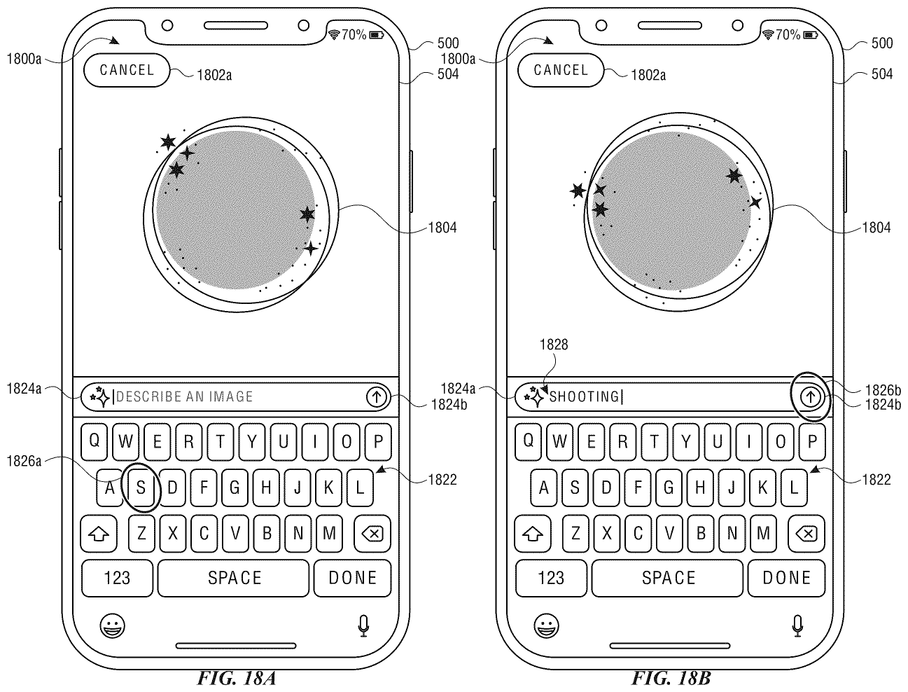

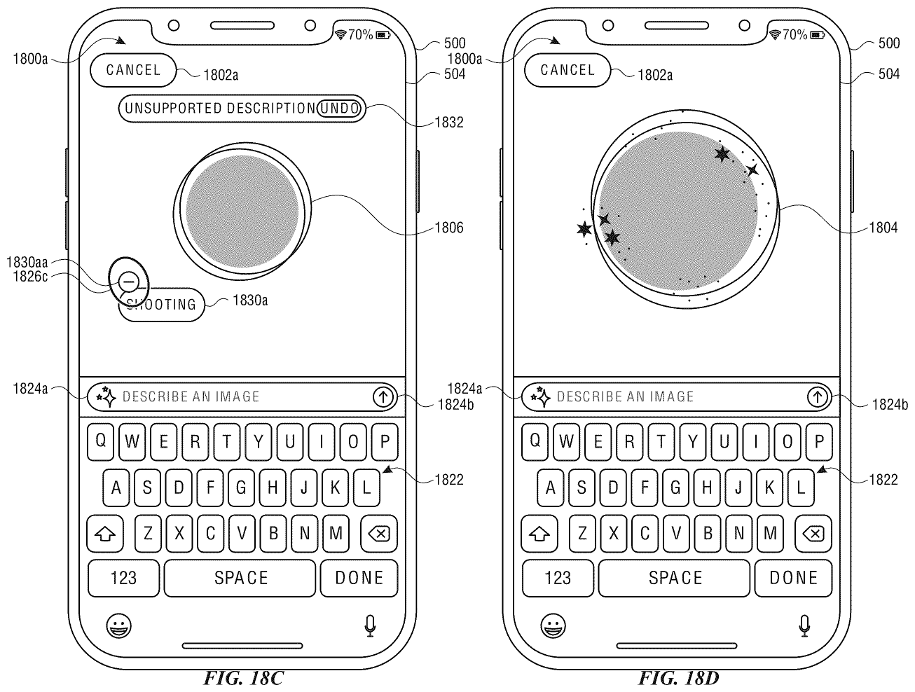

FIGS. 16A-16U illustrate exemplary ways in which an electronic device displays multiple variations of representations of automatically-generated visual content items according to some embodiments of the disclosure. The embodiments in these figures are used to illustrate the processes described below, including the processes described with reference to FIG. 17. Although FIGS. 16A-16U illustrate various examples of ways an electronic device is able to perform the processes described below with respect to FIG. 17, it should be understood that these examples are not meant to be limiting, and the electronic device is able to perform one or more processes described below with reference to FIG. 17 in ways not expressly described with reference to FIGS. 16A-16U.

In some embodiments, the user interface of FIGS. 16A-16U corresponds to the user interface of FIGS. 6A-6MM, 18A-18BB, 20D-20AA, 22A-22CCC, 24A-24E, and/or 26A-26P.

FIG. 16A illustrates an electronic device 500 displaying an editing user interface 1600a of a content application. In some embodiments, the editing user interface 1600a is displayed via one or more display generation components (e.g., a display generation component 504). As shown in FIG. 16A, the editing user interface 1600a is a user interface of content application described in more detail with reference to method 700. In some embodiments, the editing user interface 1600a corresponds to user interface 604, shown in FIG. 6A-6MM and/or the user interfaces shown in FIGS. 18A-18BB, 20D-20AA, 22A-22CCC, 24A-24E, and/or 26A-26P. For example, the content application presents automatically-generated visual content. The content application optionally obtains automatically-generated visual content from a remote server in communication with the electronic device 500 and/or a local processor (e.g., maintained by the electronic device optionally from a content application operating on the electronic device) for processing, computing, generating, and/or refining the automatically-generated visual content. The content application optionally requests, from the server through a network (e.g., local area network, cellular data network, wireless network, the Internet, wide area network, etc.), automatically-generated visual content. The content application optionally stores the automatically-generated visual content in a database of the electronic device 500. The content application optionally uses the automatically-generated visual content stored in the database and/or other automatically-generated visual content data retrieved from the server to provide content application features described herein. In some embodiments, the server is a computing device, or multiple computing devices, configured to store, generate, and/or provide automatically-generated visual content to various user devices (e.g. electronic device 500), as described herein. For example, the functionality described herein with reference to the server is optionally performed by a single computing device or optionally distributed amongst multiple computing devices.

As shown in FIG. 16A, the electronic device 500 presents the editing user interface 1600a (e.g., of a content application installed on electronic device 500) using one or more display generation components (e.g., a display generation component 504). In FIG. 16A, editing user interface 1600a includes a plurality of user interface elements. For example, the editing user interface 1600a includes a preview representation 1606 of a first automatically-generated visual content item and a set of prompt components 1604a through 1604d. As used herein, the prompt components 1604a through 1604d displayed around the preview representation 1606 are collectively referred to as a user selected prompt used to influence generation of the automatically-generated visual content item. The prompt components 1604a through 1604d include a respective deletion option (e.g., deletion options 1604aa through 1604dd) that, when selected cause the electronic device 500 to remove (e.g., cease to display the respective component) the term or recognized concept of the respective component from the request to influence generation of the automatically-generated visual content item described in detail in method 1700 and/or illustrated in the figures that follow. In some embodiments, the preview representation 1606 of the first automatically-generated visual content item and/or the set of components 1604a through 1604d are displayed having a respective visual appearance described in more detail in method(s) 1400, 1500, and/or 1700. For example, the preview representation 1606 and/or components 1604a through 1604d are optionally displayed with an animation effect (e.g., subtle motion) to convey that the status of generating the automatically-generated visual content item is changing and/or is expected to change while in the editing user interface 1600a.

The editing user interface 1600a also includes a plurality of suggested prompt components 1608b through 1608f (e.g., computer or user generated) and a selectable option 1608a that, when selected, causes the electronic device 500 to display more suggested prompt components. In some embodiments, more suggested prompt components are displayed in response to detecting a swipe or movement input directed toward the plurality of suggested prompt components. As described in more detail with reference to method(s) 700 and/or 800, the plurality of suggested prompt components 1608b through 1608f correspond to one or more concepts related to a theme or style or characteristic used to influence generation of the automatically-generated visual content item, such as, for example, an adventure theme (e.g., suggested prompt component 1608b), a birthday theme (e.g., suggested prompt component 1608c), a chef characteristic (e.g., suggested prompt component 1608e) and/or the like. Thus, in some embodiments, the automatically-generated visual content item having a birthday theme optionally includes images of a cake, balloons, party hats, and/or the like.

In FIG. 16A, the editing user interface 1600a includes a content entry control element 1610 that, when selected, causes the electronic device 500 to display a content entry user interface element (e.g., content entry user interface element 1640a in FIG. 16K) described in more detail below. Element 1610 optionally corresponds to elements 1846a, 2020a, and/or 2210a in FIGS. 18G-18BB, 20D-20AA, 22A-22CCC, and/or 26A-26P. The editing user interface 1600a also includes a subject control element 1612 that, when selected, causes the electronic device 500 to display a subject personalization user interface element (e.g., subject personalization user interface element 1626a in FIG. 16G) described in more detail below. Element 1612 optionally corresponds to elements 1848, 2020b, and/or 2210b in FIGS. 18G-18BB, 20D-20AA, 22A-22CCC, and/or 26A-26P. The editing user interface 1600a also includes a style selectable option 1614 that, when selected, causes the electronic device 500 to display a style selection user interface element described in method(s) 700, 800, and/or 2100 and/or as shown in FIG. 20V. Option 1614 optionally corresponds to options 1850, 2020c, and/or 2210c in FIGS. 18G-18BB, 20D-20AA, 22A-22CCC, and/or 26A-26P. The editing user interface 1600a also includes a cancel option 1602a that, when selected, causes the electronic device 500 to close (e.g., cease to display) the editing user interface 1600a; and a create option 1602b that, when selected, causes the electronic device 500 to initiate generation of the first automatically-generated visual content item (e.g., display a higher fidelity and/or upscaled version of the first automatically-generated visual content item) described in more detail below. In some embodiments, the cancel option 1602a corresponds to the option 624a, 1802a, and/or 2202a and the create option 1602b corresponds to the option 624b, 1802b, and/or 2202b shown in greater detail in FIG. 6B-6MM, 18A-18BB, 20D-20AA, 22A-22CCC, and/or 26A-26P.

In FIG. 16A timer 1616a is configured by the electronic device 500 to track an amount of time that has elapsed since an input was last detected. In some embodiments, when the electronic device 500 determines that the amount of time exceeds a threshold 1616b, the electronic device 500 displays a variants user interface 1600b as shown in FIG. 16B. The electronic device 500 is configured to display the variants user interface 1600b in response to other events including detecting user input(s) described in more detail with reference to method 1700 and as illustrated in the figures that follow.

In FIG. 16B, the variants user interface 1600b is a user interface of a content application and includes one or more of the same user interface elements (e.g., pre-defined components 1608b through 1608f), selectable options (e.g., options 1608a, 1614, 1602a, and/or 1602b) and/or control elements (e.g., control elements 1610 and/or 1612). In some embodiments, the variants user interface 1600b includes one or more other elements or options that were not previously displayed in the editing user interface 1600a (e.g., suggested prompt components 1608h through 1608k). In some embodiments, the suggested prompt components 1608h through 1608k include one or more characteristics of the pre-defined components 1608b through 1608f in FIG. 16A.

Variants user interface 1600b also includes a preview representation 1620a of the first automatically-generated visual content item and one or more visual indications (e.g., visual indication 1618) representing the components 1604a through 1604d that were previously displayed in the editing user interface 1600a. Thus, in some embodiments, the electronic device 500 replaces the components 1604a through 1604d with the one or more visual indications. In some embodiments, the one or more visual indications are displayed having a respective visual appearance described in more detail in method 1700. For example, visual indication 1618 representing one of the one or more visual indications is optionally displayed having a smaller size relative to the other interface elements, selectable options, and/or control elements included in the variants user interface 1600b and thus, taking up less space than if the variants user interface 1600b included its corresponding component.

In some embodiments, the preview representation 1620a in the variants user interface 1600b in FIG. 16B is a size larger than the size of the preview representation 1606 displayed in the editing user interface 1600a in FIG. 16A. For example, in FIG. 16B, the preview representation 1620a includes more of the background than the background of the preview representation 1606 displayed in FIG. 16A. Other differences and similarities in which the electronic device 500 displays these preview representations are described in more detail in method(s) 700, 800, and/or 1700. In some embodiments the preview representation 1620 is displayed in content container where different preview representations of respective generative automatically-generated visual content are displayed.

In FIG. 16B, the electronic device 500 displays indicators 1622a through 1622d corresponding to a number of generative visual content items currently available based on the user selected prompt which includes components 1604a through 1604d. In FIG. 16B, the electronic device displays the indicators 1622a through 1622d as a series of dot images where a solid dot denotes the currently displayed preview representation 1620a, and outlines of dots denote other preview representations of other generative visual content. Other visual indications are possible as described with reference to method 1700.

The electronic device 500 further displays option 1680 that, when selected, causes the electronic device 500 to display a menu with a plurality of options for preserving the currently-displayed variant of the automatically-generated visual content item. In some embodiments, after preserving the currently-displayed variant of the automatically-generated visual content item in response to detecting selection of one of the options in the menu, the electronic device 500 resumes display of the user interface in FIG. 16B, thereby enabling the user to continue to browse variants of the automatically-generated visual content item and/or preserve one or more other variants of the automatically-generated visual content item, as described in more detail below with respect to FIGS. 16Q and 16R′.

In FIG. 16B, the electronic device detects a navigation input 1624a directed to preview representation 1620a of the first automatically-generated visual content item. In some embodiments, the navigation input 1624a is a dragging input described in more detail in method(s) 700 and/or 1700. For example, a dragging input 1624a optionally includes contact (e.g., one or more fingers of the user) on the touch-sensitive surface (e.g., the one or more display generation components, the one or more input devices, or other touch-sensitive device) at a location corresponding to the preview representation 1620a followed by movement of the contact. In some embodiments, the electronic device 500 detects the dragging input via an indirect input device, such as mouse, trackpad, or other input device described in method(s) 700 and/or 1700. In some embodiments, the dragging input includes an air gesture (e.g., described in more detail in method 1700), a forward pointing gesture (e.g., described in more detail in method 1700), or a tap and drag gesture (e.g., described in more detail in method 1700).

In some embodiments, in response to (and/or while) detecting the navigation input 1624a directed to the preview representation 1620a of the first automatically-generated visual content item, the electronic device 500 moves the preview representation 1620a of the first automatically-generated visual content item across a display area in accordance with movement of the input 1624a as shown in FIG. 16C. In some embodiments, as the electronic device 500 moves the preview representation 1620a of the first automatically-generated visual content item across the display area, the electronic device 500 gradually ceases to display the preview representation 1620a of the first automatically-generated visual content item to reveal the preview representation 1620b of the second automatically-generated visual content item, as shown in FIG. 16C. In some embodiments, when the electronic device 500 detects an end of the navigation input 1624a (e.g., liftoff of the contact from the touch-sensitive surface after the movement of the contact), the electronic device 500 fully displays preview representation 1620b of the second automatically-generated visual content item within the display area previously occupied by the representation of the preview representation 1620a of the first automatically-generated visual content item, as shown in FIG. 16D.

In FIG. 16D, the preview representation 1620b of the second automatically-generated visual content item that is based on the user selected prompt including components 1604a through 1604d is different from the representation of the preview representation 1620a of the first automatically-generated visual content item shown in FIG. 16B. For example, the preview representation 1620b of the second automatically-generated visual content item includes mountains in the background and the subject in a hot air balloon while the representation of the preview representation 1620a of the first automatically-generated visual content item includes no mountains and a hot air balloon in the background. In FIG. 16D, in response to detecting the end of the navigation input 1624a and/or in response to displaying the preview representation 1620b of the second automatically-generated visual content item within the display area, the electronic device 500 updates indicator 1622b corresponding to preview representation 1620b with a solid visual appearance indicative of the preview representation 1620b being currently displayed. The electronic device 500 also updates indicator 1622a corresponding to preview representation 1620a with an outline visual appearance indicative of the preview representation 1620a not being currently displayed.

In FIG. 16D, the electronic device 500 detects a navigation input 1624b directed to preview representation 1620b of the second automatically-generated visual content item. In some embodiments, the navigation input 1624a is a swipe gesture (e.g., as described in more detail in method 1700). For example, a swipe gesture optionally includes contact on a touch-sensitive surface at a location corresponding to the preview representation 1620b followed by movement of the point of contact, and a lifting of the contact from the touch-sensitive surface. In some embodiments, the swipe gesture includes an air gesture (e.g., described in more detail in method(s) 700 and/or 1700).

In some embodiments, in response to detecting the navigation input 1624b directed to the preview representation 1620b of the second automatically-generated visual content item, the electronic device 500 moves the preview representation 1620c of the third automatically-generated visual content item off display area and moves the preview representation 1620d of the fourth automatically-generated visual content item into the display area as shown in FIG. 16F. In FIG. 16F, the electronic device 500 updates indicator 1622d corresponding to preview representation 1620d with a solid visual appearance indicative of the preview representation 1620d being currently displayed. The electronic device 500 also updates indicator 1622c corresponding to preview representation 1620c with an outline visual appearance indicative of the preview representation 1620c not being currently displayed. In FIG. 16F, the electronic device 500 displays, via the one or more display generation components, indicator 1622e that corresponds to an additional generative visual content not yet generated. As shown in FIG. 16F, indicator includes an open circle visual appearance that is optionally animated to indicate that generating the additional generative visual content is in progress.

In some embodiments, the electronic device 500 changes the subject of the automatically-generated visual content in response to user input corresponding to a request to change the subject. For example, in FIG. 16F, control element 1612 includes a name and image of the subject of the preview representations of the first through fourth automatically-generated visual content items (e.g., preview representations 1620a through 1620d). The subject is also included as a component (e.g., component 1604d) of the user selected prompt to influence the generation of automatically-generated visual content. In FIG. 16F, the electronic device 500 detects a selection input 1624e directed to the control element 1612. In some embodiments, the selection input is a tap or long press including contact on a touch-sensitive surface corresponding to the control element 1612, an air pinch gesture while the gaze of the user of the electronic device is directed to the control element 1612, a forward pointing in-air gesture directed to the control element 1612, actuation of an indirect input device, such as a mouse, trackpad, or controller while a cursor is directed to the control element 1612 (or, optionally, while the control element 1612 has input focus), and/or voice input from the user corresponding to the request to select the control element 1612 (e.g., perform an operation associated with the control element 1612 as described herein).

In some embodiments, in response to detecting the selection input 1624e directed to the control element 1612, the electronic device 500 displays subject personalization user interface element 1626a in the variants user interface 1600b as shown in FIG. 16G. As shown in FIG. 16G, the subject personalization user interface element 1626a is concurrently displayed with the preview representation 1620d of the fourth automatically-generated visual content, indicators 1622a through 1622e, the one or more visual indications (e.g., visual indication 1618), and options 1602a and 1602b. In FIG. 16G, the subject personalization user interface element 1626a includes subject user interface elements 1626g through 1626l. The subject user interface elements 1626g through 1626l represent candidate subjects that, when selected, are included the user selected prompt to influence generation of automatically-generated visual content as will be described and/or in more detail with reference to method(s) 1700, 2100 and/or 2300. In FIG. 16G, the subject personalization user interface element 1626a also includes a creation option 1626 that, when selected, causes the electronic device to display a subject creation user interface element to create a computer-generated subject for inclusion in the user selected prompt; a photo option 1626e that, when selected, causes the electronic device to open the camera application to take a photo of a subject for inclusion in the user selected prompt; a choose photo option 1626 that, when selected, causes the electronic device to open the photos application to select a photo of a subject from a photo library for inclusion in the user selected prompt; a clear option 1626b that, when selected, causes the electronic device to remove the currently selected subject as the subject included in the user selected prompt; a close option that, when selected, ceases to display the subject personalization user interface element 1626a without saving any changes made using the subject personalization user interface element 1626a; and/or a done option that, when selected, causes the electronic device 500 to cease display of subject personalization user interface element 1626a with changes to the subject saved. Option 1626b optionally corresponds to options 1868b, 2038c, and/or 2214a in FIGS. 18G-18BB, 20D-20AA, 22A-22CCC, and/or 26A-26P. Option 1626c optionally corresponds to options 1868c, 2038d, and/or 2214b in FIGS. 18G-18BB, 20D-20AA, 22A-22CCC, and/or 26A-26P.

In FIG. 16G, subject user interface element 1626j is currently selected (e.g., included in the user selected prompt to influence generation of automatically-generated visual content). The electronic device 500 displays subject user interface element 1626j with a visual appearance indicative of the subject user interface element 1626j being selected. The electronic device 500 also displays an edit option 1626jj associated with the subject user interface element 1626j that, when selected, causes the electronic device to display a user interface element for editing the subject as described in more detail with reference to method 2300.

In some embodiments, the electronic device 500 detects a selection input 1624 directed to subject user interface element 1626g. In some embodiments, the selection input is optionally analogous to and/or includes one or more characteristics of the selection input 1624e in FIG. 16F. In response to detecting the selection input directed to subject user interface element 1626g, the electronic device 500 displays a generation status indication 1628 indicative of the electronic device 500 initiating the process to generate one or more preview representations of automatically-generated visual content based on a user selected prompt that includes the subject associated with subject user interface element 1626g along with components 1604a through 1604d, as shown in FIG. 16H. In FIG. 16H, the electronic device 500 also displays subject user interface element 1626g with a visual appearance indicative of the subject user interface element 1626g being selected and an edit option 1626gg associated with the subject user interface element 1626g that, when selected, causes the electronic device to display a user interface element for editing the subject as described in more detail with reference to method 2300. The electronic device 500 also displays previously selected subject user interface element 1626j without the visual appearance indicative of being selected. In FIG. 16H, the electronic device 500 also ceases to display the create option 1602b because the process to generate one or more preview representations of automatically-generated visual content based on a user selected prompt that includes the subject associated with subject user interface element 1626g along with components 1604a through 1604d is currently in progress and that preview representations are not yet generated.

In FIG. 16I, the electronic device 500 determines that a first set of preview representations of respective automatically-generated visual content items have been generated and in response, the electronic device 500 displays, in the variants user interface 1600b, a preview representation of a first automatically-generated visual content item 1630a based on the user selected prompt that includes the subject associated with subject user interface element 1626g along with components 1604a through 1604d. The electronic device 500 also displays indicators 1634a through 1634c corresponding to the number of preview representations of respective automatically-generated visual content items available for display. In FIG. 16I, the electronic device 500 also displays the create option 1602b that, when selected, causes the electronic device to initiate generation of the first automatically-generated visual content item (e.g., display a higher fidelity and/or upscaled version of the first automatically-generated visual content item) described in more detail below.

In FIG. 16I, the electronic device 500 enables the user to edit the preview representation of a first automatically-generated visual content item 1630a. For example, in FIG. 16I, the electronic device 500 detects a selection input directed to location that does not include the preview representation of a first automatically-generated visual content item 1630a. In some embodiments, the selection input is optionally analogous to and/or includes one or more characteristics of the selection input 1624e in FIG. 16F. In response, the electronic device 500 displays the editing user interface 1600a, as shown in FIG. 16J. In some embodiments, the editing user interface 1600a in FIG. 16J includes one or more of the same user interface elements (e.g., pre-defined components 1608b through 1608f), selectable options (e.g., options 1608a, 1614, 1602a, and/or 1602b) and/or control elements (e.g., control elements 1610 and/or 1612) included in the editing user interface 1600a in FIG. 16A.

In FIG. 16J, the electronic device 500 changed the control element 1612 to include a name and image of the subject associated with the selected subject user interface element 1626g. FIG. 16J the electronic device 500 also displays components 1604a through 1604c and component 1604e representing the selected subject. In FIG. 16J, the electronic device 500 detects a selection input 1624g directed to content entry control element 1610, and in response to detecting the selection input 1624g directed to content entry control element 1610, the electronic device 500 displays a content entry user interface element 1640a in FIG. 16K. In FIG. 16K, the electronic device 500 detects a selection input 1624h directed to content entry user interface element 1640a. In some embodiments, selection inputs 1624g and 1624h are optionally analogous to and/or include one or more characteristics of the selection input 1624e in FIG. 16F.

In response to detecting selection input 1624h directed to content entry user interface element 1640a in FIG. 16K, the electronic device 500 displays keyboard user interface element 1646 in FIG. 16L. In FIG. 16L, the electronic device 500 detects one or more text entry inputs directed to the keyboard user interface element 1646 and in response, the electronic device 500 displays the text “crown” and an indication 1644 that the entered text is a recognized concept. Recognized concepts and the determination of recognized concepts is described in more detail with reference to method(s) 700, 800, and 2100. In some embodiments, the option 1640 includes an image representing the recognized concept. The electronic device 500 also displays a submit option 1640. In FIG. 16L, the electronic device 500 detects a selection input 1624i directed to the submit option 1640. In some embodiments, selection input 1624i is optionally analogous to and/or includes one or more characteristics of the selection input 1624i in FIG. 16F. In response to detecting the selection input 1624i, the electronic device 500 adds the recognized concept to the user selected prompt as illustrated with the display of component 1604e as shown in FIG. 16M. The electronic device 500 also displays a deletion option 1604ee that, when selected, causes the electronic device to remove component 1604e from the user selected prompt.

In FIG. 16M, the electronic device 500 also displays a generation status indication 1648 indicative of the electronic device 500 initiating the process to generate one or more preview representations of automatically-generated visual content based on a user selected prompt that includes added component 1604e along with components 1604a through 1604c, 1604e, and 1604f, as shown in FIG. 16H.

In FIG. 16N, the electronic device 500 determines that a first set of preview representations of respective automatically-generated visual content items have been generated and in response, the electronic device 500 displays, in the editing user interface 1600a, a preview representation 1650 of a first automatically-generated visual content item based on the user selected prompt that includes added component 1604e along with components 1604a through 1604c, 1604e, and 1604f, as shown in FIG. 16N. In FIG. 16N, the electronic device 500 detects a selection input 1624i directed to deletion option 1604aa associated with component 1604a.

In response to detecting selection input 1624i directed to deletion option 1604aa, the electronic device 500 removes component 1604a from the user selected prompt and displays a preview representation 1650 of the first automatically-generated visual content item based on the user selected prompt with the component 1604a removed as shown in FIG. 16O. In FIG. 16O the electronic device 500 detects a selection input 1624j directed to the preview representation 1650 of the first automatically-generated visual content item. In some embodiments, selection input 1624j is optionally analogous to and/or includes one or more characteristics of the selection input 1624i in FIG. 16F. In response to detecting selection input 1624j directed to the preview representation 1650 of the first automatically-generated visual content item, the electronic device 500 displays the variants user interface 1600b as shown in FIG. 16P.

In FIG. 16P, the variants user interface 1600b includes one or more of the same user interface elements (e.g., pre-defined components 1608b through 1608k), selectable options (e.g., options 1614, 1602a, and/or 1602b) and/or control elements (e.g., control elements 1610 and/or 1612) as the variants user interface element 1600b in FIG. 16B. Variants user interface 1600b also includes a preview representation 1652a of the first automatically-generated visual content item and one or more visual indications (e.g., visual indication 1656) representing the components 1604a through 1604c, 1604e, and 1604f that were previously displayed in the editing user interface 1600a in FIG. 16O. In some embodiments, visual indication 1656 includes one or more characteristics of visual indication 1618 in FIG. 16B.

In FIG. 16P, the electronic device 500 also displays indicators 1654a through 1654 corresponding to a first set of preview representations of automatically-generated content items based on the user selected and include one or more of the same characteristics of indicators 1622a through 1622d in FIG. 16B. In FIG. 16P, the electronic device 500 detects a navigation input 1624k directed to preview representation 1652a of the first automatically-generated visual content item. In some embodiments, the navigation input 1624k is a swipe gesture optionally analogous to and/or includes one or more characteristics of the navigation input 1624k in FIG. 16D. In some embodiments, in response to detecting the navigation input 1624k directed to the preview representation 1652a of the first automatically-generated visual content item, the electronic device 500 moves the preview representation 1652a of the first automatically-generated visual content item off display area and moves the preview representation 1652b of the second automatically-generated visual content into the display area as shown in FIG. 16Q. In FIG. 16Q, the electronic device 500 detects a selection input 1624i directed to create option 1602b. In some embodiments, selection input 1624j is optionally analogous to and/or includes one or more characteristics of the selection input 1624i in FIG. 16F. FIG. 16Q further illustrates the electronic device 500 detecting an input selecting option 1680, such as detecting contact 1603q (e.g., a tap or long press input). Other selection inputs, such as air gesture inputs, voice inputs, and/or inputs detected using hardware input device(s) are possible additionally or alternatively. In response to detecting selection of option 1680, the electronic device 500 displays a menu of options for preserving the currently-displayed variant of the automatically-generated visual content, as described in more detail below with reference to FIG. 16R′.

In response to detecting selection input 1624i directed to create option 1602b, the electronic device 500 displays, via the one or more display generation components, the content user interface 1600c that includes a higher fidelity and/or upscaled representation 1658 of the first automatically-generated visual content item as shown in FIG. 16R. In FIG. 16R, the electronic device 500 also includes an edit option 1602c that, when selected causes the electronic device 500 to return to the editing user interface 1600a in FIG. 16O; a close option 1602d that, when selected, causes the electronic device 500 to close the content user interface 1600c; and a share option 1602e that, when selected, causes the electronic device 500 to initiate a process to share the representation 1658 of the first automatically-generated visual content item to a second electronic device, different from the electronic device and/or to an application other than the content application, such as a messaging application, a notes application, an email application, a presentation application, a word processing application, a whiteboarding application, a sketching application, a spreadsheet application, a journaling application, and/or other content processing application. In some embodiments, the edit option 1602c corresponds to option 630a, the close option 1602d corresponds to option 630b, and the share option 1602e corresponds to the option 630c, shown in FIG. 6M. Options 1602c, 1602d, and 1602e optionally correspond to options 630a and/or 2242a, 630b and/or 2242b, and 630c and 2242c, respectfully, described above with reference to FIGS. 6A-6MM, 9A-9X, 18G-18BB, 20D-20AA, 22A-22CCC, and/or 26A-26P.

In FIG. 16R, the user interface 629h also includes the selectable option 675a, that when selected, causes the electronic device 500 to generate a three-dimensional (3D) version of the automatically-generated visual media shown in FIG. 16R. Alternatively, the electronic device 500 generates a new automatically-generated visual content item as a 3D automatically-generated visual content item using the one or more recognized concepts. In some embodiments, selectable option 627a is described in greater detail in FIG. 6Z.

FIG. 16R′ illustrates the electronic device 500 displaying selectable options 1682a through 1682c for preserving the currently-displayed variant of the automatically-generated visual content item. In some embodiments, the electronic device 500 displays options 1682a through 1682c in response to detecting the input selecting option 1680, such as the input described above with reference to FIG. 16R. As shown in FIG. 16R′, the electronic device 500 optionally displays options 1682a through 1682c overlaid on the user interface described above with reference to FIG. 16R′, which includes concurrently displaying options 1682a through 1682c with a variant of the generative visual media 1652b.

In response to detecting selection of the save option 1682a (e.g., based on a tap input or long press input based on contact 1603a), the electronic device 500 saves the currently-displayed variant of the automatically-generated visual content item to a media library of automatically-generated visual content. In response to detecting selection of the copy option 1682b (e.g., based on a tap input or long press input based on contact 1603b), the electronic device 500 copies the currently-displayed variant of the automatically-generated visual content item to a virtual clipboard of the electronic device 500. The electronic device 500 optionally pastes the currently-displayed variant of the automatically-generated visual content item into another user interface in response to receiving an input requesting to paste the contents of the virtual clipboard into the other user interface while the currently-displayed variant of the automatically-generated visual content item is saved with the virtual clipboard. In response to detecting selection of the share option 1682c (e.g., based on a tap input or long press input based on contact 1603c), the electronic device 500 presents additional selectable options that, when selected, cause the electronic device 500 to initiate a respective process to share the currently-displayed variant of the automatically-generated visual content item with a user account other than the user account of the electronic device 500. For example, the electronic device 500 transmits the currently-displayed variant of the automatically-generated visual content item to the other user account via a digital messaging service (e.g., encrypted messaging, instant messaging, email, or social media).

In some embodiments, after the electronic device 500 preserves the currently-displayed variant of the automatically-generated visual content item according to the selected option of options 1682a through 1682c, the electronic device 500 resumes display of the user interface shown in FIG. 16R. While the electronic device 500 displays the user interface shown in FIG. 16R, the electronic device 500 is able to receive one or more inputs requesting to preserve the currently-displayed variant of the automatically-generated visual content item in an additional manner. Additionally or alternatively, while the electronic device 500 displays the user interface shown in FIG. 16R, the electronic device 500 is able to receive one or more inputs requesting to present another variant of the automatically-generated visual content item. In response to receiving an input requesting to present another variant of the automatically-generated visual content item, the electronic device 500 presents the other variant of the automatically-generated visual content item with the option 1680 to preserve the now-displayed variant of the automatically-generated visual content item. In response to detecting selection of option 1680 while displaying the other variant of the automatically-generated visual content item, the electronic device 500 displays a menu of options 1682a through 1682c with options for preserving the other variant of the automatically-generated visual content item. Thus, option 1680 enables the electronic device 500 to present and/or preserve other variants of the automatically-generated visual content item after preserving a respective variant of the automatically-generated visual content item.

FIG. 16S illustrates the electronic device 500 displaying a user interface 1660 of a news aggregator application. For example, the news aggregator application presents news articles. In FIG. 16S, user interface 1660 includes a plurality of user interface elements. For example, the editing user interface 1600a includes a news article 1664 and a menu option 1662. In FIG. 16S, the electronic device 500 detects a selection input 1624m directed to the menu option 1662, and in response the electronic device 500 displays a menu user interface element 1666a that includes an option 1666b to initiate generation of one or more automatically-generated visual content items based on the news article 1664. In FIG. 16T, the electronic device 500 detects a selection input 1624n directed to option 1666b, and in response the electronic device 500 displays in user interface 1660 a representation 1668 of a first automatically-generated visual content item based on the news article 1664 in FIG. 16U. In some embodiments, the representation 1668 of a first automatically-generated visual content item is a summary of the news article 1664. In FIG. 16U, the electronic device 500 also displays indicator 1676 corresponding to representation 1668 and indicator 1676 indicative of the generation of additional generative visual content is in progress. The electronic device 500 also displays an option 1670 that, when selected, displays news article 1664; option 1672 that, when selected, causes the electronic device to save the first automatically-generated visual content item to a notes application; and option 1674 that, when selected, saves the first automatically-generated visual content item to the electronic device.

FIG. 17 illustrates a flow diagram illustrating a method in which an electronic device displays multiple variations of representations of automatically-generated visual content items in accordance with some embodiments of the disclosure in accordance with some embodiments of the disclosure. The method 1700 is optionally performed at first electronic device and/or electronic devices such as device 100, device 300, or device 500 as described above with reference to FIGS. 1A-1B, 2-3, 4A-4B and 5A-5H. Some operations in method 1700 are, optionally combined and/or order of some operations is, optionally, changed.

As described below, the method 1700 provides ways in which an electronic device displays multiple variations of representations of automatically-generated visual content items. Displaying multiple variations of representations of automatically-generated visual content items provides an intuitive way to display representations of different automatically-generated generative visual content efficient interactions between the user and the electronic device.

In some embodiments, a method 1700 is performed at an electronic device in communication with one or more display generation components and one or more input devices, such as electronic device 500 in communication with display generation component 504 as shown in FIG. 16A. In some embodiments, the electronic device has one or more characteristics of the electronic device described in method 700. In some embodiments, the display generation component(s) has (have) one or more characteristics of the display generation component described in method 700. In some embodiments, the one or more input devices have one or more characteristics of the one or more input devices described in method 700.

In some embodiments, while displaying, via the one or more display generation components, a representation of first generative visual content (e.g., the generative visual content item is described in greater detail in method(s) 700 and/or 800) based on a first prompt (e.g., the first prompt is optionally analogous to and/or includes one or more of the characteristics of the prompt described in greater detail in method(s) 700 and/or 800), the electronic device detects (1702a), via the one or more input devices, a navigation input including a movement component, such as input 1624a as shown in FIG. 16B.

For example, the electronic device optionally displays the representation of the first generative visual content in a user interface of a content application (e.g., as described in method 700 and/or as shown in FIG. 6KK), a user interface that includes information associated with the first prompt (e.g., as described in method 700 and/or as shown in FIG. 6JJ), an editing user interface (e.g., as described in method 800 and/or as shown in FIG. 6W), and/or other user interface (e.g., described below and/or in method(s) 700, 800, 1000, and/or 1200). In some embodiments, and as will be described in more detail below, the electronic device displays the representation of the first generative visual content in a user interface element (e.g., optionally in a preview mode-type of user interface element), such as a frame or container where representations of different generative visual content including the first generative visual content are displayed within the frame. In some embodiments, the user interface element includes a visual indication of the number of available generative visual content for display as will be described in more detail below.

In some embodiments, while (or after) displaying the representation of the first generative visual content, the electronic device detects an input (e.g., navigation input) from a user of the electronic device. For example, the input optionally includes a swipe gesture (e.g., as described in more detail below), a drag gesture (e.g., as described in more detail below), contact and movement on a touch-sensitive surface (e.g., touchscreen, trackpad, or touchpad), movement of a physical input device (e.g., movement of a hand held input device, such as a mouse, stylus, controller, or other motion tracking device that detects direction and/or magnitude of movement of the physical input device while it is being held in the hand of the user and/or rotating a physical click wheel or a rotatable input device, such as rotation of a digital crown), a voice input, a gaze of the user of the electronic device, and/or other predefined gesture or input (e.g., as described below, in method(s) 700 and/or 800, and/or as shown in FIG. 6KK).

In some embodiments, the input includes a movement component, such as movement of contact in a direction (e.g., horizontal, vertical, or diagonal) on a touch-sensitive surface. For example, the input includes touchdown of a contact on the touch-sensitive surface, movement of the contact, and liftoff of the contact from the touch-sensitive surface after the movement of the contact. In some embodiments, the movement component corresponds to movement within a predetermined area of the user interface. In some embodiments, the predetermined area is an area of the user interface that includes the user interface element (e.g., frame) described herein and in more detail below. In some embodiments, the movement component corresponds to movement of a portion of the user (e.g., hand, arm, and/or finger) of the electronic device in space as will be described in more detail below. In some embodiments, the input is optionally indirect and does not require contact on the touch-sensitive surface and/or contact within the predetermined area of the user interface described herein. In some embodiments, and as will be described herein, in response to detecting the input including the movement component, the electronic device navigates to a representation of a second generative visual content different from the first generative visual content. In some embodiments, the second generative visual content is one of a plurality (or, optionally, a predetermined number) of different generative visual content. In some embodiments, generating the first generative visual content and displaying a representation of first generative visual content includes generating a predetermined number of different generative visual content including the second generative visual content (e.g., described in method 700 and/or as shown in FIG. 6LL).

In some embodiments, in response to detecting the navigation input including the movement component, the electronic device displays (1702b), via the one or more display generation components, a representation of second generative visual content based on the first prompt, wherein the second generative visual content is different from the first generative visual content, such as representation 1620b as shown in FIG. 16D.

In some embodiments, displaying the representation of the second generative visual content is optionally analogous to and/or includes one or more of the characteristics of displaying the representation of the first generative visual content described in method 700 and/or as shown in FIG. 6KK. For example, the representation of the second generative visual content is optionally displayed as a preview for the second generative visual content. In some embodiments, the electronic device optionally displays respective representations of the different generative visual content including the representation of the second generative visual content in accordance with the movement component of the input as described herein. In some embodiments, displaying the representation of second generative visual content includes replacing the display of the representation of the first generative visual content. In some embodiments, the electronic device ceases to display the representation of the first generative visual content. In some embodiments, the electronic device displays the representation of second generative visual content adjacent to the representation of the first generative visual content. For example, the representation of second generative visual content and the representation of the first generative visual content are optionally displayed in a same frame or in different respective frames. In some embodiments, the representation of second generative visual content is displayed in front of and/or partially overlapping the representation of the first generative visual content. In some embodiments, the electronic device ceases to display the representation of the first generative visual content and displays the representation of the second generative visual content at a location at which the first representation of the first generative visual content had been displayed. Additional details and other examples of how and where the electronic device displays representations of generative visual content will be described below. In some embodiments, the second generative visual content is based on a same prompt and/or or same recognized concepts used for generating the first generative visual content as described in method 700 and/or as shown in FIG. 6JJ. In some embodiments, the second generative visual content differs from the first generative visual content as described in method 700 and/or as shown in FIG. 6LL. For example, the second generative visual content includes a second composition of subjects different from the first composition of subjects in the first generative visual content; a second size/scale of subject(s) larger or smaller than a first size/scale of subject(s) in the first generative visual content; and/or a second perspective that emphasizes subject(s) more or less than the first perspective in the first generative visual content. In some embodiments, the electronic device extrapolates (e.g., in a same style, mood, or direction) from the same prompt and/or the same recognized concepts used for generating the first generative visual content. In some embodiments, the electronic optionally expands upon the recognized concepts and/or generates additional details. For example, when the first generative visual content corresponds to the “tennis on the beach” example in method 700 and/or as shown in FIG. 6KK, the electronic device optionally generates a second generative visual content that includes an extension of the beach including the addition of palm trees and/or dunes. In another example, the electronic device optionally generates a third generative visual content, different from the first generative visual content and the second generative visual content, that includes the subject wearing articles of clothing typically worn when playing tennis, such as shorts, skirts, polo shirts, and/or tennis shoes. Other techniques for generating a variety of different generative visual content are described below and with reference to method 700.

Displaying a representation of second generative visual content based on the prompt used to generate the first generative visual content in response to an input including a movement component provides an intuitive way to display representations of different generative visual content and provides quick access to different generative visual content generated using a same prompt used to generate the first generative visual content without requiring the user to provide further inputs, thereby reducing the number of inputs and providing more efficient interactions between the user and the electronic device.

In some embodiments, detecting the navigation input includes detecting, via the one or more input devices, a swipe gesture, such as input 1624b as shown in FIG. 16D. In some embodiments, the swipe gesture is analogous to and/or includes one or more of the characteristics of the finger swipe gesture that is detected via the contact/motion module 130 described with reference to FIG. 1A. For example, the electronic device optionally detects contact (e.g., one or more fingers of the user) on a touch-sensitive surface (e.g., the one or more display generation components, the one or more input devices, or other touch-sensitive device) at a location corresponding to the representation of the first generative visual content (or, optionally, a representation of a respective generative visual content currently displayed within the frame) followed by movement of the point of contact, and a lifting of the contact from the touch-sensitive surface. In some embodiments, the electronic device determines a velocity of the movement component of the navigation input to distinguish a swipe gesture from a dragging input described in more detail below. For example, the electronic device optionally determines a velocity of the point of contact at or near the end of the navigation input (e.g., lift-off of the contact) followed by continued movement after the end of the input. Thus, in some embodiments, when the electronic device determines the continued motion at a first velocity higher than a second velocity (e.g., faster, quick motions), the electronic device determines the navigation input is a swipe and when the electronic device determines a second velocity lower than the first velocity (e.g., slower motions), the electronic device determines the navigation input is a dragging input as will be described in more detail below. In some embodiments, in response to (and/or while) detecting the swipe gesture, the electronic device moves (or transitions) between displaying the representation of the first generative visual content within the frame (or, optionally, display area) of a respective user interface to displaying the representation of the second generative visual content within the frame. In some embodiments, and as will be described in more detail below, moving between displaying the representation of the first generative visual content within the frame to displaying the representation of the second generative visual content within the frame gives the visual appearance of the representation of the first generative visual content being pushed out of the frame so that the representation of the second generative visual content replaces the representation of the first generative visual content within the frame. In some embodiments, and as will be described in more detail below, the electronic device displays less of the representation of the first generative visual content and more of the representation of the second generative visual content.

In some embodiments, the representation of the first generative visual content and the representation of the second generative visual content are part of a list of representations of generative visual content available for display. In some embodiments, the electronic device is configured to navigate through the list of representations of generative visual content in accordance with the movement component of the swipe gesture (e.g., amount (or distance) and/or direction). For example, while displaying the representation of the first generative visual content, the electronic device determines that the swipe gesture is a right to left swipe gesture (e.g., corresponding to a request to move forward in the list of representations of generative visual content). In some embodiments, in accordance with the determination that the swipe gesture corresponds to the request to move forward in the list, the electronic device displays the representation of the second generative visual content. In another example, in accordance with the determination that the swipe gesture is a left to right swipe gesture, the electronic device optionally moves backward in the list of representations of generative visual content. More details with respect to the manner in which the electronic device navigates through the list and displays a next (or, optionally, previous) representation of generative visual content is described in more detail below.

In some embodiments, the swipe gesture includes an air gesture. The air gesture is described in more detail with reference to method(s) 700, 800, 1000, and/or 1200. For example, the electronic device optionally detects an in-air gesture performed by a portion of the user (e.g., hand, arm, and/or finger) that involves detecting movement of the portion of the user in space (e.g., the physical environment of the user) without the portion of the user contacting the one or more input devices or an input element that is part of (or, optionally, in communication with) the electronic device (e.g., a touch-sensitive surface, the one or more display generation components, or other input controller described in FIG. 1A). In some embodiments, the electronic device detects that the air gesture includes the portion of the user moving while the user's gaze is directed to a respective representation of generative visual content. In some embodiments, the electronic device detects the air gesture (e.g., an air pinch gesture, such as two or more fingers of a user's hand such as the thumb and index finger moving together and touching each other) followed by motion of the hand in the direction of the desired navigation direction (e.g., flick of the wrist up, down, left, right, away, or toward the user). In some embodiments, in response to detecting the air gesture, the electronic device navigates through the list of representations of generative visual content available for display in accordance with the detected movement of the hand (e.g., speed and/or direction).

Displaying a representation of second generative visual content in response to a swipe gesture provides an intuitive way to navigate through different generative visual content without requiring the user to provide further inputs and without cluttering the display view available for viewing representations of generative visual content with additional navigation control user interface elements for navigating through the representations of generative visual content, thereby providing more efficient interactions between the user and the electronic device. In some embodiments, detecting the navigation input includes detecting, via the one or more input devices, a dragging input, such as 1624a as shown in FIG. 16C. In some embodiments, the dragging input has one or more characteristics of the dragging input described in method 700 and/or as shown in FIG. 6I. For example, a dragging input optionally includes contact on the touch-sensitive surface at a location corresponding to the representation of the first generative visual content followed by movement of the contact. In some embodiments, in response to (and/or while) detecting the dragging input, the electronic device moves the representation of the first generative visual content (e.g., drags the representation across the frame or display area). In some embodiments, as the electronic device drags the representation of the first generative visual content across the frame, the electronic device gradually ceases to display the representation of the first generative visual content (e.g., push out, slide out, or other transition animation) to reveal the representation of the second generative visual content. In some embodiments, when the electronic device detects an end of the dragging input (e.g., liftoff of the contact from the touch-sensitive surface after the movement of the contact), the electronic device fully displays the representation of the second generative visual content within the frame previously occupied by the representation of the first generative visual content.

In some embodiments, the electronic device detects the dragging input via an indirect input device, such as a mouse, trackpad, or other input device described herein. In some embodiments, when the dragging input is detected via an indirect input device, the electronic device displays, via the one or more display generation components, movement of a cursor along a path corresponding to trackpad inputs (e.g., finger touching a trackpad and moving in a direction and/or with a magnitude) or an input device input (e.g., movement of a hand held input device, such as a controller, mouse, stylus, or other motion tracking device that detects direction and/or magnitude of movement of the input device while it is being held in the hand of the user and/or rotating a physical click wheel or analog stick or a rotatable input device, such as rotation of a digital crown or other input device processed by input controllers of the electronic device). For example, the electronic device optionally moves the cursor (e.g., by moving the indirect input device or the finger of the user) to a location corresponding to a respective location of the representation of the first generative visual content. In some embodiments, while the cursor is directed to the representation of the first generative visual content, the electronic device detects movement of the cursor from right to left, and in response, the electronic device moves the representation of the first generative visual content across the frame in accordance with the movement of the indirect input device or the finger of the user to reveal the representation of the second generative visual content as described herein.

In some embodiments, the dragging input includes an air gesture described in more detail above and with reference to method(s) 700, 800, 1000, and/or 1200. For example, while the user's gaze is directed to the representation of the first generative visual content, the electronic device optionally detects the air pinch gesture (e.g., described above) followed by movement of the air pinch gesture. In some embodiments, in response to detecting the air pinch gesture, the electronic device moves the representation of the first generative visual content across the frame in accordance with the movement of the air pinch gesture to display the representation of the second generative visual content, such that the representation of the second generative visual content replaces the representation of the first generative visual content in the frame as described herein. In some embodiments, the electronic device detects a gesture other than an air pinch gesture, such as a forward pointing gesture (e.g., a forward movement of a user's hand while one or more fingers of the user's hand are extended towards the representation of the first generative visual content) or a tap and drag gesture with a finger of the user's hand (e.g., a forward movement by a finger of the user's hand such that the finger touches the representation of the first generative visual content or approaches within a threshold distance (e.g., 0.1, 0.1, 0.5, 1, 2, 3, 4, 5, or 10 centimeters) of the representation of the first generative visual content), followed by movement (e.g., left, right, or other direction) of the hand in the pointing gesture. In some embodiments, the electronic device gradually ceases to display the representation of the first generative visual content with a magnitude and/or direction corresponding to the detected movement of the hand of the user to reveal the representation of the second generative visual content as described herein. Displaying a representation of second generative visual content in response to a dragging input provides an intuitive way to navigate through different generative visual content without requiring the user to provide further inputs and without cluttering the display view available for viewing representations of generative visual content with additional navigation control user interface elements for navigating through the representations of generative visual content, thereby providing more efficient interactions between the user and the electronic device.

In some embodiments, displaying the representation of the second generative visual content includes displaying, via the one or more display generation components, a representation of a generative visual content item (e.g., thus, in some embodiments, the generative visual content is a generative visual content item as described with reference to method(s) 700, 800, 1000, 1200, 1400, 1500, 1700, 1900, 2100, and/or 2300), such as representation 1620c as shown in FIG. 16E. The generative visual content item is optionally analogous to and/or includes one or more of the characteristics of the generative visual content described above, in method(s) 700 and/or 800, and/or as shown in FIGS. 6L-6P.

In some embodiments, a generative visual content item includes individual generative visual content items, such as images, videos, animations, and/or the like. In some embodiments, the generative visual content item is part of a collection of generative visual content items that are based on the first prompt as described above. For example, the generative visual content item optionally includes (and/or is associated with) the first prompt including the one or more recognized concepts described with reference to method(s) 700 and/or 800, and/or as shown in FIG. 6FF.

In some embodiments, the second generative visual content is a generative visual content item of generative visual content generated based on the first prompt and is a variant of an artificial intelligence (AI) model's output described in method(s) 700, 800, 1400, 1500, 1900, and/or 2100. In some embodiments, the electronic device displays a representation of a first generative visual content item (e.g., a first variant) based on the first prompt that has its own distinct version of the generative visual content that is out by the AI model. In some embodiments, the electronic device displays the representation of the first generative visual content item having one or more characteristics, such as a first composition of objects and/or subjects, a first perspective, a first style, one or more first additional objects, or other differentiating factor(s) described above with reference to displaying the representation of the second generative visual content and/or with reference to method(s) 700, 800, and/or 1400, and/or as shown in FIGS. 6JJ-6LL. In another example, the electronic device displays a representation of a second generative visual content item (e.g., a second variant) based on the first prompt having a one or more second characteristics, different from the one or more characteristics of the representation of a first generative visual content item, such as a second style that is more cartoonish than the first style of the representation of a first generative visual content item. In some embodiments, the generative visual content item includes metadata that describes the generative visual content item, such as type of generative visual content item (e.g., image, video, animation, and/or text), creation date, and/or other information (e.g., size and/or captions). Providing a representation of a second generative visual content that includes a representation of a generative visual content item that is based on the prompt used to generate the first generative visual content provides quick access to different generative visual content generated using a same prompt used to generate the first generative visual content without requiring the user to provide further inputs, thereby reducing the number of inputs and providing more efficient interactions between the user and the electronic device.

In some embodiments, displaying the representation of the second generative visual content includes displaying, via the one or more display generation components, text-based content, such as representation 1668 as shown in FIG. 16U. In some embodiments, the text-based content is analogous to and/or includes one or more of the characteristics of the summarized text as described with reference to method 1400 and/or as shown in FIGS. 13E and/or 25K. For example, while displaying, via the one or more display generation components, a user interface of an application (e.g., an email application, a news application, a word processing application, a content application described in method 700 and/or as shown in FIG. 6KK, or other content generation application), the electronic device detects a sequence of one or more inputs, such as one or more selection inputs (e.g., described above with reference to detecting an input directed to a user interface element) corresponding to a request to refine, summarize, rewrite and/or transform text using one or more autonomous processes as described with reference to method(s) 700, 800, and/or 1400, and/or as shown in FIGS. 13D and 13E and/or 25K. In some embodiments, in response to detecting the sequence of one or more inputs, the electronic device displays text-based content based on the text identified (or, optionally, selected or included) in the request (e.g., impacted by the one or more autonomous processes). In some embodiments, the second generative visual content that includes text-based content differs from the text included in the request. For example, the text-based content is optionally a summary of the text, a reworded version of the text, content in a language, different from the language of the text, and/or other generated content that is based on the text.

In some embodiments, the text-based content is a first variant or first distinct form of visual information (e.g., content generated by an AI model described in method(s) 700, 800, 1400, 1500, 1900, and/or 2100) which is derived from the (e.g., original) text in the request but is optionally refined, summarized, rewritten, and/or transformed in a manner different from the original text. In some embodiments, the generative visual content item is part of a collection or set of a plurality of different text-based content variants generated by the AI model. In some embodiments, the electronic device detects a swipe gesture directed to the original text. For example, the swipe gesture is analogous to and/or includes one or more of the characteristics of the finger swipe gesture that is detected via the contact/motion module 130 described with reference to FIG. 1A. In some embodiments, in response to detecting the swipe gesture directed to the original text, the electronic device displays, via the one or more display generation components, a second variant, different from the first variant. For example, the second variant optionally includes less words than the first variant. In another example, the second variant optionally has a more formal tone than the first variant. In some embodiments, the electronic device detects a user input or gesture other than the swipe gesture directed to the original text. For example, in response to detecting a selection input (e.g., described above with reference to detecting an input directed to a user interface element) directed to a user interface element that, when selected, causes the electronic device to display, via the one or more display generation components, the second variant. Providing a representation of a second generative visual content that includes text-based content provides quick access to different generative visual content without requiring the user to provide further inputs, thereby reducing the number of inputs and providing more efficient interactions between the user and the electronic device.

In some embodiments, displaying the representation of the first generative visual content includes displaying the first generative visual content at a first location in a user interface, such as representation 1620a as shown in FIG. 16B. For example, the first location in the user interface at which the electronic device displays the first generative visual content optionally corresponds to a respective location of the frame or display area. In some embodiments, displaying the frame includes displaying a scrollable (e.g., responsive to detected navigation input(s), including swipe and/or drag inputs, described above) list of representations of different generative visual content including the first generative visual content and the second generative visual content. In some embodiments, the electronic device displays the frame in a manner in which the frame occupies a portion of the user interface, not the entire user interface. In some embodiments, the electronic device displays the frame in a central area or other area (e.g., top, bottom, left, or right) of the user interface. In some embodiments, displaying the frame that contains the representation of the first generative visual content includes displaying the frame overlaid onto the user interface. In some embodiments, and as will be described in more detail below displaying the frame includes displaying one or more indicators corresponding to a number of generative visual content available.

In some embodiments, in response to detecting the navigation input, the electronic device displays, via the one or more display generation components, the representation of the second generative visual content at the first location in the user interface, such as representation 1620b as shown in FIG. 16D. For example, the electronic device optionally ceases to display the representation of the first generative visual content at the first location in the user interface and displays the representation of the second generative visual content at the first location in the user interface. In some embodiments, the electronic device displays the representation of the second generative visual content within the frame that was previously occupied by the representation of the first generative visual content (e.g., before detecting the navigation input). Displaying a representation of second generative visual content at the first location in the user interface previously occupied by a representation of a first generative visual content in response to a navigation input provides an efficient manner in which to navigate and display different generative visual content without requiring the user to provide further inputs and without cluttering the display view with representations of different generative visual content, thereby providing more efficient interactions between the user and the electronic device.

In some embodiments, displaying the representation of the first generative visual content includes displaying the first generative visual content at a first location in the user interface, such as representation 1620a as shown in FIG. 16B. In some embodiments, displaying the representation of the first generative visual content at a first location in the user interface is analogous to and/or includes one or more of the characteristics of displaying the representation of the first generative visual content at the first location in the user interface described above. In some embodiments, in response to detecting the navigation input, the electronic device partially displays the representation of the second generative visual content at the first location, such as representation 1620b partially displayed as shown in FIG. 16C.

In some embodiments, partially displaying the representation of the second generative visual content is analogous to and/or includes one or more of the characteristics of displaying the representation of the second generative visual content including revealing the representation of the second generative visual content as described above. For example, in response to (and/or while) detecting the navigation input including the movement component (e.g., moving in a first direction), the electronic device optionally: moves the representation of the first generative visual content in the first direction until a moment when the representation of the first generative visual content is partially displayed or no longer displayed at the first location in the user interface (e.g., at the edge of the frame); and partially displays (or, optionally, fully displays) the representation of the second generative visual content at the first location in the user interface (e.g., within the frame). In some embodiments, when the electronic device detects an end of the navigation input (e.g., liftoff of the contact from the touch-sensitive surface after the movement of the contact, release of the in-air pinch gesture after the movement of the hand, release of the mouse button after movement of the cursor, or other event indicative of the end of the navigation input), the electronic device fully displays the representation of the second generative visual content at the first location in the user interface (e.g., within the frame). Partially displaying a representation of second generative visual content at the first location in the user interface previously occupied by a representation of a first generative visual content in response to a navigation input provides an efficient manner in which to navigate and display different generative visual content without requiring the user to provide further inputs and without cluttering the display view with representations of different generative visual content, thereby providing more efficient interactions between the user and the electronic device.

In some embodiments, while displaying the representation of the first generative visual content based on the first prompt, the electronic device concurrently displays, via the one or more display generation components, one or more indicators corresponding to (and/or indicating) a number of generative visual content available based on the first prompt, such as indicators 1622a through 1622d as shown in FIG. 16C.

For example, the electronic device displays, via the one or more display generation components, a page control user interface element or component adjacent to (e.g., below) the representation of the respective generative visual content (and/or the frame that includes the representation of the respective generative visual content). In some embodiments, the page control user interface element includes the one or more indicators corresponding to the number of generative visual content available based on the first prompt (e.g., available for display, via the one or more display generation components, in response to detecting the navigation input). In some embodiments, the one or more indicators are images, icons, or symbols. In some embodiments, the electronic device displays the page control user interface element in response to detecting user input corresponding to a request to display a generative visual content variants user interface as will be described in more detail below.

In some embodiments, the number of indicators the electronic device displays corresponds to the number of generative visual content available for display. For example, when the electronic device receives or obtains five representations of respective generative visual content, the electronic device displays, via the one or more display generation components, five indicators. In some embodiments, the electronic device displays a predetermined number of indicators (e.g., 3, 5, 7, or 10) even though there are more representations of respective generative visual content available for display.

In some embodiments, the one or more indicators show a position of current representation of a respective generative visual content in the list of representations of respective generative visual content. For example, when the electronic device displays the one or more indicators as a series of dot images, a solid dot image denotes the currently displayed representation of a respective generative visual content, and outlines of dots denote other representations of generative visual content in the sequence. Other visual characteristics, such as shape, size, color, and/or fill pattern, for distinguishing the currently-displayed representation of respective generative visual content from other representations of generative visual content in the sequence, are possible in some embodiments.

In some embodiments, in response to a tap gesture or other navigation input (e.g., as described above with reference to the electronic device detecting a navigation input including a movement component) directed to an edge (or, optionally, right or left edge) of the page control user interface element that contains the one or more indicators, the electronic device navigates to the next (or, optionally, previous) representation of the respective generative visual content. In some embodiments, in response to the electronic device detecting a tap gesture or other navigation input (e.g., including swipe and/or drag input(s)) directed to a particular dot image, the electronic device navigates to the particular representation of the respective generative visual content corresponding to the particular dot image selected. In some embodiments, navigating to the next (or, optionally, previous) representation or particular representation of the respective generative visual content includes displaying the representation of the respective generative visual content within the frame. In some embodiments, in response to detecting the navigation input, the electronic device updates the visual characteristic of a respective indicator (e.g., in accordance with detecting the navigation input) to indicate advancing (or, optionally, navigating) through the sequence of representations of respective generative visual content. Displaying one or more indicators corresponding to a number of generative visual content available based on the first prompt provides an indication of the number of available generative visual content and an indication of the position of the currently displayed generative visual content of the list of generative visual content which provides improved navigation without requiring the user to provide further inputs, thereby reducing the number of inputs and providing more efficient interactions between the user and the electronic device.

In some embodiments, the one or more indicators include a plurality of indicators having a first visual appearance and corresponding to a plurality of generative visual content available based on the first prompt, such as indicators 1622a through 1622c as shown in FIG. 16F. In some embodiments, the plurality of indicators are analogous to and/or include one or more of the characteristics of the one or more indicators corresponding to a number of generative visual content available based on the first prompt described above. In some embodiments, displaying the representation of the second generative visual content in response to detecting the navigation input includes displaying an indicator of the plurality of indicators corresponding to the representation of the second generative visual content with a third visual appearance that includes a larger size, different color, increased brightness, more distinct contrast (or, optionally, other visual property) and/or a visual effect that is more intense than the first visual appearance of the indicator when the electronic device did not display the representation of the second generative visual content. In some embodiments, displaying the indicator with the third visual appearance visually emphasizes the indicator relative to other indicators of the plurality of indicators.

In some embodiments, while displaying the one or more indicators, the electronic device concurrently displays, via the one or more display generation components, an indication of a third generative visual content being generated in response to detecting the navigation input, wherein the indication of the third generative visual content has a second visual appearance, different from the first visual appearance, such as indicator 1622e as shown in FIG. 16F.

For example, the indication of the third generative visual content being generated is optionally represented by the indicator having a second visual appearance, different from the third visual appearance of the indicator when the corresponding respective representation of the respective generative visual content is displayed. In some embodiments, the indicator with the second visual appearance is different from the first visual appearance of the indicator when the corresponding respective representation of the respective generative visual content is not displayed. For example, displaying the indicator with the second visual appearance optionally includes an open circle or other image to indicate that generating the third generative visual content is in progress (e.g., the third generative visual content is not yet generated). In some embodiments, the indicator with the second visual appearance is animated, such as a circular image that appears to spin or an open circle with a track that fills in a clockwise (or, optionally, counterclockwise) direction.

In some embodiments, in response to detecting the navigation input, the electronic device automatically initiates a process to generate for display the third generative visual content without requiring additional user input (e.g., without a separate input to generate a generative visual content based on the first prompt). In some embodiments, the electronic device detects a navigation input corresponding to an input to navigate to the last (or, optionally, penultimate, or second to last) indicator of the one or more indicators (or, optionally, the representation of the respective generative visual content corresponding to the last indicator), and in response to detecting the navigation input, the electronic device displays, via the one or more display generation components, the indicator with the second visual appearance as described herein (e.g., the indication of the third generative visual content being generated). In some embodiments, the electronic device displays the indicator with the second visual appearance adjacent to the one or more indicators.

In some embodiments, when the electronic device determines that generation of the third generative visual content is complete, the electronic device ceases to display the indicator with the second visual appearance or indication of the third generative visual content being generated. In some embodiments, ceasing to display the indicator with the second visual appearance or indication of the third generative visual content being generated includes displaying (or, optionally, replacing it with) the indicator with the first visual appearance as described herein and in more detail below with respect to displaying an indication of the third generative visual content. Displaying an indication of a third generative visual content being generated in response to detecting the navigation input provides feedback that another generative visual content is being generated for display without requiring the user to provide further inputs requesting that another generative visual content be displayed, thereby reducing the number of inputs and providing more efficient interactions between the user and the electronic device.

In some embodiments, displaying the indication of the third generative visual content includes, while the third generative visual content is being generated, displaying, via the one or more display generation components, the indication of the third generative visual content having the second visual appearance, such as indicator 1622e as shown in FIG. 16F. In some embodiments, displaying the indication of the third generative visual content having the second visual appearance is analogous to and/or includes one or more of the characteristics of the indicator having the second visual appearance described above with reference to the electronic device displaying an animated spinning circular image or the animated open circle with a track that fills in a clockwise (or, optionally, counterclockwise) direction or other indication of the third generative visual content being generated. In some embodiments, the electronic device ceases to display the indicator having the first visual appearance at the first location in the user interface (e.g., within the frame). In some embodiments, the electronic device replaces the indicator having the first visual appearance at the first location with the indication of the third generative visual content having the second visual appearance at the first location.

In some embodiments, in accordance with a determination that the third generative visual content has been generated, the electronic device displays, via the one or more generation components, the indication of the third generative visual content having the first visual appearance, different from the second visual appearance, such as, for example, the visual appearance of indicator 1622d as shown in FIG. 16F.

In some embodiments, when the electronic device determines that generation of the third generative visual content is complete, the electronic device ceases to display the indication of the third generative visual content having the second visual appearance at the first location in the user interface. In some embodiments, ceasing to display the indication of the third generative visual content having the second visual appearance includes displaying (or, optionally, replacing it with) the indicator with the first visual appearance at the first location in the user interface as described above with reference to displaying an indicator with the first visual appearance.

In some embodiments, the electronic device detects a navigation input corresponding to an input to navigate to the representation of the third generative visual content (or, optionally, the indicator with the first visual appearance corresponding to the representation of the third generative visual content). In some embodiments, in response to detecting the navigation input, the electronic device displays, via the one or more display generation components, the representation of the third generative visual content (e.g., within the frame) in the user interface and displays the indicator having the third visual appearance described above which indicates that the currently displayed representation is the representation of the third generative visual content. In some embodiments, in accordance with a determination that the third generative visual content has not been generated, the electronic device continues to display the indication of the third generative visual content having the second visual appearance at the first location in the user interface. In some embodiments, in response to detecting the navigation input corresponding to the input to navigate to the representation of the third generative visual content as described herein, and while the electronic device is displaying the indication of the third generative visual content having the second visual appearance (e.g., indicative of the third generative visual content being generated), the electronic device displays, via the one or more display generation components, an animated image indicative of the third generative visual content being generated within the frame of the user interface. In some embodiments, in accordance with a determination that the third generative visual content has been generated, the electronic device displays the representation of the third generative visual content within the frame and ceases to display the animated image indicative of the third generative visual content being generated. In some embodiments, the electronic device replaces the indication of the third generative visual content having the second visual appearance with the indicator having the third visual appearance, wherein the indicator having the third visual appearance includes the visual appearance described above which indicates that the currently displayed representation is the representation of the third generative visual content. In some embodiments, the electronic device repeats the processes of displaying the indication of the third generative visual content having the second visual appearance (e.g., indicative of the third generative visual content being generated) in response to the navigation input multiple times. In some embodiments, the electronic device sequentially adds indications of respective generative visual content having the second visual (or, optionally, the first visual appearance) for display in page control user interface element (e.g., as described above) as the electronic device detects navigation inputs (e.g., as additional representations of respective generative visual content are generated). Displaying an indication that the third generative visual content has been generated provides feedback that the generative visual content is available for display without requiring the user to provide further inputs to check the status and/or progress of generating the third generative visual content for display, thereby reducing the number of inputs and providing more efficient interactions between the user and the electronic device.

In some embodiments, prior to displaying the representation of the first generative visual content, the electronic device detects, via the one or more input devices, one or more inputs providing the first prompt, such as input 1624 directed to element 1626g as shown in FIG. 16G. In some embodiments, detecting the one or more inputs providing the first prompt includes detecting one or more text entry (or, optionally, handwritten) inputs using a soft (e.g., virtual) keyboard user interface element, a physical (e.g., hardware) keyboard, touchpad, stylus, and/or dictation as described in method(s) 700 and/or 800, and/or as shown in FIGS. 6G and 6V. In some embodiments, the hardware keyboard is included in the one or more input devices in communication with the electronic device. In some embodiments, the electronic device detects dictation by detecting speech via a microphone included in the one or more input devices. In some embodiments, detecting the one or more inputs providing the first prompt includes detecting selection of a representation of a concept (e.g., a computer-generated suggested concept or a predefined concept) using a swipe input, a dragging input, a tap input, and/or gaze input as described in method(s) 700 and/or 800, and/or as shown in FIGS. 6B-6E. In some embodiments, detecting the one or more inputs providing the first prompt includes detecting content entry (e.g., image and/or video) as described in method(s) 700, 800, and/or 1200, and/or as shown in FIGS. 11B-11E. In some embodiments, in response to detecting the one or more inputs providing the first prompt and before detecting the navigation input, the electronic device generates (e.g., using an AI process or a generative AI process) a first set of generative visual content including the first generative visual content and the second generative visual content without generating one or more additional generative visual content, such as a set of generative visual content corresponding to indicators 1632a through 1634c as shown in FIG. 16I.

In some embodiments, the electronic device generates (e.g., using an AI process or a generative AI process) a first set of generative visual content based on the first prompt. In some embodiments, the first set includes the first generative visual content and the second generative visual content. In some embodiments, the first set of generative visual content are available for display, via the one or more display generation components. In some embodiments, the electronic device is configured to generate for display a second set of generative visual content which include one or more additional generative visual content in response to detecting the navigation input described herein. In some embodiments, in response to detecting the navigation input, the electronic device initiates a process to generate the one or more additional generative visual content (e.g., third generative visual content, fourth generative visual content, fifth generative visual content and/or other generative visual content) based on the first prompt, wherein the one or more additional generative visual content are different from the first set of generative visual content, such as navigation input 1624d as shown in FIG. 16E and displaying indicator 1622e indicative of additional generative visual content being generated in FIG. 16F.

In some embodiments, detecting the navigation input is analogous to and/or includes one or more characteristics of detecting the navigation input as described in more detail above with reference to detecting a swipe gesture, a drag gesture, and/or other gesture corresponding to a request to navigate through the plurality of generative visual content. In some embodiments, initiating a process to generate the one or more additional generative visual content based on the first prompt (e.g., the second set of generative visual content) includes using one or more autonomous processes as described with reference to method(s) 700, 800, and/or 1400, and/or as shown in FIGS. 6JJ-6LL. In some embodiments, the electronic device automatically initiates the process to generate the one or more additional generative visual content based on the first prompt (e.g., without a separate user input or without explicit instructions to generate additional generative visual content).

In some embodiments, the one or more additional generative visual content are based on a same prompt and/or or same recognized concepts used for generating the first generative visual content and the second generative visual content as described in method 700 and/or as shown in FIG. 6JJ. In some embodiments, the one or more additional generative visual content differs from the first set of generative visual content as described in method 700 and/or as shown in FIG. 6LL. For example, the one or more additional generative visual content include a different composition of objects and/or subjects, a different perspective, a different style, one or more additional objects, or other differentiating factor(s) described above with reference to displaying the representation of the second generative visual content and/or with reference to method(s) 700, 800, and/or 1400, and/or as shown in FIGS. 6JJ-6LL. Initiating a process to generate one or more additional generative visual content based on the first prompt in response to detecting the navigation input provides an intuitive way to display representations of different generative visual content and provides quick access to different generative visual content generated using a same prompt used to generate the first set of generative visual content without requiring the user to provide further inputs, thereby reducing the number of inputs and providing more efficient interactions between the user and the electronic device.

In some embodiments, while displaying the representation of the second generative visual content, the electronic device detects, via the one or more input devices, an input directed to a user interface element, such as input 1624i directed to element 1602b as shown in FIG. 16Q. In some embodiments, while displaying the representation of the first generative visual content, the representation of the second generative visual content, or the representation of other generative visual content, the electronic device displays the user interface element. In some embodiments, the input directed to the user interface element includes a selection input, such as a tap or long press including contact (e.g., using a finger or stylus) on a touch-sensitive surface corresponding to the user interface element, an air pinch gesture while the gaze of the user of the electronic device is directed to the user interface element, a forward pointing in-air gesture directed to the user interface element, actuation of an indirect input device, such as a mouse, trackpad, or controller while a cursor is directed to the user interface element (or, optionally, while the user interface element has input focus), and/or voice input from the user corresponding to the request to select the user interface element (e.g., perform an operation associated with the user interface element as described herein).

In some embodiments, in response to detecting the input, the electronic device displays, via the one or more display generation components, a second representation of the second generative visual content, wherein the second representation of the second generative visual content is of higher fidelity than the representation of the second generative visual content, such as representation 1658 as shown in FIG. 16R. In some embodiments, and as described above with reference to displaying the representation of the second generative visual content, the representation of the second generative visual content is optionally displayed as a preview for the second representation of the second generative visual content. In some embodiments, displaying the higher fidelity second representation of the second generative visual content is analogous to and/or includes one or more characteristics of displaying the higher fidelity representation of a respective generative visual content described in method 700 and/or as shown in FIG. 6Z. For example, displaying the higher fidelity, second representation of the second generative visual content optionally includes displaying an upscaled version of the second generative visual content having a resolution higher resolution than the respective resolution of the representation of the second generative visual content. In some embodiments, the manner in which the electronic device transitions from displaying the representation of the second generative visual (e.g., the preview of the second generative visual content) to displaying the higher fidelity, second representation of the second generative visual content (e.g., the upscaled version of the second generative visual content) and vice-versa, does not appear to the user of the electronic that the second generative visual content has changed dramatically. Displaying a higher fidelity representation of the second generative visual content in response to detecting an input

provides quick access to the higher fidelity representation of the second generative visual content without requiring the user to provide further inputs, thereby reducing the number of inputs and providing more efficient interactions between the user and the electronic device.

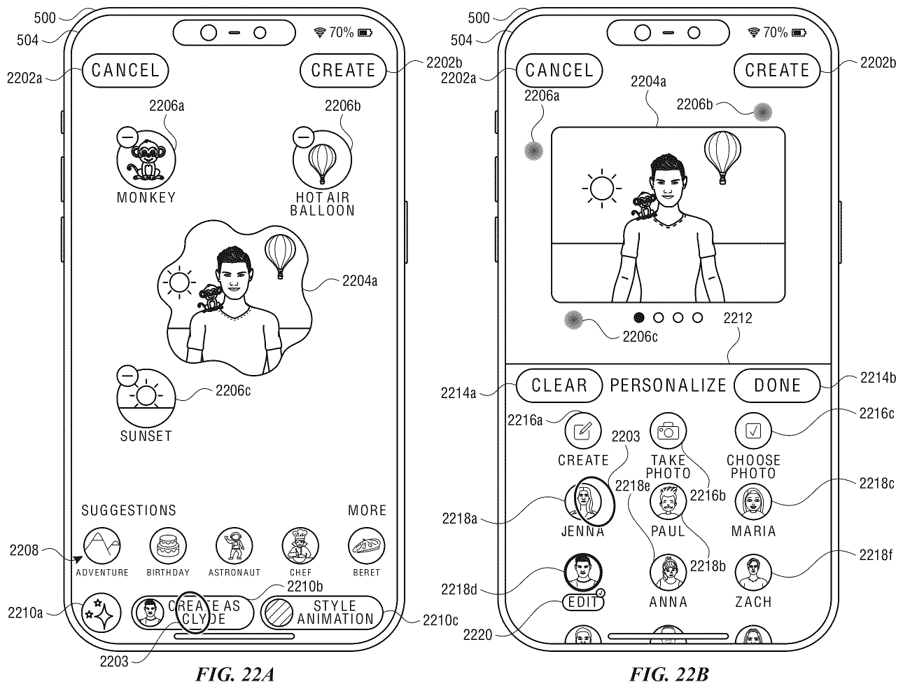

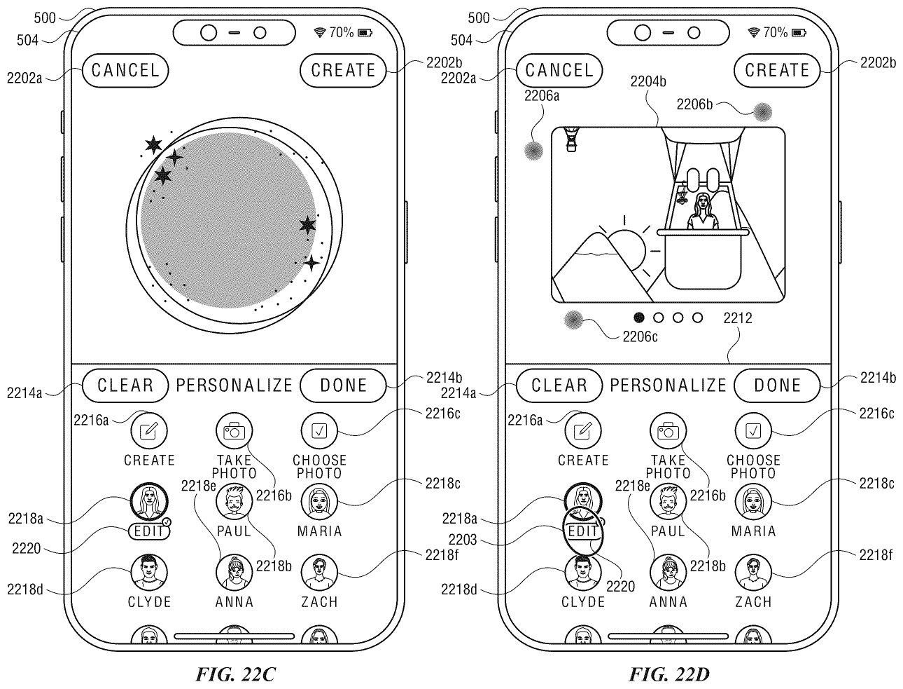

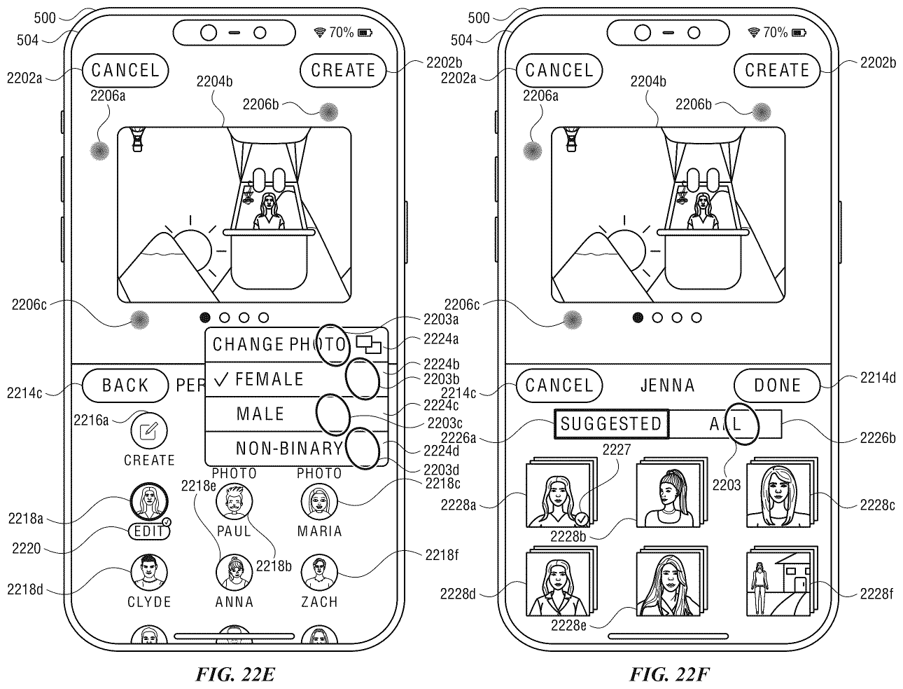

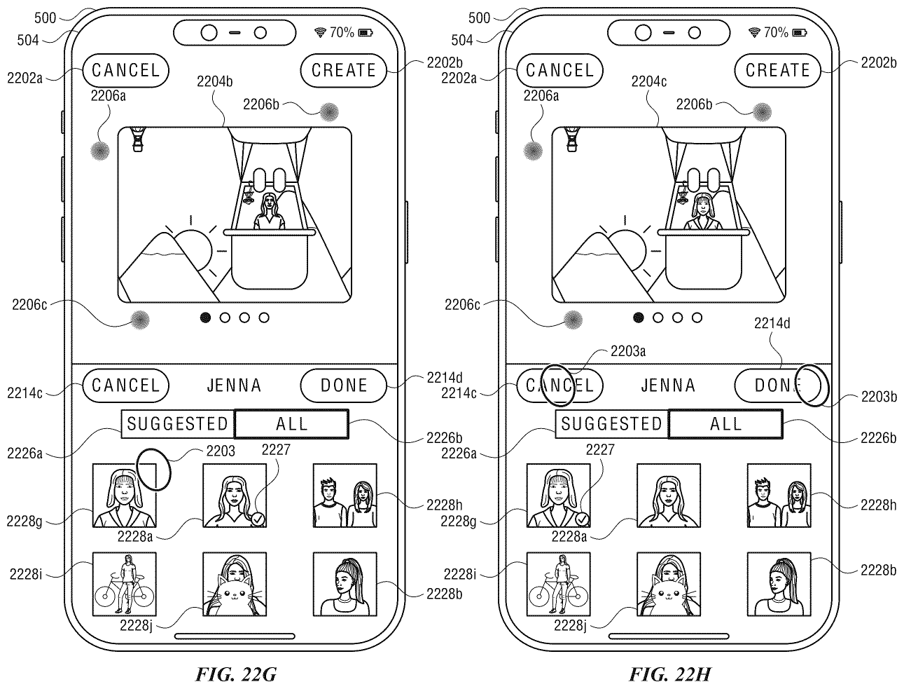

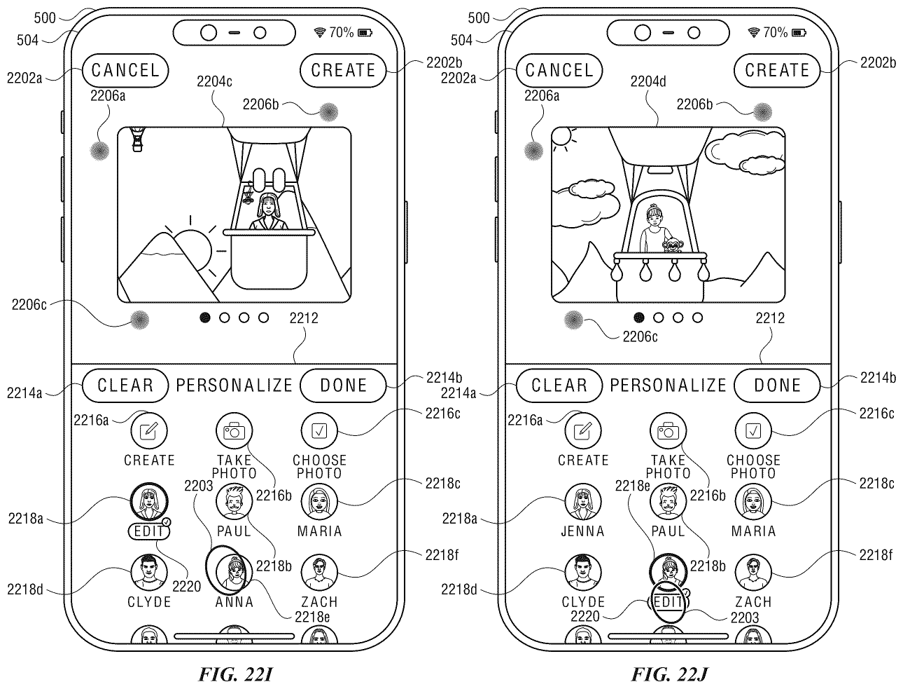

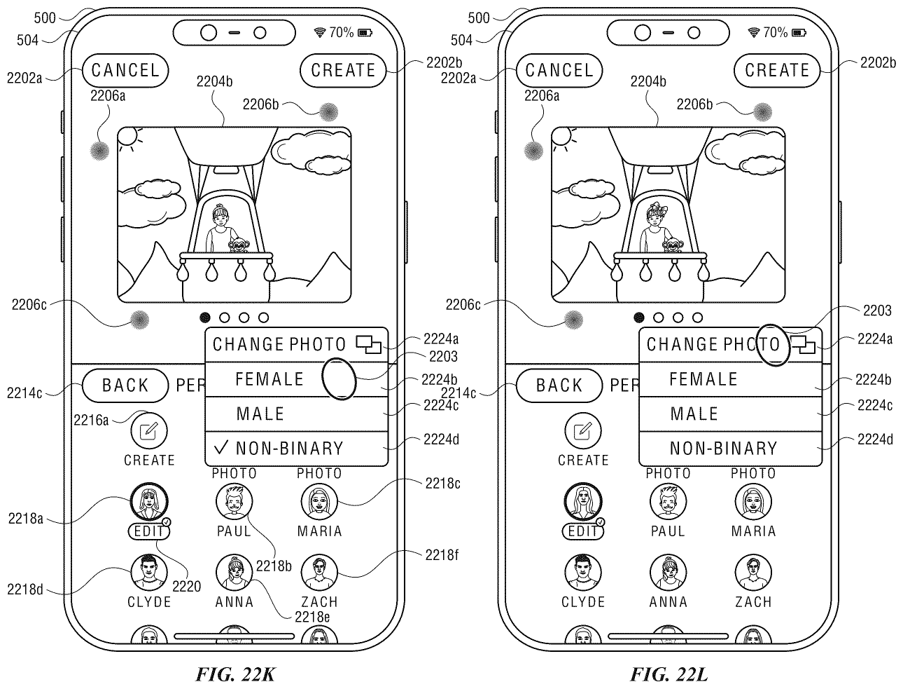

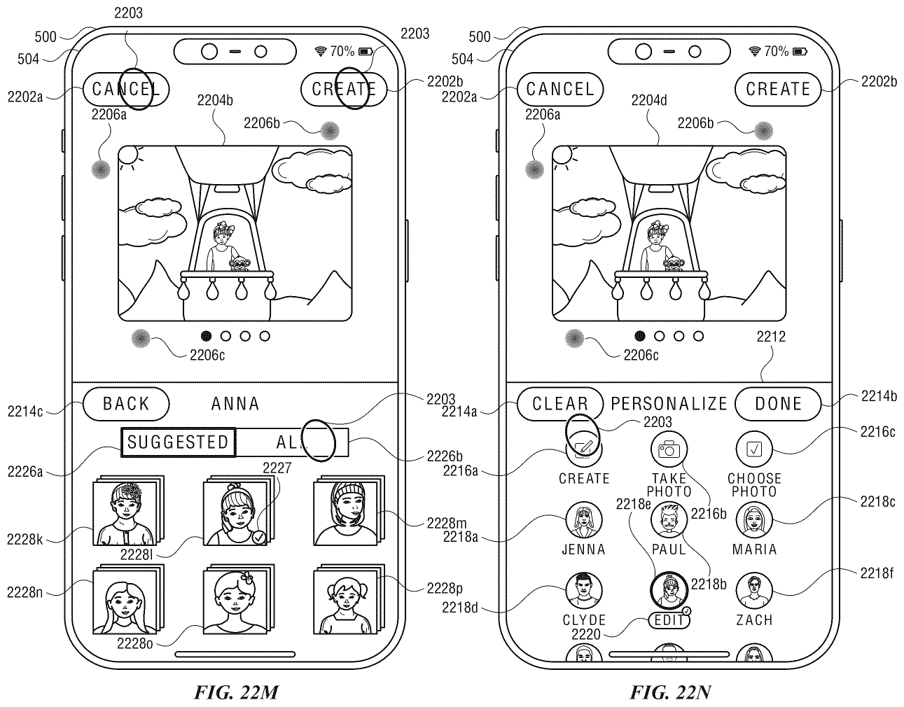

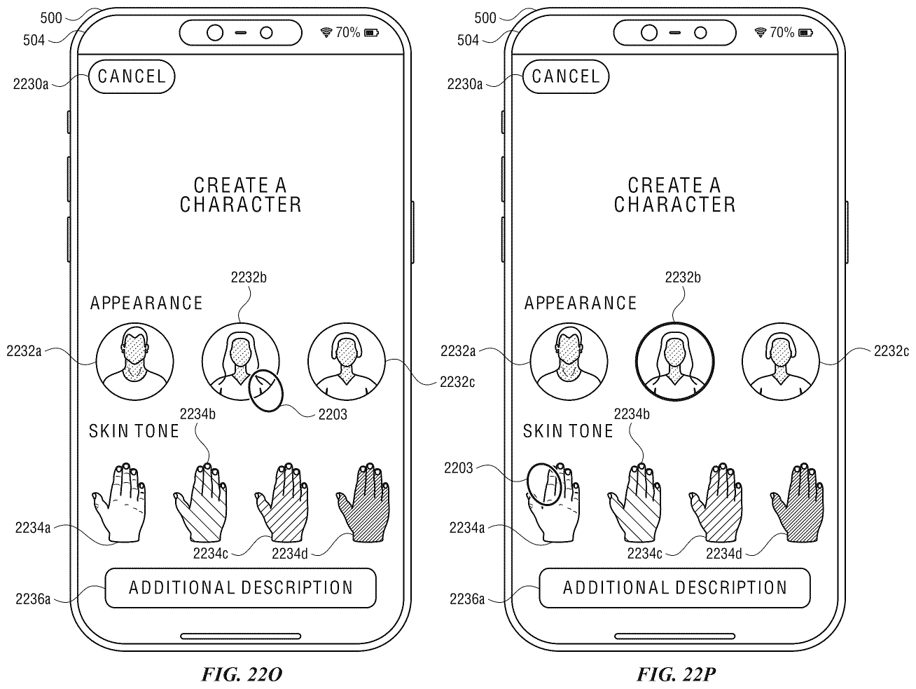

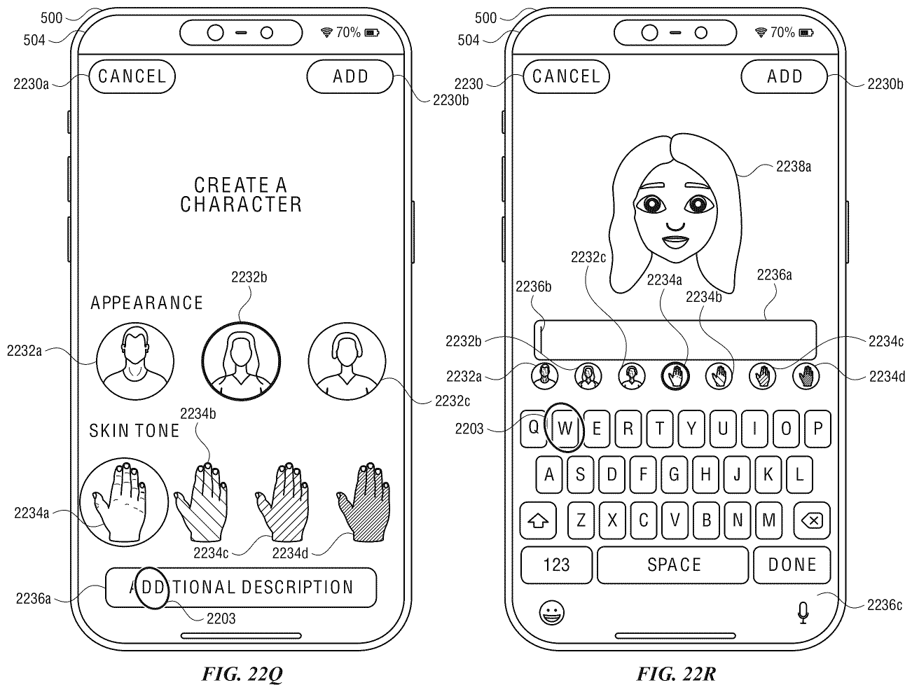

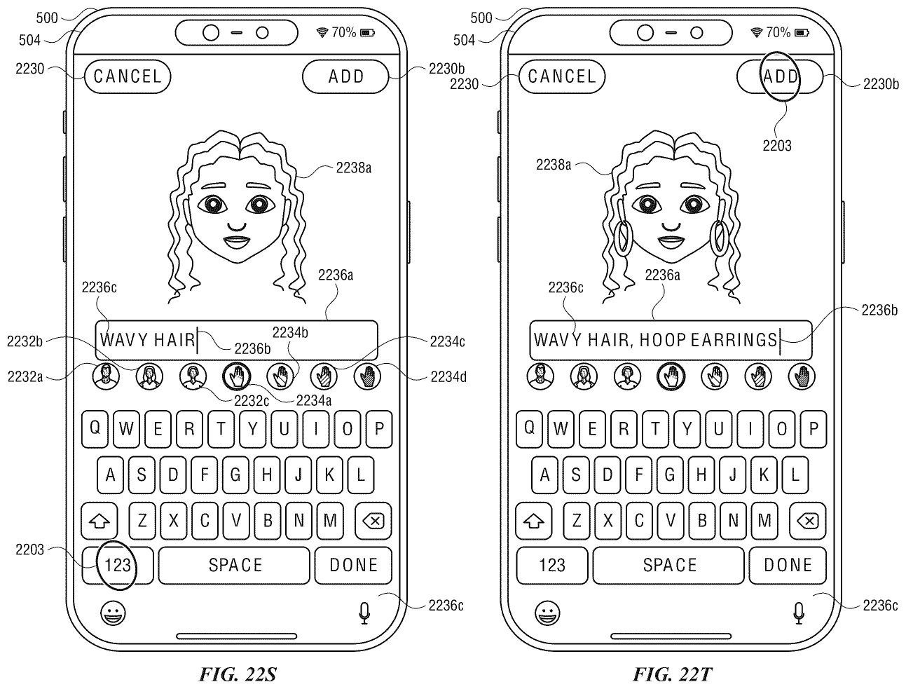

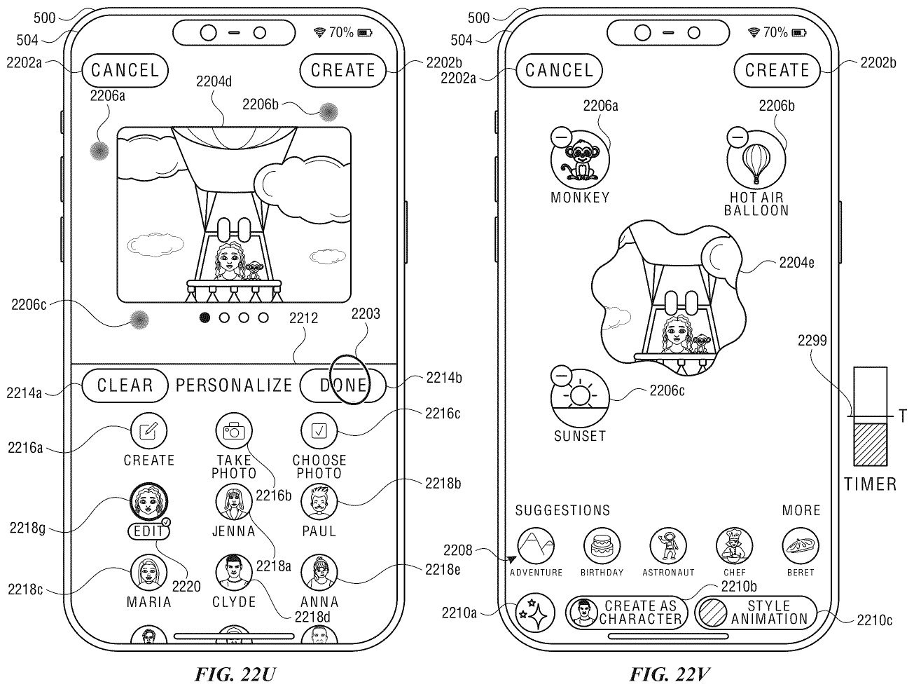

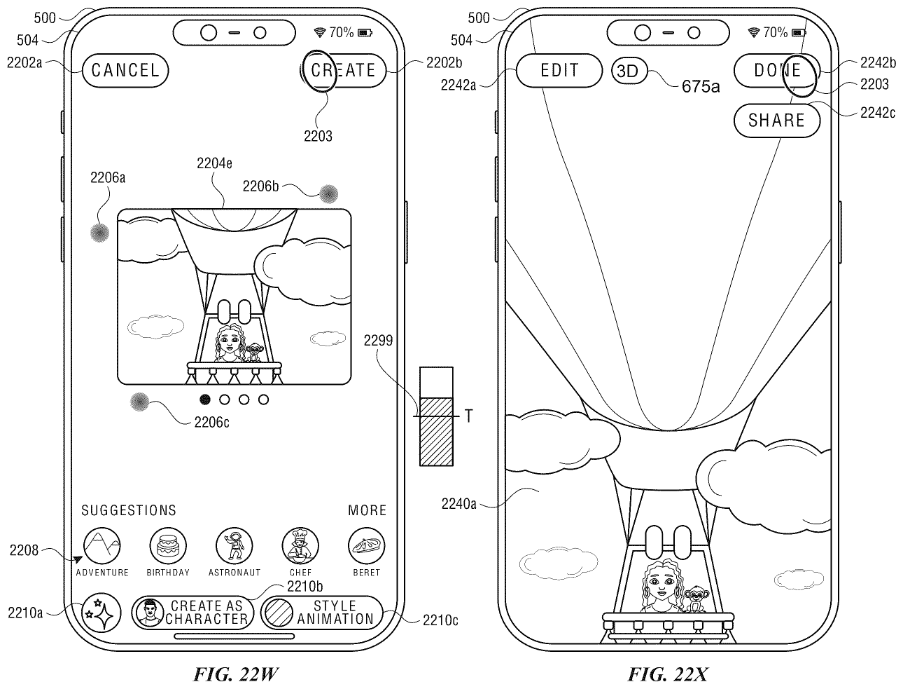

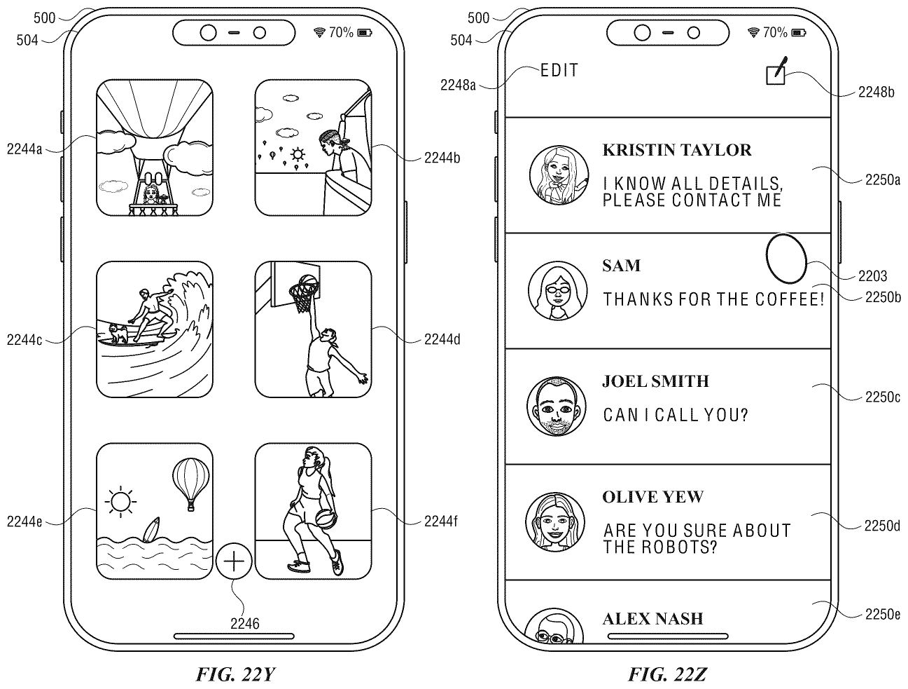

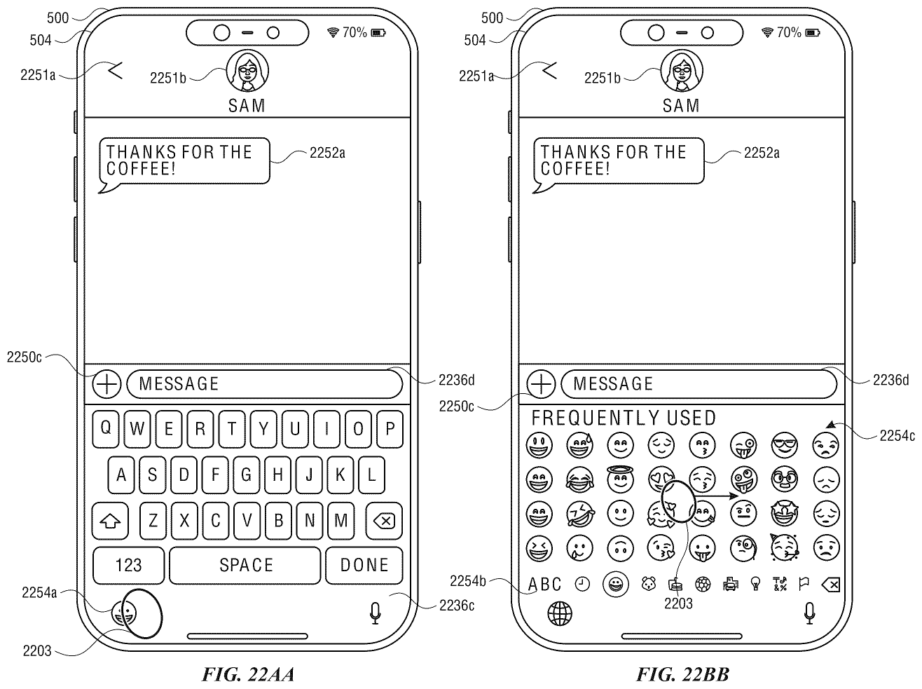

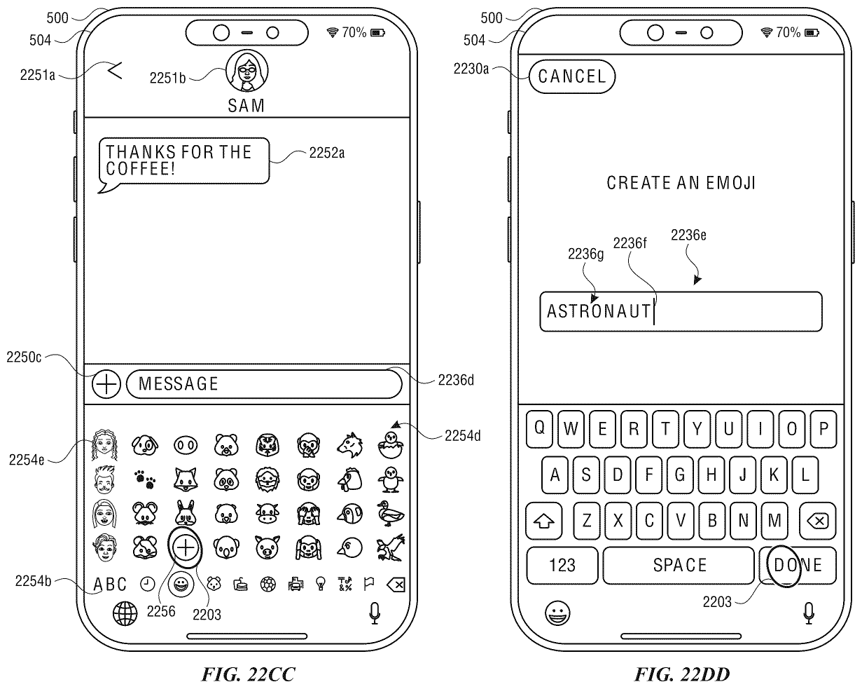

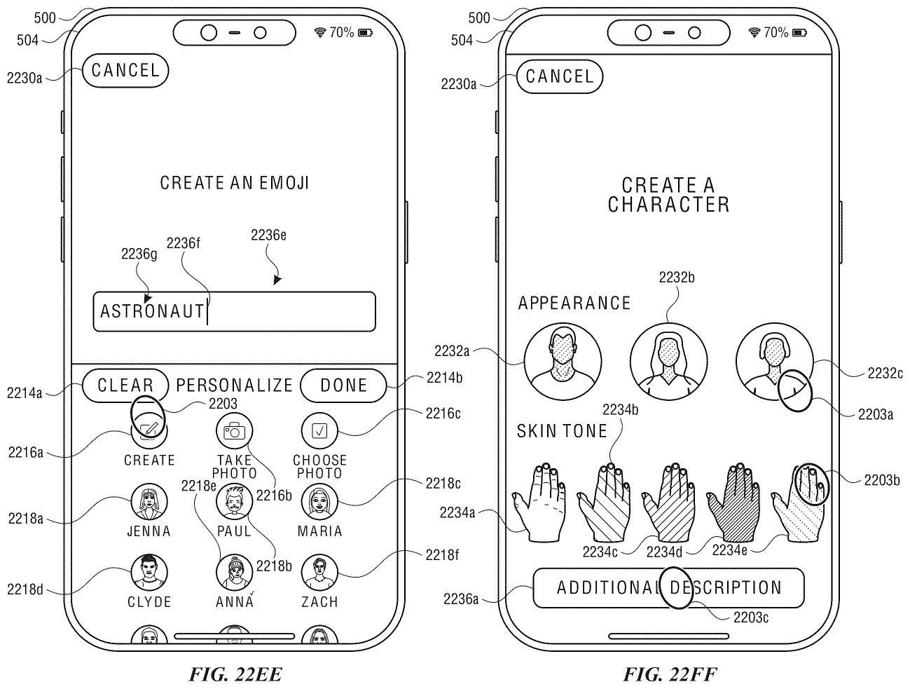

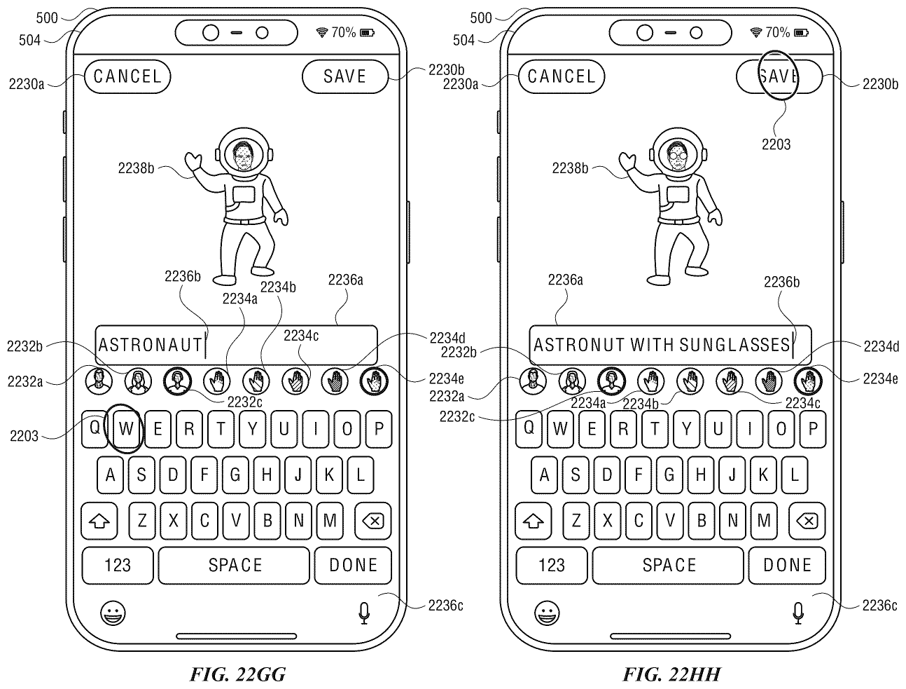

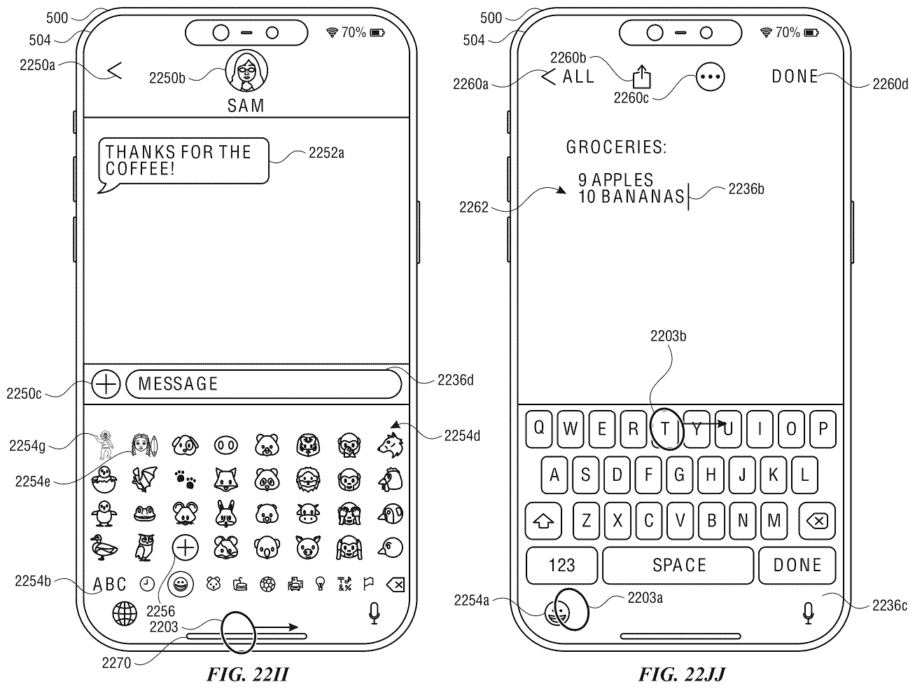

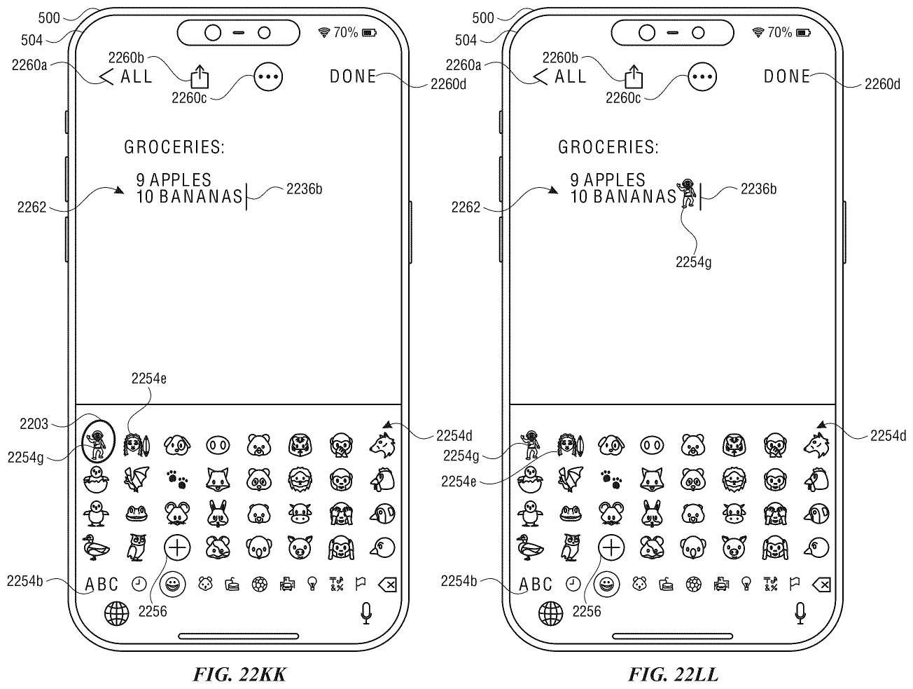

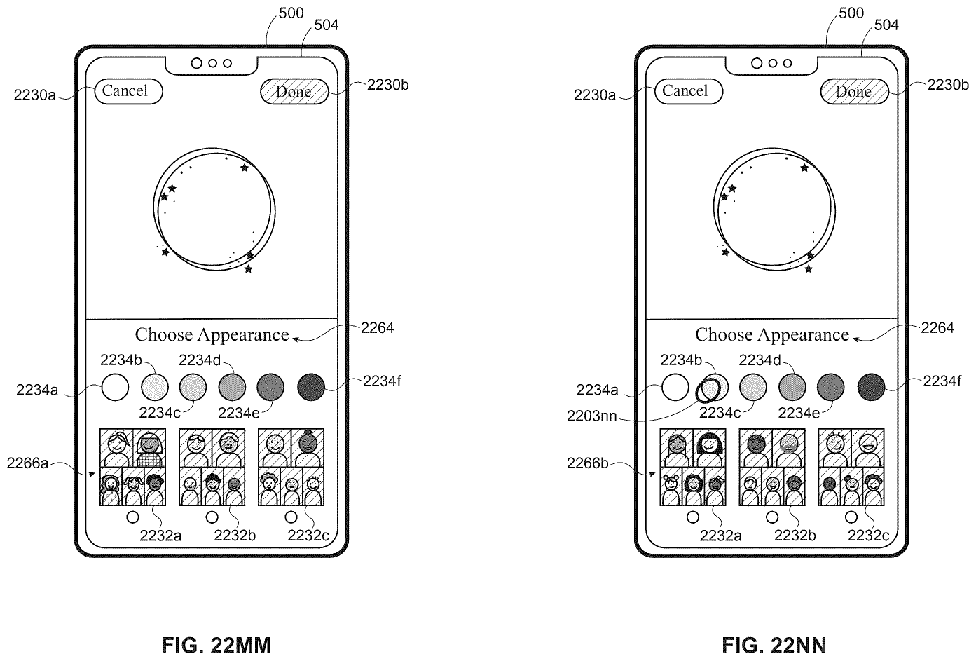

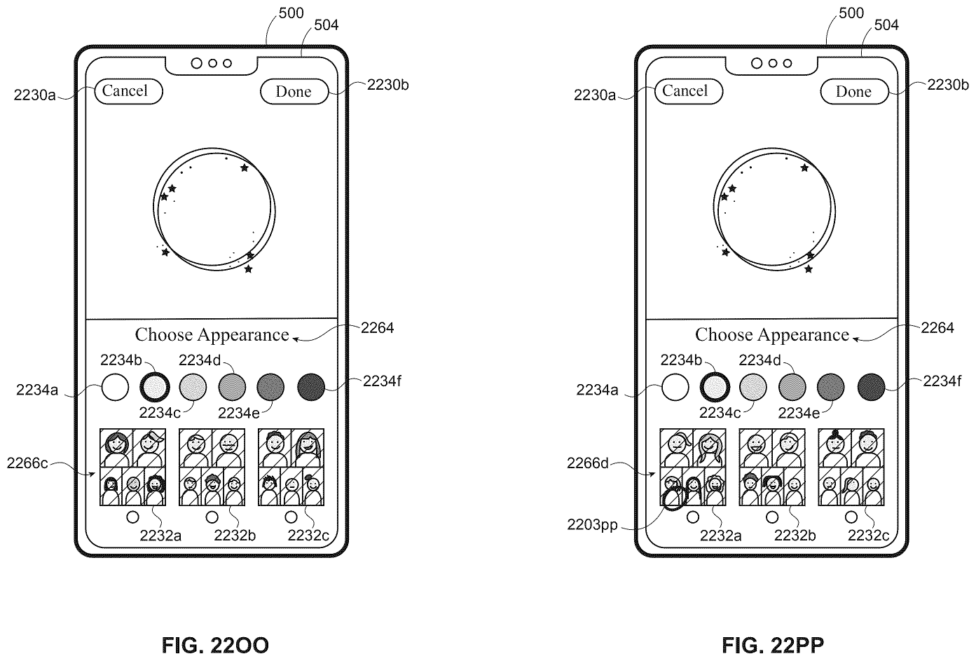

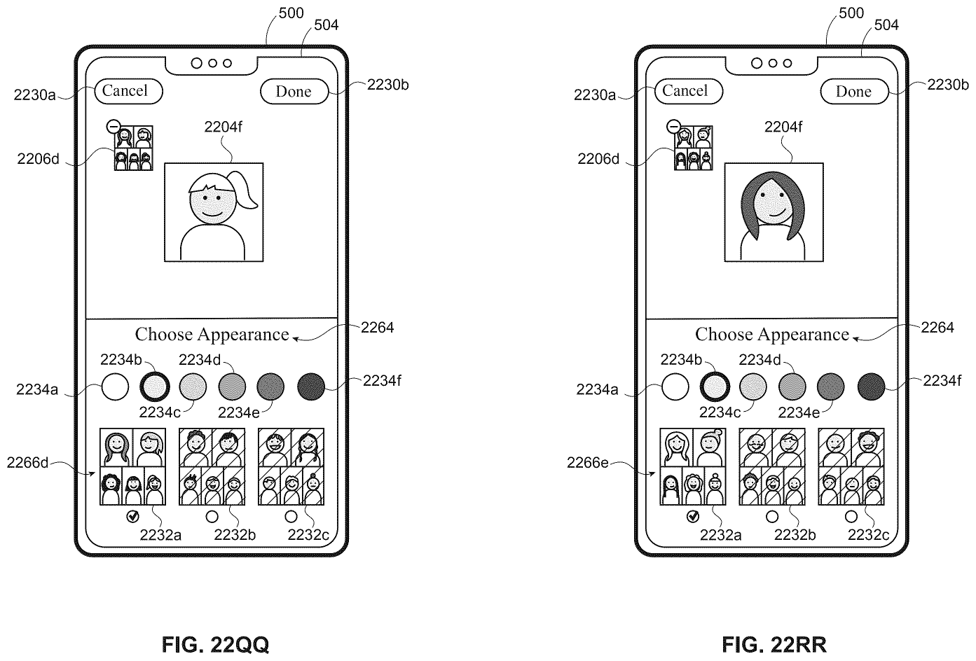

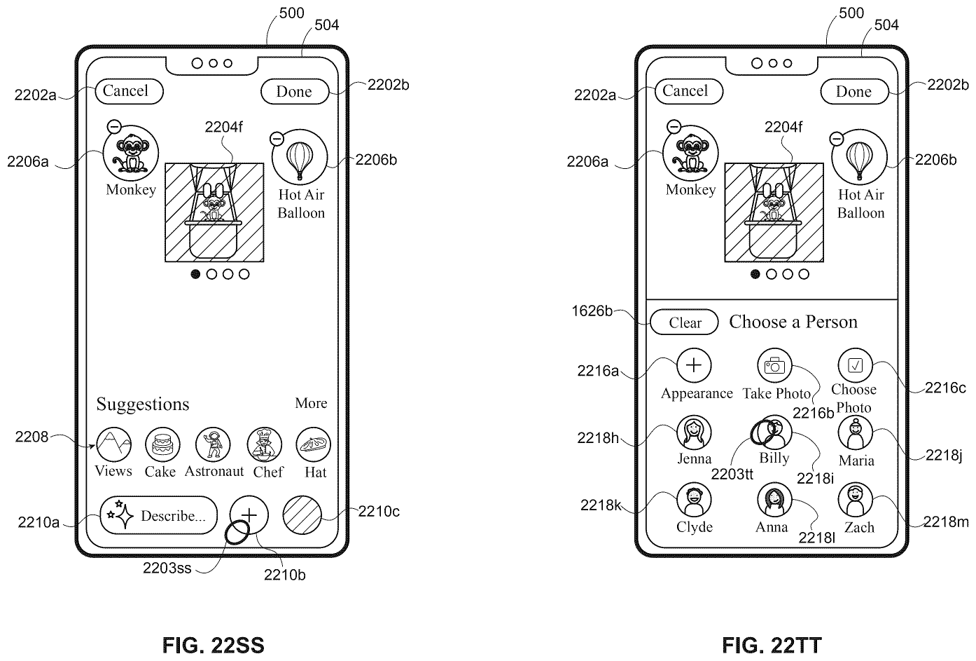

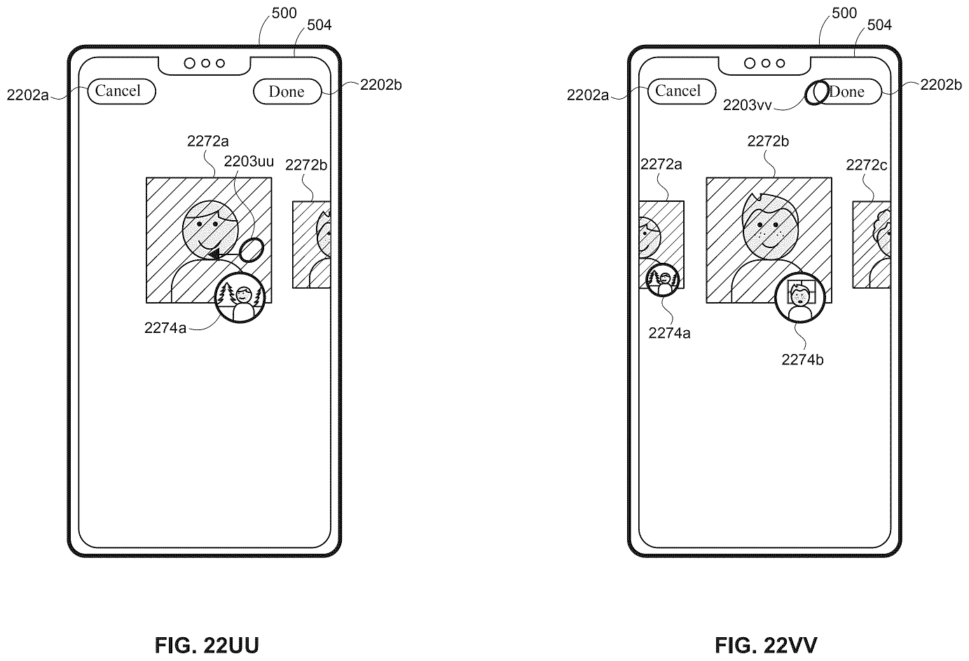

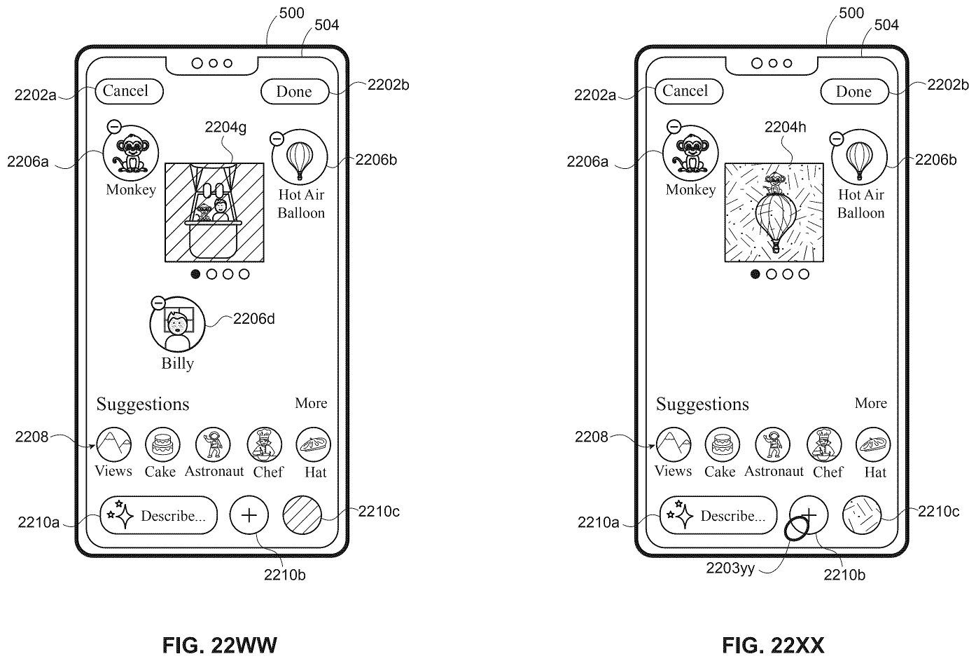

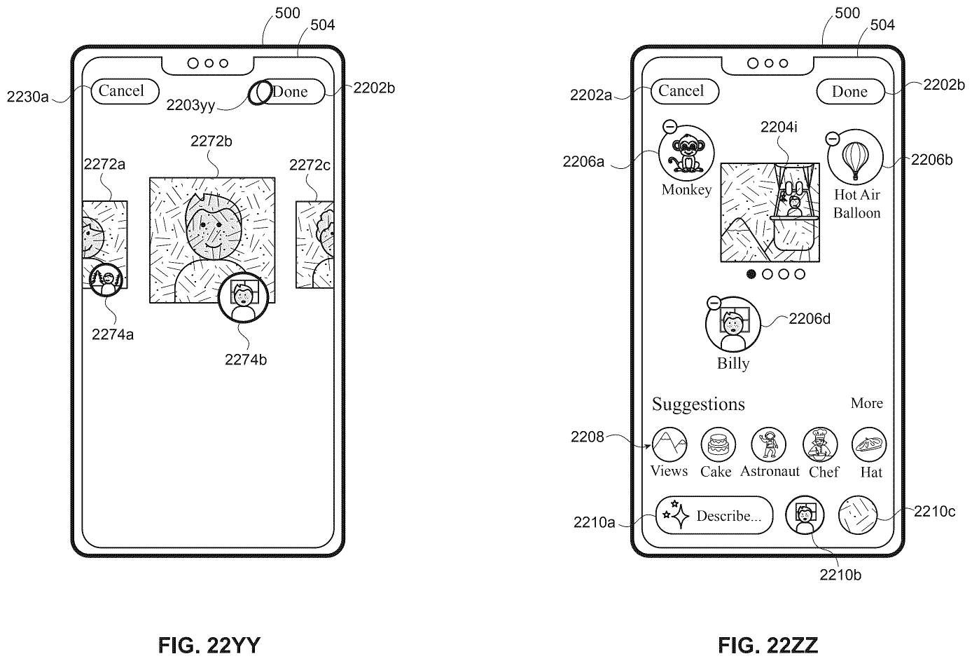

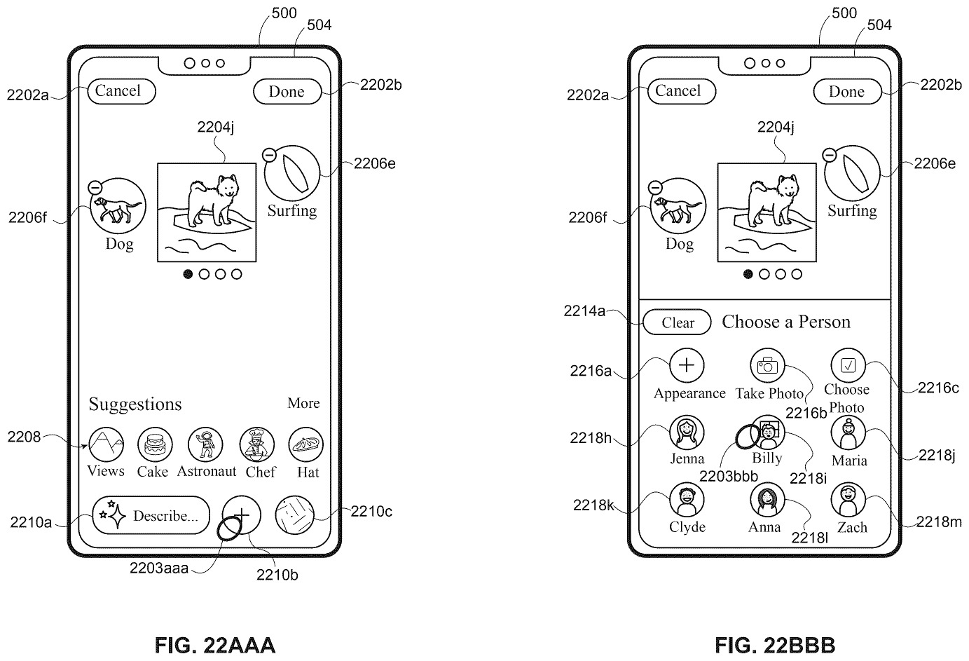

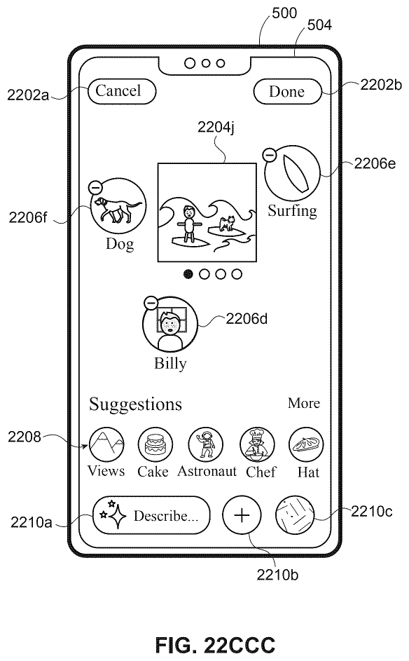

In some embodiments, while displaying the representation of the first generative visual content, the electronic device concurrently displays, via the one or more display generation components, one or more selectable options to edit the first prompt, such as input 1624f as shown in FIG. 16I. In some embodiments, the one or more selectable options to edit the first prompt include a content (e.g., text and/or images) entry field as described in method(s) 700, 800, and/or 1200, and/or as shown in FIGS. 6V and 11B-11E. In some embodiments, the one or more selectable options to edit the first prompt include one or more selectable representations of concepts (e.g., a computer-generated suggested concept, recognized concept, or a predefined concept) as described in method(s) 700 and/or 800, and/or as shown in FIGS. 6B-6E. In some embodiments, the one or more selectable options to edit the first prompt include a personalization option that, when selected, via a selection input (e.g., described above with reference to detecting an input directed to a user interface element) causes the electronic device to change the subject (or, optionally, the image of the subject) used to influence the generation of the respective generative visual content as described in more detail with reference to method(s) 1900, 2100, and/or 2300, and/or FIGS. 16F and 16G and/or FIGS. 22D-22H. In some embodiments, the one or more selectable options to edit the first prompt include a style option that, when selected, via the selection input, causes the electronic device to change the style used to influence the generation of the respective generative visual content as described in more detail with reference to method 700 and/or as shown in FIGS. 6K and 6L.

In some embodiments, while concurrently displaying the representation of the first generative visual content and the one or more selectable options, the electronic device detects, via the one or more input devices, an input directed to a first selection option of the one or more selectable options, such as, for example, an input directed to a prompt 1608c as shown in FIG. 16J. For example, the input directed to the first selection option of the one or more selectable options include a sequence of one or more inputs, such as one or more selection inputs (e.g., described above with reference to detecting an input directed to a user interface element) directed to the first selection option. In some embodiments, the first selection option is a representation of a recognized concept as described herein, the personalization option as described herein, or other selectable option described herein. In some embodiments, the electronic device determines that the input directed to the first selection option corresponds to a request to influence generation of the first generative visual content by adding, removing, or modifying a concept input via the content entry field, the personalization option, the style option, or other manner of adding a concept as described in more detail with reference to method(s) 700, 800, and/or 2100, and/or FIGS. 16C-16G and/or FIGS. 20K-20P.

In some embodiments, in response to detecting the input, the electronic device initiates an event that will influence generation of the first generative visual content, such as shown in FIG. 16H in response to detecting input 1624e directed to 1626g in FIG. 16G. In some embodiments, initiating an event that will influence generation of the first generative visual content includes adding, removing, or modifying a concept via the one or more selectable options described herein, such as adding a representation of a content as described herein, adding text-based content via the content entry field as described herein, or adding a concept in a other manner described herein and/or in more detail with reference to method(s) 700, 800, and/or 2100, and/or FIGS. 16C-16G and/or FIGS. 20D-20F. In some embodiments, initiating an event that will influence generation of the first generative visual content includes using the same edited prompt to influence generation of the second generative visual content (or, optionally, other generative visual content) as described above with reference to initiating a process to generate the one or more third generative visual content based on the first prompt. Initiating an event that will influence generation of the first generative visual content in response to detecting an input directed to a first selection option of the one or more selectable options provides an intuitive way to influence generation of the first generative visual content and provides quick access to view different generative visual content using an edited prompt without requiring the user to provide further inputs, such as starting over with a new prompt, thereby reducing the number of inputs and providing more efficient interactions between the user and the electronic device.

In some embodiments, while displaying a respective representation of a respective generative visual content in a generative visual content variants user interface, wherein the respective generative visual content is based on a respective prompt, the electronic device detects, via the one or more input devices, a prompt editing input, such as input 1624 as shown in FIG. 16I. In some embodiments, the generative visual content variants user interface is a user interface of a content application (optionally as described in method 700 and/or as shown in FIG. 6KK). In some embodiments, the electronic device displays the generative visual content variants user interface in an application other than the content application, such as a messaging application as described in method(s) 700, 800, and/or 2300, and/or as shown in FIG. 9B and/or FIGS. 22Z-22CCC.

In some embodiments, the prompt editing input is a selection input (e.g., described above with reference to detecting an input directed to a user interface element) directed to a prompt editing user interface element or button described in method(s) 700 and/or 800, and/or as shown in FIG. 6DD. In some embodiments, the prompt editing input is a selection input (e.g., described above with reference to detecting an input directed to a user interface element) directed to an area outside of the frame that contains the respective representation of the respective generative visual content. In some embodiments, in response to detecting the prompt editing input, and in accordance with a determination that the prompt editing input satisfies one or more respective criteria, such as input 1624f directed to a location outside representation 1630a as shown in FIG. 16I, the electronic device ceases displaying, via the one or more display generation components, the generative visual content variants user interface, such as variants user interface 1600b as shown in FIG. 16I.

In some embodiments, the one or more respective criteria include a criterion that is satisfied when the prompt editing input is directed to the prompt editing user interface element or the area outside of the frame that contains the respective representation of the respective generative visual content. In some embodiments, in response to detecting the prompt editing input, and in accordance with a determination that the prompt editing input satisfies one or more respective criteria, such as input 1624f directed to a location outside representation 1630a as shown in FIG. 16I, the electronic device displays, via the one or more display generation components, an editing user interface for editing the respective prompt, such as editing user interface 1600a as shown in FIG. 16J.

For example, the electronic device replaces the generative visual content variants user interface with the editing user interface for editing the respective prompt. In some embodiments, the editing user interface is analogous to and/or includes one or more characteristics of the editing user interface described in method(s) 700 and/or 800, and/or as shown in FIG. 6EE. In some embodiments, the editing user interface includes the one or more selectable options to edit the respective prompt described above. In some embodiments, in response to detecting the prompt editing input, in accordance with a determination that the prompt editing input does not satisfy the one or more respective criteria, the electronic device forgoes displaying the editing user interface for editing the respective generative visual content, such as editing user interface 1600a as shown in FIG. 16J.

The one or more respective criteria is described above with reference to a criterion that is satisfied when the prompt editing input is directed to the prompt editing user interface element or the area outside of the frame that contains the respective representation of the respective generative visual content. In some embodiments, in response to detecting the prompt editing input, in accordance with a determination that the prompt editing input does not satisfy the one or more respective criteria, the electronic device maintains display of the generative visual content variants user interface, such as variants user interface 1600b as shown in FIG. 16I.

In some embodiments, although the electronic device does not display the editing user interface for editing the respective prompt, the generative visual content variants user interface that is displayed includes the one or more selectable options to edit the respective prompt described above. Displaying the editing user interface for editing the respective prompt in accordance with a determination that a prompt editing input satisfies one or more respective criteria provides an intuitive way to edit the respective prompt and provides quick access to edit the respective prompt without requiring the user to provide further inputs, such as starting over with a new prompt, thereby reducing the number of inputs and providing more efficient interactions between the user and the electronic device. In some embodiments, the one or more respective criteria include a criterion that is satisfied when the prompt editing input corresponds to a request to add a representation of a prompt component (e.g., a recognized concept) to the first prompt, such as prompt 1826g as shown in FIG. 18G. In some embodiments, the request to add the representation of the prompt component to the first prompt is analogous to and/or includes one or more characteristics of detecting an input directed to a first selection option of the one or more selectable options described above. For example, the representation of the prompt component is optionally analogous to and/or includes one or more characteristics of the one or more selectable representations of recognized concepts described in method(s) 700 and/or 800, and/or as shown in FIGS. 6B-6E. In some embodiments, in response to detecting the prompt editing input, and in accordance with a determination the prompt editing input corresponds to the request to add the representation of the prompt component to the first prompt, the electronic device ceases displaying the generative visual content variants user interface and displays the editing user interface for editing the respective generative visual content as described above. In some embodiments, while displaying the editing user interface for editing the respective generative visual content, the electronic device displays the representation of the respective generative visual content including the representation of the prompt as described in method(s) 700 and/or 800, and/or as shown in FIGS. 6D-6E. For example, the request to add the representation of the prompt component to the first prompt optionally includes providing the prompt component via the content entry field as described above and/or in method(s) 700, 800, and/or 1200, and/or as shown in FIGS. 11B-11E and/or 6V.

Displaying the editing user interface for editing the respective generative visual content in accordance with a determination that the prompt editing input corresponds to a request to add a representation of a prompt component to the first prompt provides an intuitive way to edit the respective generative visual content and provides quick access to edit the respective generative visual content without requiring the user to provide further inputs, such as starting over with a new prompt, thereby reducing the number of inputs and providing more efficient interactions between the user and the electronic device.

In some embodiments, the one or more respective criteria include a criterion that is satisfied when the prompt editing input is an input directed to a location outside a region of the respective representation of the respective generative visual content, such as input 1624f as shown in FIG. 16I. For example, the prompt editing input is a selection input (e.g., described above with reference to detecting an input directed to a user interface element) directed to a location outside a region of the respective representation of the respective generative visual content (e.g., the frame that contains the respective representation of the respective generative visual content). In some embodiments, the one or more respective criteria include a criterion that is not satisfied when the prompt editing input is an input directed to a location inside a region of the respective representation of the respective generative visual content. Displaying the editing user interface for editing the respective generative visual content in accordance with a determination that the prompt editing input is an input directed to a location outside a region of the respective representation of the respective generative visual content provides an intuitive way to edit the respective generative visual content and provides quick access to edit the respective generative visual content without requiring the user to provide further inputs, such as starting over with a new prompt, thereby reducing the number of inputs and providing more efficient interactions between the user and the electronic device.

In some embodiments, displaying the respective representation of the respective generative visual content in the generative visual content variants user interface includes displaying the respective representation with a first amount of visual emphasis (e.g., a first size, first shape, first color, first brightness, first visual effect, or other first visual property), wherein displaying the editing user interface includes displaying the respective representation with a second amount of visual emphasis, less than the first amount of visual emphasis, such as representation 1636 as shown in FIG. 16J. For example, the second amount of visual emphasis includes a second size smaller than the first size, a second shape smaller than the first shape, a second color less distinct than the first color, a second brightness less luminous than the first brightness; a second visual effect less intense than the first visual effect, and/or a first visual property less distinct than the first visual property. In some embodiments, the electronic device minimizes or displays the respective representation with a second amount of visual emphasis, less than the first amount of visual emphasis to make room for one or more representations of prompt components associated with the first prompt used to influence generation of the respective representation of the respective generative visual content as described in method(s) 700 and/or 800, and/or as shown in FIGS. 6K and 6L. Displaying the respective representation of the respective generative visual content in the editing user interface with a second amount of visual emphasis, less than the first amount of visual emphasis associated with displaying the respective representation in the generative visual content variants user interface reduces clutter and makes the respective representation easier to view, thereby providing more efficient interactions between the user and the electronic device.

In some embodiments, displaying the respective representation of the respective generative visual content in the generative visual content variants user interface includes displaying an edge of the respective representation with a first visual appearance (e.g., a first degree of variability or other first visual property), such as representation 1630a as shown in FIG. 16I.

In some embodiments, displaying the editing user interface includes displaying the edge of the respective representation with a second visual appearance (e.g., a second degree of variability or other second visual property), different than the first visual appearance, such as representation 1636 as shown in FIG. 16J. In some embodiments, the first visual appearance refers to a degree in which the respective generative visual content is changing or is expected to change. For example, the electronic device optionally displays the respective generative visual content as a dynamic user interface object (e.g., having a degree of variability in its appearance due to the changing respective prompt or expected changing of the respective prompt that the respective generative visual content is based on). In some embodiments, the electronic device decides to display the respective representation with a visual appearance based on which user interface (e.g., the generative visual content variants user interface or the editing user interface) will be expected to include more change to the respective prompt.

For example, in accordance with a determination that displaying the user interface of the content application includes displaying the generative visual content variants user interface, the electronic device optionally displays the edge of the respective representation with the first visual appearance (e.g., a first degree of variability or other first visual property). In some embodiments, the first degree of variability refers to a degree of variability around an edge of the respective representation, wherein displaying the respective representation with the first degree of variability gives the respective representation of being at least partially blurred or feathered at the edge of the respective representation and/or including a first animation effect such that the frame is glowing. In another example, in accordance with a determination that displaying the user interface of the content application includes displaying the editing user interface, the electronic device optionally displays the edge of the respective representation with a second visual appearance. For example, a second degree of variability giving the respective representation a more blurred appearance at the edges than the first degree of variability, a second animation effect having a more intense glow than the first animation effect, and/or the second animation effect rendering the respective representation with an amorphous shape. In some embodiments, the frame that contains the representation includes one or more of the characteristics of displaying the respective representation with the respective amount of visual emphasis described herein. Changing the visual appearance of the edge of the respective representation of the respective generative visual content provides feedback that the respective generative visual content is responsive to change and/or enables the user to influence generation of the respective generative visual content, thereby providing more efficient interactions between the user and the electronic device.

In some embodiments, displaying the editing user interface includes displaying, via the one or more display generation components, one or more visual indications of one or more prompt components associated with the first prompt, such as indication 1618 as shown in FIG. 16B.

In some embodiments, displaying one or more visual indications of one or more prompt components associated with the first prompt is analogous to and/or includes one or more characteristics of displaying the one or more representations of prompt components associated with the first prompt used to influence generation of the respective representation of the respective generative visual content as described in method(s) 700 and/or 800, and/or as shown in FIGS. 6K and 6L. Displaying the editing user interface including one or more visual indications of one or more prompt components associated with the first prompt provides an intuitive way to edit the respective generative visual content and provides quick access to edit the respective generative visual content without requiring the user to provide further inputs, such as starting over with a new prompt, thereby reducing the number of inputs and providing more efficient interactions between the user and the electronic device.

In some embodiments, displaying the one or more visual indications of the one or more prompt components in the generative visual content variants user interface includes displaying the one or more visual indications of the one or more prompt components with a first amount of visual emphasis (e.g., a first size, first shape, first color, first brightness, first visual effect, or other first visual property), such as indication 1618 as shown in FIG. 16B. In some embodiments, displaying the one or more visual indications of the one or more prompt components in the editing user interface includes displaying the one or more visual indications of the one or more prompt components with a second amount of visual emphasis, greater than the first amount of visual emphasis, such as component 1604b as shown in FIG. 16A. For example, the second amount of visual emphasis optionally includes a second size larger than the first size, a second shape larger than the first shape, a second color more distinct than the first color, a second brightness more luminous than the first brightness; a second visual effect more intense than the first visual effect, and/or a first visual property more distinct than the first visual property. In some embodiments, displaying the one or more visual indications of the one or more prompt components with the first amount of visual emphasis includes displaying a circular image (or, optionally, corresponding to a prompt component) that is at least partially blurred or feathered at the edges and/or includes a first animation effect such that the visual indications are glowing. In some embodiments, the electronic device minimizes or displays the one or more visual indications of the one or more prompt components with the first amount of visual emphasis as described herein to make room for the respective representation of the respective generative visual content. In some embodiments, displaying the one or more visual indications of the one or more prompt components with the second amount of visual emphasis is analogous to and/or includes one or more characteristics of displaying the one or more representations of prompt components associated with the first prompt used to influence generation of the respective representation of the respective generative visual content as described in method(s) 700 and/or 800, and/or as shown in FIGS. 6K and 6L.

In some embodiments, while displaying the one or more visual indications of the one or more prompt components with the first amount of visual emphasis in the generative visual content variants user interface, the electronic device detects a prompt editing input (e.g., as described above with reference to detecting an input directed to a location outside a region of the respective representation of the respective generative visual content), and in response, the electronic device displays the editing user interface including displaying the one or more visual indications of the one or more prompt components with the second amount of visual emphasis as described herein. Displaying the one or more visual indications of the one or more prompt components with a respective amount of visual emphasis based on which user interface is displayed (e.g., the generative visual content variants user interface or the editing user interface) reduces clutter and makes the respective representation easier to view, provides quick access to edit the respective generative visual content without requiring the user to provide further inputs, thereby reducing the number of inputs and providing more efficient interactions between the user and the electronic device.

In some embodiments, displaying the respective representation of the respective generative visual content based on a respective prompt in the generative visual content variants user interface includes displaying, via the one or more display generation components, one or more visual indications of one or more second respective generative visual content associated with the respective prompt, such as indicators 1622a through 1622e as shown in FIG. 16G. In some embodiments, displaying the editing user interface for editing the respective generative visual content includes forgoing displaying the one or more visual indications of the one or more second respective generative visual content associated with the respective prompt, such as indicators 1634a through 1634c as shown in FIG. 16I.

In some embodiments, displaying the one or more visual indications of the one or more second respective generative visual content are optionally analogous to and/or include one or more characteristics of displaying one or more indicators corresponding to a number of generative visual content described above. For example, the one or more second respective generative visual content are optionally ephemeral in that the one or more second respective generative visual content are optionally available for display (e.g., are accessible) during a single session of displaying the generative visual content variants user interface. Thus, in some embodiments, when the electronic device transitions from displaying the generative visual content variants user interface to displaying the editing user interface (or, optionally, when the electronic device ceases to display the generative visual content variants user interface), the electronic device does not display the one or more visual indications of the one or more second respective generative visual content in the editing user interface. In some embodiments, ceasing to display the generative visual content variants user interface optionally ends the session for accessing the one or more second respective generative visual content including forgoing displaying the one or more visual indications of the one or more second respective generative visual content. In some embodiments, when the electronic device transitions back to displaying the generative visual content variants user interface after ceasing display of the generative visual content variants user interface, the electronic device does not enable access to the one or more second respective generative visual content (e.g., the same second respective generative visual content) in the generative visual content variants user interface. In some embodiments, the electronic device displays one or more visual indications of one or more third respective generative visual content associated with the respective prompt (e.g., same prompt used to influence the generation of the one or more second respective generative visual content). In some embodiments, the one or more third respective generative visual content are different from the one or more second respective generative visual content. For example, the one or more third respective generative visual content optionally include variations not included in the one or more second respective generative visual content, such as variations in composition, perspective, number of objects, size/visual emphasis of those objects, spatial relationship, and/or other manner in which the one or more third respective generative visual content are generated based on the respective prompt. These variants optionally vary from generative visual content to generative visual content. In some embodiments, if the one or more second respective generative visual content are not saved as described in more detail with respect to method 800 and/or as shown in FIGS. 6Q and 6R, the one or more second respective generative visual content are discarded that is are not accessible. Ceasing display of the one or more visual indications of the one or more second respective generative visual content in the editing user interface reduces clutter and makes the respective representation of the respective generative visual content easier to view, thereby providing more efficient interactions between the user and the electronic device.

In some embodiments, prior to displaying the representation of the first generative visual content, the electronic device displays, via the one or more display generation components, an editing user interface for detecting one or more prompt components for use in generating (e.g., using an AI process or a generative AI process) generative visual content, such as editing user interface 1600a as shown in FIG. 16A. In some embodiments, the editing user interface is analogous to and/or includes one or more characteristics of the editing user interface described in method(s) 700, 800, and/or 2100, and/or as shown in FIG. 6EE and FIGS. 20K-20P. In some embodiments, prior to displaying the representation of the first generative visual content in the generative visual content variants user interface, the electronic device displays the editing user interface. In some embodiments, the editing user interface includes a second representation of the first generative visual content. For example, the second representation of the first generative visual content displayed in the editing user interface is optionally analogous to and/or includes one or more characteristics of displaying the respective representation with a respective amount of visual emphasis in the editing user interface described above. Displaying an editing user interface for use in generating generative visual content provides quick access to generate generative visual content and preview the generative visual content without requiring the user to wait and provide further inputs, thereby reducing the number of inputs and providing more efficient interactions between the user and the electronic device.

In some embodiments, while displaying the editing user interface, the electronic device detects, via the one or more input devices, a second prompt for use in generating (e.g., using an AI process or a generative AI process) generative visual content, such as component 1604f as shown in FIG. 16M.

For example, while displaying the editing user interface, the electronic device displays a representation of the first generative visual content based on the first prompt. In some embodiments, displaying the representation of the first generative visual content in the editing user interface is analogous to and/or includes one or more characteristics of displaying the respective representation of the respective generative visual content with a respective amount of visual emphasis as described above and/or as show in FIGS. 6X and 6Y. In some embodiments, the second prompt is different from the first prompt. In some embodiments, the second prompt includes one or more prompt components that are not included in the first prompt. In some embodiments, the second prompt includes one or more less prompt components that are not included in the first prompt. For example, detecting the second prompt for use in generating the generative visual content is analogous to and/or includes one or more characteristics of detecting one or more inputs providing the first prompt described above.

In some embodiments, in response to detecting the second prompt component, the electronic device concurrently displays, via the one or more display generation components, a representation of third generative visual content that was generated based on the second prompt, such as representation 1650 as shown in FIG. 16N. For example, the representation of the third generative visual content is optionally displayed as a preview for the third generative visual content. In some embodiments, the third generative visual content (or, optionally, and its representation) is different from the first generative visual content (or, optionally, and its representation) described herein. For example, the first prompt used in generating the first generative visual content is different from the second prompt used in generating the third generative visual content, and thus, in some embodiments, the resulting respective generative visual content generated are different from one another. In some embodiments, displaying the representation of the third generative visual content in the editing user interface is optionally analogous to and/or includes one or more characteristics of displaying the representation of the first generative visual content described herein. Displaying a representation of a third generative visual content based on a second prompt in the editing user interface provides an intuitive way to generate the third generative visual content and provides quick access to generate the third generative visual content without requiring the user to provide further inputs, such as starting over with a new prompt, thereby reducing the number of inputs and providing more efficient interactions between the user and the electronic device.

In some embodiments, while displaying the representation of the third generative visual content, the electronic device detects, via the one or more input devices, an event, such as input 1624e directed to element 1626g as shown in FIG. 16G. In some embodiments, detecting the event is analogous to and/or includes one or more characteristics of detecting an event that will influence generation of the first generative visual content described above. In some embodiments, detecting the event is analogous to and/or includes one or more characteristics of detecting an event for generating generative visual content based on a user selected prompt that will influence the generation of the generative visual content described in method 1900. In some embodiments, the event is based on a threshold period of time described below with respect to the event satisfying one or more respective criteria. In some embodiments, the event is based on detecting an input that satisfies one or more respective criteria described below.

In some embodiments, in response to detecting the event, and in accordance with a determination that the event satisfies one or more respective criteria, the electronic device displays, via the one or more display generation components, a second representation of the third generative visual content based on the second prompt, such as representation 1630a as shown in FIG. 16I. In some embodiments, the one or more respective criteria include a criterion that is satisfied when the electronic device does not detect one or more inputs editing the respective prompt for a threshold period of time as will be described in more detail below. In some embodiments, the one or more respective criteria include a criterion that is satisfied when the electronic detects that the event includes (or, optionally, corresponds to a request to) a selection input directed to the representation of the third generative visual content as described in below, in method 700, and/or as shown in FIG. 6JJ.

In some embodiments, in response to detecting the event, and in accordance with a determination that the event satisfies one or more respective criteria, the electronic device displays, via the one or more display generation components, a selectable option to navigate to a second representation of fourth generative visual content based on the second prompt, such as indicators 1634a through 1634c as shown in FIG. 16I. For example, the electronic device displays the generative visual content variants user interface including the second representation of the third generative visual content and the selectable option to navigate to the second representation of the fourth generative visual content. In some embodiments, in response to the event and in accordance with the determination that the event satisfied the one or more respective criteria, the electronic device ceases to display the editing user interface including the representation of the third generative visual content and displays the generative visual content variants user interface as described herein.

In some embodiments, displaying the second representation of the third generative visual content is optionally analogous to the electronic device displaying the respective representation with a respective amount of visual emphasis as described in more detail below. For example, the second representation of the third generative visual content displayed in the generative visual content variants user interface is optionally different from the representation of the third generative visual content displayed in the editing user interface. In some embodiments, the second representation has a larger size and thus, in some embodiments, the electronic device displays a larger portion of the third generative visual content than the representation of the third generative visual displayed in the editing user interface. In some embodiments, the selectable option to navigate to the second representation of the fourth generative visual content is analogous to and/or includes one or more characteristics of the page control user interface element including the one or more indicators corresponding to the number of generative visual content available based on the respective prompt as described above. In some embodiments, the second representation of the fourth generative visual content is analogous to and/or includes one or more characteristics of the representation of the second generative visual content that is displayed in response to detecting the navigation input including the movement component described above. In some embodiments, the fourth generative visual content is different from the third generative visual content. For example, the fourth generative visual content is optionally a variant of the third generative visual content, such that the fourth generative visual content has a different composition, perspective, and/or other variations compared to the third generative visual content as described above with reference to displaying generative visual content variants.

In some embodiments, in accordance with a determination that the event does not satisfy the one or more respective criteria, the electronic device forgoes displaying the second representation of the third generative visual content and the selectable option, such as displaying the editing user interface 1600a instead as shown in FIG. 16J. For example, the electronic device optionally continues to display the editing user interface including the representation of the third generative visual content and does not display the generative visual content variants user interface including the second representation of the third generative visual content and the selectable option. Displaying a second representation of a third generative visual content and a selectable option to navigate to a second representation of a fourth generative visual content in response to detecting an event provides an intuitive way to display representations of different generative visual content and provides quick access to different generative visual content generated using a same prompt used to generate the third generative visual content without requiring the user to provide further inputs, thereby reducing the number of inputs and providing more efficient interactions between the user and the electronic device.

In some embodiments, the one or more respective criteria includes a criterion that is satisfied when the event is a selection input directed to the representation of the third generative visual content, such as input 1624j as shown in FIG. 16O. In some embodiments, detecting the selection input directed to the representation of the third generative visual content is analogous to and/or includes one or more characteristics of detecting the input directed to the user interface element described above. For example, the selection input optionally includes a tap or long press with a contact (e.g., a finger, or stylus), selection with an indirect input device (e.g., mouse, remote control, or trackpad) that is directed to a location of the representation of the third generative visual content, or focus indicator such as a cursor or selection ring) and/or a gaze input (or, optionally, as part of an air gesture). In some embodiments, the one or more respective criteria includes a criterion that is not satisfied when the event is a selection input that is not directed to the representation of the third generative visual content (e.g., a selection input that is directed elsewhere in the user interface). Displaying a second representation of a third generative visual content and a selectable option to navigate to a second representation of a fourth generative visual content in response to a selection input directed to the representation of the third generative visual content provides an intuitive way to navigate through different generative visual content without requiring the user to provide further inputs, thereby providing more efficient interactions between the user and the electronic device.

In some embodiments, the one or more respective criteria includes a criterion that is satisfied when the electronic device does not detect one or more inputs editing the second prompt for a threshold period of time (e.g., 0.2, 0.5, 0.7, 0.9, 1, 2, 5, 7, 10, or 30 seconds), such as shown by timer 1616a in FIG. 16B. In some embodiments, the one or more inputs editing the second prompt is analogous to and/or includes one or more characteristics of the electronic device detecting an input directed to a first selection option of the one or more selectable options to edit the first prompt described above. In some embodiments, the period of time starts at a moment when the electronic device detects a last input corresponding to a request to edit the second prompt. In some embodiments, the threshold period of time is based on a time to generate a threshold number (e.g., 1, 3, 5, 7, or 10) of respective generative visual content based on the second prompt. For example, the electronic device optionally delays displaying the second representation of the third generative visual content and the selectable option to navigate to the second representation of the fourth generative visual content by a delay time to generate the fourth generative visual content (or, optionally. by a delay time to generative the threshold number of respective generative visual content based on the second prompt). In some embodiments, the one or more respective criteria includes a criterion that is not satisfied when the electronic device has detected on or more inputs editing the second prompt within the threshold period of time. Displaying a second representation of a third generative visual content and a selectable option to navigate to a second representation of a fourth generative visual content in response when the electronic device does not detect one or more inputs editing the second prompt for a threshold period of time provides an intuitive way to navigate through different generative visual content without requiring the user to provide further inputs, thereby providing more efficient interactions between the user and the electronic device.

In some embodiments, the editing user interface includes one or more indications of the one or more prompt components displayed, via the one or more display generation components, with a first amount of visual prominence, such as components 1604b, 1604c, 1604e, and 1604f as shown in FIG. 16O. For example, the one or more indications of the one or more prompt components displayed with the first amount of visual prominence is analogous to and/or includes one or more characteristics of displaying the one or more representations of prompt components associated with the first prompt used to influence generation of the respective representation of the respective generative visual content as described in method(s) 700 and/or 800, and/or as shown in FIGS. 6K and 6L. In some embodiments, the one or more indications of the one or more prompt components displayed with the first amount of visual prominence is analogous to and/or includes one or more characteristics of displaying the one or more visual indications of the one or more prompt components with a respective amount of visual emphasis in the editing user interface described above.

In some embodiments, while displaying the editing user interface, the electronic device detects, via the one or more input devices, an event, such as input 1624j as shown in FIG. 16O.

In some embodiments, the event includes a selection input directed to a respective representation of a respective generative visual content as described above. In some embodiments, the event includes no detected interaction (e.g., one or more user inputs) directed to a respective prompt (e.g., to edit the respective prompt) for a threshold period of time as described above. In some embodiments, in response to detecting the event, the electronic device displays, via the one or more display generation components, the representation of the first generative visual content, such as representation 1652a as shown in FIG. 16P.

In some embodiments, in response to detecting the event, the electronic device displays, reducing the visual prominence of the one or more indications of the one or more prompt components, such as indication 1656 as shown in FIG. 16P. For example, the electronic device optionally displays the generative visual content variants user interface including the representation of the first generative visual content and the one or more indications of the one or more prompt components with reduced visual prominence. In some embodiments, displaying the one or more indications of the one or more prompt components with reduced visual prominence is analogous to and/or includes one or more characteristics of displaying the one or more visual indications of the one or more prompt components with a respective amount of visual emphasis in the generative visual content variants user interface described above. For example, the one or more prompt components with reduced visual prominence are visually represented by circular images (e.g., corresponding the one or more prompt components) that is at least partially blurred or feathered at the edges. In some embodiments, the one or more indications of the one or more prompt components displayed in the generative visual content variants user interface are not responsive to user inputs, such that when the electronic device detects a selection input directed to one of the one or more indications, the electronic device does not perform an operation associated with the respective prompt component, such as remove or edit the prompt component. In some embodiments, the one or more indications of the one or more prompt components displayed in the editing user interface are responsive to user inputs, such that when the electronic device detects a selection input directed to one of the one or more indications, the electronic device does perform an operation associated with the respective prompt component, such as remove or edit the prompt component.

In some embodiments, the one or more indications of the one or more prompt components that are displayed by the electronic device in the editing user interface correspond to the one or more indications of the one or more prompt components that are displayed by the electronic device in the generative visual content variants user interface. For example, when the electronic device removes an indication of a prompt component in the editing user interface, the electronic device will not display a corresponding indication of the removed prompt component in the generative visual content variants user interface. Displaying the one or more indications of the one or more prompt components with a respective amount of visual prominence based on which user interface is displayed (e.g., the generative visual content variants user interface or the editing user interface) reduces clutter and makes the respective representation easier to view, provides quick access to edit the respective generative visual content without requiring the user to provide further inputs, thereby reducing the number of inputs and providing more efficient interactions between the user and the electronic device.

In some embodiments, reducing the visual prominence of the one or more indications of the one or more prompt components includes ceasing display of the one or more indications of the one or more prompt components, such as removing indicator 1656 as shown in FIG. 16P. For example, when the electronic device displays the generative visual content variants user interface, the electronic device does not display the one or more indications of the one or more prompt components. In some embodiments, while displaying the generative visual content variants user interface, the electronic device detects a prompt editing input as described in more detail above, and in response to detecting the prompt editing input, the electronic device displays the one or more indications of the one or more prompt components with the first amount of visual prominence as described above. Ceasing display of the one or more indications of the one or more prompt components reduces clutter and makes the respective representation of the respective generative visual content easier to view without requiring the user to provide further inputs, thereby reducing the number of inputs and providing more efficient interactions between the user and the electronic device.

In some embodiments, reducing the visual prominence of the one or more indications of the one or more prompt components includes displaying one or more second indications corresponding to the one or more prompt components with a second amount of visual prominence (e.g., second degree of blur, second size, second amount of image fidelity, second color, second brightness, second visual property, and/or second visual effect) that is less than the first amount of visual prominence of the one or more indications of the one or more prompt components (e.g., first degree of blur, first size, first amount of image fidelity, first color, first brightness, first visual property, and/or first visual effect), such as indicator 1656 as shown in FIG. 16Q. For example, the electronic device displays the one or more second indications corresponding to the one or more prompt components with a second degree of blur greater than the first degree of blur, a second size smaller than the first size, a second amount of image fidelity that is lower than the first amount of image fidelity, a second color less distinct than the first color, a second brightness less luminous than the first brightness, a second visual effect less intense than the first visual effect, and/or a first visual property less distinct than the first visual property. In some embodiments, the electronic device reduces the amount of visual prominence of the one or more indications to make room for the representation of the generative visual content. Reducing the amount of visual prominence of the one or more indications of the one or more prompt components reduces clutter and makes the respective representation of the respective generative visual content easier to view without requiring the user to provide further inputs, thereby reducing the number of inputs and providing more efficient interactions between the user and the electronic device.

In some embodiments, while displaying a respective representation of a respective generative visual content based on the first prompt, the electronic device detects, via the one or more input devices, one or more inputs corresponding to creation of a second prompt, different from the first prompt, such as component 1604f as shown in FIG. 16M. In some embodiments, detecting the second prompt is analogous to and/or includes one or more characteristics of detecting the second prompt for use in generating generative visual content described above. For example, the second prompt is optionally a new prompt and is not based on the first prompt. In another example, the second prompt is based on the first prompt, such that the second prompt is a modified version of the first prompt. In some embodiments, a modified version of the first prompt refers to one or more prompt components added, revised, and/or deleted from the first prompt.

In some embodiments, in response to detecting one or more inputs corresponding to creation of the second prompt, the electronic device displays, via the one or more display generation components, a representation of third generative visual content based on the second prompt, wherein the third generative visual content is different from the respective generative visual content, such as representation 1652a as shown in FIG. 16P. In some embodiments, displaying the representation of the third generative visual content is analogous to and/or includes one or more characteristics of displaying the representation of the first generative visual content described above. In some embodiments, different prompts result in different generative visual content, as described in method(s) 700 and/or 800, and/or as shown in FIGS. 6V-6Z.

In some embodiments, while displaying the representation of the third generative visual content based on the second prompt, the electronic device detects, via the one or more input devices, a second navigation input including a second movement component, such as input 1624k as shown in FIG. 16P. In some embodiments, detecting the second navigation input is analogous to and/or includes one or more characteristics of detecting the navigation input described above.

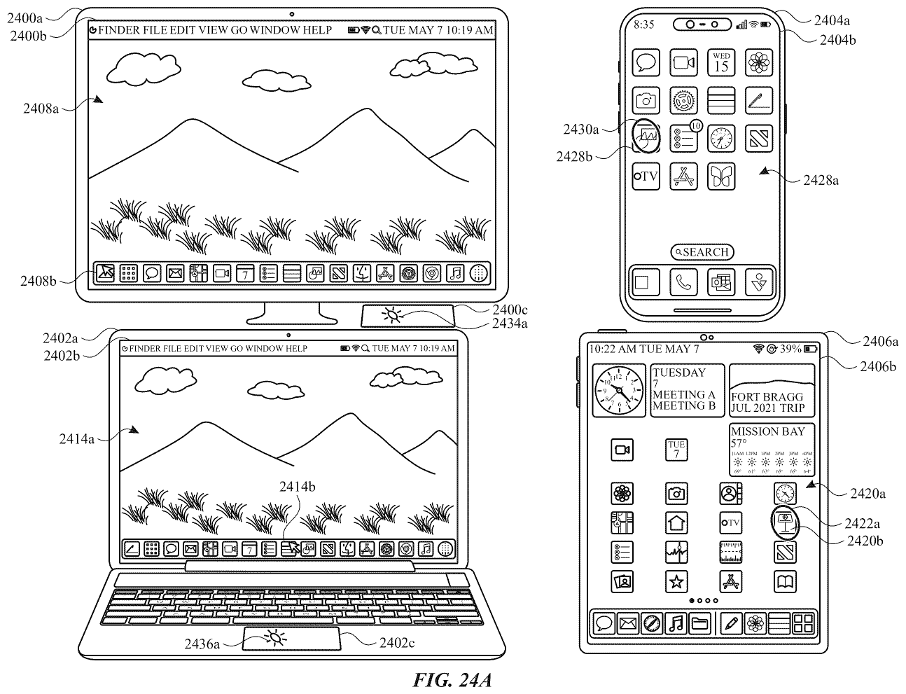

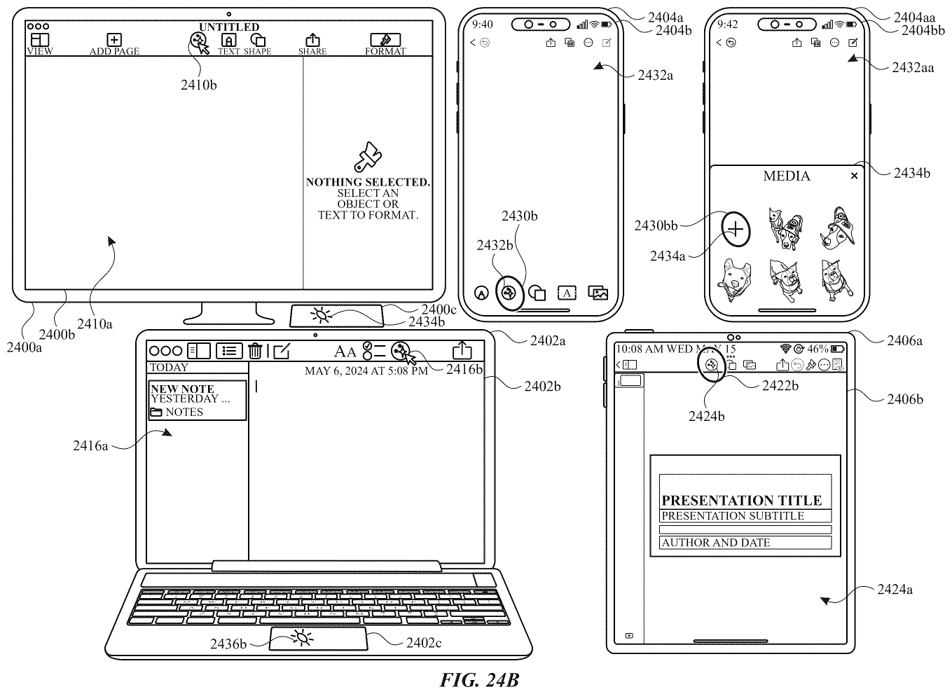

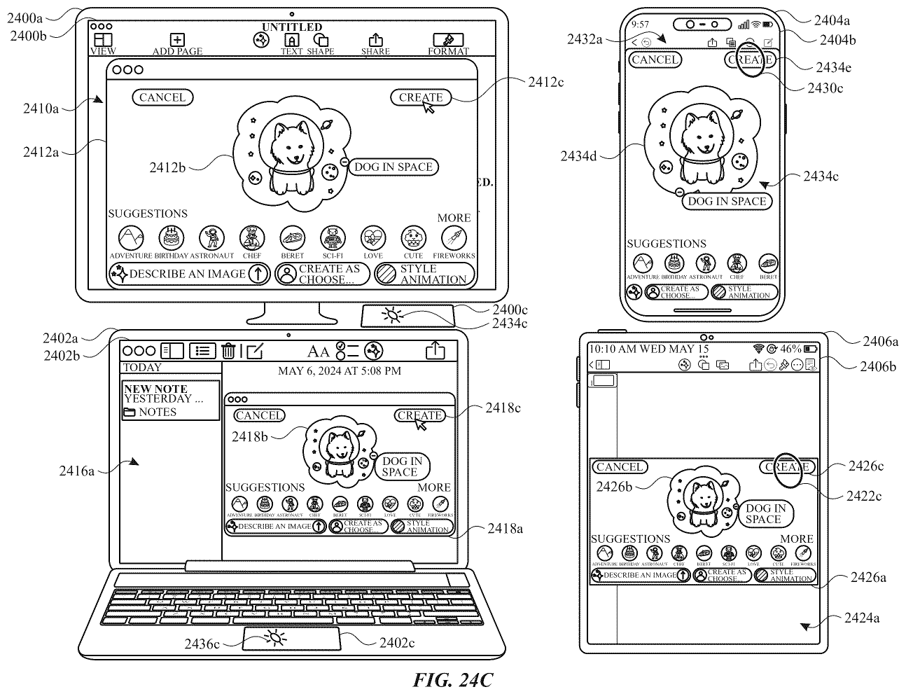

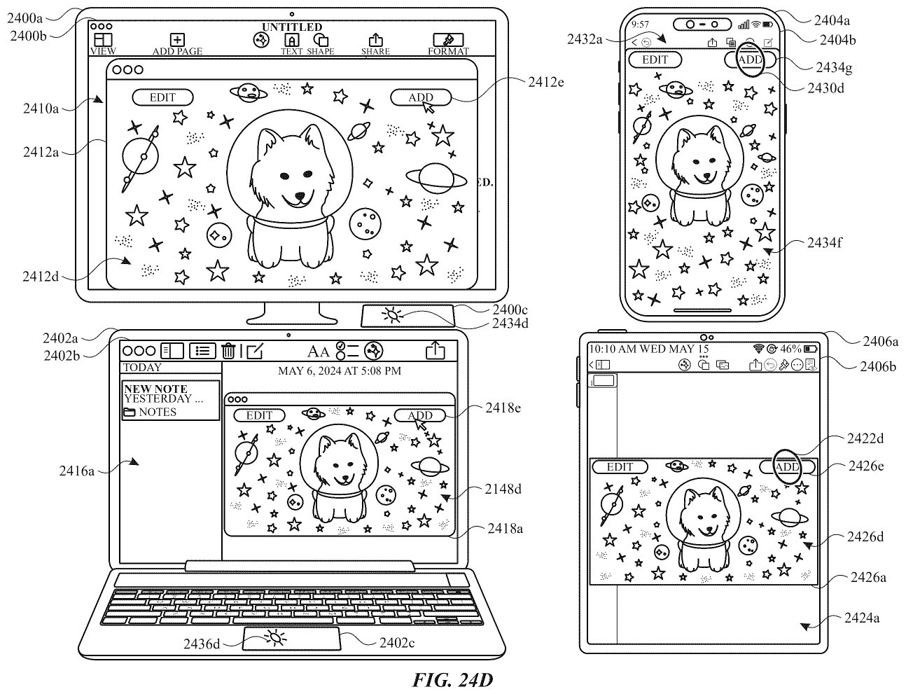

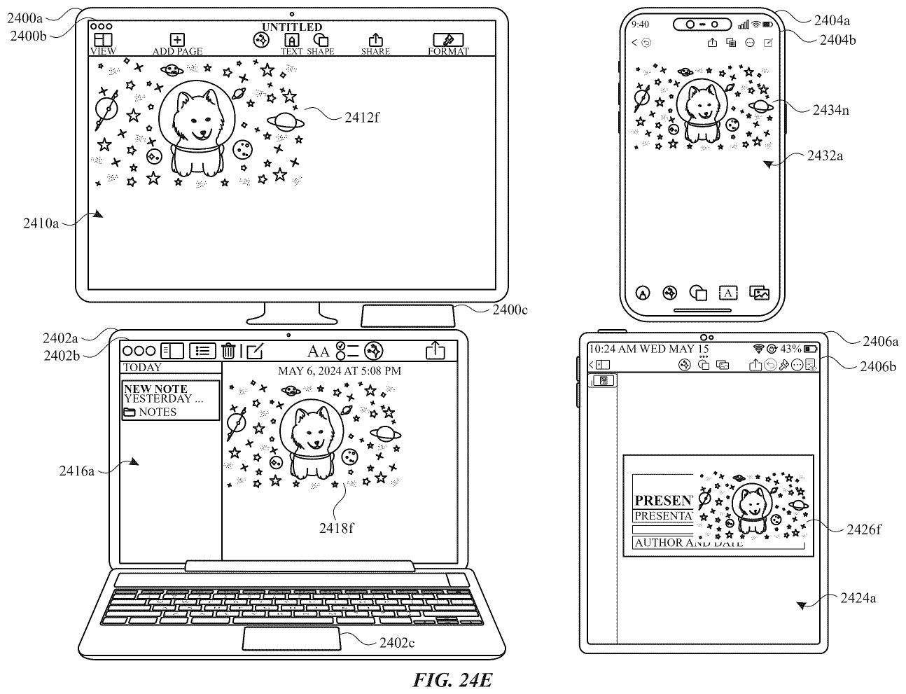

In some embodiments, in response to detecting the second navigation input including the second movement component, the electronic device displays, via the one or more display generation components, a representation of fourth generative visual content based on the second prompt, wherein the fourth generative visual content is different from the third generative visual content, such as representation 1652 as shown in FIG. 16Q. In some embodiments, displaying the representation of the fourth generative visual content is analogous to and/or includes one or more characteristics of displaying the representation of the second generative visual media described above. In some embodiments, different prompts result in different generative visual content variants. In some embodiments, displaying the representation of the fourth generative visual content based on the second prompt in response to detecting the second navigation input includes one or more of the processes and/or characteristics of displaying a respective representation of a respective generative visual content described above, such as displaying one or more indicators corresponding to a number of generative visual content available based on the same prompt (e.g., second prompt) used to generate the fourth generative visual content, displaying one or more prompt components of the second prompt, and/or other manner of displaying the representation of the fourth generative visual content including one or more user interfaces or user interface elements described above. In some embodiments, displaying the representation of the fourth generative visual content based on the second prompt includes displaying the representation in an application, other than the content application, such as a messaging application, a notes application, an email application, a presentation application, a word processing application, a whiteboarding application, a sketching application, a spreadsheet application, a journaling application, and/or other content processing application as shown in FIGS. 24A-24E. Displaying a representation of fourth generative visual content based on a second prompt used to generate the first generative visual content, different from the first prompt, in response to an input including a movement component provides an intuitive way to display representations of different generative visual content and provides quick access to different generative visual content generated using a same prompt used to generate the third generative visual content without requiring the user to provide further inputs, thereby reducing the number of inputs and providing more efficient interactions between the user and the electronic device.

In some embodiments, displaying the representation of the first generative visual content includes displaying the first generative visual content in a first user interface of a first application, such as user interface 2416a of notes application as shown in FIG. 24B. In some embodiments, the first user interface of the first application includes a user interface of a content application (e.g., described in method 700 and/or as shown in FIG. 6KK), a user interface that includes information associated with the first prompt (e.g., described in method 700 and/or as shown in FIG. 6JJ), an editing user interface (e.g., described in method 800 and/or as shown in FIG. 6W), a generative visual content variants user interface described above, and/or other user interface (e.g., described below and/or in method(s) 700, 800, 1000, and/or 1200).

In some embodiments the electronic device detects, via the one or more input devices, a sequence of one or more inputs corresponding to a request to display generative visual content in a second user interface of a second application, different from the first application, such as input directed to element 2416b as shown in FIG. 24B. For example, the second user interface of the second application is optionally a user interface of messaging application, a notes application, an email application, a presentation application, a word processing application, a whiteboarding application, a sketching application, a spreadsheet application, a journaling application, and/or other content processing application.

In some embodiments, the sequence of one or more inputs include one or more selection inputs (e.g., described above with reference to detecting an input directed to a user interface element) directed to an option that, when selected, causes the electronic device to display, within the second user interface of the second application, a user interface of the content application described herein. For example, the second user interface of the second application includes a menu user interface element that includes the option and in response to detecting a selection input directed to the option, the electronic device displays the user interface of the content application within the second user interface of the second application. In some embodiments, the electronic device detects a speech input corresponding to a request to start a session of the content application, and in response to detecting the speech input, the electronic device displays the user interface of the content application within the second user interface of the second application. In some embodiments, while displaying the user interface of the content application, the electronic device detects a selection input directed to a share option, and in response to detecting the selection input, the electronic device displays the user interface of the content application within the second user interface of the second application. In some embodiments, the electronic device optionally displays the user interface of the content application (or, optionally, as a window or volume) overlaid onto the second user interface of the second application. Thus, in some embodiments, the electronic device enables the user to access, add, and/or display generative visual content in other applications other than the content application.

In some embodiments, in response to detecting the sequence of one or more inputs, the electronic device displays, via the one or more display generation components, the second user interface including a representation of third generative visual content based on a second prompt, such as user interface element 2412a as shown in FIG. 24C. In some embodiments, the second prompt is the same as the first prompt. In some embodiments, the second prompt is different from the first prompt. For example, the second prompt is optionally a new prompt and is not based on the first prompt. In another example, the second prompt is based on the first prompt, such that the second prompt is a modified version of the first prompt. In some embodiments, a modified version of the first prompt refers to one or more prompt components added, revised, and/or deleted from the first prompt. In some embodiments, the representation of the third generative visual content is analogous to and/or include one or more characteristics of the representation of the first generative visual content.

In some embodiments, operations to create, modify, delete a respective prompt are accessible while operating the second application. In some embodiments, operations to edit, display, and/or save generative visual content are accessible while operating the second application.

In some embodiments, while displaying the representation of third generative visual content, the electronic device detects, via the one or more input devices, a second navigation input including a movement component, such as input 1624b directed to representation 1602b as shown in FIG. 16D. In some embodiments, the second navigation input is analogous to and/or includes one or more characteristics of the first navigation input described above. In some embodiments, in response to detecting the second navigation input including the movement component, the electronic device displays, via the one or more display generation components, a representation of fourth generative visual content based on the second prompt, wherein the fourth generative visual content is different from the third generative visual content, such as representation 1620e as shown in FIG. 16E.

In some embodiments, the representation of the fourth generative visual content is analogous to and/or includes one or more characteristics of the representation of the second generative visual content described above. In some embodiments, the operation to navigate through representations of respective generative visual content (e.g. generative visual content variants based on the second prompt) is accessible while operating the second application.

In some embodiments, displaying the representation of the fourth generative visual content in the second user interface of the second application in response to detecting the second navigation input includes one or more of the processes and/or characteristics of displaying a respective representation of a respective generative visual content described above, such as displaying one or more indicators corresponding to a number of generative visual content available based on the same prompt (e.g., second prompt) used to generate the fourth generative visual content, displaying one or more prompt components of the second prompt, and/or other manner of displaying the representation of the fourth generative visual content including one or more user interfaces or user interface elements described above. In some embodiments, displaying the representation of the fourth generative visual content based on the second prompt includes displaying the representation in an application, other than the content application, such as any of the applications described herein and/or as shown in FIGS. 24A-24E. Surfacing generative visual content in a second application different from the first (e.g., content) application provides an efficient way of accessing different generative visual content without leaving the second application and the need for subsequent inputs to close or end a session in the second application to open the first application, thereby reducing the number of inputs and providing more efficient interactions between the user and the electronic device.

In some embodiments, while displaying, via the one or more display generation components, the representation of the first generative visual content based on the first prompt, the electronic device displays, via the one or more display generation components, a first selectable option that, when selected, causes the electronic device to initiate a process to preserve the first generative visual content, such as option 1680 in FIG. 16B. In some embodiments, the electronic device displays the representation of the first generative visual content without having received the navigation input. In some embodiments, the electronic device displays the first generative visual content in response to receiving a navigation input while displaying a representation of different generative visual content based on the first prompt (e.g., the second generative visual content or other generative visual content). In some embodiments, the electronic device displays the first generative visual content without concurrently displaying the second generative visual content (e.g., or any other generative visual content).

In some embodiments, the electronic device displays the first selectable option concurrently with the first generative visual content. In some embodiments, the electronic device displays the first selectable option overlaid on the first generative visual content. In some embodiments, the electronic device displays the first selected option adjacent to the first generative visual content. In some embodiments, the process to preserve the first generative visual content includes saving the first generative visual content to a media library, such as an image library or a library of automatically-generated media. In some embodiments, the process to preserve the first generative visual content includes copying the first generative visual content to a virtual clipboard of the electronic device. In some embodiments, the electronic device is able to paste the first generative visual content into another user interface from the virtual clipboard. In some embodiments, the process to preserve the first generative visual content includes sharing the first generative visual content with a user account other than a user account of the electronic device. For example, the electronic device sends an electronic message including the first generative visual content to the other user account (e.g., using e-mail, instant messenger, encrypted messaging, and/or a multi-media message).

In some embodiments, while displaying, via the one or more display generation components, the representation of the first generative visual content based on the first prompt, the electronic device receives, via the one or more input devices, an input selecting the first selectable option, such as the input (e.g., a tap or a long press input) with contact 1603q in FIG. 16Q. In some embodiments, the input is a touch input, an air gesture input, an input received using a hardware input device, and/or a voice input. In some embodiments, additionally or alternatively, the electronic device receives an input requesting to preserve the first generative visual content that does not include selection of the first selectable option, such as a touch input, an air gesture input, an input received using a hardware input device, and/or a voice input not directed to the first selectable option, but corresponding to requesting the preserve the first generative visual content.

In some embodiments, while displaying, via the one or more display generation components, the representation of the first generative visual content based on the first prompt, in response to receiving the input selecting the first selectable option, the electronic device initiates the process to preserve the first generative visual content, as described above with reference to FIG. 16R′. In some embodiments, initiating the process to preserve the first generative visual content includes displaying additional selectable options, that, when selected, cause the electronic device to preserve the first generative visual media using respective actions with respect to the first generative visual media, as described in more detail below. In some embodiments, initiating the process to preserve the first generative visual content includes preserving the first generative visual content according to one of the actions with respect to the first generative visual content described in more detail below without displaying additional selectable options other than the first selectable option. As described in more detail below, in some embodiments, in response to receiving the input selecting the first selectable option (or the input requesting to preserve generative visual content) while displaying second generative visual content, the electronic device would initiate a process to preserve the second generative visual content. In some embodiments, initiating the process to preserve the first generative visual content does not include initiating a process to preserve second generative visual content and initiating the process to preserve the second generative visual content does not include initiating a process to preserve the first generative visual content. Initiating a process to preserve the first generative visual content in response to receiving an input while displaying the first generative visual content enhances user interactions with the electronic device by reducing the number of inputs needed to view the first generative visual content at a later time, which decreases energy consumption at the electronic device and optionally improves battery life of the electronic device.

In some embodiments, initiating the process to preserve the first generative visual content includes displaying, via the one or more display generation components, a second selectable option that, when selected, causes the electronic device to perform a first action with respect to the first generative visual content, and a third selectable option that, when selected, causes the electronic device to perform a second action with respect to the first generative visual content different from the first action, such as selectable options 1682a through 1682c in FIG. 16R′ and/or herein with reference to method 1700. In some embodiments, the electronic device displays the second and third options overlaid on the representation of the first generative visual content and/or the user interface for editing the prompt of the first generative visual content. In some embodiments, the second option and/or third option correspond to options to save the first generative visual content, to copy the first generative visual content to a virtual clipboard of the electronic device, and/or to initiate a process to share the first generative visual content with a user account different from the user account associated with the electronic device (e.g., via an electronic message). In some embodiments, saving the first generative visual content includes adding the first generative visual content to a library of generative visual content of the electronic device and/or of the user account associated with the electronic device. In some embodiments, copying the first generative visual content to the virtual clipboard enables pasting the first generative visual content into a content entry field of an application other than the application for editing and/or generating generative visual media. In some embodiments, sharing the first generative visual content includes presenting user interfaces for selecting the user account with which to share the first generative visual content and selecting the sharing protocol to use to share the first generative visual content, such as which form of electronic message to use to send the generative visual content to the other user account. Presenting a plurality of options for performing a plurality of actions to preserve the first generative visual content enhances user interactions with the electronic device by reducing the number of inputs needed to present various options for preserving the first generative visual content, which reduces power consumption and/or increases battery life of the electronic device.

In some embodiments, while displaying, via the one or more display generation components, the second selectable option and the third selectable option, the electronic device receives, via the one or more input devices a second input selecting the second selectable option or the third selectable option, such as one or more inputs (e.g., one or more taps or long press inputs) with contacts 1603a through 1603c in FIG. 16R′. In some embodiments, the second input is one of a touch input, air gesture input, hardware input device input, and/or voice input directed to the second selectable option or the third selectable option. In some embodiments, additionally or alternatively, the electronic device receives a different input corresponding to a request to perform the first action or second action described herein that is not directed to the first option or the second option, such as a touch input, air gesture input, hardware input device input, and/or voice input.

In some embodiments, in response to receiving the second input, in accordance with a determination that the second input includes selection of the second selectable option, the electronic device performs the first action with respect to the first generative visual content including preserving the first generative visual content in a first manner, such as one of the manners described above with reference to FIG. 16R′ and/or herein with reference to method 1700. In some embodiments, the after performing the first action, the electronic device resumes displaying the representation of the first generative visual media. In some embodiments, after performing the first action and while displaying the representation of the first generative visual media, the electronic device displays the first selectable option that, when selected, causes the electronic device to initiate the process to preserve the first generative visual media, thereby enabling the user to preserve the first generative visual media using the second action after preserving the first generative visual media using the first action. In some embodiments, after performing the first action, the electronic device receives the navigation input described above and, in response to receiving the navigation input, displays the representation of the second generative visual media based on the first prompt.

In some embodiments, in response to receiving the second input, in accordance with a determination that the second input includes selection of the third selectable option, the electronic device performs the second action with respect to the first generative visual content including preserving the first generative visual content in a second manner different from the first manner, such as one of the manners described above with reference to FIG. 16R′ and/or herein with reference to method 1700. In some embodiments, the after performing the second action, the electronic device resumes displaying the representation of the first generative visual media. In some embodiments, after performing the second action and while displaying the representation of the first generative visual media, the electronic device displays the first selectable option that, when selected, causes the electronic device to initiate the process to preserve the first generative visual media, thereby enabling the user to preserve the first generative visual media using the first action after preserving the first generative visual media using the second action. In some embodiments, after performing the second action, the electronic device receives the navigation input described above and, in response to receiving the navigation input, displays the representation of the second generative visual media based on the first prompt. In some embodiments, as described in more detail below, while displaying the representation of the second generative visual media after performing the first action and/or the second action, the electronic device displays a selectable option that, when selected, causes the electronic device to initiate a process to preserve the second generative visual media. Preserving the first generative visual media using the first action or the second action depending on whether the second input is directed to the second option or the third option enhances user interaction with the electronic device by reducing the number of inputs needed to preserve the first generative visual media, which reduces power consumption and/or preserves battery life of the electronic device.

In some embodiments, while displaying, via the one or more display generation components, the representation of the second generative visual content based on the first prompt (e.g., optionally in response to receiving the navigation input while displaying the representation of the first generative visual media as described above), the electronic device displays, via the one or more display generation components, a second selectable option that, when selected, causes the electronic device to initiate a process to preserve the second generative visual content, such as displaying one or more of options 1632a through 1632c in FIG. 16R′ while displaying a variant of the generative visual media 1652b optionally as described above with respect to the first generative visual media except with respect to the second generative visual media. In some embodiments, the electronic device displays the representation of the second generative visual content after receiving the input selecting the first selectable option and/or initiating the process to preserve the first generative visual content and/or after preserving the first generative visual content. In some embodiments, the electronic device displays the representation of the second generative visual content without having received the input selecting the first selectable option and/or initiating the process to preserve the first generative visual content and/or after preserving the first generative visual content. In some embodiments, the second selectable option has the same appearance and/or location in the user interface as the first selectable option described above. In some embodiments, the second selectable option functions the same way with respect to the second generative visual content as the way the first selectable option functions with respect to the generative visual content described above.

In some embodiments, while displaying, via the one or more display generation components, the representation of the second generative visual content based on the first prompt, the electronic device receives, via the one or more input devices, an input selecting the second selectable option, such as one of the inputs (e.g., one or more taps or long press inputs) with contacts 1603a through 1603c in FIG. 16R′, except while the electronic device 500 displays a different variant of the automatically-generated visual content 1652b, optionally as described above with respect to the first generative visual media except with respect to the second generative visual media.

In some embodiments, in response to receiving the input selecting the second selectable option, the electronic device initiates the process to preserve the second generative visual content, optionally as described above with respect to the first generative visual media except with respect to the second generative visual media and/or as described above with reference to FIG. 16R′. Preserving the first generative visual media based on the first prompt or preserving the second generative visual media depending on which representation was displayed when the first option was selected reduces the inputs needed to preserve multiple items of generative visual media based on the same prompt, which reduces power consumption and/or increases battery life of the electronic device.

It should be understood that the particular order in which the operations in FIG. 17 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1400, 1500, 1900, 2100, 2300, and/or 2700) are also applicable in an analogous manner to method 1700 described above with respect to FIG. 17. For example, the operation of generating multiple variations of representations of automatically-generated visual content described above with reference to method 1700 optionally has one or more of the characteristics of, displaying a representation of a prompt and one or more recognized concepts, editing one or more parameters, including one or more recognized concepts, of a previously generated automatically-generated visual content, adding a representation of automatically-generated visual content into a first application, presenting an automatically-generated visual media creation user interface to use a non-automatically-generated visual media as the reference media item, displaying portion(s) of a user interface with HDR luminance, displaying one or more portions of the user interface with luminance that is within or greater than a SDR luminance, restricting prompt components to be used to generate automatically-generated visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., 700, 800, 1000, 1200, 1400, 1500, 1900, 2100, 2300, and/or 2700). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 17 are, optionally, implemented by components depicted in FIGS. 1A-1B. For example, detecting operation 1702a and displaying operation 1702b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners, including interacting with applications to create content items. The embodiments described below provide a quick and efficient way of restricting automatically-generated visual content generated in response to user inputs, which enhances the operability of the device and makes the user-device interface more efficient. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

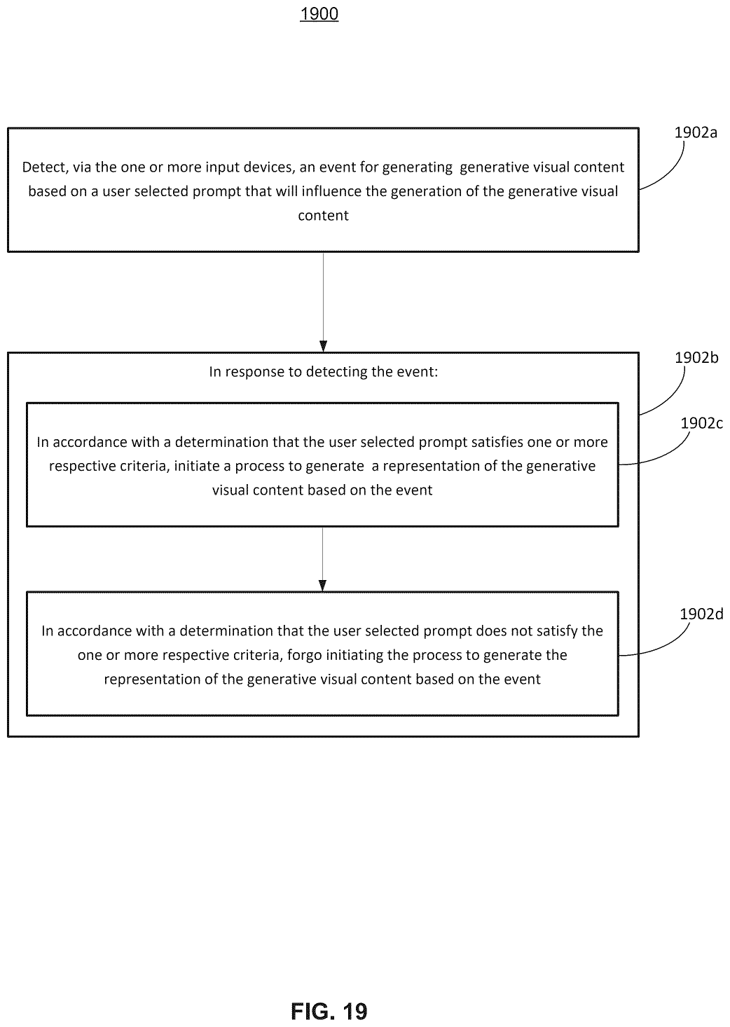

FIGS. 18A-18BB illustrate exemplary ways in which an electronic device restricts automatically-generated visual content according to some embodiments of the disclosure. The embodiments in these figures are used to illustrate the processes described below, including the processes described with reference to FIG. 19. Although FIGS. 18A-18BB illustrate various examples of ways an electronic device is able to perform the processes described below with respect to FIG. 19, it should be understood that these examples are not meant to be limiting, and the electronic device is able to perform one or more processes described below with reference to FIG. 19 in ways not expressly described with reference to FIGS. 18A-18BB.

In some embodiments, the user interface of FIGS. 18A-18BB corresponds to the user interface of FIGS. 6A-6MM, 16A-16U, 20D-20AA, 22A-22CCC, and/or 26A-26P.

FIG. 18A illustrates an electronic device 500 displaying an editing user interface 1800a of a content application described in more detail with reference to method 700. In some embodiments, displaying the editing user interface 1800a of the content application is analogous to and/or includes one or more characteristics of displaying the editing user interface 1600a in FIG. 16A-16U and user interface 604 in FIG. 6A-6MM and/or the user interface of FIGS. 20A-20AA, 22A-22CCC, 24A-24E, and/or 26A-26P. In some embodiments, the electronic device 500 generates automatically-generated visual content analogous to and/or including one or more characteristics of generating automatically-generated visual content described with reference to FIGS. 16A-16U.

In FIG. 18A, the electronic device 500 displays, in the editing user interface 1800a, a keyboard user interface element 1822 and a cancel option 1802a that, when selected, causes the electronic device 500 to close (e.g., cease to display) the editing user interface 1800a.

In some embodiments, the keyboard user interface element 1822 is analogous to and/or includes one or more characteristics of the keyboard user interface element 1646 in FIG. 16L. In some embodiments, the cancel option 1802a is analogous to and/or includes one or more characteristics of the option 624a, 1602a, and/or 2202a in FIGS. 6B-6MM, 16A-16U, 20D-20AA, 22A-22CCC, and/or 26A-26P. The electronic device 500 also displays content entry user interface element 1824a. In some embodiments, the content entry user interface element 1824a is analogous to and/or includes one or more characteristics of the content entry user interface element 1640a in FIGS. 16K and 16L. The electronic device 500 also displays submit option 1824b that, when selected, causes the electronic device to use content entered in the content entry user interface element 1640a as a prompt component for generating an automatically-generated visual content item.

In FIG. 18A, the electronic device 500 detects one or more text entry inputs 1826a directed to the keyboard user interface element 1822 and in response, the electronic device 500 displays the text 1828 “shooting” in the content entry user interface element 1824a in FIG. 18B. In some embodiments, detecting the one or more text entry inputs 1826a includes detecting a sequence of one or more selection input(s) and/or directed to the keyboard user interface element 1822. In some embodiments, the one or more selection input(s) is optionally analogous to and/or includes one or more characteristics of the selection input 1624i in FIG. 16F.

In FIG. 18A, while the electronic device 500 displays the text “shooting” in the content entry user interface element 1824a, the electronic device detects a selection input 1826b directed to the submit option 1824b, and in response to detecting the selection input 1826b, the electronic device 500 determines whether the event of adding a term that includes the text 1828 “shooting” to the user selected prompt used to influence the generation of automatically-generated visual content satisfies one or more respective criteria as described in more detail with reference to method 1900.

In some embodiments, in response to detecting the selection input 1826b directed to the submit option 1824b, the electronic device 500 determines that the event to add the term that includes the text 1828 “shooting” to the user selected prompt does not satisfy the one or more respective criteria. In accordance with a determination that the user selected prompt includes at least one term that has a high-risk meaning (e.g., the term that includes the text 1828 “shooting”), the electronic device 500 displays, as shown in FIG. 18C, the editing user interface 1800a. In FIG. 18c, the editing user interface 1800a includes an undo option 1832 indicating that the user selected prompt is unsupported (e.g., does not satisfy the one or more respective criteria). The editing user interface 1800a also includes a first component 1830a that includes the term “shooting,” and a deletion option 1830aa associated with the first component 1830a that, when selected, causes the electronic device to remove first component 1830a from the user selected prompt. Additionally, the editing user interface 1800a also includes a generation status indication 1806 indicative of the electronic device 500 forgoing initiating the process to generate one or more preview representations of automatically-generated visual content based on the user selected prompt with the component 1830a added.

In FIG. 18C, the electronic device 500 detects a selection input 1826c directed to the deletion option 1830aa. The selection input 1826c directed to the deletion option 1830aa is optionally analogous to and/or includes one or more characteristics of the selection input 1624i in FIG. 16F. In some embodiments, in response to detecting the selection input 1826c directed to the deletion option 1830aa in FIG. 18C, the electronic device 500 removes the prompt component 1830a, as shown in FIG. 18D. Additionally, in some embodiments, the electronic device 500 determines that the event to remove first component 1830a from the user selected prompt satisfies the one or more respective criteria. In accordance with a determination that the user selected prompt satisfies the one or more respective criteria, the electronic device 500 displays, in the editing user interface 1800a in FIG. 18D, a second generation status indication 1804 indicative of the user selected prompt satisfying the one or more respective criteria and optionally, that initiating the process to generate one or more preview representations of automatically-generated visual content based on the user selected prompt with component 1830a removed has not started. In some embodiments, the second generation status indication 1804 is displayed with a visual appearance different from the respective visual appearance of the generation status indication 1806 as described in more detail with reference to method(s) 1000, 1400, and/or 1500.

FIGS. 18E and 18F illustrate a side by side comparison of a left electronic device 500a-1 where the electronic device 500a-1 determines that a submitted term satisfies the one or more respective criteria and a right electronic device 500b-2 where the electronic device 500b-2 determines that a submitted term does not satisfy the one or more respective criteria. Electronic devices 500a-1 and 500b-2 are optionally analogous to and/or include one or more characteristics of the electronic device 500 described herein. In FIG. 18E, the electronic device 500a-1 detects an event corresponding to a request add a term 1834a-1 “shooting stars” to the user selected prompt. In some embodiments, the event includes detecting a sequence of selection inputs, such as one or more text entry inputs directed to the keyboard user interface element 1822a-1 and a selection input 1826a-1 directed to the submit option 1824aa-1 in FIG. 18E.

In FIG. 18E, the electronic device 500b-2 detects an event corresponding to a request add a term 1836b-2 “shooting guns” to the user selected prompt. In some embodiments, the event includes detecting a sequence of selection inputs, such as one or more text entry inputs directed to the keyboard user interface element 1822b-2 and a selection input 1826b-2 directed to the submit option 1824bb-2 in FIG. 18E. In some embodiments, the one or more selection input(s) described herein with reference to FIG. 18E are optionally analogous to and/or include one or more characteristics of the selection input 1624i in FIG. 16F.

In FIG. 18F, in response to detecting the event corresponding to the request add a term 1834a-1 “shooting stars” to the user selected prompt, the electronic device 500a-1 determines that the event satisfies the one or more respective criteria including a requirement that none of the terms in the user selected prompt have a high-risk meaning in order for the one or more respective criteria to be satisfied as described in more detail with reference to method 1900. In accordance with a determination that the user selected prompt satisfies the one or more respective criteria, the electronic device 500a-1 displays, in the editing user interface 1800a-1, a first component 1830a-1 that includes the term “shooting stars,” a deletion option 1830aa-1 associated with the first component 1830a that, when selected, causes the electronic device 500a-1 to remove first component 1830a-1 from the user selected prompt, and preview representation 1808a-1 of a first automatically-generated visual content based on the user selected prompt with the component 1838a-1 added.

In contrast, in response to detecting the event corresponding to the request add a term 1834b-2 “shooting guns” to the user selected prompt, the electronic device 500b-2 determines that the event does not satisfy the one or more respective criteria when the user selected prompt includes at least one term (e.g., term 1834b-2 “shooting guns”) that has a high-risk meaning as described in more detail with reference to method 1900. In accordance with a determination that the user selected prompt does not satisfy the one or more respective criteria, the electronic device 500b-2 displays, in the editing user interface 1800b-2, an undo option 1832b-2 indicating that the user selected prompt is unsupported (e.g., does not satisfy the one or more respective criteria) and a first component 1838b-2 that includes the term “shooting guns,” a deletion option 1838bb-2 associated with the first component 1838b-2 that, when selected, causes the electronic device 500b-2 to remove first component 1838b-2 from the user selected prompt, and a generation status indication 1806b-2 indicative of the electronic device 500 forgoing initiating the process to generate one or more preview representations of automatically-generated visual content based on the user selected prompt with the component 1838b-2 added.

In FIG. 18F, while displaying the generation status indication 1806b-2, the electronic device 500b-2 detects a selection input 1826b-2 directed to the undo option 1832b-2. The selection input 1826b-2 directed to the undo option 1832b-2 is optionally analogous to and/or includes one or more characteristics of the selection input 1624i in FIG. 16F. In some embodiments, in response to detecting the selection input 1826b-2 directed to the undo option 1832b-2, the electronic device 500b-2 performs an undo operation directed to the user selected prompt as described in more detail with reference to method 1900. For example, performing the undo operation includes the electronic device 500b-2 undoing a previous action in response to an event performed by the electronic device 500b-2, such as removing the first component 1838b-2 from the user selected prompt.

In response to detecting selection input 1826b-2 directed to the undo option 1832b-2 in FIG. 18F, the electronic device 500b-2 removes the first component 1838b-2 from the user selected prompt, as shown in FIG. 18G. In some embodiments, after removing the first component 1838b-2 from the user selected prompt, the electronic device 500b-2 determines that the event to remove first component 1838b-2 from the user selected prompt satisfies the one or more respective criteria. In accordance with a determination that the user selected prompt satisfies the one or more respective criteria, the electronic device 500b-2 displays, in the editing user interface 1800a in FIG. 18G, a second generation status indication 1804 indicative of the user selected prompt satisfying the one or more respective criteria and optionally, that initiating the process to generate one or more preview representations of automatically-generated visual content based on the user selected prompt with component 1838b-2 removed has not started.

In some embodiments, in FIG. 18F, the electronic device 500b-2 detects an input, different from the selection input 1826b-2 directed to the undo option 1832b-2 that corresponds to a request to perform an undo operation. For example, in FIG. 18F, the electronic device 500b-2 detects a shaking of the electronic device 500b-2 performed by the user of the electronic device, as illustrated by arrows 1842b-2 and 1842bb-2 indicative of motion of the electronic device 500b-2. In some embodiments, in response to detecting the shaking of the electronic device 500b-2, the electronic device performs the undo operation analogous to and/or including one or more characteristics of performing the undo operation described herein with respect to FIGS. 18F and 18G.

In some embodiments, the one or more respective criteria include a requirement that none of the combinations of two or more terms in the user selected prompt have a high-risk meaning in order for the one or more respective criteria to be satisfied as described in more detail in method 1900. For example, in FIG. 18G, the editing user interface 1800a includes a second generation status indication 1804 and pre-defined components 1844a through 1844f. Components 1844a through 1844f are optionally analogous to and/or include one or more characteristics of the pre-defined components 1608b through 1608f in FIG. 16A. The editing user interface 1800a also includes control elements 1846a and 1848 optionally analogous to and/or include one or more characteristics of control elements 1610 and 1612, respectively. Additionally, the editing user interface 1800a includes options 1844f, 1850, and 1802a optionally analogous to and/or include one or more characteristics of options 1608a, 1614, and 1602a, respectively.

In some embodiments, while displaying the editing user interface 1800a in FIG. 18G, the electronic device 500 detects a dragging input 1826g (e.g., as described in more detail in method(s) 700 and/or 800) directed to pre-defined component 1844e that includes a “Basketball Player” subject characteristic. For example, the dragging input 1826g optionally includes contact (e.g., one or more fingers of the user) on the touch-sensitive surface (e.g., the one or more display generation components, such as display generation component 504, the one or more input devices, or other touch-sensitive device) at a location corresponding to the pre-defined component 1844e followed by movement of the contact to a predefined area within the editing user interface 1800a. The predefined area is optionally adjacent to the second generation status indication 1804 and after the pre-defined component 1844e is moved to within the predefined area in accordance with the movement of the contact, the electronic device 500 automatically adds pre-defined component 1844e to the user selected prompt in response liftoff of the contact. In some embodiments, the electronic device 500 detects the dragging input via an indirect input device, such as mouse, trackpad, or other input device described in method(s) 700 and/or 1700. In some embodiments, the dragging input includes an air gesture (e.g., described in more detail in method 1700), a forward pointing gesture (e.g., described in more detail in method 1700), or a tap and drag gesture (e.g., described in more detail in method 1700).

In some embodiments, in response to detecting the dragging input directed to the pre-defined component 1844e shown in FIG. 18G, the electronic device 500 adds the pre-defined component 1844e to the user selected prompt as shown in FIG. 18H. In some embodiments, in response to detecting the event of adding the pre-defined component 1844e to the user selected prompt, the electronic device 500 determines that the pre-defined component 1844e requires that the user selected prompt includes a subject in order for the one or more respective criteria to be satisfied, and that the user selected prompt does not include a subject as described in more detail in method 1900. For example, in accordance a determination that pre-defined component 1844e (e.g., “Basketball Player” subject characteristic) of the user selected prompt requires that the user selected prompt includes a subject in order for the one or more respective criteria to be satisfied, and that the user selected prompt does not include a subject, the electronic device 500 automatically selects a particular character or person as the subject (e.g., without detecting user input selecting the subject) as described in more detail with reference to method(s) 1900, 2100, and/or 2300. For example, automatically selecting a particular character or person as the subject includes the electronic device 500 changing the control element 1848 to include a name and image of the character selected as the subject as shown in FIG. 18H. Additionally, the electronic device 500 displays a second component 1852b that includes the selected subject (e.g., particular character “Jenna”) and a deletion option 1852bb associated with component 1852b as shown in FIG. 18I.

In FIG. 18I, the electronic device 500 also displays in the editing user interface 1800a a generation status indication 1810 indicative of the electronic device 500 initiating the process to generate one or more preview representations of automatically-generated visual content based on a user selected prompt that includes added component 1852b along with component 1844e. In some embodiments, while the process to generate the one or more preview representations of automatically-generated visual content based on the user selected prompt is in progress, the electronic device 500 detects a dragging input 1826h directed to suggested prompt component that includes a “Hairstyle” subject characteristic as shown in FIG. 18J. In some embodiments, the dragging input 1826h in FIG. 18J is analogous to and/or includes one or more characteristics of the dragging input 1826g in FIG. 18G. In some embodiments, in response to detecting the dragging input 1826h directed to the pre-defined component 1844c in FIG. 18J, the electronic device 500 adds the pre-defined component 1844c to the user selected prompt as shown in FIG. 18K.

In FIG. 18K, the electronic device 500 displays, in the editing user interface 1800a, a third component 1852c that includes the “Hairstyle” subject characteristic, a deletion option 1852cc associated with the third component 1852c that, when selected, causes the electronic device 500a-1 to remove third component 1852c from the user selected prompt/Additionally, the electronic device 500 displays a preview representation 1812 of a first automatically-generated visual content based on the user selected prompt including components 1852a, 1852b, and 1852c.

In FIG. 18K, the electronic device 500 detects a selection input 1826i directed to content entry control element 1846a. Control element 1846a optionally corresponds to element 1610, 2020a, and/or 2210a in FIGS. 16A-16U, 20D-20AA, 22A-22CCC, and/or 26A-26P. In response to detecting the selection input 1826i directed to content entry control element 1846a in FIG. 18K, the electronic device 500 displays a content entry user interface element 1846b in FIG. 18L. In FIG. 18L, the electronic device 500 detects a selection input 1826j directed to content entry user interface element 1846b. In some embodiments, selection inputs 1826i and 1826j are optionally analogous to and/or include one or more characteristics of the selection input 1624e in FIG. 16F.

In response to detecting selection input 1826j directed to content entry user interface element 1846b, the electronic device 500 displays keyboard user interface element 1822 in FIG. 16M. In FIG. 16M, the electronic device 500 detects an event corresponding to a request add a term 1854 “shooting” to the user selected prompt. In some embodiments, the event includes detecting a sequence of selection inputs, such as one or more text entry inputs directed to the keyboard user interface element 1822 and a selection input 1826k directed to the submit option 1824b in FIG. 18E. In some embodiments, the sequence of selection inputs and the selection input 1826k described herein with reference to FIG. 18M are optionally analogous to and/or include one or more characteristics of the selection input 1624i in FIG. 16F.

In some embodiments, in response to detecting the selection input 1826k directed to the submit option 1824b in FIG. 18M, the electronic device 500 determines that the event to add the term 1854 “shooting” to the user selected prompt satisfies the one or more respective criteria including a requirement that none of the combinations of two or more terms in the user selected prompt have a high-risk meaning in order for the one or more respective criteria to be satisfied. Additionally or alternatively, the electronic device 500 determines that adding the term 1854 “shooting” to the user selected prompt satisfies one or more respective criteria including a criterion that is satisfied when a user selected prompt, as a whole, is not directed to a high-risk concept. In accordance with a determination that the user selected prompt satisfies the one or more criteria, the electronic device 500 displays, in the editing user interface 1800a, a generation status indication 1810 indicative of the electronic device 500 generating one or more preview representations of automatically-generated visual content based on a user selected prompt that includes components 1852a through 1852d, as shown in FIG. 18N.

In FIG. 18O, the electronic device 500 determines that a first set of preview representations of respective automatically-generated visual content items based on the user selected prompt have been generated and in response, the electronic device 500 displays, in the editing user interface 1800a, a preview representation 1816 of a first automatically-generated visual content item based on the user selected prompt. In FIG. 18P, the electronic device 500 detects an event corresponding to a request add a term 1856 “gun” to the user selected prompt. In some embodiments, the event includes detecting a sequence of selection inputs, such as one or more text entry inputs directed to the keyboard user interface element 1822 and a selection input 1826l directed to the submit option 1824b in FIG. 18P. In some embodiments, the sequence of selection inputs and the selection input 1826l described herein with reference to FIG. 18P are optionally analogous to and/or include one or more characteristics of the selection input 1624i in FIG. 16F.

In some embodiments, in response to detecting the selection input 1826l directed to the submit option 1824b in FIG. 18P, the electronic device 500 determines that adding the term 1856 (e.g., “gun”) to the user selected prompt does not satisfy the one or more respective criteria including a requirement that none of the combinations of two or more terms in the user selected prompt have a high-risk meaning in order for the one or more respective criteria to be satisfied. In accordance with a determination that the user selected prompt includes a combination of two or more terms that collectively have a high-risk meaning, the electronic device 500 displays, as shown in FIG. 18Q, in the editing user interface 1800a, an undo option 1832 because the user selected prompt is unsupported (e.g., does not satisfy the one or more respective criteria). The editing user interface 1800a also includes a fifth component 1852e that includes the term “gun,” and a deletion option 1852ee associated with the fifth component 1852e that, when selected, causes the electronic device to remove fifth component 1852e from the user selected prompt. Additionally, the editing user interface 1800a includes a generation status indication 1806 indicative of the electronic device 500 forgoing initiating one or more preview representations of automatically-generated visual content based on the user selected prompt with the component 1852e added.

In FIG. 18Q, the electronic device 500 detects a selection input 1826m directed to the deletion option 1852dd. The selection input 1826m directed to the deletion option 1852dd is optionally analogous to and/or includes one or more characteristics of the selection input 1624i in FIG. 16F. In some embodiments, in response to detecting the selection input 1826m directed to the deletion option 1852dd, the electronic device 500 determines that the event to remove the fifth component 1852d from the user selected prompt does not satisfy the one or more respective criteria including the requirement that none of the combinations of two or more terms in the user selected prompt have a high-risk meaning. In some embodiments, the electronic device 500 determines that the one or more respective criteria are not satisfied when the user selected prompt includes at least one term that has a high-risk meaning. In accordance with a determination that the user selected prompt does not satisfy the one or more respective criteria, the electronic device 500 maintains display of the undo option 1832 and generation status indication 1806 without including a preview of automatically-generated visual content, as shown in FIG. 18R.

In FIG. 18R, after removing component 1852d, the electronic device 500 detects the selection input 1826n directed to the undo option 1832 while the electronic device 500 still determines that the user selected prompt includes a high-risk concept. The selection input 1826n directed to the undo option 1832 is optionally analogous to and/or includes one or more characteristics of the selection input 1624i in FIG. 16F. In some embodiments, in response to detecting the selection input 1826n directed to the undo option 1832, the electronic device 500 performs an undo operation directed to the user selected prompt as described in more detail with reference to method 1900. For example, performing the undo operation includes the electronic device 500 returning the user selected prompt to a previous state of the user selected prompt that satisfied the one or more respective criteria, as shown in FIG. 18S.

In FIG. 18S, the editing user interface element 1800a includes a preview representation 1820 of a first automatically-generated visual content item based on the user selected prompt including components 1852a, 1852b, and 1852c. The electronic device 500 also continues to display prompt components 1852a, 1852b, and 1852c and options 1802a and 1802b. In some embodiments, options 1802a and 1802b are analogous to and/or have characteristics of options 624a, 1602a, 2202a and 624b, 1602b, and/or 2202b, respectively, in FIG. 6B-6MM, 16A-16U, 20D-20AA, 22A-22CCC, and/or 26A-26P. In FIG. 18S, the electronic device 500 detects a selection input 1826o directed to the deletion option 1852bb associated with the component 1852b. The selection input 1826o directed to the deletion option 1852bb is optionally analogous to and/or includes one or more characteristics of the selection input 1624i in FIG. 16F. In some embodiments, in response to detecting the selection input 1826o directed to the deletion option 1852bb, the electronic device 500 removes component 1852b from the user selected prompt and displays a preview representation 1818 of a first automatically-generated visual content based on the user selected prompt including components 1852a and 1852c, as shown in FIG. 18T.

In FIG. 18U, the electronic device 500 detects an event corresponding to a request add a term 1858 “shooting” to the user selected prompt. In some embodiments, the event includes detecting a sequence of selection inputs, such as one or more text entry inputs directed to the keyboard user interface element 1822 and a selection input 1826 directed to the submit option 1824b. In some embodiments, the one or more selection input(s) described herein with reference to FIG. 18U are optionally analogous to and/or include one or more characteristics of the selection input 1624i in FIG. 16F.

In FIG. 18V, in response to detecting the event corresponding to the request add a term 1858 “shooting” to the user selected prompt, the electronic device 500 determines that the event does not satisfy the one or more respective criteria when the user selected prompt includes at least one term (e.g., term 1858 “shooting”) that has a high-risk meaning as described in more detail with reference to method 1900. In accordance with a determination that the user selected prompt does not satisfy the one or more respective criteria, the electronic device 500 displays, as shown in FIG. 18W, in the editing user interface 1800b, an undo option 1832 indicating that the user selected prompt is unsupported (e.g., does not satisfy the one or more respective criteria). The editing user interface 1800b also includes a component 1852f that includes the term “shooting,” and a deletion option 1852ff associated with the component 1852f that, when selected, causes the electronic device 500 to remove component 1852f from the user selected prompt, and a generation status indication 1806 indicative of the electronic device 500 forgoing generating one or more preview representations of automatically-generated visual content based on the user selected prompt with the component 1852 added.

In FIG. 18W, while displaying the generation status indication 1806, the electronic device 500 detects an event corresponding to a request add a term 1860 “darts” to the user selected prompt. In some embodiments, the event is analogous to and/or includes one or more characteristics of detecting the event corresponding to the request to add the term 1858 “shooting” to the user selected prompt in FIG. 18U. For example, the electronic device 500 detects a sequence of inputs directed to keyboard user interface element 1822, followed by selection of submit option 1842b. In response to detecting the event corresponding to the request add a term 1860 “darts” to the user selected prompt, the electronic device 500 determines that the event satisfies the one or more respective criteria including the requirement that none of the terms in the user selected prompt have a high-risk meaning in order for the one or more respective criteria to be satisfied.

In some embodiments, in accordance with the determination that the one or more respective criteria are satisfied, the electronic device 500 displays a generation status indication 1810 indicative of the electronic device 500 generating one or more preview representations of automatically-generated visual content based on the user selected prompt that includes components 1852a, 1852c, 1852g, and 1852, as shown in FIG. 18X. In FIG. 18Y, the electronic device 500 determines a preview representation 1820 of a first automatically-generated visual content item has been generated and displays the preview representation 1820 in the editing user interface 1800a, as shown in FIG. 18Y.

In 18Y, the electronic device 500 detects a selection input 1826s directed to the control element 1848. Control element 1848 optionally corresponds to element 1612, 2020b, and/or 2210b in FIGS. 16A-16U, 20D-20AA, 22A-22CCC, and/or 26A-26P. In some embodiments, the selection input 1826s is optionally analogous to and/or includes one or more characteristics of the selection input 1624e in FIG. 16F. In some embodiments, in response to detecting the selection input 1826s directed to the control element 1848 in FIG. 18Y, the electronic device displays subject personalization user interface element 1868a in the variants user interface 1800b as shown in FIG. 18Z. In some embodiments, variants user interface 1800b is analogous to and/or includes one or more characteristics of the variants user interface 1600b as shown in FIG. 16G. In some embodiments, the subject personalization user interface element 1868a is analogous to and/or includes one or more characteristics of the subject personalization user interface element 1626a in the variants user interface 1600b as shown in FIG. 16G.

FIG. 18Z includes options 1868b and 1868c that optionally correspond to options 1626b, 2038c, and/or 2214a and options 1626c, 2038d, and/or 2214b, respectively, as shown in FIGS. 16A-16U, 20D-20AA, 22A-22CCC, and/or 26A-26P.

In FIG. 18Z, subject user interface element 1870g is currently selected (e.g., included in the user selected prompt to influence generation of automatically-generated visual content) and optionally includes one or more characteristics of the subject user interface element 1626j in FIG. 16G. In some embodiments, the electronic device 500 detects a selection input 1826t directed to subject user interface element 1870e. In some embodiments, the selection input is optionally analogous to and/or includes one or more characteristics of the selection input 1624e in FIG. 16F. In response to detecting the selection input 1826t directed to subject user interface element 1870e in FIG. 18Z, the electronic device 500 displays a generation status indication 1804 indicative of the electronic device 500 initiating the process to generate one or more preview representations of automatically-generated visual content based on a user selected prompt that includes the subject associated with subject user interface element 1870e in FIG. 18AA.

In FIG. 18BB, the electronic device 500 determines that a first set of preview representations of respective automatically-generated visual content items have been generated and in response, the electronic device 500 displays, in the variants user interface 1800b, a preview representation of a first automatically-generated visual content item 1874 based on the user selected prompt that includes the subject associated with subject user interface element 1870e. The electronic device 500 also displays indicators 1876a through 1876b corresponding to the number of preview representations of respective automatically-generated visual content items currently available for display.

FIG. 19 illustrates a flow diagram illustrating a method in which an electronic device restricts automatically-generated visual content in accordance with some embodiments of the disclosure. The method 1900 is optionally performed at first electronic device and/or electronic devices such as device 100, device 300, or device 500 as described above with reference to FIGS. 1A-1B, 2-3, 4A-4B and 5A-5H. Some operations in method 1900 are, optionally combined and/or order of some operations is, optionally, changed.

As described below, the method 1900 provides ways in which an electronic restricts automatically-generated visual content generated in response to user inputs. Restricting automatically-generated visual content enhances the operability of the device and makes the user-device interface more efficient by reducing user errors.

In some embodiments, a method 1900 is performed at an electronic device in communication with one or more display generation components and one or more input devices. In some embodiments, the electronic device has one or more characteristics of the electronic device described in method 700. In some embodiments, the display generation component(s) has (have) one or more characteristics of the display generation component described in method 700. In some embodiments, the one or more input devices have one or more characteristics of the one or more input devices described in method 700. In some embodiments, the electronic device detects (1902a), via the one or more input devices, an event for generating (e.g., using an AI process or a generative AI process) generative visual content based on a user selected prompt that will influence the generation of the generative visual content, such as the event of adding term 1828 as shown in FIG. 18B. In some embodiments, the electronic device displays a user interface while the electronic device detects the event. For example, the user interface is optionally a user interface of a content application (e.g., described in method 700 and/or as shown in FIG. 6KK), a user interface that includes information associated with the prompt (e.g., described in method 700 and/or as shown in FIG. 6JJ), an editing user interface (e.g., described in method 800 and/or as shown in FIG. 6W), and/or other user interface (e.g., described below and/or in method(s) 700 and/or 800). The generative visual content is described in greater detail in method(s) 700 and/or 800, and/or as shown in FIGS. 6E and 6F.

In some embodiments, the user selected prompt includes the prompt for use in creating generative visual content described in method 700 and/or as shown in FIG. 6L. In some embodiments, the event corresponds to a user input to modify one or more recognized concepts associated with the user selected prompt as described with reference to method 700 and/or as shown in FIG. 6N. In some embodiments, the event corresponds to receiving a user input creating and/or specifying the prompt, as described above with reference to method 700 and/or as shown in FIG. 6S. In some embodiments, the event corresponds to a user input to modify the user selected prompt as described with reference to method 700 and/or as shown in FIGS. 6X and 6Y. In some embodiments, the user input has one or more characteristics of the one or more inputs described with reference to method 700 and/or as shown in FIGS. 6U and 6V.

In some embodiments, the event corresponds to a first functionality that outputs generative visual content using a first artificial intelligence (AI) model described in method 1400. For example, and as described with reference to method 1400, the event corresponds to a request from one or more active applications running on the electronic device corresponding to a request to initiate the one or more AI operations to output generative visual content. Thus, in some embodiments, the event does not include additional user input other than user input directed to the prompt for use in creating generative visual content described in method 700. In some embodiments, and as will be described herein, initiating or forgoing the process to generate a representation of the generative visual content is based on the event (e.g., modifying the one or more recognized concepts and/or modifying the user selected prompt) and/or an event described in method 1400 corresponding to initiating one or more AI operations. In some embodiments, the electronic device automatically determines whether to initiate or forgo the process to generate a representation of the generative visual content based on the event without detecting additional user input.

In some embodiments, in response to detecting the event (1902b), and in accordance with a determination that the user selected prompt satisfies one or more respective criteria, the electronic device initiates (1902c) a process to generate (and/or generating) (e.g., using an AI process or a generative AI process) a representation of the generative visual content based on the event, such as representation 1816 as shown in FIG. 18O. In some embodiments, the one or more criteria are analogous to and/or includes one or more of the characteristics of the one or more criteria including a criterion that is satisfied when the prompt (e.g., the event based on a user selected prompt described herein) does not include high-risk recognized concepts described in method 700 and/or as shown in FIG. 6GG. In some embodiments, the electronic device determines that the one or more respective criteria are satisfied when the prompt includes one or more recognized concepts that are included in a first list and/or are not included in a second list, different from the first list. In some embodiments, the electronic device determines that the one or more respective criteria are not satisfied when the prompt includes one or more recognized concepts that are included in the second list and/or are not included in the first list. For example, the first list optionally includes acceptable concepts and the second list optionally includes high-risk concepts described in more detail with reference to method 700. In some embodiments, and as will be described in more detail below, the electronic device receives input corresponding to a request to modify the prompt and in response, the electronic device determines whether the modified prompt satisfies the one or more respective criteria as described herein. In some embodiments, the input corresponding to the request to modify the prompt is provided by the user of the electronic device and/or is automatically generated by the electronic device as will be described in more detail below. In some embodiments, when the electronic device determines that the input corresponding to the request to modify the prompt satisfies the one or more respective criteria, the electronic device initiates a process to generate a representation of the generative visual content based on the input. Generating (e.g., using an AI process or a generative AI process) the representation of the generative visual content and/or the generative visual content is (are) described in method(s) 700, 800, 1000, and/or 1200, and/or as shown in FIGS. 6HH and 6II.

In some embodiments, initiating the process to generate the representation of the generative visual content based on the event includes displaying the representation of the generative visual content in the user interface. In another example, initiating the process to generate the representation of the generative visual content based on the event optionally includes updating the representation of the generative visual content to correspond to the event (e.g., the modified one or more recognized concepts and/or the modified user selected prompt) and/or an event described in method 1400 corresponding to initiating one or more AI operations. In some embodiments, the electronic device additionally updates the representation of the prompt (e.g., described in method 700) to correspond to the event.

In some embodiments, in response to detecting the event (1902b), and in accordance with a determination that the user selected prompt does not satisfy the one or more respective criteria, the electronic device forgoes (1902d) initiating the process to generate the representation of the generative visual content based on the event, such, for example, displaying indication 1806 in FIG. 18Q. For example, and as described in more detail with reference to method 700, the electronic device optionally initiates the process to generate the representation of the generative visual content using other recognized concepts identified in the user selected prompt (e.g., recognized concepts that satisfy the one or more criteria not including the high-risk recognized concepts). Initiating or forgoing the process to generate a representation of the generative visual content based on an event allows the electronic device to enforce content restrictions while continuing to generate generative visual content when the criteria are satisfied, which simplifies the interaction between the user and the electronic device without requiring the user to provide further inputs to enforce content restrictions, thereby reducing the number of inputs and providing more efficient interactions between the user and the electronic device.

In some embodiments, satisfaction of the one or more respective criteria occurs automatically (e.g., without user input after detecting the event), such as shown in FIG. 18Y with the display of representation 18020. Thus, in some embodiments, initiating the process to generate the representation of the generative visual content based on the event occurs automatically, without detecting additional user input. In some embodiments, after detecting the event, the electronic device requests to generate the representation of the generative visual content. For example, initiating the process to generate the representation of the generative visual content based on the event optionally occurs automatically as soon as the electronic device determines that the user selected prompt satisfies the one or more respective criteria as described above with respect to high-risk concepts. In some embodiments, initiating the process to generate the representation of the generative visual content based on the event includes automatically transmitting a request to generate generative visual content to a remote server in communication with the electronic device and/or a local processor (e.g., maintained by the electronic device optionally from a content application operating on the electronic device) for processing, computing, generating, and/or refining the generative visual content. In some embodiments, the electronic device automatically includes event information including the user selected prompt that will influence the generation of the generative visual content described above in the request without detecting user input requesting to include the event information in the request. For example, detecting an event to remove a prompt component (e.g., recognized concept) from the user selected prompt that satisfies the one or more respective criteria causes the electronic device to automatically initiate the process to generate generative visual content. Thus, in some embodiments, the electronic device does not require detection of user input expressly requesting generation of generative visual content after removing the prompt component. Implementing an automatic satisfaction of the one or more respective criteria based on an event without detecting user input requesting to generate the representation of the generative visual content simplifies the interaction between the user and the electronic device without requiring the user to provide further inputs to generate generative visual content, thereby reducing the number of inputs and providing more efficient interactions between the user and the electronic device.

In some embodiments, automatically initiating the process to generate the representation of the generative visual content based on the event includes automatically initiating the process to generate the representation of the generative visual content based on the event in accordance with a determination that the electronic device does not detect one or more inputs editing the user selected prompt for a threshold period of time (e.g., 0.2, 0.5, 0.7, 0.9, 1, 2, 5, 7, 10, 30, or 60 seconds), such as, for example, automatically displaying status indication 1810 indicative of initiating the process to generate the representation of the generative visual content in FIG. 18N. In some embodiments, the one or more inputs editing the user selected prompt is analogous to and/or includes one or more characteristics of the electronic device detecting an input directed the one or more selectable options to edit a respective prompt as described in method(s) 700, 800, 1200, 1700, 1900, and/or 2100, and/or as shown in FIGS. 6B-6E, 6V, 16F, 16G, 11B-11E, and/or FIGS. 20L-20N. In some embodiments, the period of time starts at a moment when the electronic device detects a last input corresponding to a request to edit the second prompt. Automatically initiating the process to generate a representation of the generative visual content based on an event when the electronic device does not detect one or more inputs editing the second prompt for a threshold period of time simplifies the interaction between the user and the electronic device without requiring the user to provide further inputs to generate generative visual content, thereby reducing the number of inputs and providing more efficient interactions between the user and the electronic device. Additionally, by delaying the automatic generation, energy and processing resources of the electronic device are preserved by not generating the representation of the generative visual content when the electronic device detects one or more inputs editing the user selected prompt, which, reduces power usage and improves battery life of the electronic device.

In some embodiments, the event is a prompt editing event, such as the event shown in FIG. 18M of entering term 1854 in FIG. 18M. In some embodiments, automatically initiating the process to generate the representation of the generative visual content based on the event includes automatically initiating the process to generate the representation of the generative visual content based on the event in accordance with a determination that the event is a prompt editing event. For example, the electronic device determines that the event is a prompt editing event when the electronic device detects, via the one or more input devices, a user input to modify the user selected prompt, such as adding one or more prompt components (e.g., one or more recognized concepts) to the user selected prompt, removing one or more prompt components from the user selected prompt, or revising the one or more prompt components. In some embodiments, the user input has one or more characteristics of the one or more inputs described with reference to method 700. Automatically initiating the process to generate a representation of the generative visual content based on detecting a prompt editing event simplifies the interaction between the user and the electronic device without requiring the user to provide further inputs to generate generative visual content, thereby reducing the number of inputs and providing more efficient interactions between the user and the electronic device.

In some embodiments, detecting the event for generating (e.g., using an AI process or a generative AI process) generative visual content based on the user selected prompt that will influence the generation of the generative visual content includes detecting, via the one or more input devices, a user input corresponding to a request to generate generative visual content based on the user selected prompt, such as input 1826g directed to 1844f in FIG. 18G. In some embodiments, the user input corresponding to the request to generate generative visual content based on the user selected prompt includes a selection input, such as a tap or a long press including contact (e.g., using a finger or stylus) on a touch-sensitive surface corresponding to a user interface element, an air gesture (e.g., as described in method(s) 700 and/or 1700) while the gaze of the user of the electronic device is directed to the user interface element, a forward pointing in-air gesture (e.g., as described in method(s) 700 and/or 1700) directed to the user interface element, actuation of an indirect input device, such as a mouse, trackpad, or controller while a cursor is directed to the user interface element (or, optionally, while the user interface element has input focus), and/or voice input from the user corresponding to the request to select the user interface element and/or generate generative visual content based on the user selected prompt. In some embodiments, the user interface element is a control element that, when selected, causes the electronic device to initiate the process to generate the representation of the generative visual content based on the event. In some embodiments, electronic device displays, via the one or more display generation components, the user interface element concurrently with the user selected prompt as described in method 700 and/or as shown in FIGS. 6S and 6T. In some embodiments, in accordance with a determination that the user selected prompt does not satisfy the one or more respective criteria, the electronic device does not display the user interface element or the electronic device displays the user interface element with a reduced visual prominence indicative of an unavailable interaction state of the user interface element. For example, when the user interface element is unavailable, the user interface element is not responsive to the selection input. A determination that a user input corresponding to a request to generate generative visual content is an event for generating generative visual content based on a user selected prompt that will influence the generation of the generative visual content provides an intuitive way to influence generation of the first generative visual content, which simplifies the interaction between the user and the electronic device without requiring the user to provide further inputs, thereby reducing the number of inputs and providing more efficient interactions between the user and the electronic device.

In some embodiments, the one or more respective criteria are not satisfied when the user selected prompt includes at least one term that has a high-risk meaning, such as the meaning of component 1838b-2 as shown in FIG. 18F. In some embodiments, the one or more respective criteria include a requirement that none of the terms in the user selected prompt have a high-risk meaning in order for the one or more respective criteria to be satisfied, such as the user selected prompt that includes component 1852a through 1852c as shown in FIG. 18K. For example, the at least one term in a user selected prompt optionally refers to an isolated term that includes one or more recognized words or phrases. Thus, in some embodiments, the at least one term refers to a single term recognized concept (e.g., “shooting”) or multi-term recognized concept (e.g., “shooting hoops”). In some embodiments, the electronic device displays, via the one or more display generation components, a representation of the at least one in the user interface of the content application as described above. In some embodiments, the representation of the at least one term is analogous to and/or includes one or more characteristics of a (e.g., representation of a) prompt component described above. In some embodiments, the representation of the at least one term is displayed by the electronic device in response to the electronic device detecting one or more inputs providing the at least one term for inclusion in the user selection prompt. In some embodiments, detecting the one or more inputs includes detecting one or more text entry (or handwritten) inputs using a soft (or virtual) keyboard user interface element, a physical (or hardware) keyboard, touchpad, stylus, and/or dictation as described in method(s) 700 and/or 800, and/or as shown in FIGS. 6G and 6V.

In some embodiments, the one or more respective criteria are not satisfied when the electronic device determines (e.g., using one or more language models) that the meaning of the at least one term (e.g., “shooting bullets”) has a high-risk meaning (e.g., considered offensive, sensitive, or inappropriate) as described above with respect to high-risk terms, in method 700 and/or as shown in FIG. 6GG. Thus, in some embodiments, in accordance with a determination that the meaning of the at least one term in the user selected prompt does not satisfy the one or more respective criteria, the electronic device forgoes initiating a process to generate a representation of the generative visual content based on the user selected prompt that includes the at least one term that has the high-risk meaning.

In some embodiments, the electronic device determines that the one or more respective criteria are satisfied when the user selected prompt does not include the at least one term (e.g., “shooting bullets”) that has the high-risk meaning. In some embodiments, in accordance with the determination that the one or more respective criteria are satisfied, the electronic device initiates the process to generate the representation of the generative visual content based on the user selected prompt.

In some embodiments, the one or more respective criteria include a requirement that none of the terms in the user selected prompt have a high-risk meaning in order for the one or more respective criteria to be satisfied. For example, when the user selected prompt includes the terms “sunny,” “gun,” and “shooting,” the electronic device determines that one of the terms is considered to have a high-risk meaning, and thus, in some embodiments, the one or more respective criteria are not satisfied. In some embodiments, in accordance with the determination that the one or more respective criteria are not satisfied, the electronic device forgoes initiating the process to generate the representation of the generative visual content based on the user selected prompt that includes the terms “sunny,” “gun,” and “shooting.” Initiating the process to generate a representation of the generative visual content in accordance with the determination that none of the terms in the user selected prompt have a high-risk meaning; and forgoing initiating the process when the user selected prompt includes at least one term that has a high-risk meaning efficiently filters out terms and further does not trigger generation of generative visual content which avoids unnecessary processing power and time at generative visual content generation, thereby reducing the processing power and providing more efficient interactions between the user and the electronic device.

In some embodiments, the one or more respective criteria are not satisfied when the user selected prompt includes a combination of two or more terms that collectively have a high-risk meaning, such as user selected prompt that includes components 1852a through 1852e as shown in FIG. 18Q. In some embodiments, the one or more respective criteria include a requirement that none of the combinations of two or more terms in the user selected prompt have a high-risk meaning in order for the one or more respective criteria to be satisfied, such as user selected prompt that includes components 1852a through 1852c as shown in FIG. 18R. For example, the electronic device, using one or more language models, optionally determines that the combination of two or more terms included in the user selected prompt have more than one meaning or interpretation. For example, a first term “shooting” is optionally determined by the electronic device to have a first meaning (e.g., inappropriate and/or analogous to a recognized high-risk term from a list of high-risk terms as described above) when no other terms are in the user selected prompt. Thus, in some embodiments, the electronic device determines that the first term in the user selected prompt does not satisfy the one or more criteria as described above. In another example, the first term in combination with a second term “basketball player” is optionally determined by the electronic device to have a second meaning (e.g., appropriate and/or not recognized as a high-risk term), different from the first meaning. In some embodiments, the electronic device determines that the first term and the second term in the user selected prompt satisfy the one or more criteria as described above.

In some embodiments, in accordance with a determination that a meaning of the first term in the user selected prompt does not satisfy the one or more criteria as described above, and that the user selected prompt does not include one or more recognized terms other than the first term, the electronic device optionally forgoes initiating the process to generate a representation of the generative visual content based on the first term in the user selected prompt. In another example, in accordance with a determination that the meaning of the first term in the user selected prompt does not satisfy the one or more criteria as described above, and that the user selected prompt does include one or more recognized terms other than the first term, the electronic device optionally determines whether a meaning of the combination of the first term and the one or more recognized terms in the user selected prompt satisfies the one or more criteria including the requirement that none of the combinations of the first term and the one or more recognized terms in the user selected prompt have a high-risk meaning. In some embodiments, in accordance with a determination that the meaning of the combination satisfies the one or more criteria, the electronic device initiates the process to generate a representation of the generative visual content based on the combination of the first term and the one or more recognized concepts in the user selected. In some embodiments, in accordance with a determination that the meaning of the combination does not satisfy the one or more criteria including the requirement as described herein, the electronic device forgoes initiating the process to generate a representation of the generative visual content based on the combination of the first term and the one or more recognized terms in the user selected. In some embodiments, the electronic device determines the meaning of the user selected prompt as a whole, rather than each term or the combinations of two or more terms. Thus, in some embodiments, the one or more respective criteria are not satisfied when the user selected prompt as a whole has a high-risk meaning. In some embodiments, the electronic device determines whether potential output(s) (e.g., the generated generative visual content based on the user selected prompt) from the one or more AI operations indicate high-risk meaning. Thus, in some embodiments, the one or more respective criteria are not satisfied when a potential (e.g., not yet generated) generative visual content based on the user selected prompt has a high-risk meaning. Initiating the process to generate a representation of the generative visual content in accordance with the determination that none of the combinations of two or more terms in the user selected prompt have a high-risk meaning; and forgoing initiating the process when the user selected prompt includes a combination of two or more terms that collectively have a high-risk meaning efficiently filters out terms and further does not trigger generation of generative visual content which avoids unnecessary processing power and time at generative visual content generation, thereby reducing the processing power and providing more efficient interactions between the user and the electronic device.

In some embodiments, in response to detecting the event, in accordance with a determination that the user selected prompt does not satisfy the one or more respective criteria, the electronic device displays, via the one or more display generation components, a user interface element that, when selected, causes the electronic device to perform an undo operation directed to the user selected prompt, such as undo option 1832 as shown in FIG. 18Q. In some embodiments, while displaying the user interface element, the electronic device detects a selection input (e.g., described above with reference to detecting a user input corresponding to a request to generate generative visual content) directed to the user interface element, and in response, the electronic device performs the undo operation directed to the user selected prompt. In some embodiments, performing the undo operation directed to the user selected prompt includes undoing a previous action performed by the electronic device, such as removing (or, optionally, ceasing to display a representation of) a previously added prompt component, adding (or, optionally, redisplaying) a previously removed prompt component, and/or undoing a previously performed prompt component revision or modification operation. In some embodiments, in accordance with a determination that the user selected prompt does satisfy the one or more respective criteria, the electronic device forgoes displaying the user interface element. Displaying a user interface element that, when selected, causes the electronic device to perform an undo operation directed to the user selected prompt in accordance with the determination that the user selected prompt does not satisfy the one or more respective criteria provides an intuitive way to undo a previously performed user selected prompt revision, which reduces the cognitive burden on the user when undoing a previously performed user selected prompt revision and enabling the user to perform the undo operation faster and more efficiently, thereby conserving processing power and providing more efficient interactions between the user and the electronic device.

In some embodiments, while displaying the user interface element for performing the undo operation, the electronic device detects, via the one or more input devices, an input directed to the user interface element, such as input 1826n directed to undo option 1832 as shown in FIG. 18R. In some embodiments, the input directed to the user interface element is a selection input that is analogous to and/or includes one or more characteristics of detecting a user input corresponding to the request to generate generative visual content described above. For example, the user input optionally includes a tap gesture at a location on a touch-sensitive surface corresponding to the user interface element, an air gesture while the gaze of the user of the electronic device is directed to the user interface element, a forward pointing in-air gesture directed to the user interface element, actuation of an indirect input device while a cursor is directed to the user interface element (or, optionally, while the user interface element has input focus), and/or voice input from the user corresponding to the request to select the user interface element.

In some embodiments, in response to detecting the input directed to the user interface element for performing the undo operation, the electronic device performs the undo operation directed to the user selected prompt, such as removing component 1852e as shown in FIG. 18R. In some embodiments, performing the undo operation includes any of the actions to undo a previously performed prompt component revision operation described above. As described above, performing the undo operation optionally includes ceasing to display, via the one or more display generation components, the previously added prompt component (or, optionally, its representation). In some embodiments, after performing the undo operation directed to the user selected prompt, and in accordance with a determination that performing the undo operation causes the user selected prompt to satisfy the one or more respective criteria, the electronic device initiates the process to generate a second representation of the generative visual content based on the user selected prompt (e.g., the user selected prompt after the undo operation has been performed on it), such as, for example, displaying status indication 1810 indicative of initiating the process to generate a representation of generative visual content as shown in FIG. 18N. In some embodiments, the electronic device determined that the previously added prompt component in the user selected prompt did not satisfy the one or more respective criteria because the meaning of the prompt component and/or a combination of the prompt component and other prompt component(s) in the user selected prompt was determined to be high-risk as described above. In some embodiments, in response to performing the undo operation (e.g., removing the previously added prompt), the electronic device determines that the user selected prompt satisfies the one or more respective criteria. Thus, in some embodiments, after the electronic device removes the previously added prompt component, the electronic device initiates the process to generate a second representation of the generative visual content based on the user selected prompt that does not include the previously added prompt component. In some embodiments, initiating the process to generate the second representation of the generative visual content based on the user selected prompt is analogous to and/or includes one or more characteristics of initiating the process to generate the representation of the generative visual content based on the event described above. In some embodiments, in accordance with the determination that performing the undo operation causes the user selected prompt to satisfy the one or more respective criteria, the electronic device ceases to display, via the one or more display generation components, the (e.g., undo) user interface element. In some embodiments, the electronic device automatically initiates the process to generate a second representation of the generative visual content based on the user selected prompt in accordance with the determination that the prompt now satisfies the one or more criteria without receiving an input expressly requesting generative visual content generation. Thus, in some embodiments, the electronic device detects a single input to perform the undo operation that causes the electronic device to perform the undo operation and initiate the process to generate the generative visual content.

In some embodiments, after performing the undo operation directed to the user selected prompt, and in accordance with a determination that performing the undo operation causes the user selected prompt to not satisfy the one or more respective criteria, the electronic device forgoes initiating the process to generate the second representation of the generative visual content based on the user selected prompt (e.g., the user selected prompt after the undo operation has been performed on it), such as, for example, maintaining display of undo option 1832 as shown in FIG. 18R. In some embodiments, in accordance with a determination that performing the undo operation causes the user selected prompt to not satisfy the one or more respective criteria, the electronic device maintains display of the user interface element for performing the undo operation. In some embodiments, in accordance with a determination that performing the undo operation causes the user selected prompt to not satisfy the one or more respective criteria, the electronic device displays, via the one or more display generation components, a status indication that indicates the status of forgoing initiating the process to generate a representation of the generative visual content based on the user selected prompt as will be described in more detail below with respect to displaying a status indication.

For example, in response to performing the undo operation (e.g., removing the previously added prompt from the user selected prompt), the electronic device optionally determines that the user selected prompt does not satisfy the one or more respective criteria. In some embodiments, the electronic device determines that the one or more respective criteria are not satisfied in accordance with a determination that a meaning of the combination of the other prompt component(s) (e.g., not including the previously added, now removed, prompt component) in the user selected prompt is recognized as high-risk as described above. For example, the electronic device included the following terms in order to the user selected prompt: first term (e.g., “Jenna”), second term (e.g., “shooting”), and third term (e.g., “darts”). In some embodiments, after performing the undo operation to remove the third term, the electronic device determines the user selected prompt includes the first term and the second term, and that the user selected prompt does not satisfy the one or more respective criteria. Thus, in some embodiments, after the electronic device removes the previously added prompt component (e.g., the third term in the example described herein), the electronic device forgoes initiating the process to generate a second representation of the generative visual content based on the user selected prompt that does not include the previously added prompt component. In some embodiments, forgoing initiating the process to generate the second representation of the generative visual content based on the user selected prompt is analogous to and/or includes one or more characteristics of forgoing initiating the process to generate the representation of the generative visual content based on the event described above. In some embodiments, in accordance with the determination that performing the undo operation causes the user selected prompt to not satisfy the one or more respective criteria, the electronic device maintains displaying, via the one or more display generation components, the (e.g., undo) user interface element. In response to detecting further inputs directed to the undo user interface element, the electronic device performs further undo operation(s) and, in accordance with a determination that the prompt satisfies the one or more criteria, generates the media based on the prompt after the further undo operation(s) were performed as described above. In accordance with a determination that the prompt still does not satisfy the one or more criteria after performing multiple undo operations, the electronic device forgoes generating the media as described above. Initiating or forgoing the process to generate a representation of the generative visual content based on performing an undo operation and whether the undo operation causes one or more respective criteria to be satisfied simplifies the interaction between the user and the electronic device without requiring the user to provide further inputs to request the generation of generative visual content, thereby reducing the number of inputs and providing more efficient interactions between the user and the electronic device.

In some embodiments, performing the undo operation directed to the user selected prompt includes removing a last-added prompt component from the user selected prompt, such as shown in FIGS. 18F and 18G with the removal of prompt 1832b. In some embodiments, the last-added prompt component is analogous to and/or includes one or more characteristics of the prompt component described in method(s) 700 and/or 800. In some embodiments, removing the last-added prompt component from the user selected prompt refers to removing a most-recent user selected prompt revision operation from a series of user-selected prompt revisions operations, such as adding one or more prompt components to the user selected prompt, removing one or more prompt components from the user selected prompt, or modifying the one or more prompt components. In some embodiments, in accordance with a determination that removing the last-added prompt component from the user selected prompt causes the user selected prompt to satisfy the one or more respective criteria, the electronic device initiates the process to generate the second representation of the generative visual content based on the user selected prompt as described above. In some embodiments, in accordance with a determination that removing the last-added prompt component from the user selected prompt causes the user selected prompt to not satisfy the one or more respective criteria, the electronic device forgoes initiating the process to generate the second representation of the generative visual content based on the user selected prompt as described above. In some embodiments, the electronic device maintains displaying the (e.g., undo) user interface element, via the one or more display generation components, unit the electronic device determines that the user selected prompt satisfies the one or more respective criteria. In some embodiments, in response to detecting further inputs directed to the undo user interface element (e.g., requesting to perform the undo operation twice or more), the electronic device performs the undo operation(s) and, in accordance with a determination that the prompt satisfies the one or more criteria, the electronic device generates (e.g., using an AI process or a generative AI process) the generative visual content based on the prompt after the undo operation(s) were performed as described above. In accordance with a determination that the prompt still does not satisfy the one or more criteria after performing multiple undo operations, the electronic device forgoes generating the generative visual content as described above. Removing a last-added prompt component from the user selected prompt provides an intuitive way to undo a most-recently performed user selected prompt revision, which reduces the cognitive burden on the user when undoing a most-recently performed user selected prompt revision and enabling the user to perform the undo operation faster and more efficiently, thereby conserving processing power and providing more efficient interactions between the user and the electronic device.

In some embodiments performing the undo operation directed to the user selected prompt includes returning the user selected prompt to a previous state of the user selected prompt that satisfied the one or more respective criteria (e.g., the most recent state of the user selected prompt that satisfied the one or more respective criteria), such as shown in FIGS. 18R and 18S with a state that includes components 1852a through 1852c. In some embodiments, reverting the user selected prompt to the previous state of the user selected prompt that satisfied the one or more respective criteria includes removing one or more prompt components (e.g., recognized concepts). In some embodiments, removing the one or more prompt components includes removing a last-added prompt component from the user selected prompt as described above, removing a prompt component other than the last-added prompt component from the user selected prompt, or removing a combination of prompt components. In some embodiments, removing the one or more prompt components includes removing respective representations of the removed one or more prompt components.

In some embodiments, removing the one or more prompt components includes adding back one or more prompt components. For example, the electronic device initially included the following terms in order to the user selected prompt: first term (e.g., “basketball”), second term (e.g., “shooting”), and third term (e.g., “darts”). In some embodiments, the electronic device removes the first term from the user selected prompt in response to detecting user input to remove the first term. In some embodiments, after removing the first term, performing the undo operation includes adding back the first term to the user selected prompt.

In some embodiments, reverting the user selected prompt to the previous state of the user selected prompt that satisfied the one or more respective criteria includes ceasing displaying the (e.g., undo) user interface element. In some embodiments, after reverting the user selected prompt to the previous state of the user selected prompt that satisfied the one or more respective criteria, the electronic device initiates the process to generate the second representation of the generative visual content based on the user selected prompt as described above. Reverting the user selected prompt to a previous state of the user selected prompt that satisfied the one or more respective criteria reduces the cognitive burden on the user when undoing recently performed user selected prompt revision and without requiring the user to provide further inputs, such as removing prompt components or starting over with a new prompt, thereby reducing the number of inputs and providing more efficient interactions between the user and the electronic device.

In some embodiments, while displaying the user interface element, the electronic device detects, via the one or more input devices, an input corresponding to a request to edit the user selected prompt, such as input 1826k directed to a submit option to add term 1854 to the user selected prompt as shown in FIG. 18M. In some embodiments, the input corresponding to the request to edit the user selected prompt includes a sequence of one or more inputs, such as one or more selection inputs (e.g., described above with reference to detecting a user input corresponding to a request to generate generative visual content) directed to the user selected prompt, such as a prompt component in the user selected prompt. In some embodiments, the request to edit the user selected prompt includes a request to add one or more prompt components to the user selected prompt, remove one or more prompt components from the user selected prompt, or revise the one or more prompt components. For example, the request to add one or more prompt components to the user selected prompt includes detecting selection of a representation of a concept (e.g., a computer-generated suggested concept or a predefined concept) using a swipe input, a dragging input, a tap input, and/or gaze input as described in method(s) 700 and/or 800, and/or as shown in FIGS. 6B-6E. In some embodiments, the request to remove one or more prompt components from the user selected prompt includes a tap gesture at a location on a touch-sensitive surface corresponding to a remove option that, when selected, causes the electronic device to remove a respective prompt component from the user selected prompt. In some embodiments, the request to remove one or more prompt components from the user selected prompt includes an air gesture while the gaze of the user of the electronic device is directed to the remove option, a forward pointing in-air gesture directed to the remove option, actuation of an indirect input device while a cursor is directed to the remove option (or, optionally, while the user interface element has input focus), and/or voice input from the user corresponding to the request to remove the respective prompt from component the user interface element. In some embodiments, the request to revise the one or more prompt components includes detecting one or more text entry (or handwritten) inputs using a soft (or virtual) keyboard user interface element, a physical (or hardware) keyboard, touchpad, stylus, and/or dictation as described in method(s) 700 and/or 800, and/or as shown in FIGS. 6G and 6V.

In some embodiments, in response to detecting the input directed to the user selected prompt, the electronic device edits the user selected prompt in accordance with the input, and the electronic device initiates a second event for generating (e.g., using an AI process or a generative AI process) generative visual content based on the user selected prompt that will influence generation of the generative visual content, such as shown with the addition of prompt 1852d in FIG. 18N. In some embodiments, editing the user selected prompt in accordance with the input includes adding one or more prompt components to the user selected prompt, removing one or more prompt components from the user selected prompt, or revising the one or more prompt components. In some embodiments, after (or while) editing the user selected prompt in accordance with the input, the electronic device initiates the second event for generating generative visual content based on the edited user selected prompt that will influence generation of the generative visual content. In some embodiments, initiating the second event includes displaying, via the one or more display generation components, a representation of the edited user selected prompt including representations of the one or more prompt components in the user selected prompt as described in method(s) 700 and/or 800, and/or as shown in FIGS. 6I-6J, and 6V-6W.

In some embodiments, after initiating the second event, in accordance with a determination that editing the user selected prompt in accordance with the input causes the user selected prompt to satisfy the one or more respective criteria, the electronic device ceases displaying, via the one or more display generation components, the user interface element for performing the undo operation, such as undo option as shown in FIG. 18Q. Thus, in some embodiments, after the electronic device edits the user selected prompt in a manner described above (e.g., adding, deleting, and/or revising one or more prompt components) that satisfies the one or more respective criteria, the electronic device initiates the process to generate a representation of a generative visual content based on the edited user selected prompt and ceases displaying, via the one or more display generation components, the (e.g., undo) user interface element. In some embodiments, initiating the process to generate the representation of the generative visual content based on the edited user selected prompt is analogous to and/or includes one or more characteristics of initiating the process to generate the representation of the generative visual content based on the event described above.

In some embodiments, in accordance with a determination that editing the user selected prompt in accordance with the input causes the user selected prompt to not satisfy the one or more respective criteria, the electronic device maintains display of the user interface element for performing the undo operation, such as undo option 1832 as shown in FIG. 18R. Thus, in some embodiments, after the electronic device edits the user selected prompt in a manner described above (e.g., adding, deleting, and/or revising one or more prompt components) that does not satisfy the one or more respective criteria, the electronic device forgoes initiating the process to generate a representation of a generative visual content based on the edited user selected prompt and maintains displaying, via the one or more display generation components, the (e.g., undo) user interface element. Ceasing display of or maintaining display of the (e.g., undo) user interface element based on editing the user selected prompt and whether the edited user selected prompt causes one or more respective criteria to be satisfied simplifies the interaction between the user and the electronic device without requiring the user to provide further inputs to request the generation of generative visual content, thereby reducing the number of inputs and providing more efficient interactions between the user and the electronic device.

In some embodiments, while the user interface element for performing the undo operation is not displayed via the one or more display generation components, the electronic device detects, via the one or more input devices, an input corresponding to a request to perform the undo operation directed to the user selected prompt, such as shown in FIG. 18F with the shaking of electronic device 500b-2. In some embodiments, in response to detecting the input, the electronic device performs the undo operation directed to the user selected prompt, such as shown in FIGS. 18F and 18G and indicated with the removal of undo option 1832b-2.

In some embodiments, the electronic device performs the undo operation (e.g., described above with respect to performing the undo operation directed to the user selected prompt) in response to detecting user input other than the user input directed to the (e.g., undo) user interface element as described above with respect detecting a selection input directed to the user interface element. For example, when the electronic device detects, via the one or more input devices including one or more motion sensors, a shaking of the electronic device and/or a rotation of the electronic device, the electronic device determines that the input corresponds to a request to perform the undo operation directed to the user selected prompt. In another example, when the electronic device detects three or more fingers drag gesture (e.g., described in more detail with respect to the dragging input in method(s) 700 and/or 1700), the electronic device determines that the input corresponds to a request to perform the undo operation directed to the user selected prompt. In some embodiments, performing the undo operation directed to the user selected prompt is analogous to and/or includes one or more characteristics of performing the undo operation directed to the user selected prompt described above. Performing an undo operation in response to detecting an input corresponding to a request to perform the undo operation directed to the user selected prompt provides an intuitive way to undo a recently performed user selected prompt revision, which reduces the cognitive burden on the user when undoing a recently performed user selected prompt revision and enabling the user to perform the undo operation faster and more efficiently, thereby conserving processing power and providing more efficient interactions between the user and the electronic device.

In some embodiments, while forgoing initiating the process to generate the representation of the generative visual content based on the event, the electronic device detects, via the one or more input devices, an input corresponding to a request to remove a prompt component from the user selected prompt, such as input 1826m directed to 1852d as shown in FIG. 18Q. In some embodiments, the electronic device displays, via the one or more display generation components, a selectable option that, when selected, causes the electronic device to remove the prompt component (e.g., recognized concept) associated with the selectable option as described in method 700 and/or as shown in FIG. 6N-6O. In some embodiments, the input corresponding to the request to remove a prompt component from the user selected prompt to satisfy the one or more respective criteria includes a selection input (e.g., as described above with reference to detecting a user input corresponding to a request to generate generative visual content) directed to the selectable option associated with the prompt component. For example, the input corresponding to a request to remove a prompt component from the user selected prompt includes a tap gesture at a location on a touch-sensitive surface corresponding to the selectable option, an air gesture while the gaze of the user of the electronic device is directed to the selectable option, a forward pointing in-air gesture directed to the selectable option, actuation of an indirect input device while a cursor is directed to the selectable option (or, optionally, while the user interface element has input focus), and/or voice input from the user corresponding to the request to remove the prompt component from the user interface element. In some embodiments, the electronic device detects, via the one or more input devices, a second input corresponding to a request to edit the prompt component of the user selected prompt as described in more detail with reference to method(s) 700 and/or 800. In some embodiments, in response to detecting the second input, the electronic device performs one or more of the operations described herein with respect to removing a respective prompt from the user selected prompt and/or determining whether the user selected prompt satisfies the one or more respective criteria described in more detail herein.

In some embodiments, in response to detecting the input, the electronic device removes the prompt component from the user selected prompt, such as shown in FIGS. 18Q and 18R with the removal of component 1852d. In some embodiments, after removing the prompt component from the user selected prompt, the electronic device determines whether the updated user selected prompt (e.g., the user selected prompt with the prompt component removed) satisfies the one or more respective criteria for initiating the process to generate the representation of the generative visual content. In some embodiments, the electronic device makes the determination without detecting user input requesting to initiate the process to generate the representation of the generative visual content. In some embodiments, removing the prompt component from the user selected prompt includes ceasing to display a representation of the prompt component including the selectable option as described in method 700 and/or as shown in FIG. 6N-6O. In some embodiments, removing the prompt component from the user selected prompt includes displaying, via the one or more display generation components, a status indication that indicates the status of initiating the process to generate a representation of the generative visual content based on the user selected prompt as will be described in more detail below with respect to displaying a status indication. In some embodiments, displaying the status indication indicates whether the user selected prompt with the prompt component removed satisfies the one or more respective criteria for initiating the process to generate the representation of the generative visual content. In some embodiments, in response to detecting the input, in accordance with a determination that the user selected prompt with the prompt component removed satisfies the one or more respective criteria, the electronic device initiates the process to generate the representation of the generative visual content, such as representation 1820 in FIG. 18S.

In some embodiments, the one or more respective criteria are analogous to and/or includes one or more of the characteristics of the one or more respective criteria including a criterion that is satisfied when the user selected prompt with the prompt component removed does not include high-risk recognized concepts described in method 700 and/or as shown in FIG. 6GG. For example, the electronic device included the following terms to the user selected prompt: first term (e.g., “Jenna”), second term (e.g., “shooting”), and third term (e.g., “basketball”). In some embodiments, after removing the second term from the user selected prompt, the electronic device determines the user selected prompt includes the first term and the third term, and that the user selected prompt satisfies the one or more respective criteria. In another example with the terms of the user selected prompt described herein, after editing the second term resulting in the edited second term (e.g., “shooting hoops”), the electronic device determines the user selected prompt includes the first term, the edited second term, and the third term, and that the user selected prompt satisfies the one or more respective criteria. In some embodiments, initiating the process to generate the representation of the generative visual content includes generating (e.g., using an AI process or a generative AI process) a representation of the generative visual content based on the user selected prompt with the prompt component removed. In some embodiments, initiating the process to generate the representation of the generative visual content is analogous to and/or includes one or more characteristics of initiating the process to generate the representation of the generative visual content based on the event described above.

In some embodiments, in accordance with a determination that the user selected prompt with the prompt component removed does not satisfy the one or more respective criteria, the electronic device forgoes initiating the process to generate the representation of the generative visual content. In some embodiments, forgoing initiating the process to generate the representation of the generative visual content is analogous to and/or includes one or more characteristics of forgoing initiating the process to generate the representation of the generative visual content based on the event described above. Removing a prompt component from a user selected prompt and determining that the user selected prompt with the prompt component removed satisfies the one or more respective criteria for initiating the process to generative the representation of the generative visual content simplifies the interaction between the user and the electronic device without requiring the user to provide further inputs to generate generative visual content, thereby reducing the number of inputs and providing more efficient interactions between the user and the electronic device.

In some embodiments, while the process to generate the representation of the generative visual content based on the event is not occurring, the electronic device detects, via the one or more input devices, an input corresponding to a request to add a prompt component to the user selected prompt, such as, for example, input 1826g directed to component 1844e in FIG. 18G. In some embodiments, an input corresponding to a request to add a prompt component (e.g., recognized concept) to the user selected prompt includes detecting one or more text entry (or handwritten) inputs using a soft (or virtual) keyboard user interface element, a physical (or hardware) keyboard, touchpad, stylus, and/or dictation as described in method(s) 700 and/or 800, and/or as shown in FIGS. 6G and 6V. In some embodiments, an input corresponding to a request to add a prompt component to the user selected prompt includes detecting one or more content entry (e.g., image and/or video) inputs as described in method(s) 700, 800, and/or 1200, and/or as shown in FIGS. 11B-11E. In some embodiments, an input corresponding to a request to add a prompt component to the user selected prompt includes detecting a selection input (optionally as described above with reference to detecting a user input corresponding to a request to generate generative visual content), a swipe input, or a dragging input (e.g., as described in method(s) 700 and/or 800, and/or as shown in FIGS. 6B-6E) directed to a representation of a prompt component (e.g., a computer-generated suggested concept, recognized concept, or a predefined concept as described in method(s) 700, 800, and/or 2100, and/or as shown in FIGS. 20N-20O).

In some embodiments, in response to detecting the input, the electronic device adds the prompt component to the user selected prompt, such as indicated with the display of component 1852a in FIG. 18H. In some embodiments, after adding the prompt component to the user selected prompt, the electronic device determines whether the updated user selected prompt (e.g., the user selected prompt with the prompt component added) satisfies the one or more respective criteria for initiating the process to generate the representation of the generative visual content. In some embodiments, the electronic device makes the determination without detecting user input requesting to initiate the process to generate the representation of the generative visual content. In some embodiments, adding the prompt component to the user selected prompt includes displaying, via the one or more display generation components, a status indication that indicates the status of initiating the process to generate a representation of the generative visual content based on the user selected prompt as will be described in more detail below with respect to displaying a status indication. In some embodiments, displaying the status indication indicates whether the user selected prompt with the prompt component added satisfies the one or more respective criteria for initiating the process to generate the representation of the generative visual content.

In some embodiments, in response to detecting the input, and in accordance with a determination that the user selected prompt with the prompt component added satisfies the one or more respective criteria, the electronic device initiates the process to generate the representation of the generative visual content, such as indicated with the display of the status indication 1810 in FIG. 18N. In some embodiments, the one or more respective criteria are analogous to and/or include one or more of the characteristics of the one or more respective criteria including a criterion that is satisfied when the user selected prompt with the prompt component added does not include high-risk recognized concepts described in method 700 and/or as shown in FIG. 6GG. For example, the electronic device included the following terms to the user selected prompt: first term (e.g., “Jenna”) and second term (e.g., “gun”). In some embodiments, after adding a third term (e.g., water) from the user selected prompt, the electronic device determines the user selected prompt includes the first term, the second term, and the third term, and that the user selected prompt satisfies the one or more respective criteria. In another example with the terms of the user selected prompt described herein, after editing the second term resulting in the edited second term (e.g., “paint gun”), the electronic device determines the user selected prompt includes the first term and the edited second term, and that the user selected prompt satisfies the one or more respective criteria. In some embodiments, initiating the process to generate the representation of the generative visual content includes generating (e.g., using an AI process or a generative AI process) a representation of the generative visual content based on the user selected prompt with the prompt component added. In some embodiments, initiating the process to generate the representation of the generative visual content is analogous to and/or includes one or more characteristics of initiating the process to generate the representation of the generative visual content based on the event described above. In some embodiments, in accordance with a determination that the user selected prompt with the prompt component added does not satisfy the one or more respective criteria, the electronic device forgoes initiating the process to generate the representation of the generative visual content. In some embodiments, forgoing initiating the process to generate the representation of the generative visual content is analogous to and/or includes one or more characteristics of forgoing initiating the process to generate the representation of the generative visual content based on the event described above. Adding a prompt component from a user selected prompt and determining that the user selected prompt with the prompt component added satisfies the one or more respective criteria for initiating the process to generative the representation of the generative visual content simplifies the interaction between the user and the electronic device without requiring the user to provide further inputs to generate generative visual content, thereby reducing the number of inputs and providing more efficient interactions between the user and the electronic device.

In some embodiments, in response to detecting the event, and in accordance with a determination that a prompt component of the user selected prompt requires that the user selected prompt includes a subject in order for the one or more respective criteria to be satisfied, and that the user selected prompt does not include a subject, the electronic device displays, via the one or more display generation components, a user interface element for selecting the subject, such as indicated by control element 1848 as shown in FIG. 18H. In some embodiments, detecting the event corresponds to detecting a user input for creating and/or specifying the prompt, as described above with reference to method(s) 700, 800, 1700, 2100, and/or 2300 and/or as shown in Fig. FIGS. 22N-20V. For example, the electronic device optionally determines that the user input corresponds to a request to add a prompt component to the user selected prompt. In some embodiments, the request to add the prompt component to the user selected prompt is analogous to and/or includes one or more characteristics of detecting a selection input (e.g., described above with reference to detecting a user input corresponding to a request to generate generative visual content) directed to the one or more selectable representations of recognized concepts described in method(s) 700, 800, and/or 2300 as shown in FIGS. 6B-6E and/or FIGS. 20N-20P. In another example, the request to add the prompt component to the user selected prompt optionally includes providing the prompt component via a content entry field as described in method(s) 700, 800, 1200, and/or 2300 and/or as shown in FIGS. 11B-11E and/or 6V.

In some embodiments, after (and/or while) detecting the event including adding the prompt component to the user selected prompt, the electronic device determines whether the prompt component of the user selected prompt (e.g., the user selected prompt with the prompt component added) requires a subject in order for the one or more respective criteria to be satisfied (e.g., for initiating the process to generate the representation of the generative visual content). For example, a subject optionally refers to a human or non-human character (e.g., anthropomorphic entity, such as personified animal, robot, or other non-human, inanimate object) as described in more detail with reference to method 2300 and/or as shown in FIGS. 22N-20V. In some embodiments, and as described in method 2300, the subject includes computer-generated (and/or user-created) avatars, photorealistic representations, and/or other graphical representations of the subject.

In some embodiments, the requirement that the user selected prompt includes a subject is based on the type of prompt component and/or the meaning associated with the prompt component (and/or the user selected prompt that includes the prompt component). In some embodiments, the type of prompt component is established by an administrator of the content application or an entity controlling the generation of generative visual content. In some embodiments, the electronic device determines that the prompt component corresponds to a first type of prompt component. For example, the first type of prompt component optionally corresponds to a property (or trait or characteristic) of the subject, such as an occupation of the subject, a style of the subject (e.g., hair, clothing, and/or the like), a body type/build of the subject, and/or other normally human property. In some embodiments, in accordance with a determination that the prompt component is the first type of prompt component (e.g., requires that the user selected prompt includes a subject in order for the one or more respective criteria to be satisfied), the electronic device displays, via the one or more display generation components, a user interface element for selecting the subject.

For example, the user interface element optionally refers to a control element, such as a button, affordance, virtual object, or other graphical user interface element. In some embodiments, a control element is configured by the electronic device to visually convey a specific action or intention in response to detecting an event (e.g., detecting user input to add the prompt component to the user selected prompt described herein). Thus, in some embodiments, the electronic device displays the user interface element in a manner that indicates the requirement that the user selected prompt includes a subject in order for the one or more respective criteria to be satisfied. In some embodiments, the manner in which the electronic device displays the user interface element indicative of the requirement includes displaying the user interface element with an amount of visual emphasis described in more detail below. In some embodiments, while detecting the event (e.g., adding the prompt component to the user selected prompt), the respective user interface includes the user interface element having a first visual appearance. Thus, in some embodiments, the electronic device displays the user interface element having a first visual appearance before detecting the event (e.g., at the start of the generative visual content session/upon the electronic device displaying a respective user interface of a content application content application, such as shown in FIG. 6B and/or FIGS. 22I-22N). In some embodiments, in accordance with the determination that the prompt component of the user selected prompt requires that the user selected prompt includes the subject in order for the one or more respective criteria to be satisfied, the electronic device displays the user interface element having a second visual appearance, different from the first visual appearance as will be described in more detail below with respect to displaying the user interface element with an amount of visual emphasis. For example, displaying the user interface element with the first visual appearance optionally includes generic text or placeholder content prompting the user of the electronic device to select the subject. In some embodiments, displaying the user interface element with the second visual appearance optionally includes displaying text identifying the selected subject (e.g., name or other identifier of the subject) and/or a visual representation of the selected subject as will be described in more detail below.

In some embodiments, in response to detecting the event, and in accordance with a determination that the user selected prompt does not include a prompt component that requires that the user selected prompt include a subject for the one or more respective criteria to be satisfied, or that the user selected prompt includes a subject, the electronic device forgoes displaying, via the one or more display generation components, the user interface element for selecting the subject, such as, for example, displaying the control element 1848 as shown in FIG. 18G or in some embodiments, the removal of control element 1848 in FIG. 18G. In some embodiments, the electronic device determines that the prompt component corresponds to a second type of prompt component, different from the first type. For example, the second type of prompt component optionally does not correspond to a property of the subject as described above. In some embodiments, in accordance with a determination that the prompt component is the second type of prompt component (e.g., does not include requirement that the user selected prompt includes a subject in order for the one or more respective criteria to be satisfied), the electronic device forgoes displaying, via the one or more display generation components, the user interface element for selecting the subject In some embodiments, although the electronic device determines that the user selected prompt does not require a subject in order for the one or more respective criteria to be satisfied, the electronic device displays the user interface element (or, optionally, with the first visual appearance as described above).

In some embodiments, after the electronic device adds, removes, or edits a respective prompt component of the user selected prompt component, in accordance with a determination that the addition, the removal, or the revision to the respective prompt component does not require a subject in order for the one or more respective criteria to be satisfied, the electronic device forgoes displaying the user interface element for selecting the subject. In some embodiments, in accordance with a determination that the addition, the removal, or the revision to the respective prompt component includes selection of a subject, the electronic device forgoes displaying the user interface element for selecting the subject. Displaying or forgoing displaying a user interface element for selecting a subject based on a determination that a prompt component of the user selected prompt includes a requirement that the user selected prompt include the subject in order for the one or more respective criteria to be satisfied provides an intuitive way to select a subject when required, which enables the user to initiate the process to generate a representation of generative visual content based on the user selected prompt faster and more efficiently, thereby providing more efficient interactions between the user and the electronic device. Additionally, by displaying a user interface element for selecting a subject, the electronic device ensures that the generative visual content that is output is agnostic to the appearance of the subject and helps ensure that the generative visual content does make unexpected assumptions about the appearance of the subject by allowing the user of the electronic device to specify the subject via the user interface element.

In some embodiments, displaying the user interface element for selecting the subject includes automatically selecting a particular character (e.g., a character that was previously created by the user) or person (e.g., who is represented in a personal media library of the user) as the subject (e.g., without detecting user input selecting the subject), such as control element 1848 as shown in FIG. 18H. In some embodiments, automatically selecting the subject is analogous to and/or includes one or more characteristics of adding a prompt component (e.g., recognized concept) corresponding to a representation of a person described in method(s) 700, 800, and/or 2300, and/or as shown in FIGS. 6B, 6V, and/or FIGS. 22N-20V. In some embodiments, automatically selecting the subject includes adding the selected subject as a prompt component to the user selected prompt that will influence the generation of the generative visual content without detecting user input requesting to include the selected subject as a prompt component (e.g., recognized concept) to the user selected prompt. In some embodiments, automatically selecting the subject includes displaying, via the one or more display generation components, a representation of a prompt component corresponding to the selected subject as described in method(s) 700, 800, and/or 2300, and/or as shown in FIGS. 6B and/or 6C. In some embodiments, automatically selecting the subject includes displaying the user interface element with a respective visual appearance as described above, such as including text identifying the selected subject and/or a visual representation of the selected subject (e.g., avatar, image, and/or other graphic representing the subject). In some embodiments, automatically selecting the subject occurs automatically as soon as the electronic device determines that a prompt component of the user selected prompt includes a respective criterion of the one or more criteria that is satisfied when the user selected prompt includes a subject to satisfy the one or more respective criteria as described above. The electronic device optionally selects the subject automatically using the considerations described below. Automatically selecting a subject based on a requirement that the user selected prompt include the subject in order for the one or more respective criteria to be satisfied simplifies the interaction between the user and the electronic device without requiring the user to provide further inputs to generate generative visual content, thereby reducing the number of inputs and providing more efficient interactions between the user and the electronic device.

In some embodiments, automatically selecting the subject includes, in accordance with a determination that context information of the electronic device corresponds to a first person, selecting a representation of the first person as the subject, such as, for example, based on a detected recent communication with person “Jenna” identified in control element 1848 as shown in FIG. 18H. In some embodiments, the context information is analogous to and/or includes one or more characteristics of the context information described in method 2100. For example, the electronic device optionally determines that the context information includes one or more prior interactions between the user of the electronic device and the first person (e.g., first user account) of a second electronic device, different from the electronic device, that is associated or linked with the user (e.g., user account) of the electronic device, different from the first person. In some embodiments, the one or more prior interactions were through a communication session (e.g., phone call, video call, email, instant messaging, video conference, and/or collaboration session). Thus, in some embodiments, if the electronic device determines that the user recently interacted with the first person through a communication session, the electronic device automatically selects the representation of the first person as the subject. In another example, if the electronic device determines the first person was mentioned or identified in the communication session, the electronic device automatically selects the representation of the first person as the subject.

In another example, the electronic device optionally determines that the context information includes information from an application other than the content application, such as a photos application, a social media application, a messaging application, an email application, an address book application, a calendar application, a media content application, a gaming application, or other application configured for sharing and/or collaborating between the user of the electronic device and the first person of the second electronic device. For example, if the electronic device determines that the user was recently viewing (e.g., the electronic device was recently displaying) information associated with the first person, such as displaying a photo (or video or other media content) of the first person (or a photo captured by the first person); viewing a social media profile, post, and/or the like of the first person; viewing a document or content shared by the first person (e.g., transmitted by the second electronic device), and/or the like, the electronic device automatically selects the representation of the first person as the subject. In some embodiments, the electronic device determines that the first person is stored as a favorite person in a contacts list in an address book application, a gaming application, a social media application, or any one of the applications described herein, and thus, in some embodiments, the electronic device automatically selects the representation of the first person as the subject.

In some embodiments, the electronic device optionally determines that the context information indicates that the first user of the second electronic device is (or, optionally, was) within a threshold distance (e.g., 1, 5, 10, 15, 20, 30, 40, 50 or 100 meters) of the electronic device, and thus, in some embodiments, the electronic device automatically selects the representation of the first person as the subject. In some embodiments, selecting the representation of the first person includes selecting a representation from a plurality of representations of the first person (e.g., avatar, digital image, younger version, older version, or other version described in more detail with reference to method 2300 and/or as shown in FIG. 22M). In some embodiments, selecting the representation of the first person includes displaying the user interface element with a respective visual appearance as described above, such as including text identifying first person and/or a visual representation of the first person (e.g., avatar, image, and/or other graphic representing the subject). In some embodiments, automatically selecting the representation of the first person as the subject includes displaying, via the one or more display generation components, a representation of a prompt component corresponding to the first person as described in method(s) 700, 800, and/or 2300, and/or as shown in FIGS. 6B and/or 6C.

In some embodiments, automatically selecting the subject includes, in accordance with a determination that context information of the electronic device corresponds to a second person, selecting a representation of the second person as the subject, such as person “Paul” identified by the electronic device as a person captured in a recent photo as shown in FIG. 18Z. In some embodiments, the context information is analogous to and/or includes one or more characteristics of the context information described in method 2100. In some embodiments, the second person is different from the first person. It is understood that although the embodiments described herein are directed to the first person, such processes and/or characteristics, optionally apply to other persons, such as the second person. Automatically selecting a subject based on context information of the electronic device simplifies the interaction between the user and the electronic device without requiring the user to provide further inputs to generate generative visual content, thereby reducing the number of inputs and providing more efficient interactions between the user and the electronic device.

In some embodiments, automatically selecting the subject includes, in accordance with a determination that a first individual was selected as the subject within a time threshold (e.g., 0.5, 0.1, 0.5, 2, 4, 6, 8, 10, 12, 14, 16, 24, 48, or 72 hours) of a current time, selecting the first individual as the subject, such as indicated with the selection of person “Jenna” as shown by control element 1848 in FIG. 18H and who was recently selected as the subject. For example, a first individual optionally refers to a human, non-human character, animal, mythical creature, anthropomorphic object, or other digital image described in more detail above and/or with reference to method 2300. In some embodiments, if the first individual was recently selected (e.g., within the time threshold), the electronic device selects the first individual as the subject. For example, the electronic device automatically selects the first individual as the subject, wherein the first individual is an individual who was recently selected as the subject as described herein. In some embodiments, when the electronic device ends the content application session and starts a new session, the electronic device automatically selects the first individual as the subject. In some embodiments, when the electronic device ends the content application session, the selection history is cleared. Thus, in some embodiments, after ending a first session and when the content application is activated another time (e.g., starts a second session), the selection history is cleared and the electronic device optionally does not select the first individual as the subject despite the determination that the first individual was selected as the subject within the time threshold. In some embodiments, selecting the first individual as the subject is analogous to and/or includes one or more characteristics of selecting a representation of the first person as the subject described above.

In some embodiments, in accordance with a determination that no individual was selected as the subject within the time threshold, the electronic device selects a respective subject based on context information as described above or based on other information described in more detail with reference to method(s) 700, 800, 2100, and/or 2300. In some embodiments, one or more applications or one or more application functions are locked to prevent unauthorized access to contextual information that is used to select the first individual as the subject. Thus, in some embodiments, the electronic device displays, via the one or more display generation components, a request for additional authentication credentials (e.g., password, passcode, and/or biometrics information) to be provided to the application in order to retrieve the contextual information.

In some embodiments, automatically selecting the subject includes, in accordance with a determination that a second individual was selected as the subject within the time threshold of the current time, selecting the second individual as the subject, such as person “Paul” as shown in FIG. 18Z. In some embodiments, the second individual is different from the first individual. It is understood that although the embodiments described herein are directed to the first individual, such processes and/or characteristics, optionally apply to other individuals, such as the second individual. Automatically selecting a subject based on a determination that a respective individual was selected as the subject within the time threshold simplifies the interaction between the user and the electronic device without requiring the user to provide further inputs to generate generative visual content, thereby reducing the number of inputs and providing more efficient interactions between the user and the electronic device.

In some embodiments, displaying the user interface element for selecting the subject includes, in accordance with a determination that the user selected prompt does not include a prompt component that requires that the user selected prompt include a subject for the one or more respective criteria to be satisfied, or that the user selected prompt includes a subject, displaying the user interface element for selecting the subject includes displaying, via the one or more display generation components, the user interface element for selecting the subject with a first amount of visual emphasis (e.g., a first size, first shape, first color, first brightness, first visual effect, first animation, or other first visual property), such as control element 1848 as shown in FIG. 18G. In some embodiments, the requirement that the user selected prompt include the subject for the one or more respective criteria to be satisfied is analogous to and/or includes one or more characteristics of the requirement that the user selected prompt include the subject described above. In some embodiments, the user interface element is analogous to and/or includes one or more characteristics of the user interface element for selecting the subject described above.

In some embodiments, displaying the user interface element for selecting the subject includes, in accordance with a determination that a prompt component of the user selected prompt requires that the user selected prompt includes a subject in order for the one or more respective criteria to be satisfied, and that the user selected prompt does not include a subject, displaying the user interface element for selecting the subject with a second amount of visual emphasis, different from the first amount of visual emphasis, such as control element 1848 as shown in FIG. 18H.

In some embodiments, the second amount of visual emphasis is greater than the first amount of visual emphasis. For example, the second amount of visual emphasis includes a second size larger than the first size, a second shape larger than the first shape, a second color more distinct than the first color, a second brightness more luminous than the first brightness; a second visual effect more intense than the first visual effect, a second animation more appealing than the first animation, and/or a first visual property more distinct than the first visual property. In some embodiments, the electronic device displays the user interface element for selecting the subject with a second amount of visual emphasis to distinguish the user interface element from other user interface element displayed via the one or more display generation components. In some embodiments, displaying the user interface element with the second amount of visual emphasis draws a focus of the user to the user interface element for facilitating interaction with the user interface element and/or for viewing the automatically selected subject. In some embodiments, the electronic device displays the user interface element for selecting the subject with a second amount of visual emphasis for a predetermined amount of time (e.g., 0.1, 0.2, 0.3, 0.5, 1, 3, 5, 10, 15, 20, or 30 seconds) before returning to being displayed with the first amount of visual emphasis. Displaying the user interface element for selecting the subject with a second amount of visual emphasis in accordance with a determination that the user selected prompt includes the requirement that the user selected prompt include the subject in order for the one or more respective criteria to be satisfied clearly indicates that the electronic device automatically selected a subject without requiring the user to provide further inputs to select a subject, thereby reducing the number of inputs and providing more efficient interactions between the user and the electronic device.

In some embodiments, while displaying the user interface element for selecting the subject, the electronic device detects, via the one or more input devices, an input directed to the user interface element, such as input 1826a directed to control element 1848 as shown in FIG. 18Y. In some embodiments, detecting the input directed to the user interface element includes detecting a selection input (e.g., described above with reference to detecting a user input corresponding to a request to generate generative visual content) directed to the user interface element. For example, the user input optionally includes a tap gesture at a location on a touch-sensitive surface corresponding to the user interface element, an air gesture while the gaze of the user of the electronic device is directed to the user interface element, a forward pointing in-air gesture directed to the user interface element, actuation of an indirect input device while a cursor is directed to the user interface element (or, optionally, while the user interface element has input focus), and/or voice input from the user corresponding to the request to select the user interface element. In some embodiments, displaying the user interface element is analogous to and/or includes one or more characteristics of displaying the user interface element for selecting the subject described above. For example, displaying the user interface element includes displaying the user interface element with a respective visual appearance as described in more detail above and/or displaying the user interface element with an indication that the subject was automatically selected by the electronic device as described in more detail above. In some embodiments, as and as will be described herein, the electronic device changes the selected subject in response to detecting user input. In some embodiments, the electronic device displays the user interface element without the indication that the subject was automatically selected.

In some embodiments, in response to detecting the input directed to the user interface element, the electronic device displays, via the one or more display generation components, a second user interface element for changing the subject, such as element as shown in FIG. 1868a in FIG. 18Z. In some embodiments, in response to detecting the input directed to the user interface element, the electronic device ceases to the display the user interface element. In some embodiments, in response to detecting the input directed to the user interface element, the electronic device concurrently displays the second user interface element and a generative visual content variants user interface described in more detail with reference to method 1700 and/or as shown in FIGS. 16F and 16G. In some embodiments, the electronic device displays the generative visual content variants user interface including the second user interface element. In some embodiments, displaying the second user interface element for changing the subject is analogous to and/or includes one or more characteristics of displaying a respective user interface element for changing a subject as described in method 2300 and/or as shown in FIGS. 22N-20V. For example, the second user interface element optionally include a plurality of representations of individuals (e.g., humans, non-human characters, animals, mythical creatures, anthropomorphic objects, and/or the like as described in method 2300). In some embodiments, the second user interface element includes a representation of the selected subject with an option that, when selected, causes the electronic device to display a third user interface element for editing the subject as described in more detail in method 2300 and/or as shown in FIGS. 22N-20V.

In some embodiments, the electronic device detects a selection input (e.g., described above with reference to detecting a user input corresponding to a request to generate generative visual content) directed to a first (or second) representation of a first (or second) individual of the plurality of representations. In some embodiments, in response to detecting the selection input directed to the first (or second) representation, the electronic device selects the first (or second) individual as the subject and automatically initiates a process to generate a representation of the generative visual content based on selecting the first (or second) individual as the subject. Displaying a user interface element for changing the subject in response to detecting the input directed to the user interface element simplifies the interaction between the user and the electronic device without requiring the user to provide further inputs to generate generative visual content, thereby reducing the number of inputs and providing more efficient interactions between the user and the electronic device.

In some embodiments, displaying the user interface element for selecting the subject includes a prompt for a user of the electronic device to select the subject, such as indicated with the display of elements 1870a through 1870i as shown in FIG. 18Z. In some embodiments, the prompt visually and/or audibly requests the user of the electronic device to select a subject. In some embodiments, the prompt is or includes an option that, when selected, causes the electronic device to display the second user interface element for changing the subject described above. In some embodiments, the electronic device outputs the visual and/or audible prompt for a predetermined amount of time (e.g., 0.1, 0.2, 0.3, 0.5, 1, 3, 5, 10, 15, 20, or 30 seconds) before ceasing outputting the prompt. In some embodiments, displaying the prompt includes generic text or placeholder content prompting the user of the electronic device to select the subject. In some embodiments, if the electronic device automatically selected the subject, displaying the prompt includes displaying text identifying the selected subject (e.g., name or other identifier of the subject) and/or a visual representation of the selected subject with a respective visual emphasis as described above.

In some embodiments, the electronic device includes the prompt when displaying the user interface element and/or presents the prompt as described herein when the electronic device determines that the user selected prompt requires a subject in order for the one or more respective criteria to be satisfied, and that the user selected prompt does not include the subject as described above. Providing a prompt for a user of the electronic device to select the subject clearly indicates selection of a subject, which simplifies the interaction between the user and the electronic device without requiring the user to provide further inputs to generate generative visual content, thereby reducing the number of inputs and providing more efficient interactions between the user and the electronic device. In some embodiments, while displaying the user interface element for selecting the subject and while the prompt component is included in the user selected prompt (e.g., a prompt component of the user selected prompt that requires that the user selected prompt includes a subject in order for the one or more respective criteria to be satisfied), the electronic device detects, via the one or more input devices, an input corresponding to a request to select the subject, such as input 1826t directed to 1870e as shown in FIG. 18Z. In some embodiments, the user interface element for selecting the subject is analogous to and/or includes one or more characteristics of the second user interface element for changing the subject described above. In some embodiments, the input corresponding to the request to select the subject includes a selection input (e.g., described above with reference to detecting a user input corresponding to a request to generate generative visual content) directed to a first representation of a first individual of the plurality of representations described above.

In some embodiments, in response to detecting the input, the electronic device adds the subject as a second prompt component to the user selected prompt, such as element 1852a as shown in FIG. 18S. For example, in response to detecting the input (e.g., selection input directed to the first representation), the electronic device selects the first individual as the subject (e.g., adds the subject as a second prompt component to the user selected prompt) and automatically initiates a process to generate a representation of the generative visual content based on selecting the first individual as the subject (e.g., adding the subject as the second prompt component to the user selected prompt).

In some embodiments, after adding the subject as the second prompt component to the user selected prompt, the electronic device detects, via the one or more input devices, a second input that corresponds to a request to remove the prompt component (e.g., that includes the requirement that the user selected prompt includes a subject in order for the one or more respective criteria to be satisfied as described above) from the user selected prompt, such as input 1826o directed to option 1852bb as shown in FIG. 18S. In some embodiments, the second input corresponds to a request to remove the prompt component and includes a selection input (e.g., as described above with reference to detecting a user input corresponding to a request to generate generative visual content) directed to a selectable option associated with the prompt component that, when selected, causes the electronic device to remove the prompt component from the user selected prompt. In some embodiments, the request to remove the prompt component from the user selected prompt includes a tap gesture at a location on a touch-sensitive surface corresponding to the selectable option, an air gesture while the gaze of the user of the electronic device is directed to the selectable option, a forward pointing in-air gesture directed to the selectable option, actuation of an indirect input device while a cursor is directed to the selectable option (or, optionally, while the user interface element has input focus), and/or voice input from the user corresponding to the request to remove the prompt component from the user interface element.

In some embodiments in response to detecting the second input, the electronic device removes the prompt component (e.g., that includes the requirement that the user selected prompt includes a subject in order for the one or more respective criteria to be satisfied as described above) while maintaining the subject as part of the user selected prompt (e.g., which includes the second prompt component), such as component 1852a as shown in FIG. 18T. In some embodiments, in response to detecting the second input, the electronic device removes the prompt component from the user selected prompt. In some embodiments, the electronic device maintains the subject as part of the user selected prompt despite removing the prompt component that includes the requirement that the user selected prompt includes a subject. Maintaining the subject as part of the user selected prompt in response to detecting user input to remove a prompt component from the user selected prompt that required selection of a subject simplifies the interaction between the user and the electronic device without requiring the user to provide further inputs to generate generative visual content, thereby reducing the number of inputs and providing more efficient interactions between the user and the electronic device.

In some embodiments, in response to detecting the event, and in accordance with a determination that a prompt component of the user selected prompt requires that the user selected prompt includes a subject in order for the one or more respective criteria to be satisfied, and that the user selected prompt does not include a subject, the electronic device displays, via the one or more display generation components, a user interface element for selecting the subject among a plurality of subjects identified in a media library associated with a user of the electronic device, such as element 1868a as shown in FIG. 18BB. In some embodiments, the event corresponds to a request to add a prompt component to the user selected prompt. In some embodiments, the request to add the prompt component to the user selected prompt is analogous to and/or includes one or more characteristics of detecting a selection input (e.g., described above with reference to detecting a user input corresponding to a request to generate generative visual content) directed to the one or more selectable representations of recognized concepts described in method(s) 700, 800, and/or 2300 as shown in FIGS. 6B-6E and/or FIGS. 20M-20O. In another example, the request to add the prompt component to the user selected prompt optionally includes providing the prompt component via a content entry field as described in method(s) 700, 800, 1200, and/or 2300 and/or as shown in FIGS. 11B-11E and/or 6V.

In some embodiments, displaying the user interface element for selecting the subject is analogous to and/or includes one or more characteristics of displaying the second user interface element for changing the subject described above. In some embodiments, displaying the user interface element for selecting the subject includes a plurality of subjects identified in a media library (e.g., photo and/or video library) associated with a user of the electronic device as described in more detail with reference to method 2300 and/or as shown in FIG. 22M.

In some embodiments, in response to detecting the event, and in accordance with a determination that the user selected prompt does not include a prompt component that requires that the user selected prompt include a subject for the one or more respective criteria to be satisfied, or that the user selected prompt includes a subject, the electronic device forgoes displaying, via the one or more display generation components, the user interface element for selecting the subject, such as no longer displaying element 1868a as shown in FIG. 18Y. In some embodiments, although the electronic device determines that the user selected prompt does not require that the user selected prompt include a subject in order for the one or more respective criteria to be satisfied, the electronic device displays the user interface element. Displaying or forgoing displaying a user interface element for selecting a subject among a plurality of subjects identified in a media library associated with a user of the electronic device based on a determination that a prompt component of the user selected requires that the user selected prompt includes a subject in order for the one or more criteria to be satisfied when the user selected prompt includes a subject provides an intuitive way to select a subject when required, which enables the user to initiate the process to generate a representation of generative visual content based on the user selected prompt faster and more efficiently, thereby providing more efficient interactions between the user and the electronic device.

In some embodiments, in response to detecting the event, in accordance with a determination that a prompt component of the user selected prompt requires that the user selected prompt includes a subject in order for the one or more respective criteria to be satisfied, and that the user selected prompt does not include a subject, the electronic device displays, via the one or more display generation components, a user interface element for selecting the subject among a plurality of subjects including one or more computer-generated avatars, such as, for example, an avatar included as an option in element 1868 as shown in FIG. 18BB. In some embodiments, the event corresponds to a request to add a prompt component to the user selected prompt as described above.

In some embodiments, displaying the user interface element for selecting the subject is analogous to and/or includes one or more characteristics of displaying the second user interface element for changing the subject described above. In some embodiments, displaying the user interface element for selecting the subject includes one or more computer-generated avatars as described in more detail with reference to method 2300 and/or as shown in FIG. 22U.

In some embodiments, in response to detecting the event, in accordance with a determination that the user selected prompt does not include a prompt component that requires that the user selected prompt include a subject for the one or more respective criteria to be satisfied, or that the user selected prompt includes a subject, the electronic device forgoes displaying, via the one or more display generation components, the user interface element for selecting the subject, such as no longer displaying element 1868a as shown in FIG. 18Y. In some embodiments, although the electronic device determines that the user selected prompt does not require a subject in order for the one or more respective criteria to be satisfied, the electronic device displays the user interface element. In some embodiments, the electronic device displays the user interface element in response to detecting a respective input (e.g., selection of a selectable option associated with the user interface element) irrespective of whether the prompt includes the requirement that the user selected prompt includes a subject in order for the one or more respective criteria to be satisfied or not. Displaying or forgoing displaying a user interface element for selecting a subject among a plurality of subjects including one or more computer-generated avatars based on a determination that a prompt component of the user selected prompt requires that the user selected prompt includes a subject in order for the one or more criteria to be satisfied when the user selected prompt includes a subject provides an intuitive way to select a subject when required, which enables the user to initiate the process to generate a representation of generative visual content based on the user selected prompt faster and more efficiently, thereby providing more efficient interactions between the user and the electronic device.

In some embodiments, initiating the process to generate the representation of the generative visual content based on the event includes displaying, via the one or more display generation components, a preview of the generative visual content, such as indicated with the display of status indication 1804 in FIG. 18AA. In some embodiments, displaying the preview of the generative visual content is analogous to and/or includes one or more characteristics of displaying the representation of the first generative visual content in a user interface of a content application (e.g., described in method 700 and/or as shown in FIG. 6KK), a user interface that includes information associated with the first prompt (e.g., escribed in method 700 and/or as shown in FIG. 6JJ), an editing user interface (e.g., described in method 800 and/or as shown in FIG. 6W), and/or other user interface (optionally as described in more detail in method(s) 700, 800, 1000, 1200, 1700, and/or 2300). For example, and as described in more detail with reference to method 1700 and/or as shown in FIG. 16B, the electronic device displays the preview of the generative visual content in a user interface element (e.g., optionally in a preview mode-type of user interface element), such as a frame or container where different previews of respective different generative visual content are displayed within the frame.

In some embodiments, while displaying the preview of the generative visual content based on the user selected prompt, the electronic device detects, via the one or more input devices, an input corresponding to a request to edit the user selected prompt, such as input 1826t directed to element 1870e in FIG. 18Z. In some embodiments, detecting the input corresponding to the request to edit the user selected prompt is analogous to and/or includes one or more characteristics of detecting the one or more inputs editing the user selected prompt described in more detail above and in method(s) 700, 800, 1200, 1700, 1900, and/or 2100, and/or as shown in FIGS. 6B-6E, 6V, 16F, 16G, 11B-11E, 16F and/or 16L.

In some embodiments, the request to edit the user selected prompt includes a request to add one or more prompt components to the user selected prompt, remove one or more prompt components from the user selected prompt, or revise the one or more prompt components. For example, the request to add one or more prompt components to the user selected prompt includes detecting selection of a representation of a concept (e.g., a computer-generated suggested concept or a predefined concept) using a swipe input, a dragging input, a tap input, and/or gaze input as described in method(s) 700 and/or 800, and/or as shown in FIGS. 6B-6E. In some embodiments, the request to remove one or more prompt components from the user selected prompt includes a tap gesture at a location on a touch-sensitive surface corresponding to a remove option that, when selected, causes the electronic device to remove a respective prompt component from the user selected prompt. In some embodiments, the request to remove one or more prompt components from the user selected prompt includes an air gesture while the gaze of the user of the electronic device is directed to the remove option, a forward pointing in-air gesture directed to the remove option, actuation of an indirect input device while a cursor is directed to the remove option (or, optionally, while the user interface element has input focus), and/or voice input from the user corresponding to the request to remove the respective prompt from component the user interface element. In some embodiments, the request to revise the one or more prompt components includes detecting one or more text entry (or handwritten) inputs using a soft (or virtual) keyboard user interface element, a physical (or hardware) keyboard, touchpad, stylus, and/or dictation as described in method(s) 700 and/or 800, and/or as shown in FIGS. 6G and 6V.

In some embodiments, in response to detecting the input, the electronic device edits the user selected prompt in accordance with the input, and automatically changing the appearance of the preview of the generative visual content based on the edited user selected prompt, such as representation 1874 as shown in FIG. 18BB. In some embodiments, editing the user selected prompt includes as adding one or more prompt components (e.g., one or more recognized concepts) to the user selected prompt, removing one or more prompt components from the user selected prompt, or revising the one or more prompt components. In some embodiments, automatically changing the appearance of the preview includes ceasing to display the preview of the generative visual content and displaying, via the one or more display generation components, a second preview of a second generative visual content, different from the preview of the generative visual content. In some embodiments, editing the user selected prompt in accordance with the input influences the generation of the generative visual content without detecting user input requesting to generate the generative visual content based on the edited the user selected prompt. In some embodiments, the electronic device does not change the appearance of the preview if the electronic device determines that the one or more respective criteria described in more detail above is not satisfied. Automatically changing the appearance of the preview of the generative visual content in response to detecting an input corresponding to a request to edit the user selected prompt provides an intuitive way to display representations of different generative visual content and provides quick access to different generative visual content generated without requiring the user to provide further inputs, thereby reducing the number of inputs and providing more efficient interactions between the user and the electronic device.

In some embodiments, in response to detecting the event, and in accordance with a determination that the user selected prompt satisfies one or more respective criteria, the electronic device displays, via the one or more display generation components, a first generation status indication (e.g., in conjunction with initiating the process to generate the representation of the generative visual content based on the event), such as indication 1810 as shown in FIG. 18N. In some embodiments, first generation status indication indicates a generation status and/or progress of generating (e.g., using an AI process or a generative AI process) the representation of the generative visual content based on the event. In some embodiments, the first generation status indication includes an audible and/or visual indication. For example, displaying the first generation status indication includes displaying the first generation status indication having a first amount of visual emphasis (e.g., a first size, first shape, first color, first brightness, first visual effect, first animation, or other first visual property described in method(s) 1400 and/or 1500) indicative of the electronic device initiating the process to generate the representation of the generative visual content based on the event.

In some embodiments, in response to detecting the event, and in accordance with a determination that the user selected prompt does not satisfy the one or more respective criteria the electronic device displays, via the one or more display generation components, a second generation status indication, different from the first generation status indication (or, optionally, in conjunction with forgoing initiating the process to generate the representation of the generative visual content based on the event), such as indication 1806b-2 as shown in FIG. 18F. In some embodiments, displaying the second generation status indication includes displaying the second generation status indication having a second amount of visual emphasis, different from the first amount of visual emphasis of the first generation status indication, such as a second size smaller than the first size, a second shape smaller than the first shape, a second color less distinct than the first color, a second brightness less luminous than the first brightness; a second visual effect less intense than the first visual effect, a second animation less appealing than the first animation, and/or a first visual property less distinct than the first visual property. In some embodiments, displaying the second generation status indication having the second amount of visual emphasis is indicative of the electronic device forgoing initiating the process to generate the representation of the generative visual content based on the event. Displaying a respective generation status indication in accordance with a status of generating the representation of the generative visual content provides feedback that generation is initiated or not initiated without requiring the user to provide further inputs to check the status and/or progress of generating the representation of the generative visual content for display, thereby reducing the number of inputs and providing more efficient interactions between the user and the electronic device.

In some embodiments, displaying the first generation status indication includes displaying the first generation status indication with a first animation effect, such as animating indication 1810 as shown in FIG. 18N. In some embodiments, displaying the second generation status indication includes displaying the second generation status indication with a second animation effect, different from the first animation effect, such as animating indication 1806b-2 as shown in FIG. 18F. In some embodiments, the second animation effect is less appealing than the first animation effect. In some embodiments, the first animation effect and/or the second animation effect includes visual effects described in more detail with reference to method(s) 1400 and/or 1500 and/or as shown in FIGS. 13X-13Y and/or 25F. For example, displaying the first generation status indication optionally includes a graphical object with simulated motion to indicate that the representation of the generative visual content is being generated. In another example, displaying the second generation status indication optionally includes the graphical object with less (or no) simulated motion than the simulated motion of the first generation status indication. Displaying a respective animation effect in accordance with a status of generating the representation of the generative visual content provides feedback that generation is initiated or not initiated without requiring the user to provide further inputs to check the status and/or progress of generating the representation of the generative visual content for display, thereby reducing the number of inputs and providing more efficient interactions between the user and the electronic device.

In some embodiments, detecting the event for generating (e.g., using an AI process or a generative AI process) generative visual content based on the user selected prompt that will influence the generation of the generative visual content includes detecting the event in a first user interface of a first application, such as an event to add term 1828 to the user selected prompt as shown in FIG. 18B. In some embodiments, the first user interface of the first application includes a user interface of a content application (e.g., described in method 700 and/or as shown in FIG. 6KK), a user interface that includes information associated with the first prompt (e.g., described in method 700 and/or as shown in FIG. 6JJ), an editing user interface (e.g., described in method 800 and/or as shown in FIG. 6W), a generative visual content variants user interface described above, and/or other user interface (e.g., described below and/or in method(s) 700, 800, 1000, and/or 1200).

In some embodiments, the electronic device detects, via the one or more input devices, a second event for generating (e.g., using an AI process or a generative AI process) generative visual content based on a second user selected prompt that will influence the generation of the generative visual content in a second user interface of a second application, different from the first application, such as element 2424a of a presentation application as shown and will be described in FIG. 24B. For example, the second user interface of the second application is optionally a user interface of messaging application, a notes application, an email application, a presentation application, a word processing application, a whiteboarding application, a sketching application, a spreadsheet application, a journaling application, and/or other content processing application. In some embodiments, detecting the second event is analogous to and/or includes one or more characteristics of detecting the first event for generating generative visual content based on a user selected prompt that will influence the generation of the generative visual content described above.

In some embodiments, the electronic device displays the first user interface of the first application (e.g., content application overlaid onto the second user interface of the second application (e.g., window of a sketching application).

In some embodiments, in response to detecting the second event, and in accordance with a determination that the second user selected prompt satisfies the one or more respective criteria, the electronic device initiates a process to generate (and/or generating) (e.g., using an AI process or a generative AI process) a representation of the generative visual content based on the second event, such as representation 2426b as shown and will be described in FIG. 24C. In some embodiments, in response to detecting the second event, and in accordance with a determination that the user selected prompt does not satisfy the one or more respective criteria, the electronic device forgoes initiating the process to generate the representation of the generative visual content based on the second event, such as indicated with the display of undo option 1832 and indication 1806 as shown in FIG. 18Q.

In some embodiments, determining that the second user selected prompt satisfies or does not satisfy the one or more respective criteria is analogous to and/or includes one or more characteristics of determining that the user selected prompt satisfies or does not satisfy the one or more respective criteria described above. In some embodiments, initiating the process or forgoing initiating the process to generate the representation of the generative visual content based on the second event is analogous to and/or includes one or more characteristics of initiating the process or forgoing initiating the process to generate the representation of the generative visual content based on the event described above. In some embodiments, detecting and responding to a second event for generating (e.g., using an AI process or a generative AI process) generative visual content based on a second user selected prompt that will influence the generation of the generative visual content is accessible while operating the second application (e.g., during the second application session). In some embodiments, determining whether the second user selected prompt satisfies the one or more respective criteria in response to detecting the second event includes one or more of the processes and/or characteristics of determining whether the user selected prompt satisfies the one or more respective criteria in response to detecting the event described above, such as removing a prompt component, displaying a user interface element for selecting a subject, triggering the requirement that none of the terms and/or none of the combinations of two or more terms in the user selected prompt have a high-risk meaning and/or other manner of satisfying the one or more respective criteria to initiate the process to generate generative visual content described above. Surfacing generative visual content in a second application different from the first (e.g., content) application provides an efficient way of accessing different generative visual content without leaving the second application and the need for subsequent inputs to close or end a session in the second application to open the first application, thereby reducing the number of inputs and providing more efficient interactions between the user and the electronic device.

It should be understood that the particular order in which the operations in FIG. 19 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1400, 1500, 1700, 2100, 2300, and/or 2700) are also applicable in an analogous manner to method 1900 described above with respect to FIG. 19. For example, the operation of restricting prompt components to be used to generate automatically-generated visual content described above with reference to method 1900 optionally has one or more of the characteristics of, displaying a representation of a prompt and one or more recognized concepts, editing one or more parameters, including one or more recognized concepts, of a previously generated automatically-generated visual content, adding a representation of automatically-generated visual content into a first application, presenting an automatically-generated visual media creation user interface to use a non-automatically-generated visual media as the reference media item, displaying portion(s) of a user interface with HDR luminance, displaying one or more portions of the user interface with luminance that is within or greater than a SDR luminance, generating multiple variations of representations of automatically-generated visual content, displaying a representation of second generative visual content based on first prompt, wherein the second generative visual content is different from first generative visual content, suggesting prompt component suggestions based on device context, customizing subjects for generating automatically-generated visual content, and constraining template subjects and using a random or pseudorandomly selected template subject as the subject for generating the automatically-generated visual content described herein with reference to other methods described herein (e.g., 700, 800, 1000, 1200, 1400, 1500, 1700, 2100, 2300, and/or 2700). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 19 are, optionally, implemented by components depicted in FIGS. 1A-1B. For example, detecting operation 1902a and initiating operations 1902c are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices, a display generation component, and wireless circuitry. In some embodiments, the electronic device determines the context that the electronic device is in based on previous activity. For example, the electronic device uses previous device activity (e.g., messaging conversations, application activity, web browsing activity, or other device activity) to determine the context of the electronic device. In some embodiments, after determining the context of the electronic device, the electronic device is able to display prompt component suggestions relating to the context of the electronic device while presenting the user interface for detecting a prompt for generating an automatically-generated visual content. In some embodiments, automatically-generated visual media is media generated using autonomous processes optionally as described herein. In some embodiments, generating the automatically-generated visual content includes using a real image as a starting point to build in additional concepts and/or features found in the prompt, as described in methods 700 and 800. The embodiments described below also provide ways in which the electronic device suggests prompt components which are able to be used as recognized concepts to generate an automatically-generated visual content. Suggesting prompt components based on previously presented content and/or device context allows the user to easily and efficiently select relevant prompt components to be used to influence the generation of an automatically-generated visual content, thereby reducing the number of inputs needed to generate automatically-generated visual media and reducing erroneous inputs to the electronic device. It is understood that people use devices. When a person uses a device, that person is optionally referred to as a user of the device.

FIGS. 20A-20AA illustrate exemplary ways in which an electronic device displays prompt component suggestions and generates an automatically-generated visual content. The embodiments in these figures are used to illustrate the processes described below, including the processes described with reference to FIG. 21. Although FIGS. 20A-20AA illustrate various examples of ways an electronic device is able to perform the processes described below with respect to FIG. 21, it should be understood that these examples are not meant to be limiting, and the electronic device is able to perform one or more processes described below with reference to FIG. 21 in ways not expressly described with reference to FIGS. 20A-20AA.

FIG. 20A illustrates embodiments of a messaging user interface of a messaging application. FIG. 20A illustrates an electronic device 500 with a display generation component 504 (e.g., a touchscreen). In some embodiments, the electronic device 500 is a mobile device, such as a smartphone, tablet, or wearable device. In FIG. 20A, the electronic device 500 displays an embodiment of user interface 900 that includes a messaging conversation between Joe (e.g., the user associated with the electronic device 500) and a contact named Jack (e.g., indicated by the representation 2002a of Jack). The messaging user interface 900 includes the first user interface object 2004a (or representation) of a first message that was added to the messaging conversation from a second device and/or a second user account associated with Jack, the second user interface object 2004b (or representation) of a second message that was added to the messaging conversation from the electronic device 500 and/or a first user account associated with Joe, and the third user interface object 2004c (or representation) of a third message that was added to the messaging conversation from the second device and/or the second user account associated with Jack. In some embodiments, the user interface objects and the messaging user interface 900 are described in additional detail in FIG. 9A.

In FIG. 20A, the messaging user interface 900 also includes a content entry field 906, a selectable option 910, that when selected, causes the electronic device 500 to use the one or more input devices (e.g., a microphone) to receive a voice command from a user (e.g., a voice command to input text), and a selectable option 912, that when selected, causes the electronic device 500 to display a menu of selectable options 916a through 916h that are selectable to insert various content items into the content entry field, which are described in greater detail in FIGS. 9B and 11B. In FIG. 20A, the electronic device 500 receives a swipe input including contact 2008 directed towards bar 2006. In response to detecting the swipe input in FIG. 20A, the electronic device 500 displays a home screen user interface 2000, shown in FIG. 20B.

FIG. 20B illustrates the home screen user interface 2000. The home screen user interface 2000 includes a plurality of selectable options 2010a through 2010m that correspond to various application. In response to detecting a selection input directed towards an option 2010a through 2010m, the electronic device 500 displays a user interface of the respective application corresponding to the selected option. In FIG. 20B, the electronic device 500 receives a selection input (e.g., a tap or long press input) including contact 2012 directed towards option 2010i. In response to detecting the selection input, the electronic device 500 displays user interface 600, a user interface of the automatically-generated visual media application, described in greater detail in the FIG. 6A and shown in FIG. 20C.

Additionally or alternatively, the electronic device 500 displays user interface 600 in response to detecting one or more inputs while in user interface 900, shown in FIG. 20A. In FIG. 20A, the electronic device 500 detects a selection input (e.g., a tap or long press input) including contact 2012 directed towards selectable option 912. In response to detecting the input including contact 2012 in FIG. 20A, the electronic device 500 displays selectable options 916a through 916h, which are shown in FIG. 9B. As described in FIG. 9B, the electronic device 500 receives a selection input directed towards option 916g. In response to detecting the input directed towards option 916g, the electronic device 500 displays user interface 600, shown in FIG. 20C (which corresponds to user interface element 922). Although FIG. 20A illustrates multiple inputs (e.g., tap or long press inputs) directed towards multiple options using contact 2012, the electronic device 500 optionally receives the inputs directed towards one or more options independently

FIG. 20C illustrates an embodiment of user interface 600, which includes a gallery of automatically-generated visual content, which are shown as representations 2014a through 2014f, and the selectable option 610. As described in method 700 and shown in FIGS. 6CC and 6DD, the representations 2014a through 2014f are selectable and, when a representation is selected, the electronic device 500 displays a user interface including a respective representation of the automatically-generated visual content. In FIG. 20C, the electronic device 500 receives a selection input (e.g., a tap or long press input) including contact 2012 directed towards option 610. In response to detecting the input in FIG. 20C, the electronic device 500 displays user interface 604, shown in FIG. 20D.

FIG. 20D illustrates an embodiment of user interface 604, which corresponds to user interface 604 shown in FIGS. 6B-6MM and/or the user interfaces shown in FIGS. 16A-16U, 18A-18BB, 22A-22CCC, 24A-24E, and/or 26A-26P. User interface 604 is a user interface for detecting a prompt for use in generating automatically-generated visual content. User interface 604 includes prompt component suggestions 2016a through 2016h, which have one or more characteristics of selectable options 608a through 608d, shown in FIG. 6B. Prompt component suggestions are described in greater detail in method 2100. In some embodiments, prompt component suggestions are optionally related to a context of the electronic device 500, described in greater detail in method 2100. In FIG. 20C, prompt component suggestions 2016a through 2016d are related to the messaging conversation shown in FIG. 20A. In the messaging conversation in FIG. 20A, Jack and Joe are discussing dogs surfing. In FIG. 20C, prompt component suggestions 2016a through 2016d, shown in FIG. 20A include “dog”, “surfer”, “ocean”, and “adventure”, which are terms relevant to the messaging conversation. In some embodiments, the electronic device 500 also displays prompt component suggestions (e.g., suggestions 2016e through 2016h, shown in FIG. 6D) that are optionally not relevant to the context of the electronic device. In some embodiments, suggestions 2016e through 2016h, shown in FIG. 6D, are suggested by the electronic device 500 (e.g., at random, based on previous device activity prior to presenting the messaging conversation in FIG. 20A, and/or they are frequently and/or recently used prompt components).

In FIG. 20D, the electronic device 500 also displays selectable options 2020a through 2020c. Option 2020a, when selected, causes the electronic device 500 to display a content entry field for detecting prompt components and/or recognized concepts, as described in greater detail in method 2100 and shown in FIG. 20L. Option 2020b, when selected, causes the electronic device 500 to display a user interface for changing the subject of the automatically-generated visual content, as described in greater detail in method(s) 2100 and/or 2300 and shown in FIG. 20Q and FIGS. 22A-22CCC. Option 2020c, when selected, causes the electronic device 500 to display a user interface for changing the style of the automatically-generated visual content, as described in greater detail in method 2100 and shown in FIG. 20V. In some embodiments, options 2020a, 2020b, and 2020c are analogous to options 1610 1846a, and/or 2210a; 1612, 1848, and/or 2210b; and 1614, 1850, and/or 2210c in Fig. FIGS. 16A-16U, 18G-18BB, 22A-22CCC, and/or 26A-26P.

In FIG. 20D, options 2020b and options 2020c are prefilled with a respective subject and style and the electronic device 500 displays text and images corresponding to the prefilled subject and style on options 2020b and 2020c. In some embodiments, the style of the automatically-generated visual content is described in greater detail in methods 700 and 800. In some embodiments, the subject of the automatically-generated visual content is described in greater detail in methods 1000, 1200, 2100, and 2300. As described in method 2100, the electronic device 500 uses the context of the electronic device 500 to prefill the subject. For example, in FIG. 20D, the electronic device 500 adds “Jack” as the subject to be used to influence the generation of the automatically-generated visual content because the electronic device 500 was previously displaying a messaging conversation, shown in FIG. 20A with “Jack”. In some embodiments, the electronic device 500 prefills the respective subject and style with the last used subject and style. For example, the most recent previously generated automatically-generated visual content used “animation” as the style.

In FIG. 20D, the electronic device 500 receives an input including contacts 2018 (e.g., a dragging motion using a finger remaining in contact with the touch screen) directed towards suggestions 2016b and 2016c so that they can be used to influence the generation of the automatically-generated visual content. In response to detecting the inputs in FIG. 20D, the electronic device 500 updates a first region of the electronic device 500 to include the recognized concepts 2022a and 2022b in a prompt region 2017, which correspond to suggestions 2016b and 2016c, respectively, shown in FIG. 20E. Although FIG. 20D illustrates multiple inputs (e.g., tap or long press inputs) directed towards multiple suggestions 2016b and 2016c using contact 2018, the electronic device 500 optionally receives the inputs directed towards one or more suggestions independently.

FIG. 20E illustrates user interface 604 including recognized concepts 2022a and 2022b in the prompt region 2017. Recognized concepts 2022a and 2022b have one or more characteristics of recognized concepts 620a through 620c shown in FIG. 6E. Recognized concepts are described in greater detail in methods 700, 800, and 2100. Additionally, in response to detecting the inputs in FIG. 20D, the electronic device 500 updates user interface 604 to include representation 2024a in the preview region 2019 of the first region of the user interface 604. In some embodiments, representation 2024a includes one or more characteristics of representation 622a through 622g shown above in FIGS. 6A-9X. Displaying a preview of the automatically-generated visual content is described in greater detail in methods 700, 800, 1000, 1200, 1400, 1500, 1700, 1900, 2100, 2300 and/or 2700.

In FIG. 20E, the electronic device includes visual effects 2026a and 2026b. The visual effect 2026a is displayed between the recognized concept 2022a and the representation 2024a. The visual effect 2026b is displayed between the recognized concept 2022b and the representation 2024a. The visual effects between the recognized concept and the representation of the automatically-generated visual content is described in greater detail in methods 1400, 1500, and 2100.

In FIG. 20E, the electronic device 500 updates suggestions 2016a through 2016h, shown in FIG. 20D, to suggestions 2016i through 2016p. In some embodiments, some of the suggestions in FIG. 20E correspond to suggestions in FIG. 20D (e.g., suggestions 2016e through 2016h correspond to suggestions 2016m through 2016p). In FIG. 20E, the electronic device 500 changes one or more of the suggestions in response to detecting the one or more inputs to add recognized concepts, shown in FIG. 20D. As described in method 2100, as the context of the electronic device changes (e.g., the prompt used to influence the generation of the automatically-generated visual media changes), the electronic device 500 changes the prompt component suggestions.

In FIG. 20E, the user interface 604 also includes options 624a and 624b. Option 624a optionally corresponds to options 1602a, 1802a, and/or 2202a in FIGS. 6B-6MM, 16A-16U, 18A-18BB, 22A-22CCC, and/or 26A-26P. Option 624b optionally corresponds to option 1602b, 1802b and/or 2202b in FIGS. 6B-6MM, 16A-16U, 18A-18BB, 22A-22CCC, and/or 26A-26P. In some embodiments, selectable option 624a, when selected, causes the electronic device 500 to end (e.g., cancel) the process to generate an automatically-generated visual content, and selectable option 624b, when selected, causes the electronic device 500 to generate the automatically-generated visual content, as described in greater detail in methods 700 and 800. In FIG. 20E, the electronic device 500 receives an input (e.g., tap or long press input) including contact 2012 directed towards option 624b. In response to detecting the input in FIG. 20E, the electronic device 500 displays user interface 629j, shown in FIG. 20F. In some embodiments, user interface 629j has one or more characteristics of user interfaces 629a through 629h, described in FIGS. 6A-6MM. User interface 629j includes a representation of the automatically-generated visual content that is optionally higher fidelity than the representation 2024a, described in further detail in method 700.

In FIG. 20F, the user interface 629h also includes the selectable option 675a, that when selected, causes the electronic device 500 to generate a three-dimensional (3D) version of the automatically-generated visual media shown in FIG. 20F. Alternatively, the electronic device 500 generates a new automatically-generated visual content item as a 3D automatically-generated visual content item using the one or more recognized concepts. In some embodiments, selectable option 627a is described in greater detail in FIG. 6Z.

FIG. 20G illustrates a different embodiment of user interface 900 shown in FIG. 20A. In FIG. 20A, the electronic device 500 displays a messaging conversation between Joe and Jack. In FIG. 20G, the electronic device 500 displays the same messaging conversation as shown in FIG. 20A, however, the conversation is between Joe and Jane.

After displaying the user interface 900 in FIG. 20G, the electronic device 500 navigates to (e.g., as described above) and displays user interface 604 shown in FIG. 20H. Because the conversation is between Jane and Joe, the electronic device 500 prefills the subject with “Jane” in FIG. 20H instead of “Jack” in FIG. 20D because the context of the electronic device 500 has changed. Additionally, the electronic device 500 replaces representation 2024a, shown in FIG. 20E, with representation 2024b, shown in FIG. 20H, because the prompt components used to generate the automatically-generated visual content have changed (e.g., the subject changed from “Jack” to “Jane”.

In FIG. 20H, the electronic device 500 receives an input including contact 2012 (e.g., tap or long press input) directed towards option 624b. In response to detecting the input in FIG. 20H, the electronic device 500 generates the automatically-generated visual content using the recognized concepts 2022a and 2022b, the subject shown on option 2020b, and the style shown in option 2020c. In response to detecting the input in FIG. 20H, the electronic device 500 displays a user interface including a high-fidelity representation of the automatically-generated visual content. The details for creating and generating the automatically-generated visual content are described above with reference to FIGS. 9G-91 and FIGS. 9N-90. For example, detecting selection of selectable option 624b causes the electronic device 500 to generate the automatically-generated visual content and then the electronic device receives an input to save the automatically-generated visual content.

FIGS. 20I-20N illustrate an embodiment where the electronic device 500 displays a user interface for a second application and then displays prompt component suggestions related to the user interface from the second application. In FIG. 20I, the electronic device 500 displays user interface 2028 of a web browser application. In FIG. 20I, the user interface 2028 includes search results 2030a through 2030d for a search for “Argentina Vacations”, shown in content entry field 2032a. In some embodiments, the search results 2030a through 2030d, when selected, cause the electronic device 500 to display a respective webpage corresponding to the search result. User interface 2028 also includes selectable options 2032b through 2032f. In some embodiments, option 2032b, when selected, causes the electronic device 500 to return to a previous web browser page that was previously presented. In some embodiments, option 2032c, when selected, causes the electronic device 500 to display a web browser page that was displayed after the electronic device 500 displays the web browser page shown in FIG. 20I. In some embodiments, option 2032d, when selected, causes the electronic device 500 to display a menu of selectable options to share the page shown on user interface 2028 in FIG. 20I. In some embodiments, option 2032e, when selected, causes the electronic device 500 to display a menu of selectable options corresponding to bookmarked web browser pages. In some embodiments, option 2032f, when selected, causes the electronic device 500 to display a collection of web browser pages that are presently open.

In FIG. 20I, the electronic device 500 receives a swipe input including contact 2008 directed towards bar 2006 to cease displaying user interface 2028 and begin displaying the home screen user interface 2000, shown in FIG. 20B. While displaying the home screen user interface 2000, the electronic device 500 receives an input corresponding to a request to open the automatically-generated visual media application, which results in the electronic device 500 displaying user interface 600, shown in FIG. 20J.

FIG. 20J illustrates user interface 600, including representations 2014a through 2014e and 2014g, corresponding to previously generated automatically-generated visual media that have been saved. In some embodiments, saving the automatically-generated visual content also includes adding the automatically-generated visual content as an automatically-generated visual content in user interface 600, described in method 700 and 800, and in FIG. 6R. In some embodiments, the automatically-generated visual content shown in FIG. 20F was saved and the electronic device 500 displays representation 2014g in FIG. 20J corresponding the automatically-generated visual content shown in user interface 629j, shown in FIG. 20F.

In FIG. 20J, the electronic device 500 receives an input including contact 2012 (e.g., a tap or long press input) directed towards representation 2014g. In response to detecting the input in FIG. 20J, the electronic device 500 displays user interface 604, shown in FIG. 20K, including the one or more recognized concepts used to generate the respective automatically-generated visual content. Additionally, in FIG. 20K, the electronic device 500 updates the prompt component suggestions to suggestions 2016q through 2016x because the context of the electronic device 500 is updated after the electronic device 500 displays the user interface 2028 shown in FIG. 20I.

In FIG. 20K, suggestions 2016q through 2016t are relevant to the context of the electronic device 500. For example, suggestions 2016q through 2016t are relevant to the search results displays in user interface 2028, shown in FIG. 20I. In some embodiments, the suggestions are displayed based on prior device activity and/or previously-used applications, as described in method 2100. In some embodiments, and as described above, the electronic device 500 optionally also displays prompt component suggestions (e.g., suggestions 2016u through 2016x) that are not based on the context of the electronic device 500.

In FIG. 20K, the electronic device 500 receives an input including contact 2012 (e.g., a tap or long press input) directed towards option 2020a. In response to detecting the input in FIG. 20K, the electronic device 500 displays a content entry field 2020d for detecting prompt component inputs, shown in FIG. 20L. Additionally, the electronic device 500 updates the display of options 2020b and 2020c to options 2020e and 2020f, respectively, shown in FIG. 20L. In some embodiments, detecting prompt components and/or prompts in the content entry field is described in greater detail in method 2100.

In FIG. 20L, the electronic device 500 receives an input including contact 2012 (e.g., a tap or long press input) directed towards the content entry field 2020d. In response to detecting the input, shown in FIG. 20L, the electronic device 500 displays keyboard user interface element including keyboard 2037, prompt component suggestions 2034a through 2034c, and content entry field 2020d, shown in FIG. 20M.

FIG. 20M illustrates user interface 604 including the keyboard user interface element. In some embodiments, the keyboard user interface element includes the content entry field 202d. Within the content entry field, the electronic device 500 displays indication 2020h. In response to receiving an input including a prompt component that is a recognized concept, such as shown in FIG. 20N and described in greater detail in method 2100, the electronic device 500 updates indication 202h with an icon corresponding to the respective recognized concept. The electronic device 500 also displays option 2020g, that when selected, causes the electronic device 500 to add the text as a prompt component in the prompt region 2017 of the user interface 604. In FIG. 20M, the electronic device 500 displays prompt component suggestions 2034a through 2034c as text suggestions above the keyboard 2037 instead of as images and text as shown by prompt component suggestions 2016q through 2016x shown in FIG. 20K because the keyboard user interface element is displayed. In some embodiments, prompt component suggestions 2034a through 2034c are suggestions relevant to the context of the electronic device (e.g., relevant to the previous user interface, user interface 2028 shown in FIG. 20I).

In FIG. 20M, the electronic device 500 receives an input including contact 2012 (e.g., a tap or long press input) directed towards suggestion 2034b. In response to detecting the input in FIG. 20M, the electronic device 500 updates content entry field 2020d to include the text from the suggestion 2034b, shown in FIG. 20N.

In FIG. 20N, the electronic device 500 displays text corresponding to suggestion 2034b. Because the text “mountains” is a recognized concept, the electronic device 500 displays an icon including mountains as indication 2020h. In some embodiments, the electronic device 500 displays the icon corresponding to the suggestion 2034b (e.g., “mountains”) but does not display the text corresponding to the suggestion 2034b.

In FIG. 20N, the electronic device 500 receives an input including contact 2012 (e.g., a tap or long press input) directed towards option 2020g. In response to detecting the input, the electronic device 500 updates user interface 604 to include recognized concept 2026c, shown in FIG. 20O. which corresponds to the prompt component displayed in the content entry field 2020d, shown in FIG. 20N.

In FIG. 20O, the electronic device 500 displays recognized concept 2022c in the prompt region 2017 of user interface 604. Because the electronic device 500 updated the prompt components used to generate the automatically-generated visual content, the electronic device also updates representation 2024a, shown in FIG. 20E, with representation 2024c, shown in FIG. 20O. The electronic device 500 also displays visual effect 2026g between recognized concept 2022c and representation 2024c. The visual effects displayed between respective recognized concepts and the representation of the automatically-generated visual content is described in greater detail above and with reference to methods 1400, 1500, and/or 2100. Additionally, in FIG. 20O, the electronic device updates visual effect 2026a with visual effect 2026e and visual effect 2026b with visual effect 2026f. In some embodiments, the electronic device 500 updates and/or changes visual effects between respective recognized concepts and/or prompt components and the representation of the automatically-generated visual content in response to modifications to the recognized concepts and/or prompt components, as described in greater detail in methods 1400, 1500, and 2100.

In FIG. 20O, the electronic device 500 displays “raining meatballs” in content entry field 2020d in response to detecting one or more inputs directed towards keyboard 2037 and/or a voice input for adding context to the content entry field 2020d. In some embodiments, because the electronic device 500 does not identify “raining meatballs” as a recognized concept (e.g., “raining meatballs” is not in a database of recognized concepts, described in greater detail in methods 700 and 800), the electronic device 500 does not update indication 2020h to include an icon/image of a respective recognized concept. Additionally, the electronic device updates the prompt component suggestions from suggestions 2034a through 2034c shown in FIG. 20M to suggestions 2034d through 2034f shown in FIG. 20O because adding content to the content entry field 2020d changes the context of the electronic device, which is described in greater detail in method 2100.

In FIG. 20O, the electronic device 500 receives an input including contact 2012 (e.g., a tap or long press input) directed towards option 2020g to add the prompt component to the prompt region 2017 of the user interface 604 to be used to influence the generation of the automatically-generated visual content. In response to detecting the input in FIG. 20O, the electronic device 500 updates user interface 604 to include prompt component 2022d, shown in FIG. 20P. Because “raining meatballs” is not identified as a recognized concept, the electronic device 500 does not display an image/icon corresponding to the prompt component.

FIG. 20P illustrates user interface 604 with the addition of prompt component 2022d. In some embodiments, before displaying FIG. 20P, the electronic device 500 receives one or more inputs to cease displaying the keyboard user interface element. In FIG. 20P, the electronic device 500 updates representation 2024c, shown in FIG. 20O, to representation 2024d because there is an additional prompt component 2026d to be used to generate the automatically-generated visual content. In FIG. 20P, the electronic device 500 displays visual effect 2026k between prompt component 2022d and the representation 2024d. Additionally, the electronic device 500 updates the visual effects 2026e, 2026f and 2026g to visual effects 2026h, 2026i, and 2026j, respectively, for the recognized concepts 2022a through 2022c. In FIG. 20P, the electronic device 500 displays prompt component suggestions 2016y through 2026ff, which are optionally relevant to the context of the electronic device 500. In some embodiments, the context of the electronic device 500 is updated after the one or more prompt components and/or recognized concepts used to generate the automatically-generated visual content changes. The one or more of suggestions 2016y through 2026ff shown in FIG. 20P are different from the one or more suggestions 2016q through 2016x shown in FIG. 20K because the electronic device 500 has added one or more recognized concepts and/or prompt components to the prompt region 2017.

In FIG. 20P, the electronic device 500 receives an input including contact 2012 (e.g., a tap or long press input) directed towards option 2020b. In response to detecting the input in FIG. 20P, the electronic device 500 displays a subject selection user interface 2036, shown in FIG. 20Q.

FIG. 20Q illustrates a subject selection user interface 2036 for changing the subject of the automatically-generated visual content. In some embodiments, subject selection is described in greater detail in methods 2100 and 2300. Subject selection user interface 2036 includes selectable options 2038a through 2038d. Option 2038a, when selected, causes the electronic device 500 to cease displaying user interface 2036 and redisplay user interface 604 including the one or more recognized concepts and/or prompt components user to influence the generation of the automatically-generated visual content. Option 2038b, when selected, causes the electronic device 500 to create the automatically-generated visual content using the selected subject and the one or more recognized concepts and/or prompt components that were previously displayed on user interface 605, shown in FIG. 20P. Option 2038c, when selected, causes the electronic device 500 to clear the selection of the subject. Option 2039d, when selected, causes the electronic device 500 to redisplay the user interface 604, shown in FIG. 20P, with the selected subject illustrated in option 2020b. In some embodiments, options 2038a and 2038b are analogous to options 624a and 624b, respectively, in FIG. 6A. In some embodiments, options 2038c and 2038d are analogous to options 1626b, 1868b, and/or 2214a and 1626c, 1868c, and/or 2214b, respectively, in FIGS. 16A-16U, 18G-18BB, 22A-22CCC, and/or 26A-26P. User interface 2036 includes indications 2050a through 2050d, which represent the recognized concepts and/or prompt components displayed in the prompt region 2017, shown in FIG. 20P. In some embodiments, the number of indications 2050a through 2050d corresponds to the number of the recognized concepts and/or prompt components displayed in the prompt region 2017, shown in FIG. 20P.

User interface 2036 includes representation 2040a, which corresponds to representation 2024d, shown in FIG. 20P. In some embodiments, the electronic device 500 generates three previews of the automatically-generated visual content, indicated by indication 2042. The generation of additional previews of automatically-generated visual content is described in greater detail in methods 700 and 1700. User interface 2036 includes selectable options 2044a through 2044c for creating a new subject. In some embodiments, option 2044a, when selected, causes the electronic device 500 to display a user interface for creating a subject, described in greater detail in method 2300. Option 2044b, when selected, causes the electronic device 500 to display a user interface of a camera application, such as shown in FIG. 11C, to take a picture of a subject. Option 2044c, when selected, causes the electronic device 500 to display a user interface of a media library, such as shown in FIG. 9R as user interface element 936. In some embodiments, while displaying the user interface of the media library, such as shown in FIG. 9R, the electronic device 500 receives one or more inputs directed towards an image and/or video in the media library to be used as a reference to create a subject for influencing the generation of the automatically-generated visual content. In some embodiments, selecting a subject is described in greater detail in methods 1000, 1200, 2100, and 2300.

In FIG. 20Q, the electronic device 500 displays indications 2044d through 2044i, which represent subjects that are able to be used to influence the generation of the automatically-generated visual content. In some embodiments, the electronic device 500 uses photos and/or videos (e.g., from a media library application, a messaging application, and/or other applications that include photos and/or videos) stored on the electronic device 500 and/or in a storage device in communication with the electronic device 500 to generate different subjects that are able to be used, which is described in greater detail in method 2300. In some embodiments, the electronic device 500 prioritizes displaying recently used, commonly used, and/or contextually relevant subjects, as described in method 2100. In some embodiments, the electronic device 500 display a respective image and text for indications 2044d through 2044i that represents the respective subject. In some embodiments, user interface 2036 is scrollable such that additional indications of additional subjects are displayed in response to a scroll input towards the region of the user interface 2036 including indications 2044d through 2044i. In FIG. 20Q, the electronic device 500 displays indication 2044h with a bolded outline and a check mark because indication 2044h is the presently selected subject. The electronic device 500 displays option 2046 next to the selected subject (e.g., indication 2044h). In some embodiments, option 2046, when selected, causes the electronic device 500 to display a user interface for changing the representation of the subject to a different representation of the same subject (e.g., a different image of the subject) to be used to influence the generation of the automatically-generated visual content. Changing the representation of the subject is described in greater detail in method 2300. In some embodiments, the image of indication 2044h is also displayed on option 2020b, shown in FIG. 20K. In some embodiments, the image on option 2020b changes to correspond to the respective image of the selected subject.

In FIG. 20Q, the electronic device 500 receives an input including contact 2048 (e.g., a swipe input using a direct contact such as a finger and/or a stylus, or an indirect input such as a gaze and/or a mouse) directed towards representation 2040a. In response to detecting the input, the electronic device 500 updates representation 2040a with a different representation of the same automatically-generated visual content, representation 2040b, shown in FIG. 20R. Additionally, in FIG. 20R, the electronic device 500 updates indication 2042 to show that the second representation is being displayed. As described in method 1700, the electronic device 500 regenerates the preview in FIG. 20R using the same recognized concepts and/or prompt concepts shown in prompt region 2017 in FIG. 20P.

In FIG. 20S, the electronic device 500 receives an input including contact 2012 (e.g., a tap or long press input) directed towards indication 2044e to change the subject of the generated media. In response to detecting the input in FIG. 20S, the electronic device 500 updates the selected subject from a subject corresponding to indication 2044h (“Jack”) to a subject corresponding to indication 2044e (“Ava”), shown in FIG. 20T.

In FIG. 20T, the electronic device 500 displays indication 2044e as the selected subject, including displaying option 2046 next to indication 2044e. In FIG. 20T, the electronic device 500 updates representation 2040b, shown in FIG. 20S, to representation 2040c. Representation 2040c is a representation of the automatically-generated visual content including “Ava” as the subject instead of “Jack”.

In FIG. 20T, the electronic device 500 receives a plurality of inputs including contact 2012 (e.g., a tap or long press input) directed towards options 2038a through 2038d. Option 2038a, when selected, causes the electronic device 500 to cease displaying user interface 2036 and redisplay user interface 604 including the one or more recognized concepts and/or prompt components user to influence the generation of the automatically-generated visual content. Option 2038b, when selected, causes the electronic device 500 to create the automatically-generated visual content using the selected subject and the one or more recognized concepts and/or prompt components that were previously displayed on user interface 605, shown in FIG. 20P. Option 2038c, when selected, causes the electronic device to clear the selection of the subject. Option 2039d, when selected, causes the electronic device 500 to redisplay the user interface 604, shown in FIG. 20P, with the selected subject illustrated in option 2020b.

In FIG. 20T, the electronic device 500 receives an input including contact 2012 (e.g., a tap or long press input) directed towards a region of user interface 2036 outside of representation 2040c. In response to detecting the input in FIG. 20T, the electronic device 500 redisplays user interface 604, shown in FIG. 20U. Although FIG. 20T illustrates multiple inputs directed towards multiple options 2038a through 2038c and directed towards a region outside user interface 2036 using contact 2012 (e.g., a tap or long press input), the electronic device 500 optionally receives the inputs directed towards one or more options independently.

In FIG. 20U, the electronic device 500 displays user interface 604 with “Ava” as the subject. In some embodiments, the electronic device 500 displays the user interface 604 shown in FIG. 20U in response to detecting the input including contact 2012 (e.g., a tap or long press input) shown in FIG. 20T. In FIG. 20U, the electronic device 500 updates option 2020b to include the text “Ava” and an icon corresponding to the indication 2044e to indicate that “Ava” is the subject. In FIG. 20U, the electronic device 500 displays representation 2024e, corresponding to representation 2040c shown in FIG. 20T. In FIG. 20U, the electronic device 500 updates visual effects 2026h through 2026k with visual effects 20261 through 20260, respectively, because one or more prompt components have changed (e.g., the subject).

In FIG. 20U, the electronic device 500 receives an input including contact 2012 (e.g., a tap or long press input) directed towards option 2020. In response to detecting the input, the electronic device 500 displays a style selection user interface 2052, shown in FIG. 20V. In some embodiments, the electronic device 500 changes the style using style selection user interface 2052, which is described in greater detail in method 2100.

FIG. 20V illustrates the style selection user interface 2052. Options 2054a through 2054d corresponds to option 2038a through option 2038d shown in FIG. 20T, respectively. User interface 2052 also includes a representation of the automatically-generated visual content (e.g., representation 2040c). In some embodiments, detecting a swipe input on representation 2040c causes the electronic device 500 to display a different representation that is generated using the same prompt components as representation 2040c.

In FIG. 20V, the electronic device 500 displays indications 2056a through 2056i, which represent different styles. Styles are described in further detail in methods 700 and 800, and shown in FIG. 6N. The indications 2056a through 2046i include respective icons and images corresponding to the respective style. In some embodiments, user interface 2052 is scrollable such that additional indications of additional styles are displayed in response to a scroll input towards the region of the user interface 2052 including indications 2056a through 2046i. In FIG. 20V, the electronic device 500 displays a check mark on indication 2056b to indicate that indication 2056b corresponds to the presently selected style. In FIG. 20V, the electronic device 500 receives an input including contact 2012 (e.g., a tap or long press input) directed towards indication 2056a. In response to detecting the input in FIG. 20V, the electronic device 500 updates the presently selected style from “animation” to “sketch”, shown in FIG. 20W.

FIG. 20W illustrates user interface 2052 in response to the electronic device 500 detecting an input to change the selected style. In FIG. 20W, the electronic device 500 displays a check mark on indication 2056a to indicate that indication 2056a corresponds to the presently selected style. Additionally, the electronic device 500 changes the representation 2040c shown in FIG. 20V to representation 2040d, shown in FIG. 20W, which is generated using the style “Sketch”. In FIG. 20W, the electronic device 500 receive an input including contact 2012 (e.g., a tap or long press input) directed towards a region of user interface 2052 outside of representation 2040d. In response to detecting the input in FIG. 20W, the electronic device 500 redisplays user interface 604, shown in FIG. 20X.

In FIG. 20X, the electronic device 500 displays user interface 604 with “sketch” as the style. In FIG. 20X, the electronic device 500 updates option 2020c to include the text “sketch” and an icon corresponding to the indication 2056a to indicate that “sketch” is the style. In FIG. 20X, the electronic device 500 displays representation 2024f, corresponding to representation 2040d shown in FIG. 20W. In FIG. 20X, the electronic device 500 updates visual effects 20261 through 20260 with visual effects 2026p through 2026s, respectively, because one or more prompt components have changed (e.g., the style).

In FIG. 20X, the electronic device 500 detects an input including contact 2012 (e.g., a tap or long press input) directed towards option 624b. In response to detecting the input in FIG. 20X, the electronic device 500 displays user interface 629k, shown in FIG. 20Y. In some embodiments, user interface 629k has one or more characteristics of user interfaces 629a through 629h, described in FIGS. 6A-6MM. User interface 629k includes a representation of the automatically-generated visual content that is optionally higher fidelity than the representation 2024f, shown in FIG. 20X, which is described in further detail in method 700.

In FIG. 20Y, the user interface 629h also includes the selectable option 675a, that when selected, causes the electronic device 500 to generate a three-dimensional (3D) version of the automatically-generated visual media shown in FIG. 20Y. Alternatively, the electronic device 500 generates a new automatically-generated visual content item as a 3D automatically-generated visual content item using the one or more recognized concepts. In some embodiments, selectable option 627a is described in greater detail in FIG. 6Z.

FIG. 20Z illustrates an embodiment of user interface 604 wherein options 2020a through 2020c, shown in FIG. 20X, are replaced with content entry field 2020d and options 2020k and 2020l. Content entry field 2020d is shown and described in greater detail in FIG. 20K. Option 2020k illustrates the current subject that is influencing the generation of the automatically-generated visual content. Option 2020k includes an icon and/or representation of the current subject. In some embodiments, option 2020k, when selected, causes the electronic device 500 to display user interface 2036 for selecting a subject, shown in FIG. 20Q. Option 2020l, when selected, causes the electronic device 500 to display a menu including options for changing the subject and style being used to influence the generation of the automatically-generated visual content. In some embodiments, the menu is described in greater detail in method 2100.

In FIG. 20Z, the electronic device 500 detects an input directed towards option 2020l, such as detecting contact 2012 (e.g., a tap or long press input). In some embodiments, other selection inputs, such as an air gesture input, a voice input, and/or an input detected using a hardware input device, are possible. In response to detecting the input, the electronic device 500 displays menu 2074, shown in FIG. 20AA.

FIG. 20AA illustrates the menu 2074 including a plurality of selectable options for selecting a style and/or subject to be used to generate the automatically-generated visual content. in FIG. 20AA, the electronic device 500 displays a section 2072a including a selection of options 2070a through 2070c corresponding to different styles. In some embodiments, the different styles are described in greater detail in method 700 and shown in FIG. 6L. In some embodiments, the electronic device 500 detects an input directed towards option 2070c, corresponding to a three-dimensional style, such as detecting with contact 2012 (e.g., a tap or long press input). In response to detecting the input, the electronic device 500 re-generates the automatically-generated visual content (e.g., including regenerating representation 2024d) to include the three-dimensional style. In some embodiments, three-dimensional styles are described in greater detail in method 2100 and 2700. The menu 2074 also includes selectable option 2072b and 2072c. In some embodiments, in response to receiving an input including contact 2012 (e.g., a tap or long press input) directed towards option 2072b, the electronic device 500 displays a media library so that a user can select a photo to be used to generate the subject. In some embodiments, option 2072b includes one or more characteristics of option 1626e shown in FIG. 16G. In some embodiments, in response to detecting an input directed towards option 2072c, such as detecting with contact 2012 (e.g., a tap or long press input), the electronic device 500 displays a user interface of a camera application so that a user can take a photo to be used as the subject. In some embodiments, option 2072c includes one or more characteristics to option 1626e shown in FIG. 16G.

FIG. 20AA illustrates a plurality of inputs. In some embodiments, the inputs are detected independently from each other. In some embodiments, the electronic device 500 detects only one of the inputs illustrated in FIG. 20AA. In some embodiments, the electronic device 500 detects the inputs concurrently.

FIG. 21 illustrates a flow diagram illustrating a method in which an electronic device displays prompt component suggestions and generates an automatically-generated visual content in accordance with some embodiments of the disclosure. The method 2100 is optionally performed at first electronic device and/or electronic devices such as device 100, device 300, or device 500 as described above with reference to FIGS. 1A-1B, 2-3, 4A-4B and 5A-5H. Some operations in method 2100 are, optionally combined and/or order of some operations is, optionally, changed.

As described below, the method 2100 provides ways in which an electronic device displays prompt component suggestions and generated an automatically-generated visual content. Suggesting prompt components based on previously presented content and/or device context allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, method 2100 is performed at an electronic device in communication with one or more display generation components and one or more input devices, such as electronic device 500 shown in FIG. 20A. In some embodiments, the electronic device has one or more characteristics of the electronic device described in one or more methods above including method 700. In some embodiments, the one or more display generation component has one or more characteristics of the one or more display generation component described in one or more methods above including method 700. In some embodiments, the one or more input devices has one or more characteristics of the one or more input devices described in one or more methods above including method 700.

In some embodiments, the electronic device detects (2102a), via the one or more input devices, a first input corresponding to a request to display a user interface for detecting a prompt for use in generating automatically-generated visual media (e.g., automatically-generated visual media is described in greater detail in methods 700, 800, 1000, 1200, 1400, 1500, 1700, 1900, and/or 2100), such as input including contact 2012 (e.g., a tap or long press input) directed towards option 2010i shown in FIG. 20B. In some embodiments, the user interface for detecting the prompt is a user interface of the automatically-generated visual media application, described in greater detail in methods 700, 800, 1000, 1200, 1400, 1500, 1700, and/or 1900. In some embodiments, the user interface for detecting the prompt has one or more characteristics of the user interface used to receive the prompt described in method 700. In some embodiments, the first input is a selection input, such as a tap, a gaze, and/or a click using a mouse/trackpad directed towards a selectable option (e.g., a virtual or physical button) that when selected, causes the electronic device to display the user interface of the automatically-generated visual media application. In some embodiments, the first input is a voice input.

In some embodiments, in response to detecting the input to display the user interface for detecting the prompt (2102b), in accordance with a determination that the electronic device is in a first context, such as the context based on the messaging conversation in FIG. 20A, the electronic device displays (2102c), via the one or more display generation components, one or more visual indications of a first set of one or more prompt component suggestions (e.g., prompt components suggestions are suggestions for recognized concepts (described in greater detail in method 700 and 800) that could be selected as prompt components to be used to influence the generation of an automatically-generated visual content), such as prompt component suggestions 2016a through 2016h shown in FIG. 20D. In some embodiments, the electronic device determines context based on previous activity on the electronic device, previous activity on another electronic device associated with the user account associated with the electronic device, and/or based on text provided (e.g., typed, spoken and/or selected) into a prompt insertion field (e.g., the content entry field for inputting a prompt described in greater detail in method 700). In some embodiments, the one or more prompt component suggestions are based on activity in an application other than the automatically-generated visual media application which includes the user interface for inserting the prompt, as described in greater detail below. For example, if the electronic device previously displayed a messaging user interface with a messaging conversation between a contact of the electronic device and the user of the electronic device, the electronic device uses content from the messaging conversation to determine the first context. In some embodiments, the one or more prompt component suggestions are based on the topic(s) of the messaging conversation. For example, if the messaging conversation was about surfing in Big Sur, then the first set of one or more prompt component suggestions optionally include the contact, beach, surfing, and/or other prompt components related to the messaging conversation. In some embodiments, the messaging user interface and messaging conversations are described in greater detail in methods 1000 and/or 1200.

In some embodiments, in response to detecting the input to display the user interface for detecting the prompt (2102b), in accordance with a determination that the electronic device is in a second context, different from the first context, such as the context based on the web browser user interface 2028 shown in FIG. 20I, the electronic device displays (2012d), via the display generation component, one or more visual indications of a second set of one or more prompt component suggestions, different from the first set of one or more prompt component suggestions, such as prompt component suggestions 2016q through 2016x, shown in FIG. 20K. In some embodiments, the second context is associated with the electronic device presenting a user interface of a third application, different from the second application of the first context and different from the automatically-generated visual media application, prior to presenting the user interface for inserting the prompt. In some embodiments, the second context is associated with using the second application to interact with content related to a second topic different from a first topic the electronic device used the second application to interact with in the first context. In some embodiments, the electronic device was previously displaying messaging user interface of a second messaging conversation. In some embodiments, the electronic device displays one or more second visual indication of a second set of one or more prompt component suggestions relating to the content of the second messaging conversation. In some embodiments, the electronic device is in a second context when the electronic device was previously displaying a user interface of a third application, different than the messaging application and/or the automatically-generated visual media application. For example, the electronic device displays one or more second visual indication of a second set of one or more prompt components relating to recently played music if the electronic device was previously displaying a user interface of a music application. In some embodiments, if the electronic device was not previously displaying other content, then the second context optionally includes displaying one or more second visual indication of recently used and/or commonly used sets of prompt components. In some embodiments, after the electronic device detects one or more inputs (e.g., selection inputs as described above and with reference to methods 700, 800, 1000, and/or 1200) directed towards selecting (e.g., adding) one or more prompt component, including prompt component suggestions, to be used to influence the generation of an automatically-generated visual content. In some embodiments, prompt component suggestions are recognized concept suggestions. For example, when selected, a prompt component suggestion is added as a recognized concept to be used to influence the generation of an automatically-generated visual content. In some embodiments, the electronic device uses the one or more recognized concepts to generate an automatically-generated visual content, as described in greater detail in methods 700 and/or 800. In some embodiments, as described in methods 700 and/or 800, the electronic device uses artificial intelligence and/or machine learning to generate an automatically-generated visual content using the one or more recognized concepts. Suggesting prompt components based on previously presented content and/or device context allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, displaying the user interface for detecting the prompt for use in creating automatically-generated visual media includes displaying, via the one or more display generation components, a keyboard user interface element including a keyboard and a content entry field in the user interface for detecting the prompt for use in creating automatically-generated visual media, such as keyboard 2037 and content entry field 20s0d, shown in FIG. 20M. In some embodiments, the keyboard user interface element includes a soft keyboard for receiving one or more inputs to type text to add to the content entry field. In some embodiments, the electronic device receives content (e.g., images and/or videos from a media library and/or a camera application) in the content entry field to be used as the prompt. In some embodiments, the electronic device does not display the keyboard if the electronic device includes a physical keyboard in communication with the electronic device. In some embodiments, the electronic device is able to receive one or more typing inputs from a physical keyboard in communication with the electronic device. Displaying a keyboard user interface while displaying the user interface for detecting the prompt for use in creating the automatically-generated visual media allows the user to easily and efficiently enter prompts and/or prompt components, thereby reducing the number of inputs needed to add a prompt and/or prompt component.

In some embodiments, displaying, via the display generation component, the one or more visual indications of the first set of the one or more prompt component suggestions includes displaying the first set of the one or more prompt components suggestions in the keyboard user interface element, such as prompt component suggestions 2034a through 2034c shown in FIG. 20M. In some embodiments, displaying, via the display generation component, the one or more visual indications of the second set of one or more prompt component suggestions includes displaying the second set of the one or more prompt components suggestions in the keyboard user interface element, such as prompt component suggestions 2034d through 2034f, shown in FIG. 20O. In some embodiments, the one or more visual indications of the respective set of one or more prompt components include text and/or images (e.g., emojis or icons) corresponding to the associated prompt component. In some embodiments, the one or more visual indications changes as the electronic device receives inputs to the keyboard to add prompt components. In some embodiments, the one or more visual indications are displayed above the keyboard as text autocomplete and/or autocorrect suggestions, as described in greater detail below. In some embodiments, the one or more visual indications are selectable to be added as a recognized concept to be used to influence the generation of the automatically-generated visual content, as described in greater detail in methods 700 and 800. Displaying a keyboard user interface including the respective set of one or more suggested prompt components allows the user to easily and efficiently view and select suggested prompt components, thereby reducing the number of inputs needed to add a prompt and/or prompt component.

In some embodiments, displaying, via the one or more display generation components, the one or more visual indications of the first set of the one or more prompt component suggestions includes displaying the first set of the one or more prompt components in a prompt component suggestion region near (e.g., at a predefined position and/or orientation relative to) the content entry field, such as prompt component suggestions 2016q through 2016x displayed near content entry field 2020d shown in FIG. 20L. In some embodiments, the prompt component suggestion region is part of the keyboard user interface element, as described above, and in some embodiments, the prompt component suggestion region is displayed without the keyboard. In some embodiments, the prompt component suggestions is displayed below the content entry field and above the keyboard. In some embodiments, the prompt component suggestions are displayed in the content entry field. In some embodiments, the prompt component suggestions are displayed above the content entry field. In some embodiments, the prompt component suggestion region displays predicted language (e.g., text that is related to the respective context and text that not related to the respective context) text suggestions (e.g., autocomplete and/or autocorrect text) that is able to be selected and entered into the content entry field. For example, the predicted language text suggestions includes autocomplete and/or autocorrect text relating to the respective context that the device is in. In some embodiments, the predicted language text suggestions includes frequently used text.

In some embodiments, displaying, via the display generation component, the one or more visual indications of the second set of one or more prompt component suggestions includes displaying the second set of the one or more prompt components in the prompt component suggestion region near (e.g., at the predefined position and/or orientation relative to) the content entry field, such as prompt component suggestions 2034a through 2034c near content entry field 2020d shown in FIG. 20M. In some embodiments, the one or more visual indications of the respective set of one or more prompt component suggestions include text and/or images representing the respective prompt component suggestion. In some embodiments, the one or more visual indications, as described above, when selected, cause the electronic device to add the associated respective prompt component as a prompt component to be used to influence the generation of the automatically-generated visual content. In some embodiments, the prompt component suggestions and the respective visual indications change and/or update as the electronic device adds recognized concepts to be used to influence the generation of the automatically-generated visual content. Displaying a keyboard user interface including the respective set of one or more suggested prompt components allows the user to easily and efficiently view and select suggested prompt components, thereby reducing the number of inputs needed to add a prompt and/or prompt component.

In some embodiments, while displaying one or more visual indications of a respective set of one or more prompt component suggestions (e.g., the first or second set of prompt component suggestions or a third set of prompt component suggestions different form the first or second set) and while the electronic device is in a respective context (e.g., the first or second context, or a third context different than the first or second context), the electronic device detects, via the one or more input devices, one or more second inputs corresponding to a request to add text to the content entry field, such as an input including contact 2012 (e.g., a tap or long press input) shown in FIG. 20M. In some embodiments, the one or more second inputs are directed towards the keys on the keyboard in the keyboard user interface element. In some embodiments, the one or more second inputs are inputs directed towards a physical keyboard to add text. In some embodiments, the one or more second inputs include voice inputs to add text. In some embodiments, the sequence of one or more inputs include a keyboard input (e.g., a tap input, air gesture, a click input, and/or a gaze input) while attention (e.g., based on a cursor, a touch input, a direct air gesture, gaze, or a substitute for gaze) is directed toward the keyboard.

In some embodiments, in response to detecting the one or more inputs, the electronic device adds the text to the content entry field in accordance with the one or more second inputs, such as the content entry field 2020d including the text “mountains” shown in FIG. 20N. In some embodiments, the electronic device displays the text in the content entry field. In some embodiments, the electronic device changes the respective context of the electronic device from the respective context to a third context. In some embodiments, the third context is associated with the content of the text entered to the content entry field with the one or more second inputs. In some embodiments, the third context is also associated with one or more previously-used applications and/or user interfaces, as described with reference to the first context and the second context.

In some embodiments, in response to detecting the one or more inputs, the electronic device ceases displaying one or more visual indications of the respective set of one or more prompt component suggestions, such as no longer displaying suggestion 2034b, shown in FIG. 20N. In some embodiments, the electronic device ceases displaying one or more visual indications of prompt component suggestions associated with the previous context. For example, if the electronic device was in the first context before receiving the one or more second inputs, then the electronic device ceases displaying one or more visual indications of the first set of one or more prompt suggestions. For example, if the electronic device was in the second context before receiving the one or more second inputs, then the electronic device ceases displaying one or more visual indications of the second set of one or more prompt suggestions. In some embodiments, the electronic device does not cease displaying one or more visual indications of the respective set of one or more prompt component suggestions, such as one or more visual indications of the respective set of one or more prompt component suggestions that correspond to the previous context and to the third context. In some embodiments, the electronic device ceases displaying a portion of the one or more visual indications. In some embodiments, the respective set of one or more prompt component suggestions optionally on longer correspond to the context of the electronic device because of the added text.

In some embodiments, the electronic device displays, via the one or more display generation components, one or more visual indications of a third set of one or more prompt component suggestions corresponding to the added text in the content entry field, such as displaying suggestions 2034d through 2034f after adding text ‘raining meatballs” shown in FIG. 20O. In some embodiments, the one or more visual indications of the third set of one or more prompt component suggestions are associated with the third context. In some embodiments, the electronic device displays the one or more visual indications of the third set of one or more prompt component suggestions along with the one or more visual indication of the respective set of one or more prompt component suggestions. In some embodiments, if the electronic device updates prompt by including one or more prompt component suggestions from the respective context, then displaying the third set of one or more prompt component suggestions includes displaying prompt component suggestions that relate to the prompt component suggestions that were added to the prompt. Updating prompt component suggestions based on the text in the content entry field allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, in response to detecting the one or more inputs, in accordance with a determination that the text corresponds to recognized concept, the electronic device replaces the text with a representation of the recognized concept in the content entry field, such as if the electronic device replaces the text “mountain” with the icon shown on indication 2020h, shown in FIG. 20N. In some embodiments, recognized concepts are described in greater detail in methods 700 and 800. In some embodiments, recognized concepts are from a predetermined list of recognized concepts stored on the electronic device, or on a storage device in communication with the electronic device. In some embodiments, the automatically-generated visual media application is able to access the predetermined list of recognized concepts. In some embodiments, the representation of the recognized concept is text. In some embodiments, replacing the text with the representation of the recognized concept does not include changing the text (e.g., if the text corresponds to the recognized concept). In some embodiments, replacing the text with the representation of the recognized concept includes changing one or more visual characteristics of the text (e.g., bolding, color, underlining, and/or highlighting). In some embodiments, the representation of the recognized concept is an image (e.g., an icon) representing the prompt component/text. Replacing text with a representation of the recognized concept allows the user to easily and efficiently view recognized concepts to be used to influence the generation of an automatically-generated visual content, thereby reducing the number of inputs needed to generate automatically-generated visual media and reducing erroneous inputs to the electronic device.

In some embodiments, in response to detecting the one or more inputs, in accordance with a determination that the text corresponds to a recognized concept, the electronic device displays, via the one or more display generation components, a graphical representation of the recognized concept in the content entry field, such as the icon of indication 2020h, shown in FIG. 20N. In some embodiments, recognized concepts are described in greater detail in methods 700 and 800. In some embodiments, the graphical representation of the recognized concept is displayed alongside the text and/or the representation of the recognized concept, described above. In some embodiments, the graphical representation is an image (e.g., an icon) representing the respective recognized concept. In some embodiments, the graphical representation is automatically selected (e.g., chosen by the application not by the user) based on the text corresponding to a recognized concept. In some embodiments, a respective recognized concept is associated with a respective graphical representation. Displaying a graphical representation of a recognized concept when the electronic device detects that the text corresponding to a prompt component is a recognized concept allows the user to easily and efficiently view recognized concepts to be used to influence the generation of an automatically-generated visual content, thereby reducing the number of inputs needed to generate automatically-generated visual media and reducing erroneous inputs to the electronic device.

In some embodiments, after adding the text to the content entry field, the electronic device detects, via the one or more input devices, a third input corresponding to a request to add the text as a prompt component to be used to influence generation of an automatically-generated visual content, such as the input including contact 2020 (e.g., a tap or long press input) directed towards option 2020g, shown in FIG. 20N. In some embodiments, the third input is directed towards an option to add text as a prompt component. In some embodiments, the third input is a selection input (e.g., a tap input, air gesture, a click input, and/or a gaze input) while attention (e.g., based on a cursor, a touch input, a direct air gesture, gaze, or a substitute for gaze) is directed toward the option to add text. In some embodiments, the third input is a voice input requesting the addition of the text as a prompt component.

In some embodiments, in response to detecting the third input, in accordance with a determination that the text corresponds to a recognized concept, the electronic device displays, via the display generation component, an indication of the recognized concept in an automatically-generated visual media user interface and using the recognized concept to influence the generation of the automatically-generated visual content, such as displaying recognized concept 2022c, shown in FIG. 20O, that corresponds to the text “mountains” shown in FIG. 20N. In some embodiments, displaying an indication of the recognized concept is described in greater detail in methods 700 and 800. In some embodiments, displaying an indication of the recognized concept includes displaying images corresponding to the recognized concept. In some embodiments, the electronic device does not display text corresponding to the recognized concept. In some embodiments, the indication of the recognized concept is displayed in the automatically-generated visual media user interface (e.g., part of the user interface for detecting the prompt, as described above). In some embodiments, the automatically-generated visual media user interface includes one or more recognized concepts and/or other prompt component to be used to influence the generation of the automatically-generated visual content.

In some embodiments, in response to detecting the third input, in accordance with a determination that the text does not correspond to a recognized concept, the electronic device displays, via the display generation component, an indication of the text as an indication of a prompt component in the automatically-generated visual media user interface and using the prompt component to influence the generation of the automatically-generated visual content, such as displaying prompt component 2022d, shown in FIG. 20P, that corresponds to the text “raining meatballs”, shown in FIG. 20O, which is not a recognized concept. In some embodiments, the text does not correspond to a known concept in a database of recognized concepts. In some embodiments, the database of recognized concepts is described in greater detail in method 700. In some embodiments, the indication of the prompt component includes text representing the prompt component. In some embodiments, the indication of the prompt component is displayed in conjunction with indications of recognized concepts in the automatically-generated visual media user interface. In some embodiments, the indications of prompt components do not include graphical representations (e.g., because the text does not correspond to recognized concepts). Displaying an indication of a recognized concept when the electronic device detects that the text corresponding to a prompt component is a recognized concept and displaying an indication of text when the electronic device detects that the text does not correspond to a recognized concept allows the user to easily and efficiently view prompt components to be used to influence the generation of an automatically-generated visual content, thereby reducing the number of inputs needed to generate automatically-generated visual media and reducing erroneous inputs to the electronic device.

In some embodiments, displaying the user interface for detecting the prompt for use in creating automatically-generated visual media includes displaying a set of prompt editing options, such as the deletions options on the respective concepts 2022a through 2020c and component 2022d, option 2020a to add prompt components, and options 2020b and 2020c to change the style and subject prompt components, shown in FIG. 20P. In some embodiments, the prompt editing options include options to add, delete, and/or modify the prompt and/or a portion of the prompt (e.g., a recognized concept and/or a prompt component).

In some embodiments, while the prompt is a respective prompt, the electronic device detects, via the one or more input devices, a sequence of one or more inputs including an input directed towards a first prompt editing option of the set of prompt editing options, such as an input (e.g., a tap or a long press input) including contact 2012 directed towards option 2020b shown in FIG. 20P, and an input (e.g., a tap or a long press input) including contact 2012 directed towards option 2044e, shown in FIG. 20S. In some embodiments, the sequence of one or more inputs include a selection input (e.g., a tap input, air gesture, a click input, and/or a gaze input) while attention (e.g., based on a cursor, a touch input, a direct air gesture, gaze, or a substitute for gaze) is directed toward the first prompt editing option. In some embodiments, the sequence of one or more inputs includes a voice input requesting the selection of the first prompt editing option.

In some embodiments, in response to detecting the sequence of one or more inputs, the electronic device updates the respective prompt in accordance with the first prompt editing option, such as updating the subject from “Jack” to “Ava”, as shown in FIG. 20U. In some embodiments, editing prompts, recognized concepts, and/or prompt components is described in greater detail in method 700 and 800. In some embodiments, updating the respective prompt includes updating the one or more recognized concepts and/or prompt components associated with the prompt (e.g., deleting, adding, or modifying). In some embodiments, updating the respective prompt also includes updating a representation of the automatically-generated visual content, described in greater detail in methods 700 and 800, and below. Additionally, in some embodiments, updating the respective prompt also includes changing the automatically-generated visual content that is generated in response to the electronic device receiving in input requesting to generate the automatically-generated visual content. Including a set of prompt editing options in the user interface for detecting the prompt allows the user to easily and efficiently edit prompt components thereby reducing the number of inputs needed to generate automatically-generated visual media and reducing erroneous inputs to the electronic device. In some embodiments, the set of prompt editing options includes a keyboard invocation option, such as option 2020a, shown in FIG. 20K.

In some embodiments, the electronic device detects, via the one or more input devices, a second input selecting the keyboard invocation option, such as input including contact 2012 directed towards option 2020a, shown in FIG. 20K. In some embodiments, the second input is selection input (e.g., a tap input, air gesture, a click input, and/or a gaze input) while attention (e.g., based on a cursor, a touch input, a direct air gesture, gaze, or a substitute for gaze) is directed toward the keyboard invocation option. In some embodiments, the second input is a voice input requesting the selection of the keyboard invocation option.

In some embodiments, in response to detecting the second input, the electronic device displays, via the one or more display generation components, a keyboard user interface element on the user interface for detecting the prompt, such as content entry field 2020d, shown in FIG. 20L. In some embodiments, the keyboard user interface element has one or more characteristics of the keyboard user interface element described above. In some embodiments, after displaying the keyboard user interface element, the electronic device is able to receive one or more inputs directed towards the keyboard of the keyboard user interface element to add additional prompt components and/or recognized concepts to be used to generate an automatically-generated visual content. Including a keyboard invocation option in the user interface for detecting the prompt allows the user to easily and efficiently displaying the keyboard user interface element to edit prompt components thereby reducing the number of inputs needed to generate automatically-generated visual media and reducing erroneous inputs to the electronic device. In some embodiments, the set of prompt editing options includes a subject selection option, such as option 2020b, shown in FIG. 20P.

In some embodiments, the electronic device detects, via the one or more input devices, a second input selecting the subject selection option, such as input (e.g., a tap or a long press input) including contact 2012 directed towards option 2020b, shown in FIG. 20P. In some embodiments, the second input is selection input (e.g., a tap input, air gesture, a click input, and/or a gaze input) while attention (e.g., based on a cursor, a touch input, a direct air gesture, gaze, or a substitute for gaze) is directed toward the subject selection option. In some embodiments, the second input is a voice input requesting the selection of the subject selection option.

In some embodiments, in response to detecting the second input, the electronic device displays, via the one or more display generation components, a subject selection user interface for detecting a candidate subject for use in creating the automatically-generated visual media, such as user interface 2036, shown in FIG. 20Q. In some embodiments, the subject selection user interface is overlaid over the user interface for detecting the prompt. In some embodiments, the subject selection user interface has one or more selectable options of different candidate subjects (e.g., different people, animals, and/or objects), described in greater detail below. In some embodiments, while displaying the subject selection user interface, the electronic device is able to receive one or more inputs to select a candidate subject to be used to influence the generation of the automatically-generated visual content. In some embodiments, additional disclosure about selecting a candidate subject is described in method(s) 700, 800, 1000, 1200, and/or 2300. In some embodiments, the candidate subject has one or more characteristics of the reference media item described in methods 1000 and 1200. In some embodiments, the subject selection user interface includes one or more options that, when selected, cause the electronic device to create a new candidate subject and/or edit an existing candidate subject, as described below with reference to method 2300. Including a subject selection option in the user interface for detecting the prompt allows the user to easily and efficiently edit and/or add a candidate subject for the automatically-generated visual content thereby reducing the number of inputs needed to generate automatically-generated visual media and reducing erroneous inputs to the electronic device.

In some embodiments, displaying the subject selection user interface includes in accordance with a determination that the electronic device is in the first context, displaying, via the one or more display generation components, one or more selectable options of a first set of candidate subjects in the subject selection user interface, such as representations 2044d through 2044i, shown in FIG. 20Q. In some embodiments, while in the first context, the electronic device was previously communicating with and/or presenting media depicting a first set of subjects.

In some embodiments, displaying the subject selection user interface includes in accordance with a determination that the electronic device is in the second context, displaying, via the one or more display generation components, one or more selectable options of a second set of candidate subjects in the subject selection user interface, wherein the second set of candidate subjects is different from the first set of candidate subjects (e.g., the first set of candidate subjects includes at least one candidate subject that is not included in the second set of candidate subjects and/or the second set of candidate subjects includes at least one candidate subject that is not included in the first set of candidate subjects), such as if the representations 2044d through 2044i shown in FIG. 20Q represented different candidate subjects. In some embodiments, while in the second context, the electronic device was previously communicating with and/or presenting media depicting a second set of candidate subjects. In some embodiments, the electronic device displays one or more selectable options of a respective set of candidate subjects that is contextually relevant. For example, while in the first context, a first set of candidate subjects is contextually relevant and while in the second context, a second set of candidate subjects is contextually relevant. In some embodiments, the candidate subjects are contextually relevant based on previous activities of the electronic device such as candidate subjects with which the device was communicating with using the previous application and/or candidate subjects depicted in media that the device was previously presenting. For example, while in the first context, the electronic device was previously displaying a messaging user interface of a messaging conversation between the user and a second user, and the second user is a contextually relevant candidate subject. In some embodiments, the electronic device receives an input to select a first candidate subject in a respective set of candidate subjects. In some embodiments, as a result, the electronic device uses the first candidate subject to influence the generation of an automatically-generated visual content. Including one or more selectable options of contextually relevant candidate subjects allows the user to easily and efficiently choose a relevant candidate subject for the automatically-generated visual content thereby reducing the number of inputs needed to generate automatically-generated visual media and reducing erroneous inputs to the electronic device.

In some embodiments, displaying the subject selection user interface includes displaying one or more selectable options of a set of previously used candidate subjects, such as if the representations 2044d through 2044i shown in FIG. 20Q represented previously used candidate subjects. In some embodiments, previously used subjects are subjects that have been previously used to influence the generation of an automatically-generated visual content. In some embodiments, the electronic device displays selectable options of candidate subjects that were recently used (e.g., subjects of previously generated automatically-generated visual content). In some embodiments, recently used includes candidate subjects that were used in the last 5 minutes, last 30 minutes, last hour, last day, last week, or last month. In some embodiments, recently used includes the last 1-20 subjects that were used to generate an automatically-generated visual content. In some embodiments, previously generated automatically-generated visual content are described in greater detail in method 800. In some embodiments, the electronic device displays selectable options of candidate subjects that have been used more often before the candidate subjects that have been used less often. In some embodiments, the electronic device receives an input to select a first candidate subject in the set of previously used candidate subjects. In some embodiments, as a result, the electronic device uses the first candidate subject to influence the generation of an automatically-generated visual content. Including one or more selectable options of recently used candidate subjects allows the user to easily and efficiently choose a relevant candidate subject for the automatically-generated visual content thereby reducing the number of inputs needed to generate automatically-generated visual media and reducing erroneous inputs to the electronic device.

In some embodiments, displaying the subject selection user interface includes displaying an option to capture a media item of a new subject (e.g., using a camera application), such as option 2044b, shown in FIG. 20Q

In some embodiments, the electronic device detects, via the one or more input devices, a second input selecting the option, such as if the electronic device detects an input (e.g., a tap or a long press input) including contact 2012 directed towards option 2044b, shown in FIG. 20Q. In some embodiments, the second input is a selection input (e.g., a tap input, air gesture, a click input, and/or a gaze input) while attention (e.g., based on a cursor, a touch input, a direct air gesture, gaze, or a substitute for gaze) is directed toward the option. In some embodiments, the second input is a voice input requesting the selection of the option and/or requesting to capture a media item of a new subject.

In some embodiments, in response to detecting the second input, the electronic device displays, via the one or more display generation component, on the subject selection user interface, a user interface of the camera application including a live preview of a media item of a physical environment of the electronic device, such as if the electronic device 500 displays a user interface 1104, shown in FIG. 11C after receiving the input directed towards option 2044b shown in FIG. 20Q. In some embodiments, the user interface of the camera application is described in greater detail in methods 1000 and 1200. In some embodiments, the user interface of the camera application includes one or more options to take a picture and/or video of the physical environment shown in the live preview of the physical environment included in the user interface of the camera application. In some embodiments, the user interface of the camera application includes the live preview of the physical environment, an option that is selectable to capture an image and/or video of what is being previewed in the live preview. In some embodiments, the electronic device displays the user interface of the camera application while running the automatically-generated visual media application (e.g., the user interface of the camera application is overlaid over the subject selection user interface).

In some embodiments, while displaying the user interface of the camera application, the electronic device detects, via the one or more input devices, one or more inputs corresponding to a request to capture a media item using the camera application for use as a candidate subject, such as receiving an input directed towards option 1110 shown in FIG. 11C In some embodiments, the one or more inputs includes a selection input (e.g., a tap input, air gesture, a click input, and/or a gaze input) directed towards an option that when selected takes a picture and/or video of the physical environment shown in the live preview. In some embodiments, the one or more inputs includes a voice input requesting to capture the media item.

In some embodiments, in response to detecting the one or more inputs corresponding to the request to capture the media item using the camera application, the electronic device captures the image using the camera application and using the media item as the candidate subject in generating the automatically-generated visual media, such as if the electronic device uses representation 1108, shown in FIG. 11D as the candidate subject. In some embodiments, after capturing the image and/or video, the user interface includes one or more selectable options to edit the image and/or video and to use the image and/or video as the subject in an automatically-generated visual content. In some embodiments, using the media item as the subject is described in more detail in methods 1000 and 1200 (e.g., using the captured image and/or video as the reference media item). In some embodiments, the media item is used to influence the generation of an automatically-generated visual content. Displaying a user interface of a camera application for a user to capture an image to be used as the subject without opening the camera application and/or navigating away from the subject suggestion user interface reduces the number of inputs needed to select candidate subjects. In some embodiments, displaying the subject selection user interface includes displaying an option to display a media library to select a candidate subject, such as option 2044c, shown in FIG. 20Q.

In some embodiments, the electronic device detects, via the one or more input devices, a second input selecting the option, such as if the electronic device 500 receives an input (e.g., a tap or a long press input) including contact 2012 directed towards option 2044c, shown in FIG. 20Q. In some embodiments, the second input is a selection input (e.g., a tap input, air gesture, a click input, and/or a gaze input) while attention (e.g., based on a cursor, a touch input, a direct air gesture, gaze, or a substitute for gaze) is directed towards an option in the subject selection user interface that is selectable to display the media library. In some embodiments, the media library is described in greater detail in methods 800, 1000, and 1200.

In some embodiments, in response to detecting the second input, the electronic device displays, via the one or more display generation components, in the subject selection user interface, a representation of the media library (optionally in the subject selection user interface), such as if the electronic device 500 displays a media library in FIG. 20Q. In some embodiments, the media library is an image (e.g., photo) and/or video library. In some embodiments, the media library includes image(s) (e.g., photo(s)) and/or video(s) of people, objects, or environments (e.g., of animals, people, or scenery). In some embodiments, the media library includes automatically-generative visual content and non-generative visual content. In some embodiments, the media library is overlaid over the subject selection user interface.

In some embodiments, while displaying the media library, the electronic device detects, via the one or more input devices, one or more inputs corresponding to a request to select a respective media item from a plurality of media items in the media library as the candidate subject, such as if the electronic device receives an input to select a media item from the media library, as described in greater detail in FIGS. 9Q-9V. In some embodiments, the one or more inputs includes a selection input (e.g., a tap input, air gesture, a click input, and/or a gaze input) directed towards a representation of a respective media item. In some embodiments, the one or more inputs includes a voice input requesting to select a respective media item.

In some embodiments, in response to detecting the one or more inputs corresponding to the request to select the respective media item, the electronic device uses the respective media item as the candidate subject in generating the automatically-generated visual media, such as if the electronic device 500 uses the media item as the candidate subject (e.g., in place of “Jack” shown in FIG. 20P) to generate the automatically-generated visual content. In some embodiments, the respective set of one or more inputs has one or more characteristics of the inputs described above. In some embodiments, the respective set of one or more inputs includes tap inputs, gaze inputs, and/or voice command inputs. In some embodiments, respective set of one or more inputs is directed towards a representation of the respective media item displayed in the media library. In some embodiments, after selecting the respective media item, the electronic device displays the generative visual media creation user interface, described above in method 1000. Displaying a media library for a user to select a media item as the subject without opening the media library and/or navigating away from the subject suggestion user interface reduces the number of inputs needed to select candidate subjects. In some embodiments, the set of prompt editing options includes a style selection option, such as option 2020c, shown in FIG. 20U.

In some embodiments, the electronic device detects, via the one or more input devices, a second input selecting the style selection option, such as an input (e.g., a tap or a long press input) including contact 2012 directed towards option 2020c, shown in FIG. 20U. In some embodiments, the second input is a selection input (e.g., a tap input, air gesture, a click input, and/or a gaze input) while attention (e.g., based on a cursor, a touch input, a direct air gesture, gaze, or a substitute for gaze) is directed toward the style selection option. In some embodiments, the second input is a voice input requesting the selection of the style selection option.

In some embodiments, in response to detecting the second input, the electronic device displays, via the one or more display generation components, a style selection user interface including one or more selectable options corresponding to different styles, such as representations 2056a through 2056i, shown in FIG. 20V. In some embodiments, the style selection user interface is overlaid over the user interface for detecting the prompt. In some embodiments, the style selection user interface has one or more selectable options of different styles (e.g., styles to generate the automatically-generated visual content with). Styles are described in greater detail in method 700. In some embodiments, while displaying the style selection user interface, the electronic device is able to receive one or more inputs to select a style to be used to influence the generation of the automatically-generated visual content. Including a style selection option in the user interface for detecting the prompt allows the user to easily and efficiently display the style selection user interface thereby reducing the number of inputs needed to generate automatically-generated visual media and reducing erroneous inputs to the electronic device.

In some embodiments, prior to detecting a third input (e.g., described in greater detail below) corresponding to a request to select a respective style, automatically selecting a first style to be used to influence the generation of an automatically-generated visual content, such as the electronic device automatically selecting “animation” as the style in FIG. 20P. In some embodiments, the electronic device automatically selects the last used style (e.g., the last style used to generate an automatically-generated visual content). In some embodiments, the electronic device automatically selects a frequently used style (e.g., the most frequently used style to generate an automatically-generated visual media with). In some embodiments, the automatically-generated visual content cannot be generated without a designated style. In some embodiments, style options are described in greater detail in method 700. Automatically selecting a first style reduces the number of inputs needed to select a style thereby reducing the number of inputs needed to generate automatically-generated visual media and reducing erroneous inputs to the electronic device.

In some embodiments, the first style was a last-used style to influence the generation of an automatically-generated visual content (e.g., the last used style is the style that was used to generate a previously generated automatically-generated visual content), such as the style shown in FIG. 20P being the last-used style.

In some embodiments, while displaying the style selection user interface, the electronic device detects, via the one or more input devices, the third input corresponding to the request to select a respective style, such as the input (e.g., a tap or a long press input) including contact 2012 directed towards representation 2056a, shown in FIG. 20V. In some embodiments, the third input a selection input (e.g., a tap input, air gesture, a click input, and/or a gaze input) while attention (e.g., based on a cursor, a touch input, a direct air gesture, gaze, or a substitute for gaze) is directed toward an option corresponding to a request to select the respective style. In some embodiments, the second input is a voice input requesting the selection of the respective style.

In some embodiments, in response to detecting the third input corresponding to a request to select a respective style, the electronic device ceases using the first style to influence the generation of the automatically-generated visual content, such as no longer using “animation” as the style shown in FIG. 20X. In some embodiments, the third input is directed towards an option in the style selection user interface (e.g., selectable via tap input, gaze input, and/or voice command input) that corresponds to a respective style. In some embodiments, after detecting the third input, the electronic device ceases using the default style (e.g., the first style as described above) to influence the generation of the automatically-generated visual content.

In some embodiments, in response to detecting the third input corresponding to a request to select a respective style, the electronic device selects the respective style to be used to influence the generation of the automatically-generated visual content, such as using “sketch” as the style shown in FIG. 20X. In some embodiments, the electronic device uses the selected style (e.g., the respective style) from the plurality of styles described in greater detail in method 700, to be used to generate the automatically-generated visual content. Including one or more options for styles allows the user to easily and efficiently view and select a style to replace the default style, thereby reducing the number of inputs needed to add a prompt and/or prompt component.

In some embodiments, the one or more selectable options corresponding to different styles includes a selectable option corresponding to a three-dimensional style, such as if FIG. 20V includes a style option corresponding to option 2070c, shown in FIG. 20AA. In some embodiments, the three-dimensional style is a style that causes the electronic device to generate the automatically-generated visual media item as a three-dimensional object and/or display the automatically-generated visual media item in three-dimensions. In some embodiments, the three-dimensional style has one or more characteristics of the three-dimensional representation described in greater detail in method 700.

In some embodiments, while displaying the style selection user interface, such as shown in FIG. 20V, the electronic device detects, via the one or more input devices, a third input corresponding to the request to select the selectable option corresponding to the three-dimensional style, such as if the electronic device detects a selection input (e.g., a tap or a long press input) including contact 2012 directed towards option 2070c in FIG. 20V. In some embodiments, the third input is a selection input (e.g., a tap input, air gesture, a click input, and/or a gaze input) while attention (e.g., based on a cursor, a touch input, a direct air gesture, gaze, or a substitute for gaze) is directed toward the selectable option. In some embodiments, the third input is a voice input requesting the selection of the selectable option. The three-dimensional representation can be a true three-dimensional object, an object that has been generated with two or more views that can be viewed concurrently by different eyes to generate the illusion of stereoscopic depth (e.g., by simulating the appearance of a three-dimensional object from multiple viewpoints concurrently), and/or another type of three-dimensional representation. In some embodiments, the three-dimensional representation is a stereoscopic three-dimensional representation and/or a three-dimensional object that is generated using the prompt that is able to be viewed in three-dimensions)

In some embodiments, in response to detecting the third input corresponding to the request to select the selectable option corresponding to the three-dimensional style, the electronic device selects the three-dimensional style to be used to influence the generation of the automatically-generated visual media item, including generating the automatically-generated visual media item as a three-dimensional object (optionally having one or more of the characteristics of generating the three-dimensional automatically-generated visual media item described with reference to method 700), such as if the electronic device 500 generates a three-dimensional representation of representation 2040c, shown in FIG. 20V, that is similar in style to the three-dimensional representation shown in FIG. 6AA′. In some embodiments, the one or more recognized concepts used to influence the generation of the automatically-generated visual media item are used to generate a three-dimensional version of the automatically-generated visual content (e.g., the three-dimensional object). In some embodiments, the three-dimensional object retains one or more (or all) the features (e.g., recognized concepts, styles, and/or subjects) of the automatically-generated visual content. For example, in response to detecting the input, the electronic device displays a three-dimensional version of the two-dimensional representation that was previously displayed. In some embodiments, the electronic device generates the three-dimensional object using the same prompt as the previously generated automatically-generated visual content. Alternatively, in some embodiments, in response to detecting the input, the electronic device generates a new image based on the prompt that is three-dimensional and has a different composition (e.g., a different appearance and/or different automatically-generated elements such as a subject, style, foreground, and/or background) from the previously displayed two-dimensional representation, though still being based on the same prompt. For example, the electronic device generates a different representation of the prompt/recognized concepts using the new style (e.g., the three-dimensional style), as described in greater detail in method 1700. In some embodiments, the subject of the automatically-generated visual media item is generated as a three-dimensional subject. In some embodiments, the three-dimensional object is optionally a virtual environment (e.g., a user is optionally immersed in the generated automatically-generated visual media item). In some embodiments, the electronic device displays and/or generates the three-dimensional object using one or more autonomous processes such as artificial neural networks and/or machine learning models, as described in method 700. In some embodiments, the one or more autonomous processes includes characteristics of the one or more autonomous processes used to generate automatically-generated visual content (e.g., two-dimensional automatically-generated visual content). In some embodiments, the electronic device displays the three-dimensional representation after generating and/or saving the three-dimensional representation. In some embodiments, the three-dimensional representation is displayed using a different electronic device that has three-dimensional display capabilities (e.g., an electronic device with a lenticular display and/or on a head-mounted display). Including a three-dimensional style option allows a user to easily and efficiently generate a three-dimensional object, thereby reducing erroneous inputs to the electronic device.

In some embodiments, displaying the user interface for detecting the prompt for use in creating automatically-generated visual media includes displaying a selectable option for displaying the set of prompt editing options (e.g., a subject selection option and/or a style selection option, which are described above), such as option 2020l, shown in FIG. 20Z.

In some embodiments, while not displaying the set of prompt editing options, the electronic device detects, via the one or more input devices, a second input directed towards the selectable option for displaying the set of prompt editing options, such as detecting contact 2012 (e.g., a tap or long press input), shown in FIG. 20Z. In some embodiments, the selectable option is an option that when selected, causes the electronic device to display a menu of additional options for editing the prompt (e.g., changing the subject, changing the style, and/or changing one or more other components of the prompt such as a recognized concept). In some embodiments, the second input is a selection input (e.g., a tap input, air gesture, a click input, and/or a gaze input) while attention (e.g., based on a cursor, a touch input, a direct air gesture, gaze, or a substitute for gaze) is directed toward the selectable option. In some embodiments, the second input is a voice input requesting the selection of the selectable option.

In some embodiments, in response to detecting the second input, the electronic device displays, via the one or more display generation components, the set of prompt editing options including one or more style selection options or one or more subject selection options (optionally one or more style selection options and one or more subject selection options), such as options 2070a through 2070c and options 2072a and 2072b, shown in FIG. 20AA. In some embodiments, the style selection options include one or more characteristics of the style selection options described above. In some embodiments, the subject selection options include one or more characteristics of the subject selection options as described above. In some embodiments, the subject selection options include an option to take a photo of a subject or choose a photo of a subject. In some embodiments, the set of prompt editing options includes one of a subject option and/or one of a style option. In some embodiments, in response to receiving an input corresponding to the selection of the subject option, the electronic device displays one or more subject selection options (e.g., such as described above). In some embodiments, in response to receiving an input corresponding to the selection of the style option, the electronic device displays one or more style selection options (e.g., such as described above). Including a selectable that, when selected, causes the electronic device to display additional options to change the prompt (e.g., the style or subject) thereby simplifying user device interaction by reducing clutter on the user interface and making use of limited screen space for displaying interactive user interface elements.

In some embodiments, the electronic device is in the first context based on a first prior device activity and the electronic device is in the second context based on a second prior device activity. For example, the electronic device 500 is in the first context shown in FIG. 20D because of the first prior device activity corresponding to the messaging conversation shown in FIG. 20A, and the electronic device 500 is in the second context shown in FIG. 20K, because of the second prior device activity corresponding to the web browsing activity shown in FIG. 20I. In some embodiments, the respective prior device activity includes prior activity with a second application (e.g., messaging application, web browsing application, notes application, content application, music application, or other applications) different than the automatically-generated visual media application. In some embodiments, prior device activity includes activity based on content from the previously used applications (e.g., the second application). In some embodiments, the electronic device changes context when the electronic device closes the automatically-generated visual media application, opens a different application (e.g., the second application), and then reopens the automatically-generated visual media application. In some embodiments, and as described above, the electronic device changes context based on content entered into the content entry field (e.g., the electronic device receives inputs to add one or more prompt components). Suggesting prompt components based on prior device activity allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, the first prior device activity is based on a first previously used application, such as the messaging application shown in FIG. 20A and the second prior device activity is based on a second previously used application, such as the web browsing application shown in FIG. 20I. In some embodiments, the electronic device uses content viewed from previously used applications to determine the context, as described above. In some embodiments, previously used applications are applications used by the electronic device prior to displaying the user interface for detecting the prompt or other user interfaces of the automatically-generated visual media application. In some embodiments, previously used applications are applications that were used in the last 5 minutes, last 30 minutes, last hour, last day, last week, or last month. Suggesting prompt components based on a context based on a respective previously used application allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, the first prior device activity is based on a first previous communication (e.g., with a second user account), such as the messaging conversation with Jack shown in FIG. 20A and the second prior device activity is based on a second previous communication (e.g., with the second user account and/or a third user account different than the second user account), such as the messaging conversation with Jane, shown in FIG. 20G. In some embodiments, communications includes messages (e.g., messaging conversations), phone calls, emails, social media communications (e.g., likes, follows, and/or comments), and other communications. In some embodiments, the second user account is associated with a second electronic device, different than the electronic device. In some embodiments, the second user account is associated with a second user, different than the user of the electronic device. In some embodiments, the electronic device uses content from the previous messaging conversation to determine the context. In some embodiments, previous messaging conversations are messaging conversations from a messaging application previously accessed before the electronic device displays the user interface for detecting the prompt or other user interfaces of the automatically-generated visual media application. In some embodiments, the electronic device suggests one or more subjects based on the respective previous messaging conversation. Suggesting subjects is described in greater detail above. Suggesting prompt components based on a previous messaging conversation allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, the first prior device activity is based on one or more topics of content from a previously used application, such as the one or more messages from the messaging conversation shown in FIG. 20A and the second prior device activity is based on one or more topics of content from a previously used application, such as the one or more search results from the web browser user interface shown in FIG. 20I. In some embodiments, the electronic device uses semantic understanding, artificial intelligence and/or machine learning to summarize one or more topics of content from a previously used application. In some embodiments, the electronic device displays suggested prompt components corresponding to the topics of content in the user interface for detecting the prompt. Suggesting prompt components based on a summary of context from a respective previously used application allows the user to easily and efficiently select relevant prompt components to be used to influence the generation of an automatically-generated visual content, thereby reducing the number of inputs needed to generate automatically-generated visual media and reducing erroneous inputs to the electronic device.

In some embodiments, while displaying the user interface for detecting the prompt for use in generating the automatically-generated visual media, while the prompt is a first prompt (e.g., a first prompt used to influence the generation of the automatically-generated visual content), the electronic device displays, via the one or more display generation components, a representation of the automatically-generated visual content based on the first prompt in a preview region of the first region of the user interface for detecting the prompt, wherein the representation of the automatically-generated visual content is influenced by the prompt, such as representation 2024c, shown in FIG. 20O. In some embodiments, the representation of the automatically-generated visual content is described in greater detail in methods 700, 800, 1000, 1200, 1400, 1500, 1700, and/or 1900. In some embodiments, the representation of the automatically-generated visual content is a low fidelity representation of the automatically-generated visual content. In some embodiments, the representation of the automatically-generated visual content does not include all the features/characteristics that are included in the automatically-generated visual content. For example, the representation of the automatically-generated visual content does not fully encapsulate all the recognized concepts and/or prompt components. In some embodiments, the first region includes a preview region and a prompt region. In some embodiments, the prompt region encompasses the preview region. In some embodiments, the user interface for detecting the prompt also includes a second region. In some embodiments, the second region includes the set of prompt editing options, described in greater detail above.

In some embodiments, while the prompt is the first prompt and while displaying the representation of the automatically-generated visual content based on the first prompt, the electronic device detects, via the one or more input devices, one or more second inputs corresponding to a request to modify one or more prompt components of the first prompt, such as adding the prompt component corresponding to the text “raining meatballs” shown in FIG. 20O. In some embodiments, the sequence of one or more second inputs is a selection input (e.g., a tap input, air gesture, a click input, and/or a gaze input) while attention (e.g., based on a cursor, a touch input, a direct air gesture, gaze, or a substitute for gaze) is directed toward one or more representations of prompt components and/or to a content entry field for receiving one or more prompt components, as described in greater detail above. In some embodiments, the one or more second inputs include one or more inputs directed towards a soft or physical keyboard (e.g., to add a prompt component). In some embodiments, the modifying prompt components (e.g., including recognized concepts) is described in greater detail in methods 700, 800, 1000, 1200, 1400, 1500, 1700, and/or 1900.

In some embodiments, in response to detecting the one or more second inputs, the electronic device updates the first prompt in accordance with the one or more second inputs (e.g., adding, deleting, or modifying one or more prompt components of the first prompt), such as by adding component 2022d, shown in FIG. 20P. The electronic device also displays, via the one or more display generation components, an updated representation of the automatically-generated visual content in accordance with the modifications of one or more prompt components, such as representation 2024d, shown in FIG. 20P. In some embodiments, the updated representation of the automatically-generated visual content is different than the representation of the automatically-generated visual content. In some embodiments, the updated representation of the automatically-generated visual content is based on the one or more modifications of the one or more prompt components. In some embodiments, updating representations of automatically-generated visual content is described in greater detail in methods 700, 800, 1000, 1200, 1400, 1500, 1700, and/or 1900. Updating the representation of the automatically-generated visual content based on modifications of the one or more prompt components allows the user to easily and efficiently visualize the automatically-generated visual content thereby reducing the number of erroneous inputs to the electronic device to generate the automatically-generated visual content.

In some embodiments, while displaying the user interface for detecting the prompt for use in generating the automatically-generated visual media and while displaying one or more visual indications of a respective set of one or more prompt component suggestions, the electronic device displays, via the one or more display generation components, a representation of the automatically-generated visual content based on a first prompt in a preview region of the first region of the user interface for detecting the prompt, wherein the representation of the automatically-generated visual content is influenced by the prompt, and a first visual indication corresponding to a first prompt component of the first prompt, such as the representation 2024c being influenced by recognized concepts 2022a through 2022c, shown in FIG. 20O. In some embodiments, the representation of the automatically-generated visual content is described in greater detail above, and with reference to methods 700, 800, 1000, 1200, 1400, 1500, 1700, and/or 1900. In some embodiments, the first visual indication corresponding to the first prompt component is displayed in the prompt region of the first region. In some embodiments, the first visual indication includes text and/or images corresponding to the first prompt component.

In some embodiments, the electronic device detects, via the one or more input devices, a second input corresponding to a request to add a first prompt component suggestion (e.g., of a respective set of one or more prompt component suggestions based on a respective context) as a second prompt component for use in generating the automatically-generated visual content, such as the input (e.g., a tap or a long press input) including contact 2012 directed towards option 2020g, shown in FIG. 20O. In some embodiments, adding the first prompt component suggestion includes dragging (e.g., using a dragging input) to drag the first prompt component suggestion or a selection input to select the first prompt component suggestion from the respective set of one or more prompt component suggestions (as described above) into the prompt region. In some embodiments, the second input has one or more characteristics of the selection inputs described above. In some embodiments, the selection input (e.g., a tap input, air gesture, a click input, and/or a gaze input) is received while attention (e.g., based on a cursor, a touch input, a direct air gesture, gaze, or a substitute for gaze) is directed toward the first prompt component suggestion. In some embodiments, the second input is a dragging input including a tap and drag and drop motion using a contact or a gaze. In some embodiments, the dragging input is described in greater detail with reference to methods 700 and 800. In some embodiments, second input includes a selection input, such as a tap or a long press with a contact (e.g., a finger, or stylus), selection with an indirect input device (e.g., mouse, remote control, or trackpad) that is directed to a location of a selectable option representing the first prompt component suggestion, or focus indicator such as a cursor or selection ring) and/or a gaze input (optionally as part of an air gesture).

In some embodiments, in response to detecting the second input (e.g., while displaying one or more visual indications of a respective set of one or more prompt component suggestions), the electronic device updates, via the one or more display generation components, the display of the representation of the automatically-generated visual content to a second representation of the automatically-generated visual content, such as updating representation 2024c to 2024d shown in FIG. 20P. In some embodiments, updating the representation of the automatically-generated visual content to the second representation of the automatically-generated visual media is described in greater detail above and with reference to methods 700, 800, 1000, 1200, 1400, 1500, 1700, and/or 1900. In some embodiments, the second representation of the automatically-generated visual content is based on the first prompt component of the first prompt (and other prompt components corresponding to the first prompt) and the second prompt component.

In some embodiments, the electronic device displays, via the one or more display generation components, the first visual indication corresponding to the first prompt component and a second visual indication corresponding to the second prompt component in the prompt region of the first region of the user interface, such as displaying concepts 2022a through 2022c and component 2022d in the prompt region 2017, shown in FIG. 20P. In some embodiments, the first visual indication and the second visual indication include respective text and/or images corresponding to the respective prompt component, as described above, and with reference to methods 700, 800, 1000, 1200, 1400, 1500, 1700, and/or 1900. Displaying the visual indications corresponding to the prompt components in a first region allows the user to easily and efficiently view the prompt components together, thereby reducing erroneous inputs to the electronic device.

In some embodiments, while displaying the first visual indication corresponding to the first prompt component without displaying the second visual indication corresponding to the second prompt component (e.g., prior to detecting the third input corresponding to the request to add the first prompt component suggestion as the second prompt component for use in generating the automatically-generated visual content), the electronic device displays, via the one or more display generation components, a first visual effect with a first value for a first visual characteristic between the first visual indication and the representation of the automatically-generated visual content, such as the visual effect 2026f between concept 2022b and representation 2024c, shown in FIG. 20O. In some embodiments, the first visual effect is a glow effect. In some embodiments, the first value for the glow effect includes a first brightness, a first opacity, a first color, and/or a first position. In some embodiments, the first visual effect surrounds a visual indication (e.g., a representation of a prompt component) and the representation of the automatically-generated visual content. In some embodiments, the first visual effect includes animations. For example, the glow effect changes brightness, opacity, colors, and/or positions within a first range for the first value. In some embodiments, the first visual effect connects the first visual indication and the representation of the automatically-generated visual content. In some embodiments, the first visual effect is not displayed in areas that do not connect the respective elements. In some embodiments, the first visual effect is described in greater detail in methods 1400 and/or 1500.

In some embodiments, in response to detecting the second input, the electronic device displays, via the one or more display generation components, the first visual effect with the first value between the first visual indication, and the second representation of the automatically-generated visual content, and a second visual effect with a second value (e.g., or the first value, as described above) for the first visual characteristic between the second visual indication and the second representation of the automatically-generated visual content, such as visual effect 2026e between the concept 2022a and the representation 2024c, shown in FIG. 20O. In some embodiments, the respective visual indications have a respective value for the second visual effect that is displayed between the respective visual indication and the representation of the automatically-generated visual content. In some embodiments, displaying the second visual effect with the second value includes displaying the glow effect including a second brightness, a second opacity, a second color, and/or a second position different from the first brightness, the first opacity, the first color, and/or the first position. In some embodiments, the second visual effect connects the first visual indication and the second representation of the automatically-generated visual content. In some embodiments, the second visual effect is not displayed in areas that do not connect the respective elements. In some embodiments, the second visual effect is described in greater detail in methods 1400 and/or 1500.

In some embodiments, while displaying the first visual effect with the first value between the first visual indication, and the second representation of the automatically-generated visual content, and the second visual effect with the second value for the first visual characteristic between the second visual indication and the second representation of the automatically-generated visual content, the electronic device detects, via the one or more input devices, a third input corresponding to a request to move the first visual indication from a first location to a second location, different than the first location in the first region of the user interface, such as if the electronic device 500 receives a request to move one or more of concepts 2022a through 2022c in FIG. 20O. In some embodiments, the third input has one or more characteristics of the second input. For example, moving the first visual indication from the first location to the second location is the result of adding a third indication corresponding to a third prompt component to the prompt region. In some embodiments, adding the third indication includes dragging (e.g., using a dragging input) to drag a second prompt component suggestion or a selection input to select the second prompt component suggestion from the respective set of one or more prompt component suggestions (as described above) into the prompt region. In some embodiments, the third input is a dragging input including a tap and drag and drop motion using a contact or a gaze. In some embodiments, third input includes a selection input (e.g., a tap input, air gesture, a click input, and/or a gaze input) while attention (e.g., based on a cursor, a touch input, a direct air gesture, gaze, or a substitute for gaze) is directed toward a location of a selectable option representing the second prompt component suggestion. In some embodiments, the third input is a dragging input to drag the first visual indication to a second location in the prompt region.

In some embodiments, in response to detecting the third input, the electronic device displays, via the one or more display generation components, the first visual indication at the second location in the first region of the user interface, such as if the electronic device 500 moves representation 2022b to a different location on region 2017 shown in FIG. 20P. In some embodiments, the second location is in the prompt region of the first region.

In some embodiments, the electronic device displays, via the one or more display generation components, the second visual effect with a third value, different than the first value and the second value, for the first visual characteristic between the first visual indication and the second representation of the automatically-generated visual content, such as visual effect 2026i between the concept 2022b and the representation 2024d, shown in FIG. 20P. In some embodiments, if the third input is an input corresponding to a request to add a third prompt component, then the electronic device displays a third representation of the automatically-generated visual content influenced by the first, second, and third prompt components. In some embodiments, displaying the first visual effect with the third value includes displaying the glow effect including a third brightness, a third opacity, a third color, and/or a third position, different than the second brightness, the second opacity, the second color, and/or the second position. Displaying different values for the first visual effect for different visual indications corresponding to the prompt components in a first region allows the user to easily and efficiently view the prompt components together, thereby reducing erroneous inputs to the electronic device.

In some embodiments, the electronic device displays, via the one or more display generation components, one or more indications of one or more first prompt components used to influence the generation of the automatically-generated visual content in the prompt region of the first region adjacent to the preview region of the first region of the user interface, such as prompt region 2017, which is adjacent to preview region 2019, shown in FIG. 20P. In some embodiments, the one or more indications corresponding to one or more first prompt components used to influence the generation of the automatically-generated visual content surrounds the representation of the automatically-generated visual content, displayed in the preview region of the first region. In some embodiments, the prompt region surrounds the preview region. Displaying the visual indications corresponding to the prompt components in the prompt region surrounding the preview region including the representation of the automatically-generated visual content allows the user to easily and efficiently view the prompt components together along with the representation of the automatically-generated visual content, thereby reducing the inputs needed to generate the automatically-generated visual content and reducing erroneous inputs to the electronic device.

In some embodiments, the electronic device displays, via the one or more display generation components, one or more indications of one or more second prompt components that indicate variations for predefined characteristics (e.g., style and subject characteristics) of the automatically-generated visual content, different than the one or more first prompt components, used to influence the generation of the automatically-generated visual content in a second region of the user interface, different from a first region of the user interface, such as displaying options 2020b and 2020c in a different region than region 2017, shown in FIG. 20P. In some embodiments, respective indications corresponding to the one or more second prompt components are displayed in a separate region of the user interface for detecting a prompt than the respective indications corresponding to the one or more first prompt components. In some embodiments, the second region is located below the first region. In some embodiments, the second region includes the subject selection option to change the subject, described above, and the style selection option to change the style, described above. In some embodiments, the one or more first prompt components are closer than the one or more second prompt components to the preview region including a representation of the automatically-generated visual content, described in greater detail above. In some embodiments, the one or more second prompt components are displayed closer than the one or more first prompt components to the set of prompt editing options and the keyboard user interface element, described above. In some embodiments, selecting the indications of the second prompt components causes the electronic device to display options to change the respective prompt component. In some embodiments, indications of the first prompt components are not selectable. In some embodiments, selecting an indication of a first prompt component removes the selected component from the prompt region and is no longer used to influence the generation of the automatically-generated visual content. Displaying the respective indications of the second prompt components at a different location than the respective indications of the first prompt components allows the user to view the first and second prompt components separately, thereby reducing the inputs needed to generate the automatically-generated visual content and reducing erroneous inputs to the electronic device.

In some embodiments, the one or more second prompt components include a subject prompt component, such as option 2020b, shown in FIG. 20P. In some embodiments, the electronic device receives a subject prompt component using the subject selection user interface, as described above. In some embodiments, the electronic device uses the respective context of the electronic device to automatically select a subject, as described above. In some embodiments, the subject prompt component is a selectable option that, when selected, causes the electronic device to display the subject selection user interface described above, and in method 2300. Displaying the respective indications of the second prompt components at a different location than the respective indications of the first prompt components allows the user to view the first and second prompt components separately, thereby reducing the inputs needed to generate the automatically-generated visual content and reducing erroneous inputs to the electronic device.

In some embodiments, the one or more second prompt components include a style prompt component, such as option 2020c, shown in FIG. 20P. In some embodiments, the electronic device receives the style prompt component using the style selection user interface, having one or more characteristics of the style selection user interface as described above. In some embodiments, the electronic device uses a previously selected style as a default style, having one or more characteristics of the last-used style as described above. In some embodiments, the style prompt component is a selectable option, that when selected, causes the electronic device to display the style selection user interface described above. Displaying the respective indications of the second prompt components at a different location than the respective indications of the first prompt components allows the user to view the first and second prompt components separately, thereby reducing the inputs needed to generate the automatically-generated visual content and reducing erroneous inputs to the electronic device.

In some embodiments, while the first prompt including the first prompt component and not including the second prompt component corresponding to the first prompt component suggestion influences generation of the automatically-generated visual content, the electronic device displays the first visual indication corresponding to the first prompt component at a first location in the prompt region of the first region of the user interface (e.g., in the prompt region wherein indications of prompt components that are used to influence the generation of the automatically-generated visual content are displayed), such as concept 2022a in the region 2017, shown in FIG. 20P and displaying a third visual indication correspond to the first prompt component suggestion in a second location in a second region of the user interface (e.g., in the second region where prompt component suggestions, described in greater detail above, are displayed), such as suggestion 2016b shown in a different region from the region 2017 in FIG. 20D. In some embodiments, displaying the first visual indication of the first prompt component also includes displaying a first representation of the automatically-generated visual content that uses the first prompt component to influence the generation of the automatically-generated visual content. In some embodiments, the second region includes one or more first prompt component suggestions, described in greater detail above.

In some embodiments, in response to detecting the second input (e.g., the second input is optionally a dragging input or a selection input as described above), such as the input including contact 2018 directed towards suggestion 2016b shown in FIG. 20D, the electronic device displays the first visual indication corresponding to the first prompt component at a third location in the prompt region of the first region of the user interface, different than the first location, such as if component 2022a moved locations in region 2017, shown in FIG. 20P.

In some embodiments, the electronic device displays the second visual indication corresponding to the second prompt component at a fourth location in the prompt region of the first region of the user interface, different than the first location and the second location, such as component 2022b at the location in region 2017, shown in FIG. 20P. In some embodiments, in response to detecting the second input, the electronic device adds the first prompt component suggestion as the second prompt component to influence the generation of the automatically-generated visual content, and displays the second visual indication corresponding to the second prompt component in the prompt region. In some embodiments, in response to detecting the second input, the electronic device moves the first visual indication to accommodate the second visual indication. For example, if the first location is the bottom center of the prompt region, then the third and fourth locations are the bottom left and bottom right, respectively. In some embodiments, adding the second visual indication includes updating the value of the first visual effect for the first visual indication and adding the first visual effect to the second visual indication. In some embodiments, adding the second prompt component includes updating the representation of the automatically-generated visual content to the second representation of the automatically-generated visual content in accordance with the first and second prompt components. Updating the locations of the visual indications corresponding to the prompt components in the prompt region in response to adding additional prompt components allows the user to easily and efficiently view the prompt components together, thereby reducing erroneous inputs to the electronic device.

In some embodiments, displaying the user interface for detecting the prompt for use in generating automatically-generated visual media includes displaying the user interface for detecting the prompt in a first user interface of a first application, such as user interface 604 shown in FIG. 20E.

In some embodiments, the first user interface of the first application includes a user interface of a content application (described in method 700 and/or as shown in FIG. 6KK), a user interface that includes information associated with the prompt (described in method 700 and/or as shown in FIG. 6JJ), an editing user interface (described in method 800 and/or as shown in FIG. 6W), a generative visual media variants user interface described above, and/or other user interface including user interfaces relating to the automatically-generated visual media application (described below and/or in method(s) 700, 800, 1000, and/or 1200).

In some embodiments, the electronic device detects, via the one or more input devices, a sequence of one or more inputs corresponding to a request to display the user interface for detecting the prompt in a second application, different from the first application, such as if the electronic device displays user interface 604 in a different application from the automatically-generated visual media application.

For example, the second user interface of the second application is optionally a user interface of messaging application, a notes application, an email application, a presentation application, a word processing application, a whiteboarding application, a sketching application, a spreadsheet application, a journaling application, and/or other content processing application.

In some embodiments, the sequence of one or more inputs include a selection input (e.g., a tap input, air gesture, a click input, and/or a gaze input) while attention (e.g., based on a cursor, a touch input, a direct air gesture, gaze, or a substitute for gaze) is directed to an option that, when selected causes the electronic device to display, within the second user interface of the second application, a user interface of the content application described herein. For example, the electronic device optionally displays the user interface of the content application (optionally as a window or volume) overlaid onto the second user interface of the second application. Thus, in some embodiments, the electronic device enables the user to access, add, and/or display generative visual media in other applications other than the content application.

In some embodiments, in response to detecting the sequence of one or more inputs, in accordance with a determination that the electronic device is in the first context, the electronic device displays, via the one or more display generation components, the one or more visual indications of the first set of one or more prompt component suggestions while running the second application (e.g., without closing or exiting the second application), such as prompt component suggestions 2016a through 2016h shown in FIG. 20D.

In some embodiments, in response to detecting the sequence of one or more inputs, in accordance with a determination that the electronic device is in the second context, different from the first context, the electronic device displays, via the display generation component, the one or more visual indications of the second set of one or more prompt component suggestions, different from the first set of one or more prompt component suggestions, such as prompt component suggestions 2016q through 2016x, shown in FIG. 20K. In some embodiments, the user interface for detecting the prompt of the first application is displayed while running the second application and/or while in a user interface of the second application. In some embodiments, the context of the electronic device and the prompt component suggestions are described in greater detail above.

Surfacing the user interface for detecting the prompt in a second application different from the first (content) application provides an efficient way of accessing automatically-generated visual media user interfaces without leaving the second application and the need for subsequent inputs to close or end a session in the second application to open the first application, thereby reducing the number of inputs and providing more efficient interactions between the user and the electronic device.

It should be understood that the particular order in which the operations in FIG. 21 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1400, 1500, 1700, 1900, 2300, and/or 2700) are also applicable in an analogous manner to method 2100 described above with respect to FIG. 21. For example, the operation of the suggestion of prompt component suggestions based on device context described above with reference to method 2100 optionally has one or more of the characteristics of displaying a representation of a prompt and one or more recognized concepts, editing one or more parameters, including one or more recognized concepts, of a previously generated automatically-generated visual content, adding a representation of automatically-generated visual content into a first application, presenting an automatically-generated visual media creation user interface to use a non-automatically-generated visual media as the reference media item, displaying portion(s) of a user interface with HDR luminance, displaying one or more portions of the user interface with luminance that is within or greater than a SDR luminance, generating multiple variations of representations of automatically-generated visual content, restricting prompt components to be used to generate automatically-generated visual content, customizing subjects for generating automatically-generated visual content, and constraining template subjects and using a random or pseudorandomly selected template subject as the subject for generating the automatically-generated visual content described herein with reference to other methods described herein (e.g., 700, 800, 1000, 1200, 1400, 1500, 1700, 1900, 2300, and/or 2700). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 21 are, optionally, implemented by components depicted in FIGS. 1A-1B. For example, detecting operation 2102a, and displaying operation 2102c and 2012d are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners. In some embodiments, an electronic device is in communication with one or more input devices and/or one or more display generation components. In some embodiments, the electronic device generates (e.g., using an AI process or a generative AI process) automatically-generated visual content items including a human or nonhuman subject. In some embodiments, automatically-generated visual content is media generated using autonomous processes optionally as described herein. The subject is optionally based on reference media, such as one or more still or video images that capture a portion of the real world including the subject. The subject is optionally automatically-generated based on one or more features indicated by a plurality of inputs the electronic device detects. The embodiments described below provide ways in which the electronic device presents user interfaces for modifying the appearance of a subject during a process for providing and/or editing a prompt for generation of an automatically-generated visual content item. Modifying the appearance of a subject while creating and/or editing a prompt for generating an automatically-generated visual content item allows the user to easily and efficiently customize the subject of the automatically-generated visual content item, thereby reducing the number of inputs needed to generate automatically-generated visual content and reducing erroneous inputs to the electronic device. It is understood that people use devices. When a person uses a device, that person is optionally referred to as a user of the device.

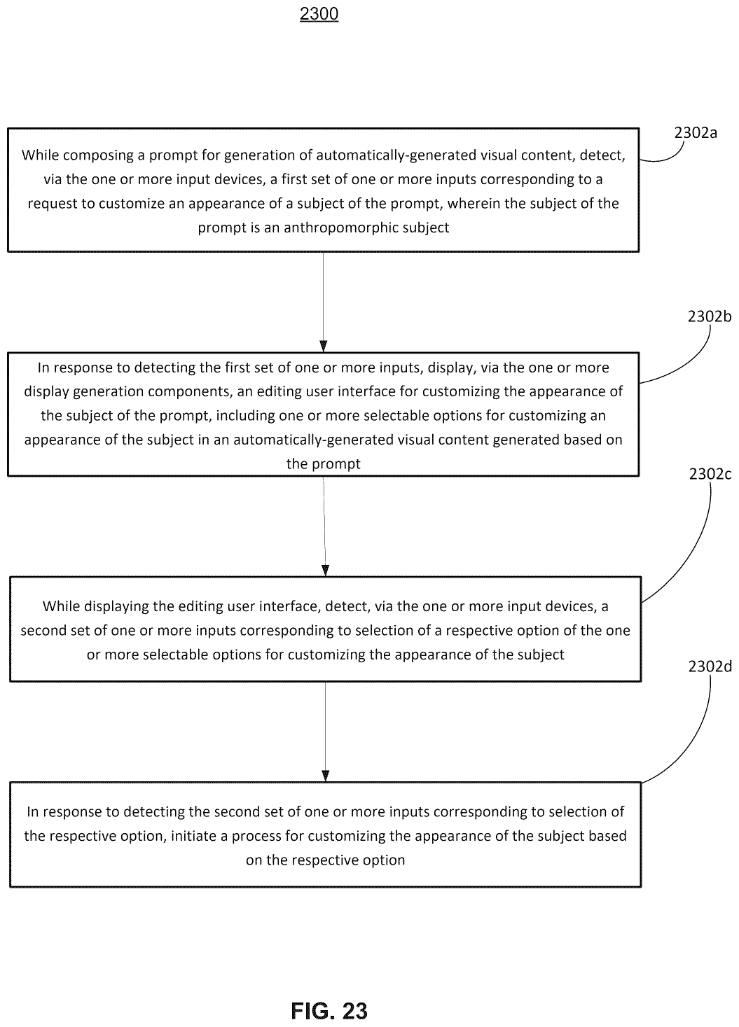

FIGS. 22A through 22CCC illustrate exemplary ways in which an electronic device presents user interfaces for editing a subject of an automatically-generated visual content item. The embodiments in these figures are used to illustrate the processes described below, including the processes described with reference to FIG. 23. Although FIGS. 22A through 22CCC illustrate various examples of ways an electronic device is able to perform the processes described below with respect to FIG. 23, it should be understood that these examples are not meant to be limiting, and the electronic device is able to perform one or more processes described below with reference to FIG. 23 in ways not expressly described with reference to FIGS. 22A through 22CCC.

In some embodiments, the user interface of FIGS. 22A-22CCC corresponds to the user interface of FIGS. 6A-6MM, 16A-16U, 18A-18BB, 20D-20AA, 24A-24E, and/or 26A-26P.

FIG. 22A illustrates embodiments of a user interface for a media generation application. FIG. 22A illustrates an electronic device 500 that is in communication with a display generation component 504 (e.g., a touchscreen). In some embodiments, the electronic device 500 is a mobile device, such as a smartphone, tablet, or wearable device. In some embodiments, display generation component 504 is a touchscreen, a non-touch sensitive display, and/or a projected display in which images are cast into a physical environment of a user of the electronic device 500. In FIG. 22A, electronic device 500 displays a user interface for automatically creating and/or generating content such as one or more images as described further with reference to method(s) 2300. In some embodiments, the user interface optionally corresponds to user interface 604, in FIG. 6A.

In FIG. 22A, electronic device 500 displays an automatically-generated visual content item corresponding to representation 2204a. As described with reference to method 2300, representation 2204a is generated using one or machine learning models that draw upon prompt components to define the content that is generated. Electronic device 500 displays prompt components 2206a, 2206b, and 2206c in FIG. 22A, for example, which optionally influence the content included in the representation 2204a, and as described with reference to method 2300.

In FIG. 22A, electronic device 500 displays a plurality of selectable options 2208 of prompt components, which are respectively selectable to update the representation 2204a. Additionally or alternatively, in FIG. 22A, electronic device 500 displays option 2210a, that when selected, causes electronic device 500 to display a content entry field for detecting prompt components and/or prompt components, as described in greater detail in method 2100 and/or 2300. Option 2210a optionally corresponds to option 1610, 1846a, and/or 2020a in FIGS. 16A-16U, 18G-18BB, 20D-20AA, and/or 26A-26P. In FIG. 22A, electronic device 500 displays option 2210b, which when selected, causes electronic device 500 to display a user interface for changing the subject of the automatically-generated visual content item, as described in greater detail in method(s) 2100 and/or 2300 and shown in FIG. 20Q and/or FIGS. 22A through 22CCC. Option 2210b optionally corresponds to option 1612, 1848, and/or 2020b in FIGS. 16A-16U, 18G-18BB, 20D-20AA, and/or 26A-26P. In FIG. 22A, electronic device 500 displays option 2020c, which when selected, causes the electronic device 500 to display a user interface for changing the style of the automatically-generated visual content item, as described in greater detail in method 2300. In FIG. 22A, electronic device 500 displays selectable option 2202a, which when selected, causes electronic device 500 to cease display of the user interface and/or cease editing of the automatically-generated visual content item. In FIG. 22a, electronic device 500 displays selectable option 2202b, which when selected, causes the electronic device 500 to generate the automatically-generated visual content item, as described in greater detail in methods 700 and 800. In FIG. 22A, electronic device 500 detects selection input 2203 directed to option 2210b. In response to detecting the input in FIG. 22A, the electronic device 500 presents a user interface for changing the subject of the automatically-generated visual content item and/or personalizing one or more available candidate subjects, as shown in FIG. 22B. In some embodiments, options 2202a and 2202b are analogous to options 624a, 1602a, and/or 1802a and 624b, 1602b, and/or 1802b, respectively, in FIGS. 6B-6MM, 16A-16U, 18A-18BB, 20D-20AA, and/or 26A-26P.

Although input 2203 in FIG. 22A is illustrated as a contact (e.g., a tap or a long press input), it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 2300, are possible.

In FIG. 22B, electronic device 500 updates the displayed user interface to include a personalization user interface for changing the subject of the automatically-generated visual content item, such as in response to input 2203 that is illustrated in FIG. 22A. In FIG. 22B, electronic device 500 displays a plurality of candidate subjects corresponding to candidate subject options 2218a through 2218f. For example, respective candidate subjects corresponding to candidate subject options 2218a through 218f are optionally anthropomorphic subjects that are different from one another, such as corresponding to different emojis, models, images of users of devices, and/or the like. For example, candidate subjects options 2218a, 2218d, 2218e, and 2218f correspond to people (e.g., “Jenna,” “Clyde,” “Anna,” and “Zach,” respectively) captured in one or more images in a media library of the electronic device 500 and candidate subject options 2218b and 2218c correspond to automatically-generated characters the electronic device 500 created according to one or more steps of method 2300 and/or described in more detail below.

As shown in FIG. 22B, the electronic device 500 displays candidate subject option 2218d with an indication that candidate subject option 2218d corresponds to the currently-selected subject of the automatically-generated visual content item corresponding to representation 2204a. The electronic device 500 displays the candidate subject option 2218d with an editing option 2220. As will be described in more detail below at least with reference to FIGS. 22D-22H, in response to receiving an input selecting option 2218d, the electronic device 500 presents user interfaces for modifying the appearance of the candidate subject corresponding to option 2218d displayed in association with editing option 2220.

Additionally, in FIG. 22B, the electronic device 500 displays a representation 2204a of a preview of an automatically-generated visual content item generated according to prompt components 2206a through 2206c. In FIG. 22B, the electronic device 500 displays the prompt components 2206a through 2206c at smaller sizes and with fewer details than those with which the electronic device 500 displayed the prompt components 2206a through 2206c in FIG. 22B.

In FIG. 22B, electronic device 500 displays a plurality of selectable options 2216a through 2206c that, when respectively selected, cause the electronic device 500 to generate new candidate subjects for use in generating automatically-generated visual content items. In response to detecting selection of as option 2216a, the electronic device 500 presents a user interface for generating a candidate subject using one or more options according to one or more steps of method 2300. In response to detecting selection of selectable option 2216b, the electronic device 500 captures media (e.g., a photo and/or video) to use as a reference for a new candidate subject. In response to detecting selection of selectable option 2216c, the electronic device 500 presents a media library including selectable representations of media items that, when selected, cause the electronic device 500 add a candidate subject to the plurality of candidate subjects based upon one or more selected media items (e.g., photo(s) and/or video(s)). Additionally, electronic device 500 displays selectable option 2214a which, when selected, causes the electronic device 500 to forgo any changes personalizing the plurality of candidate subjects, and selectable option 2214b which, when selected, causes the electronic device 500 to save and/or commit any changes personalizing the plurality of candidate subjects. In FIG. 22B, electronic device 500 detects input 2203 directed to candidate subject option 2218a. In response to detecting the input shown in FIG. 22B, the electronic device 500 selects the candidate subject corresponding to option 2218a as the subject for the automatically-generated visual content item, as shown in FIGS. 22C-22D. In some embodiments, option 2214a and 2214b are analogous to options 1626b, 1868b, and/or 2038c and 1626c, 1868c, and/or 2038d, respectively, shown in FIGS. 16A-16U, 18G-18BB, 22A-22CCC, and/or 26A-26P.

In FIG. 22C, electronic device 500 initiates a process to modify the candidate subject used for automatically-generated visual content. For example, in FIG. 22C, electronic device 500 displays an animation to indicate that content generation is underway. Additionally, in FIG. 22C, electronic device 500 changes the visual emphasis displayed in the candidate subject user interface away from candidate subject option 2218d and toward candidate subject option 2218a, such as increasing the bolding, shading, and/or scale of candidate subject option 2218a relative to as shown in FIG. 22B. Changing the shading indicates that the candidate subject corresponding to candidate subject option 2218a is selected as the subject of the automatically-generated visual content item instead of the candidate subject corresponding to candidate subject option 2218d.

From FIG. 22C to FIG. 22D, electronic device 500 ceases display of the placeholder visual media and initiates display of representation 2204b, corresponding to visual media that is automatically generated featuring the subject corresponding to candidate subject option 2218a. For example, representation 2204b in FIG. 22D includes an image of the subject corresponding to candidate subject option 2218a in a hot air balloon that is floating in a sky scene. Thus, representation 2204b in FIG. 22D is based upon the prompt components displayed in FIG. 22A, such as prompt components 2206a, 2206b, and 2206c. In FIG. 22D, electronic device 500 detects input 2203 directed to selectable option 2220, corresponding to a request to initiate editing of the subject corresponding to candidate subject option 2218a. In response to detecting the input shown in FIG. 22D, the electronic device 500 displays selectable options for editing the subject, such as the user interface illustrated in FIG. 22E.

In FIG. 22E, the electronic device 500 displays of a menu including one or more selectable options 2224a through 2224d that, when selected, cause the electronic device 500 to edit the physical characteristics of the selected candidate. For example, electronic device 500 in FIG. 22E displays selectable option 2224a, which when selected, optionally causes electronic device 500 to initiate a process to select reference visual media to change visual characteristics of the selected candidate. Further, electronic device 500 in FIG. 22E displays selectable option 2224b, which when selected, optionally causes electronic device 500 to change the appearance of the candidate to include physical attributes such as phenotypic structures to correspond to a stereotypically female physical attributes (e.g., shoulder width, hair length and/or style, musculature, and/or the like). Additionally, electronic device 500 in FIG. 22E displays selectable option 2224c, which when selected, optionally causes electronic device 500 to change the appearance of the candidate to include physical attributes such as phenotypic structures to correspond to a stereotypically male physical attributes. Additionally, electronic device 500 in FIG. 22E displays selectable option 2224d, which when selected, optionally causes electronic device 500 to change the appearance of the candidate to include physical attributes such as phenotypic structures to correspond to a stereotypically non-binary physical attributes (or without specifying a particular appearance for physical attributes that are stereotypically associated with male or female body types). In FIG. 22E, electronic device 500 detects inputs 2203a, 2203b, 2203c, and 2203d, respectively directed to selectable option 2224a, selectable option 2224b, 2224c, and selectable option 2224d. In response to detecting input 2203a in FIG. 22E, the electronic device 500 displays options for changing the reference media of the selected candidate subject, such as shown in FIG. 22F. In response to detecting input 2203b, 2203c or 2203d, the electronic device 500 would update the appearance of the subject in the automatically-generated visual content, such as in representation 2204b, according to the selected option.

In FIG. 22F, electronic device 500 updates the personalization user interface to display a plurality of options 2228a through 2228f associated with media items featuring the subject. In some embodiments, the electronic device 500 maintains display of the representation 2204b of the automatically-generated visual content item and/or the prompt components 2206a through 2206c of prompt components while displaying the updated personalization user interface. In some embodiments, respective options 2228a through 2228f correspond to collections of content items in a content library of the electronic device 500 representing various appearances of the subject. For example, option 2228a is associated with a collection of content items featuring the subject with a first appearance and option 2228b is associated with a collection of content items featuring the subject with a second appearance.

In some embodiments, the various collections of content items featuring the subject include content items captured within a predetermined time frame so that respective appearances of the subject do not combine images in which the subject is aged differently and different appearances of the subject capture different stages of aging of the subject. For example, collections of content items for adults are grouped in ten-year periods and collections of content items for children are grouped in three-year periods. Because the subject featured in FIG. 22F is an adult, the respective collections of content items corresponding to options 228a through 228f include sets of content items within respective ten-year periods. Optionally, the ten-year periods overlap.

In some embodiments, visual media collections corresponding to options 2228a through 2228f are intelligently selected (e.g., are “suggested”), such as in accordance with a determination that the selected visual media include the candidate that is being personalized. In FIG. 22F, option 2228a includes an indication 2227 that visual media in the collection corresponding to option 2228a is currently being used as a template and/or input for creating the representation of the subject in representation 2204b (e.g., a check mark overlaying option 2228a). In some embodiments, in response to detecting selection of a different option 2228b through 2228f, the electronic device 500 updates the subject to have an appearance based on the collection of content items corresponding to the selected option. In FIG. 22F, electronic device 500 detects an input 2203 directed to selectable option 2226b. In response to receiving the input in FIG. 22F, the electronic device 500 displays additional or alternative visual media that the user potentially is interested in using as a template for the selected candidate, such as all content items in the content library the electronic device detects as including the subject, as shown in FIG. 22G.

In FIG. 22G, electronic device 500 updates the personalization user interface to include a plurality of visual content featuring the subject of the automatically-generated visual content item corresponding to representation 2204b. In some embodiments, the electronic device 500 maintains display of the representation 2204b of the automatically-generated visual content item and/or the prompt components 2206a through 2206c of prompt components while displaying the updated personalization user interface. For example, in FIG. 22G, electronic device 500 displays options 2228a, 2228b, and 2228g through 228j associated with content items that, when selected, cause the electronic device 500 use the content item corresponding to the selected option to create the appearance of the subject in automatically-generated visual content items, such as representation 2204b. In FIG. 22G, electronic device 500 displays options associated with content items that are in part the same, and in part different from content items that were intelligently selected. For example, the content items corresponding to options 2228a and 2228b are displayed in both FIGS. 22F and 22G, and content items associated with options 2228g through 228j are displayed in FIG. 22F and not in FIG. 22G by electronic device 500. Thus electronic device 500 displays additional visual media (e.g., “all” visual media), such as visual media that is relatively or is the most recent in a collection of visual media content, such as a collection of photos stored at electronic device 500. In some embodiments, the personalization user interface is scrollable to reveal additional options corresponding to additional content items featuring the subject. In FIG. 22G, electronic device 500 detects input 2203 selecting option 2228g associated with a respective content item featuring the subject. In response to receiving the input shown in FIG. 22G, the electronic device 500 updates the appearance of the subject, including in representation 2204b, to correspond to the content item associated with option 2228g, as shown in FIG. 22H.

In FIG. 22H, electronic device 500 updates representation 2204c to reflect the updated appearance of the subject. For example, electronic device 500 updates representation 2204c to make the subject look similar to, the same as, and/or based upon the appearance of the subject in content item corresponding to option 2228g (as further indicated by the overlaying of indication 2227 over option 2228g). Accordingly, electronic device 500 changes the specific content used as a template in generating the automatically-generated visual content item, which optionally includes a same subject as representation 2204b in FIG. 22G, but displayed with different visual characteristics (e.g., clothes, hairstyle, jewelry, skin texture, and/or some combination thereof). FIG. 22H illustrates an input 2203a selecting option 2214c and an input 2203b selecting option 2214d. In response to detecting the input 2203a directed to option 2214c, the electronic device 500 would discard any personalization editing performed (e.g., from FIGS. 22E through 22H) and display the user interface shown in FIG. 22D. In response to detecting input 2203b directed to selectable option 2214d, the electronic device 500 saves the personalization editing that was performed and displays the user interface shown in FIG. 22I.

In FIG. 22I, the electronic device 500 maintains display of representation 2204c including the subject with the appearance shown in FIG. 22H. In FIG. 22I, electronic device 500 detects input 2203 directed to candidate subject option 2218e. In response to detecting the input shown in FIG. 22I, the electronic device 500 uses the candidate subject corresponding to candidate subject option 2218e to generate the automatically-generated visual content item, as shown in FIG. 22J.

In FIG. 22J, electronic device 500 updates the automatically-generated visual content based upon the newly selected subject. For example, electronic device 500 displays representation 2204d, which is optionally similar to representation 2204c illustrated as shown in FIG. 22I, including the subject corresponding to option 2218e in a hot air balloon with a monkey corresponding to candidate subject option 2218e. As described above, visual emphasis shifts to candidate subject option 2218e to indicate its current selection and relationship with representation 2204d. As shown in FIG. 22J, the visual content of representation 2204d is different from the visual content of representation 2204c in FIG. 22I. In addition to using a different subject to generate the content shown in representation 2204d, the electronic device 500 generates a new image based on prompt components 2206a through 2206c. In FIG. 22J, electronic device 500 detects input 2203 directed to selectable option 2220. In response to detecting the input shown in FIG. 22J, the electronic device 500 displays options for editing the appearance of the subject corresponding to option 2218e.

In FIG. 22K, electronic device 500 displays the menu including the one or more selectable options 2224a through 2224d that, when selected, cause the electronic device 500 to change physical attributes of the subject of the automatically-generated visual content. Selectable options 2224a through 2224d are optionally associated with the operations described above with reference to FIG. 22E. As shown in FIG. 22K, option 2224d includes a check mark indicating that the electronic device 500 is generating the appearance of the subject to be stereotypically non-binary. In FIG. 22K, electronic device 500 detects input 2203 directed to selectable option 2224b, which when selected, changes the visual attributes of the candidate subject option 2218a to reflect stereotypically female physical attributes. In FIG. 22L, electronic device 500 updates the appearance of the candidate to be more stereotypically feminine. For example, in FIG. 22L, the electronic device 500 displays (e.g., among other possible visual elements) a piece of clothing that is stereotypically associated with the female gender (e.g., a bow in the hair of the subject) in the representation 2204b. In FIG. 22L, electronic device 500 detects input 2203 directed to selectable option 2224a. In response to detecting the input in FIG. 22L, the electronic device 500 displays options for changing the reference media used to generate images of the subject, as shown in FIG. 22M.

In FIG. 22M, electronic device 500 updates the personalization user interface to include options 2228a through 2228p for changing the appearance of the subject, similar to the user interface shown in FIG. 22E, but with respect to a different candidate subject. For example, electronic device 500 in FIG. 22M includes options 2228k through 2228p corresponding to collections of content items featuring the subject. As shown in FIG. 22M, the electronic device 500 displays option 22281 with indication 2227 to indicate that the representation 2204b includes the subject with an appearance based on the content items corresponding to option 22281. The collections of content items corresponding to options 2228k through 2228p are intelligently selected (e.g., “suggested”) to the user of electronic device 500 as described above with reference to FIG. 22E. Because the subject in FIG. 22M is a child, the collections of content items corresponding to options 2228k through 228p are grouped in time periods of three years instead of ten years, as would be the case for an adult subject, with some time periods overlapping one another optionally. In FIG. 22M, electronic device 500 detects input 2203 directed to selectable option 2226b. In response to detecting the input in FIG. 22M, the electronic device 500 would display additional content items including the subject, such as all content items in the content library including the subject, in a manner similar to the manner described above with reference to FIG. 22G.

FIGS. 22N through 22X illustrates embodiments in which electronic device 500 facilitates creation of an anthropomorphic subject such as an avatar that is optionally used to generate automatically-generated visual content and/or as an emoji. For example, in FIG. 22N, electronic device 500 displays a personalization user interface (as described above) including a plurality of selectable options such as selectable option 2216a and detects input 2203 directed to selectable option 2216a. In response to detecting the input shown in FIG. 22N, the electronic device 500 displays a user interface for creating a subject, such as in FIG. 22O.

In FIG. 22O, electronic device 500 displays a user interface to generate and/or customize the appearance of an avatar. For example, electronic device 500 displays the character creation user interface in FIG. 22O in response to detecting input 2203 as shown in FIG. 22N. In some embodiments, the electronic device 500 displays the user interface shown in FIG. 22MM, described below, in response to detecting the input shown in FIG. 22N. The character creation user interface in FIG. 22O includes a plurality of selectable options, including selectable options 2332a through 232c, which when respectively selected, causes electronic device 500 to initiate display and/or select a template appearance to generate an avatar (e.g., to create a subject or emoji) with various appearances, optionally associated with masculine, feminine, and non-binary appearances. Electronic device 500 in FIG. 22O additionally displays a plurality of representations of skin tones, such as representations 2334a through 2234d. In some embodiments, the skin tones associated with representations 2334a through 2234d correspond to natural-looking skin tones, such as shades of peach, tan, and/or brown. In some embodiments, prior to detecting selection of one of the options 2234a through 2234b, the electronic device displays the options 2232a through 2232c with unnatural skin tones (e.g., emoji yellow). In FIG. 22O, electronic device 500 displays text entry field 2236a, which is optionally a prompt bar that is selectable to cause electronic device 500 to prompt the user to provide a text input for features and/or descriptions of characteristics of their desired avatar. In FIG. 22O, electronic device 500 detects input 2203 directed to selectable option 2232b, corresponding to a stereotypically female appearance for the avatar.

In FIG. 22P, electronic device 500 updates the visual appearance of selectable option 2232b to indicate that is currently selected, such as including an enlarged scale, a border, an increasing in brightness, and/or the like. Electronic device 500 detects input 2203 directed to selectable option 2234a. In response to detecting the input 2203 in FIG. 22O, the electronic device 500 updates the visual appearance of selectable option 2234a as shown in FIG. 22Q to indicate that that selectable option 2234a is currently selected and updates the options 2232a through 2232c to have the skin tone corresponding to the selected option 2234a. In FIG. 22Q, electronic device 500 detects selection input 2203 directed to text entry field 2236a. In response to detecting the input in FIG. 22Q, the electronic device 500 displays a user interface for receiving one or more inputs providing a text description of the avatar.

In FIG. 22R, electronic device 500 updates the character creation user interface to prompt the user of electronic device 500 for additional details that impact the generated avatar. For example, electronic device 500 updates the user interface to be as shown in FIG. 22R in response to detecting input 2203 directed to text entry field 2236a as shown in FIG. 22Q. In FIG. 22R, electronic device 500 displays a text entry region 2236a, which electronic device 500 populates with text in response to detecting input (e.g., dictation, voice input, simulated handwritten input, and/or the like). Electronic device 500 concurrently displays a plurality of options 2232a through 232c and option 2234a through 234d, which optionally indicate which of the respective characteristics are being applied as inputs and/or factors used to generate avatar 2238a. In response to detecting selection of one of the options 2232a through 2232c and/or 2234a through 2234d, the electronic device 500 updates the avatar to have the characteristic corresponding to the selected option. Accordingly, electronic device 500 in FIG. 22R displays the avatar 2238a with physical attributes that are based upon the selected representation described with reference to FIGS. 22P and 22Q. In FIG. 22R, electronic device 500 detects a sequence of inputs, including input 2203 directed to a letter included in a virtual keyboard (e.g., “w”).

In FIG. 22S, electronic device 500 displays the text entry field 2236a with text 2236c entered in response to detecting one or more inputs as described above entering text into the text entry region, including the input shown in FIG. 22R. Electronic device 500 optionally interprets the text, determines and/or obtains an indication of the meaning of the text, and/or updates the avatar 2238a to reflect the text. For example, avatar 2238a in FIG. 22S includes hair with a wavy texture, based upon the “wavy hair” text 2236c. Electronic device 500 detects input 2203 in FIG. 22S, corresponding to one of one more inputs that when detected, caused electronic device 500 to update text 2236c (e.g., as indicated by movement of the cursor 2236b) to as shown in FIG. 22T. In FIG. 22T, electronic device 500 adds additional text (e.g., “hoop earrings”) into the text entry region 2236a, and in response, updates avatar 2238a to include visual elements such as earrings matching the entered text. In FIG. 22T, electronic device 500 detects input 2203 directed to selectable option 2230b, which when selected, optionally causes electronic device 500 to save the edits made to the avatar 2238a and to use the avatar as the subject for automatically-generated visual content items. If the electronic device 500 had detected an input directed to option 2230, the electronic device 500 would discard the avatar 2238a and display the user interface shown in FIG. 22N.

In FIG. 22U, electronic device 500 displays the user interface(s) which include the automatically generated visual content and the selectable options associated with personalization of subjects. For example, in response to the input 2203 as shown in FIG. 22T, electronic device 500 displays representation 2204d, which is generated based upon and/or includes the generated avatar 2238 as shown in FIG. 22T and based on the prompt components 2206a through 2206c. Generating the image of representation 2204d in FIG. 22U includes generating a new image based on the prompt components including the avatar as the subject In FIG. 22U, electronic device 500 displays candidate subject option 2218g, which corresponds to the generated avatar, with visual emphasis indicating that the avatar is the subject of the automatically-generated visual content items. In FIG. 22U, electronic device 500 detects input 2203 directed to selectable option 2214b, which causes electronic device 500 to cease display of the personalization user interface, keeping the avatar as the subject of the automatically-generated visual content item corresponding to representation 2204d, and displaying the user interface shown in FIG. 22V.

In FIG. 22V, electronic device 500 has ceased display of the personalization user interfaces, and/or is displaying a portion of the representation that was presented concurrently with the personalization user interface. For example, representation 2204e in FIG. 22V corresponds to a portion of representation 2204d in FIG. 22U. In FIG. 22V, electronic device 500 again displays the prompt components 2206a through 2206c and selectable options 2208 and 2210a through 2210c. In FIG. 22V, a timer is depicted, and is not displayed by electronic device 500. The timer indicates an amount of time that has elapsed from detecting the input operative to cease display of the personalization user interface and/or selectable options (e.g., input 2203 in FIG. 22U). In FIG. 22V, timer 2299 has not yet reached a threshold 2299 amount of time (e.g., the horizontal line intersecting the timer), so the electronic device 500 displays the representation 2204e and prompt components 2206a through 2206c at the sizes shown in FIG. 22V.

From FIG. 22V to FIG. 22W, time advances, and the timer exceeds the threshold 2299 amount of time. In some embodiments, after displaying the preview corresponding to representation 2204d for the threshold amount of time, electronic device 500 initiates display of a more complete depiction of the automatically generated visual content corresponding to representation 2204e. For example, electronic device 500 in FIG. 22W increases the dimensions of the representation 2204e relative to as shown in FIG. 22V, and/or reduces the size and/or level of detail of the prompt components 2206a through 2206c that were used to generate representation 2204e. In FIG. 22W, electronic device 500 detects input 2203 directed to selectable option 2202b, which optionally initiates a process to display the automatically-generated visual content in a larger scale and/or a (at least temporarily) finalized form, as shown in FIG. 22X.

In FIG. 22X, electronic device 500 displays the representation 2240a, which is the automatically generated visual content, occupying the dimensions of the user interface presented by electronic device 500. Representation 2240a is optionally similar to, or the same as representation 2204e, such as including similar or the same virtual elements including a depiction of the candidate selected during the personalization editing process. In some embodiments, representation 2240a is of higher fidelity (e.g., with a bigger size and/or more detail) than representation 2204e. FIG. 22X includes an option 2242a that, when selected, causes the electronic device 500 to navigate back to the user interface shown in FIG. 22W, thus enabling the user to edit the prompt component(s) for generating the automatically-generated visual content item. In FIG. 22X, electronic device 500 detects selection input 2203, directed to selectable option 2242b, which when selected initiates a process to save the generated visual content to a library of automatically-generated visual content. In FIG. 22X, electronic device 500 displays selectable option 2242c, which when selected, causes electronic device 500 to initiate a process to share the automatically-generated visual content (e.g., with one or more other electronic devices). In some embodiments, options 2242a, 2242b, and 2242c are analogous to options 630a and/or 1602c, 630b and/or 1602d, and 630c and/or 1602e, respectively, in Fig. FIGS. 6A-6MM, 9A-9X, 16A-16U, 18G-18BB, 20D-20AA, and/or 26A-26P.

In FIG. 22X, the user interface 629h also includes the selectable option 675a, that when selected, causes the electronic device 500 to generate a three-dimensional (3D) version of the automatically-generated visual media shown in FIG. 22X. Alternatively, the electronic device 500 generates a new automatically-generated visual content item as a 3D automatically-generated visual content item using the one or more recognized concepts. In some embodiments, selectable option 627a is described in greater detail in FIG. 6Z.

In FIG. 22Y, electronic device 500 displays a library of automatically-generated visual content. For example, in response to detecting the input 2203 shown in FIG. 22X, electronic device 500 ceases display of the representation 2240a, and initiates display of the corresponding representation 2244a in user interface for browsing the library. In FIG. 22Y, electronic device 500 displays representations 2244b through 2244f, which correspond to additional or alternative visual media (e.g., automatically generated visual content), and selectable option 2246, which when selected, causes electronic device 500 to initiate a process to add a visual content to the library.

FIGS. 22Z through 22KK illustrate embodiments in which electronic device 500 facilities generation and/or sharing of one or more automatically generated emoticons (e.g., emojis). FIG. 22Z, for example depicts electronic device 500 displaying a user interface for a messaging application, including a plurality of representation of messaging conversations 2250a through 250e. In FIG. 22Z, electronic device 500 detects input 2203 directed to a first messaging conversation 2250b. In response to detecting the input 2203 in FIG. 22Z, the electronic device 500 displays the messaging conversation corresponding to the selected conversation 2250b.

In FIG. 22AA, electronic device 500 displays the contents of the first messaging conversation 2250b. For example, electronic device 500 displays message 2252aa, received from another electronic device other than electronic device 500. In FIG. 22AA, electronic device 500 displays a plurality of selectable options 2251a and 2251b. In response to detecting selection of option 2251a, the electronic device 500 displays the user interface shown in FIG. 22Z. In response to detecting selection of option 2251b, the electronic device displays additional information and/or settings pertaining to the messaging conversation. In FIG. 22AA, electronic device 500 displays a text entry bar 2236d, which is selectable to initiate entry of text, such as for composing a text message, and displays a selectable option, which when selected, initiates dictation input directed to the text entry bar 2236d. In FIG. 22AA, electronic device 500 detects input 2203 directed to selectable option 2254a, and in turn, electronic device 500 displays a user interface including a plurality of emojis 2254c, as shown in FIG. 22BB.

In FIG. 22BB, electronic device 500 displays a plurality of emojis 2254c. In response to detecting selection of one of the emojis 2254c, the electronic device 500 inserts the selected emoji into text entry bar 2236d. For example, in response to input 2203 as shown in FIG. 22AA, electronic device 500 displays emojis 2254c and selectable option 2254b that, when selected, causes the electronic device 500 to display the letter keyboard shown in FIG. 22AA. In FIG. 22BB, electronic device 500 detects input 2203, which optionally includes movement of contact such as movement on a touch screen and corresponds to a request to scroll through emojis 2254c.

For example, from FIG. 22BB to FIG. 22CC, electronic device 500 scrolls the emojis rightward. In FIG. 22CC, the electronic device 500 displays additional emojis, including an emoji 2254c of a custom-created subject created in the process described above with reference to FIGS. 22O to 22T, and option 2256 that, when selected, causes the electronic device 500 to present a user interface for creating a custom emoji. In FIG. 22CC, electronic device 500 detects input 2203 directed to selectable option 2256, and initiates a process to create an emoji, such as by using one or more operations similar to or the same as described with reference to generating the avatar above, including displaying the user interface shown in FIG. 22DD.

In FIG. 22DD, electronic device 500 displays a user interface for creating an emoji, including a text entry bar 2236e similar to the text entry bar described above. Text entry bar 2236e includes a cursor 2236f, which indicates the point at which text will be inserted in response to detecting user input typing, writing, and/or dictating input. As shown in FIG. 22DD, the text entry bar 2236e includes the text 2236g “astronaut.” While displaying the text 2236g in the text entry bar 2236e, the electronic device 500 receives an input 2203 selecting the “done” option. In response to receiving the input shown in FIG. 22DD, the electronic device 500 initiates a process to generate an emoji based on the text 2236g. Because the text 2236g is related to a human occupation, the electronic device 500 presents a user interface for selecting a subject on which to base the emoji prior to displaying an emoji based on text 2236g, as shown in FIG. 22EE.

In FIG. 22EE, electronic device 500 displays the personalization user interface, similar to or the same as the personalization user interface for selecting a subject of the custom emoji. As shown in FIG. 22EE, the electronic device 500 detects an input 2203 detecting option 2216a to create a new subject for the custom emoji. In response to detecting selection input 2203 directed to 2216a in FIG. 22EE, electronic device 500 displays a user interface for selecting characteristics of the emoji, as shown in FIG. 22FF. In some embodiments, in response to detecting the input shown in FIG. 22EE, the electronic device 500 presents a user interface similar to the user interface described with reference to FIG. 22MM below.

For example, electronic device 500 in FIG. 22FF displays the character creation user interface. The character creation user interface in FIG. 22FF is the same as the character creation user interface in FIG. 22O, except the character creation user interface includes an option 2234e associated with an unnatural skin tone (e.g., emoji yellow) in addition to the options 2234a through 2234d corresponding to natural skin tones because the user interface in FIG. 22FF is displayed in the context of creating an emoji, rather than creating the subject for automatically-generated visual content items. In response to detecting the inputs 2203a through 2203c, electronic device 500 updates the emoji to have the characteristics corresponding to the selected options 2232c and 2234e and displays a user interface for providing text inputs specifying additional visual characteristics of the emoji, as shown in FIG. 22GG.

In FIG. 22GG, electronic device 500 displays a representation 2238b of the emoji in accordance with the operations described with reference to FIGS. 22DD through 22FF in a user interface for providing additional description of the emoji. For example, electronic device 500 displays a representation 2238b, including clothing corresponding to the “astronaut” text entered into the text entry region 2236a. Additionally, representation 2238b is based upon the selected selectable options 2232c and 2234e, which correspond to a defined appearance and/or skin tone of representation 2238b. In FIG. 22GG, electronic device 500 detects input 2203, requesting additional text be appended after cursor 2236b. In FIG. 22GG, the electronic device 500 detects an input 2203 directed to the soft keyboard included in a sequence of inputs to add additional text to the text entry field 2236a.

In FIG. 22HH, electronic device 500 updates representation 2238b based upon the additional inputs requesting text entry, as indicated by the additional text included in the text entry region 2236a. For example, electronic device 500 detects input typing “with sunglasses,” and accordingly displays representation 2238b with sunglasses. Thus, similar to as described with reference to the avatar generation process above, electronic device 500 optionally facilitates creating an avatar that corresponds to an emoji and/or that is initiated from an emoji portion of a messaging interface. In FIG. 22HH, electronic device 500 detects input 2203 directed to selectable option 2230, and in response saves the generated emoji to the library of emojis.

In FIG. 22II, electronic device 500 displays the emojis 2254d including the newly generated emoji 2254g. In FIG. 22II, the emoji 2254g is similar to or the same as representation 2238b generated as shown in FIG. 22HH. Additionally, in response to generating the new emoji 2254g, electronic device 500 scales and/or shifts the displayed emojis 2254d. For example, in FIG. 22II, emoji 2254e is at a different position and/or displayed with a different scale than as shown in FIG. 22CC. Thus, completing the emoji generating process optionally changes the position, such as a scrolling position, that is displayed to accommodate the newly generated emoji 2254g. In FIG. 22II, electronic device 500 detects input 2203 directed to an element 2270 associated with operations relating to the operating system of electronic device 500, such as an input requesting switching between user interfaces corresponding to different respective applications. In response to receiving the input 2203 shown in FIG. 22II, the electronic device presents a user interface of a notes application, as shown in FIG. 22JJ.

In FIG. 22JJ, electronic device 500 changes the displayed user interface to correspond to a user interface for a note taking application. In FIG. 22JJ, electronic device 500 displays text 2262 and a text insertion cursor 2236b, corresponding to a preexisting note the user created. In FIG. 22JJ, electronic device 500 detects a plurality of inputs, input 2203a directed to selectable option 2254a, corresponding to a request to display the library of emojis, followed by an input 2203b swiping to display the custom emojis, as shown in FIG. 22JJ.

From FIG. 22JJ to FIG. 22KK, electronic device 500 displays the emojis 2254d in response to detecting the input 2203a. In some embodiments, electronic device 500 displays emojis that are generated (e.g., using one or more machine learning models, as illustrated above). For example, emojis 2254d includes the emoji 2254g, which was previously generated during the avatar and/or character creation processes described above. As shown in FIG. 22KK, the electronic device 500 receives an input selecting emoji 2254g. In response to receiving the input in FIG. 22KK, the electronic device 500 inserts the emoji 2254g into the text 2262, as shown in FIG. 22LL.

FIGS. 22MM-22RR illustrate examples of the electronic device 500 presenting user interfaces to select visual characteristics of a template subject for use in generating automatically-generated visual content. In some embodiments, the template subject includes a skin tone and a body style (e.g., based on gender).

FIG. 22MM illustrates an example user interface to generate and/or customize the appearance of an avatar. In some embodiments, the electronic device displays the user interface in FIG. 22MM in response to detecting input shown in FIG. 22N. In some embodiments, the electronic device displays a user interface similar to the user interface shown in FIG. 22MM in response to detecting input shown in FIG. 22EE while creating a generative emoji, with some differences that are described below.

As shown in FIG. 22MM, the user interface includes skin tone options 2234a through 2234f. In response to detecting selection of one of the options 2234a through 2234f, the electronic device 500 uses the selected skin tone as the skin tone for the template subject. In some embodiments, when displaying the user interface in FIG. 22MM while editing the prompt for creating automatically-generated visual content other than emojis, the skin tone options 2234a through 2234f include skin tones corresponding to natural human skin tones. In some embodiments, when displaying a user interface similar to the user interface in FIG. 22MM while generating an automatically-generated emoji, the skin tone options 2234a through 2234f include skin tones corresponding to natural human skin tones and additional include an option corresponding to a yellow color associated with emojis.

The body style options 2232a through 2232b in FIG. 22MM include example avatars 2266a for the respective style. For example, option 2232a includes female example avatars 2266a; option 2232b includes non-binary example avatars 2266a; and option 2232c includes male example avatars 2266a. In FIG. 22MM, because no skin tone option 2234a through 2234f is currently selected, the example avatars 2266a include avatars having a variety of skin tones included in options 2234a through 2234f. Further, the example avatars 2266a include avatars having a variety of hairstyles, hair colors, facial features, and/or ages.

In FIG. 22MM, while there isn't a skin tone option 2234a through 2234f selected and there isn't a body style option 2232a through 2232c selected, the example avatars 2266a are displayed with a relatively low amount of visual emphasis, such as being blurred, dimmed, de-saturated, and/or translucent. As shown in FIG. 22NN, the electronic device 500 updates the example avatars 2266a over time to show additional and/or alternative example avatars.

The user interface in FIG. 22MM further includes cancel option 2230a and done option 2230b. In response to detecting selection of the cancel option 2230a, such as the tap or long press input with contact 2203, the electronic device 500 displays the previously-displayed user interface without adding a template subject to the prompt for generating the automatically-generated visual content. In some embodiments, once a skin tone is selected from skin tone options 2234a through 2234f and a body style is selected from body style options 2232a through 2232c, in response to detecting selection of the done option 2230b, the electronic device 500 adds the template subject with the selected skin tone and body style to the prompt for generating the automatically-generated visual content and displays a user interface including indications of the prompt components of the prompt, including an indication of the template subject. As shown in FIG. 22MM, while a skin tone and/or body style are not selected, the done option 2230b is disabled, and the electronic device 500 forgoes adding the template subject to the prompt in response to detecting selection of the done option 2230b and continues to display the user interface shown in FIG. 22MM.

FIG. 22NN illustrates the example user interface to generate and/or customize the appearance of the avatar with updated example avatars 2266b. In some embodiments, the electronic device 500 updates the example avatars 2266b included in options 2232a through 2232c in response to detecting a predetermined amount of time pass (e.g., 1, 2, 3, 5, 10, 15, or 30 seconds or one or two minutes) without receiving an input or irrespective of whether or not the electronic device 500 receives an input. Alternatively, in some embodiments, the electronic device 500 does not update the example avatars 2266b included in options 2232a through 2232c unless and until the electronic device 500 receives an input while displaying the user interface shown in FIG. 22NN.

In FIG. 22NN, the electronic device 500 detects an input selecting skin tone option 2234b. For example, the input includes contact 2203nn (e.g., a tap or a long press input). Other inputs (e.g., selection inputs), such as air gesture inputs, voice inputs, and/or inputs received using a hardware device, are possible. In response to detecting the input shown in FIG. 22NN, the electronic device 500 adds the skin tone corresponding to option 2234b to the template for the subject of the automatically-generated visual content and updates avatar images 2266b as shown in FIG. 22OO.

FIG. 22OO illustrates the example user interface to generate and/or customize the appearance of the avatar updated to indicate a selected skin tone. In response to detecting the input described above with reference to FIG. 22NN, the electronic device 500 selects the skin tone associated with option 2234b for the subject template and updates the option 2234b to indicate selection. As shown in FIG. 22OO, the electronic device 500 indicates that option 2234b is selected by displaying the option 2234b with a thicker border than the borders of the other options 2234a and 2234c through 2234f, but other visual indications of selection (e.g., changing the size, shape, translucency, and/or color of option 2234b) are possible.

Additionally, as shown in FIG. 22OO, in response to detecting selection of option 2234b, the electronic device 500 updates avatars 2266c to have the selected skin tone. Additionally, the electronic device 500 displays avatars 2266c in FIG. 22OO with more visual emphasis than the amount of visual emphasis of avatars 2266b in FIG. 22NN. In some embodiments, the electronic device 500 updates the avatars 2266c to show additional and/or alternative subjects with the selected skin tone corresponding to option 2234b based on the passage of time and/or in response to detecting an input, as described above previously, and as shown in FIG. 22PP.

FIG. 22PP illustrates the example user interface to generate and/or customize the appearance of the avatar with updated avatars 2266d having the selected skin tone. The avatars 2266d in FIG. 22PP are different from the avatars 2266c in FIG. 22OO in one or more characteristics such as facial features, hair, and/or age, and have the same skin tone as avatars 2266c corresponding to selectable option 2234b. In some embodiments, the electronic device 500 displays avatars 2266d in response to the predetermined time period passing without receiving an input. In some embodiments, the electronic device 500 does not update the avatars 2266d unless and until the electronic device 500 detects an input.

As shown in FIG. 22PP, the electronic device 500 detects an input selecting option 2232a corresponding to one of the body styles, such as a female body style. As shown in FIG. 22PP, the input optionally includes a contact 2203pp (e.g., a tap or a long press input) of a touch input. Other inputs, such as air gesture inputs, voice inputs, and/or inputs detected with a hardware input device, are possible. In response to detecting the input shown in FIG. 22PP, the electronic device 500 updates the template subject of the prompt to have the selected body style and updates the user interface to indicate that the template subject is added to the prompt.

FIG. 22QQ illustrates the example user interface to generate and/or customize the appearance of the avatar with a skin tone and body style selected. In some embodiments, the electronic device 500 displays the user interface shown in FIG. 22QQ in response to detecting a sequence of inputs selecting a skin tone and body style for the template subject, such as the inputs (e.g., touch inputs with contacts 2203nn and 2203pp) in FIGS. 22NN and 22PP. As shown in FIG. 22QQ, the user interface indicates the user's selections, such as displaying option 2234b with visual emphasis compared to options 2234a and 2234c through 2234f and displaying option 2232a with a checkmark and displaying the avatars 2266d of option 2232a with increased visual emphasis compared to the avatars 2266d of options 2232b and 2232c. Additionally or alternatively, the avatars 2266d of option 2232a in FIG. 22QQ after the user selected option 2232a have increased visual emphasis compared to the avatars 2266c of option 2232a in FIG. 22PP.

Additionally or alternatively, in some embodiments, in response to detecting the inputs selecting the skin tone and body style of the template subject, the electronic device 500 adds the template subject to the prompt for use in generating the automatically-generated visual content. The electronic device 500 displays a representation 2206d of the template subject as a component of the prompt and displays a preview 2204f of the automatically-generated visual media content. In FIG. 22QQ, the prompt includes the template subject without including additional prompt components, so the preview 2204f includes a preview of a template subject having the selected skin tone and body style. In some embodiments, if the prompt included additional prompt components, the electronic device 500 would display representations of those prompt components similar to representation 2206d as described herein and the preview 2204f would include image(s) representing the additional prompt components.

In some embodiments, the electronic device 500 displays the user interface in FIG. 22QQ for generating automatically-generated visual content of a respective style, such as an image having a selected artistic style and/or an image other than an emoji. Thus, in some embodiments, the avatars 2266d in options 2232a through 2232c, representation 2206d, and image preview 2204f have the selected style of the automatically-generated visual content. In some embodiments, if the electronic device 500 was displaying a user interface similar to the user interface of FIG. 22QQ for generating an automatically-generated emoji, then avatars 2266d of options 2232a through 2232c, representation 2206d, and preview 2204f would have an emoji visual style. In some embodiments, the avatars 2266d of option 2232a are the same as the avatars included in representation 2206d.

In some embodiments, the electronic device 500 continues to update the avatars 2266d shown in options 2232a through 2232c and representation 2206d and the image preview 2204f over time in response to a predetermined time passing without receiving an input and/or in response to receiving an input, as shown in FIG. 22RR.

FIG. 22RR illustrates the example user interface to generate and/or customize the appearance of the avatar with a skin tone and body style selected featuring a different subject based on the selected subject template. As described above, in response to detecting the predetermined time pass without receiving an input or, additionally or alternatively in some embodiments, in response to detecting an input (e.g., a selection input, such as a long press or a tap with a contact or other types of inputs described herein, selecting one of the displayed options 2234a through 2234f and/or 2232a through 2232c), the electronic device 500 updates the avatars 2266e featured in options 2232a through 2232c and representation 2206d. The avatars 2266e have the selected skin tone corresponding to option 2234b. The avatars 2266e of options 2232a through 2232c have the respective body styles corresponding to options 2232a through 2232c. The avatars included in representation 2206d are the same as the avatars included in option 2232a and have the selected skin tone and body style. In some embodiments, when the electronic device 500 updates the avatars included in options 2232a through 2232c and representation 2206d, the electronic device 500 updates the appearance of the template subject included in image preview 2204f to be a different subject that has the selected skin tone and body style.

In some embodiments, if the electronic device 500 were to receive an input selecting the cancel option 2230a, the electronic device 500 would remove the template subject from the prompt for generating the automatically-generated visual media content. In some embodiments, if the electronic device 500 were to receive an input selecting the done option 2230b, the electronic device 500 would add the template subject with the selected skin tone and body style to the prompt for generating the automatically-generated visual media content.

FIGS. 22SS-22ZZ illustrate examples of the electronic device 500 generating representations of subjects from a media library for use in generating automatically-generated visual content according to some embodiments of the disclosure.

FIG. 22SS illustrates an example of the electronic device 500 displaying the user interface of a media application for editing a prompt used to generate automatically-generated visual content. The user interface illustrated in FIG. 22SS is similar to user interface in FIG. 22A, the details of which will not be repeated here for the sake of brevity. As shown in FIG. 22SS, the user interface includes representations 2206a and 2206b of prompt components for generating an automatically-generated visual media content corresponding to “monkey” and “hot air balloon,” respectively. The user interface further includes a preview 2204f of automatically-generated visual content based on the prompt components “hot air balloon” and “monkey,” and thus features both of these concepts in the image.

In some embodiments, while the prompt includes the prompt components corresponding to representations 2206a and 2206b, the electronic device 500 receives an input selecting the subject option 2210b. In some embodiments, the input is a touch input including contact 2203ss (e.g., a tap or long press input). Other inputs, such as air gesture inputs, voice inputs, and/or inputs detected using hardware input devices are possible. In response to detecting the input described with reference to FIG. 22SS, the electronic device 500 displays a user interface including various options for adding a subject to the prompt for generating the automatically-generated visual media content, as shown in FIG. 22TT.

FIG. 22TT illustrates an example of the electronic device 500 displaying options 2216a through 2216c and 2218h through 2218m for selecting a subject of the automatically-generated visual content. The user interface shown in FIG. 22TT is similar to the user interface shown in FIG. 22B, the details of which will not be repeated here for brevity.

As shown in FIG. 22TT, the electronic device 500 detects an input selecting option 2218i corresponding to a person in a media library of the electronic device 500. For example, the input is a touch input including contact 2203tt (e.g., a tap or long press input). Other inputs, such as air gesture inputs, voice inputs, and/or inputs received using a hardware input device, are possible. In response to detecting the input described with reference to FIG. 22TT, if the electronic device 500 has not generated a representation of the person corresponding to option 2218i, the electronic device 500 displays a user interface for selecting a representation of the person, as shown in FIG. 22UU. If the electronic device previously generated a representation of the person, then the electronic device 500 would use the existing representation as described below with reference to FIGS. 22AAA-22CCC in response to detecting the input described with reference to FIG. 22TT.

FIG. 22UU illustrates an example of the electronic device 500 displaying a user interface for customizing a representation of a person from the media library of the electronic device 500 for use as a subject of automatically-generated visual media content. The user interface includes a preview 2272a of a representation of the person concurrently displayed with an image 2274a of the person from the media library. In some embodiments, the representation of the person corresponding to preview 2272a has one or more visual characteristics in common with the image 2274a and the image 2274a is displayed overlaid on the preview 2272a of the representation. For example, the preview 2272a has visual characteristics like hair style, eyewear, and/or age in common with those visual characteristics of the image 2274a. In some embodiments, the image 2274a includes additional visual content other than the person that the electronic device 500 does not include in the preview 2272a of the representation of the person or in automatically-generated visual media content including the representation of the person. For example, in FIG. 22UU, the image 2274a includes trees in the background that are not included in the preview 2272a of the representation and will not be included in automatically-generated visual media generated using the subject represented by preview 2272a.

The preview 2272a has a respective visual style that matches the visual style selected for the automatically-generated visual media content when the input corresponding to the request to use the person as the subject was received. For example, the style of preview 2272a is the same as the style selected in FIGS. 22SS and 22TT, which is the style of the preview 2204f of the automatically-generated visual media content in those figures. As described below with reference to method 2300 and as shown in FIGS. 22XX-22ZZ, if a different visual style had been selected, the electronic device 500 would use that visual style for the preview 2272a. In some embodiments, if the electronic device 500 was in the process of creating an automatically-generated emoji, then the preview 2272a would have the visual style of an emoji.

In some embodiments, the user interface further includes a cancel option 2202a and a done option 2202b. In some embodiments, in response to detecting an input selecting the cancel option 2202a, the electronic device 500 returns to the user interface shown in FIG. 22TT without adding the person as the subject of the automatically-generated visual media content and/or optionally does not associate the representation corresponding to preview 2272a with the person. In some embodiments, in response to detecting an input selecting the done option 2202b, the electronic device 500 uses the representation corresponding to the preview 2272a to represent the person and as the subject of the automatically-generated visual media content.

The user interface in FIG. 22UU further includes a portion of a preview 2272b of a different representation of the person featured in the media library of the electronic device 500. As will be described with reference to FIG. 22VV, the preview 2272b is based on a different image of the person included in the media library of the electronic device 500.

As shown in FIG. 22UU, the electronic device 500 receives a directional input corresponding to the direction of the preview 2272b of the other representation of the person. For example, the input includes movement of a contact 2203uu. In some embodiments, other inputs, such as air gesture inputs, voice inputs, and/or inputs detected using a hardware input device, are possible. In some embodiments, in response to detecting the input described with reference to FIG. 22UU, the electronic device 500 displays the preview 2272b of the next representation, as shown in FIG. 22VV.

FIG. 22VV illustrates an example of the electronic device 500 displaying the user interface for customizing the representation of the person from the media library of the electronic device 500 updated to show a preview 2272b of a different representation of the same person from the media library of the electronic device 500. As shown in FIG. 22VV, the electronic device 500 displays the preview 2272b of the representation of the person at the same position in the user interface at which the electronic device 500 displayed the preview 2272a of the representation in FIG. 22UU.

The representation corresponding to preview 2272b has one or more visual characteristics in common with the appearance of the person in the image 2274b. For example, the representation of the person in preview 2272b has the same hairstyle as the hairstyle of the person in image 2274b. Although the image 2274b includes a window in the background, the preview 2272b of the representation of the person does not include a window, and automatically-generated visual media content will not necessarily include a window, either, unless the prompt includes “window” or other object related to a window.

If the electronic device 500 were to receive a directional input while displaying the user interface in FIG. 22VV, the electronic device 500 would display a different preview 2272a or 2272c at the position in the user interface of preview 2272b.

As shown in FIG. 22VV, the electronic device 500 detects an input selecting done option 2202b. For example, the input includes a contact 2203vv with a touch-sensitive surface (e.g., a tap or long press input). Additionally or alternatively, in some embodiments, the selection input includes an air gesture input, a voice input, and/or an input detected using a hardware input device. In response to detecting the input described in FIG. 22VV, the electronic device 500 uses the representation corresponding to preview 2272b as the subject for the automatically-generated visual content, as shown in FIG. 22WW.

FIG. 22WW illustrates an example of the electronic device 500 displaying the user interface of a media application for editing a prompt used to generate automatically-generated visual content with a subject from the media library of the electronic device 500 added to the prompt. In some embodiments, the electronic device 500 displays the user interface in FIG. 22WW in response to detecting the input described with reference to FIG. 22VV. The user interface is the same as the user interface described above with reference to FIG. 22TT, except the electronic device 500 further includes the person selected in FIG. 22UU as the subject of the automatically-generated visual media content, displaying a representation 2206d of the person as a prompt component and updating the preview of the image 2204g to include the person. The appearance of the person in the image 2204g corresponds to the appearance of the person in the representation 2206d. Representation 2206d includes the image from the media library of the electronic device 500 that features the person selected as the subject. In some embodiments, the image of representation 2206d is the same as the image corresponding to the selected representation of the person in FIG. 22VV. The image 2204g in FIG. 22WW has the visual style selected for the automatically-generated visual media content, corresponding to style option 2210c. Option 2210c optionally corresponds to option 1614, 1850, and/or 2020c in FIGS. 16A-16U, 18G-18BB, 20D-20AA, and/or 26A-26P.

FIG. 22XX illustrates another example of the electronic device 500 displaying the user interface of a media application for editing a prompt used to generate automatically-generated visual content. The user interface illustrated in FIG. 22XX is similar to user interface in FIG. 22SS, except option 2210c indicates a different visual style selected for the automatically-generated visual media content than the visual style selected in FIG. 22SS.

As shown in FIG. 22XX, the electronic device 500 detects an input selecting the subject option 2210b. For example, the input includes a contact 2203yy detected using a touch-sensitive surface (e.g., a tap or long press input). Other selection inputs, such as air gesture inputs, voice inputs, and/or inputs detected using a hardware input device, are possible. In some embodiments, in response to detecting the input shown in FIG. 22XX, the electronic device 500 would update the user interface to include options 1626b, 2216a through 2216c and 2218h through 2218m shown in FIG. 22TT. If, while displaying options 1626b, 2216a through 2216c and 2218h through 2218m shown in FIG. 22TT in response to receiving the input described with reference to FIG. 22XX, the electronic device 500 were to detect the input described above with reference to FIG. 22TT, then the electronic device 500 would present the user interface shown in FIG. 22YY.

FIG. 22YY illustrates an example of the electronic device 500 displaying the user interface for customizing the representation of the person from the media library of the electronic device 500. The electronic device 500 optionally displays the user interface shown in FIG. 22YY in response to detecting a sequence of inputs similar to those shown in FIG. 22TT and/or FIG. 22UU, except while the visual style selected in FIG. 22XX is selected instead of the visual style that was selected in FIG. 22TT. The user interface in FIG. 22YY is the same as the user interface in FIG. 22VV except previews 2272a through 2272c of respective representations of the person from the media library of the electronic device 500 use the visual style from FIG. 22XX instead of the visual style from FIG. 22TT.

In FIG. 22YY, the electronic device detects an input selecting done option 2202b. For example, the input includes contact 2203yy (e.g., a tap or long press input). In some embodiments, other selection inputs, such as air gesture inputs, voice inputs, and/or inputs detected using hardware input device(s) are possible. In response to detecting the input described with reference to FIG. 22YY, the electronic device 500 uses the representation of the person corresponding to preview 2272b as the subject for the automatically-generated visual content, as shown in FIG. 22ZZ.

FIG. 22ZZ illustrates an example of the electronic device 500 displaying the user interface of a media application for editing a prompt used to generate automatically-generated visual content with a subject from the media library of the electronic device 500 added to the prompt. The user interface illustrated in FIG. 22ZZ is the same as the user interface shown in FIG. 22WW, except the image 2204i generated based on the prompt includes the visual style indicated by option 2210c in FIG. 22ZZ, instead of the visual style indicated in FIG. 22WW. As described above with reference to FIG. 22WW, and as shown in FIG. 22ZZ, the user interface is updated to include a representation 2206d of the subject selected in FIG. 22YY. Although FIGS. 22WW and 22ZZ are shown with respective visual styles selected for the automatically-generated visual media content, it should be understood that it is possible to change the visual style for the automatically-generated visual media content in response to detecting a sequence of inputs including selection of the visual style option 2210c followed by selection of an option corresponding to a different visual style. In response to detecting this sequence of inputs, the electronic device 500 would update the visual style of the preview image 2204i and would use the updated visual style when generating the automatically-generated visual media content based on the prompt.

In some embodiments, once the electronic device 500 has associated a representation with a person from the media library, the electronic device 500 automatically uses that representation when generating further automatically-generated visual content featuring that person. In some embodiments, it is possible to change the representation of the person, such as by selecting an edit option 2220 similar to the option shown in FIG. 22C, for example. In response to detecting selection of the edit option 2220, in some embodiments, the electronic device 500 displays a user interface similar to the user interface shown in FIG. 22UU.

FIG. 22AAA illustrates an example of the electronic device 500 displaying the user interface for editing a prompt used to generate automatically-generated visual content. In some embodiments, the electronic device 500 displays the user interface shown in FIG. 22AAA after associating the representation shown in FIGS. 22VV and 22YY with the person from the media library of the electronic device 500.

In FIG. 22AAA, the prompt includes “dog,” represented by representation 2206f and “surfing,” represented by representation 2206e. Thus, preview image 2204j shows automatically-generated visual content including a surfing dog.

While displaying the user interface shown in FIG. 22AAA, the electronic device 500 detects an input selecting the option 2210b to add an anthropomorphic (e.g., human) subject to the prompt. For example, detecting the input includes detecting contact 2203aaa (e.g., a tap or long press input). In some embodiments, other selection inputs, such as an air gesture input, a voice input, and/or an input detected using a hardware input device, are possible. In response to detecting the input described with reference to FIG. 22AAA, the electronic device 500 displays the user interface shown in FIG. 22BBB.

FIG. 22BBB illustrates an example of the electronic device 500 displaying options 2216a through 2216c and 2218h through 2218m for selecting a subject of the automatically-generated visual content. These options are described above with reference to FIG. 22TT. As shown in FIG. 22BBB, the option 2218i corresponding to Billy includes the photo the representation of Billy selected in FIGS. 22VV and/or 22YY was based on. Optionally, prior to associating the person with particular images to generate a representation, the option 2218i included a different image associated with that person, such as a contact photo, a different photo selected automatically by the electronic device, and/or initials of the person.

In FIG. 22BBB, the electronic device 500 detects an input selecting option 2218i corresponding to a person (“Billy”) in a media library of the electronic device 500. For example, detecting the input includes detecting contact 2203bbb (e.g., a tap or long press input). In some embodiments, other selection inputs, such as air gesture inputs, voice inputs, and/or inputs detected using a hardware input device, are possible. In response to detecting the input, because the electronic device 500 has previously used a representation of that person to generate automatically-generated visual media content, the electronic device 500 adds the existing representation of the person to the prompt in FIG. 22BBB. For example, in response to detecting the input in FIG. 22BBB, the electronic device 500 updates preview 2204j while continuing to display options 2216a through 2216c and 2218h through 2218m. In some embodiments, the electronic device 500 displays an edit option 2220 shown in FIG. 22C and done option 2214b in response to detecting the input described with reference to FIG. 22BBB. In response to detecting selection of edit option 2220 associated with option 2218i, the electronic device 500 would display the user interface shown in FIG. 22UU to allow the user to select a different representation of the person. In response to selection of done option 2214b, the electronic device 500 would display of the options 2216a through 2216c and 2218h through 2218m, as shown in FIG. 22CCC.

FIG. 22CCC illustrates the user interface for editing the prompt for use in generating the automatically-generated visual content updated to include the selected subject. In some embodiments, the electronic device 500 displays the user interface in FIG. 22CCC in response to detecting the sequence of inputs described above with reference to FIG. 22BBB. The user interface in FIG. 22CCC includes a representation 2206d of the subject, which includes the photo the representation is based on. The user interface in FIG. 22CCC includes an updated preview image 2204j including the subject in the automatically-generated visual content.

FIG. 23 illustrates a flow diagram illustrating a method in which an electronic device presents user interfaces for editing a subject of an automatically-generated visual content item in accordance with some embodiments of the disclosure. The method 2300 is optionally performed at first electronic device and/or electronic devices such as device 100, device 300, or device 500 as described above with reference to FIGS. 1A-1B, 2-3, 4A-4B and 5A-5H. Some operations in method 2300 are, optionally combined and/or order of some operations is, optionally, changed.

As described below, the method 2300 provides ways in which an electronic device creates and/or edits subjects of automatically-generated visual content. Providing efficient ways of creating and/or editing subjects of automatically-generated visual content allows the user to easily and efficiently customize an automatically-generated visual content, thereby reducing the number of inputs needed to generate automatically-generated visual media and reducing erroneous inputs to the electronic device.

In some embodiments, a method 2300 is performed at an electronic device in communication with one or more display generation components and one or more input devices, such as electronic device 500 in FIG. 22A. In some embodiments, the electronic device has one or more of the characteristics of the electronic devices of methods 700, 800, 1000, 1200, 1400, 1500, 1700, 1900, and/or 2100. In some embodiments, the one or more display generation components have one or more of the characteristics of the display generation components of methods 700, 800, 1000, 1200, 1400, 1500, 1700, 1900, and/or 2100. In some embodiments, the one or more input devices have one or more of the characteristics of the one or more input devices of methods 700, 800, 1000, 1200, 1400, 1500, 1700, 1900, and/or 2100.

In some embodiments, while composing (and/or receiving input for composing) a prompt for generation of automatically-generated visual content (e.g., generative visual content), the electronic device detects (2302a), via the one or more input devices, a first set of one or more inputs corresponding to a request to customize an appearance of a subject of the prompt, wherein the subject of the prompt is an anthropomorphic subject such as the input 2203 directed to option 2220 in FIG. 22D. In some embodiments, the prompt is based on one or more user inputs, such as one or more inputs defining one or more recognized concepts based on which the automatically-generated visual content is generated. In some embodiments, the prompt (and/or the inputs for composing the prompt) has one or more of the characteristics of the prompts (and/or the inputs for composing the prompts) for generating automatically-generated visual content described with reference to methods 700, 800, 1000, 1200, 1400, 1500, 1700, 1900, and/or 2100. In some embodiments, an automatically-generated visual content refers to any visual content created by the electronic device based on a prompt. Some examples of automatically-generated visual content include, but are not limited to, images, animations, or videos that incorporate and visualize one or more characteristics and/or modifications specified in the prompt. In some embodiments, the automatically-generated visual content has one or more of the characteristics of the automatically-generated visual content described with reference to methods 700, 800, 1000, 1200, 1400, 1500, 1700, 1900, and/or 2100. In some embodiments, the subject of the prompt refers to the main focus or key entity around which the automatically-generated visual content is generated. In some embodiments, the subject is an anthropomorphic figure (e.g., a human, humanoid character, or an anthropomorphized creature or object), meaning a figure or entity that is attributed human characteristics or behaviors. In some embodiments, the subject is a virtual representation of a real individual, whose likeness is generated based on data inputs such as photographs or biometric information. In some embodiments, the subject is a fictional character designed according to user specifications or selected from a database of pre-existing character designs the user can modify. In some embodiments, the subject is a virtual representation of a group of characters (e.g., two or more individuals), where the prompt allows customization of each individual within the group. In some embodiments, the appearance of the subject refers to one or more visual characteristics of the subject as depicted in the automatically-generated visual content. Some examples of visual characteristics include, but are not limited to, physical features such as facial structure, facial features, facial expressions, gender, body shape, body movements/position, skin tone, skin complexion, hair style/color, eye color/shape/size, age, height, build, tattoos/piercings/body art, cosmetic features (e.g., eyeshadow, lipstick, blush, and/or nail color), prosthetics, and any other feature which defines a physical characteristic of the subject. In some embodiments, the appearance of the subject includes clothing, accessories, and/or other stylistic details that define how the subject is presented visually within the automatically-generated visual content. In some embodiments, the appearance is altered to fit different artistic styles, such as realistic, cartoonish, or abstract, depending on the user's preferences, and/or one or more characteristics of the prompt and/or the automatically-generated visual content. In some embodiments, the appearance of the subject is adapted automatically to different environmental contexts shown within the automatically-generated visual content (e.g., changing the subject's attire automatically to match a specific historical era, geographic location, or action specified by the prompt and/or a user input). In some embodiments, the first one or more inputs corresponding to the request to customize the appearance of the subject include one or more selection inputs, such as a tap or a long press with a contact (e.g., a finger, or stylus), selection with an indirect input device (e.g., mouse, remote control, or trackpad) that is directed to a location of a selectable option, or focus indicator such as a cursor or selection ring) and/or a gaze input (optionally as part of an air gesture).

In some embodiments, in response to detecting the first set of one or more inputs, the electronic device displays (2302b), via the one or more display generation components, an editing user interface for customizing the appearance of the subject of the prompt, including one or more selectable options for customizing an appearance of the subject in an automatically-generated visual content generated based on the prompt (e.g., an automatically-generated visual content that will be generated based on the prompt, such as described with reference to methods 700, 800, 1000, 1200, 1400, 1500, 1700, 1900, and/or 2100), such as the menu including options 2224a through 2224d in FIG. 22D. In some embodiments, the editing user interface includes tools, menus, sliders, and/or other interactive elements that allow the user to visualize changes in real-time or near real-time and apply various modifications to the subject's appearance (e.g., in a preview of the automatically-generated visual content, as described with reference to methods 700, 800, 1000, 1200, 1400, 1500, 1700, 1900, and/or 2100). In some embodiments, the one or more selectable options for customizing the appearance of the subject refer to a variety of tools and/or choices that are interactable through the editing user interface (e.g., in response to input detected by the electronic device), which allow for the modification of visual elements of the subject in the automatically-generated visual content. In some embodiments, the editing user interface is displayed prior to the generation of the automatically-generated visual content (e.g., while the electronic device is displaying and/or generating a preview of the automatically-generated visual content)

In some embodiments, while displaying the editing user interface, the electronic device detects (2302c), via the one or more input devices, a second set of one or more inputs corresponding to selection of a respective option of the one or more selectable options for customizing the appearance of the subject (e.g., detecting a tap input directed to the respective option, detecting an air pinch or air tap gesture while attention of the user is directed to the respective option, and/or detecting a selection input while a focus selector such as a cursor is directed to the respective option), such as one of the inputs 2203a through 2203d in FIG. 22E. In some embodiments, the second set of one or more inputs has one or more characteristics of the first set of one or more inputs described above. In some embodiments, the selection of the respective option of the one or more selectable options for customizing the appearance of the subject refers to the user action of choosing a specific option provided within the editing user interface that pertains to altering the appearance of the anthropomorphic subject in the automatically-generated visual content (e.g., via a click, touch, or other command).

In some embodiments, in response to detecting the second set of one or more inputs corresponding to selection of the respective option, the electronic device initiates (2302d) a process for customizing the appearance of the subject based on the respective option (e.g., selecting a value of a parameter corresponding to the respective option or displaying a user interface for selecting a value of a parameter corresponding to the respective option), such as updating the appearance of the subject in FIG. 22G in response to detecting the input 2203 in FIG. 22F. In some embodiments, the process for customizing the appearance of the subject based on the respective option involves a series of automated steps executed by the electronic device to apply the specific changes selected by the user to the anthropomorphic subject within the automatically-generated visual content. Displaying an editing user interface with one or more selectable options for customizing the appearance of the subject (e.g., specific attributes of the subject) in an automatically-generated visual content avoids the processing resources required to generate an automatically-generated visual content that has an erroneous appearance, and also avoids the need for user input to correct such an error, thereby improving device performance and reducing unnecessary processing. In addition, the one or more selectable options for customizing the appearance of the subject provide a quick and efficient way to customize an automatically-generated visual content, rather than requiring the automatically-generated visual content to be created by hand or stylus.

In some embodiments, the editing user interface includes a first representation of a first candidate subject for the prompt, and a second representation of a second candidate subject for the prompt, such as options 2218a and 2218b in FIG. 22C. In some embodiments, a candidate subject refers to a potential subject that the user optionally selects to become the focus of the automatically-generated visual content. In some embodiments, the first and second candidate subjects are anthropomorphic subjects different from each other and/or the subject of the prompt. In some embodiments, a representation of a candidate subject refers to the visual depiction or illustration of a candidate subject within the editing user interface. Some examples of a representation of a candidate subject include, but are not limited to, an image, an emoji, a sketch, a digital model, or any other form of visual media that conveys the appearance and/or one or more characteristics of the candidate subject.

In some embodiments, the second set of one or more inputs includes selection of the first representation of the first candidate subject (e.g., a user action choosing a specific visual representation of a corresponding candidate subject within the editing user interface, such as a tap input, a mouse click input, or an air gesture input selecting the first representation of the first candidate subject), such as input 2203 in FIG. 22B.

In some embodiments, initiating the process for customizing the appearance of the subject includes customizing the appearance of the subject based on the first candidate subject, such as using the subject corresponding to option 2218a selected in FIG. 22B as the subject of the automatically-generated visual content in FIG. 22D. In some embodiments, customizing the appearance of the subject based on the first candidate subject involves the electronic device replacing the subject of the automatically-generated visual content with the selected first candidate subject (e.g., when there is already a subject of the prompt) or including the selected first candidate subject as the subject of the prompt (e.g., when there is no current subject of the prompt). In some embodiments, customizing the appearance of the subject based on the first candidate subject refers to the process executed by the electronic device which modifies the appearance of the subject of the automatically-generated visual content to adopt one or more characteristics of the selected first candidate subject. Initiating the customization process based on the first candidate subject in response to detecting the selection of the first representation of the first candidate subject conserves computational resources by allowing the device to adopt characteristics from an existing visual representation, rather than generating new attributes from scratch.

In some embodiments, the editing user interface includes a preview representation of the automatically-generated visual content generated based on the prompt, and initiating the process for customizing the appearance of the subject based on the first candidate subject includes updating the preview representation of the automatically-generated visual content to be based on the first candidate subject, such as displaying representation 2204b in FIG. 22D with the subject corresponding to option 2218a selected in FIG. 22C. In some embodiments, the preview representation has one or more of the characteristics of the preview representations described with reference to methods 700, 800, 1000, 1200, 1400, 1500, 1700, 1900, and/or 2100. In some embodiments, the preview representation of the automatically-generated visual content refers to an interim visual depiction provided by the electronic device within the editing user interface that illustrates how the automatically-generated visual content will appear once fully processed. In some embodiments, the preview representation is a lower-resolution and/or simplified version of the automatically-generated visual content. In some embodiments, the preview representation dynamically updates in real-time as the user provides input via the editing user interface. In some embodiments, updating the preview representation of the automatically-generated visual content to be based on the first candidate subject involves the electronic device replacing the subject of the automatically-generated visual content displayed in the preview representation with the selected first candidate subject (e.g., when there is already a subject of the prompt) or including the selected first candidate subject as the subject of the prompt in the preview representation (e.g., when there is no current subject of the prompt). In some embodiments, updating the preview representation of the automatically-generated visual content to be based on the first candidate subject involves the electronic device modifying the preview representation to reflect the appearance and/or one or more characteristics of the selected first candidate subject. Updating the preview representation of the automatically-generated visual content to reflect the first candidate subject enhances user interaction efficiency by providing visual feedback, allowing users to see real-time changes and make informed decisions about further customizations without waiting for full processing, thereby conserving time and reducing computational demands on the electronic device.

In some embodiments, the editing user interface includes a first selectable option for initiating a process to capture a photo using a camera associated with the electronic device (e.g., a feature that allows the user to activate the camera functionality of their device directly from the editing user interface), such as option 2216b in FIG. 22C.

In some embodiments, while displaying, via the one or more display generation components, the editing user interface, the electronic device detects, via the one or more input devices, a third set of one or more inputs including selection of the first selectable option (e.g., one or more of a tap input, a mouse click input, or an air gesture input selecting the first selectable option, which is directed to the first selectable option (e.g., based on a location of a touch input, a location of a cursor or location of attention of a user (e.g., based on gaze)), such as an input selecting option 2216b similar to input 2203 in FIG. 22D selecting option 2220. In some embodiments, the third set of one or more inputs has one or more characteristics of the first and/or second sets of inputs described herein.

In some embodiments, in response to detecting the third set of one or more inputs, the electronic device displays, via the one or more display generation components, a camera user interface that includes a representation of a physical environment of the electronic device that is captured using the camera, such as displaying a camera user interface in response to detecting selection of option 2216b in FIG. 22D. In some embodiments, the camera user interface refers to the graphical interface displayed via the one or more display generation components when the camera function associated with the first selectable option is selected. In some embodiments, the camera user interface has one or more functions typically associated with a camera, such as controls for taking pictures and/or adjusting settings (e.g., focus, zoom, exposure). In some embodiments, the camera user interface shares functionalities with the camera of the electronic device. In some embodiments, the camera user interface including a representation of the physical environment of the electronic device that is captured using the camera refers to the camera user interface displaying a live feed or real-time image captured by the electronic device's camera. In some embodiments, the camera user interface has one or more of the characteristics of the camera user interface described with reference to method 1200.

In some embodiments, while displaying the camera user interface, the electronic device detects, via the one or more input devices, a fourth set of one or more inputs (e.g., one or more of a tap input, a mouse click input, or an air gesture input selecting a capture option, which is directed to the capture option (e.g., based on a location of a touch input, a location of a cursor or location of attention of a user (e.g., based on gaze)) corresponding to a request to use a captured subject (e.g., a person, animal, and/or other object) in the representation of the physical environment of the electronic device that is captured using the camera as the subject of the prompt (e.g., a user-initiated command or selection within the camera user interface that indicates the intention of the user to utilize the live image or recorded scene from the camera as the main focus for generating the visual content), such as using the captured image as the subject in an automatically-generated visual content item, similar to using the subject corresponding to option 2218a as the subject in a representation 2204b of an automatically-generated visual content item in FIG. 22D in response to detecting the input 2203 in FIG. 22B. In some embodiments, the fourth set of one or more inputs has one or more characteristics of the first, second, and/or third sets of inputs described herein.

In some embodiments, in response to detecting the fourth set of one or more inputs, the electronic device initiates a process to use the captured subject in the representation of the physical environment of the electronic device that is captured using the camera as the subject of the prompt (e.g., a method by which the electronic device incorporates the captured image or video of the environment into the automatically-generated visual content), such as using the captured image as the subject in an automatically-generated visual content item, similar to using the subject corresponding to option 2218a as the subject in a representation 2204b of an automatically-generated visual content item in FIG. 22D in response to detecting the input 2203 in FIG. 22B. In some embodiments, the process to use the representation of the physical environment of the electronic device has one or more characteristics of the process for customizing the appearance of the subject based on the respective option and/or a candidate subject. In some embodiments, the process to use the representation of the physical environment of the electronic device includes the electronic device analyzing the representation of the physical environment to detect an anthropomorphic subject, which the electronic device then utilizes as the subject of the prompt. In some embodiments, the process to use the representation of the physical environment of the electronic device includes the electronic device analyzing the representation of the physical environment to extract one or more visual elements from the captured environment (e.g., colors, textures, shapes, objects, backgrounds, subjects, actions/gestures being performed, lighting conditions, and/or any other recognizable element that contributes to generating the automatically-generated visual content). Integrating a camera user interface that displays a real-time representation of the physical environment directly within the editing user interface reduces the need for switching between different applications to capture photos, thereby streamlining the content creation process and conserving computational resources by minimizing the load on the electronic device's processing capabilities.

In some embodiments, the editing user interface includes a first selectable option for initiating a process to generate a new candidate subject for the prompt (e.g., a specific feature or tool within the editing user interface for creating a new potential subject), such as option 2216a in FIG. 22N. In some embodiments, the process to generate the new candidate subject for the prompt involves collecting one or more inputs from the user specifying preferences for one or more characteristics of the new candidate subject. In some embodiments, the process to generate a new candidate subject for the prompt involves the electronic device using generative algorithms to assemble a subject that aligns with the one or more characteristics. In some embodiments, the process to generate a new candidate subject for the prompt includes displaying the generated candidate subject in the editing user interface alongside additional candidate subjects (e.g., first and second candidate subjects) awaiting user selection.

In some embodiments, while displaying, via the one or more display generation components, the editing user interface, the electronic device detects, via the one or more input devices, a third set of one or more inputs including selection of the first selectable option (e.g., one or more of a tap input, a mouse click input, or an air gesture input selecting the first selectable option, which is directed to the first selectable option (e.g., based on a location of a touch input, a location of a cursor or location of attention of a user (e.g., based on gaze)), such as input 2203 selecting option 2216a in FIG. 22N. In some embodiments, the third set of one or more inputs has one or more characteristics of any of the sets of one or more inputs described herein.

In some embodiments, in response to detecting the third set of one or more inputs, the electronic device displays, via the one or more display generation components, a subject generation user interface that includes one or more options for customizing a generated candidate subject, such as the user interface shown in FIG. 22O including options 2232a through 2232c and 2234a through 2234d. In some embodiments, the subject generation user interface refers to a user interface designed for the creation and/or customization of new candidate subjects. In some embodiments, the subject generation user interface includes tools, features, options, and/or controls for modifying one or more characteristics and/or the appearance of the generated candidate subject. Some examples of the one or more options for customizing the generated candidate subject include options for customizing one or more of the candidate subject's physical appearance (e.g., skin tone, texture, color, body shape/size, facial features, hair style/color/texture, eye color/shape, tattoos, scars, birthmarks, prosthetics/medical aids, and/or age), apparel and/or accessories (e.g., clothing styles/fabrics, footwear, headgear, jewelry and ornamentation, glasses, watches, and/or belts), poses and/or gestures (e.g., static or dynamic poses, hand gestures, and/or facial expressions), background/environment (e.g., environmental setting, and/or weather conditions), and/or any other characteristic that may influence the appearance of a subject in the automatically-generated visual content.

In some embodiments, while displaying the subject generation user interface, the electronic device detects, via the one or more input devices, a fourth set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to a request to use the generated candidate subject as the subject of the prompt, such as input 2203 in FIG. 22T selecting option 2203b. In some embodiments, the fourth set of one or more inputs has one or more characteristics of any of the sets of one or more inputs described herein. In some embodiments, the request to use the generated candidate subject as the subject of the prompt refers to a user-initiated action within the subject generation user interface or the editing user interface that signals the desire to select the newly generated candidate subject as the primary focus for the automatically-generated visual content.

In some embodiments, in response to detecting the fourth set of one or more inputs, the electronic device initiates a process to use the generated candidate subject as the subject of the prompt, such as displaying representation 2204d of automatically generated visual content using the generated candidate subject as the subject in FIG. 22U. In some embodiments, the process to use the generated candidate subject as the subject of the prompt refers to the sequence of operations performed by the electronic device to integrate the generated candidate subject into the automatically-generated visual content as its main focus. In some embodiments, the process to use the generated candidate subject as the subject of the prompt involves updating a representation or preview of the automatically-generated visual content to replace an existing subject with the generated candidate subject. In some embodiments, the process to use the generated candidate subject as the subject of the prompt involves integrating one or more characteristics of the generated candidate subject into the automatically-generated visual content. Implementing a subject generation user interface that allows users to create and customize new candidate subjects directly within the editing interface conserves processing resources and enhances user efficiency by eliminating the need to switch between multiple software tools or platforms, thereby streamlining the process of generating personalized visual content.

In some embodiments, the one or more selectable options include one or more options to select a body style for the subject of the prompt (e.g., via one or more of a tap input, a mouse click input, or an air gesture input selecting the first representation of the first candidate subject), such as options 2232a through 2232c in FIG. 22O. In some embodiments, the body style for the subject of the prompt refers to the specific configuration or design of the body of the subject in the automatically-generated visual content, incorporating a range of physical attributes that define the appearance and/or form of the body of the subject. Some examples of physical attributes that may define the body style include, but are not limited to, gender, shape/proportion (e.g., muscular, slender, curvy, stocky, and/or specific body part sizing), size/height, posture, and/or physical condition, and/or any other relevant physical characteristics that contribute to the overall body configuration of the subject. Including selectable options for body style customization allows the electronic device to streamline the rendering process by applying predefined body style parameters, reducing the computational load associated with dynamically generating complex body configurations from scratch.

In some embodiments, the body style that can be selected for the subject of the prompt is based on gender, such as options 2232a through 2232c in FIG. 22O. In some embodiments, selecting a gender for the subject sets a baseline for one or more physical characteristics that traditionally align with said gender. For example, choosing a female gender may correspond with a body style with curvier body shapes, specific facial features, a default posture, specific body parts, and/or other characteristics associated with the female gender; choosing a male gender may correspond with a body style with broader shoulders, taller stature, muscular features, and/or other characteristics associated with the male gender; and choosing a different gender may correspond with a body style with a mix of traditionally masculine and feminine traits. Some examples of genders include, but are not limited to, male, female, gender neutral, nonbinary, agender, genderfluid, genderqueer, two-spirit, not specified, and any other gender identity. In some embodiments, upon selecting a gender, the subject generation user interface displays one or more customization features that are particularly relevant to the chosen gender. In some embodiments, the electronic device learns from the customization choices of the user post-gender selection to refine its understanding and future suggestions of gender-specific body styles. By basing the body style selection on gender, the electronic device streamlines the customization process by providing tailored options that align with gender-specific characteristics, reducing the need for extensive manual adjustments and enhancing processing efficiency during media generation.

In some embodiments, the one or more options to select the body style for the subject of the prompt include a first option associated with a first body style, such as body style options 2232a through 2232c in FIG. 22MM. As described above, in some embodiments, the first body style corresponds to a first gender. In some embodiments, the one or more options to select the body style include a second option associated with a second body style (e.g., a second gender) different from the first body style (e.g., different from the first gender). In some embodiments, other numbers of body styles (e.g., genders), such as 3 or 4 or more, with associated options are available. In some embodiments, in response to detecting selection of the first option, the electronic device uses the first body style for the template subject. In some embodiments, in response to detecting selection of the second option, the electronic device uses the second body style for the template subject.

In some embodiments, the electronic device displays, via the one or more display generation components, a representation of the first body style including a plurality of (e.g., 2, 3, 4, 5, 10, or 20) representations of template subjects having the first body style, such as avatars 2266a in FIG. 22MM. In some embodiments, the representation of the first body style is displayed proximate to the first option associated with the first body style. In some embodiments, the first option includes the representation of the first body style. In some embodiments, the electronic device displays a representation of the second body style including a plurality of representations of template subjects having the second body style. In some embodiments, the representation of the second body style is displayed proximate to the first option associated with the second body style. In some embodiments, the second option includes the representation of the second body style. In some embodiments, if a first skin tone or a first range of skin tones is selected in the editing user interface, the representations of the plurality of template subjects have the first skin tone or the first range of skin tones. In some embodiments, if a second skin tone or a second range of skin tones different from the first skin tone or the first range of skin tones is selected in the editing user interface, the representations of the plurality of template subjects have the second skin tone or the second range of skin tones. In some embodiments, if a skin tone or a range of skin tones is not selected in the editing user interface, the representations of the plurality of template subjects have a variety of skin tones, optionally including the first skin tone, the first range of skin tones, the second skin tone, the second range of skin tones, and/or additional skin tones and/or ranges of skin tones available for selection. In some embodiments, the plurality of template subjects having the first body style are template subjects representing different anthropomorphic subjects. Displaying a plurality of representations of template subjects having the first body style in the editing user interface enhances user interactions with the electronic device by providing improved visual feedback to the user, therefore reducing inputs and/or user errors, which decreases power consumption and/or improves battery life of the electronic device.

In some embodiments, displaying the representation of the first body style includes changing an appearance of the plurality of representations of template subjects over time (e.g., changing over time automatically, without user input), such as replacing avatars 2266a in FIG. 22MM with avatars 2266b in FIG. 22NN.

In some embodiments, at a first time, the electronic device 500 displays, via the one or more display generation components, a first plurality of representations of template subjects having the first body style, such as avatars 2266a of option 2232a in FIG. 22MM. In some embodiments, displaying the representation of the first body style includes displaying an animation of the plurality of representations of template subjects having the first body style changing over time. In some embodiments, the first plurality of representations of template subjects having the first body style have one or more of the characteristics of the plurality of representations of template subjects having the first body style described above, including characteristics related to skin tone and/or being representative of different anthropomorphic subjects, for example.

In some embodiments, at a second time different from the first time, the electronic device displays, via the one or more display generation components, a second plurality of representations of template subjects having the first body style different from the first plurality of representations of template subjects having the first body style, such as avatars 2266b of option 2232a in FIG. 22NN. In some embodiments, the electronic device transitions from displaying the first plurality of representations of template subjects having the first body style without receiving a user input requesting to view the second plurality of representations of template subjects. In some embodiments, the electronic device presents a new plurality of representations of template subjects having the first body style after a predetermined time period has passed since updating the representations of the template subjects. In some embodiments, the second plurality of representations of template subjects having the first body style have one or more of the characteristics of the plurality of representations of template subjects having the first body style described above, including characteristics related to skin tone and/or being representative of different anthropomorphic subjects, for example. In some embodiments, displaying the representation of the second body style includes, at a third time, displaying, via the one or more display generation components, a first plurality of representations of template subjects having the second body style and at a fourth time different from the third time, displaying, via the one or more display generation components, a second plurality of representations of template subjects having the second body style different from the first plurality of representations of template subjects having the second body style similar to the manner of displaying the plurality of representations of template subjects having the first body style. In some embodiments, the first and third time are the same (e.g., the electronic device updates the representations of template subjects having the first body style at the same time as updating the representations of the template subjects having the second body style). In some embodiments, the first and third time are different (e.g., the electronic device updates the representations of template subjects having the first body style at a different time from updating the representations of template subjects having the second body style). Automatically transitioning from displaying the first plurality of representations of template subjects having the first body style to displaying the second plurality of representations of template subjects having the first body style enhances user interactions with the electronic device by providing improved visual feedback to the user, thereby reducing inputs and/or user errors, which reduces power consumption of the electronic device and/or improves battery life of the electronic device.

In some embodiments, the one or more selectable options include one or more options to select a skin tone for the subject of the prompt, such as options 2234a through 2234f in FIG. 22MM. In some embodiments, the one or more selectable options include a first option to select a first skin tone and/or a first range of skin tones and a second option to select a second skin tone and/or a second range of skin tones different from the first skin tone and/or first range of skin tones. In some embodiments, in response to detecting selection of the first option, the electronic device uses the first skin tone and/or the first range of skin tones for the anthropomorphic subject. In some embodiments, in response to detecting selection of the second option, the electronic device uses the second skin tone and/or the second range of skin tones for the anthropomorphic subject.

In some embodiments, displaying the representation of the first body style including the plurality of representations of template subjects having the first body style includes, in accordance with a determination that the one or more options to select the skin tone for the subject of the prompt are not selected, displaying a first plurality of representations of template subjects having the first body style, where the first plurality of representations include template representations with different skin tones, such as avatars 2266a in FIG. 22MM. In some embodiments, the first plurality of representations of template subjects having the first body style include subjects having the first skin tone (or skin tones in the first range of skin tones) and representations of template subjects having the second skin tone (or skin tones in the second range of skin tones). In some embodiments, the representation of the second body style includes a first plurality of representations of template subjects having the second body style, including template subjects having the first skin tone (or skin tones in the first range of skin tones) and representations of template subjects having the second skin tone (or skin tones in the second range of skin tones). In some embodiments, the electronic device (e.g., periodically without receiving a user input) updates the representation of the first body style to include different representations of different template subjects, including template subjects having the first skin tone (or skin tones in the first range of skin tones) and representations of template subjects having the second skin tone (or skin tones in the second range of skin tones) as described above. In some embodiments, the electronic device (e.g., periodically without receiving a user input) updates the representation of the second body style to include different representations of different template subjects, including template subjects having the first skin tone (or skin tones in the first range of skin tones) and representations of template subjects having the second skin tone (or skin tones in the second range of skin tones) as described above.

In some embodiments, displaying the representation of the first body style including the plurality of representations of template subjects having the first body style includes in accordance with a determination that a respective skin tone option of the one or more options to select the skin tone for the subject of the prompt is selected, displaying a second plurality of representations of template subjects having the first body style different from the first plurality of representations of template subjects having the first body style, where the second plurality of representations have the respective skin tone (optionally including slight variants of the respective skin tone), such as avatars 2266d in FIG. 22PP. In some embodiments, the second plurality of representations of template subjects have a skin tone matching the selected skin tones or skin tones in the selected range of skin tones. In accordance with a determination that a first option corresponding to a first skin tone or a first range of skin tones is selected in the editing user interface, the second plurality of representations of template subjects with the first body style have the first skin tone or skin tones in the first range of skin tones. In accordance with a determination that a second option corresponding to a second skin tone or a second range of skin tones is selected in the editing user interface, the second plurality of representations of template subjects with the first body style have the second skin tone or skin tones in the second range of skin tones. In some embodiments, in accordance with a determination that a respective skin tone option of the one or more options to select the skin tone for the subject of the prompt is selected, displaying the representation of the second body style includes displaying a second plurality of representations of template subjects having the second body style different from the first plurality of representations of template subjects having the second body style in a manner similar to the manner of displaying the second plurality of template subjects having the first body style. In some embodiments, the electronic device (e.g., periodically and/or automatically without receiving an input) updates the representations of template subjects having the first body style and selected skin tone as described above. In some embodiments, the electronic device (e.g., periodically and/or automatically without receiving an input) updates the representations of template subjects having the second body style and selected skin tone as described above. Displaying a first plurality of representations of template subjects with the first body style or the second plurality of representations of template subjects with the first body style as described above depending on whether or not a respective skin tone option is selected in the editing user interface enhances user interactions with the electronic device by providing improved visual feedback to the user, which reduces inputs and/or user errors and reduces power consumption and/or improves battery life of the electronic device.

In some embodiments, displaying the representation of the first body style includes, prior to receiving a second set of one or more inputs, displaying, via the one or more display generation components, a first plurality of representations of template subjects having the first body style, such as avatars 2266d of options 2232a through 2232c in FIG. 22PP. In some embodiments, prior to receiving the second set of one or more inputs, the first plurality of representations of template subjects with the first body style include representations corresponding to a plurality of possible inputs. In some embodiments, the first plurality of representations of the template subjects having the first body style include representations corresponding to selection of a first option (e.g., representations of template subjects having the first body style and a first value for a respective characteristic other than body style) and representations corresponding to selection of a second option (e.g., representations of template subjects having the first body style and a second value different from the first value for the respective characteristic other than body style). For example, as described above, prior to detecting an input selecting an option corresponding to a respective skin tone or a respective range of skin tones, the first plurality of representations of template subjects having the first body style include template subjects with the first body style having a first skin tone or skin tones in a first range of skin tones and template subjects with the first body style having a second skin tone different from the first skin tone or a skin tones in a second range of skin tones different from the first range of skin tones. In some embodiments, prior to receiving the second set of one or more inputs, the electronic device displays a plurality of representations of template subjects with the second body style including representations corresponding to a plurality of possible inputs. In some embodiments, the plurality of representations of the template subjects having the second body style include representations corresponding to selection of a first option (e.g., representations of template subjects having the second body style and a first value for a respective characteristic other than body style) and representations corresponding to selection of a second option (e.g., representations of template subjects having the second body style and a second value different from the first value for the respective characteristic other than body style).

In some embodiments, the electronic device receives, via the one or more input devices, the second set of one or more inputs, such as input (e.g., a tap or a long press input) including contact 2203pp in FIG. 22PP. In some embodiments, the second set of one or more inputs include an input selecting an option corresponding to a respective skin tone or a respective range of skin tones. In some embodiments, the second set of one or more inputs includes selection of an option related to a characteristic other than skin tone, such as an option selecting a first value for the characteristic or an option selecting a second value different from the first value for the characteristic. The input optionally includes one or more of a touch gesture (e.g., a tap on a touch-sensitive surface), an air gesture (e.g., detected via one or more cameras), attention (e.g., including gaze, detected via one or more cameras and/or an eye tracking device), a voice input (e.g., detected via one or more microphones), and/or an input received using a hardware input device (e.g., a mouse, keyboard, and/or trackpad).

In some embodiments, in response to receiving the second set of one or more inputs, the electronic device updates the representation of the first body style to include a second plurality of representations of template subjects having the first body style different from the first plurality of representations of template subjects having the first body style in accordance with the second set of one or more inputs, such as avatars 2266d of options 2232a through 2232c in FIG. 22QQ. In some embodiments, in response to receiving the one or more inputs, the first plurality of representations of template subjects with the first body style include representations corresponding to the second set of one or more inputs. In some embodiments, the second plurality of representations of the template subjects having the first body style include representations corresponding to the second set of one or more inputs selecting a first value for a first characteristic other than body style (e.g., representations of template subjects having the first body style and the first value for a respective characteristic other than body style), and do not include representations corresponding to other inputs that were possible prior to receiving the second set of one or more inputs (e.g., representations of template subjects having the first body style and a second value different from the first value for the respective characteristic other than body style). For example, as described above, in response to detecting an input selecting an option corresponding to a first skin tone or a first range of skin tones, the second plurality of representations of template subjects having the first body style include template subjects with the first body style having a first skin tone or skin tones in a first range of skin tones do not include template subjects with the first body style having a second skin tone different from the first skin tone or a skin tones in a second range of skin tones different from the first range of skin tones. In some embodiments, in response to receiving the second set of the one or more inputs, the electronic device displays a plurality of representations of template subjects with the second body style including representations corresponding to the second set of one or more inputs. In some embodiments, the plurality of representations of the template subjects having the second body style include representations corresponding to the second set of one or more inputs selecting a first value for a characteristic other than body style (e.g., representations of template subjects having the second body style and the first value for the characteristic other than body style) and do not include representations corresponding to other inputs possible prior to detecting the second set of one or more inputs (e.g., representations of template subjects having the second body style and a second value different from the first value for the respective characteristic other than body style). Displaying the first plurality of representations of template subjects or the second plurality of representations of template subjects depending on whether or not the electronic device detected the second set of one or more inputs enhances user interactions with the electronic device by providing improved visual feedback to the user, thereby reducing user inputs and/or user errors and/or reducing power usage and/or increasing battery life of the electronic device.

In some embodiments, displaying the first plurality of representations of template subjects having the first body style includes displaying, via the one or more display generation components, the first plurality of representations of template subjects having the first body style with a first amount of visual emphasis, such as avatars 2266b in FIG. 22NN.

In some embodiments, displaying the second plurality of representations of template subjects having the first body style includes displaying, via the one or more display generation components, the second plurality of representations of template subjects having the first body style with a second amount of visual emphasis greater than the first amount of visual emphasis, such as avatars 2266c in FIG. 22OO. In some embodiments, the first amount of visual emphasis corresponds to being more dimmed, more faded, desaturated and/or more blurred than the second amount of visual emphasis. In some embodiments, the second set of one or more inputs includes one or more inputs selecting a respective skin tone and/or a respective range of skin tones for the template subject. In some embodiments, the second set of one or more inputs includes one or more inputs selecting a body style of the template subject. In some embodiments, prior to detecting the second set of one or more inputs, the electronic device displays representations of template subjects having the first body style with the first amount of visual emphasis. In some embodiments, in response to detecting the second set of one or more inputs, the electronic device displays representations of template subjects having the first body style with the second amount of visual emphasis. Increasing the visual emphasis of the representations of template subjects in response to detecting the second set of one or more inputs enhances user interactions with the electronic device by providing improved visual feedback to the user, which reduces user error and/or user inputs, and optionally reduces power usage and/or increases battery life at the electronic device.

In some embodiments, the one or more selectable options for customizing the appearance of the subject include a plurality of options for customizing different aspects of the appearance of the subject, such as options 2232a through 2232c and 2234a through 2234d in FIG. 22O. In some embodiments, the plurality of options for customizing different aspects of the appearance of the subject refers to a range of selectable choices provided within the editing user interface that allow the user to modify various components of the appearance of the subject in the automatically-generated visual content. In some embodiments, the plurality of options includes tools for altering physical attributes, attire, accessories, and other characteristics, as described in greater detail herein. In some embodiments, multiple customization options are displayed concurrently within the editing user interface. In some embodiments, options that are commonly modified together are grouped in the editing user interface. For example, features that define the face may be grouped together in a first panel, while clothing and accessory choices may be grouped in a second panel. In some embodiments, the electronic device adapts the grouping of options based on an input by the user. In some embodiments, the electronic device dynamically updates the user interface to reflect changes as they are applied (e.g., by updating the one or more selectable options and/or a preview of the automatically-generated visual content). Providing a plurality of customization options for different aspects of the subject's appearance allows the electronic device to efficiently manage and apply user modifications in combination, reducing the overall processing time and improving the responsiveness and interactivity of the editing user interface.

In some embodiments, the editing user interface includes a preview representation of the automatically-generated visual content generated based on the prompt, including the subject having the customized appearance, such as representation 2204d in FIG. 22U. In some embodiments, the preview representation of the automatically-generated visual content refers to an interim visual depiction provided by the electronic device, as described in greater detail herein and above (and with reference to methods 700, 800, 1000, 1200, 1400, 1500, 1700, 1900, and/or 2100). In some embodiments, the editing user interface including the preview representation of the automatically-generated visual content refers to the interface integrating the preview alongside the various customization tools included in the interface, allowing the preview and the tools to be displayed concurrently. In some embodiments, the preview representation of the automatically-generated visual content including the subject having the customized appearance refers to the electronic device displaying the subject with customization that has been applied based on a user input (e.g., the first or second sets of one or more inputs). In some embodiments, as the user adjusts one or more characteristics of the appearance of the subject, the changes are reflected in the subject shown within the preview representation of the automatically-generated visual content. Including a preview representation of the automatically-generated visual content in the editing user interface allows the electronic device to provide visual feedback on customizations, enhancing user experience and reducing the need for iterative processing cycles, thereby conserving computational resources and improving system efficiency.

In some embodiments, in response to detecting the second set of one or more inputs, the electronic device updates the preview representation of the automatically-generated visual content to be based on the appearance of the subject as customized by the selection of the respective option (e.g., updating the preview representation similarly to as described with reference to methods 700, 800, 1000, 1200, 1400, 1500, 1700, 1900, and/or 2100), such as updating the appearance of the subject in representation 2204b in FIG. 22L in response to detecting the input 2203 directed to options 2224b in FIG. 22K. In some embodiments, customizing the appearance of the subject based on the selection of the respective option refers to the process whereby the electronic device applies changes to the appearance of the subject in the automatically-generated visual content in response to user inputs. In some embodiments, the user inputs for customizing the appearance of the subject (e.g., the second set of one or more inputs), involve selecting one or more specific options that modify one or more characteristics of the appearance of the user, and optionally performing one or more actions related to the one or more specific options (e.g., dragging a slider or picking an item from a list). In some embodiments, updating the preview representation of the automatically-generated visual content to be based on the appearance of the subject as customized by the selection of the respective option involves the electronic device modifying the preview representation to reflect the modifications to the one or more characteristics of the appearance of the subject made by the user. In some embodiments, the electronic device updates the preview representation after a customization option is selected. In some embodiments, the preview representation integrates multiple customization options as they are applied. For instance, when the user adjusts two or more characteristics of the appearance of the subject (e.g., the body style and an outfit of the subject), the electronic device updates the preview representation to show both changes concurrently. Updating the preview representation of the automatically-generated visual content after a customization option is selected allows the electronic device to provide real-time visual feedback, reducing the need for repeated rendering and enhancing processing efficiency by dynamically integrating multiple customization options as they are applied.

In some embodiments, after detecting the second set of one or more inputs, the electronic device detects, via the one or more input devices, a third set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to confirmation of customization of the appearance of the subject based on the second set of one or more inputs, such as the input 2203 directed to option 2214b in FIG. 22U. In some embodiments, the third set of one or more inputs has one or more characteristics of any of the sets of one or more inputs described herein. In some embodiments, the confirmation of customization of the appearance of the subject refers to a user-initiated action that finalizes the selection(s) and/or change(s) made to the subject's appearance within the editing user interface. For example, the user may press a ‘confirm’ or ‘save’ button (or engage a similar function), which signals to the electronic device that the user is satisfied with the modifications.

In some embodiments, in response to detecting the third set of one or more inputs, the electronic device updates the preview representation of the automatically-generated visual content to be based on the appearance of the subject as customized by the second set of one or more inputs (e.g., updating the preview representation similarly to as described with reference to methods 700, 800, 1000, 1200, 1400, 1500, 1700, 1900, and/or 2100), such as in representation 2204e in FIG. 22V. In some embodiments, updating the preview representation of the automatically-generated visual content to be based on the appearance of the subject as customized by the second set of one or more inputs in response to detecting the third set of one or more inputs involves the electronic device modifying the preview representation to reflect the modifications to one or more characteristics of the appearance of the subject made by the user after detecting the user confirming the customization choices. In some embodiments, changes to the preview representation based on the selected customization options are not applied until the electronic device detects the confirmation input. By updating the preview representation of the automatically-generated visual content after detecting confirmation of customization, the electronic device ensures that all user-selected modifications are accurately reflected, thereby reducing redundant processing and improving the efficiency and accuracy of the media generation process.

In some embodiments, prior to detecting the third set of one or more inputs (and/or when the first set of one or more inputs is detected), the prompt includes one or more components (e.g., prompt components such as described with reference to methods 700, 800, 1000, 1200, 1400, 1500, 1700, 1900, and/or 2100), and the updated preview representation of the automatically-generated visual content is based on the appearance of the subject as customized by the second set of one or more inputs and the one or more components of the prompt, such as including a prompt component related to the appearance of the subject of the representation 2204e of automatically-generated visual content among prompt components 2206a through 2206c in FIG. 22V. In some embodiments, the one or more components of the prompt refer to the various elements and/or attributes that are included in the prompt. Some examples of the one or more components include, but are not limited to, activities, roles, environments, drawing style, props, mood/tone, color, lighting, period/setting, emotional state, weather, season, or any other characteristic that may shape the creative direction and specifics of the automatically-generated visual content. In some embodiments, the one or more components of the prompt are based on textual descriptions and/or visual tags associated with the prompt. In some embodiments, the updated preview representation of the automatically-generated visual content is based on the appearance of the subject as customized by the second set of one or more inputs and the one or more components of the prompt refers to the visual display within the editing user interface showing the subject of the automatically-generated visual content with all the applied customizations and integrated prompt components. In some embodiments, the updated preview representation reflects both the specific modifications made by the user through modifications made via the selectable options (e.g., the second set of inputs) and the foundational elements provided by the prompt components. Integrating the one or more components of the prompt with the customized appearance of the subject in the updated preview representation enhances the electronic device's ability to provide clear and efficient visual output, thereby reducing the need for separate rendering processes and optimizing the overall computational efficiency.

In some embodiments, the anthropomorphic subject is a human subject, such as the subject of representation 2204e of the automatically-generated visual content item in FIG. 22V. In some embodiments, a human subject refers to an anthropomorphic figure that specifically represents a human being within the automatically-generated visual content. In some embodiments, the human subject is meant to emulate real-life human proportions, facial features, expressions, and/or movements. Defining the anthropomorphic subject as a human subject allows the electronic device to utilize rendering techniques for human proportions, facial features, and movements, enhancing the realism and quality of the generated visual content while improving processing efficiency.

In some embodiments, the anthropomorphic subject is a human subject identified from a media collection of a user of the electronic device (e.g., a collection or library as described with reference to methods 800, 1200, and/or 1900), such as the subject of representation 2204d of automatically-generated visual content in FIG. 22N. In some embodiments, the media collection of the user of the electronic device refers to a compilation of digital media files that are owned, stored, and/or accessible by the user on their electronic device. In some embodiments, the media collection includes a variety of media types, such as one or more of photographs, videos, audio files, GIFs, emojis, and/or digital documents. In some embodiments, the media collection is a personal media collection of the user of the electronic device, which optionally includes photos and/or videos captured by a camera of the electronic device. In some embodiments, the electronic device utilizes one or more of image recognition technologies, machine learning algorithms, and/or user input to identify the human subject from the media collection of the user. In some embodiments, after the human subject is identified and confirmed, the electronic device creates a profile that includes the extracted features and additional information about the human subject (e.g., commonly associated environments, settings, interactions, activities, accessories, and/or any other relevant aspects that characterize the human subject). Identifying the human subject from the user's media collection allows the electronic device to personalize the generated visual content based on existing user data, reducing the need for extensive manual input and enhancing the accuracy and relevance of the media generation process.

In some embodiments, the one or more selectable options in the editing user interface include a first selectable option that is selectable to select a first appearance for the human subject for use in generating (e.g., using an AI process or a generative AI process) the automatically-generated visual content based on the prompt, wherein the first appearance corresponds to a first set of one or more media items in the media collection of the user of the electronic device, such as option 2228a in FIG. 22F. In some embodiments, the first appearance for the human subject refers to a specific visual representation or style of the human subject that is derived from analyzing and synthesizing one or more characteristics found in a first set of one or more media items from the media collection of the user. In some embodiments, the first set of one or more media items in the media collection refers to a specific grouping or collection of digital media files selected from the overall media collection of the user. In some embodiments, each of the one or more media items of the first set of one or more media items shares one or more common characteristics or themes that are relevant to the first appearance for the human subject. For example, a set of media items from corporate events, galas, or formal gatherings where the subject is dressed in business attire or formal wear could constitute a “formal” appearance for the human subject; a set of media items where the subject wears glasses could constitute a “glasses” appearance; a set of media items where the subject is smiling could constitute a “smiling” appearance; and a set of media items where the subject has a beard could constitute a “bearded” appearance.

In some embodiments, the one or more selectable options in the editing user interface include a second selectable option that is selectable to select a second appearance, different from the first appearance, for the human subject for use in generating (e.g., using an AI process or a generative AI process) the automatically-generated visual content based on the prompt, wherein the second appearance corresponds to a second set of one or more media items in the media collection of the user of the electronic device, such as option 2228b in FIG. 22F. In some embodiments, the second appearance for the human subject has one or more characteristics of the first appearance for the human subject. In some embodiments, the second set of one or more media items in the media collection has one or more characteristics of the first set of one or more media items. In some embodiments, the second appearance for the human subject and the second set of one or more media items are different from the first appearance and the first set, enabling the user to generate visual content that reflect varied appearances of the subject. Providing selectable options to choose different appearances for the human subject based on distinct sets of media items from the user's collection enhances the electronic device's ability to generate diverse and contextually relevant visual content, improving the personalization and accuracy of the media output while reducing the need for extensive manual customization.

In some embodiments, the first set of one or more media items is from a first time period, such as option 2228a corresponding to media from a first time period in FIG. 22F. In some embodiments, the first time period refers to a specific segment of time during which the one or media items of the first set were created or captured. In some embodiments, a time period is defined by a period of time between two years (e.g., between the years 2010 and 2015), by a period of time in the subject's life (e.g., between 5 and 10 years old, teenage years, and/or any other significant life stages), or by specific personal or family events (e.g., college years, first years of marriage, or time living abroad).

In some embodiments, the second set of one or more media items is from a second time period, different from the first time period, such as option 2228b corresponding to media from a second time period in FIG. 22F. In some embodiments, the second time period has one or more characteristics of the first time period. In some embodiments, the difference between the first and second time periods allows the electronic device to generate visual content that reflect varied appearances during different phases in the subject's life. By selecting media items from distinct time periods, the electronic device can generate visual content that accurately reflects changes in the subject's appearance over time, enhancing the personalization and historical context of the media output.

In some embodiments, in accordance with a determination that the human subject has a current age that is a first age, the first time period has a first length and the second time period has the first length, such as time periods associated with options 2228a through 2228f for the adult candidate subject in FIG. 22F. In some embodiments, the current age of the human subject refers to the most recent or present age of the individual as determined at the time of use of the electronic device. In some embodiments, the current age of the human subject refers to the age of the human subject in a given media item. In some embodiments, when the electronic device does not know the birthdate of the subject, the device infers the age of the subject by analyzing the media items associated with the subject in the media collection of the user. In some embodiments, the length of a time period refers to the duration or span of the time period, which is adjusted based on the age of the subject to ensure the time period is contextually suitable for generating media items that reflect an accurate and meaningful portrayal of the subject at this stage of their life. In some embodiments, when the electronic device determines that the subject has a current age categorized as the first age (e.g., a number, such as 5 years old, or an age descriptor, such as “child”), the first and second time periods are defined with the first length specifically determined to be appropriate or relevant to the first age. For example, if the first age is a younger age (e.g., 0-18 years old), the first length of the first and second time periods may be shorter, covering only a few years (e.g., 1, 2, 3, 4, or 5 years), so each set of one or more media items captures rapid changes typical of early development.

In some embodiments, in accordance with a determination that the human subject has the current age that is a second age, different from the first age, the first time period has a second length and the second time period has the second length, wherein the second length is different from the first length, such as time periods associated with options 2228k through 2228p for the child subject in FIG. 22M. In some embodiments, the second age has one or more characteristics of the first age. In some embodiments, the second length has one or more characteristics of the first length. In some embodiments, when the electronic device determines that the subject has a current age categorized as the second age (e.g., 50 years old or “adult”), the first and second time periods are defined with the second length specifically determined to be appropriate or relevant to the second age. For example, if the second age is an older age (e.g., more than 18 years old), the second length of the first and second time periods may be longer, covering more years than for a younger age, since the appearance of a human doesn't tend to change as much as in their younger years. In some embodiments, the difference between the first and second lengths ensures that the sets of one or more media items chosen for subjects of different ages are representative of the specific subject's appearance. In some embodiments, for a given human subject, multiple sets of media items are available for selection corresponding to different time periods and/or visual appearances. In some embodiments, the sets of media items for the human subject that are available include one or more sets of media items that correspond to childhood for the human subject, and one or more sets of media items that correspond to adulthood for the human subject. The one or more sets of media items that correspond to childhood for the human subject are optionally from one or more first time periods, and the one or more sets of media items that correspond to adulthood for the human subject are optionally from one or more second time periods, which optionally have durations that are longer than the one or more first time periods. Adjusting the lengths of time periods for media item selection based on the current age of the human subject allows the electronic device to tailor the visual content generation process more precisely to the developmental stages of the subject's life, thus improving the contextual accuracy and relevance of the generated visual content and enhancing the personalization.

In some embodiments, the first set of one or more media items depict the human subject with a first visual appearance, such as the set of media items corresponding to options 2228k in FIG. 22M. In some embodiments, the first visual appearance refers to a specific set of one or more observable physical characteristics and/or styling details that define the appearance of the subject based on the first set of one or more media items. In some embodiments, the specific set of one or more observable physical characteristics and/or styling details encapsulates a particular combination of features that is consistent across the one or more media items of the first set. For example, the first visual appearance may be identified by the uniformity of certain features across the media collection, such as a consistent hairstyle, facial hair, glasses, dress style, or any other characteristic that defines the appearance of the subject, as described in greater detail herein.

In some embodiments, the second set of one or more media items depict the human subject with a second visual appearance, different from the first visual appearance, such as the set of media items corresponding to options 2228k through 2228d in FIG. 22M. In some embodiments, the second visual appearance has one or more characteristics of the first visual appearance. In some embodiments, the difference between the first and second visual appearances allows the electronic device to generate visual content that reflect diverse appearances of the same subject. By grouping media items based on consistent visual characteristics of the subject, the electronic device can streamline the customization process when generating diverse visual representations based on user selections.

In some embodiments, the one or more selectable options in the editing user interface include a first selectable option that is selectable to display selectable options for selecting any media item included in the media collection of the user of the electronic device as an appearance for the human subject, including a selectable option for a media item that does not include the human subject, such as option 2226b in FIG. 22M. In some embodiments, the first selectable option that is selectable to display selectable options for selecting any media item included in the media collection of the user of the electronic device as an appearance for the human subject refers to a specific feature within the editing user interface that allows the user to access and browse through their entire media collection. In some embodiments, the electronic device displays each media item of the media collection as a selectable option capable of defining and/or influencing the appearance of the human subject in the automatically-generated visual content when selected by the user. In some embodiments, the first selectable option enables users to select any chosen media item to the appearance of the subject of the automatically-generated visual content being created or modified, whether or not the media item is identified by the device as including the human subject (e.g., even if the media item includes a different human subject). In some embodiments, the media item that does not include the human subject is a media item that contains the subject, but the electronic device has not identified the subject as being in the media item (e.g., has incorrectly failed to identify the subject as being in the media item), providing a mechanism that enables the user to manually select such media items for use in the generation of the automatically-generated visual content. Providing a selectable option to use any media item from the user's collection as an appearance for the human subject increases the customization capabilities of the generation process, reducing the need for manual edits and optimizing the electronic device's processing by using existing visual data.

In some embodiments, the one or more selectable options in the editing user interface include a first selectable option that is selectable to display selectable options for selecting any media item included in the media collection of the user of the electronic device that has been identified as including the human subject as an appearance for the human subject, such as option 2226b in FIG. 22M. In some embodiments, the first selectable option that is selectable to display selectable options for selecting any media item included in the media collection of the user of the electronic device that has been identified as including the human subject as an appearance for the human subject refers to a specific feature within the editing user interface that allows the user to access and browse a curated list of media items from their media collection that specifically depicts the human subject. In some embodiments, the electronic device displays each of a plurality of different media items in the curated list of media items as a selectable option capable of defining or influencing the appearance of the human subject in the automatically-generated visual content when selected by the user.

In some embodiments, the one or more selectable options in the editing user interface do not include a selectable option for a media item that does not include the human subject, such as the media items corresponding to options 2228a, 2228b, and 2228g through 2228j in FIG. 22H. In some embodiments, the electronic device excludes any media item that does not visually include the human subject from the one or more selectable options in the editing user interface. In some embodiments, the electronic displays the media items that do not include the human subject as part of the media collection, but does not designate said media items as selectable options. In some embodiments, the media item that does not include the human subject is a media item that contains the subject, but the electronic device has not identified the subject as being in the media item. Limiting selectable options to media items that visually include the human subject streamlines the customization process within the electronic device by focusing computational efforts on relevant visual data, thereby enhancing processing efficiency and reducing the likelihood of user error in selecting inappropriate media for appearance customization.

In some embodiments, the one or more selectable options in the editing user interface include a first selectable option that is selectable to cause the electronic device to automatically select a set of one or more media items as an appearance for the human subject, such as option 2218a in FIG. 22B. In some embodiments, while displaying, via the one or more display generation components, the editing user interface, the electronic device detects, via the one or more input devices, a third set of one or more inputs corresponding to selection of the first selectable option, such as input 2203 directed to option 2218a in FIG. 22B (e.g., detecting a tap input directed to the first selectable option, detecting an air pinch or air tap gesture while attention of the user is directed to the first selectable option, and/or detecting a selection input while a focus selector such as a cursor is directed to the first selectable option).

In some embodiments, in response to detecting the third set of one or more inputs, the electronic device automatically selects the set of one or more media items as the appearance for the human subject, such as the subject of the representation 2204b of the automatically-generated visual content item in FIG. 22D. In some embodiments, the first selectable option that is selectable to cause the electronic device to automatically select the set of one or more media items as an appearance for the human subject refers to a feature within the editing user interface that enables the user to initiate an automated process managed by the electronic device which involves the device algorithmically selecting (e.g., via image recognition, pattern matching, and/or machine learning algorithms) one or more media items from the media collection of the user that are most suitable for defining or influencing the appearance of the human subject in the automatically-generated visual content. In some embodiments, the selection process is governed by specific criteria, which include one or more of the clarity of the media item, the prominence of the human subject, a match with the desired characteristics for the subject's appearance (e.g., specific facial features, attire styles, and/or contextual settings), user preferences, a specific period of time, recency of the media item, particular emotional expressions, particular activities, or any other characteristic of a media item which allows the electronic device to group the one or more media items. By enabling the electronic device to automatically select a set of media items for defining the human subject's appearance, the method reduces user effort and improves customization efficiency, streamlining the selection process and optimizing the use of computational resources.

In some embodiments, before the anthropomorphic subject is the human subject identified from a media collection of a user of the electronic device, the electronic device detects, via the one or more input devices, one or more respective inputs selecting the human subject identified from the media collection, such as the input (e.g., a tap or a long press input) including contact 2203tt in FIG. 22TT. In some embodiments, the one or more respective inputs include touch input(s), air gesture input(s), voice input(s) and/or input(s) detected using hardware input device(s). In some embodiments, the one or more respective inputs include one or more inputs selecting respective selectable options displayed by the electronic device in the editing user interface.

In some embodiments, in response to detecting the one or more respective inputs, the electronic device displays, via the one or more display generation components, a representation of a candidate subject corresponding to the human subject, wherein the representation of the candidate subject is automatically-generated based on one or more media items from the media collection featuring the human subject, such as representation 2272a in FIG. 22UU. In some embodiments, the one or more media items are a subset of a plurality of media items in the media collection that feature the human subject. In some embodiments, the one or more media items feature the human subject having an appearance with one or more characteristics in common and the media collection further includes one or more media items featuring the user with one or more characteristics different from the one or more characteristics in common among the one or more media items. For example, the media collection includes media items featuring the human subject having a variety of hair styles and the one or more media items feature the human subject having a respective hair style. In some embodiments, the candidate subject has one or more characteristics in common with the one or more media items. For example, the candidate subject has the respective hair style featured in the one or more media items. In some embodiments, in response to receiving one or more second inputs selecting a second human subject identified from the media collection, the electronic device displays a representation of a second candidate subject corresponding to the second human subject that is automatically-generated based on one or more media items from the media collection featuring the second human subject. The second candidate subject corresponding to the second human subject optionally has one or more characteristics of the candidate subject corresponding to the human subject described herein. In some embodiments, the editing user interface further includes additional candidate subjects based on the second human subject. Displaying a representation of the candidate subject automatically-generated based on one or more media items enhances user interactions with the electronic device by reducing the number of user inputs needed to crate the candidate subject, which decreases power usage and/or increases battery life of the electronic device.

In some embodiments, the prompt includes one or more prompt components other than the subject of the prompt, such as prompt components corresponding to representations 2206a and 2206b in FIG. 22TT.

In some embodiments generating the representation of the candidate subject is based on the one or more media items without being based on the one or more prompt components other than the subject of the prompt, such as representation 2272a in FIG. 22UU not being based on prompt components corresponding to representations 2206a and 2206b in FIG. 22TT. In some embodiments, the one or more prompt components include prompt components and/or recognized concepts described herein with reference to method(s) 700, 800, 1000, 1200, 1700, 1900, 2100, and/or 2300. In some embodiments, the one or more prompt components influence the generation of the automatically-generated visual media, including defining features, styles, and/or other characteristics of the automatically-generated visual media. Optionally, the one or more prompt components include prompt components related to features of the automatically-generated visual media other than the anthropomorphic subject, such as prompt components identifying a setting of the automatically-generated visual media, an additional subject (e.g., objects and/or animals) to be included in the automatically-generated visual media, and/or characteristics thereof. Optionally, the one or more prompt components include prompt components related to features and/or characteristics of the anthropomorphic subject, such as an outfit, occupation, pose and/or activity of the human subject in the automatically-generated visual media. In some embodiments, while the prompt is a first prompt the candidate subject has a first appearance based on the one or more media items without being based on the first prompt. In some embodiments, while the prompt is a second prompt different from the first prompt, the candidate subject has the first appearance based on the one or more media items without being based on the second prompt. For example, the candidate subject with the first appearance is the same irrespective of whether the prompt is the first prompt or the second prompt. In some embodiments, generating the representation of the candidate subject is based on the one or more media items without being based on a subset of the one or more prompt components other than the subject of the prompt. For example, the representation of the candidate subject is optionally based on a visual style prompt component of the prompt, as described in more detail below, but optionally not based on one or more other prompt components other than the subject. Generating the candidate subject based on the one or more media items and not based on the one or more prompt components other than the subject of the prompt enhances user interactions with the electronic device by providing improved visual feedback to the user (e.g., allowing the user to evaluate the accuracy of the candidate subject without the rest of the prompt), which reduces user error and user inputs to correct those errors, as well as reducing power consumption of the electronic device and/or increasing battery life of the electronic device.

In some embodiments, displaying the editing user interface includes while displaying the representation of the candidate subject, displaying, via the one or more display generation components, a representation of a first media item of the one or more media items from the media collection featuring the human subject, such as media item 2274a in FIG. 22UU. In some embodiments, the electronic device generates the representation of the candidate subject based on the first media item. In some embodiments, the electronic device generates the representation of the candidate subject based on a plurality of media items featuring the human subject, including the first media item. In some embodiments, the plurality of media items featuring the human subject on which the representation of the candidate subject is based feature the human subject with a respective set of visual characteristics, as described in more detail above. In some embodiments, the electronic device displays the first media item overlaid on the representation of the candidate subject. Concurrently displaying the first media item and the representation of the candidate subject provides improved visual feedback to the user, thereby reducing user errors and user inputs, which decreases power consumption and increases battery life of the electronic device.

In some embodiments, the prompt includes a visual style for the automatically-generated visual content, such as the visual style indicated by option 2210c in FIG. 22SS. In some embodiments, the visual style has one or more characteristics of visual styles described herein with reference to one or more of method(s) 700, 800, 1000, 1200, 1700, 1900, 2100, and/or 2300. In some embodiments, the visual style refers to an aesthetic of the automatically-generated visual content. In some embodiments, the visual style refers to an artistic technique that the automatically-generated visual content emulates. Example visual styles include animation, sketch, cartoon, comic strip, watercolor, black and white, emoji, and/or charcoal drawing.

In some embodiments, displaying the representation of the candidate subject includes, in accordance with a determination that the prompt includes a first visual style, displaying, via the one or more display generation components, the representation of the candidate subject in the first visual style, such as representation 2272a in FIG. 22UU having the style indicated in FIG. 22SS. In some embodiments, the electronic device receives one or more inputs selecting a style prior to displaying the editing user interface. In some embodiments, the one or more inputs include one or more selection inputs selecting a displayed option, such as with a touch input, air gesture, hardware input device, and/or voice input. In some embodiments, the one or more inputs include inputs not directed to a particular displayed element, such as voice input. In some embodiments, in response to receiving the one or more inputs selecting the visual style, the electronic device adds the visual style to the prompt. In some embodiments, the electronic device displays the representation of the candidate subject in the same visual style as the visual style selected for the automatically-generated visual content.

In some embodiments, displaying the representation of the candidate subject includes, in accordance with a determination that the prompt includes a second visual style different from the first visual style, displaying, via the one or more display generation components, the representations of the candidate subject in the second visual style, such as representation 2272b in FIG. 22YY having the style indicated in FIG. 22XX. As described above, in some embodiments, the visual style of the representation of the candidate character is the same as the visual style selected for the automatically-generated visual media. In some embodiments, it is possible for the electronic device to generate automatically-generated visual media featuring the candidate subject in a visual style other than the visual style that was selected while displaying the representation of the candidate subject. For example, after displaying the representation of the candidate subject with a respective visual style and after adding the candidate subject to the prompt, the electronic device receives one or more inputs to change the visual style of the prompt. In response to receiving the one or more inputs to change the visual style of the prompt, the electronic device adds the new visual style of the prompt to the prompt. In some embodiments, when the electronic device generates the automatically-generated visual media, the electronic device generates the automatically-generated visual media using the new style with the candidate subject as the subject of the automatically-generated visual media, including the candidate subject being rendered in the new style in the automatically-generated visual media. Displaying the representation of the candidate subject in the same visual style as a visual style included in a prompt for generating the automatically-generated visual media enhances user interactions with the electronic device by providing improved visual feedback to the user, which reduces user errors, reduces user inputs, decreases power consumption of the electronic device, and improves battery life of the electronic device.

In some embodiments, while displaying the representation of the candidate subject, the electronic device detects, via the one or more input devices, a respective input corresponding to a request to display a representation of a second candidate subject corresponding to the human subject, such as the input including movement of contact 2203uu in FIG. 22UU. In some embodiments, the respective input includes selection of a displayed option, such as a touch input, air gesture input, hardware input device input, and/or voice input. In some embodiments, the respective input is a directional input, such as a swipe (e.g., a touch input swipe or air gesture input swipe), an input detected with a hardware input device (e.g., scrolling on a trackpad or mouse, selection of an arrow key of a hardware input device), and/or voice input.

In some embodiments, in response to detecting the respective input corresponding to the request to display the representation of the second candidate subject, the electronic device displays, via the one or more display generation components, the representation of the second candidate subject different from the representation of the candidate subject, wherein the representation of the second candidate subject is automatically-generated based on one or more second media items from the media collection featuring the human subject, the one or more second media items different from the one or more media items, such as representation 2272b in FIG. 22VV. In some embodiments, the second candidate subject and the candidate subject represent the same human subject included in the collection of media items. In some embodiments, the second candidate subject has a different appearance from the candidate subject. In some embodiments, the human subject has a different appearance in the one or more media items than in the one or more second media items. For example, the one or more media items feature the human subject with a first hairstyle, first glasses, and/or in a first age range and the one or more second media items feature the human subject with a second hairstyle, second glasses, and/or in a second age range. As another example, the candidate subject has a first hairstyle, first glasses, and/or in a first age range corresponding to those characteristics of the human subject in the one or more media items and the second candidate subject has a second hairstyle, second glasses, and/or in a second age range corresponding to those characteristics of the human subject in the one or more second media items. In response to receiving the respective input, while displaying the second candidate subject, the electronic device displays one or more of the one or more second media items in a manner similar to the manner described above of displaying a media item concurrently with the candidate subject. Displaying a second candidate subject corresponding to the human subject and different from the candidate subject enhances user interactions with the electronic device by providing improved visual feedback to the user during the process of editing the subject of an automatically-generated visual media item, which reduces user inputs and user errors, reduces power consumption of the electronic device, and/or increases battery life of the electronic device.

In some embodiments, while a respective candidate subject corresponding to the human subject is selected for use in generating the automatically-generated visual media, the respective candidate subject being one of the candidate subject or the second candidate subject, the electronic device detects, via the one or more input devices, a third set of one or more inputs corresponding to a request to generate the automatically-generated visual media using the respective candidate subject, such as selection of option 2202b in FIG. 22WW. In some embodiments, the respective candidate subject is one of the candidate subjects described above. For example, the respective candidate subject corresponds to a human person in the media library of the electronic device and/or corresponds to one or more media items featuring the human person. In some embodiments, the electronic device selects the respective candidate subject as the subject for use in generating the automatically-generated visual media in response to receiving one or more inputs confirming the user of the respective candidate subject while the electronic device displays the respective candidate subject, as described above. In some embodiments, the respective candidate subject is one of a plurality of possible respective candidate subjects corresponding to the human subject included in the media library. In some embodiments, the respective candidate subject is the first candidate subject or the second candidate subject described above. In some embodiments, the third set of one or more inputs has characteristics of inputs for generating automatically-generated visual media described above with reference to method(s) 700, 800, 1000, 1200, 1700, 1900, 2100, and/or 2300. The third set of one or more inputs optionally include touch inputs, air gesture inputs, hardware input device inputs, and/or voice inputs.

In some embodiments, while a respective candidate subject corresponding to the human subject is selected for use in generating the automatically-generated visual media, the respective candidate subject being one of the candidate subject or the second candidate subject, in response to detecting the third set of one or more inputs, the electronic device generates first automatically-generated visual media with the respective candidate subject, optionally as described herein with reference to method(s) 700, 800, 1000, 1200, 1700, 1900, 2100, and/or 2300, such as in response to detecting selection of option 2202b in FIG. 22WW. In some embodiments, the first automatically generated visual media features the respective candidate subject as the subject of the visual media.

In some embodiments, after generating the first automatically-generated visual media, the electronic device receives, via the one or more input devices, a fourth set of one or more inputs corresponding to a request to generate second automatically-generated visual media based on a second prompt that includes the human subject (e.g., the respective subject) as the subject of the second prompt, optionally including an input such as the input (e.g., a tap or a long press input) including contact 2203bbb in FIG. 22BBB. The fourth set of one or more inputs optionally have one or more characteristics of the first set of one or more inputs described above. In some embodiments, the second prompt is different from the first prompt. In some embodiments, the electronic device detects the first set of one or more inputs during a first time period and the electronic device detects the fourth set of one or more inputs during a second time period different from the first time period. In some embodiments, the electronic device receives the fourth set of one or more inputs after generating automatically-generated visual media content using a subject different from the human subject after generating the automatically-generated visual media content using the human subject. The subject different from the human subject is optionally a template subject or a second human subject different from the human subject. In some embodiments, the electronic device receives the fourth set of one or more inputs after generating the automatically generated visual media content featuring the human subject without generating automatically generated visual media content featuring a different subject.

In some embodiments, after generating the first automatically-generated visual media, in response to receiving the fourth set of one or more inputs, the electronic device generates the second automatically-generated visual media with the respective candidate subject, optionally as described herein with reference to method(s) 700, 800, 1000, 1200, 1700, 1900, 2100, and/or 2300, such as using the candidate subject corresponding to representation 2206d in FIG. 22CCC. In some embodiments, the second automatically generated visual media features the respective candidate subject as the subject of the visual media.

In some embodiments, in accordance with a determination that the third set of one or more inputs selected a first image or set of images as a basis for generating the representation of the human subject when generating the first automatically-generated visual media, the first image or set of images is used as a basis for generating the representation of the human subject when generating the second automatically-generated visual media, such as using the candidate subject corresponding to representation 2206d in FIG. 22CCC after using this candidate subject in FIG. 22ZZ. In some embodiments, the first candidate subject is included in the prompt for the automatically-generated visual media in response to the electronic device receiving the third set of one or more inputs while the first candidate subject was selected for use in generating the automatically-generated visual media. In some embodiments, the electronic device is configured to use the first candidate subject when using the human subject as the subject of automatically-generated visual media in response to receiving the third set of one or more inputs while the first candidate subject was selected for use in generating the automatically-generated visual media unless and until the electronic device receives further inputs requesting to use a different candidate subject corresponding to the human subject to generate automatically generated visual media. In some embodiments, in response to receiving one or more inputs corresponding to a request to add the human subject to the prompt for creating the second automatically-generated visual media, the electronic device is configured to use the first candidate subject to generate the second automatically-generated visual media without requiring the user select the first candidate subject to represent the human subject. In some embodiments, the fourth set of one or more inputs selects the human subject as the subject of the automatically-generated visual content but does not specify that the first image or first set of images should be used as the basis for generating the representation of the human subject.

In some embodiments, in accordance with a determination that the third set of one or more inputs selected a second image or set of images as a basis for generating the representation of the human subject when generating the first automatically-generated visual media, the second image or set of images is used as a basis for generating the representation of the human subject when generating the second automatically-generated visual media, such as using a different candidate subject from the candidate subject corresponding to representation 2206d in FIG. 22CCC after using a candidate subject different from the candidate subject used in FIG. 22ZZ. In some embodiments, the second candidate subject is included in the prompt for the automatically-generated visual media in response to the electronic device receiving the third set of one or more inputs while the second candidate subject was selected for use in generating the automatically-generated visual media. In some embodiments, the electronic device is configured to use the second candidate subject when using the human subject as the subject of automatically-generated visual media in response to receiving the third set of one or more inputs while the second candidate subject was selected for use in generating the automatically-generated visual media unless and until the electronic device receives further inputs requesting to use a different candidate subject corresponding to the human subject to generate automatically generated visual media. In some embodiments, in response to receiving one or more inputs corresponding to a request to add the human subject to the prompt for creating the second automatically-generated visual media, the electronic device is configured to use the second candidate subject to generate the second automatically-generated visual media without requiring the user select the second candidate subject to represent the human subject. In some embodiments, the fourth set of one or more inputs selects the human subject as the subject of the automatically-generated visual content but does not specify that the second image or second set of images should be used as the basis for generating the representation of the human subject. In some embodiments, once the electronic device generates a representation of a human subject using a respective image or a respective set of images as the basis for the representation of the human subject, the electronic device uses the representation of the human subject generated using the respective image or respective set of images automatically without receiving input(s) specifically requesting to use the respective image or respective set of images unless and until receiving one or more inputs selecting a different image or different set of images for use as the basis of the representation of the human subject. Using the same candidate subject to represent the human subject in the second automatically-generated visual media as the candidate subject used in the automatically generated visual media enhances user interactions with the electronic device by requiring fewer user inputs to generate subsequent automatically-generated visual media with a human subject that has been the subject of automatically-generated visual media already, which decreases power usage and/or increases battery life of the electronic device.

In some embodiments, the anthropomorphic subject is an avatar that is generated by the electronic device, wherein the avatar has one or more user-specified characteristics (e.g., physical features, attire, accessories, and any other characteristic of an anthropomorphic subject, as described herein), such as the subject of the automatically-generated visual content corresponding to representations 2204d in FIG. 22U. In some embodiments, the avatar refers to a digital representation or character that is generated by the electronic device to serve as the anthropomorphic subject in the automatically-generated visual content. In some embodiments, one or more characteristics of the avatar are based on a real-life human being or have a default setting. In some embodiments, the avatar is initially generated with a generic appearance as its seed, which does not derive from an actual human subject, and the user customizes the avatar by adjusting one or more characteristics of its appearance based on input rather than replicating specific human images. Generating an avatar with user-specified characteristics as the anthropomorphic subject allows the electronic device to efficiently create personalized digital representations, enhancing user engagement and reducing the need for extensive manual customization.

In some embodiments, the one or more selectable options include a respective set of one or more selectable options for customizing a skin tone of the avatar, such as options 2232a through 2232c in FIG. 22O. In some embodiments, the respective set of one or more selectable options for customizing the skin tone of the avatar refers to a specific group of choices presented within the editing user interface that allows the user to alter the skin tone of the avatar. In some embodiments, the respective set of one or more selectable options for customizing the skin tone of the avatar includes a range of skin colors and/or tones that are applicable to the avatar (e.g., pale, olive, almond, bronze, dark brown, and any other shades that accommodate a wide spectrum of ethnicities and racial identities). Providing a respective set of selectable options for customizing the skin tone of the avatar allows the electronic device to offer precise and diverse customization capabilities, reducing the computational burden of generating varied skin tones from scratch and enhancing the personalization of the digital representation.

In some embodiments, in accordance with a determination that the automatically-generated visual content is an automatically-generated emoji, the respective set of one or more selectable options corresponds to a first set of available skin tones for the avatar, such as options 2234a through 2234e in FIG. 22F. In some embodiments, the automatically-generated emoji refers to a digital representation, such as an avatar or icon, that is created or customized to express a range of emotions, actions, or personal attributes. In some embodiments, unlike standard emojis that exist in predefined forms, automatically-generated emojis are designed to reflect specific features of an individual user or character, including customizable aspects such as physical attributes, attire, accessories, and/or any other personal attributes that define the user or character. In some embodiments, the automatically-generated emoji is generated based on one or more user inputs and/or preferences or automatically based on a human subject or candidate subject. In some embodiments, when the automatically-generated visual content is determined to be an automatically-generated emoji and/or sticker, the respective set of one or more selectable options for customizing the skin tone of the avatar corresponds to the first set of available skin tones that include natural human skin tones and other colors commonly used in emojis to promote a universal representation, such as yellow and/or other neutral emoji colors.

In some embodiments, in accordance with a determination that the automatically-generated visual content is not an automatically-generated emoji (e.g., images, animations, or videos with an anthropomorphic subject), the respective set of one or more selectable options corresponds to a second set of available skin tones for the avatar, different from the first set of available skin tones for the avatar, such as options 2234a through 2234d in FIG. 22O. In some embodiments, when the automatically-generated visual content is not an automatically-generated emoji, the respective set of one or more selectable options for customizing the skin tone of the avatar corresponds to the second set of available skin tones that is characterized by a range of realistic human skin tones that reflect human diversity, but do not include colors commonly used in emojis, such as yellow and/or other color that is not typically used to represent a human skin color (e.g., green, blue, or another color). Differentiating between sets of selectable skin tones based on whether the media item is an automatically-generated emoji or another type of visual content allows the electronic device to efficiently manage and apply appropriate color palettes, improving the efficiency of rendering processes and reducing user error by ensuring users select skin tones suitable for the specific type of media being generated.

In some embodiments, the one or more selectable options include a content entry field for entering content (e.g., text, emoji, image, and/or video) for customizing the avatar (e.g., a specific component within the editing user interface that allows the user to input textual or numerical data related to the customization of the avatar, such as entering text as part of prompts, as described with reference to methods 700, 800, 1000, 1200, 1400, 1500, 1700, 1900, and/or 2100), such as content entry field 2236a in FIG. 22R. In some embodiments, while displaying, via the one or more display generation components, the editing user interface including the content entry field, the electronic device detects, via the one or more input devices, entry of respective content into the content entry field, such as entering content 2236c in the text entry field 2236a in FIG. 22S in response to detecting the input 2203 in FIG. 22R. In some embodiments, detecting entry of respective content into the content entry field refers to the process by which the electronic device recognizes and captures information that the user input into the content entry field within the editing user interface. In some embodiments, the respective content refers to the specific data, commands, and/or parameters entered by the user into the content entry field. In some embodiments, the respective content is related to customizing the avatar and includes one or more of textual descriptions (e.g., “elderly with gray hair”), numerical values (e.g., an RGB value), coded instructions (e.g., increase smile by 20% or cartoonify), activities (e.g., surfing or dancing), professions (e.g., astronaut, chef, or climber), hair color (e.g., blonde, brunette, or red), emotional expressions (e.g., joyful, serious, or pensive), physical attributes (e.g., tall, short, or muscular), and/or other attributes or forms of data that are intended to influence the appearance of the avatar in one or more ways.

In some embodiments, in response to detecting the entry of the respective content into the content entry field, in accordance with a determination that the respective content is first content, the electronic device modifies the avatar in a first manner corresponding to the first content, such as displaying representation 2238a based on text 2236c in FIG. 22S. In some embodiments, modifying the avatar in the first manner corresponding to the first content refers to the electronic device applying the specific changes or adjustments made to the avatar based on the first content entered by the user into the content entry field. Modifying or updating automatically-generated content based on text or other content input is described with reference to methods 700, 800, 1000, 1200, 1400, 1500, 1700, 1900, 2100 and/or 2300.

In some embodiments, in response to detecting the entry of the respective content into the content entry field, in accordance with a determination that the respective content is second content, different from the first content, the electronic device modifies the avatar in a second manner corresponding to the second content, wherein the second manner is different from the first manner, such as displaying representation 2238a based on text 2236c in FIG. 22T. In some embodiments, modifying the avatar in the second manner corresponding to the second content refers to the electronic device applying the specific changes or adjustments made to the avatar based on the second content entered by the user into the content entry field. In some embodiments, the distinction between the first content and the second content involves each containing different instructions, parameters, and/or descriptions for customizing the avatar, resulting in each guiding the customization of the avatar in distinct manners. In some embodiments, the avatar is manually generated and customized by the user based on specific user inputs rather than being produced by automated generative processes, such as the automatically-generated visual content. Including a content entry field for customizing the avatar allows the electronic device to accurately capture and apply user-defined textual or numerical inputs.

In some embodiments, while displaying, via the one or more display generation components, the editing user interface, the electronic device detects, via the one or more input devices, a third set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to a request to add the avatar that has the one or more user-specified characteristics to a respective set of candidate subjects available for use in prompts (e.g. for use in future prompts) for generating (e.g., using an AI process or a generative AI process) an automatically-generated visual content, such as input 2203 selecting option 2230b in FIG. 22T. In some embodiments, the third set of one or more inputs has one or more characteristics of any of the sets of one or more inputs described herein. In some embodiments, the request to add the avatar that has the one or more user-specified characteristics to the respective set of candidate subjects available for use in prompts for generating the automatically-generated visual content refers to a specific user action or series of actions initiated through the editing user interface involving selecting or indicating that a newly created or modified avatar, which includes particular characteristics defined by the user, should be included in a list of candidate subjects (e.g., alongside the first and second candidate subjects). In some embodiments, the avatar is optionally used in future prompts by the user to generate and/or modify automatically-generated visual content.

In some embodiments, in response to detecting the third set of one or more inputs, the electronic device adds the avatar that has the one or more user-specified characteristics to the respective set of candidate subjects available for use in prompts for generating (e.g., using an AI process or a generative AI process) an automatically-generated visual content, such as displaying option 2218g in FIG. 22U in response to detecting the input 2203 selecting option 2230b in FIG. 22T. In some embodiments, adding the avatar that has the one or more user-specified characteristics to the respective set of candidate subjects available for use in prompts for generating an automatically-generated visual content involves the electronic device incorporating the customized avatar into the list of candidate subjects. In some embodiments, once added to the respective set of candidate subjects, the customized avatar is selectable as the subject for future prompts when generating automatically-generated visual content, allowing for repeated use of the customized avatar in subsequent media generation. By allowing users to add a customized avatar to the set of candidate subjects, the electronic device enhances user convenience and reduces repetitive customization tasks, improving efficiency by allowing reuse of detailed user-specified characteristics in future media generation processes.

In some embodiments, in accordance with a determination that the automatically-generated visual content is a first type of automatically-generated visual content (e.g., emojis and/or stickers with an anthropomorphic subject), the respective set of candidate subjects is a first set of candidate subjects available for use in prompts for generating (e.g., using an AI process or a generative AI process) the automatically-generated visual content, such as the candidate subjects in the user interface in FIG. 22EE. In some embodiments, the first set of candidate subjects available for use in prompts for generating the automatically-generated visual content refers to a curated group of candidate subjects (e.g., human beings, avatars, characters, or other anthropomorphic figures) that are pre-selected and stored within the electronic device.

In some embodiments, in accordance with a determination that the automatically-generated visual content is a second type of automatically-generated visual content (e.g., images, animations, and/or videos), different from the first type of automatically-generated visual content, the respective set of candidate subjects is a second set of candidate subjects available for use in prompts for generating (e.g., using an AI process or a generative AI process) the automatically-generated visual content, different from the first set of candidate subjects available for use in prompts for generating the automatically-generated visual content, such as the candidate subjects in the user interface in FIG. 22U. In some embodiments, the second set of candidates subjects available for use in prompts for generating the automatically-generated visual content refers to a curated group of candidate subjects, different from the first set of candidate subjects, that are pre-selected and stored within the electronic device. In some embodiments, the distinction between the first and second sets of candidate subjects, is based on the distinction between the first and second types of automatically-generated visual content, ensuring that the candidate subjects are appropriate for the visual expectations of the respective media types being generated. For example, when the first type of automatically-generated visual content corresponds to automatically-generated emojis and/or stickers, the first set of candidate subjects may include avatars with stylized or non-traditional skin tones (e.g., yellow and/or other colors that are not typically used to represent skin tone); and when the second type of automatically-generated visual content corresponds to images, animations, or videos (e.g., generative visual content other than emojis or stickers), the second set of candidate subjects excludes these stylized color options and focuses on candidate subjects that offer realistic human skin tones and features. In this example, the first set of candidate subjects may include both avatars with stylized or non-traditional skin tones and anthropomorphic subjects with realistic human skin tones and features. Differentiating between sets of candidate subjects based on the type of automatically-generated visual content allows the electronic device to optimize media generation by making it more likely that the candidate subjects are appropriately matched to the visual requirements of each media type, thereby enhancing the quality and relevance of the generated content while reducing processing errors.

In some embodiments, the second set of one or more inputs includes input directed to a plurality of the one or more selectable options in the editing user interface, such as the inputs 2203 shown in FIGS. 22O and 22P. In some embodiments, while displaying, via the one or more display generation components, the editing user interface and after detecting the second set of one or more inputs, the electronic device detects, via the one or more input devices, a third set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to a request to complete customization of the appearance of the subject of the prompt, such as the input 2203 in FIG. 22T. In some embodiments, the third set of one or more inputs have one or more characteristics of any of the sets of one or more inputs described herein. In some embodiments, the request to complete customization of the appearance of the subject of the prompt refers to a specific user action or set of actions indicating that they have finalized their choices regarding the customization of the appearance of the subject in the editing user interface.

In some embodiments in response to detecting the third set of one or more inputs, the electronic device adds a plurality of different components to the prompt for generation of the automatically-generated visual content based on the second set of one or more inputs, such as the automatically-generated visual content corresponding to representation 2204d in FIG. 22U. In some embodiments, adding the plurality of different components to the prompt for generation of the automatically-generated visual content based on the second set of one or more inputs involves integrating multiple distinct elements or modifications into the final configuration of the prompt that drives the generation of the visual content. In some embodiments, the plurality of different components added to the prompt include one or more visual elements (e.g., physical attributes of the subject, accessories, background details, color schemes, image/drawing style, lighting, and/or any other elements that can visually define or enhance the subject within the automatically-generated visual content). In some embodiments, adding the plurality of different components to the prompt includes adding a textual description corresponding to the plurality of different components to the prompt. For example, for an initial prompt that reads “John wearing a cowboy hat,” a modified prompt based on two components, a horse and a lasso, may read “John wearing a cowboy hat and wielding a lasso while riding a horse,” which optionally adds both a lasso and a horse as components to the prompt. Additional examples of prompts, which are more generic, include “man with curly hair and glass” (which optionally adds “man”, “curly hair” and “glasses” as components to the prompt), “woman with short hair and earrings” (which optionally adds “woman”, “short hair” and “earrings” as components to the prompt), and “non-binary person with long hair and a necklace” (which optionally adds “non-binary”, “long hair” and “necklace” as components to the prompt). In some embodiments, adding multiple components to the prompt has one or more of the characteristics of adding multiple components to a prompt as described with reference to methods 700, 800, 1000, 1200, 1700, 1900, and/or 2100). In some embodiments, the electronic device represents the multiple components with one representation. For example, in response to receiving an input requesting to use a female subject with a first skin tone (optionally including slight variants of the first skin tone), the electronic device displays a representation of a subject that indicates the subject is female and has the first skin tone. In some embodiments, the electronic device stores the characteristics of the subject as a vector including values for a plurality of characteristics. For example, the vector has an entry for the body style (e.g., gender) of the subject and/or an entry for the skin tone of the subject. By detecting a third set of inputs to finalize customization and adding a plurality of different components to the prompt, the electronic device streamlines the media generation process, reducing user effort and potential errors by consolidating multiple customization actions into a prompt for generating the visual content.

In some embodiments, while displaying, via the one or more display generation components, the editing user interface, the electronic device detects, via the one or more input devices, a third set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to a request to complete customization of the appearance of the subject of the prompt, such as the input 2203 shown in FIG. 22U. In some embodiments, the third set of one or more inputs have one or more characteristics of any of the sets of one or more inputs described herein.

In some embodiments, in response to detecting the third set of one or more inputs, the electronic device displays, via the one or more display generation components, an automatically-generated visual content generation user interface (e.g., as described with reference to methods 700, 800, 1000, 1200, 1700, 1900, and/or 2100), including displaying, in the automatically-generated visual content generation user interface, a visual indication of the subject having the customized appearance as a single recognized concept (e.g., as described with reference to methods 700, 800, 1000, 1200, 1700, 1900, and/or 2100) for the prompt, such as the indication of the subject in option 2210b or in a style similar to prompt components 2206a through 2206c in FIG. 22V. In some embodiments, the automatically-generated visual content generation user interface refers to a specialized interface that is specifically designed for overseeing and/or managing the generation of the automatically-generated visual content. In some embodiments, the electronic device displays the automatically-generated visual content generation user interface once the customization phase is complete, providing tools, controls, and/or visual displays that facilitate the final creation process of the automatically-generated visual content. In some embodiments, the automatically-generated visual content generation user interface includes a preview representation of the automatically-generated visual content, as described previously. In some embodiments, the single recognized concept for the prompt includes one or more keywords, visual media, and/or style representations. In some embodiments, the single recognized concept has one or more characteristics of the recognized concepts of method 700. In some embodiments, the visual indication includes text and/or images (e.g., an icon) describing the recognized concept. In some embodiments, the visual indication has one or more characteristics of the visual indications of method 700 In some embodiments, upon detecting the third set of one or more inputs and transitioning to the automatically-generated visual content generation user interface, the electronic device displays an image and/or representation of the subject with the customized appearance within a dedicated subject selection area located within the user interface (e.g., within the selectable option that is selectable to select a subject for use in the generative visual content) and/or as a visual representation surrounding the preview area. In some embodiments, the visual representation serves as a concrete example of the subject post-customization, assisting the user in visualizing how the subject will appear in the final automatically-generated visual content. Displaying a visual indication of the subject with the customized appearance as a single recognized concept in the automatically-generated visual content generation user interface reduces user error and streamlines the final creation process by providing clear, consolidated visual feedback, enhancing the efficiency and accuracy of the media generation workflow.

In some embodiments, while displaying, via the one or more display generation components, the editing user interface, the electronic device detects, via the one or more input devices, a third set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to a request to complete customization of the appearance of the subject of the prompt and a request to generate the automatically-generated visual content, such as the input 2203 in FIG. 22X. In some embodiments, the third set of one or more inputs have one or more characteristics of any of the sets of one or more inputs described herein. In some embodiments, the request to generate the automatically-generated visual content refers to a specific user action or set of actions indicating that they wish to initiate the process of creating the final automatically-generated visual content.

In some embodiments, in response to detecting the third set of one or more inputs, the electronic device generates (e.g., using an AI process or a generative AI process) the automatically-generated visual content based on the customized appearance of the subject, including adding the automatically-generated visual content to a collection of automatically-generated visual content, such as displaying the automatically-generated visual content 2244a in the user interface in FIG. 22Y. In some embodiments, generating the automatically-generated visual content based on the customized appearance of the subject involves the process by which the electronic device takes the user-defined customizations of the appearance of the subject and integrates them into the creation of a new automatically-generated visual content, such as described in more detail with reference to methods 700, 800, 1000, 1200, 1400, 1500, 1700, 1900, and/or 2100. In some embodiments, generating the automatically-generated visual content has one or more characteristics of the generation of automatically-generated visual content of methods 700, 800, 1000, 1200, 1400, 1500, 1700, 1900, and/or 2100. In some embodiments, adding the automatically-generated visual content to the collection of automatically-generated visual content refers to the process where the newly generated automatically-generated visual content is stored within a designated digital repository or library that houses a plurality of automatically-generated visual content and serves as a resource for the user to access, review, and utilize the automatically-generated visual content in the future, such as described in more detail with reference to methods 700 and/or 800. Generating the automatically-generated visual content based on the customized appearance of the subject and adding it to a collection allows the electronic device to efficiently store and manage user-generated content, enhancing resource utilization and providing easy access to a library of personalized media items for future use.

In some embodiments, while displaying, via the one or more display generation components, the editing user interface, the electronic device detects, via the one or more input devices, a third set of one or more inputs (e.g., one or more of a tap input, a mouse click input, or an air gesture input selecting a confirmation option, which is directed to the confirmation option (e.g., based on a location of a touch input, a location of a cursor or location of attention of a user (e.g., based on gaze)) corresponding to a request to complete customization of the appearance of the subject of the prompt and a request to generate the automatically-generated visual content, such as input 2203 directed to option 2230b in FIG. 22T. In some embodiments, the third set of one or more inputs have one or more characteristics of any of the sets of one or more inputs described herein.

In some embodiments, in response to detecting the third set of one or more inputs, the electronic device generates (e.g., using an AI process or a generative AI process) the automatically-generated visual content based on the customized appearance of the subject, including adding the automatically-generated visual content to a collection of automatically-generated visual content that are available to be used in a plurality of different applications, such as emoji 2254c in FIG. 22CC and FIG. 22K. In some embodiments, generating the automatically-generated visual content has one or more characteristics of the generation of automatically-generated visual content of methods 700, 800, 1000, 1200, 1400, 1500, 1700, 1900, and/or 2100. In some embodiments, adding the automatically-generated visual content to the collection of automatically-generated visual content that are available to be used in the plurality of different applications refers to the process where the newly generated automatically-generated visual content is stored within a designated digital repository or library that houses a plurality of automatically-generated visual content (e.g., optionally of the same type) and is designed to be accessible and utilizable across multiple applications or platforms (e.g., applications other than the application used to generate the automatically-generated visual content). For example, when the automatically-generated visual content is an emoji and/or a sticker, the automatically-generated visual content is added to a library of emojis and/or stickers that may be accessed and used across various applications, such as messaging applications, email clients, collaborative workspaces, social media applications, digital note-taking tools, presentation software, educational applications, design tools, and/or any other suitable applications where such automatically-generated visual content can be integrated. Generating the automatically-generated visual content and adding it to a collection available for use across multiple applications enhances the electronic device's interoperability and resource management, enabling personalized media items to be used across different applications, thereby improving user experience and system efficiency.

In some embodiments, the editing user interface is a user interface of a first application (e.g., a software program or a set of programs designed to perform specific tasks or functions for the user, such as the application in which the automatically-generated visual content is generated), such as the application of the user interface in FIG. 22HH. In some embodiments, after generating the automatically-generated visual content based on the customized appearance of the subject, the electronic device displays, via the one or more display generation components, a user interface of a second application, different from the first application, wherein the user interface of the second application includes a keyboard user interface (e.g., a component within the second application that allows the user to input text, commands, and/or other data using a virtual keyboard layout), such as the messaging user interface in FIG. 22II. In some embodiments, the keyboard user interface is displayed in applications such as messaging applications, email clients, social media platforms, content creation tools, note-taking applications, and/or any other applications where text entry is a frequent user interaction. In some embodiments, the keyboard user interface includes a layout of keyboard keys that are selectable to enter text, commands, and other data into the user interface of the second application, facilitating interactive and textual input by the user. In some embodiments, the keyboard user interface includes one or more selectable options that allow the user to access and display emojis and/or stickers, which are available for selection and insertion into communications or content within the second application. In some embodiments, the keyboard user interface is a component of the operating system, universally accessible across various applications, or it is a specific feature integrated within the user interface of the second application. In some embodiments, the keyboard user interface displayed in the second application is used in conjunction with the user interface of a third application.

In some embodiments, while displaying the keyboard user interface, the electronic device detects, via the one or more input devices, a fourth set of one or more inputs (e.g., one or more of a tap input, a mouse click input, or an air gesture input selecting a key or other selectable option in the keyboard user interface, which is directed to the key or other selectable option (e.g., based on a location of a touch input, a location of a cursor or location of attention of a user (e.g., based on gaze)) directed to the keyboard user interface, such as the input 2203 in FIG. 22KK. In some embodiments, the fourth set of one or more inputs includes user actions such as tapping or clicking on an emoji and/or sticker button within the keyboard user interface. In some embodiments, the fourth set of one or more inputs has one or more characteristics of any set of one or more inputs described herein. In some embodiments, the fourth set of one or more inputs being directed to the keyboard user interface involves one or more user actions that involve typing or entering data through the keyboard user interface (e.g., text entry or command execution).

In some embodiments, in response to detecting the fourth set of one or more inputs, the electronic device displays, in the user interface of the second application, a plurality of representations of a plurality of automatically-generated visual content that are available for use in the second application, including a representation of the automatically-generated visual content that was generated based on the customized appearance of the subject, such as displaying emoji 2254g in FIG. 22L in response to detecting the input 2203 in FIG. 22K. In some embodiments, the plurality of representations of the plurality of automatically-generated visual content that are available for use in the second application refers to a set of distinct visual elements (e.g., icons or simplified graphical representations) displayed within the user interface of the second application that represent different automatically-generated visual content from the collection that the user optionally selects for use within the application. In some embodiments, these different automatically-generated visual content items are generated in one or more of the ways described above with reference to method 2300. For example, in a messaging application, the keyboard user interface may display a series of icons representing different emojis or stickers corresponding to the plurality of automatically-generated visual content available for use in the second application. In some embodiments, the user interface of the second application includes a specific icon or visual representation that corresponds to the automatically-generated visual content generated from the customized appearance of the subject, allowing the automatically-generated visual content to be selected for use within the second application. In some embodiments, upon detecting an input selecting a particular emoji or sticker (e.g., the automatically-generated visual content) from the plurality of representations of the plurality of automatically-generated visual content displayed within the user interface of the second application, the electronic device inserts the selected emoji or sticker into an active text field or designated area within the user interface of the second application. Displaying the automatically-generated visual content within a second application's user interface, including a keyboard user interface, enhances the electronic device's versatility and user experience by enabling personalized media items to be generated and used across different applications, reducing the need for repetitive operations with are inefficient and require additional inputs and additional processing.

It should be understood that the particular order in which the operations in FIG. 23 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1400, 1500, 1700, 1900, 2100, and/or 2700) are also applicable in an analogous manner to method 2300 described above with respect to FIG. 23. For example, the operation of customizing subjects for generating automatically-generated visual content described above with reference to method 2300 optionally has one or more of the characteristics of, displaying a representation of a prompt and one or more recognized concepts, editing one or more parameters, including one or more recognized concepts, of a previously generated automatically-generated visual content, adding a representation of automatically-generated visual content into a first application, presenting an automatically-generated visual media creation user interface to use a non-automatically-generated visual media as the reference media item, displaying portion(s) of a user interface with HDR luminance, displaying one or more portions of the user interface with luminance that is within or greater than a SDR luminance, generating multiple variations of representations of automatically-generated visual content, restricting prompt components to be used to generate automatically-generated visual content, suggesting prompt component suggestions based on device context, and constraining template subjects and using a random or pseudorandomly selected template subject as the subject for generating the automatically-generated visual content as described herein with reference to other methods described herein (e.g., 700, 800, 1000, 1200, 1400, 1500, 1700, 1900, 2100, and/or 2700). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 23 are, optionally, implemented by components depicted in FIGS. 1A-1B. For example, detecting operations 2302a and 2302c and displaying operation 2302b are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Some embodiments of the disclosure are directed to automatically generating generative visual content items, such as by using one or more AI processes (e.g., based on one or more AI models). In some embodiments one or more AI processes (e.g., based on AI models) are performed by an electronic device, such as AI processes invoked from a software application stored in memory at the electronic device. For example, respective electronic devices optionally are configured to use the same one or more AI procedures (e.g., based on one or more AI models) and/or one or more AI processes to automatically generate visual content items. In some embodiments, one or more software applications invoke the one or more AI processes. In some embodiments, a first electronic device is configured to invoke one or more AI processes, via a first software application, that are similar to one or more AI procedures invoked by a second electronic device, via a second software application. For example, FIGS. 24A-24E illustrate examples of various electronic devices detecting inputs launching different software applications, detecting inputs initiating invoking one or more of the machine learning models, facilitating automatic generation of representation of automatically generated generative visual content items, and/or displaying the automatically-generated generative visual content items (e.g., overlaying user interfaces for respective software applications). It is understood that such examples are merely exemplary, and that the respective electronic devices illustrated in FIGS. 24A-24E are optionally configured to invoke the one or more AI procedures (e.g., based on one or more AI models) from user interfaces for different applications than those expressly illustrated. Additionally or alternatively, it is understood that the one or more AI processes (e.g., based on one or more AI models) described with reference to FIGS. 24A-24E have one or more characteristics that are similar to, or the same as one or more characteristics of one or more machine learning models, one or more AI models, and/or one or more AI processes described with reference to methods 700, 800, 1000, 1200, 1400, 1500, 1700, 1900, 2100, 2300 and/or 2700.

FIG. 24A illustrates a plurality of electronic devices displaying system user interfaces. For example, electronic device 2400a (e.g., a desktop computing device) displays user interface 2408a via display generation component 2400b, corresponding to a desktop user interface including a plurality of selectable options that, when selected, cause electronic device 2400a to launch a user interface for a software application corresponding to the selected option. In FIG. 24A, electronic device 2400a is in communication with an input device 2400c, such as a trackpad that includes a touch-sensitive surface. In FIG. 24A, electronic device 2400a detects input 2434a, corresponding to a contacting of an object such as a finger and/or a stylus on the surface while a cursor that is controlled in accordance with the input directed to input device 2400c (or, optionally, while input focus) is directed to selectable option 2408b displayed in user interface 2408a. In FIG. 24A, input 2434a corresponds to a request to a launch a user interface for a word processing application. It is understood that additional or alternative input described in relation to electronic device 2400a is optionally directed to the trackpad, and is optionally communicated to electronic device 2400a, which in turn optionally moves the cursor and/or selects displayed content (e.g., one or more presses on the trackpad, one or more clicks on the trackpad, one or more contacts on the trackpad, dragging of the one or more contacts, double-tap or triple-taps on the trackpad, and/or the like are communicated to electronic device 2400a, which in response performs one or more operations).

In some embodiments, electronic device 2402a (e.g., laptop computing device) displays user interface 2414a via display generation component 2402b, corresponding to a desktop user interface including a plurality of selectable options that, when selected, causes electronic device 2402a to launch a user interface for a software application corresponding to the selected option. Electronic device 2402a includes an input device 2402c, which optionally has one or more characteristics similar to or the same as described with reference to input device 2400c. For example, in FIG. 24A, input device 2402c detects input 2436a while a cursor is directed to selectable option 2414b. In response to detecting input 2436a, electronic device 2402a optionally displays a user interface for a note taking application.

In some embodiments, electronic device 2404a (e.g., a handheld mobile device) displays user interface 2428a via display generation component 2404b, corresponding to a home screen user interface 2428a including a plurality of selectable options that, when selected, causes electronic device 2400a to launch a user interface for a software application corresponding to the selected option. For example, display generation component 2404b optionally corresponds to a touchscreen, and electronic device 2404a optionally detects input 2430a (e.g., a touch on the touchscreen) directed to selectable option 2428b. In response to detecting input 2430a, electronic device 2404a optionally displays a user interface for a simulated marking application (e.g., for drawing and/or writing).

In some embodiments, electronic device 2406a (e.g., a tablet computing device) displays user interface 2420a via display generation component 2406b, corresponding to a home screen user interface including a plurality of selectable options that, when selected, causes electronic device 2406a to launch a user interface for a software application corresponding to the selected option. For example, display generation component 2406b optionally corresponds to a touchscreen, and electronic device 2406a optionally detects input 2422a (e.g., a touch on the touchscreen) directed to selectable option 2420b. In response to detecting input 2422a, electronic device 2406a optionally displays a user interface for a presentation application.

FIG. 24B illustrates a plurality of electronic devices displaying user interfaces corresponding to inputs illustrated as shown in FIG. 24A. For example, in FIG. 24B, electronic device 2400a displays user interface 2410a in response to detecting the input as shown in FIG. 24A. User interface 2410a includes a selectable option 2410b, which when selected, optionally causes electronic device 2400a to initiate and/or continue performance of a process to automatically generate a generative visual content item, such as in response to detecting input 2434b. In some embodiments, the devices in FIG. 24B are showing different applications that can access the same functionality as a system-level functionality. In some embodiments, the system-level functionality is available as an API that can be called by the application (e.g., using one or more API calls) to generate content (e.g., automatically-generated content or generative content) based on a prompt (e.g., using an AI process or a generative AI process). Providing the same content generation functionality to a plurality of different applications (e.g., via an API) enables the different applications to provide access to functionality that would be time consuming and/or resource intensive to create separately.

In some embodiments, an API (3190) can be configured to receive one or more parameters that customize an API response and, in turn customize an application behavior. For example, the API (3190) optionally allows for receiving values that enable functionality related to automatic generation of a visual content item, providing text generation/suggestions in writing tool editors, etc. An application, via an API-calling module (3180), optionally provides values to enable different degrees of functionality.

In some embodiments, a value is, optionally, set by the application in the API-calling module (3180) that is indicative of whether, or to what degree, a text suggestion in the text editor will adopt generative AI. One numerical value, such as zero or a value close to zero, optionally indicates little to no generative suggestions while another numerical value, such as one or a value close to one, optionally indicates significant generative suggestions. Alternatively, the value may not be on a scale of zero to one but could be on an alternate scale (e.g., zero to one-hundred). Additionally or alternatively, the value need not be numerical but may be a verbally descriptive value such as low/medium/high or weak/moderate/strong.

In the case of an application requesting, via the API-calling module (3180), little to no image generative suggestions, the API (3190) optionally provides more basic image suggestions such as a standard image recommendation based on a keyword match of an existing collection of images. By contrast, in the case the application via the API-calling module (3180) requests significant generative suggestions, the API (3190) optionally enables the application to preform automatic generation of entirely new images constructed using the existing user-created text, drawings or images as a prompt.

In the case of an application requesting, via the API-calling module (3180) little to no textual generative suggestions, the API (3190) optionally provide more basic text editing suggestions in the text editor such as a standard spell checker or grammar checker. By contrast, in the case the application via the API-calling module (3180) requests significant generative suggestions, the API (3190) optionally enables the text editor in the application to preform entire textual re-writes (e.g., re-write an entire email in a different tone such as a professional tone, a casual tone, etc.) or large text block add-ons (e.g., the introduction of new sentences or paragraphs) that use the existing user-created text, drawings or images as a prompt.

Additionally or alternatively, electronic device 2402a displays user interface 2416a in response to detecting the input as shown in FIG. 24A. User interface 2416a includes a selectable option 2416b, which when selected, optionally causes electronic device 2402a to initiate and/or continue performance of a process to automatically generate a generative visual content item, such as in response to detecting input 2436b.

Additionally or alternatively, electronic device 2404a displays user interface 2432a in response to detecting the input as shown in FIG. 24A. User interface 2432a includes selectable option 2432b, which when selected, optionally causes electronic device 2404a to display user interface 2342aa, corresponding to a selection interface including selection region 2438 and including a plurality of representations of generative visual content items, and/or including a selectable option 2440. Selectable option 2440, when selected, causes electronic device 2404aa to initiate and/or continue performance of a process to automatically generate a generative visual content item, such as in response to detecting input 2430bb.

Additionally or alternatively, electronic device 2406a displays user interface 2424a in response to detecting the input as shown in FIG. 24A. User interface 2424a includes a selectable option 2424b, which when selected, optionally causes electronic device 2406a to initiate and/or continue performance of a process to automatically generate a generative visual content item, such as in response to detecting input 2422b.

FIG. 24C illustrates a plurality of electronic devices displaying user interfaces configured to facilitate generating of generative visual content items overlaying user interfaces for software applications. For example, in FIG. 24C, electronic device 2400a displays window 2412a overlaying user interface 2410a in response to detecting input as shown in FIG. 24B. In some embodiments, window 2412a includes representation 2412b, which corresponds to one or more of the representations and/or visual media that provides a preview of an automatically-generated generative visual content item. In some embodiments, the content including representations, selectable options, visual effects, animations, and/or the like have one or more characteristics of similar or the same terms described with reference to methods 700, 800, 1000, 1200, 1400, 1500, 1700, 1900, 2100, 2300 and/or 2700. In FIG. 24C, electronic device 2400a detects input 2434c while the cursor is directed to selectable option 2412c, which when selected, causes electronic device 2400a to display a high-fidelity version of the automatically-generated generative visual content item depicted by representation 2412b.

In FIG. 24C, electronic device 2402a displays window 2418a overlaying user interface 2416a in response to detecting input as shown in FIG. 24B. In some embodiments, window 2418a includes representation 2418b, which corresponds to one or more of the representations and/or visual media that provides a preview of an automatically-generated generative visual content item. In some embodiments, the content including representations, selectable options, visual effects, animations, and/or the like have one or more characteristics of similar or the same terms described with reference to methods 700, 800, 1000, 1200, 1400, 1500, 1700, 1900, 2100, 2300 and/or 2700. In FIG. 24C, electronic device 2402a detects input 2436c while the cursor is directed to selectable option 2418c, which when selected, causes electronic device 2402a to display a high-fidelity version of the automatically-generated generative visual content item depicted by representation 2418b.

In FIG. 24C, electronic device 2404a displays user interface 2442 overlaying user interface 2432a in response to detecting input as shown in FIG. 24B. In some embodiments, user interface 2442 includes representation 2444, which corresponds to one or more of the representations and/or visual media that provides a preview of an automatically-generated generative visual content item. In some embodiments, the content including representations, selectable options, visual effects, animations, and/or the like have one or more characteristics of similar or the same terms described with reference to methods 700, 800, 1000, 1200, 1400, 1500, 1700, 1900, 2100, 2300 and/or 2700. In FIG. 24C, electronic device 2404a detects input 2430c directed to selectable option 2434e, which when selected, causes electronic device 2404a to display a high-fidelity version of the automatically-generated generative visual content item depicted by representation 2444.

In FIG. 24C, electronic device 2406a displays window 2426a overlaying user interface 2424a in response to detecting input as shown in FIG. 24B. In some embodiments, window 2426a includes representation 2426b, which corresponds to one or more of the representations and/or visual media that provides a preview of an automatically-generated generative visual content item. In some embodiments, the content including representations, selectable options, visual effects, animations, and/or the like have one or more characteristics of similar or the same terms described with reference to methods 700, 800, 1000, 1200, 1400, 1500, 1700, 1900, 2100, 2300 and/or 2700. In FIG. 24C, electronic device 2406a detects input 2422c directed to selectable option 2426c, which when selected, causes electronic device 2406a to display a high-fidelity version of the automatically-generated generative visual content item depicted by representation 2426b.

FIG. 24D illustrates a plurality of electronic devices displaying high fidelity previews of automatically-generated generative visual content items. For example, in FIG. 24D, electronic device 2400a displays window 2412a overlaying user interface 2410a. In some embodiments, the generative visual content item displayed in window 2412a corresponds to (e.g., is similar to, the same as, is based upon, is generated using a same AI process, is generated using a same generative AI process, and/or is accessed using a same API call to access system-level functionality that was used to generate) the corresponding representation displayed in FIG. 24C previewing the generative visual content item. In some embodiments, the generative visual content item included in window 2412a is displayed with a level of fidelity greater than the representation displayed in FIG. 24C, such as described with reference to method(s) 700, 800, 1700, 1900, 2100, and/or 2300. In some embodiments, window 2412a includes a selectable option 2412e, which when selected, causes electronic device 2400a to initiate a process to save and/or add the generative visual content item to the user interface 2410a, such as in response to detecting input 2434d.

In FIG. 24D, electronic device 2402a displays window 2418a overlaying user interface 2416a. In some embodiments, the generative visual content item displayed in window 2418a corresponds to (e.g., is similar to, the same as, is based upon, is generated using a same AI process, is generated using a same generative AI process, and/or is accessed using a same API call to access system-level functionality that was used to generate) the corresponding representation displayed in FIG. 24C previewing the generative visual content item. In some embodiments, the generative visual content item included in window 2418a is displayed with a level of fidelity greater than the representation displayed in FIG. 24C, such as described with reference to method(s) 700, 800, 1700, 1900, 2100, and/or 2300. In some embodiments, window 2418a includes a selectable option 2418e, which when selected, causes electronic device 2402a to initiate a process to save and/or add the generative visual content item to the user interface 2416a, such as in response to detecting input 2436d.

In FIG. 24D, electronic device 2404a displays user interface 2434f overlaying user interface 2432a. In some embodiments, the generative visual content item displayed in user interface 2434f corresponds to (e.g., is similar to, the same as, is based upon, is generated using a same AI process, is generated using a same generative AI process, and/or is accessed using a same API call to access system-level functionality that was used to generate) the corresponding representation displayed in FIG. 24C previewing the generative visual content item. In some embodiments, the generative visual content item included in user interface 2434f is displayed with a level of fidelity greater than the representation displayed in FIG. 24C, such as described with reference to method(s) 700, 800, 1700, 1900, 2100, and/or 2300. In some embodiments, user interface 2434f includes a selectable option 2434g, which when selected, causes electronic device 2404a to initiate a process to save and/or add the generative visual content item to the user interface 2432a, such as in response to detecting input 2430d.

In FIG. 24D, electronic device 2406a displays window 2426a overlaying user interface 2424a. In some embodiments, the generative visual content item displayed in window 2426a corresponds to (e.g., is similar to, the same as, is based upon, is generated using a same AI process, is generated using a same generative AI process, and/or is accessed using a same API call to access system-level functionality that was used to generate) the corresponding representation displayed in FIG. 24C previewing the generative visual content item. In some embodiments, the generative visual content item included in window 2426a is displayed with a level of fidelity greater than the representation displayed in FIG. 24C, such as described with reference to method(s) 700, 800, 1700, 1900, 2100, and/or 2300. In some embodiments, window 2426a includes a selectable option 2426e, which when selected, causes electronic device 2406a to initiate a process to save and/or add the generative visual content item to the user interface 2424a, such as in response to detecting input 2422d.

FIG. 24E illustrates display of automatically generated visual media included in user interfaces for respective software applications. In FIG. 24E, electronic devices 2400a, 2402a, 2404a, and 2406a respectively display automatically-generated generative visual content items 2412f, 2418f, 2434n, and 2426f, such as respectively overlaying user interfaces 2410a, 2416a, 2432a, and 2424a. For example, electronic devices 2400a, 2402a, 2404a, and 2406a respectively display the automatically-generated generative visual content items in response to respectively detecting and/or detecting an indication of inputs 2434d, 2346d, 2340d, and 2422d as shown in FIG. 24D.

Thus, electronic devices 2400a, 2402a, 2404a, and 2406a optionally incorporate automatically-generated generative visual content items into user interface for respective software applications, thereby enabling a user of electronic devices 2400a, 2402a, 2404a, and 2406a to quickly and efficiently add visual media to user interfaces for application that are otherwise are not optimized to generate and/or do not facilitate generating of the visual media.

FIGS. 25A-25O illustrate example visual effects and/or operations corresponding to visual effects and/or operations described in this disclosure, such as described with reference to methods 700, 800, 1000, 1200, 1400, 1500, 1700, 1900, 2100 and/or 2300.

FIG. 25A illustrates an example visual effect 2502A for when the computer system 101 presents notifications that have been summarized using one or more AI processes (e.g., based on one or more AI models). FIG. 25A includes a first view (“view A”), a second view (“view B”) and a third view (“view C”). The visual effect 2502A is applied to notification indications 2504A, 2506A, and 2508A that include content (e.g., automatically-generated text content or generative text content) summarized using one or more AI processes (e.g., or one or more generative AI processes). In some embodiments, the visual effect 2502A includes multi-colored animation overlaying the notification indications 2504A, 2506A, and 2508A. The visual effect 2502A optionally corresponds to the border and/or animation of the visual effects 1808d through 1308f described with reference to FIG. 13B and/or the visual effects applied to notification 1390 summarized using one or more AI processes in FIG. 13Z. The notification indications 2504A, 2506A, and 2508A optionally correspond to visual information 1317 generated using one or more AI processes described with reference to FIG. 13B and/or to notification 1390 summarized using one or more AI processes in FIG. 13Z. Notification 2510A, to which the visual effects are not applied, optionally corresponds to notification 1392 in FIG. 13Z. The techniques described with reference to FIG. 25A optionally have one or more characteristics of similar techniques described above with reference to method(s) 1400 and/or 1500.

FIG. 25B illustrates an example visual effect 2502B for when the computer system 101 presents notifications that have been summarized using one or more AI processes (e.g., based on one or more AI models). FIG. 25B includes a first view (“view A”) including notification 2504B that includes content (e.g., automatically-generated text content or generative text content) that has been summarized and/or prioritized using one or more (e.g., or one or more generative AI processes) AI processes, a second view (“view B”) including notification 2506B that includes content (e.g., automatically-generated text content or generative text content) that has been summarized and/or prioritized using one or more AI processes (e.g., or one or more generative AI processes), and a third view (“view C”) including notification 2506B that includes content (e.g., automatically-generated text content or generative text content) that has been summarized and/or prioritized using one or more AI processes (e.g., or one or more generative AI processes). The visual effect 2502B is applied to notification indications 2504B, 2506B, and 2508B that include content summarized using one or more AI processes. In some embodiments, the visual effect 2502B includes multi-colored animation overlaying and/or outlining the notification indications 2504B, 2506B, and 2508B. The visual effect 2502B optionally corresponds to the border and/or animation of the visual effects 1808d through 1308f described with reference to FIG. 13B and/or the visual effects applied to notification 1390 summarized using one or more AI processes in FIG. 13Z. The notifications 2504B, 2506B, and 2508B optionally correspond to visual information 1317 generated using one or more AI processes described with reference to FIG. 13B and/or to notification 1390 summarized using one or more AI processes in FIG. 13Z. The techniques described with reference to FIG. 25B optionally have one or more characteristics of similar techniques described above with reference to method(s) 1400 and/or 1500.

FIG. 25C illustrates an example visual effect 2502C for when the computer system 101 presents a response from a virtual assistant (e.g., based on a written and/or verbal prompt and optionally on contextual information about a state of the device or a state of the user interface displayed via a display generation component of the device) that has been generated using one or more AI processes (e.g., using one or more generative AI processes and/or based on one or more AI models). FIG. 25C includes a first view (“view A”) without a response from a virtual assistant that has been generated using the one or more AI processes (e.g., one or more generative AI processes), a second view (“view B”) including a response 2504C from a virtual assistant that has been generated using one or more AI processes (e.g., one or more generative AI processes), a third view (“view C”) including a response 2506C from a virtual assistant that has been generated using one or more AI processes, and a fourth view (“view D”) including a response 2508C from a virtual assistant that has been generated using one or more AI processes (e.g., one or more generative AI processes). The visual effect 2502C is applied to response indications 2504C, 2506C, and 2508C that include a response from a virtual assistant that has been generated using one or more AI processes. In some embodiments, the visual effect 2502C includes multi-colored animation overlaying and/or outlining the response indications 2504C, 2506C, and 2508C. The visual effect 2502C optionally corresponds to the border and/or animation of the visual effects 1808d through 1308f described with reference to FIG. 13B and/or the visual effects applied to response 1390 generated using one or more AI processes in FIG. 13Z. The response indications 2504C, 2506C, and 2508C optionally correspond to visual information 1317 generated using one or more AI processes described with reference to FIG. 13B, 13J, 13K, 13L, 13O, 13P, and/or to notification 1390 summarized using one or more AI processes in FIG. 13Z. The techniques described with reference to FIG. 25C optionally have one or more characteristics of similar techniques described above with reference to method(s) 1400 and/or 1500.

FIG. 25D illustrates an example visual effect 2502D for when an electronic device performs an invocation of a virtual assistant using hardware on the electronic device 500 (e.g., a button, crown, or dial). Invocation of the virtual assistant when accompanied by a prompt optionally generates a response generated by one or more AI processes (e.g., one or more generative AI processes), as described in greater detail above with reference to FIG. 25C. The visual effect 2502D is applied to a user interface (e.g., a lock screen user interface, such as shown in FIG. 25D. The visual effect 2502D optionally includes displaying a portion of the user interface with one or more colors (e.g., orange, yellow, pink, and/or purple) along a color gradient. In some embodiments, the electronic device displays the visual effect 2502D starting at a location of the user interface (e.g., a location on the touch screen adjacent to the hardware). In some embodiments, the visual effect 2502D is animated such that the visual effect 2502D spreads throughout the user interface. The visual effect 2502D and/or the operation of invoking the voice assistant correspond to (e.g., share one or more or all of the characteristics of) the visual effects and/or operations described with reference to FIG. 13A. The techniques described with reference to FIG. 25D optionally have one or more characteristics of similar techniques described above with reference to method(s) 1400 and/or 1500.

FIG. 25E illustrates an example visual effect 2502E for when an electronic device performs an invocation of a virtual assistant using a voice input on the electronic device 500 (e.g., a button, crown, or dial). Invocation of the virtual assistant when accompanied by a prompt optionally generates a response generated by one or more AI processes (e.g., one or more generative AI processes), as described in greater detail above with reference to FIG. 25C. The visual effect 2502E is applied to a user interface (e.g., a lock screen user interface, such as shown in FIG. 25E. The visual effect 2502E optionally includes displaying a portion of the user interface with one or more colors (e.g., orange, yellow, pink, and/or purple) along a color gradient. In some embodiments, the electronic device displays the visual effect 2502E starting at a location of the user interface (e.g., the bottom of the user interface). In some embodiments, the visual effect 2502E is animated such that the visual effect 2502E spreads throughout the user interface. The visual effect 2502E and/or the operation of invoking the voice assistant correspond to (e.g., share one or more or all of the characteristics of) the visual effects and/or operations described with reference to FIG. 13A and FIG. 13O. The techniques described with reference to FIG. 25E optionally have one or more characteristics of similar techniques described above with reference to method(s) 1400 and/or 1500.

FIG. 25F illustrates an example visual effect 2502F for when an electronic device performs an invocation of a virtual assistant using a keyboard on the electronic device 500 (e.g., a button, crown, or dial), or when a virtual keyboard is displayed for providing a prompt to a virtual assistant. Invocation of the virtual assistant when accompanied by a prompt optionally generates a response generated by one or more AI processes (e.g., one or more generative AI processes), as described in greater detail above with reference to FIG. 25C. The visual effect 2502F is applied to a keyboard such as shown in FIG. 25D after the electronic device receives an input to invoke a virtual assistant. The visual effect 2502F optionally includes displaying a portion of the keyboard with one or more colors (e.g., orange, yellow, pink, and/or purple) along a color gradient. In some embodiments, the visual effect 2502F is overlaid over the keyboard. In some embodiments, the visual effect 2502F is animated such that the visual effect 2502F optionally changes in location, length, width, color, and/or luminance over time. The visual effect 2502F and/or the operation of invoking the voice assistant correspond to (e.g., share one or more or all of the characteristics of) the visual effects and/or operations described with reference to FIG. 13Y. The techniques described with reference to FIG. 25F optionally have one or more characteristics of similar techniques described above with reference to method(s) 1400 and/or 1500.

FIG. 25G illustrates an example visual effect 2502g for when the computer system performs an operation to initiate a process to generate a representation of automatically-generated generative visual content based on an event (e.g., using an AI process or a generative AI process) as described in more detail with reference to methods 700, 800, 1000, 1200, 1700, 1900, 2100, and/or 2300. The visual effect 2502g is applied to the representations of the automatically-generated generative visual content item (e.g., the edges of the representation), such as representations 2504g, 2506g, 2508g, 2510g, and/or 2512g (e.g., control element user interface element). In some embodiments, the visual effect 2502g has an amount of visual effect that includes a size larger, a shape larger, a color more distinct, a brightness more luminous; a visual emphasis more distinct, an animation more appealing, and/or a visual property more distinct than prior to initiating the process to generate the representation of the automatically-generated generative visual content item. Visual effect 2502g optionally includes displaying the edges of the representation of automatically-generated generative visual content (e.g., a text color, background color, or highlighting color) with one or more colors (e.g., orange, yellow, pink, and/or purple) along a color gradient and/or includes displaying regions of a user interface (e.g., one or more regions that include the representation) with HDR luminance, such that the representation and/or regions around the representation visually move over and/or through the regions. The visual effect 2502g and/or initiating the process to generate a representation of automatically-generated generative visual content optionally corresponds to (e.g., share one or more or all of the characteristics of) the visual effects and/or operations described with reference to FIGS. 6C, 9E, 11E, 16A, 18F, 20E, and/or 22V and/or method(s) 1400 and/or 1500.

FIG. 25H illustrates an example visual effect 2502h for when the computer system performs an operation to initiate a process to generate a representation of automatically-generated generative visual content based on an event (e.g., using an AI process or a generative AI process) as described in more detail with reference to methods 700, 800, 1000, 1200, 1700, 1900, 2100, and/or 2300. In some embodiments the manner in which the computer system applies the visual effect is based on one or more dimensions of the representation of automatically-generated generative visual content item. For example in FIG. 25H, visual effect 2502h includes a cuboidal shape (e.g., representation 2506h) or a spherical shape (e.g., representation 2504h) for example. In some embodiments, when the representation is irregularly shaped, the computer system optionally applies and/or associates appropriately shaped visual effects. In some embodiments, the visual effect 2502h includes colors with varying intensity (e.g., light, dark, or other level of luminosity), such a dark variant (e.g., representation 2502h) and/or a light variant (e.g., representations 2504h and/or 2506h). In some embodiments, the visual effect 2502h optionally corresponds to (e.g., share one or more or all of the characteristics of) the visual effects described with reference to FIGS. 25G, 6C, 9E, 11E, 16A, 18F, 20E, and/or 22V and/or method(s) 1400 and/or 1500.

FIG. 25I illustrates an example visual effect 2506i for when an electronic device performs textual rewriting and/or summarization that includes automatically-generated text (e.g., generative text content) and/or automatically generated content (e.g., generative visual content) that was generated automatically (e.g., using an AI process or a generative AI process). Visual effect 2506i optionally includes displaying one or more user interface elements (e.g., 2502i and/or 2504i) associated with performing the automatic generation with one or more colors (e.g., orange, yellow, pink, and/or purple) along a color gradient and/or includes displaying those user interface elements with HDR luminance, such that the colors visually move over and/or through the user interface elements, such as regions corresponding to user interface elements 2502i and/or 2504i. For example, the electronic device displays a text field 2502i that can accept user input (e.g., text or voice input) to modify text or visual content, including toolbar 2504i that provides selectable suggestions for inputs for modifying text or visual content. In response to receiving selection of one or more of the selectable suggestions in toolbar 2504i and/or in response to receiving input in text field 2502i, the electronic device optionally automatically generates text and/or visual content corresponding to the user inputs (e.g., using an AI process or a generative AI process), for example to modify existing text or visual content. In some embodiments, visual effect 2506i corresponds to (e.g., shares one or more or all of the characteristics of) the visual effects and/or operations described with reference to methods 1400 and/or 1500.

FIG. 25J illustrates an example visual effect 2502j for when an electronic device performs textual rewriting and/or summarization that includes automatically-generated text (e.g., generative text content) that was generated automatically (e.g., using an AI process or a generative AI process). The visual effect optionally includes displaying one or more user interface elements (e.g., 2506j, 2510j and/or 2508j) associated with performing the automatic generation with one or more colors (e.g., orange, yellow, pink, and/or purple) along a color gradient and/or includes displaying those user interface elements with HDR luminance, such that the colors visually move over and/or through the user interface elements, such as regions corresponding to user interface elements 2506j, 2510j and/or 2508j. For example, the electronic device displays a text field 2510j that can accept user input (e.g., text or voice input) to modify text or visual content (e.g., content in a user interface 2504j, such as an email composition user interface), including element 2506j that provides selectable suggestions (e.g., 2508j) for inputs for modifying the text and/or visual content included in user interface 2504j. In response to receiving selection of one or more of the selectable suggestions 2508j and/or in response to receiving input in text field 2510j, the electronic device optionally automatically generates text and/or visual content corresponding to the user inputs (e.g., using an AI process or a generative AI process), for example to modify existing text or visual content in user interface 2504j. In some embodiments, the visual effect described with reference to FIG. 15J corresponds to (e.g., shares one or more or all of the characteristics of) the visual effects and/or operations described with reference to FIG. 13C through FIG. 13F and/or methods 1400 and/or 1500.

FIG. 25K illustrates an example visual effect 2502K for when an electronic device performs textual rewriting and/or summarization that includes automatically-generated text (e.g., generative text content) that was generated automatically (e.g., using an AI process or a generative AI process). Visual effect 2502K optionally includes displaying the automatically-generated text (e.g., a text color, background color, or highlighting color) with one or more colors (e.g., orange, yellow, pink, and/or purple) along a color gradient and/or includes displaying regions of a user interface (e.g., one or more regions that include the automatically-generated text) with HDR luminance, such that the regions visually move over and/or through displayed text, such as regions corresponding to text 2504K. In some embodiments, visual effect 2502K and/or the textual rewriting and/or summarization correspond to (e.g., share one or more or all of the characteristics of) the visual effects and/or operations described with reference to FIG. 13C through FIG. 13F and/or with reference to methods 1400 and/or 1500.

FIG. 25L illustrates an example visual effects 2504L, 2506L for when an electronic device performs visual modification of one or more components of visual content that includes automatically-generated text (e.g., generative text content) and/or automatically generated content (e.g., generative visual content) that was generated automatically (e.g., using an AI process or a generative AI process). The electronic device, while displaying user interface 2502L, optionally detects user input directed to a visual element in user interface 2502L (e.g., circling the visual element using a stylus). The electronic device optionally displays a representation 2504L of the user input directed to the visual element, the representation 2504L having a visual effect applied to it. The visual effect applied to representation 2504L optionally includes displaying the representation with one or more colors (e.g., orange, yellow, pink, and/or purple) along a color gradient and/or includes displaying the representation with HDR luminance, such that the colors visually move over and/or through the representation. The electronic device optionally generates generative visual content based on the visual element in user interface 2502L to which the user input was directed. After the selection or designation of the visual element based on the user input, the electronic device replaces display of the visual element with visual effect 2506L, which optionally signifies that the electronic device is generating generative visual content based on the selected visual element in user interface 2502L. Visual effect 2506L optionally includes displaying the selected region of user interface 2502L with one or more colors (e.g., orange, yellow, pink, and/or purple) along a color gradient and/or includes displaying the region with HDR luminance, such that the colors visually move over and/or through the region. The electronic device then optionally displays visual representations 2508L of recognized concepts extracted from the original selected visual element while maintaining display of visual effect 2506L. Once the electronic device has generated the generative visual content 2510L based on the original selected visual element, the electronic device displays a representation of that generative visual content 2510L in user interface 2502L, concurrently with the visual representations 2508L of recognized concepts extracted from the original selected visual element used to generate the generative visual content 2510L. The electronic device optionally applies a visual effect to the representation of the representation of the generative visual content 2510L, the visual effect optionally including displaying the representation of the generative visual content 2510L with one or more colors (e.g., orange, yellow, pink, and/or purple) along a color gradient and/or includes displaying the representation of the generative visual content 2510L with HDR luminance, such that the colors visually move over and/or through the representation of the generative visual content 2510L. The visual effects described with reference to 2504L, 2506L and 2510L optionally correspond to (e.g., share one or more or all of the characteristics of) the visual effects and/or operations described with reference to methods 1400 and/or 1500.

FIG. 25M illustrates an example visual effect 2502M for when an electronic device performs editing of visual content such as photographs, video, and/or automatically-generated visual content (e.g., generative visual content) that was generated automatically (e.g., using an AI process or a generative AI process). Visual effect 2502M optionally includes displaying regions of a user interface where input is directed to (e.g., to indicate a target of visual content removal) with one or more colors (e.g., orange, yellow, pink, and/or purple) along a color gradient and/or displaying such regions of a user interface with HDR luminance, such as overlaying a region 2506M and/or applied to a region 2506M. In FIG. 25M, grey portions are used to indicate a standard brightness while white portions are used to indicate an HDR brightness value that appears (e.g., when displayed via the display generation component) to be brighter than standard brightness. The temporary display of HDR visual effects indicates (e.g., provides a clear indication of) the portions of the user interface where one or more inputs (e.g., detected via one or more input devices) were directed and where an AI process (e.g., a generative AI process) will perform (or, optionally, has performed) operations to change the content based on the one or more inputs. For example, region 2506M optionally corresponds to a path of an input corresponding to a request to indicate a target of an editing operation-such as an operation to remove an element 2504M from visual content 2508M. In some embodiments, visual effect 2502M and/or the editing of visual content 2508M correspond to (e.g., share one or more or all of the characteristics of) the visual effects and/or operations described with reference to FIG. 13V through FIG. 13W and/or with reference to methods 1400 and/or 1500.

FIG. 25N illustrates an example visual effect 2502N for when an electronic device performs editing of visual content such as simulated drawing, simulated markings, and/or automatically-generated simulated markings (e.g., generative simulated markings) that were generated automatically (e.g., using an AI process or a generative AI process). Visual effect 2502N optionally includes displaying regions of a user interface where input is directed to (e.g., to indicate a target of visual content removal) with one or more colors (e.g., orange, yellow, pink, and/or purple) along a color gradient and/or displaying such regions of a user interface with HDR luminance, such as overlaying a region 2506N and/or applied to a region 2506N. For example, region 2506N optionally corresponds to a path of an input corresponding to a request to indicate a target of an editing operation (e.g., an operation to remove an element 2504N from visual content 2508N). In FIG. 25N, grey portions are used to indicate a standard brightness while white portions are used to indicate an HDR brightness value that appears (e.g., when displayed via the display generation component) to be brighter than standard brightness. The temporary display of HDR visual effects indicates (e.g., provides a clear indication of) the portions of the user interface where one or more inputs (e.g., detected via one or more input devices) were directed and where an AI process (e.g., a generative AI process) will perform (or, optionally, has performed) operations to change the content based on the one or more inputs. In some embodiments, visual effect 2502N and/or the editing of visual content 2508N correspond to (e.g., share one or more or all of the characteristics of) the visual effects and/or operations described with reference to FIG. 13V through FIG. 13W and/or with reference to methods 1400 and/or 1500.

FIG. 25O illustrates an example sequence of visual effects 25020 through 25140 for when the computer system performs an operation to initiate a process to generate a representation of automatically-generated generative visual content that includes a collection of content and/or media, such as a memory collection 15160 of photos (e.g., using an AI process or a generative AI process) as described in more detail with reference to methods 1400 and/or 1500. In some embodiments, the collection of visual content is automatically-generated based on a prompt (e.g., based on a prompt provided to an AI process or a generative AI process), and the visual content is selected and or organized based on the prompt (e.g., selected and or organized by an AI process or a generative AI process). In some embodiments, some or all of the visual content included in the collection of visual is not automatically-generated visual content (e.g., content generated using an AI process or a generative AI process). In some embodiments, some or all of the visual content included in the collection of visual is automatically-generated visual content (e.g., content generated using an AI process or a generative AI process). In some embodiments the manner in which the computer system applies the visual effect includes displaying regions of a user interface that includes the collection of content (e.g., one or more regions that include the collection of content) with HDR luminance, such that a content item of the collection and/or respective region of the content item gives an appearance of animated tiles that have HDR luminance. In FIG. 25O, black portions or portions with other (non-white) colors are used to indicate a standard brightness while white portions are used to indicate an HDR brightness value that appears (e.g., when displayed via the display generation component) to be brighter than standard brightness. The temporary display of HDR visual effects indicates (e.g., provides a clear indication of) the operation of an AI process (e.g., a generative AI process) to perform operations to select items for the collection. In some embodiments, the sequence of visual effects 25020 through 25140 optionally corresponds to (e.g., share one or more or all of the characteristics of) the visual effects described with reference to Figs. FIGS. 13BB-13CC and/or with reference to methods 1400 and/or 1500.

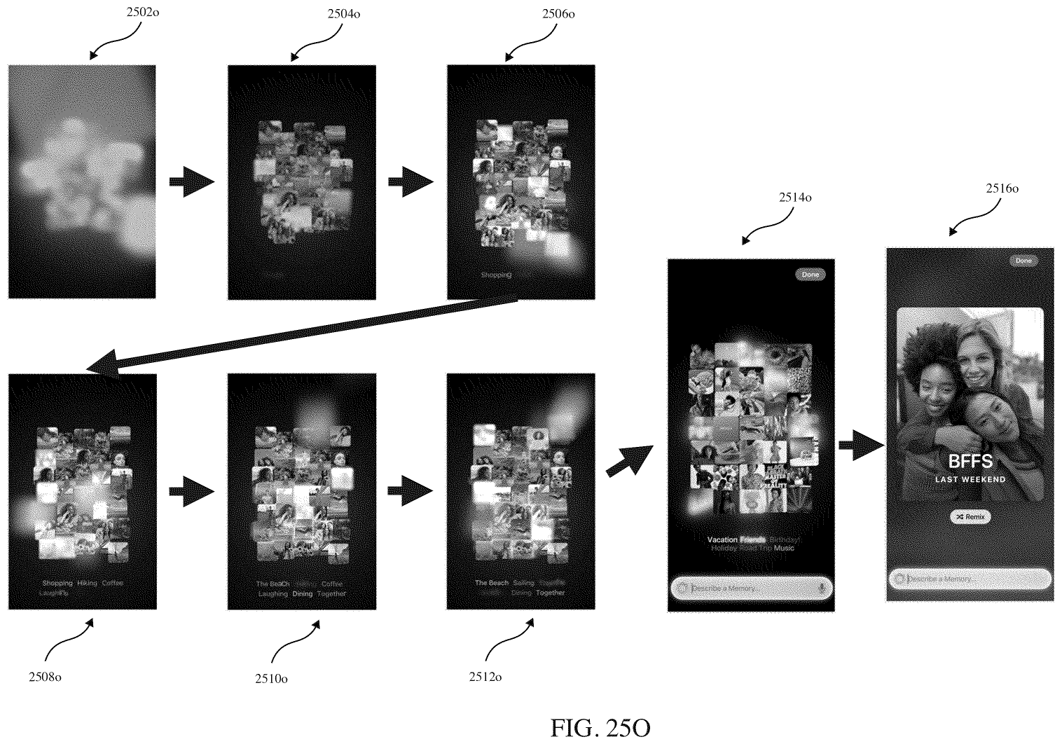

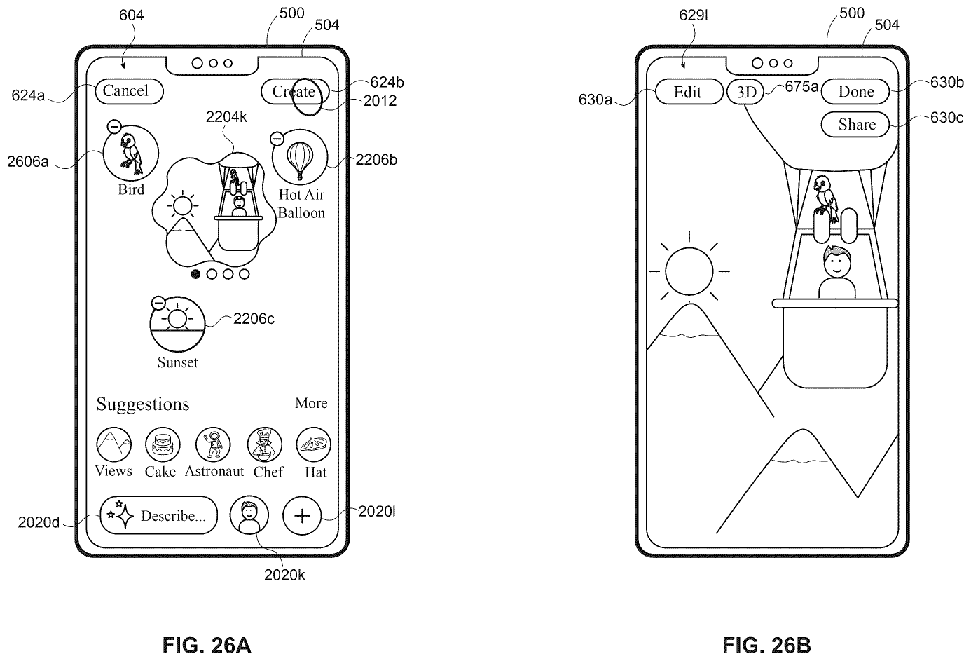

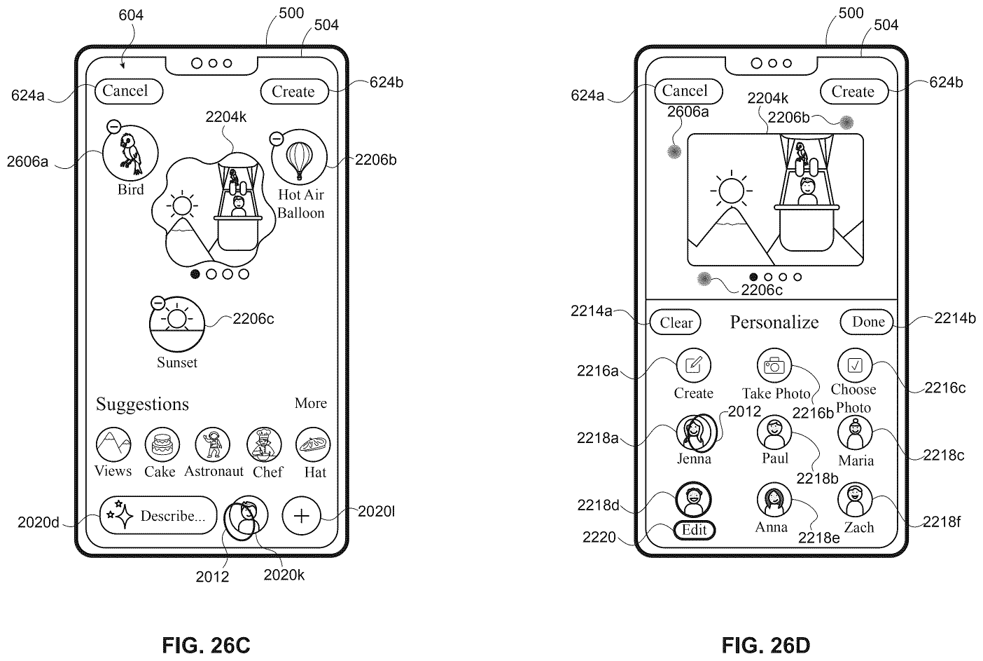

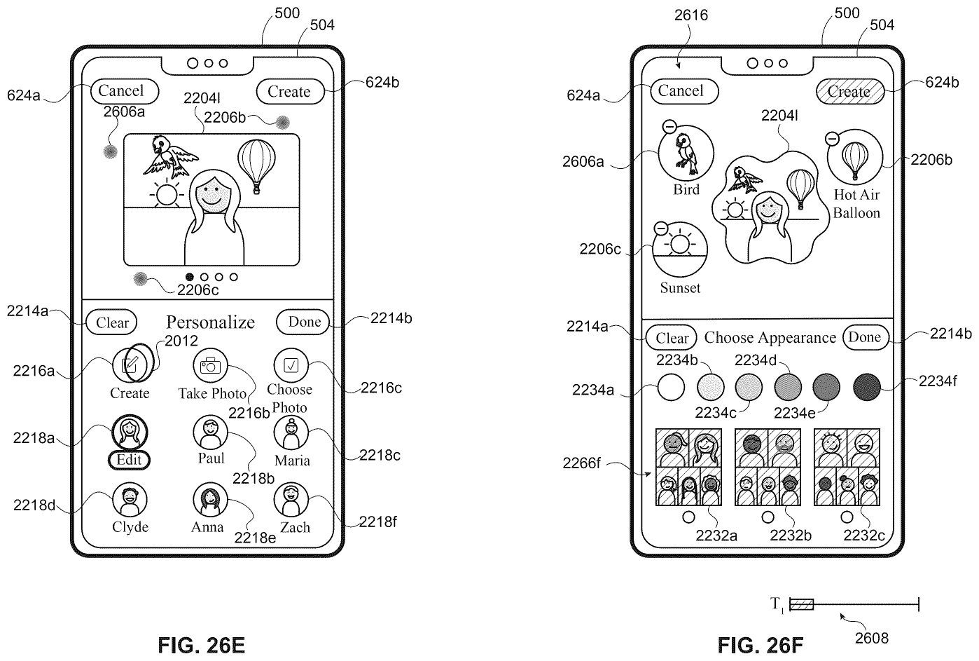

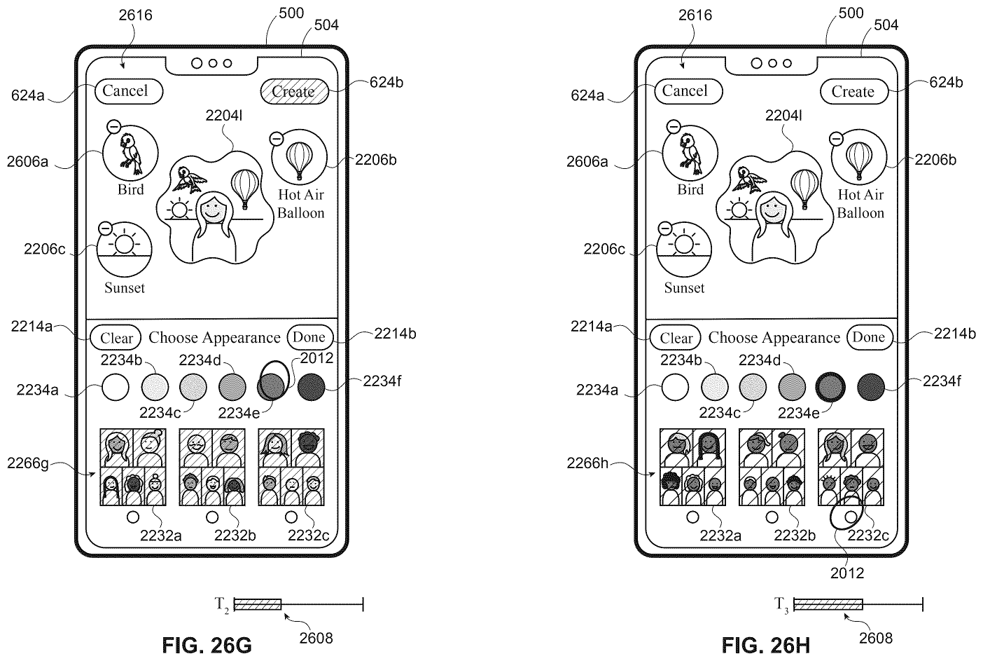

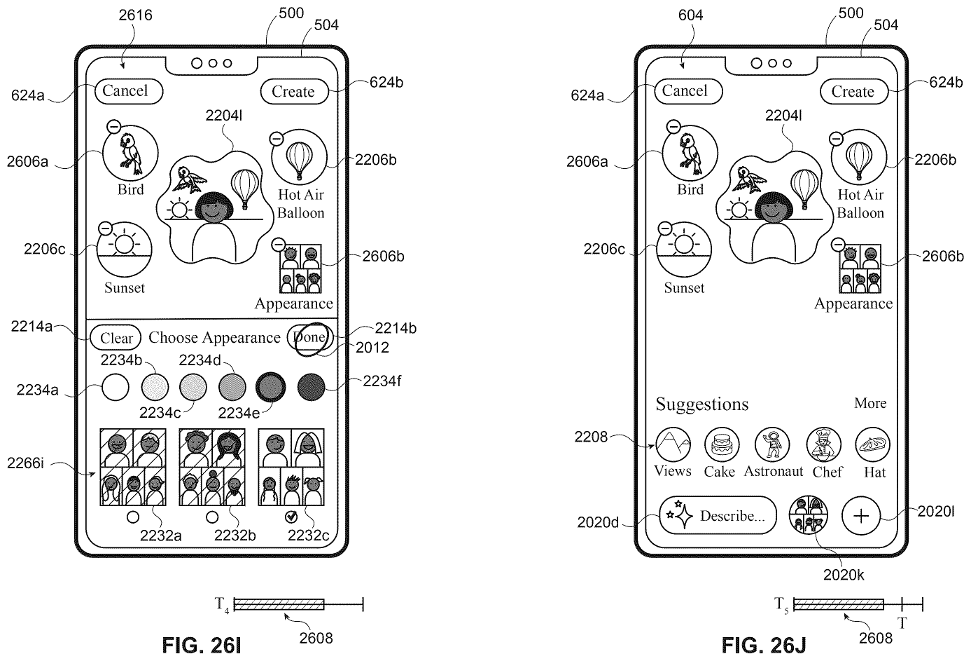

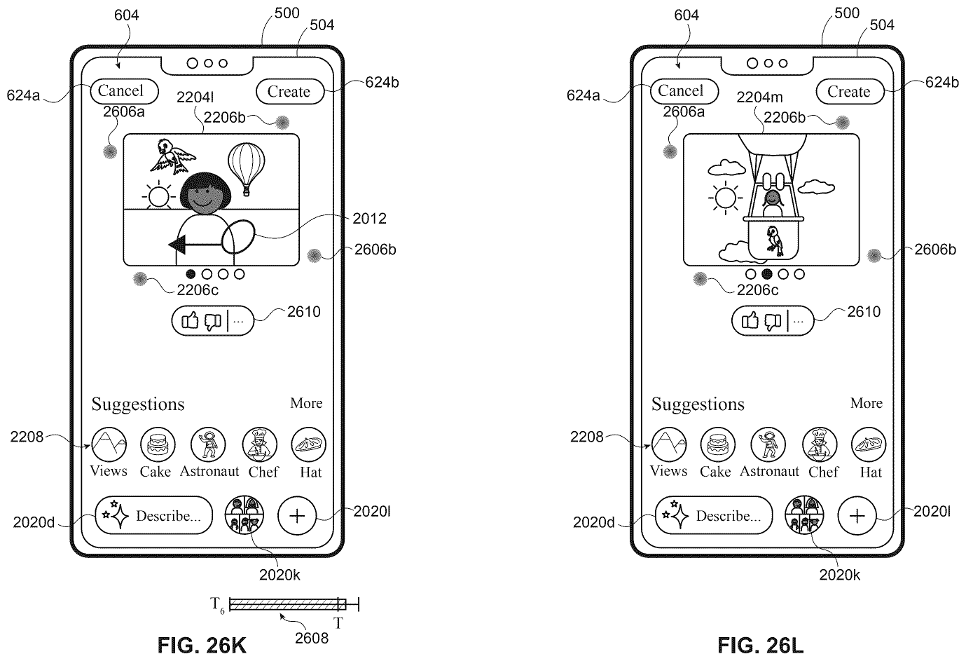

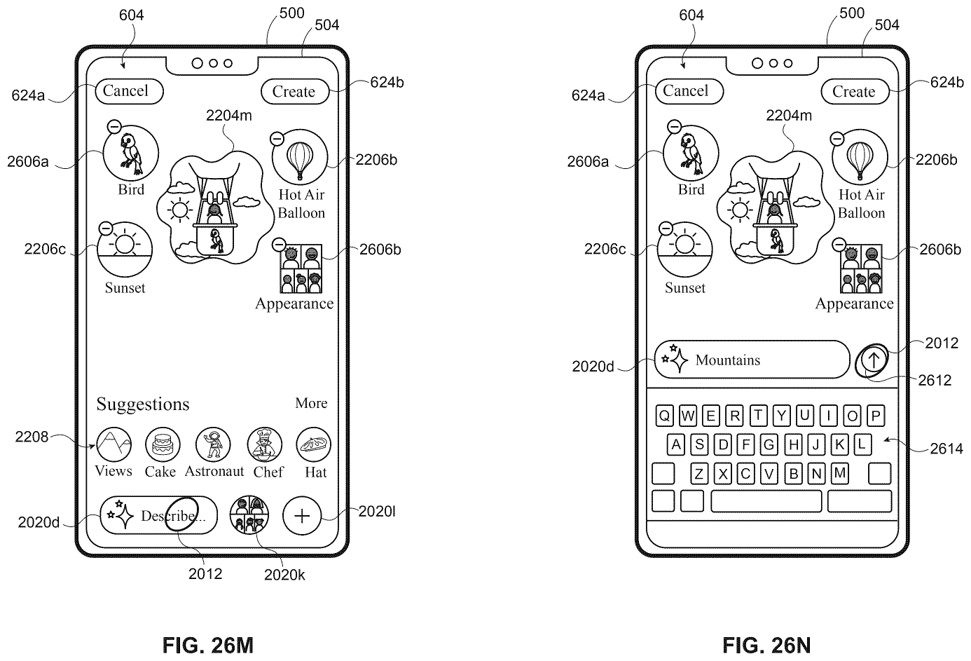

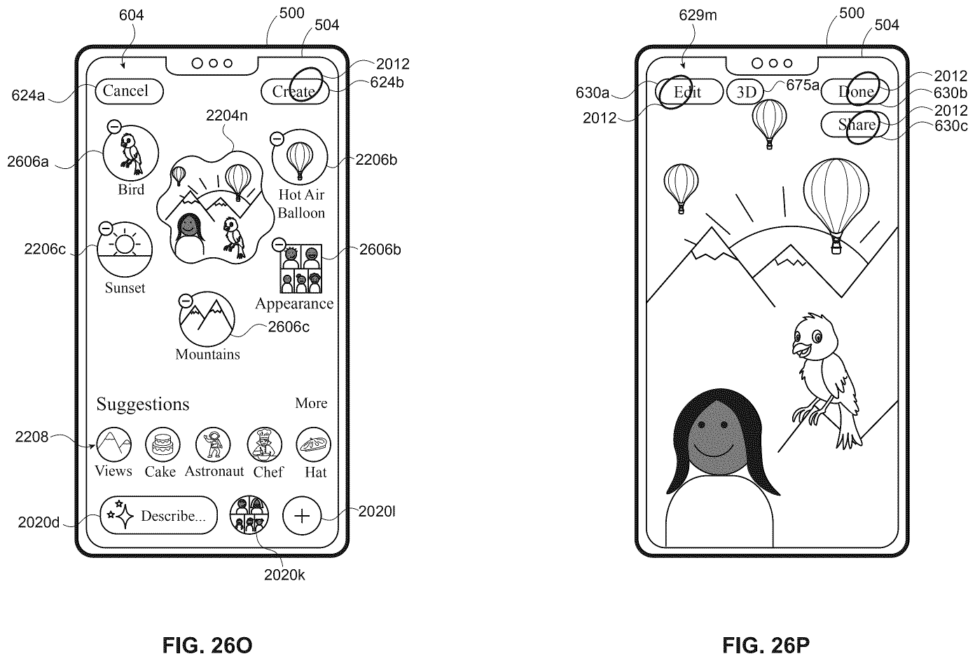

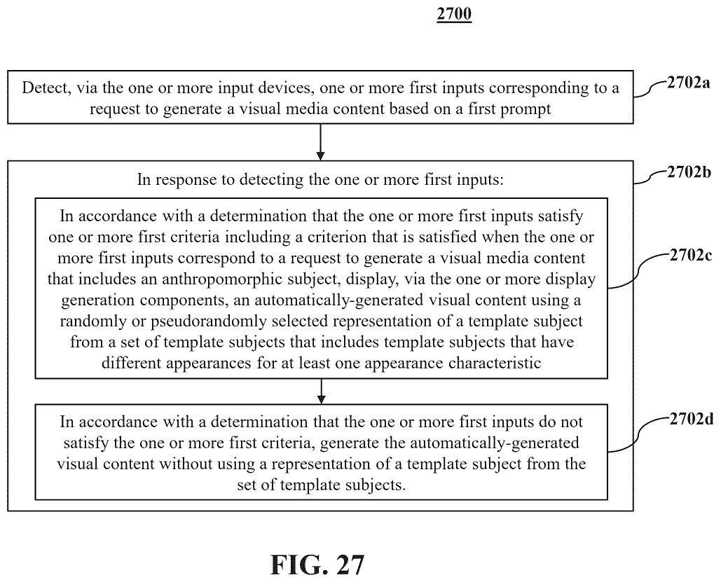

FIGS. 26A-26P illustrate exemplary ways in which an electronic device presents user interfaces for selecting a template subject for generating an automatically-generated visual content item in accordance with some embodiments of the disclosure. The embodiments in these figures are used to illustrate the processes described below, including the processes described with reference to FIG. 27. Although FIGS. 26A-26P illustrate various examples of ways an electronic device is able to perform the processes described below with respect to FIG. 27, it should be understood that these examples are not meant to be limiting, and the electronic device is able to perform one or more processes described below with reference to FIG. 27 in ways not expressly described with reference to FIGS. 26A-26P.

In some embodiments, the user interface of FIGS. 26A-26P corresponds to the user interface of FIGS. 6A-6MM, 16A-16U, 18A-18BB, 20D-20AA, 22A-22CCC, and/or 24A-24E.

Users interact with electronic devices in many different manners. In some embodiments, an electronic device is in communication with one or more input devices and/or one or more display generation components. In some embodiments, the electronic device generates (e.g., using an AI process or a generative AI process) automatically-generated visual content items including a human or nonhuman subject. In some embodiments, automatically-generated visual content is media generated using autonomous processes optionally as described herein. In some embodiments, the subject is an anthropomorphic subject that is randomly or pseudorandomly selected from a set of template subjects. The embodiments described below provide ways in which the electronic device presents user interfaces for selecting sets of template subjects and constraining one or more appearance characteristics of the template subjects. Providing a set of template subjects for customizing the appearance of a subject provide a quick and efficient way to customize an automatically-generated visual content, rather than requiring the automatically-generated visual content to be created by hand or stylus. Providing a set of template subjects allows a user to dictate an overall appearance of the automatically-generated visual content (and the person that is the subject of the automatically-generated visual content). It is understood that people use devices. When a person uses a device, that person is optionally referred to as a user of the device.

FIGS. 26A-26P illustrate exemplary ways in which an electronic device presents user interfaces for selecting a template subject for generating an automatically-generated visual content item. The embodiments in these figures are used to illustrate the processes described below, including the processes described with reference to FIG. 27. Although FIGS. 26A-26P illustrate various examples of ways an electronic device is able to perform the processes described below with respect to FIG. 27, it should be understood that these examples are not meant to be limiting, and the electronic device is able to perform one or more processes described below with reference to FIG. 27 in ways not expressly described with reference to FIGS. 26A-26P.

FIG. 26A illustrates an embodiment of the user interface displayed in FIG. 22A. in FIG. 26A, the prompt component 2206a is replaced with prompt component 2606a, representing a bird. In some embodiments, the one or more prompt components (e.g., component 2206a, 2206d, and 2606a) are recognized concepts used to influence the generation of the automatically-generated visual content item. In some embodiments, recognized concepts are described in greater detail in method 700. In FIG. 26A, representation 2204a shown in FIG. 22A is replaced with representation 2204k. Representation 2204k corresponds to the automatically-generated visual content item that is generated using the one or more prompt components (e.g., the recognized concepts, style, and/or subject). In FIG. 26A, the electronic device 500 displays the subject (e.g., “Clyde”) as an icon on option 2020k. In some embodiments, the subject is based on a person featured in the media library of electronic device 500 as described in further detail in method 2300. In some embodiments, the content entry field 2020d, and options 2020k, and 2020l, are described in greater detail in FIG. 20Z.

In FIG. 26A, the electronic device 500 receives a selection input directed towards option 624b, such as detecting contact 2012 (e.g., a tap or long press input). In response to detecting the input, the electronic device 500 generates the automatically-generated visual content corresponding to representation 2204k, shown in FIG. 26B. Although contact 2012 (e.g., a tap or a long press input) in FIG. 26A is illustrated as a touch input, it should be understood that selection inputs are not limited to touch inputs. Other types of selection inputs, including air gestures, hardware input device inputs, voice inputs and/or one or more inputs based on the attention of the user (e.g., gaze or a gaze proxy, direct input location(s), input focus, and/or cursor location), described in more detail below at least with reference to method 2700, are possible.

FIG. 26B illustrates the user interface 629l including the automatically-generated visual content item. In some embodiments, the electronic device 500 generates the automatically-generated visual content item using the subject (“Clyde”) that is not a template subject. As described above, the subject of the automatically-generated visual content item in FIG. 26B is a subject featured in a media library of the electronic device (e.g., a person in the photo library of the electronic device) In some embodiments, template subjects are described in greater detail in method 2700.

FIG. 26C illustrates user interface 604 including the prompt components 2606a, 2206b, and 2206c. In FIG. 26C, the electronic device 500 detects a selection input directed towards option 2210b, such as detecting the input with contact 2012 (e.g., a tap or long press input). In some embodiments, inputs other than touch inputs are possible, as described above. In response to detecting the input in FIG. 26C, the electronic device 500 displays the personalization user interface for changing the subject of the automatically-generated visual content item, shown in FIG. 26D. The personalization user interface is illustrated and described in greater detail in FIG. 22B. As described above, while displaying the personalization user interface in FIG. 26D, the electronic device 500 updates the display of prompt components 2606a, 2206b, and 2206c to be smaller sizes and with fewer details than illustrated in FIG. 26C. In FIG. 26D, the electronic device 500 detects a selection input directed towards option 2218h, which represents the subject, “Jenna”. The selection input is detected with contact 2012 (e.g., a tap or a long press input), for example. Other inputs described herein are possible. In some embodiments, candidate subjects are described in greater detail in methods 2300 and 2700. In response to detecting the input in FIG. 26D, the electronic device 500 updates the representation 2204k to representation 2204l, shown in FIG. 26E.

FIG. 26E illustrates representation 2204l including the candidate subject “Jenna” instead of the candidate subject “Clyde” shown previously in representation 2204k. In some embodiments, in response to updating the candidate subject without updating the other prompt components (e.g., prompt components 2606a, 2206b, and 2206c), the electronic device 500 generates a different variation of the automatically-generated visual content item using the same prompt components and the selected candidate subject (“Jenna”). In some embodiments, generating variations of automatically-generated visual content items is described in greater detail in method 1700 and 2300.

In FIG. 26E, the electronic device 500 detects a selection input (e.g., a tap or a long press input) directed towards option 2216a with contact 2012. In some embodiments, inputs other than touch inputs are possible, as described above. In response to detecting the input in FIG. 26E, the electronic device 500 displays a user interface 2616 for creating a subject, shown in FIG. 26F. In some embodiments, the user interface 2616 in FIG. 26F is a different embodiment of the user interface shown in FIG. 22O, described above.

FIG. 26F illustrates the user interface 2616 for customizing and selecting an appearance of a template subject. The user interface 2616 includes a plurality of options to customize the template subject such as skin tone options 2234a through 2234f. The skin tone options are shown and described in greater detail in FIG. 20MM. In some embodiments, the skin tone options 2234a through 2234f correspond to natural human skin tones when the electronic device 500 is generating visual media other than emojis. In some embodiments, the skin tone options 2234a through 2234f include a yellow skin tone associated with emojis when the electronic device 500 is generating emojis. Additionally, in FIG. 26F, the electronic device 500 displays a plurality of avatars 2266f (e.g., template subjects, as described in greater detail in method 2300 and 2700) in association with options 2232a, 2232b, and 2232c. Options 2232a, 2232b, and 2232c are shown and described in greater detail in FIG. 22M. In FIG. 26F, the avatars 2266f are displayed with a relatively low amount of visual emphasis prior to the electronic device 500 detecting a selection of a skin tone and/or body style, similar to as shown in FIG. 22MM. Additionally, option 624b shown in FIG. 26F corresponding to option 2230b shown in FIG. 22M, is disabled prior to the electronic device 500 detecting a skin tone and/or body style.

In FIG. 26F, the electronic device 500 displays options 2232a, 2232b, and 2232c with a first set of avatars 2266f (e.g., option 2232a includes female example avatars 2266f; option 2232b includes non-binary example avatars 2266f; and option 2232c includes male example avatars 2266f) having a variety appearance characteristics. Appearance characteristics are described in greater detail in methods 2300 and 2700. In FIG. 26F, the electronic device displays the first set of avatars 2266f at a time T1, indicated by indicator 2608.

In FIG. 26G, at a time T2, different than the time T1, the electronic device 500 updates the display of the first set of avatars 2266f to the second set of avatars 2266g, including updating the avatars 2266g in options 2232a, 2232b, and 2232c. As described in method 2300 and 2700, the electronic device 500 automatically updates the set of template subjects (e.g., also described as avatars) without further user input and based on a threshold amount of time. In FIG. 26G, the electronic device receives a selection input (e.g., a tap or a long press input) directed towards option 2234e with contact 2012 to select a skin tone option 2234e. In some embodiments, inputs other than touch inputs are possible, as described above. In response to detecting the input, the electronic device 400 updates the avatars 2266g to avatars 2266h, shown in FIG. 26H, which includes updating the example avatars 2266g in options 2232a, 2232b, and 2232c to include the selected skin tone, and to no longer include avatars with skin tones other than the selected skin tone. Additionally, updating the avatars also includes displaying the avatars 2266h with different appearance characteristics (e.g., to show additional and/or alternative example avatars). Constraining avatars based on appearance characteristics is described in greater detail in methods 2300 and 2700.

In FIG. 26H, the electronic device 500 updates the avatars from avatars 2266g to 2266h at time T3, as illustrated by indicator 2608. Time T3 is different than time T2 and time T1. In some embodiments, the time between T1, T2, and T3 is not uniform. For example, the electronic device 500 updates the avatars based on a time threshold (e.g., the amount of time between T1 and T2) without additional user input or based on a user input to constrain the appearance characteristics of the avatars (e.g., shown in FIG. 26H, at time T3). Additionally, in FIG. 26H, the electronic device 500 displays the avatars 2266h with more visual emphasis than the amount of visual emphasis of avatars 2266g shown in FIG. 26G. In some embodiments, visual emphasis of avatars is described in greater detail in method 2300.

In FIG. 26H, the electronic device 500 detects a selection input (e.g., a tap or a long press input) directed towards option 2232c with contact 2012. In some embodiments, inputs other than touch inputs are possible, as described above. In some embodiments, the selection input directed towards option 2232c corresponds to selecting a body style for the template subject, such as the male body style. In response to detecting the input in FIG. 26H, the electronic device 500 adds a template subject as a prompt component 2606b to influence the generation of the automatically-generated visual content item, shown in FIG. 26I. Additionally, in FIG. 26I, the electronic device 500 displays the selected option 2232c with more visual emphasis than the amount of visual emphasis of the other options 2232a and 2232b. In some embodiments, visual emphasis of avatars is described in greater detail in method 2300.

In FIG. 26I, the electronic device 500 adds the prompt component 2060b to the prompt for generating the automatically-generated visual content item and as a result, updates the representation of the automatically-generated visual content item to representation 2204l to include the template subject. In some embodiments, the template subject includes the selected skin tone and a body style based on option 2232c. Additionally, in FIG. 26I, the electronic device 500 update the avatars 2266h to avatars 2266i shown in options 2232a through 2232c and prompt component 2606b and the representation 2204l over time in response to a predetermined time passing without receiving an input and/or in response to receiving an input, as shown in FIG. 22I. In FIG. 26I, the electronic device 500 receives a selection input directed towards option 2216b with contact 2012 (e.g., a tap or long press input). In some embodiments, inputs other than touch inputs are possible, as described above. In response to detecting the input directed towards option 2216b, the electronic device 500 ceases displaying user interface 2616 and begins displaying user interface 604, shown in FIG. 26J.

FIG. 26J illustrates the user interface 604 including prompt component 2606b. In FIG. 26J, the electronic device 500 updates option 2020k to include prompt component 2606b since the avatars of 2606b are the subject of the automatically-generated visual content item. In FIG. 26J, the electronic device 500 is at time T5, which is less than a time threshold T. Time T5 is the time in which the electronic device 500 redisplays the user interface 604. In FIG. 26K, the electronic device 500 is at time T6, which is greater than the time threshold T. For example, time T6 is a time after time T5. Between time T5 and T6, the electronic device 500 does not detect additional inputs. Because the time in FIG. 26K exceeds the time threshold, the electronic device 500 updates the user interface 604 to include a larger display of representation 2204l. Additionally, the prompt components 2606a, 2606b, 2206b, and 2206c are smaller in FIG. 26K than in FIG. 26J. The change in display of the prompt components and the representation of the automatically-generated visual content item is described in greater detail in method 700. In some embodiments, the time threshold T has one or more characteristics of 1616b, shown in FIGS. 16A and 16B.

Additionally, in FIG. 26K, the electronic device 500 displays option 2610. Option 2610 includes a thumbs up and a thumbs down option for a user to rate whether they like the representation 2204l of the automatically-generated visual content item. In some embodiments, if the electronic device detects an input directed towards the thumbs up option, then the electronic device 500 displays similar features for future generations of automatically-generated visual content items. In some embodiments, if the electronic device detects an input directed towards the thumbs down option, then the electronic device 500 avoids displaying similar features for future generations of automatically-generated visual content items. Option 2610 also includes a menu option, that when selected, causes the electronic device 500 to display a menu of selectable options to save the automatically-generated visual content item corresponding to representation 2204l while still displaying user interface 604.

In FIG. 26K, the electronic device 500 receives a swipe input directed towards representation 2204l, with contact 2012. In some embodiments, inputs other than touch inputs are possible, as described above. In response to detecting the swipe input, the electronic device 500 displays a second representation 2204m of the automatically-generated visual content item, shown in FIG. 26L. In some embodiments, the second representation 2204m is generated using the same prompt components (e.g., components 2606a, 2606b, 2206b, and 2206c) as representation 2204l, shown in FIG. 26K.

In FIG. 26L, the electronic device 500 displays option 2610, including the menu option. When selected, the menu option causes the electronic device 500 to display a menu of selectable options to save the automatically-generated visual content item corresponding to representation 2204m while still displaying user interface 604.

FIG. 26M illustrates the user interface 604 with a smaller representation 2204m and larger icons for prompt components 2606a, 2606b, 2206b, and 2206c. In FIG. 26M, the electronic device 500 detects an input (e.g., a tap or a long press input) directed towards content entry field 2020d with contact 2012. In some embodiments, inputs other than touch inputs are possible, as described above. In response to detecting the input, the electronic device 500 expands content entry field 2020d, and displays a keyboard 2614, shown in FIG. 26N, which corresponds to keyboard 2037, shown in FIG. 20O.

In FIG. 26N, the electronic device 500 displays “mountains” in the content entry field 2020d in response to detecting one or more inputs directed towards keyboard 2037 to add text to the content entry field 2020d. In FIG. 26N, the electronic device 500 receives a selection input (e.g., a tap or a long press input) directed towards option 2612 using contact 2012 to add the text “mountains” as a prompt component to the prompt for generating the automatically-generated visual content item. In some embodiments, inputs other than touch inputs are possible, as described above. In some embodiments, option 2612 corresponds to option 2020g, shown in FIG. 20O.

In response to receiving the input in FIG. 26N, the electronic device 500 displays the text “mountains” as a prompt component 2606c to be used to influence the generation of the automatically-generated visual content item, as shown in FIG. 26O. Additionally, as shown in FIG. 26O, in response to adding the prompt component 2606c to the prompt, the electronic device 500 displays representation 2204n which includes the addition of the prompt component 2606c. Additionally, the electronic device 500 updates the template subject in representation 2204n to be a different template subject of prompt component 2606b since the electronic device 500 generated a new representation 2204n in response to the addition of prompt component 2606c.

In FIG. 26O, the electronic device 500 detects a selection input (e.g., a tap or a long press input) directed towards option 624b using contact 2012. In some embodiments, inputs other than touch inputs are possible, as described above. In response to detecting the input in FIG. 26O, the electronic device 500 displays user interface 629m including the automatically-generated visual content item generated using the prompt components 2206b, 2206c, 2606a, 2606b, and 2606c, shown in FIG. 26P.

In FIG. 26P, the electronic device 500 optionally detects one or more inputs directed towards options 630a, 630b, and/or 630c with contact 2012 (e.g., a tap or a long press input). Options 630a, 630b, and 630c in FIG. 26P optionally correspond to options 630a, 1602c, and/or 2242a; options 630b, 1602d, and/or 2242b; and options 630c, 1602e, and/or 2242c in FIGS. 6A-6MM, 9A-9X, 16A-16U, 18G-18BB, 20D-20AA, and/or 22A-22CCC. Although FIG. 26P illustrates multiple inputs directed towards multiple options 630a through 630c using contact 2012, the electronic device 500 optionally receives the inputs directed towards one or more options independently. In some embodiments, the electronic device 500 redisplays user interface 604 in FIG. 26O in response to the electronic device receiving an input directed towards selectable option 630a. In some embodiments, the electronic device 500 saves the automatically-generated visual content (e.g., in the gallery shown by user interface 600 in FIG. 6A) in response to the electronic device receiving an input directed towards selectable option 630b. Actions in response to the electronic device receiving an input directed towards selectable option 630b are described in further detail above. For example, the user optionally saves the image as a new image or overrides a previous image, as described in FIG. 6Q. In some embodiments, the electronic device 500 transmits the automatically-generated visual content to a different application and/or a different device in response to the electronic device receiving an input directed towards selectable option 630c.

FIG. 27 illustrates a flow diagram illustrating a method in which an electronic device presents user interfaces for selecting a template subject for generating an automatically-generated visual content item in accordance with some embodiments of the disclosure. The method 2700 is optionally performed at first electronic device and/or electronic devices such as device 100, device 300, or device 500 as described above with reference to FIGS. 1A-1B, 2-3, 4A-4B and 5A-5H. Some operations in method 2700 are, optionally combined and/or order of some operations is, optionally, changed.

In some embodiments, method 2700 is performed at an electronic device in communication with one or more display generation components and one or more input devices, such as electronic device 500, as shown in FIG. 26A. In some embodiments, the electronic device has one or more characteristics of the electronic device described in one or more methods above including methods 700, 800, 1000, 1200, 1400, 1500, 1700, 1900, 2100, and/or 2300. In some embodiments, the one or more display generation components have one or more characteristics of the one or more display generation components described in one or more methods above including method 700, 800, 1000, 1200, 1400, 1500, 1700, 1900, 2100, and/or 2300. In some embodiments, the one or more input devices have one or more characteristics of the one or more input devices described in one or more methods above including method 700, 800, 1000, 1200, 1400, 1500, 1700, 1900, 2100, and/or 2300.

In some embodiments, the electronic device detects, via the one or more input devices, one or more first inputs corresponding to a request to generate a visual media content (e.g., automatically-generated visual media is described in greater detail in methods 700, 800, 1000, 1200, 1400, 1500, 1700, 1900, 2100, and/or 2300) based on a first prompt, such as detecting contact 2012 (e.g., a tap or long press input) in FIGS. 26A-26P to generate the automatically-generated visual content shown in FIG. 26B and/or FIG. 26P In some embodiments, generating an automatically-generated visual content based on a first prompt is described in greater detail in method(s) 700, 800, 1000, 1200, 1400, 1500, 1700, 1900, 2100, and/or 2300. In some embodiments, the first prompt includes a subject and a style, which is described in greater detail in method(s) 800, 900, 2100 and/or 2300. In some embodiments, the one or more first inputs include a selection input, such as a tap, a gaze, and/or a click using a mouse/trackpad directed towards one or more selectable options including a selectable option (e.g., a virtual or physical button) that when selected, causes the electronic device to display the user interface of the automatically-generated visual media application. In some embodiments, the one or more first inputs include a voice input.

In some embodiments, in response to detecting the one or more first inputs, in accordance with a determination that the one or more first inputs satisfy one or more first criteria including a criterion that is satisfied when the one or more first inputs correspond to a request to generate a visual media content that includes an anthropomorphic subject (e.g., anthropomorphic subjects are described in greater detail in method 2300), the electronic device displays, via the one or more display generation components, an automatically-generated visual content using a randomly or pseudorandomly selected representation of a template subject from a set of template subjects that includes template subjects that have different appearances for at least one appearance characteristic (e.g., skin color, hair style, hair color, clothing style, facial features, age, and/or gender), such as avatars 2266i displayed in options 2232a through 2232c. In some embodiments, the electronic device 500 generates the automatically-generated visual content shown in FIG. 26P using a randomly selected template subject from the avatars in the selected option 2232c (and shown as component 2606b, in FIG. 26M). In some embodiments, the electronic device generates the automatically-generated visual content without displaying the automatically-generated visual content. In some embodiments, the automatically-generated visual content includes an anthropomorphic subject when the prompt includes the anthropomorphic subject as the subject or includes a directive to generate the automatically-generated visual content of the respective anthropomorphic subject. In some embodiments, the subject of the automatically-generated visual content is described in further detail in methods 700, 800, 1900, and 2100. In some embodiments, template subjects are representations of humans (e.g., anthropomorphic subjects) including one or more appearance characteristics (e.g., skin color, hair style, hair color, clothing style, facial features, age, and/or gender). In some embodiments, the set of template subjects include one or more consistent and/or shared appearance characteristics (e.g., skin color and gender) while other appearance characteristics (e.g., facial features, hair style, hair color, clothing style, age, and/or other features) are variable. In some embodiments, the electronic device presents a user interface including one or more selectable options that represent available appearance characteristics for a set of template subjects. In some embodiments, while displaying the user interface, the electronic device receives one or more inputs to select a respective appearance characteristic to be kept consistent (e.g., a specific gender and/or hair color) for the set of template subjects. In some embodiments, the electronic device provides a plurality of sets of template subjects to choose from as described above with reference to method 2300. In some embodiments, the user selects a set of template subjects for use in the generation of the automatically-generated visual content. In some embodiments, the electronic device randomly selects or pseudorandomly selects one representation of a template subject to be used as the subject for the generation of the automatically-generated visual content. In some embodiments, the electronic device uses the likeness (e.g., the appearance characteristics) of the randomly selected representation to influence the generation of the automatically-generated visual content. In some embodiments, the first prompt does not influence the selection of the template subject. In some embodiments, the first prompt does not include an indication of a template subject to be used to generate the automatically-generated visual content. In some embodiments, randomly selecting or pseudorandomly selecting is described in greater detail in methods 1400 and 1500. In some embodiments, randomly selecting one representation of a template subject includes selecting one of the plurality of template subjects without a definite pattern. In some embodiments, pseudorandomly selecting one representation of a template subject includes selecting one of the plurality of template subjects using a deterministic algorithm which appears to be random.

In some embodiments, in response to detecting the one or more first inputs, in accordance with a determination that the one or more first inputs do not satisfy the one or more first criteria (e.g., because the prompt does not include a request to generate visual media that includes an anthropomorphic subject and/or does not include a request to generate visual media that is based on a template subject and instead includes a request to generate visual media based on an existing media item such as a set of one or more photos, images, and/or videos that includes an anthropomorphic subject), the electronic device generates the automatically-generated visual content without using a representation of a template subject from the set of template subjects (e.g., the electronic device generates the automatically-generated visual content without using any template subject or without using any subject), such as the automatically-generated visual content item shown in FIG. 26B, generated using the subject “Clyde”. In some embodiments, the one or more first inputs include an input to generate the automatically-generated visual content using a non-randomly or non-pseudorandomly generated candidate subject, described in greater detail in method 2100 and/or 2300, which optionally does not satisfy the one or more first criteria. For example, the subject is based on one or more photos of a real-world person or animal. In some embodiments, the prompt does not include a person and/or animal subject (e.g., the prompt does not include a subject) and in such embodiments, the electronic device generates the automatically-generated visual content without an anthropomorphic subject. In some embodiments, the electronic device forgoes presenting the user interface for selecting a template subject and/or choosing consistent appearance characteristics of a template subject when the electronic device detects that the prompt includes a subject other than an anthropomorphic subject and/or no subject. Providing a set of template subjects for customizing the appearance of a subject provide a quick and efficient way to customize an automatically-generated visual content, rather than requiring the automatically-generated visual content to be created by hand or stylus. Providing a set of template subjects allows a user to dictate an overall appearance of the automatically-generated visual content (and the person that is the subject of the automatically-generated visual content). Additionally, providing the set of template subjects allows for a broader range of representations of different types of subjects for the automatically-generated visual content.

In some embodiments, in response to detecting the one or more first inputs, in accordance with a determination that the one or more first inputs satisfy one or more second criteria including a criterion that is satisfied when the one or more first inputs correspond to a request to generate a visual media item based on a subject in a media item (e.g., the subject in the media item is described in greater detail in methods 1700, 2100, and/or 2300), the electronic device displays (and/or generating such as generating without displaying), via the one or more display generation components, the automatically-generated visual content including a candidate subject based on an appearance of the subject in the media item, such as the automatically-generated visual content item shown in FIG. 26B, generated using the subject “Clyde”. In some embodiments, the candidate subject is described in greater detail in methods 1700, 2100, and/or 2300. In some embodiments, the media item is a media item from a camera application and/or a content library. In some embodiments, the electronic device uses the one or more subjects (e.g., objects) in the media item to be used as the candidate subject to generate the automatically-generated visual content. Generating the automatically-generated visual content using a subject from a media item allows the user to dictate an overall appearance of the automatically-generated visual content (and the person that is the subject of the automatically-generated visual content).

In some embodiments, after generating the automatically-generated visual content using the randomly or pseudorandomly selected representation of the template subject, the electronic device detects, via the one or more input devices, one or more second inputs corresponding to a request to regenerate the automatically-generated visual media content that includes the anthropomorphic subject, such as detecting the contact 2012 (e.g., a tap or a long press input) in FIG. 26K to display a different representation of the automatically-generated visual content item. In some embodiments, the one or more second inputs include a selection input, such as a tap, a gaze, and/or a click using a mouse/trackpad directed towards one or more selectable options including a selectable option (e.g., a virtual or physical button) that when selected, causes the electronic device to regenerate the automatically-generated visual content. In some embodiments, the one or more second inputs include a voice input. In some embodiments, regenerating the automatically-generated visual content is described in greater detail in method 700, 800, and/or 1700.

In some embodiments, in response to detecting the one or more second inputs, the electronic device regenerates the automatically-generated visual media content using a second randomly or pseudorandomly selected representation of a second template subject from the set of template subjects, such as displaying a second representation 2204m of the automatically-generated visual content item with a different template subject, shown in FIG. 26L. In some embodiments, the one or more second inputs includes a swipe input directed towards a representation of the automatically-generated visual content to swipe through a plurality of representations of the automatically-generated visual content based on the first prompt and the set of template subjects. In some embodiments, the different representations of the automatically-generated visual content are described in greater detail in methods 700 and/or 1700. In some embodiments, the set of template subjects includes a plurality of template subjects including different appearances but are constrained by (e.g., having in common) one or more appearance characteristics (e.g., body type and/or skin color), described below. In some embodiments, regenerating the automatically-generated visual content includes using a different randomly selected or pseudorandomly selected representation of a template subject from the set of template subjects. Additionally, regenerating the automatically-generated visual content results in an automatically-generated visual content with a different appearance that the previously generated automatically-generated visual content, such as described in greater detail in methods 700, 800, and/or 1700. Generating the automatically-generated visual content using different representations of template subjects allows a user to easily change and dictate the overall appearance of the automatically-generated visual content.

In some embodiments, the one or more second inputs include an input corresponding to a request to change the first prompt to a second prompt to be used to generate the visual media content, such as adding an additional prompt component (e.g., component 2606c), shown in FIG. 26O, in response to detecting contact 2012 (e.g., a tap or long press input), in FIG. 26N. As a result of adding component 2606c, the electronic device displays a different representation 2204n of the automatically-generated visual content item using a different template subject. In some embodiments, the electronic device uses a different template subject to generate the automatically-generated visual content in response to modifications to the prompt (e.g., changing the first prompt to the second prompt). In some embodiments, modifications to the prompt are described in greater detail in method 700. In some embodiments, the electronic device receives one or more second inputs to add, delete, and/or modify recognized concepts of the prompt. In some embodiments, recognized concepts are described in greater detail in previous methods, such as methods 700, 800, 1700, 1900, and/or 2100. Generating the automatically-generated visual content using different representations of template subjects in response to changing the prompt allows a user to easily change and dictate the overall appearance of the automatically-generated visual content.

In some embodiments, the one or more second inputs include an input (e.g., a swipe gesture using a finger, a gaze, and/or a stylus) corresponding to a request to generate a second visual media content based on the first prompt, different from the visual media content, such as generating/displaying representation 2205m, shown in FIG. 26L, after detecting the contact 2012 (e.g., a tap or a long press input) directed towards representation 2204l, shown in FIG. 26K. In some embodiments, the input include a selection input, such as a tap, a gaze, and/or a click using a mouse/trackpad directed towards the selectable option (e.g., a virtual or physical button) that when selected, causes the electronic device to generate the second visual media content based on the first prompt. In some embodiments, in response to receiving the request, the electronic device generates a second automatically-generated visual content different from the automatically-generated visual content. In some embodiments, the second automatically-generated visual content is a variant generated using the first prompt (e.g., and the recognized concept(s) of the first prompt). In some embodiments, generating variants using the same prompt is described in greater detail in method 1700. Generating the automatically-generated visual content using different representations of template subjects while maintaining the same prompt allows a user to easily change and dictate the overall appearance of the automatically-generated visual content.

In some embodiments, the set of template subjects share a first appearance characteristic (e.g., a hair color, a skin color, a gender, a body type, or other appearance characteristics, as described above) selected in response to detecting, via the one or more input devices, one or more user inputs, such as the avatars 2266h, shown in FIG. 26H, sharing the same skin tone in response to detecting the contact 2012 (e.g., a tap or a long press input), shown in FIG. 26G. In some embodiments, the electronic device receives one or more inputs from a user and based on user preference to constrain the set of template subjects, wherein the template subjects all include the first appearance characteristic. In some embodiments, the set of template subjects include variable appearance characteristics for other appearance characteristics, as described below. Constraining the appearance characteristics of the set of template subjects based on user preference allows the user to easily and efficiently dictate the overall appearance of the subject of the automatically-generated visual content, thereby decreasing power consumption and/or improving battery life of the electronic device.

In some embodiments, the one or more user inputs includes an input corresponding to a request to select a body type characteristic as the first appearance characteristic, such as detecting contact 2012 (e.g., a tap or long press input), shown in FIG. 26H. In some embodiments, the input include a selection input, such as a tap, a gaze, and/or a click using a mouse/trackpad directed towards the selectable option (e.g., a virtual or physical button) that when selected, causes the electronic device to constrain the set of template subjects using the first appearance characteristic.

In some embodiments, in response to detecting the input, the electronic device selects the body type characteristic as the first appearance characteristic, such as selecting option 2232c, shown in FIG. 26I. In some embodiments, the body type characteristic includes gender representation, artistic representation of a body (e.g., cartoon, animated, or realistic), shape/proportion, size, height, posture, and/or physical condition. In some embodiments, the body type characteristic is described in greater detail in method 2300. In some embodiments, a user selects a specific body type characteristic as the first appearance characteristic and then the set of template subjects all display the specific body type characteristic. Constraining the appearance characteristics of the set of template subjects based on user preference of body type allows the user to easily and efficiently dictate the overall appearance of the subject of the automatically-generated visual content, thereby decreasing power consumption and/or improving battery life of the electronic device.

In some embodiments, in response to receiving the input, constraining the set of template subjects with the body type characteristic prior to generating the automatically-generated visual content, such as updating the representation 2204k, shown in FIG. 26H, to representation 2204l, shown in FIG. 26I, prior to generating the automatically-generated visual content item based on the prompt components in FIG. 26I and the representation 2204l. In some embodiments, the electronic device updates the template subjects of the set of template subjects to include the body type characteristic. In some embodiments, in response to receiving the input, the electronic device updates the randomly or pseudorandomly selected representation of the template subject to include the body type characteristic. In some embodiments, the electronic device updates the automatically-generated visual content (e.g., by regenerating the automatically-generated visual content) to include the body type characteristic. In some embodiments, while the electronic device constrains the template subjects using the body type characteristic, the template subjects includes other characteristics that are different amongst the template subjects (e.g., unconstrained characteristics). Displaying the set of template subjects with the body type characteristic enhances user interactions with the electronic device by providing improved visual feedback to the user of the updated template subjects, therefore reducing inputs and/or user errors, which decreases power consumption and/or improves battery life of the electronic device.

In some embodiments, displaying the set of template subjects includes displaying an animation (e.g., as described in greater detail in method 2300) of the set of template subjects having a set of appearance characteristics that change over time (e.g., changing over time automatically, without user input), including displaying, at a first time, a first set of template subjects with a first set of appearance characteristics including the body type characteristic, such as avatars 2266f at time T1, shown in FIG. 26F. In some embodiments, the first set of template subjects with the first set of appearance characteristics has one or more characteristics of the template subjects as described above, including characteristics related to skin tone and/or being representative of different anthropomorphic subjects, for example. In some embodiments, the first set of template subjects are constrained by the body type characteristics, described in greater detail above.

In some embodiments, displaying the set of template subjects includes displaying an animation (e.g., as described in greater detail in method 2300) of the set of template subjects having a set of appearance characteristics that change over time also including displaying, at a second time, different than the first time, a second set of template subjects with a second set of appearance characteristics including the body type characteristic, such as avatars 2266g, at time T2, shown in FIG. 26G. In some embodiments, the electronic device transitions from displaying the first set of template subjects having the first set of appearance characteristics to the second set of template subjects having the second set of appearance characteristics without receiving a user input requesting to view the second set of template subjects. In some embodiments, the automatic display of different template subjects is described in greater detail in method 2300. In some embodiments, the electronic device presents the second set of template subjects after a predetermined time period has passed since updating/adding further constraints to the template subjects. In some embodiments, the second set of template subjects having one or more appearance characteristics different than the first set of template subjects. In some embodiments, the second set of template subjects also include the body type characteristic. Automatically transitioning from displaying the first set of template subjects to the second set of template subjects enhances user interactions with the electronic device by providing improved visual feedback to the user, thereby reducing inputs and/or user errors, which reduces power consumption of the electronic device and/or improves battery life of the electronic device.

In some embodiments, in accordance with a determination that the one or more user inputs include an input corresponding to a request to constrain the set of template subjects based on a first set of appearance characteristic selected by a user, the electronic device displays, via the one or more display generation components, the animation of a first set of template subjects sharing the first set of appearance characteristics, such as the avatars 2266g, shown in FIG. 26G, with varying skin tones. In some embodiments, the input include a selection input, such as a tap, a gaze, and/or a click using a mouse/trackpad directed towards the selectable option (e.g., a virtual or physical button) that when selected, causes the electronic device to constrain the set of template subjects using the first set of appearance characteristic. In some embodiments, the first set of appearance characteristic includes an appearance characteristic as described above, such as a skin tone or a hair style. In some embodiments, prior to receiving the input, the electronic device displays the first set of template subjects with a wider set of template subjects (e.g., including a variance in the first set of appearance characteristics). In some embodiments, in response to receiving the input to constrain the template subjects, the electronic device displays the first set of template subjects (e.g., a narrower set of template subjects prior to receiving the input) including the body type constraint and the first set of appearance characteristics constraint. For example, prior to the input, the electronic device displays the first set of template subjects including a variety of skin tones and after receiving the input, the electronic device displays the first set of template subjects including the selected first skin tone.

In some embodiments, in accordance with a determination that the one or more user inputs include an input corresponding to a request to constrain the set of template subjects based on a second set of appearance characteristic selected by a user, the electronic device displays, via the one or more display generation components, the animation of a second set of template subjects sharing the second set of appearance characteristics, such as the avatars 2266h, shown in FIG. 26H, that share the same skin tone. In some embodiments, the second set of appearance characteristics includes a second skin tone different than the first skin tone. In some embodiments, the electronic device displays the second set of template subjects with the second skin tone and a variance in the other appearance characteristics that are not constrained. Displaying a smaller set of template subjects after selecting constraints to the template subjects enhances user interactions with the electronic device by providing improved visual feedback to the user of the updated template subjects, therefore reducing inputs and/or user errors, which decreases power consumption and/or improves battery life of the electronic device.

In some embodiments, in response to detecting the one or more first inputs, the electronic device displays a representation of the first appearance characteristic, including in accordance with a determination that the request to generate the visual media content is a first type of request (e.g., generating an emoji, wherein generating an emoji is described in greater detail in method 2300), the electronic device displays, via the one or more display generation components, a first representation of the first appearance characteristic with a first style associated with the first type of request, such as if the request was a request to generate an emoji as shown in FIG. 22O-22T. In some embodiments, the user interface shown in FIG. 22O includes the one or more elements shown in FIG. 22F (e.g., selecting a set of template subjects). If the request was a request to generate an emoji, then the avatars 2266F, shown in FIG. 26F, would be emojis with different appearance characteristics. In some embodiments, if the request is a first type of request (e.g., to generate an emoji), then the electronic device displays the first appearance characteristic (e.g., and all characteristics) with a first style (e.g., a cartoon, animated, and/or non-realistic style). For example, the template subjects are displayed as emojis rather than anthropomorphic subjects when the electronic device is generating emojis. In some embodiments, while the electronic device receives the first type of request, the appearance characteristics correspond to the first style and includes style specific characteristics (e.g., a yellow skin tone for emojis).

In some embodiments, in accordance with a determination that the request to generate the visual media content is a second type of request, different from the first type of request (e.g., generating automatically-generated visual content using an anthropomorphic representation of a subject optionally in a visual style other than emoji. Generating the automatically-generated visual content using the anthropomorphic representation of the subject is described in greater detail in method 700, 800, 1000, 1200, 1700, 1800, and/or 2100.), the electronic device displays, via the one or more display generation components, a second representation of the first appearance characteristic with a second style associated with the second type of request, wherein the second style is different from the first style, such as the avatars 2266f, shown in FIG. 26F, being different representations of humans with different appearance characteristics. In some embodiments, if the request is the second type of request (e.g., to generate a automatically-generated visual content with a realistic-looking subject (e.g., human subject)), then the electronic device displays the first appearance characteristic (e.g., and all the characteristics) with the second style. In some embodiments, the second style is a realistic style wherein the template subjects are anthropomorphic representations of humans. In some embodiments, the second style also includes a visual style such as a non-realistic visual styles such as sketch, comic book, animation, or other styles as described in method 700. In some embodiments, the second style also includes style specific characteristics, such as human skin tones, human face shapes, human hair styles, and other realistic characteristics for appearance characteristics. Displaying the set of template subjects with a respective style based on the type of request enhances user interactions with the electronic device by providing improved visual feedback to the user of the style of the visual media content, therefore reducing inputs and/or user errors, which decreases power consumption and/or improves battery life of the electronic device.

In some embodiments, the one or more user inputs includes an input corresponding to a request to select a skin tone (or a range of skin tones) characteristic as the first appearance characteristic, such as detecting contact 2012 (e.g., a tap or long press input) directed towards option 2235e, shown in FIG. 26G. In some embodiments, the skin tone characteristic is described in greater detail above and in more detail with respect to method 2300. In some embodiments, the input corresponds to a request to select a first skin tone as the first appearance characteristic.

In some embodiments, in response to detecting the input, the electronic device selects the skin tone characteristic as the first appearance characteristic, such as the avatars 2266h all sharing the same skin tone in FIG. 26H. In some embodiments, in response to selecting the first skin tone as the skin tone characteristic, the electronic device displays the set of template subjects to include the first skin tone. In some embodiments, prior to selecting the first appearance characteristic, the electronic device displays a larger set of subjects in the set of template subjects having a variety of skin tones. In some embodiments, after selecting the first appearance characteristic, the electronic device narrows the set of template subjects to only include subjects including the first appearance characteristic. Constraining the appearance characteristics of the set of template subjects based on user preference of skin tone allows the user to easily and efficiently dictate the overall appearance of the subject of the automatically-generated visual content, thereby decreasing power consumption and/or improving battery life of the electronic device.

In some embodiments, in response to receiving the input, the electronic device constrains the set of template subjects with skin tone characteristic prior to generating the automatically-generated visual content, such as representation 2204l having the respective skin tone in FIG. 26I, prior to generating the automatically-generated visual content item corresponding to the representation 2204l. In some embodiments, containing the set of template subjects is described in greater detail above. In some embodiments, in response to receiving the input, the electronic device selects the first skin tone and displays the set of template subjects with the first skin tone and forgoes displaying a set of template subjects with a second skin tone different from the first skin tone. In some embodiments, the electronic device also generates the automatically-generated visual content including a subject with the first skin tone. Displaying the set of template subjects with the skin tone characteristic enhances user interactions with the electronic device by providing improved visual feedback to the user of the updated template subjects, therefore reducing inputs and/or user errors, which decreases power consumption and/or improves battery life of the electronic device.

In some embodiments, constraining the set of template subjects based on the first appearance characteristic includes forgoing constraining the set of template subjects in one or more second appearance characteristics, such as the avatars 2266i in FIG. 26I having varying hair styles while being constrained by skin tone. In some embodiments, constraining the set of template subjects based on the first appearance characteristic includes maintaining a variance in appearance characteristics for one or more second appearance characteristics. In some embodiments, the electronic device displays the set of template subjects such that all the template subjects are constrained with (e.g., share) the first appearance characteristic. In some embodiments, the set of template subjects share one or more second appearance characteristics that are not constrained (e.g., based on user input). In some embodiments, the one or more second appearance characteristics is an appearance characteristic described above. For example, if the set of template subjects is constrained by a first skin tone, the set of template subjects optionally has variance in hair style, body shape, gender, or other appearance characteristics, described above. In some embodiments, the electronic device constrains the set of template subjects based on appearance characteristics for which the user has provided an input to constrain. In some embodiments, the electronic device maintains variance for appearance characteristics for which the electronic device has not detected an input from a user to constrain. In some embodiments, the representation of the template subject used in the automatically-generated visual content is a vector in a multi-dimensional space, where the dimensions are the various appearance characteristics. In some embodiments, the template subject is restricted in a first dimension corresponding to the first appearance characteristic. In some embodiments, the electronic device randomly or pseudorandomly selects positions/numbers in the other dimensions of the multi-dimensional space (e.g., corresponding to the one or more second appearance characteristics) to determine the representation of the template subject to be used to influence the generation of the automatically-generated visual content. Displaying variation in template subjects based on unconstrained appearance characteristics enhances user interactions with the electronic device by allowing the user to easily dictate the overall appearance of the subject while providing different variations of subjects, therefore reducing inputs and/or user errors, which decreases power consumption and/or improves battery life of the electronic device.

In some embodiments, the at least one appearance characteristic includes a hair type characteristic, such as the avatars 2266i shown in FIG. 26I having varying hair styles. In some embodiments, the hair type characteristic includes different hair styles, hair colors, and/or hair textures. In some embodiments, constraining the set of template subjects based on the hair type characteristic restricts the template subject in a dimension corresponding to the hair type characteristic. In some embodiments, constraining the body type characteristic and/or the skin tone characteristic does not include constraining a hair type characteristic. In some embodiments, the one or more template subjects includes a variance in hair type. For example, while the template subjects are optionally constrained in a second appearance characteristic, they include a variation in the hair type characteristic. In some embodiments, the randomly or pseudorandomly selected template subject includes variations in the hair style characteristic. Displaying variation in template subjects based on a hair type characteristic enhances user interactions with the electronic device by allowing the user to easily dictate the overall appearance of the subject while providing different variations of subjects, therefore reducing inputs and/or user errors, which decreases power consumption and/or improves battery life of the electronic device.

In some embodiments, the at least one appearance characteristic includes an age characteristic, such as the avatars 2266i shown in FIG. 26I having varying ages. In some embodiments, the age characteristic includes representation of ages of a subject (e.g., face fullness, wrinkles, color of hair, or other representations of age). In some embodiments, constraining the set of template subjects based on the age characteristic restricts the template subject in a dimension corresponding to the age characteristic. In some embodiments, constraining the body type characteristic and/or the skin tone characteristic does not include constraining the age characteristic. In some embodiments, the one or more template subjects includes a variance in age. For example, while the template subjects are optionally constrained in a second appearance characteristic, they include a variation in the age characteristic. In some embodiments, the randomly or pseudorandomly selected template subject includes variations in the age characteristic. Displaying variation in template subjects based an age characteristic enhances user interactions with the electronic device by allowing the user to easily dictate the overall appearance of the subject while providing different variations of subjects, therefore reducing inputs and/or user errors, which decreases power consumption and/or improves battery life of the electronic device.

It should be understood that the particular order in which the operations in FIG. 27 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 800, 1000, 1200, 1400, 1500, 1700, 1900, 2100, and/or 2300) are also applicable in an analogous manner to method 2700 described above with respect to FIG. 27. For example, the operation of constraining template subjects and using a random or pseudorandomly selected template subject as the subject for generating the automatically-generated visual content described above with reference to method 2700 optionally has one or more of the characteristics of, displaying a representation of a prompt and one or more recognized concepts, editing one or more parameters, including one or more recognized concepts, of a previously generated automatically-generated visual content, adding a representation of automatically-generated visual content into a first application, presenting an automatically-generated visual media creation user interface to use a non-automatically-generated visual media as the reference media item, displaying portion(s) of a user interface with HDR luminance, displaying one or more portions of the user interface with luminance that is within or greater than a SDR luminance, generating multiple variations of representations of automatically-generated visual content, restricting prompt components to be used to generate automatically-generated visual content, suggesting prompt component suggestions based on device context, and customizing subjects for generating automatically-generated visual content described herein with reference to other methods described herein (e.g., 700, 800, 1000, 1200, 1400, 1500, 1700, 1900, 2100, and/or 2300). For brevity, these details are not repeated here.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is tracking and displaying content. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data relating to a person's likeness, name, date of birth, or any other identifying or personal information.

The present disclosure recognizes that the use of such personal information data, in the present technology, can be used to the benefit of users. For example, displaying a representation of a person based on a plurality of images of a person. Accordingly, use of such personal information data enables users to use electronic devices to generate automatically-generated visual content of themselves and other representations of people found on the electronic device. Further, other uses for personal information data that benefit the user are also contemplated by the present disclosure. For instance, personal information data may be generate automatically-generated visual content.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device generates (e.g., using an AI process or a generative AI process) automatically-generated visual media content without associating the content with personal user data.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component, and one or more input devices:
while displaying a first user interface, detecting a first event; and
in response to detecting the first event:
in accordance with a determination that the first event corresponds to a first functionality that outputs content generated using a first artificial intelligence (AI) model, displaying first visual information corresponding to the first event in the first user interface with a first visual effect, wherein the first visual effect includes a first visual characteristic; and
in accordance with a determination that the first event corresponds to a second functionality, different from the first functionality, that outputs content generated using a second AI model, displaying second visual information corresponding to the first event in the first user interface with a second visual effect, different from the first visual effect, wherein the second visual effect includes the first visual characteristic.

2. The method of claim 1, further comprising:
while displaying the first user interface, and in response to detecting the first event:
in accordance with a determination that the first event corresponds to a third functionality, different from the first functionality and the second functionality, that outputs content generated using a third AI model displaying third visual information corresponding to the first event in the first user interface with a third visual effect, different from the first visual effect and the second visual effect, wherein the third visual effect includes the first visual characteristic.

3. The method of claim 2, further comprising:
while displaying the first user interface, and in response to detecting the first event:
in accordance with a determination that the first event corresponds to a fourth functionality, different from the first functionality, the second functionality, and the third functionality, that outputs content generated using a fourth AI model, displaying fourth visual information corresponding to the first event in the first user interface with a fourth visual effect, different from the first visual effect, the second visual effect, and the third visual effect, wherein the fourth visual effect includes the first visual characteristic.

4. The method of claim 1, further comprising:
while displaying the first user interface, and in response to detecting the first event:
in accordance with a determination that the event corresponds to a respective functionality, different from the first functionality and the second functionality, that does not output content generated using an AI model, displaying respective visual information corresponding to the first event in the first user interface, wherein the respective visual information does not include the first visual characteristic.

5. The method of claim 1, further comprising:
while displaying the first user interface, detecting a second event, different from the first event; and
in response to detecting the second event;
in accordance with a determination that the second event corresponds to the first functionality, displaying a first animation sequence corresponding to the first functionality, wherein the first animation sequence corresponds to a respective animation sequence that was displayed as part of displaying the first visual information corresponding to the first functionality in response to the first event.

6. The method of claim 1, wherein displaying visual effects with the first visual characteristic includes displaying the visual effects with a graphical element.

7. The method of claim 1, wherein displaying the first visual effect includes displaying the first visual effect with a first animated visual effect, and wherein displaying the second visual effect includes displaying the second visual effect with a second animated visual effect.

8. The method of claim 7, wherein displaying the visual effects with the first visual characteristic includes displaying the visual effects with an animated change in color.

9. The method of claim 8, wherein displaying the animated change in color includes displaying the animated change in color with an animated change through a first range of colors.

10. The method of claim 9, further comprising:
while displaying the first user interface, and in response to detecting the first event:
in accordance with the determination that the first event corresponds to the first functionality that outputs content using the first AI model, animating the animated change through the first range of colors in a first manner; and
in accordance with the determination that the first event corresponds to the second functionality that outputs content using the second AI model, animating the animated changed through the first range of colors in a second manner, different from the first manner.

11. The method of claim 1, further comprising:
while displaying the first user interface, and in response to detecting the first event:
in accordance with the determination that the first event corresponds to the first functionality that outputs content using the first AI model, animating an animated change through a first portion of a first range of colors; and
in accordance with the determination that the first event corresponds to the second functionality that outputs content using the second AI model, animating the animated change through a second portion of the first range of colors, different than the first portion of the first range of colors.

12. The method of claim 7, wherein the displaying the visual effects with the first visual characteristic includes displaying the visual effects with an animation of a spatially varying color pattern.

13. The method of claim 7, wherein displaying visual effects with the first visual characteristic includes displaying the visual effects with a glowing effect that extends from a boundary associated with the first user interface, and gradually fades according to a non-linear manner as a distance from the boundary associated with the first user interface increases.

14. The method of claim 7, wherein the method further comprises:
while displaying the first user interface, and in response to detecting the first event corresponding to the first functionality:
displaying the first visual effect with a first spatial parameter at a first time; and
displaying the first visual effect with a second spatial parameter, different from the first spatial parameter, at a second time, different from the first time.

15. The method of claim 7, wherein the method further comprises:
while displaying the first user interface, and in response to detecting the first event:
displaying the first visual effect with a first visual intensity at a first time; and
displaying the first visual effect with a second visual intensity, different from the first visual intensity, at a second time, different from the first time.

16. The method of claim 15, wherein the first visual effect at least temporarily includes displaying a first visual content with High Dynamic Range (HDR) luminance that is greater than a standard range of luminance that is available to display content in the first user interface.

17. The method of claim 7, wherein the first user interface includes a plurality of user interface elements, and wherein the method further comprises:
in response to the first event, and in accordance with the determination that the first event corresponds to the first functionality, displaying the first visual effect comprises displaying a first user interface element of the first user interface with the first visual effect, wherein the first visual effect includes displaying the first user interface element with a common animated layer, and wherein the common animated layer varies spatially over time; and
in response to detecting a second event, different from the first event, and in accordance with a determination that the second event corresponds to a second functionally that outputs content generated using a third AI model, displaying a second user interface element of the first user interface with a third visual effect, wherein the third visual effect includes displaying the second user interface element with the common animated layer, and wherein the common animated layer varies spatially over time.

18. The method of claim 7, wherein displaying first visual information corresponding to the first event in the first user interface with the first visual effect comprises:
while displaying the first user interface, and while displaying the first visual effect in response to detecting the first event:
receiving a first user input at the first user interface; and
in response to receiving the first user input, modifying one or more aspects of the first visual effect.

19. The method of claim 1, displaying first visual information includes applying the first visual effect to content generated based on the first functionality, and wherein displaying second visual information includes applying the second visual effect to content generated based on the second functionality.

20. The method of claim 1, wherein the first functionality includes a status indicator associated with a virtual assistant.

21. The method of claim 1, wherein the first functionality includes a response generated by a virtual assistant.

22. The method of claim 1, wherein the first functionality includes displaying an input region on the first user interface for accepting one or more inputs to specify parameters for generation of content using an AI model.

23. The method of claim 1, wherein the first functionality includes displaying a block of text that was impacted by the first AI model.

24. The method of claim 23, wherein the block of text includes a first portion and a second portion, and wherein displaying first visual information corresponding to the first event in the first user interface with the first visual effect includes displaying the first portion of the block of text with the first visual effect, and displaying the second portion of the block of text without the first visual effect.

25. The method of claim 23, wherein the block of text is included in a notification, the block of text includes summarized text, and the summarized text is generated by the first AI model.

26. The method of claim 1, wherein the first functionality includes displaying visual media content generated by the first AI model.

27. The method of claim 1, wherein the first functionality includes displaying an element of a visual media content that is removeable.

28. The method of claim 1, wherein the first functionality includes displaying one or more animated media items as part of a visual media content.

29. The method of claim 1, wherein the first functionality includes displaying an indication of one or more search results, wherein the one or more search results are generated, using the first AI model, in response to a search query.

30. The method of claim 1, wherein the first AI model is a generative AI model.

31. The method of claim 1, wherein the first event is detected while the electronic device displays a first user interface corresponding to a first software application, the method further comprising:
while displaying a second user interface, different from the first user interface, corresponding to a second software application that is different from the first software application, detecting a second event, different from the first event; and
in response to detecting the second event:
in accordance with a determination that the second event corresponds to the first functionality that outputs content generated using the first artificial intelligence (AI) model, displaying the first visual information corresponding to the second event in the first user interface with the first visual effect, wherein the first visual effect includes the first visual characteristic; and
in accordance with a determination that the second event corresponds to the second functionality, different from the first functionality, that outputs content generated using the second AI model, displaying the second visual information corresponding to the first event in the first user interface with the second visual effect, different from the first visual effect, wherein the second visual effect includes the first visual characteristic.

32. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
while displaying a first user interface, detecting a first event; and
in response to detecting the first event:
in accordance with a determination that the first event corresponds to a first functionality that outputs content generated using a first artificial intelligence (AI) model, displaying first visual information corresponding to the first event in the first user interface with a first visual effect, wherein the first visual effect includes a first visual characteristic; and
in accordance with a determination that the first event corresponds to a second functionality, different from the first functionality, that outputs content generated using a second AI model, displaying second visual information corresponding to the first event in the first user interface with a second visual effect, different from the first visual effect, wherein the second visual effect includes the first visual characteristic.

33. A non-transitory computer readable storage medium storing one or more programs, the one or more programs comprising instructions, which when executed by one or more processors of an electronic device, cause the electronic device to perform a method comprising:
while displaying a first user interface, detecting a first event; and
in response to detecting the first event:
in accordance with a determination that the first event corresponds to a first functionality that outputs content generated using a first artificial intelligence (AI) model, displaying first visual information corresponding to the first event in the first user interface with a first visual effect, wherein the first visual effect includes a first visual characteristic; and
in accordance with a determination that the first event corresponds to a second functionality, different from the first functionality, that outputs content generated using a second AI model, displaying second visual information corresponding to the first event in the first user interface with a second visual effect, different from the first visual effect, wherein the second visual effect includes the first visual characteristic.
